(19) United States
(12) Patent Application Publication
(10) Pub. No.: US 2025/0258591 A1
(43) Pub. Date: Aug. 14, 2025

(54) MEDIA LIBRARY USER INTERFACES

(71) Applicant: Apple Inc., Cupertino, CA (US)

(72) Inventors: Chia Yang LIN, San Francisco, CA (US); William A. SORRENTINO, III, Mill Valley, CA (US); Andre SOUZA DOS SANTOS, San Jose, CA (US); James J. OWEN, San Francisco, CA (US); Alfred B. HUERGO WAGER, Redwood City, CA (US)

(21) Appl. No.: 18/898,615

(22) Filed: Sep. 26, 2024

Related U.S. Application Data
(60) Provisional application No. 63/657,813, filed on Jun. 8, 2024.
(60) Provisional application No. 63/631,428, filed on Apr. 8, 2024.
(60) Provisional application No. 63/552,041, filed on Feb. 9, 2024.

(51) Int. Cl. G06F 3/04842

(52) U.S. Cl. CPC G06F 3/04842

(57) ABSTRACT

The present disclosure generally relates to navigation, display, and/or presentation of content.

### CROSS-REFERENCE TO RELATED APPLICATIONS

This application claims priority to U.S. Provisional Application No. 63/552,041, entitled “MEDIA LIBRARY USER INTERFACES,” filed on Feb. 9, 2024, U.S. Provisional Application No. 63/631,428, entitled “MEDIA LIBRARY USER INTERFACES,” filed on Apr. 8, 2024, and U.S. Provisional Application No. 63/657,813, entitled “MEDIA LIBRARY USER INTERFACES,” filed on Jun. 8, 2024, each of which is hereby incorporated by reference in their entirety.

### FIELD

The present disclosure relates generally to computer user interfaces, and more specifically to techniques for navigating, displaying, and/or presenting content, such as content items in a media library.

### BACKGROUND

As the storage capacity and processing power of devices continue to increase, coupled with the rise of effortless media sharing between interconnected devices, the size of users' libraries of media items (e.g., photos and videos) continues to increase.

### BRIEF SUMMARY

Some techniques for navigating, displaying, and/or presenting content using electronic devices, however, are generally cumbersome and inefficient. For example, some existing techniques use a complex and time-consuming user interface, which may include multiple key presses or keystrokes. Existing techniques require more time than necessary, wasting user time and device energy. This latter consideration is particularly important in battery-operated devices.

Accordingly, the present technique provides electronic devices with faster, more efficient methods and interfaces for navigating, displaying, and/or presenting content. Such methods and interfaces optionally complement or replace other methods for navigating, displaying, and/or presenting content. Such methods and interfaces reduce the cognitive burden on a user and produce a more efficient human-machine interface. For battery-operated computing devices, such methods and interfaces conserve power and increase the time between battery charges.

In some embodiments, a method is disclosed. The method comprises: at a computer system that is in communication with one or more display generation components and one or more input devices: displaying, via the one or more display generation components, a representation of a media library, wherein the media library includes a plurality of media items including a first media item and a second media item different from the first media item; while displaying the representation of the media library, detecting, via the one or more input devices, a first user input; and in response to detecting the first user input: in accordance with a determination that the first user input includes movement in a first direction, updating, via the one or more display generation components, an appearance of the representation of the media library, including navigating through representations of a first plurality of the plurality of media items of the media library in a first scroll direction; and in accordance with a determination that the first user input includes movement in a second direction different from the first direction, displaying, via the one or more display generation components, at least a portion of a representation of a first media collection of media items from the media library that was not displayed prior to detecting the first user input, wherein: the first media collection includes a first subset of the plurality of media items of the media library; and the first subset of the plurality of media items is selected for inclusion in the first media collection based on a first set of criteria.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: displaying, via the one or more display generation components, a representation of a media library, wherein the media library includes a plurality of media items including a first media item and a second media item different from the first media item; while displaying the representation of the media library, detecting, via the one or more input devices, a first user input; and in response to detecting the first user input: in accordance with a determination that the first user input includes movement in a first direction, updating, via the one or more display generation components, an appearance of the representation of the media library, including navigating through representations of a first plurality of the plurality of media items of the media library in a first scroll direction; and in accordance with a determination that the first user input includes movement in a second direction different from the first direction, displaying, via the one or more display generation components, at least a portion of a representation of a first media collection of media items from the media library that was not displayed prior to detecting the first user input, wherein: the first media collection includes a first subset of the plurality of media items of the media library; and the first subset of the plurality of media items is selected for inclusion in the first media collection based on a first set of criteria.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: displaying, via the one or more display generation components, a representation of a media library, wherein the media library includes a plurality of media items including a first media item and a second media item different from the first media item; while displaying the representation of the media library, detecting, via the one or more input devices, a first user input; and in response to detecting the first user input: in accordance with a determination that the first user input includes movement in a first direction, updating, via the one or more display generation components, an appearance of the representation of the media library, including navigating through representations of a first plurality of the plurality of media items of the media library in a first scroll direction; and in accordance with a determination that the first user input includes movement in a second direction different from the first direction, displaying, via the one or more display generation components, at least a portion of a representation of a first media collection of media items from the media library that was not displayed prior to detecting the first user input, wherein: the first media collection includes a first subset of the plurality of media items of the media library; and the first subset of the plurality of media items is selected for inclusion in the first media collection based on a first set of criteria.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a representation of a media library, wherein the media library includes a plurality of media items including a first media item and a second media item different from the first media item; while displaying the representation of the media library, detecting, via the one or more input devices, a first user input; and in response to detecting the first user input: in accordance with a determination that the first user input includes movement in a first direction, updating, via the one or more display generation components, an appearance of the representation of the media library, including navigating through representations of a first plurality of the plurality of media items of the media library in a first scroll direction; and in accordance with a determination that the first user input includes movement in a second direction different from the first direction, displaying, via the one or more display generation components, at least a portion of a representation of a first media collection of media items from the media library that was not displayed prior to detecting the first user input, wherein: the first media collection includes a first subset of the plurality of media items of the media library; and the first subset of the plurality of media items is selected for inclusion in the first media collection based on a first set of criteria.

In some embodiments, a computer system is disclosed. The computer system is configured to communicate with one or more display generation components and one or more input devices, and comprises: means for displaying, via the one or more display generation components, a representation of a media library, wherein the media library includes a plurality of media items including a first media item and a second media item different from the first media item; means for, while displaying the representation of the media library, detecting, via the one or more input devices, a first user input; and means for, in response to detecting the first user input: in accordance with a determination that the first user input includes movement in a first direction, updating, via the one or more display generation components, an appearance of the representation of the media library, including navigating through representations of a first plurality of the plurality of media items of the media library in a first scroll direction; and in accordance with a determination that the first user input includes movement in a second direction different from the first direction, displaying, via the one or more display generation components, at least a portion of a representation of a first media collection of media items from the media library that was not displayed prior to detecting the first user input, wherein: the first media collection includes a first subset of the plurality of media items of the media library; and the first subset of the plurality of media items is selected for inclusion in the first media collection based on a first set of criteria.

In some embodiments, a computer program product is disclosed. The computer program product comprises one or more programs configured to be executed by one or more processors of a computer system that is in communication with one or more display generation components and one or more input devices, the one or more programs including instructions for: displaying, via the one or more display generation components, a representation of a media library, wherein the media library includes a plurality of media items including a first media item and a second media item different from the first media item; while displaying the representation of the media library, detecting, via the one or more input devices, a first user input; and in response to detecting the first user input: in accordance with a determination that the first user input includes movement in a first direction, updating, via the one or more display generation components, an appearance of the representation of the media library, including navigating through representations of a first plurality of the plurality of media items of the media library in a first scroll direction; and in accordance with a determination that the first user input includes movement in a second direction different from the first direction, displaying, via the one or more display generation components, at least a portion of a representation of a first media collection of media items from the media library that was not displayed prior to detecting the first user input, wherein: the first media collection includes a first subset of the plurality of media items of the media library; and the first subset of the plurality of media items is selected for inclusion in the first media collection based on a first set of criteria.

In some embodiments, a method is disclosed. The method comprises: at a computer system that is in communication with one or more display generation components and one or more input devices: displaying, via the one or more display generation components, a first representation of a first media collection, wherein: the first media collection includes a first plurality of media items from a media library; and displaying the first representation of the first media collection includes concurrently displaying: an animated media representation that corresponds to a second plurality of media items selected from the first media collection, wherein displaying the animated media representation includes sequentially displaying different media items in the second plurality of media items over time; and a media collection region that includes concurrently displaying representations of at least some of the first plurality of media items of the first media collection, including a first representation representative of a first media item and a second representation representative of a second media item different from the first media item; while displaying the first representation of the first media collection, detecting, via the one or more input devices, a first user input; and in response to detecting the first user input: in accordance with a determination that the first user input includes movement in a first direction, displaying, via the one or more display generation components, expansion of the animated media representation to occupy a greater display area of the one or more display generation components than was occupied by the animated media representation prior to detecting the first user input; and in accordance with a determination that the first user input includes movement in a second direction different from the first direction, displaying, via the one or more display generation components, expansion of the media collection region to occupy a greater display area of the one or more display generation components than was occupied by the media collection region prior to detecting the first user input.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: displaying, via the one or more display generation components, a first representation of a first media collection, wherein: the first media collection includes a first plurality of media items from a media library; and displaying the first representation of the first media collection includes concurrently displaying: an animated media representation that corresponds to a second plurality of media items selected from the first media collection, wherein displaying the animated media representation includes sequentially displaying different media items in the second plurality of media items over time; and a media collection region that includes concurrently displaying representations of at least some of the first plurality of media items of the first media collection, including a first representation representative of a first media item and a second representation representative of a second media item different from the first media item; while displaying the first representation of the first media collection, detecting, via the one or more input devices, a first user input; and in response to detecting the first user input: in accordance with a determination that the first user input includes movement in a first direction, displaying, via the one or more display generation components, expansion of the animated media representation to occupy a greater display area of the one or more display generation components than was occupied by the animated media representation prior to detecting the first user input; and in accordance with a determination that the first user input includes movement in a second direction different from the first direction, displaying, via the one or more display generation components, expansion of the media collection region to occupy a greater display area of the one or more display generation components than was occupied by the media collection region prior to detecting the first user input.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: displaying, via the one or more display generation components, a first representation of a first media collection, wherein: the first media collection includes a first plurality of media items from a media library; and displaying the first representation of the first media collection includes concurrently displaying: an animated media representation that corresponds to a second plurality of media items selected from the first media collection, wherein displaying the animated media representation includes sequentially displaying different media items in the second plurality of media items over time; and a media collection region that includes concurrently displaying representations of at least some of the first plurality of media items of the first media collection, including a first representation representative of a first media item and a second representation representative of a second media item different from the first media item; while displaying the first representation of the first media collection, detecting, via the one or more input devices, a first user input; and in response to detecting the first user input: in accordance with a determination that the first user input includes movement in a first direction, displaying, via the one or more display generation components, expansion of the animated media representation to occupy a greater display area of the one or more display generation components than was occupied by the animated media representation prior to detecting the first user input; and in accordance with a determination that the first user input includes movement in a second direction different from the first direction, displaying, via the one or more display generation components, expansion of the media collection region to occupy a greater display area of the one or more display generation components than was occupied by the media collection region prior to detecting the first user input.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a first representation of a first media collection, wherein: the first media collection includes a first plurality of media items from a media library; and displaying the first representation of the first media collection includes concurrently displaying: an animated media representation that corresponds to a second plurality of media items selected from the first media collection, wherein displaying the animated media representation includes sequentially displaying different media items in the second plurality of media items over time; and a media collection region that includes concurrently displaying representations of at least some of the first plurality of media items of the first media collection, including a first representation representative of a first media item and a second representation representative of a second media item different from the first media item; while displaying the first representation of the first media collection, detecting, via the one or more input devices, a first user input; and in response to detecting the first user input: in accordance with a determination that the first user input includes movement in a first direction, displaying, via the one or more display generation components, expansion of the animated media representation to occupy a greater display area of the one or more display generation components than was occupied by the animated media representation prior to detecting the first user input; and in accordance with a determination that the first user input includes movement in a second direction different from the first direction, displaying, via the one or more display generation components, expansion of the media collection region to occupy a greater display area of the one or more display generation components than was occupied by the media collection region prior to detecting the first user input.

In some embodiments, a computer system is disclosed. The computer system is configured to communicate with one or more display generation components and one or more input devices, and comprises: means for displaying, via the one or more display generation components, a first representation of a first media collection, wherein: the first media collection includes a first plurality of media items from a media library; and displaying the first representation of the first media collection includes concurrently displaying: an animated media representation that corresponds to a second plurality of media items selected from the first media collection, wherein displaying the animated media representation includes sequentially displaying different media items in the second plurality of media items over time; and a media collection region that includes concurrently displaying representations of at least some of the first plurality of media items of the first media collection, including a first representation representative of a first media item and a second representation representative of a second media item different from the first media item; means for, while displaying the first representation of the first media collection, detecting, via the one or more input devices, a first user input; and means for, in response to detecting the first user input: in accordance with a determination that the first user input includes movement in a first direction, displaying, via the one or more display generation components, expansion of the animated media representation to occupy a greater display area of the one or more display generation components than was occupied by the animated media representation prior to detecting the first user input; and in accordance with a determination that the first user input includes movement in a second direction different from the first direction, displaying, via the one or more display generation components, expansion of the media collection region to occupy a greater display area of the one or more display generation components than was occupied by the media collection region prior to detecting the first user input.

In some embodiments, a computer program product is disclosed. The computer program product comprises one or more programs configured to be executed by one or more processors of a computer system that is in communication with one or more display generation components and one or more input devices, the one or more programs including instructions for: displaying, via the one or more display generation components, a first representation of a first media collection, wherein: the first media collection includes a first plurality of media items from a media library; and displaying the first representation of the first media collection includes concurrently displaying: an animated media representation that corresponds to a second plurality of media items selected from the first media collection, wherein displaying the animated media representation includes sequentially displaying different media items in the second plurality of media items over time; and a media collection region that includes concurrently displaying representations of at least some of the first plurality of media items of the first media collection, including a first representation representative of a first media item and a second representation representative of a second media item different from the first media item; while displaying the first representation of the first media collection, detecting, via the one or more input devices, a first user input; and in response to detecting the first user input: in accordance with a determination that the first user input includes movement in a first direction, displaying, via the one or more display generation components, expansion of the animated media representation to occupy a greater display area of the one or more display generation components than was occupied by the animated media representation prior to detecting the first user input; and in accordance with a determination that the first user input includes movement in a second direction different from the first direction, displaying, via the one or more display generation components, expansion of the media collection region to occupy a greater display area of the one or more display generation components than was occupied by the media collection region prior to detecting the first user input.

In some embodiments, a method is disclosed. The method comprises: at a computer system that is in communication with one or more display generation components: displaying, via the one or more display generation components, a search user interface, including: displaying, within the search user interface, a representation of a first query and a representation of a first set of content that is responsive to the first query); and after displaying the representation of the first query and the representation of the first set of content: automatically ceasing display of the representation of the first set of content that is responsive to the first query; and automatically displaying a representation of a second query and a representation of a second set of content that is responsive to the second query, wherein the second set of content is different from the first set of content and the second query is different from the first query.

In some embodiments, a non-transitory computer-readable storage medium is disclosed. The non-transitory computer-readable storage medium stores one or more programs configured to be executed by one or more processors of a computer system that is in communication with one or more display generation components, the one or more programs including instructions for: displaying, via the one or more display generation components, a search user interface, including: displaying, within the search user interface, a representation of a first query and a representation of a first set of content that is responsive to the first query); and after displaying the representation of the first query and the representation of the first set of content: automatically ceasing display of the representation of the first set of content that is responsive to the first query; and automatically displaying a representation of a second query and a representation of a second set of content that is responsive to the second query, wherein the second set of content is different from the first set of content and the second query is different from the first query.

In some embodiments, a transitory computer-readable storage medium is disclosed. The transitory computer-readable storage medium stores one or more programs configured to be executed by one or more processors of a computer system that is in communication with one or more display generation components, the one or more programs including instructions for: displaying, via the one or more display generation components, a search user interface, including: displaying, within the search user interface, a representation of a first query and a representation of a first set of content that is responsive to the first query); and after displaying the representation of the first query and the representation of the first set of content: automatically ceasing display of the representation of the first set of content that is responsive to the first query; and automatically displaying a representation of a second query and a representation of a second set of content that is responsive to the second query, wherein the second set of content is different from the first set of content and the second query is different from the first query.

In some embodiments, a computer system is disclosed. The computer system is configured to communicate with one or more display generation components, and comprises: one or more processors; and memory storing one or more programs configured to be executed by the one or more processors, the one or more programs including instructions for: displaying, via the one or more display generation components, a search user interface, including: displaying, within the search user interface, a representation of a first query and a representation of a first set of content that is responsive to the first query); and after displaying the representation of the first query and the representation of the first set of content: automatically ceasing display of the representation of the first set of content that is responsive to the first query; and automatically displaying a representation of a second query and a representation of a second set of content that is responsive to the second query, wherein the second set of content is different from the first set of content and the second query is different from the first query.

In some embodiments, a computer system is disclosed. The computer system is configured to communicate with one or more display generation components, and comprises: means for displaying, via the one or more display generation components, a search user interface, including: means for displaying, within the search user interface, a representation of a first query and a representation of a first set of content that is responsive to the first query); and means for, after displaying the representation of the first query and the representation of the first set of content: automatically ceasing display of the representation of the first set of content that is responsive to the first query; and automatically displaying a representation of a second query and a representation of a second set of content that is responsive to the second query, wherein the second set of content is different from the first set of content and the second query is different from the first query.

In some embodiments, a computer program product is disclosed. The computer program product comprises one or more programs configured to be executed by one or more processors of a computer system that is in communication with one or more display generation components, the one or more programs including instructions for: displaying, via the one or more display generation components, a search user interface, including: displaying, within the search user interface, a representation of a first query and a representation of a first set of content that is responsive to the first query); and after displaying the representation of the first query and the representation of the first set of content: automatically ceasing display of the representation of the first set of content that is responsive to the first query; and automatically displaying a representation of a second query and a representation of a second set of content that is responsive to the second query, wherein the second set of content is different from the first set of content and the second query is different from the first query.

In some embodiments, a method is disclosed. The method comprises: at a computer system that is in communication with one or more display generation components and one or more input devices: receiving, via the one or more input devices, a first user input that corresponds to a first term in a search query that includes multiple terms; and in response to receiving the first user input that corresponds to the first term: in accordance with a determination that the first term meets ambiguity criteria, displaying, via the one or more display generation components, a first prompt prompting a user to provide one or more user inputs clarifying the meaning of the first term without changing other terms in the search query.

In some embodiments, a non-transitory computer-readable storage medium is disclosed. The non-transitory computer-readable storage medium stores one or more programs configured to be executed by one or more processors of a computer system that is in communication with one or more display generation components and one or more input devices, the one or more programs including instructions for: receiving, via the one or more input devices, a first user input that corresponds to a first term in a search query that includes multiple terms; and in response to receiving the first user input that corresponds to the first term: in accordance with a determination that the first term meets ambiguity criteria, displaying, via the one or more display generation components, a first prompt prompting a user to provide one or more user inputs clarifying the meaning of the first term without changing other terms in the search query.

In some embodiments, a transitory computer-readable storage medium is disclosed. The transitory computer-readable storage medium stores one or more programs configured to be executed by one or more processors of a computer system that is in communication with one or more display generation components and one or more input devices, the one or more programs including instructions for: receiving, via the one or more input devices, a first user input that corresponds to a first term in a search query that includes multiple terms; and in response to receiving the first user input that corresponds to the first term: in accordance with a determination that the first term meets ambiguity criteria, displaying, via the one or more display generation components, a first prompt prompting a user to provide one or more user inputs clarifying the meaning of the first term without changing other terms in the search query.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: receiving, via the one or more input devices, a first user input that corresponds to a first term in a search query that includes multiple terms; and in response to receiving the first user input that corresponds to the first term: in accordance with a determination that the first term meets ambiguity criteria, displaying, via the one or more display generation components, a first prompt prompting a user to provide one or more user inputs clarifying the meaning of the first term without changing other terms in the search query.

In some embodiments, a computer system is disclosed. The computer system is configured to communicate with one or more display generation components and one or more input devices, and comprises: means for receiving, via the one or more input devices, a first user input that corresponds to a first term in a search query that includes multiple terms; and means for, in response to receiving the first user input that corresponds to the first term: in accordance with a determination that the first term meets ambiguity criteria, displaying, via the one or more display generation components, a first prompt prompting a user to provide one or more user inputs clarifying the meaning of the first term without changing other terms in the search query.

In some embodiments, a computer program product is disclosed. The computer program product comprises one or more programs configured to be executed by one or more processors of a computer system that is in communication with one or more display generation components and one or more input devices, the one or more programs including instructions for: receiving, via the one or more input devices, a first user input that corresponds to a first term in a search query that includes multiple terms; and in response to receiving the first user input that corresponds to the first term: in accordance with a determination that the first term meets ambiguity criteria, displaying, via the one or more display generation components, a first prompt prompting a user to provide one or more user inputs clarifying the meaning of the first term without changing other terms in the search query.

In some embodiments, a method is disclosed. The method comprises: at a computer system that is in communication with one or more display generation components and one or more input devices: concurrently displaying, via the one or more display generation components: a representation of a media library, wherein the media library includes a plurality of media items including a first media item and a second media item different from the first media item and the representation of the media library includes representations of multiple different media items from the media library; and a memory generation option; while concurrently displaying the representation of the media library and the memory generation option, receiving, via the one or more input devices, a selection input corresponding to selection of the memory generation option; and in response to receiving the selection input corresponding to selection of the memory generation option: initiating a process for generating a memory collection that includes a plurality of media items that are automatically selected from the media library based on a respective set of terms wherein the plurality of media items includes one or more media items that were not selected by the user to be included in the memory collection.

In some embodiments, a non-transitory computer-readable storage medium is disclosed. The non-transitory computer-readable storage medium stores one or more programs configured to be executed by one or more processors of a computer system that is in communication with one or more display generation components and one or more inputs devices, and the one or more programs include instructions for: concurrently displaying, via the one or more display generation components: a representation of a media library, wherein the media library includes a plurality of media items including a first media item and a second media item different from the first media item and the representation of the media library includes representations of multiple different media items from the media library; and a memory generation option; while concurrently displaying the representation of the media library and the memory generation option, receiving, via the one or more input devices, a selection input corresponding to selection of the memory generation option; and in response to receiving the selection input corresponding to selection of the memory generation option: initiating a process for generating a memory collection that includes a plurality of media items that are automatically selected from the media library based on a respective set of terms wherein the plurality of media items includes one or more media items that were not selected by the user to be included in the memory collection.

In some embodiments, a transitory computer-readable storage medium is disclosed. The transitory computer-readable storage medium stores one or more programs configured to be executed by one or more processors of a computer system that is in communication with one or more display generation components and one or more inputs devices, and the one or more programs include instructions for: concurrently displaying, via the one or more display generation components: a representation of a media library, wherein the media library includes a plurality of media items including a first media item and a second media item different from the first media item and the representation of the media library includes representations of multiple different media items from the media library; and a memory generation option; while concurrently displaying the representation of the media library and the memory generation option, receiving, via the one or more input devices, a selection input corresponding to selection of the memory generation option; and in response to receiving the selection input corresponding to selection of the memory generation option: initiating a process for generating a memory collection that includes a plurality of media items that are automatically selected from the media library based on a respective set of terms wherein the plurality of media items includes one or more media items that were not selected by the user to be included in the memory collection.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: concurrently displaying, via the one or more display generation components: a representation of a media library, wherein the media library includes a plurality of media items including a first media item and a second media item different from the first media item and the representation of the media library includes representations of multiple different media items from the media library; and a memory generation option; while concurrently displaying the representation of the media library and the memory generation option, receiving, via the one or more input devices, a selection input corresponding to selection of the memory generation option; and in response to receiving the selection input corresponding to selection of the memory generation option: initiating a process for generating a memory collection that includes a plurality of media items that are automatically selected from the media library based on a respective set of terms wherein the plurality of media items includes one or more media items that were not selected by the user to be included in the memory collection.

In some embodiments, a computer system is disclosed. The computer system is configured to communicate with one or more display generation components and one or more input devices, and comprises: means for concurrently displaying, via the one or more display generation components: a representation of a media library, wherein the media library includes a plurality of media items including a first media item and a second media item different from the first media item and the representation of the media library includes representations of multiple different media items from the media library; and a memory generation option; means for, while concurrently displaying the representation of the media library and the memory generation option, receiving, via the one or more input devices, a selection input corresponding to selection of the memory generation option; and means for, in response to receiving the selection input corresponding to selection of the memory generation option: initiating a process for generating a memory collection that includes a plurality of media items that are automatically selected from the media library based on a respective set of terms wherein the plurality of media items includes one or more media items that were not selected by the user to be included in the memory collection.

In some embodiments, a computer program product is disclosed. The computer program product comprises one or more programs configured to be executed by one or more processors of a computer system that is in communication with one or more display generation components and one or more input devices, and the one or more programs include instructions for: concurrently displaying, via the one or more display generation components: a representation of a media library, wherein the media library includes a plurality of media items including a first media item and a second media item different from the first media item and the representation of the media library includes representations of multiple different media items from the media library; and a memory generation option; while concurrently displaying the representation of the media library and the memory generation option, receiving, via the one or more input devices, a selection input corresponding to selection of the memory generation option; and in response to receiving the selection input corresponding to selection of the memory generation option: initiating a process for generating a memory collection that includes a plurality of media items that are automatically selected from the media library based on a respective set of terms wherein the plurality of media items includes one or more media items that were not selected by the user to be included in the memory collection.

In some embodiments, a method is disclosed. The method comprises: at a computer system that is in communication with one or more display generation components and one or more input devices: detecting, via the one or more input devices, a user request to generate a memory collection, wherein the request to generate the memory collection includes one or more terms entered by a user; and in response to detecting the user request to generate a memory collection: in accordance with a determination that the one or more terms includes a first set of one or more terms, generating a first memory collection that includes a first plurality of media items that are automatically selected from a media library associated with the user based on the first set of one or more terms entered by the user, wherein the first plurality of media items includes one or more media items that were not selected by the user to be included in the first memory collection; and in accordance with a determination that the one or more terms includes a second set of one or more terms that are different from the first set of one or more terms, generating a second memory collection that includes a second plurality of media items that are automatically selected from the media library associated with the user based on the second set of one or more terms entered by the user, wherein the second plurality of media items includes one or more media items that were not selected by the user to be included in the second memory collection and the second plurality of media items is different from the first plurality of media items.

In some embodiments, a non-transitory computer-readable storage medium is disclosed. The non-transitory computer-readable storage medium stores one or more programs configured to be executed by one or more processors of a computer system that is in communication with one or more display generation components and one or more inputs devices, and the one or more programs include instructions for: detecting, via the one or more input devices, a user request to generate a memory collection, wherein the request to generate the memory collection includes one or more terms entered by a user; and in response to detecting the user request to generate a memory collection: in accordance with a determination that the one or more terms includes a first set of one or more terms, generating a first memory collection that includes a first plurality of media items that are automatically selected from a media library associated with the user based on the first set of one or more terms entered by the user, wherein the first plurality of media items includes one or more media items that were not selected by the user to be included in the first memory collection; and in accordance with a determination that the one or more terms includes a second set of one or more terms that are different from the first set of one or more terms, generating a second memory collection that includes a second plurality of media items that are automatically selected from the media library associated with the user based on the second set of one or more terms entered by the user, wherein the second plurality of media items includes one or more media items that were not selected by the user to be included in the second memory collection and the second plurality of media items is different from the first plurality of media items.

In some embodiments, a transitory computer-readable storage medium is disclosed. The transitory computer-readable storage medium stores one or more programs configured to be executed by one or more processors of a computer system that is in communication with one or more display generation components and one or more inputs devices, and the one or more programs include instructions for: detecting, via the one or more input devices, a user request to generate a memory collection, wherein the request to generate the memory collection includes one or more terms entered by a user; and in response to detecting the user request to generate a memory collection: in accordance with a determination that the one or more terms includes a first set of one or more terms, generating a first memory collection that includes a first plurality of media items that are automatically selected from a media library associated with the user based on the first set of one or more terms entered by the user, wherein the first plurality of media items includes one or more media items that were not selected by the user to be included in the first memory collection; and in accordance with a determination that the one or more terms includes a second set of one or more terms that are different from the first set of one or more terms, generating a second memory collection that includes a second plurality of media items that are automatically selected from the media library associated with the user based on the second set of one or more terms entered by the user, wherein the second plurality of media items includes one or more media items that were not selected by the user to be included in the second memory collection and the second plurality of media items is different from the first plurality of media items.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: detecting, via the one or more input devices, a user request to generate a memory collection, wherein the request to generate the memory collection includes one or more terms entered by a user; and in response to detecting the user request to generate a memory collection: in accordance with a determination that the one or more terms includes a first set of one or more terms, generating a first memory collection that includes a first plurality of media items that are automatically selected from a media library associated with the user based on the first set of one or more terms entered by the user, wherein the first plurality of media items includes one or more media items that were not selected by the user to be included in the first memory collection; and in accordance with a determination that the one or more terms includes a second set of one or more terms that are different from the first set of one or more terms, generating a second memory collection that includes a second plurality of media items that are automatically selected from the media library associated with the user based on the second set of one or more terms entered by the user, wherein the second plurality of media items includes one or more media items that were not selected by the user to be included in the second memory collection and the second plurality of media items is different from the first plurality of media items.

In some embodiments, a computer system is disclosed. The computer system is configured to communicate with one or more display generation components and one or more input devices, and comprises: means for detecting, via the one or more input devices, a user request to generate a memory collection, wherein the request to generate the memory collection includes one or more terms entered by a user; and means for, in response to detecting the user request to generate a memory collection: in accordance with a determination that the one or more terms includes a first set of one or more terms, generating a first memory collection that includes a first plurality of media items that are automatically selected from a media library associated with the user based on the first set of one or more terms entered by the user, wherein the first plurality of media items includes one or more media items that were not selected by the user to be included in the first memory collection; and in accordance with a determination that the one or more terms includes a second set of one or more terms that are different from the first set of one or more terms, generating a second memory collection that includes a second plurality of media items that are automatically selected from the media library associated with the user based on the second set of one or more terms entered by the user, wherein the second plurality of media items includes one or more media items that were not selected by the user to be included in the second memory collection and the second plurality of media items is different from the first plurality of media items.

In some embodiments, a computer program product is disclosed. The computer program product comprises one or more programs configured to be executed by one or more processors of a computer system that is in communication with one or more display generation components and one or more input devices, and the one or more programs include instructions for: detecting, via the one or more input devices, a user request to generate a memory collection, wherein the request to generate the memory collection includes one or more terms entered by a user; and in response to detecting the user request to generate a memory collection: in accordance with a determination that the one or more terms includes a first set of one or more terms, generating a first memory collection that includes a first plurality of media items that are automatically selected from a media library associated with the user based on the first set of one or more terms entered by the user, wherein the first plurality of media items includes one or more media items that were not selected by the user to be included in the first memory collection; and in accordance with a determination that the one or more terms includes a second set of one or more terms that are different from the first set of one or more terms, generating a second memory collection that includes a second plurality of media items that are automatically selected from the media library associated with the user based on the second set of one or more terms entered by the user, wherein the second plurality of media items includes one or more media items that were not selected by the user to be included in the second memory collection and the second plurality of media items is different from the first plurality of media items.

In some embodiments, a method is disclosed. The method comprises: at a computer system that is in communication with one or more display generation components and one or more input devices: displaying, via the one or more display generation components, a representation of a media library, wherein the media library includes a plurality of media items including a first media item and a second media item different from the first media item; while displaying the representation of the media library, detecting, via the one or more input devices, a request to display the first media item; and in response to detecting the request to display the first media item: in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.

In some embodiments, a non-transitory computer-readable storage medium is disclosed. The non-transitory computer-readable storage medium stores one or more programs configured to be executed by one or more processors of a computer system that is in communication with one or more display generation components and one or more inputs devices, and the one or more programs include instructions for: displaying, via the one or more display generation components, a representation of a media library, wherein the media library includes a plurality of media items including a first media item and a second media item different from the first media item; while displaying the representation of the media library, detecting, via the one or more input devices, a request to display the first media item; and in response to detecting the request to display the first media item: in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.

In some embodiments, a transitory computer-readable storage medium is disclosed. The transitory computer-readable storage medium stores one or more programs configured to be executed by one or more processors of a computer system that is in communication with one or more display generation components and one or more inputs devices, and the one or more programs include instructions for: displaying, via the one or more display generation components, a representation of a media library, wherein the media library includes a plurality of media items including a first media item and a second media item different from the first media item; while displaying the representation of the media library, detecting, via the one or more input devices, a request to display the first media item; and in response to detecting the request to display the first media item: in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: displaying, via the one or more display generation components, a representation of a media library, wherein the media library includes a plurality of media items including a first media item and a second media item different from the first media item; while displaying the representation of the media library, detecting, via the one or more input devices, a request to display the first media item; and in response to detecting the request to display the first media item: in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.

In some embodiments, a computer system is disclosed. The computer system is configured to communicate with one or more display generation components and one or more input devices, and comprises: means for displaying, via the one or more display generation components, a representation of a media library, wherein the media library includes a plurality of media items including a first media item and a second media item different from the first media item; means for, while displaying the representation of the media library, detecting, via the one or more input devices, a request to display the first media item; and means for, in response to detecting the request to display the first media item: in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.

In some embodiments, a computer program product is disclosed. The computer program product comprises one or more programs configured to be executed by one or more processors of a computer system that is in communication with one or more display generation components and one or more input devices, and the one or more programs include instructions for: displaying, via the one or more display generation components, a representation of a media library, wherein the media library includes a plurality of media items including a first media item and a second media item different from the first media item; while displaying the representation of the media library, detecting, via the one or more input devices, a request to display the first media item; and in response to detecting the request to display the first media item: in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.

In some embodiments, a method is disclosed. The method comprises: at a computer system that is in communication with one or more display generation components and one or more input devices: detecting, via the one or more input devices, a sequence of one or more inputs corresponding to a request to display a portion of a media library that is associated with a user account; and in response to detecting, via the one or more input devices, the sequence of one or more inputs corresponding to the request to display the portion of the media library, concurrently displaying, via the one or more display generation components: a representation of a portion of a media library, wherein the media library includes a plurality of media items including a first media item and a second media item different from the first media item; and a user profile indication corresponding to the user account, wherein displaying the user profile indication corresponding to the user account includes, in accordance with a determination that an ongoing process is occurring with respect to the media library, displaying the user profile indication with a first indicator that indicates a progress of the ongoing process and that updates as the ongoing process progresses.

In some embodiments, a non-transitory computer-readable storage medium is disclosed. The non-transitory computer-readable storage medium stores one or more programs configured to be executed by one or more processors of a computer system that is in communication with one or more display generation components and one or more inputs devices, and the one or more programs include instructions for: detecting, via the one or more input devices, a sequence of one or more inputs corresponding to a request to display a portion of a media library that is associated with a user account; and in response to detecting, via the one or more input devices, the sequence of one or more inputs corresponding to the request to display the portion of the media library, concurrently displaying, via the one or more display generation components: a representation of a portion of a media library, wherein the media library includes a plurality of media items including a first media item and a second media item different from the first media item; and a user profile indication corresponding to the user account, wherein displaying the user profile indication corresponding to the user account includes, in accordance with a determination that an ongoing process is occurring with respect to the media library, displaying the user profile indication with a first indicator that indicates a progress of the ongoing process and that updates as the ongoing process progresses.

In some embodiments, a transitory computer-readable storage medium is disclosed. The transitory computer-readable storage medium stores one or more programs configured to be executed by one or more processors of a computer system that is in communication with one or more display generation components and one or more inputs devices, and the one or more programs include instructions for: detecting, via the one or more input devices, a sequence of one or more inputs corresponding to a request to display a portion of a media library that is associated with a user account; and in response to detecting, via the one or more input devices, the sequence of one or more inputs corresponding to the request to display the portion of the media library, concurrently displaying, via the one or more display generation components: a representation of a portion of a media library, wherein the media library includes a plurality of media items including a first media item and a second media item different from the first media item; and a user profile indication corresponding to the user account, wherein displaying the user profile indication corresponding to the user account includes, in accordance with a determination that an ongoing process is occurring with respect to the media library, displaying the user profile indication with a first indicator that indicates a progress of the ongoing process and that updates as the ongoing process progresses.

In some embodiments, a computer system is disclosed. The computer system is configured to communicate with one or more display generation components and one or more input devices, and comprises: one or more processors; and memory storing one or more programs configured to be executed by the one or more processors, the one or more programs including instructions for: detecting, via the one or more input devices, a sequence of one or more inputs corresponding to a request to display a portion of a media library that is associated with a user account; and in response to detecting, via the one or more input devices, the sequence of one or more inputs corresponding to the request to display the portion of the media library, concurrently displaying, via the one or more display generation components: a representation of a portion of a media library, wherein the media library includes a plurality of media items including a first media item and a second media item different from the first media item; and a user profile indication corresponding to the user account, wherein displaying the user profile indication corresponding to the user account includes, in accordance with a determination that an ongoing process is occurring with respect to the media library, displaying the user profile indication with a first indicator that indicates a progress of the ongoing process and that updates as the ongoing process progresses.

In some embodiments, a computer system is disclosed. The computer system is configured to communicate with one or more display generation components and one or more input devices, and comprises: means for detecting, via the one or more input devices, a sequence of one or more inputs corresponding to a request to display a portion of a media library that is associated with a user account; and means for, in response to detecting, via the one or more input devices, the sequence of one or more inputs corresponding to the request to display the portion of the media library, concurrently displaying, via the one or more display generation components: a representation of a portion of a media library, wherein the media library includes a plurality of media items including a first media item and a second media item different from the first media item; and a user profile indication corresponding to the user account, wherein displaying the user profile indication corresponding to the user account includes, in accordance with a determination that an ongoing process is occurring with respect to the media library, displaying the user profile indication with a first indicator that indicates a progress of the ongoing process and that updates as the ongoing process progresses.

In some embodiments, a computer program product is disclosed. The computer program product comprises one or more programs configured to be executed by one or more processors of a computer system that is in communication with one or more display generation components and one or more input devices, and the one or more programs include instructions for: detecting, via the one or more input devices, a sequence of one or more inputs corresponding to a request to display a portion of a media library that is associated with a user account; and in response to detecting, via the one or more input devices, the sequence of one or more inputs corresponding to the request to display the portion of the media library, concurrently displaying, via the one or more display generation components: a representation of a portion of a media library, wherein the media library includes a plurality of media items including a first media item and a second media item different from the first media item; and a user profile indication corresponding to the user account, wherein displaying the user profile indication corresponding to the user account includes, in accordance with a determination that an ongoing process is occurring with respect to the media library, displaying the user profile indication with a first indicator that indicates a progress of the ongoing process and that updates as the ongoing process progresses.

Executable instructions for performing these functions are, optionally, included in a non-transitory computer-readable storage medium or other computer program product configured for execution by one or more processors. Executable instructions for performing these functions are, optionally, included in a transitory computer-readable storage medium or other computer program product configured for execution by one or more processors.

Thus, devices are provided with faster, more efficient methods and interfaces for navigating, displaying, and/or presenting content, thereby increasing the effectiveness, efficiency, and user satisfaction with such devices. Such methods and interfaces may complement or replace other methods for navigating, displaying, and/or presenting content.

### DESCRIPTION OF THE FIGURES

For a better understanding of the various described embodiments, reference should be made to the Description of Embodiments below, in conjunction with the following drawings in which like reference numerals refer to corresponding parts throughout the figures.

FIG. 1A is a block diagram illustrating a portable multifunction device with a touch-sensitive display in accordance with some embodiments.

FIG. 1B is a block diagram illustrating exemplary components for event handling in accordance with some embodiments.

FIG. 2 illustrates a portable multifunction device having a touch screen in accordance with some embodiments.

FIG. 3A is a block diagram of an exemplary multifunction device with a display and a touch-sensitive surface in accordance with some embodiments.

FIGS. 3B-3G illustrate the use of Application Programming Interfaces (APIs) to perform operations.

FIG. 4A illustrates an exemplary user interface for a menu of applications on a portable multifunction device in accordance with some embodiments.

FIG. 4B illustrates an exemplary user interface for a multifunction device with a touch-sensitive surface that is separate from the display in accordance with some embodiments.

FIG. 5A illustrates a personal electronic device in accordance with some embodiments.

FIG. 5B is a block diagram illustrating a personal electronic device in accordance with some embodiments.

FIG. 5C is a block diagram illustrating an operating environment of a computer system for providing XR experiences in accordance with some embodiments.

FIGS. 5D-5R are examples of a computer system for providing XR experiences in the operating environment of FIG. 5C.

FIG. 5S is a block diagram illustrating a controller of a computer system that is configured to manage and coordinate a XR experience for the user in accordance with some embodiments.

FIG. 5T is a block diagram illustrating a display generation component of a computer system that is configured to provide a visual component of the XR experience to the user in accordance with some embodiments.

FIG. 5U is a block diagram illustrating a hand tracking unit of a computer system that is configured to capture gesture inputs of the user in accordance with some embodiments.

FIG. 5V is a block diagram illustrating an eye tracking unit of a computer system that is configured to capture gaze inputs of the user in accordance with some embodiments.

FIG. 5W is a flow diagram illustrating a glint-assisted gaze tracking pipeline in accordance with some embodiments.

FIGS. 6A-1-6AJ illustrate exemplary devices and user interfaces for navigating, displaying, and/or presenting content in accordance with some embodiments.

FIG. 7 is a flow diagram illustrating methods of navigating, displaying, and/or providing content in accordance with some embodiments.

FIGS. 8A-8B are a flow diagram illustrating methods of navigating, displaying, and/or providing content in accordance with some embodiments.

FIGS. 9A-9Z illustrate exemplary devices and user interfaces for navigating, displaying, and/or presenting content in accordance with some embodiments.

FIG. 10 is a flow diagram illustrating methods of navigating, displaying, and/or providing content in accordance with some embodiments.

FIG. 11 is a flow diagram illustrating methods of navigating, displaying, and/or providing content in accordance with some embodiments.

FIGS. 12A-1-12AU illustrate exemplary devices and user interfaces for navigating, generating, and/or presenting content in accordance with some embodiments.

FIG. 13 is a flow diagram illustrating methods of generating and/or presenting content in accordance with some embodiments.

FIG. 14 is a flow diagram illustrating methods of generating and/or presenting content in accordance with some embodiments.

FIGS. 15A-15V-2 illustrate exemplary devices and user interfaces for displaying and/or providing content in accordance with some embodiments.

FIG. 16 is a flow diagram illustrating methods of displaying and/or providing content in accordance with some embodiments.

FIGS. 17A-17P illustrate exemplary devices and user interfaces for displaying and/or providing content in accordance with some embodiments.

FIG. 18 is a flow diagram illustrating methods of displaying and/or providing content in accordance with some embodiments.

### DESCRIPTION OF EMBODIMENTS

The following description sets forth exemplary methods, parameters, and the like. It should be recognized, however, that such description is not intended as a limitation on the scope of the present disclosure but is instead provided as a description of exemplary embodiments.

There is a need for electronic devices that provide efficient methods and interfaces for navigating, displaying, and/or presenting content. This is particularly true given the constantly increasing sizes of content libraries and/or media libraries that are available to users. Such techniques can reduce the cognitive burden on a user who is accessing and/or navigating content, thereby enhancing productivity. Further, such techniques can reduce processor and battery power otherwise wasted on redundant user inputs.

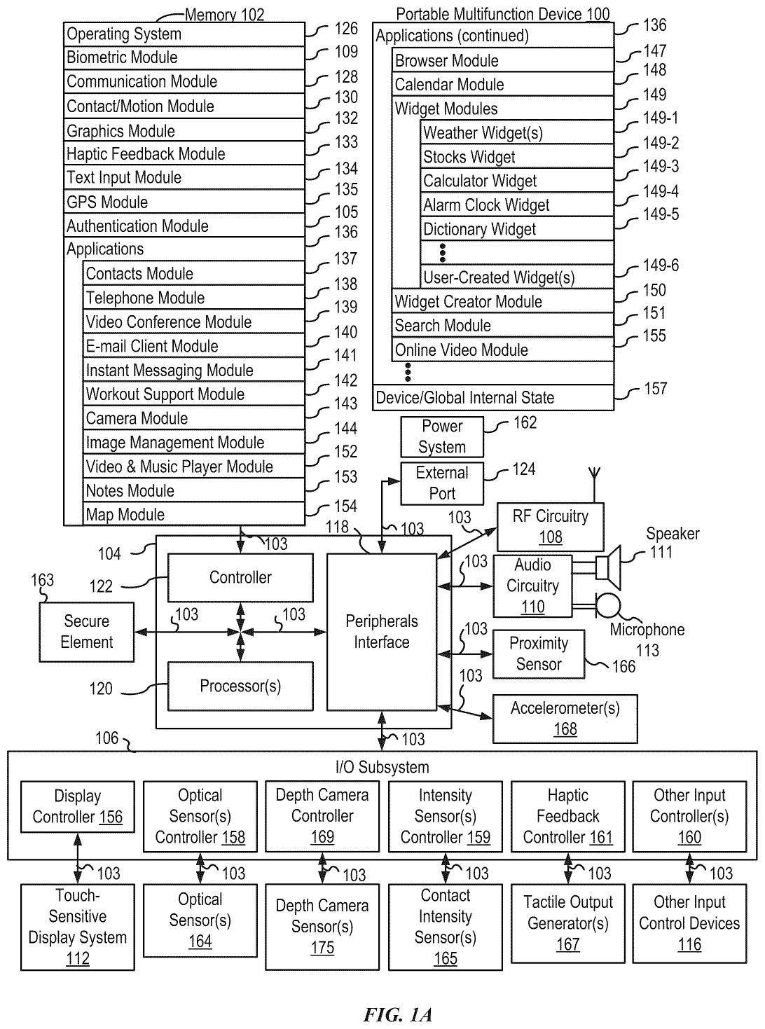

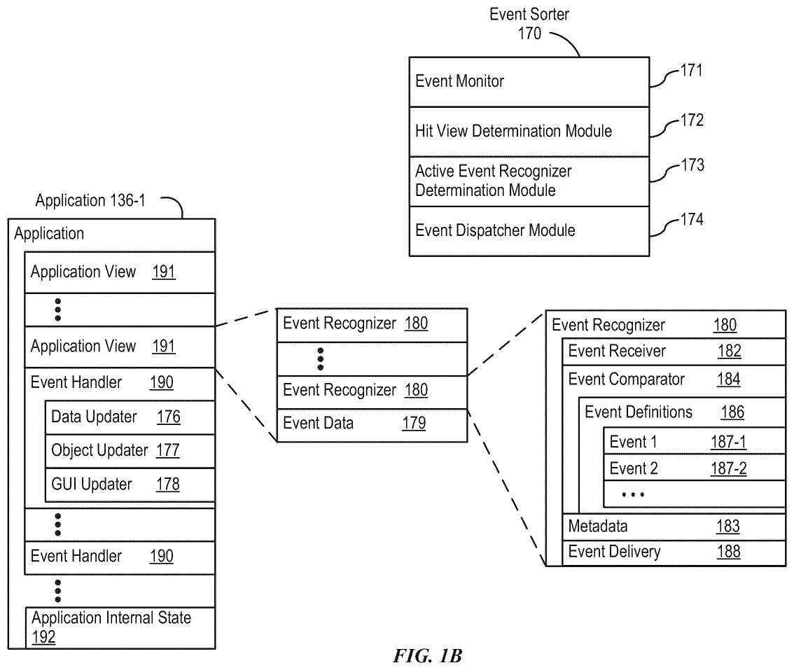

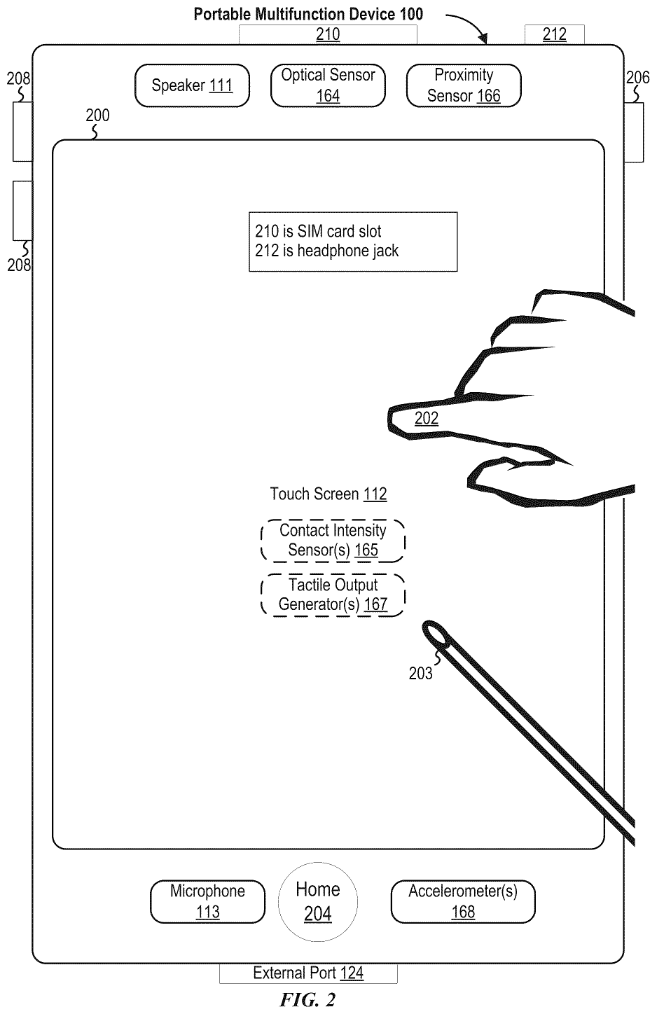

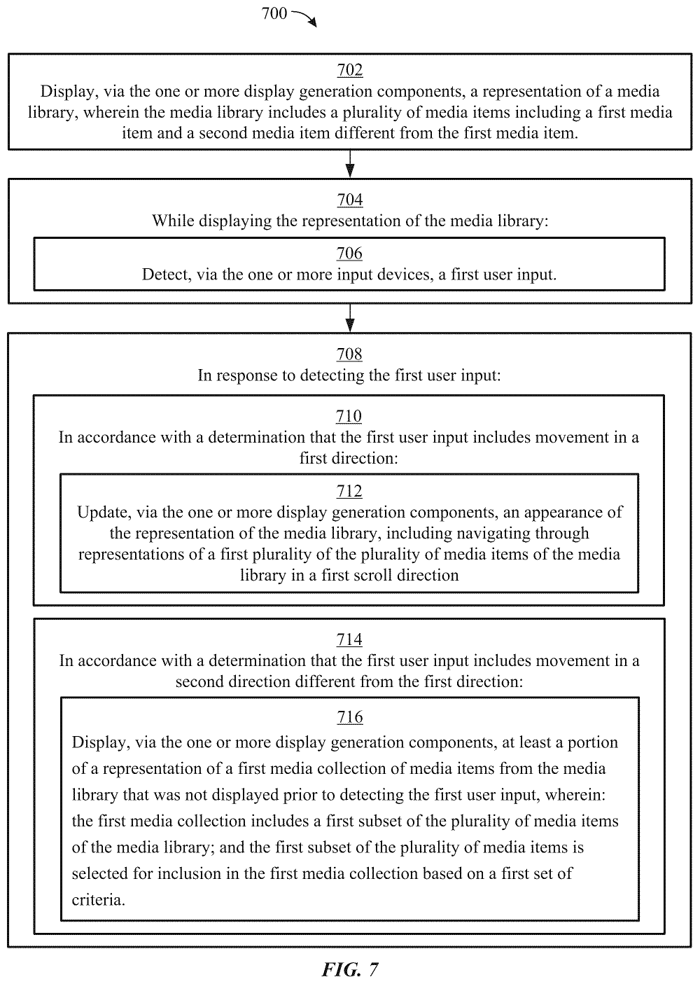

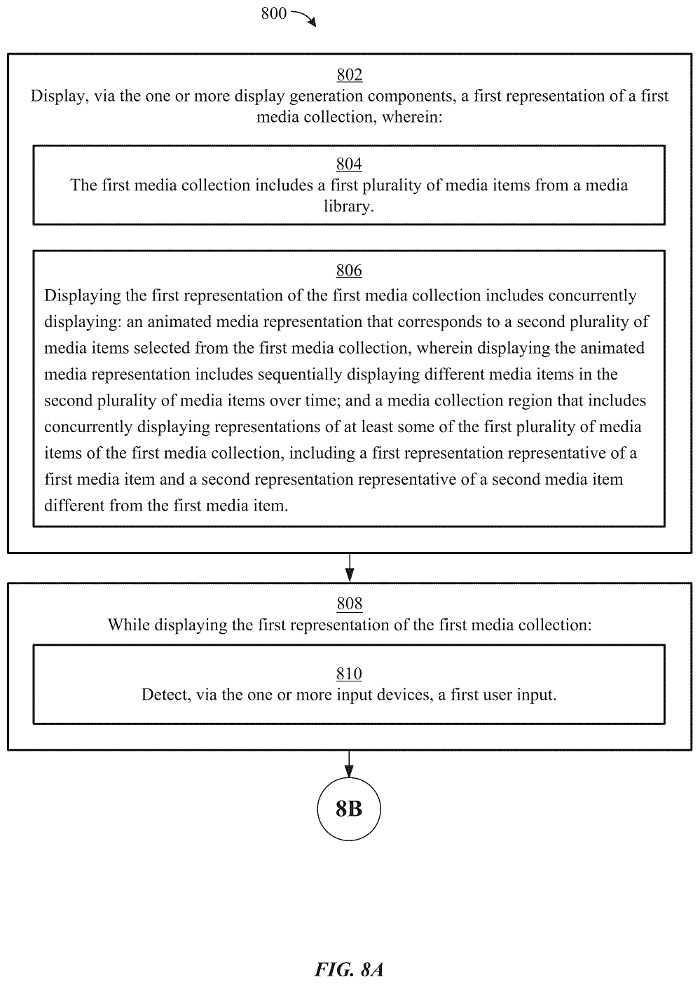

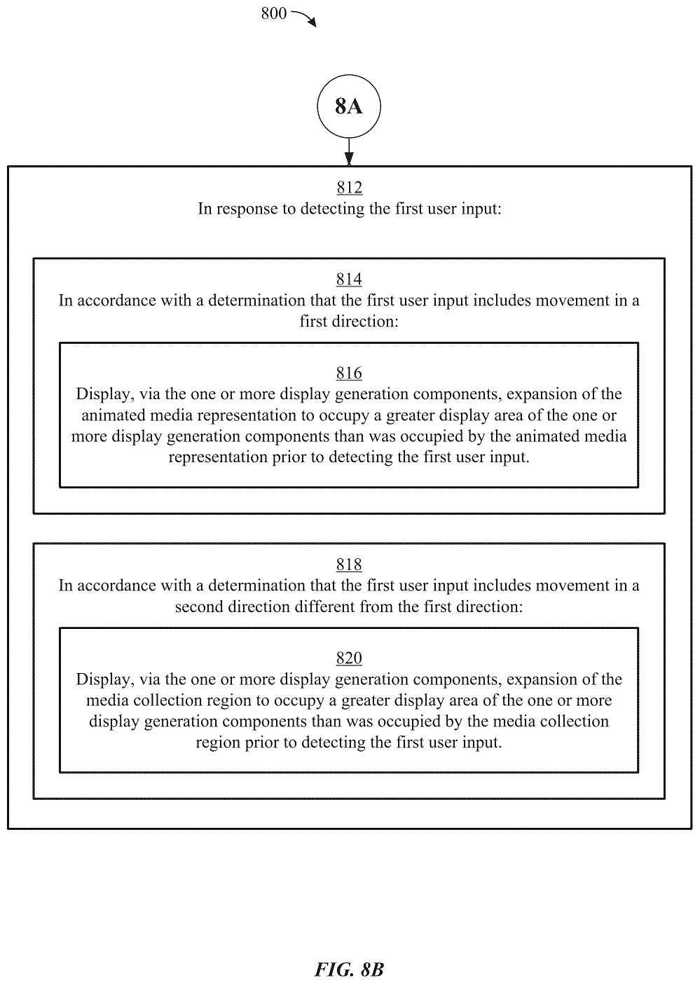

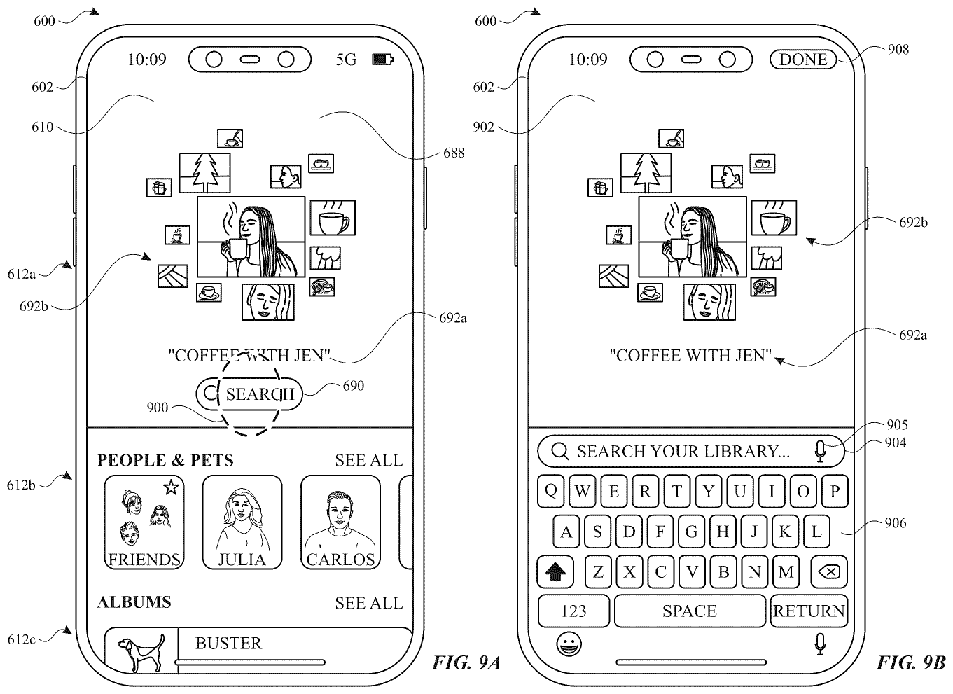

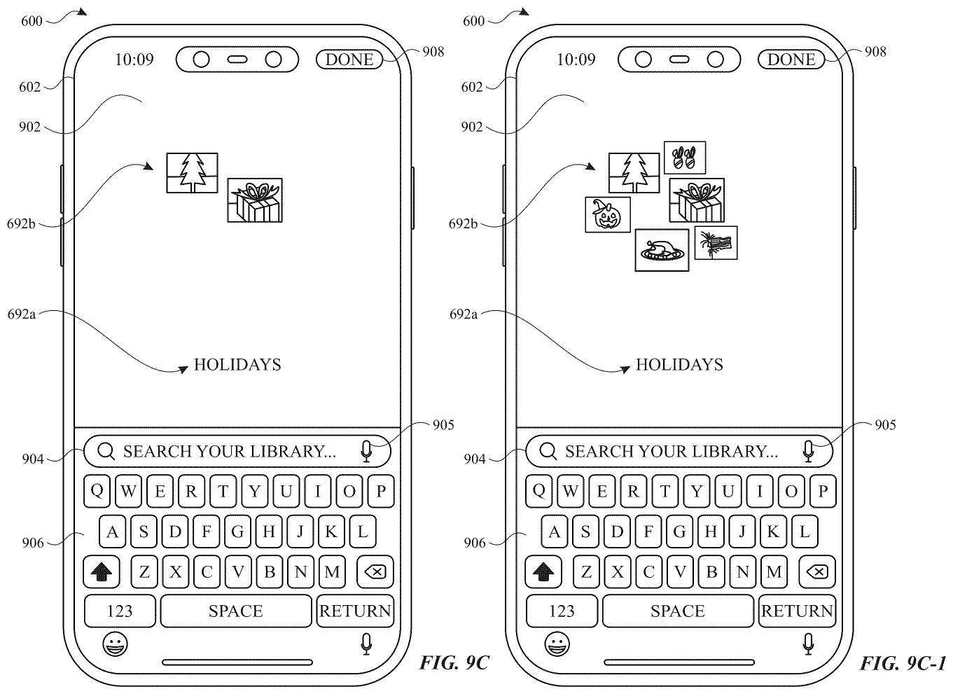

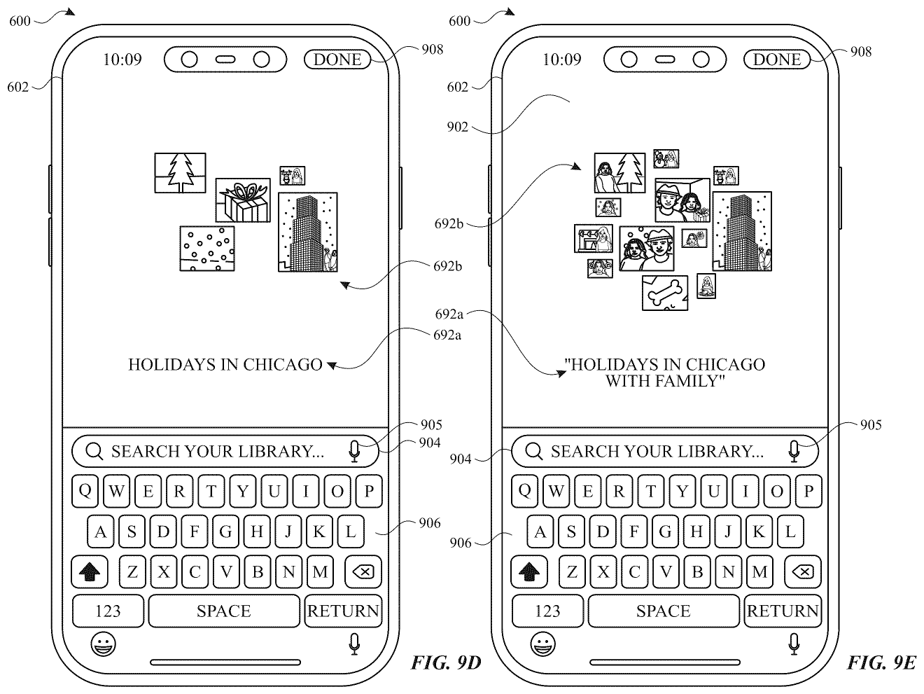

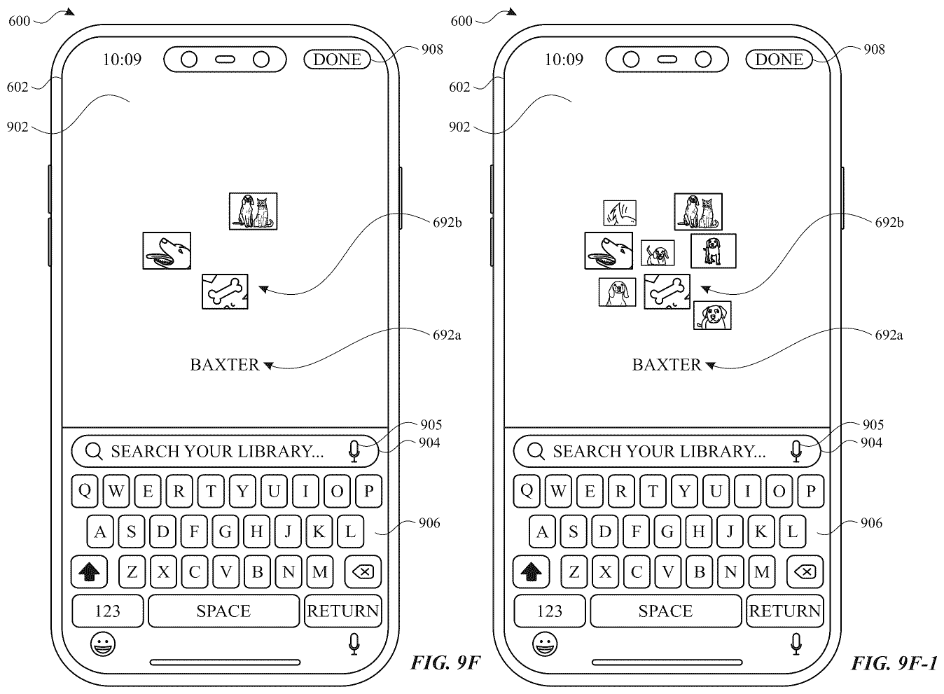

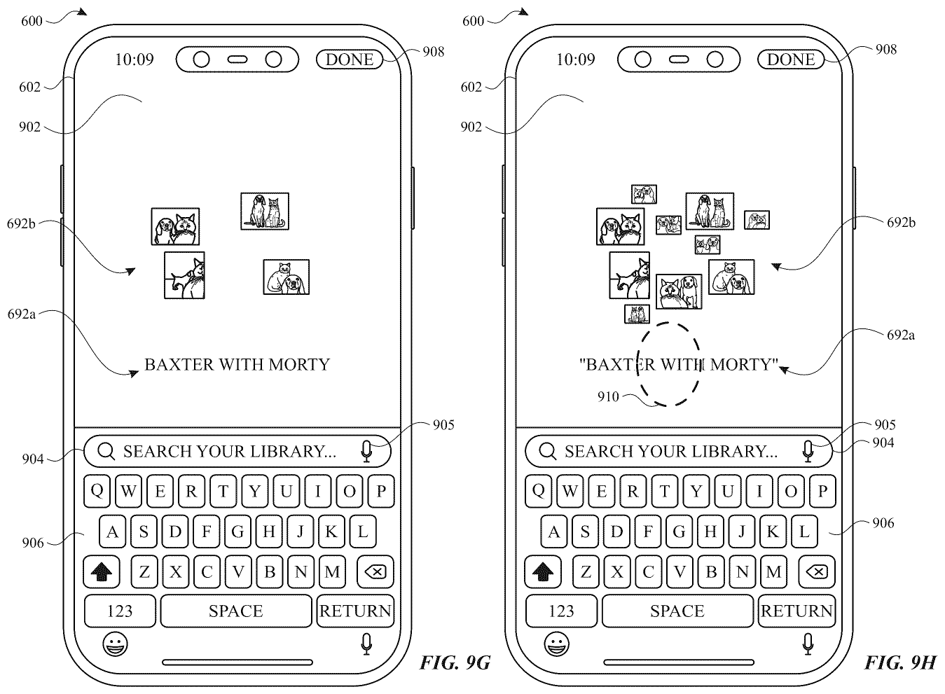

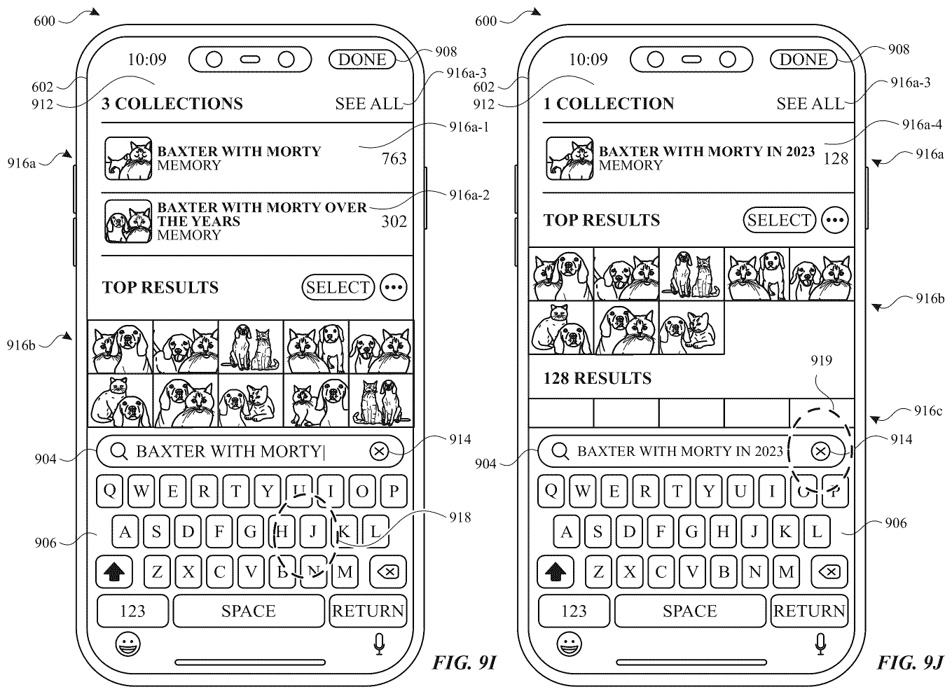

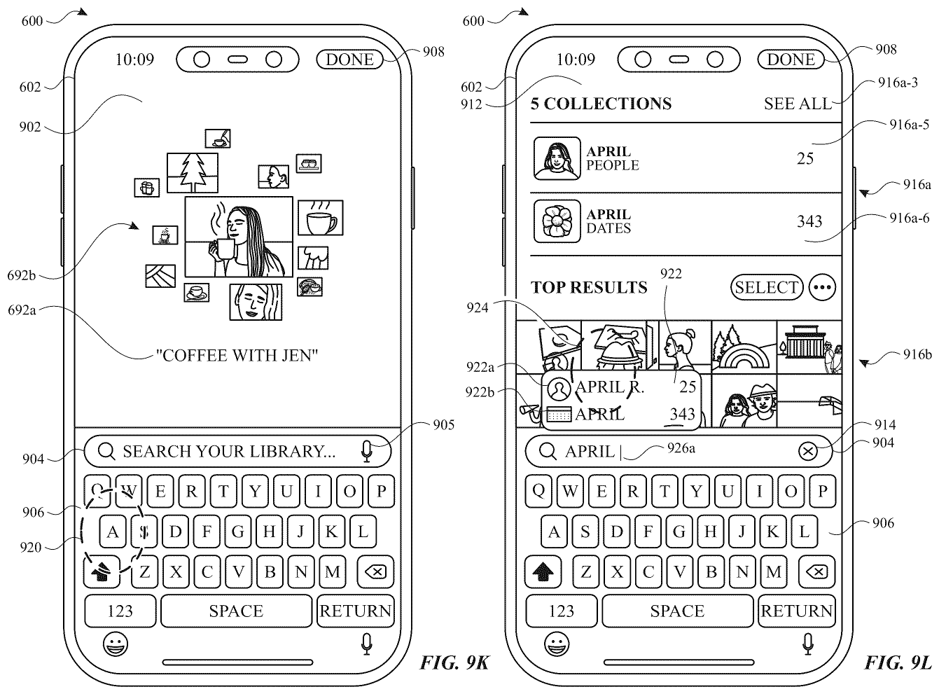

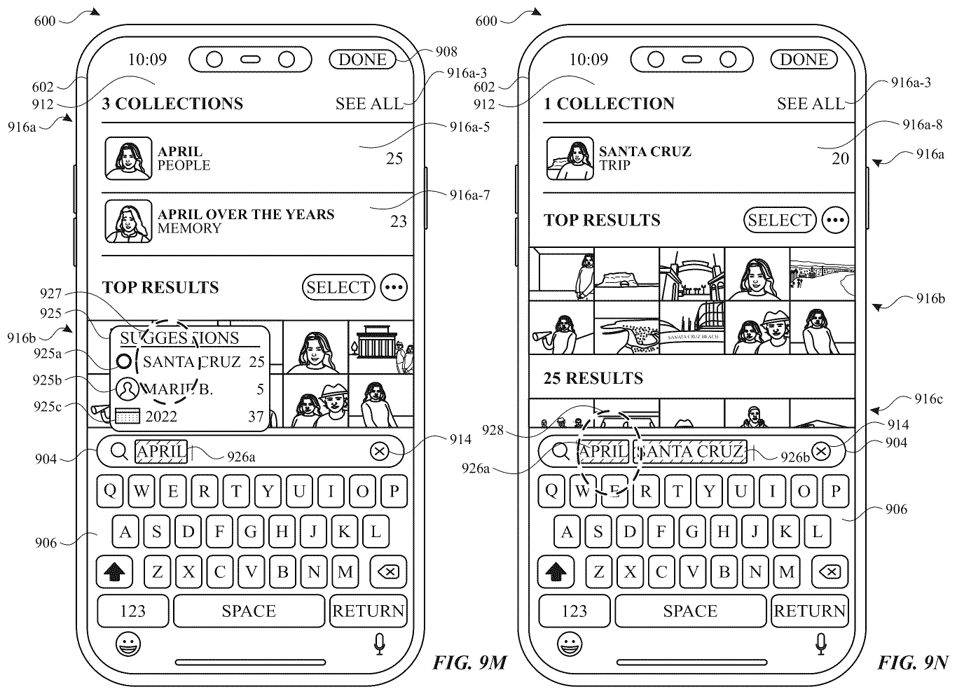

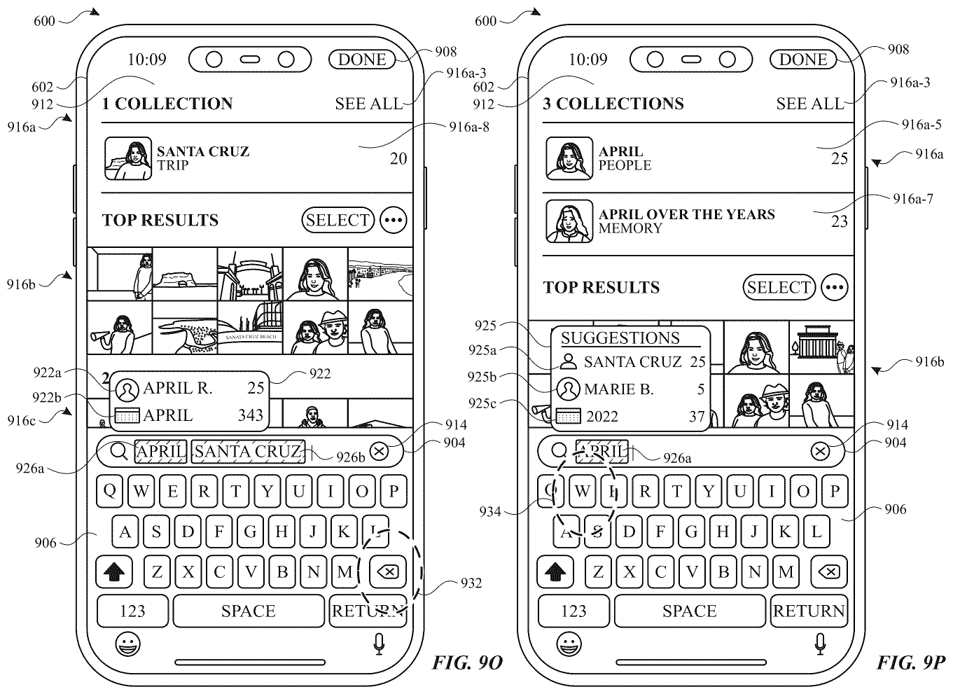

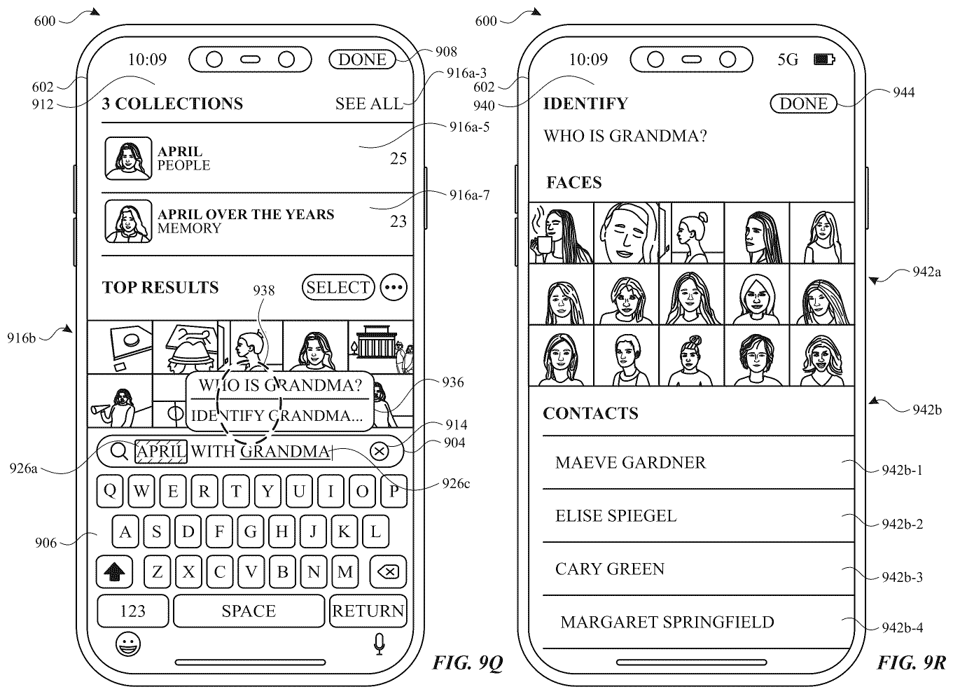

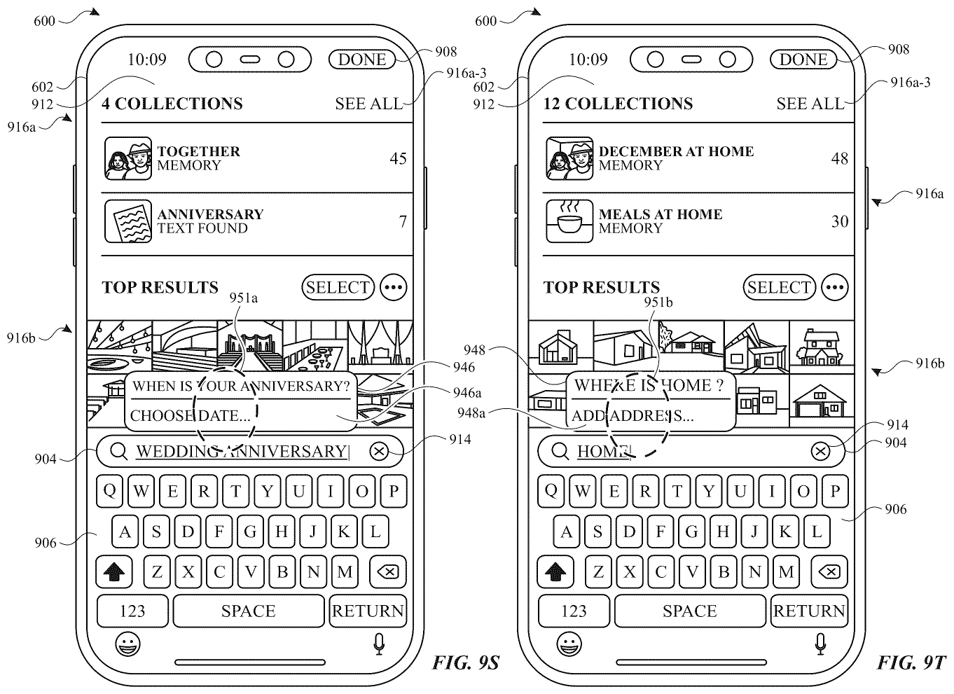

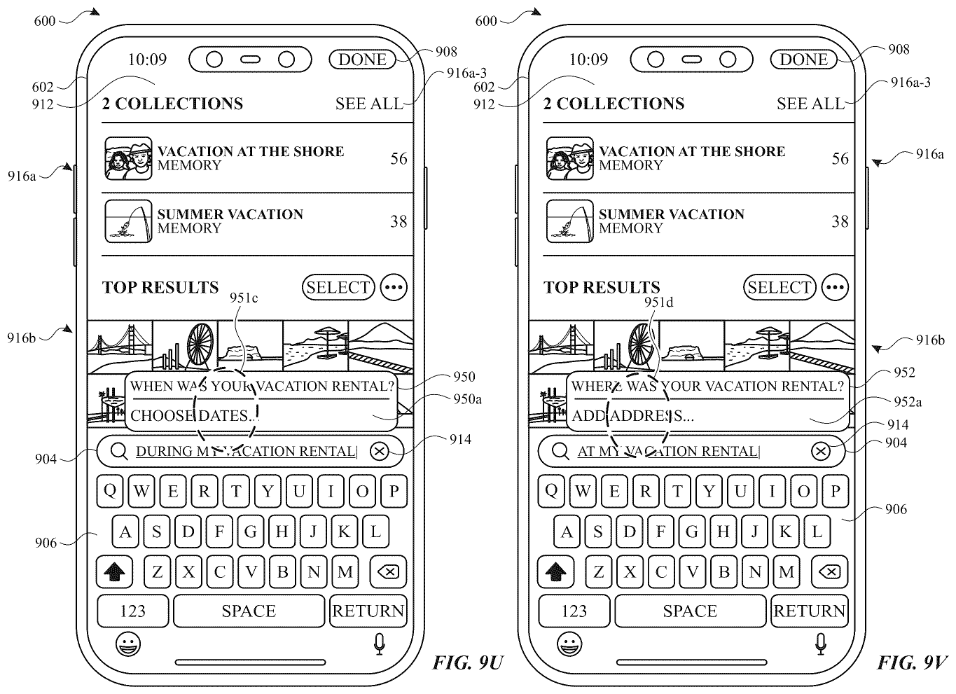

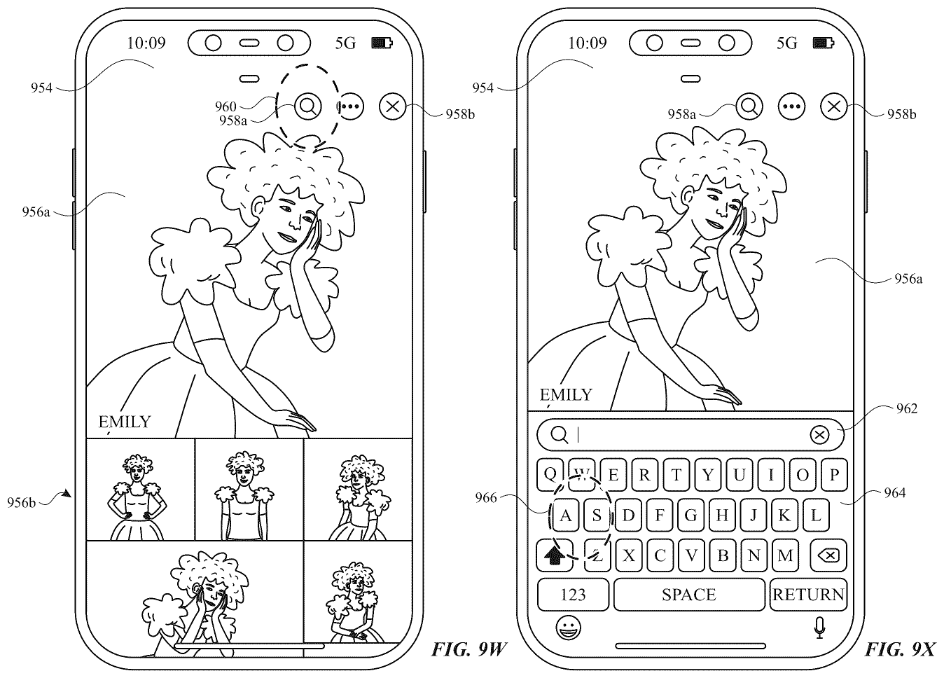

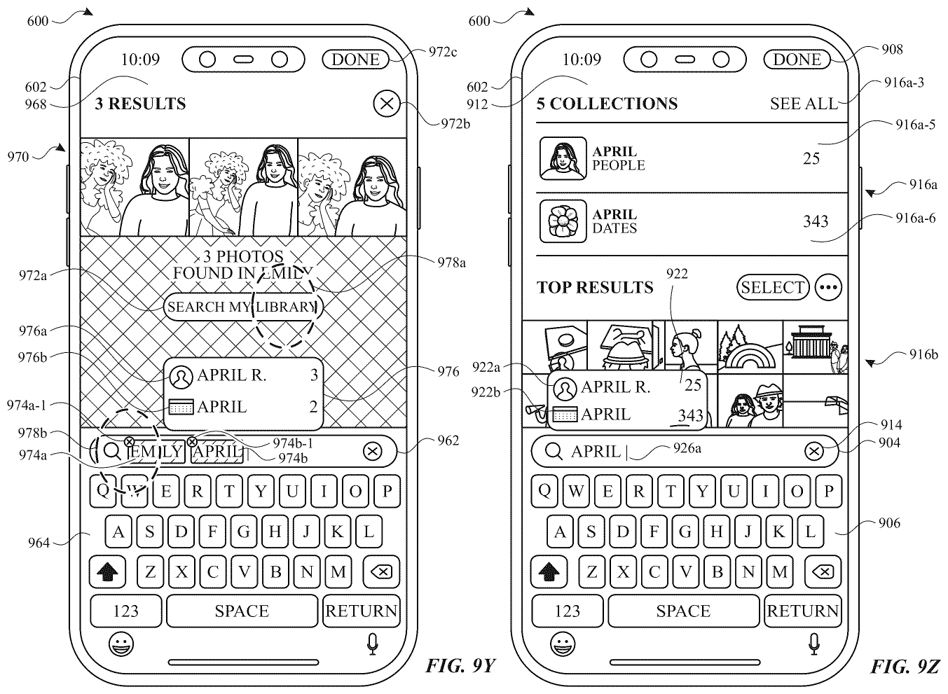

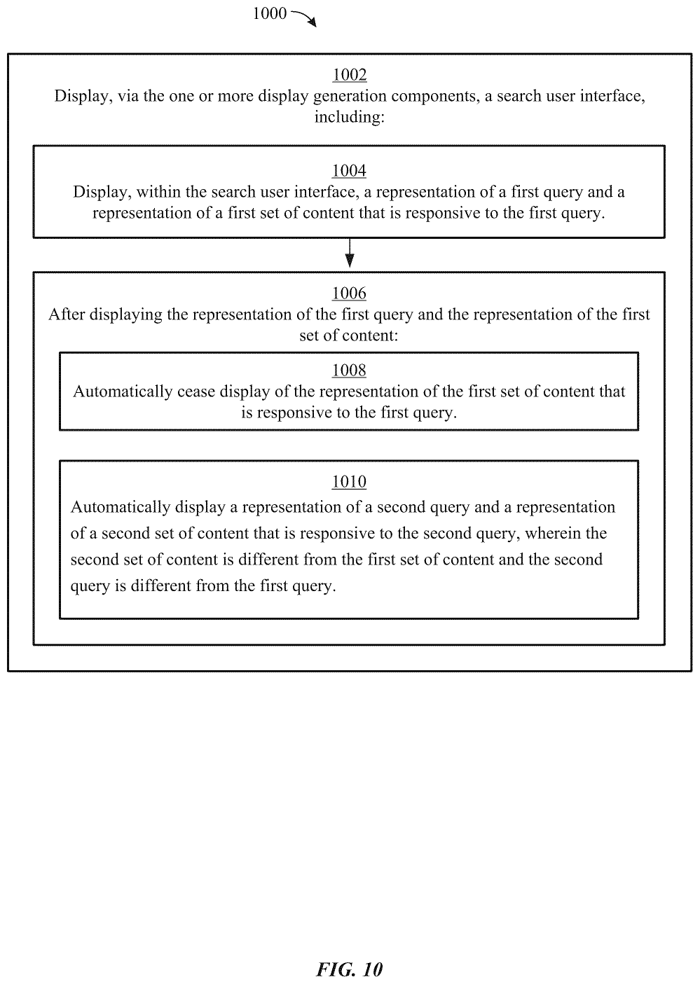

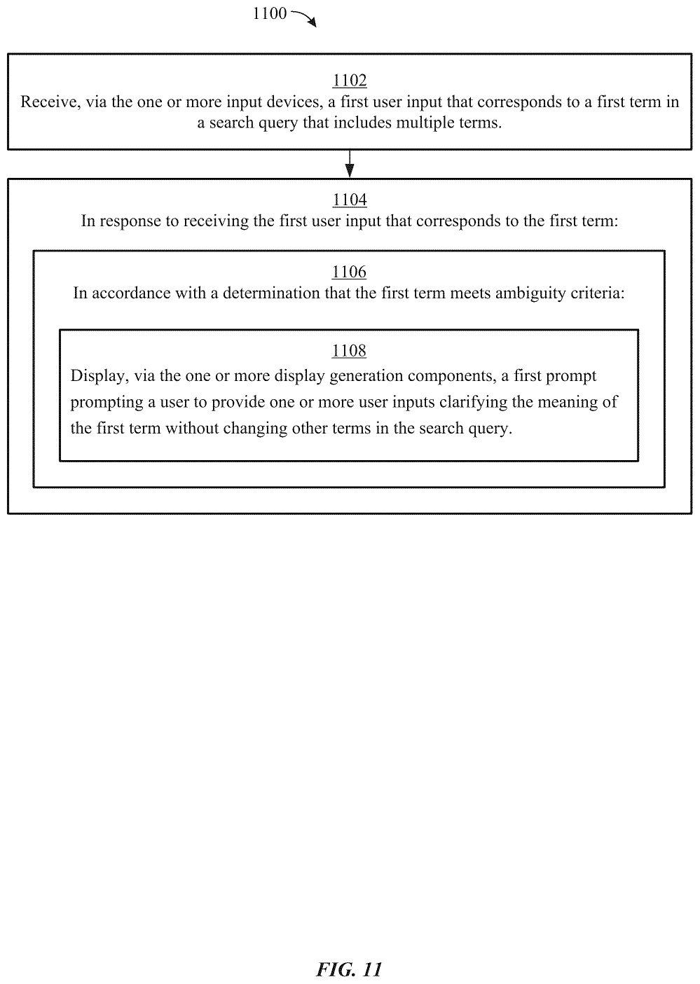

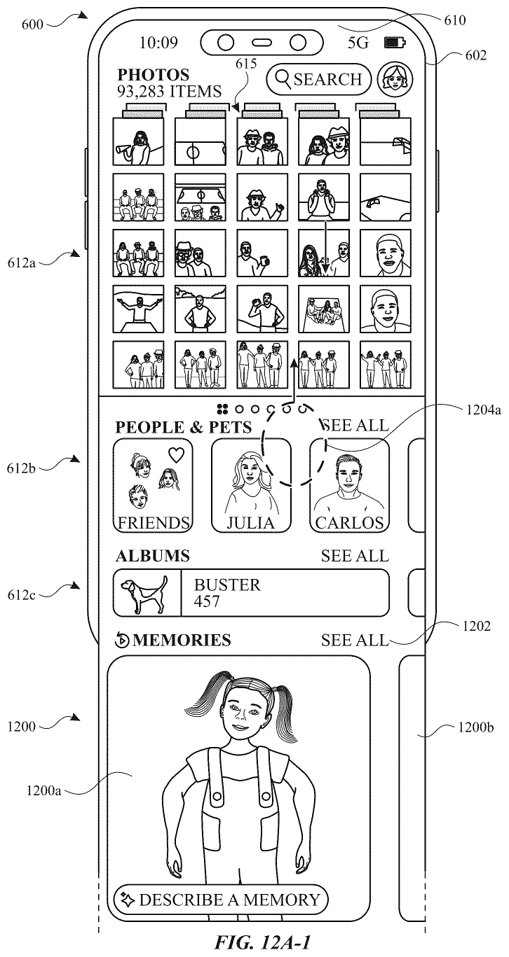

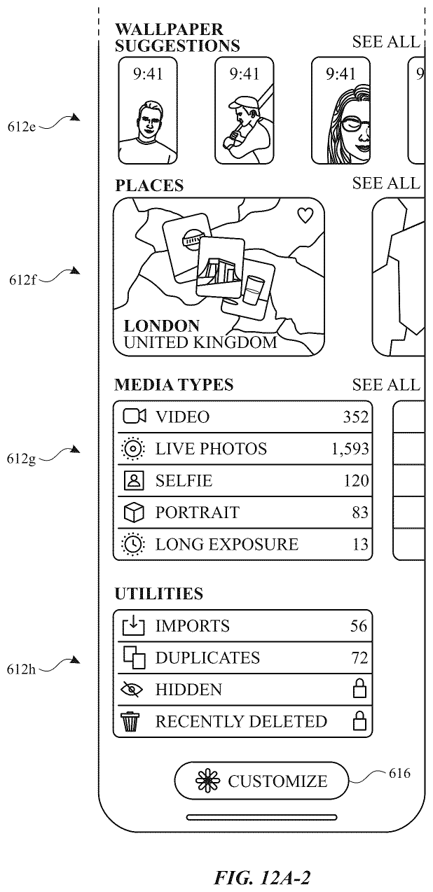

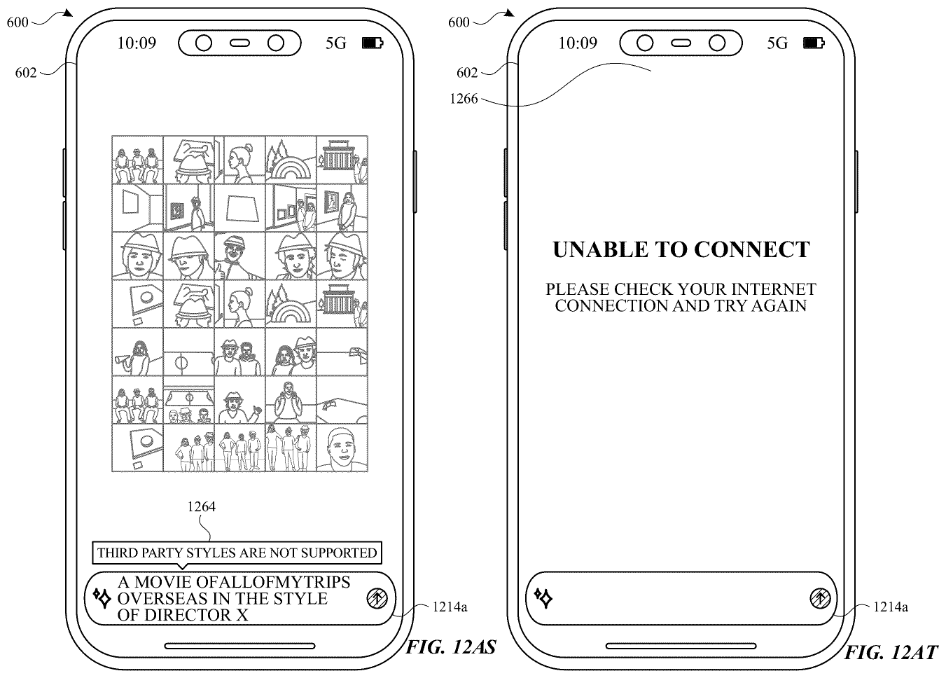

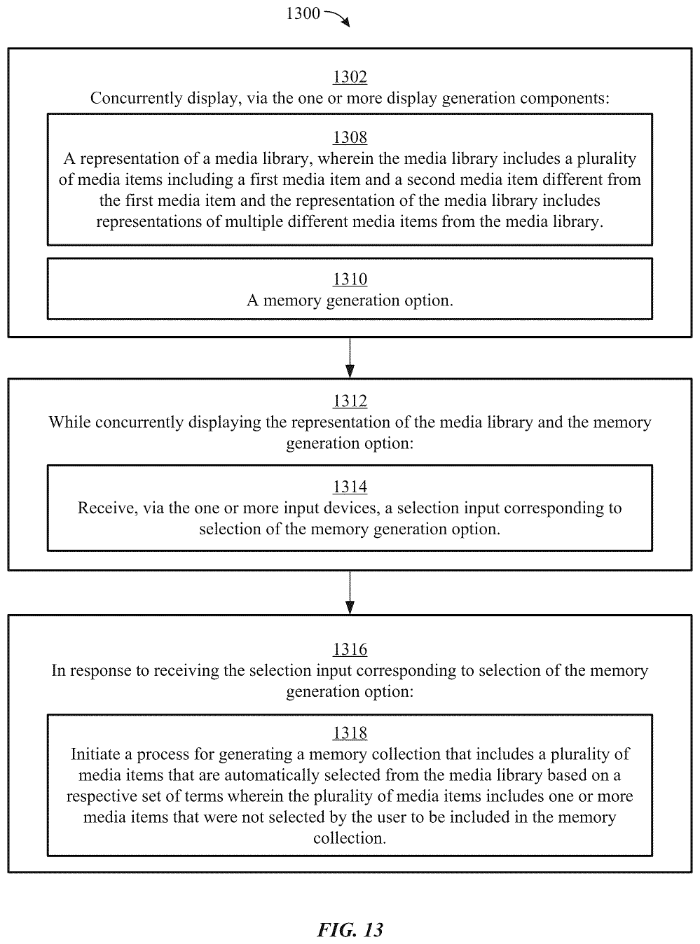

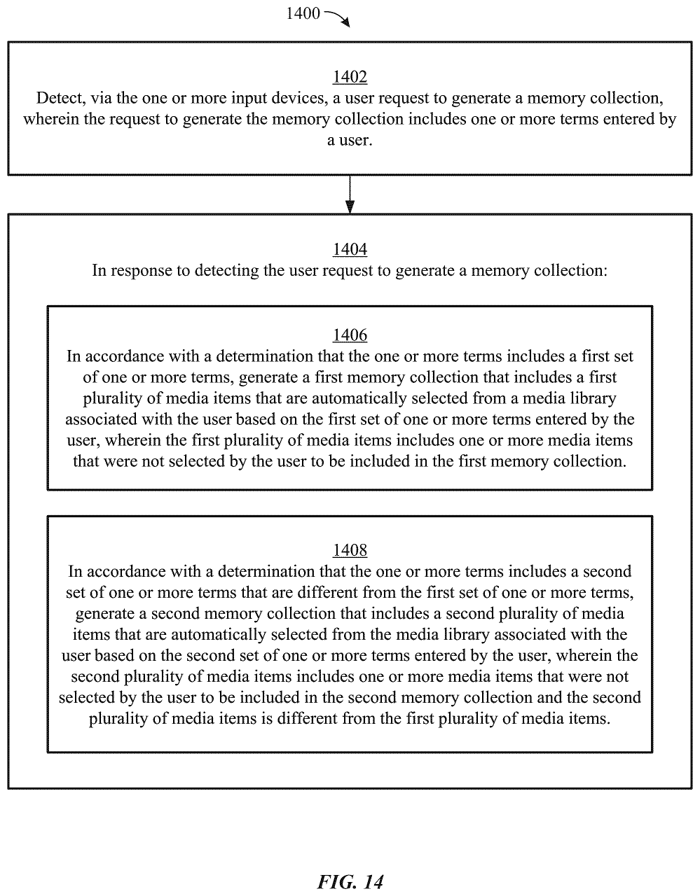

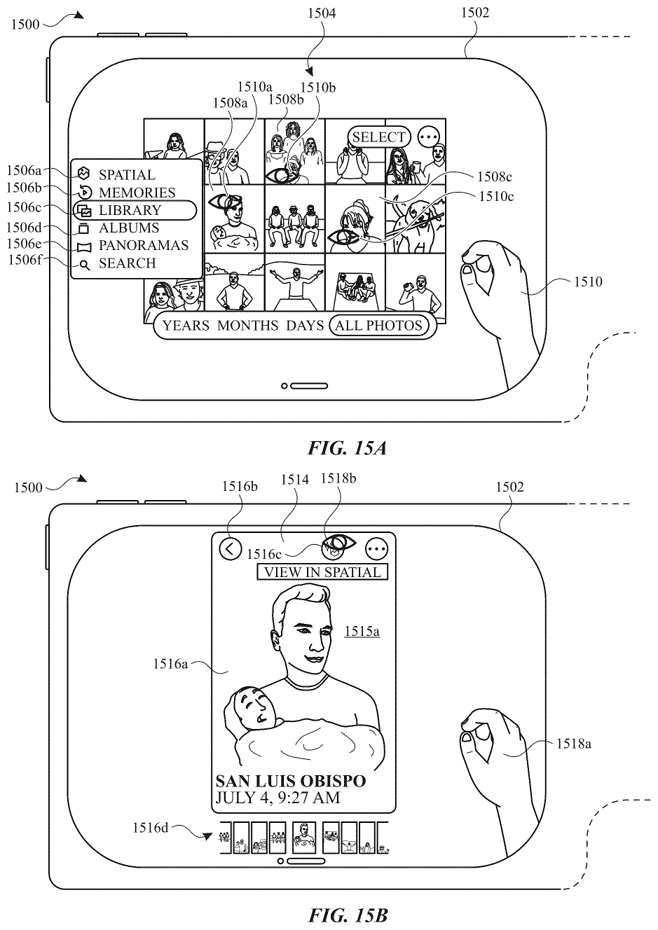

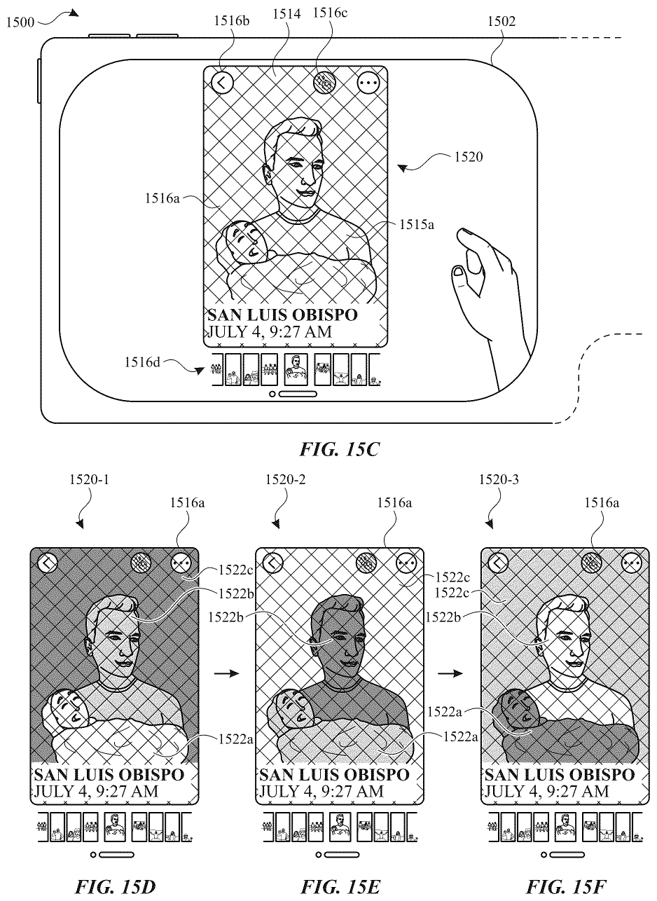

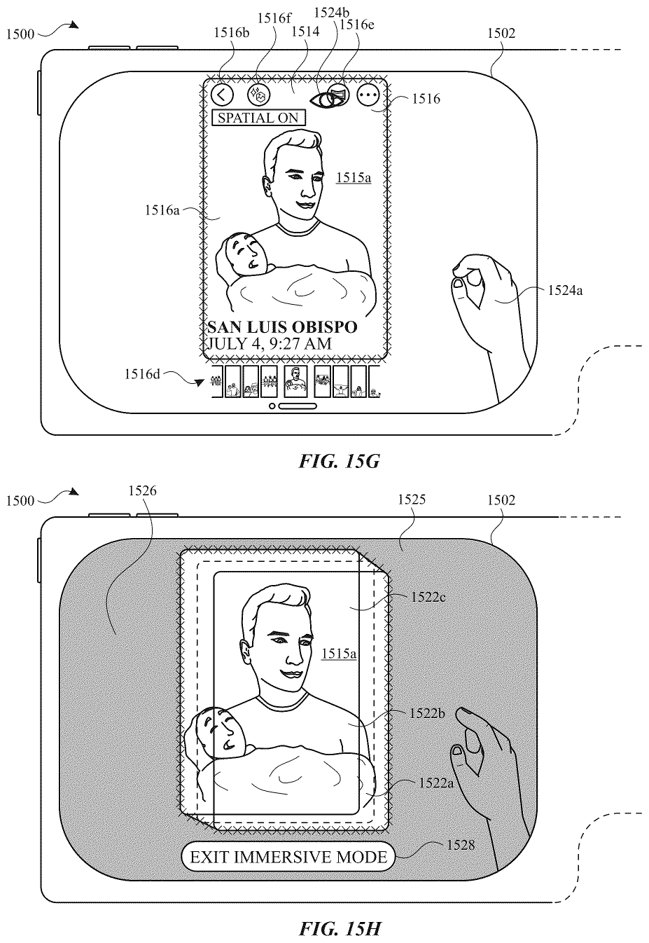

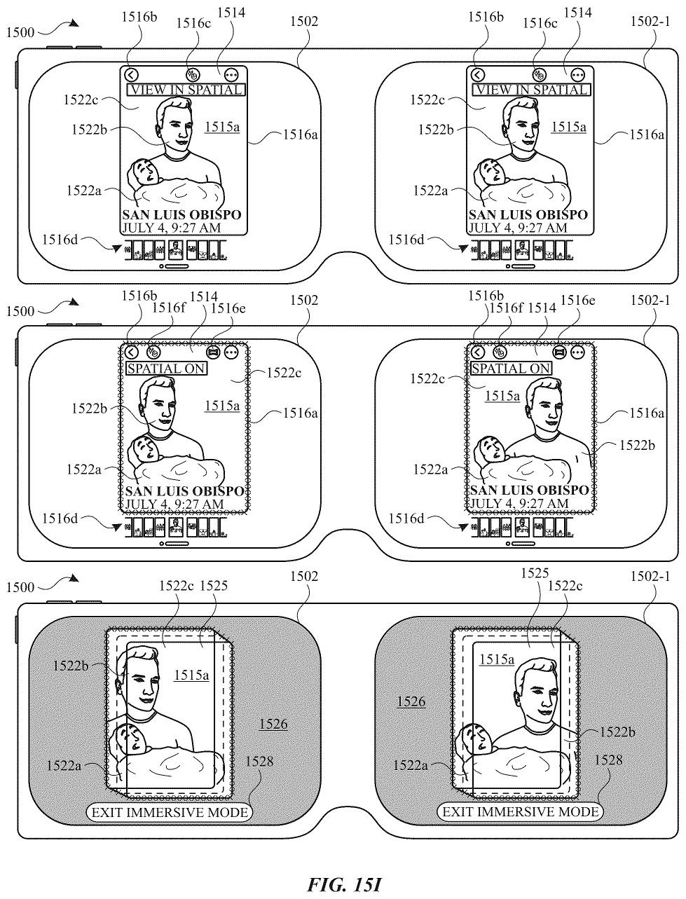

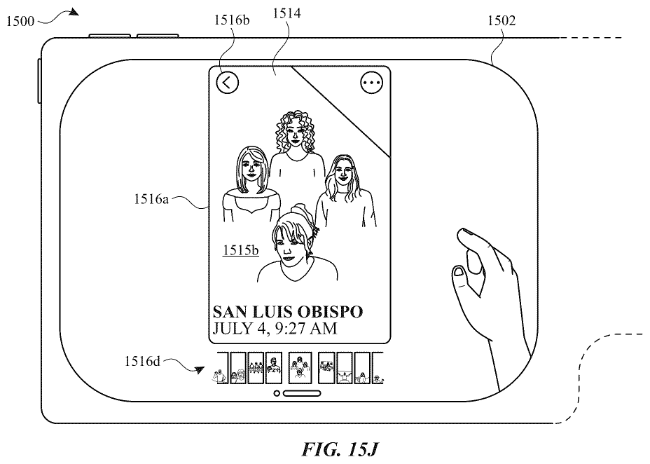

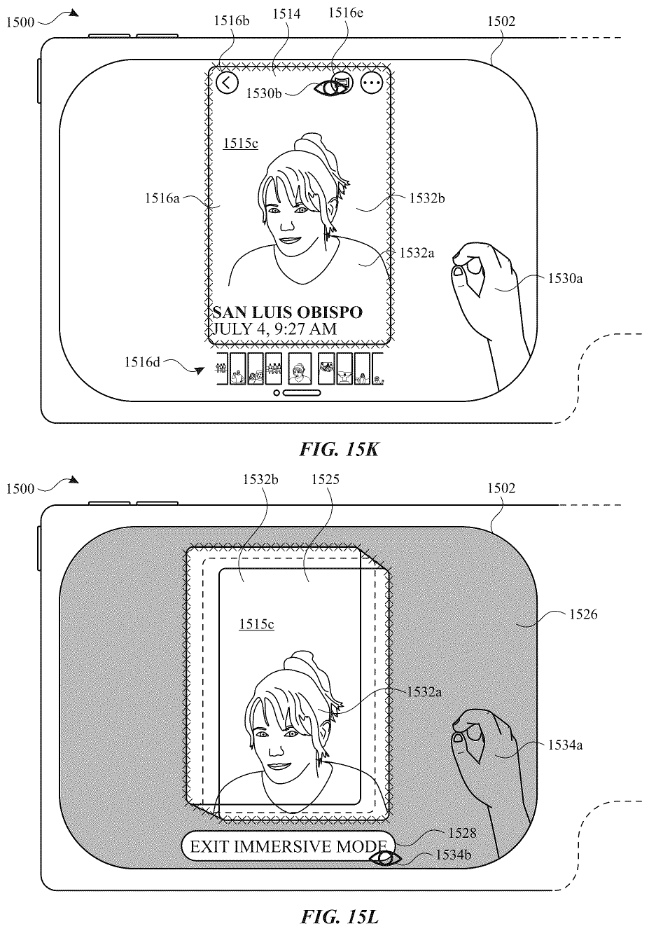

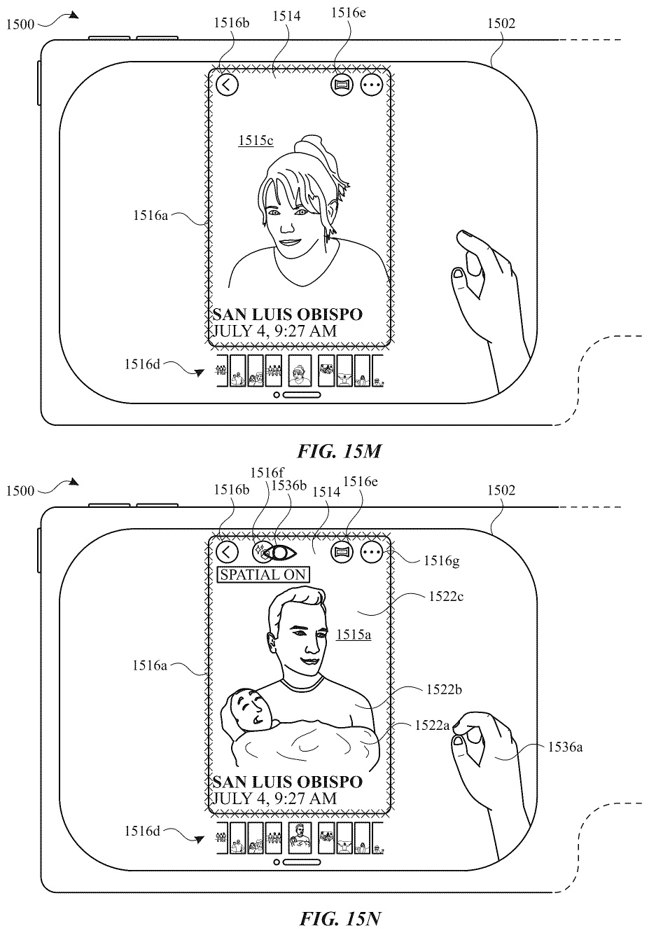

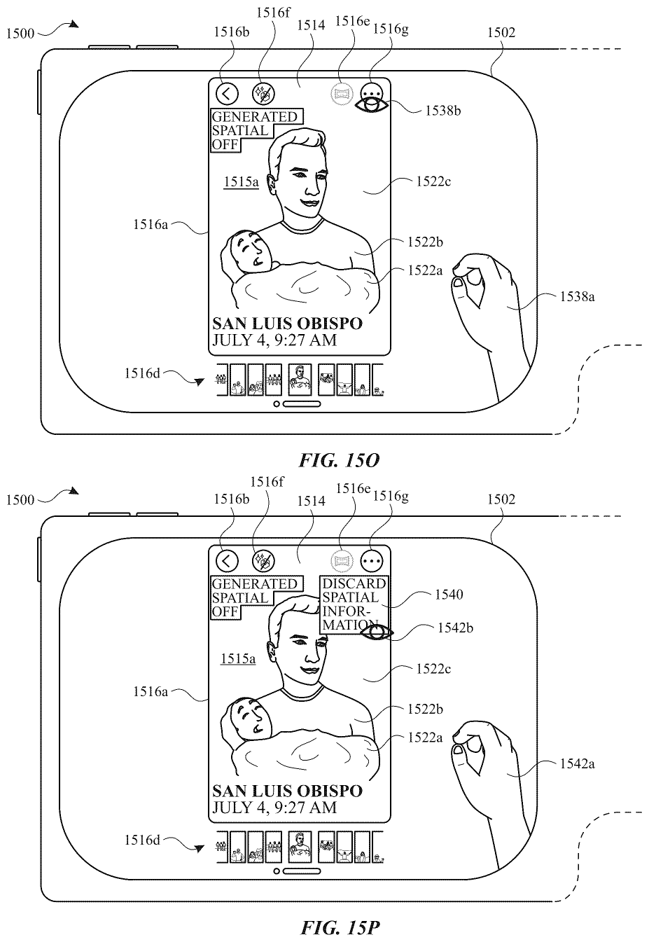

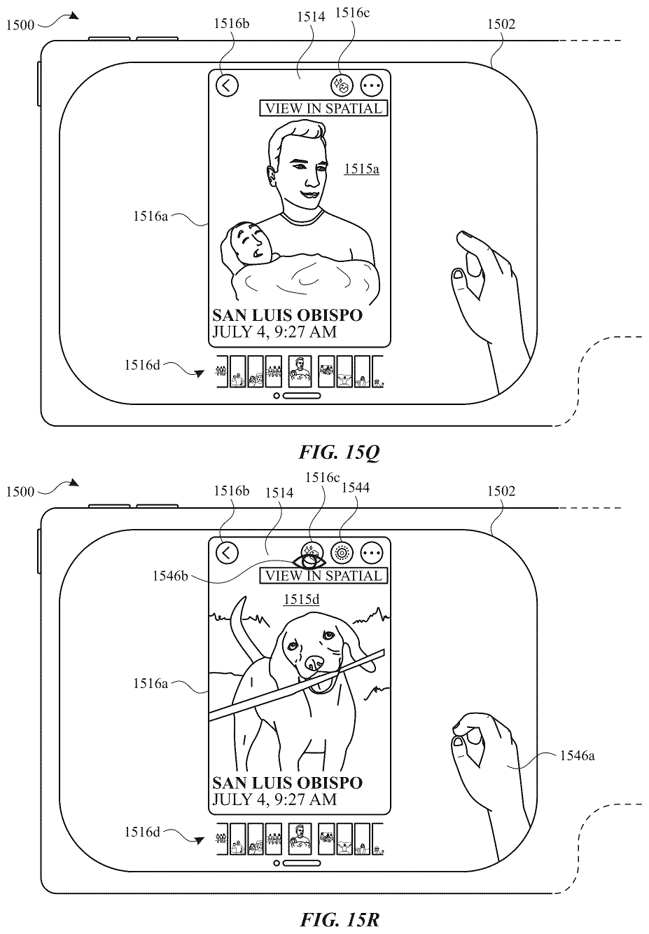

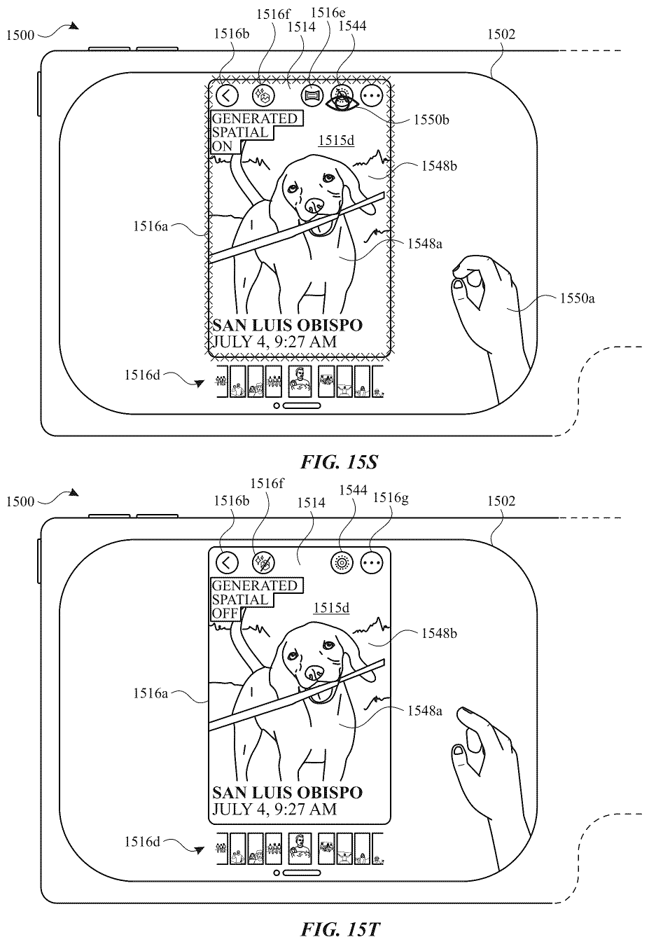

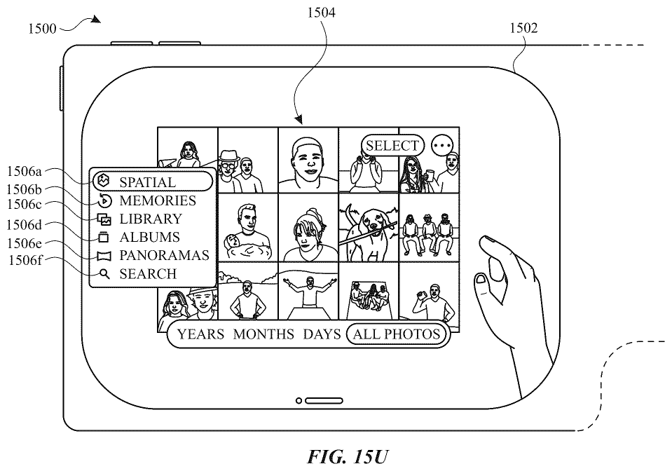

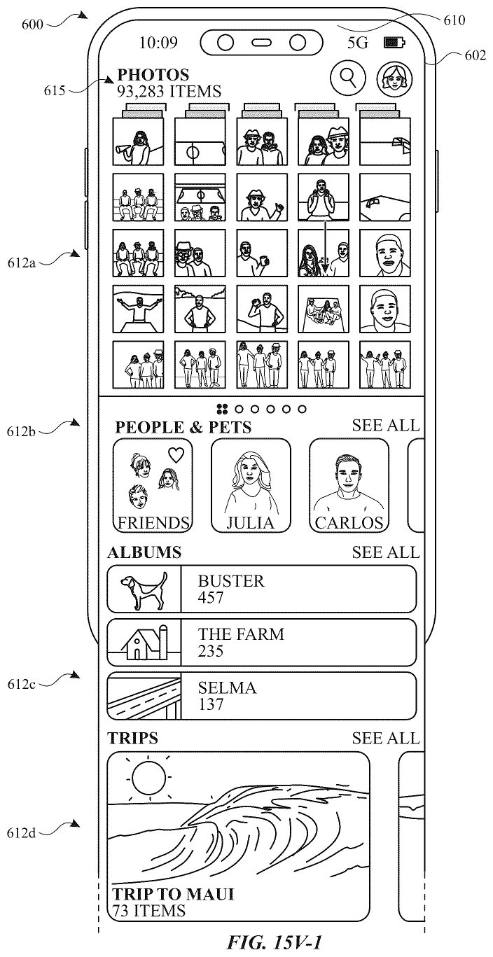

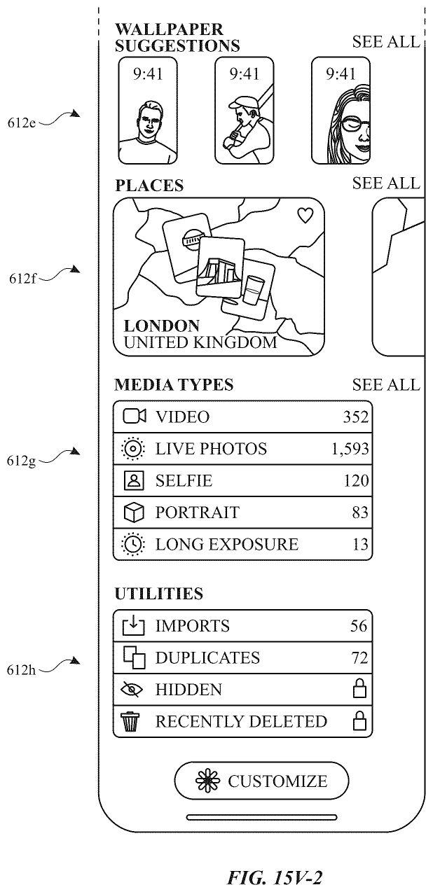

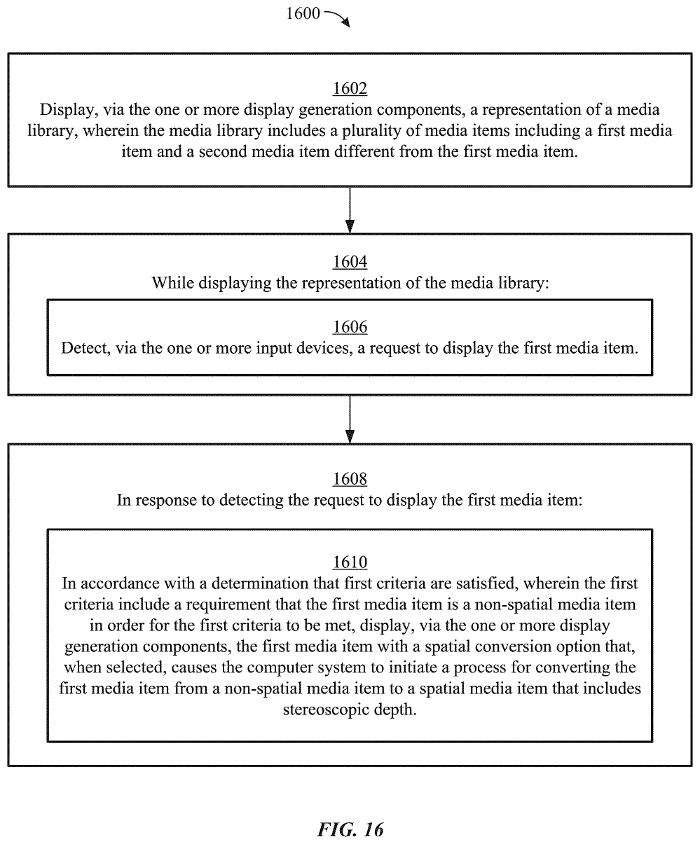

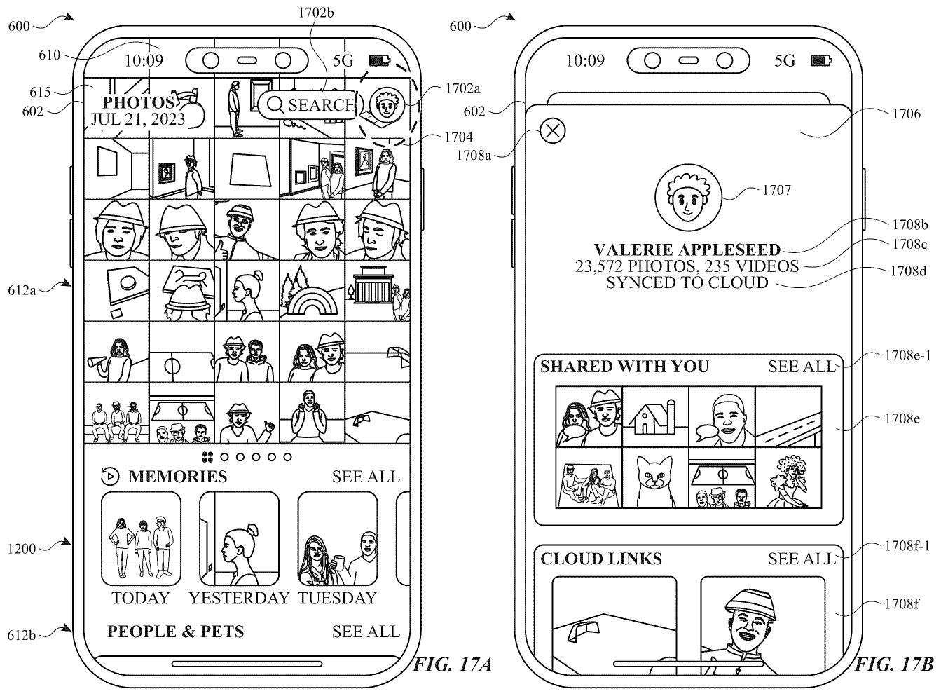

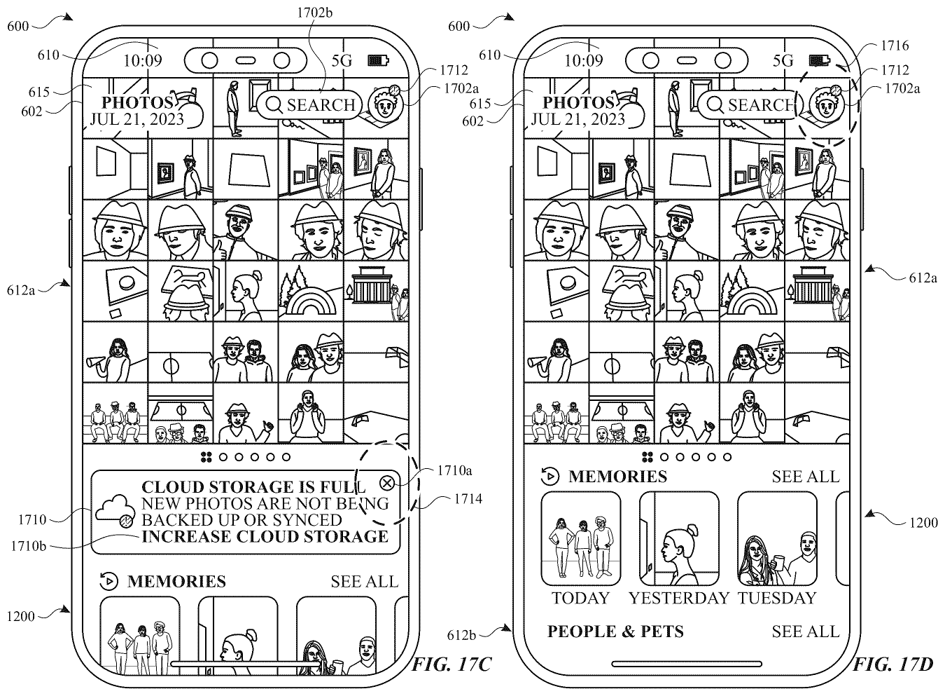

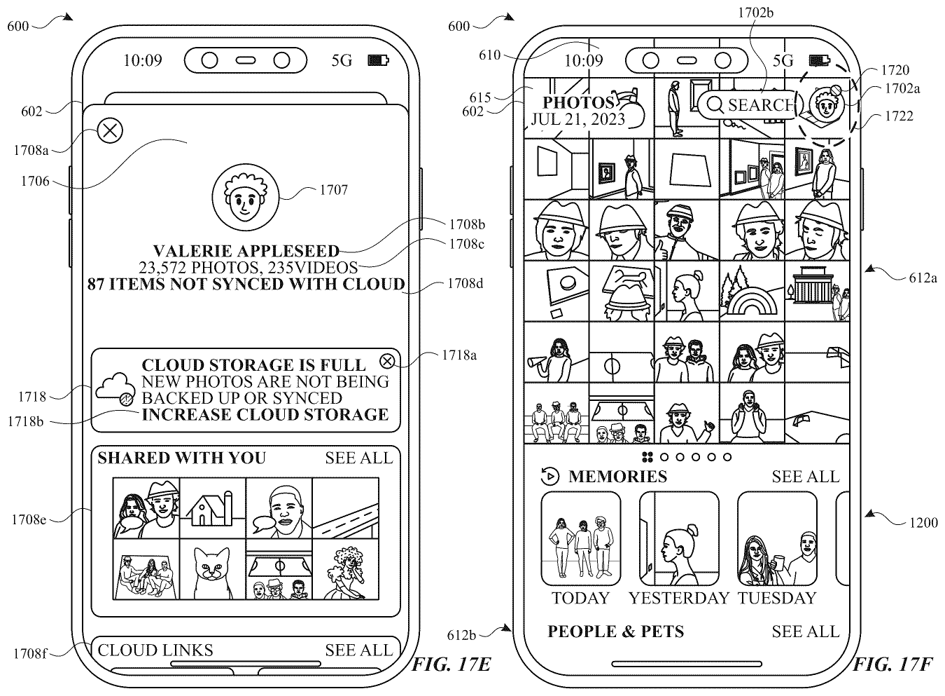

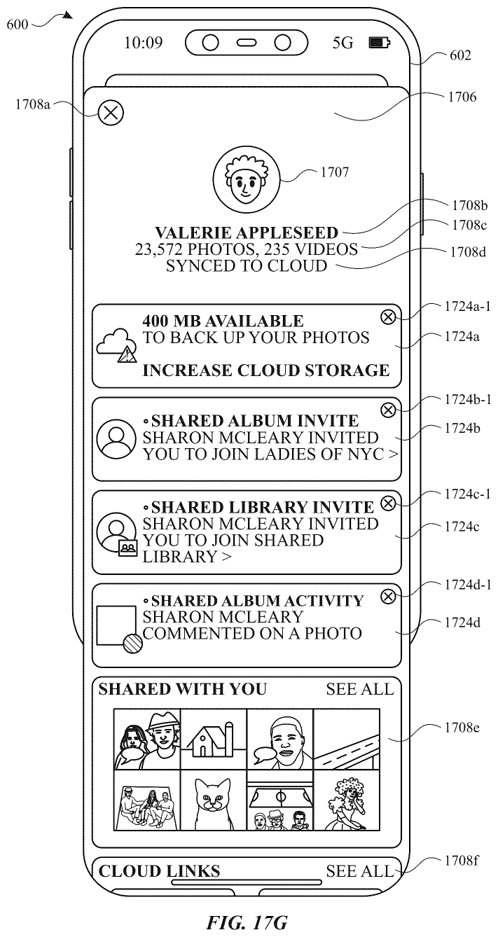

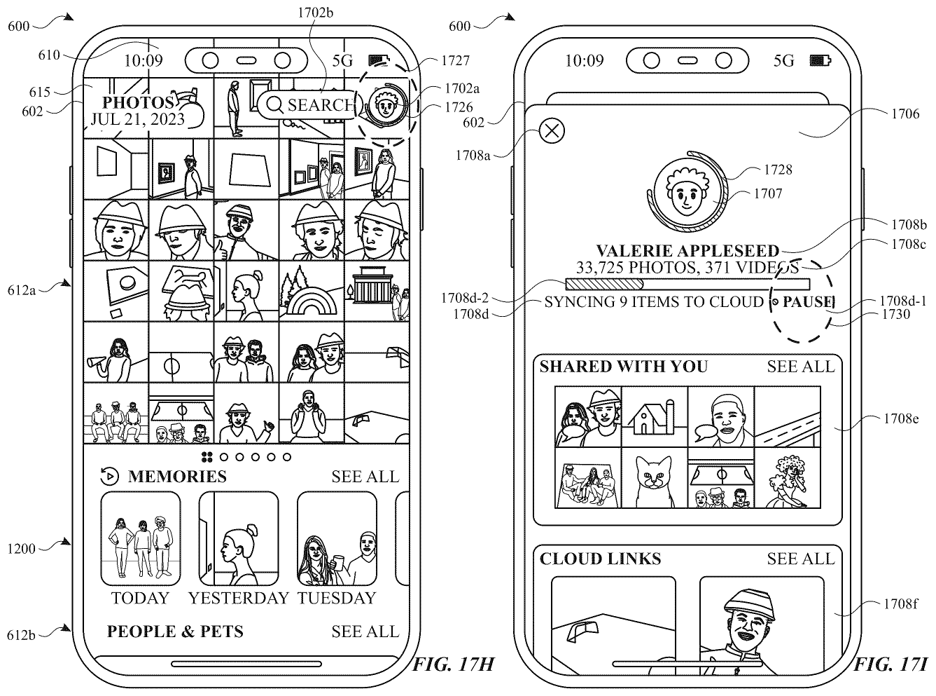

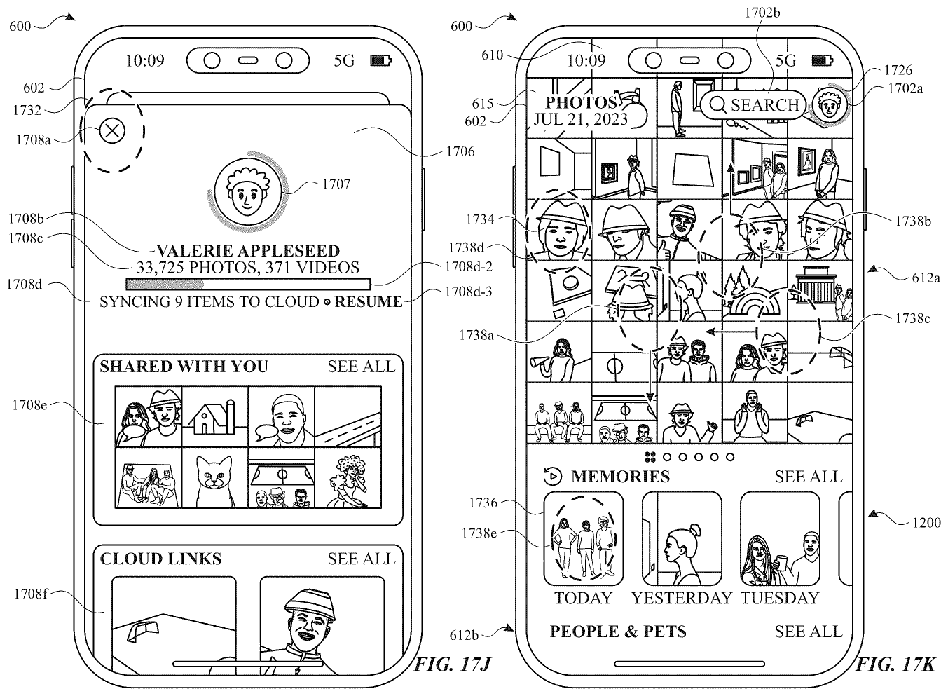

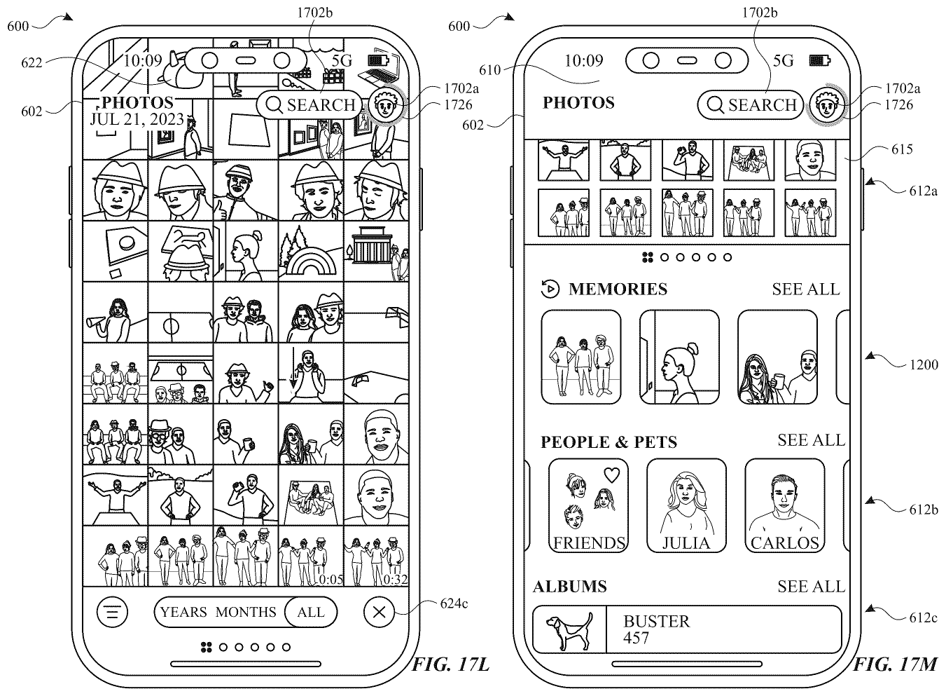

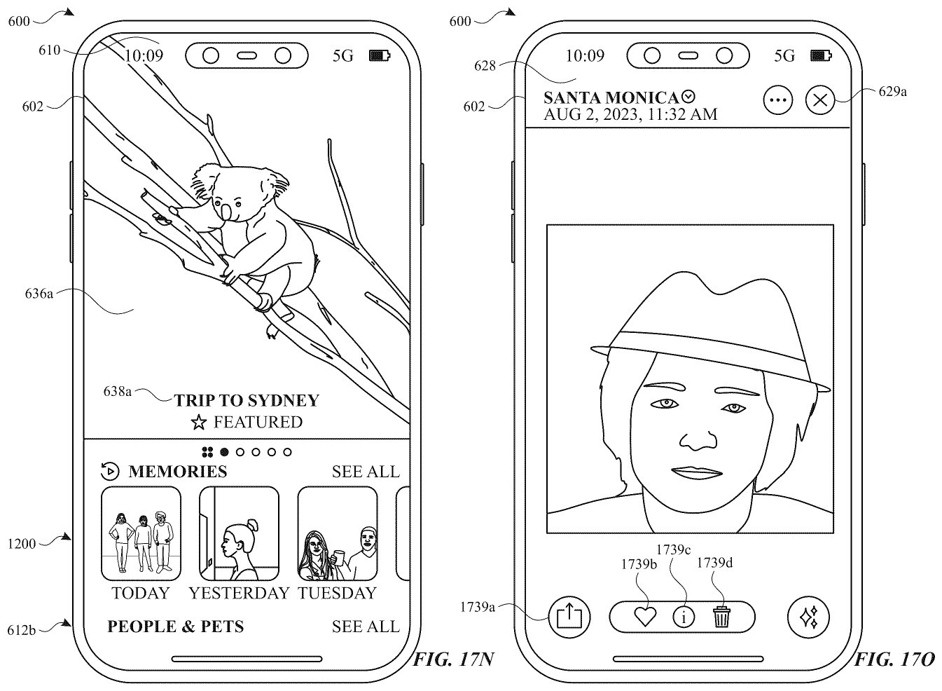

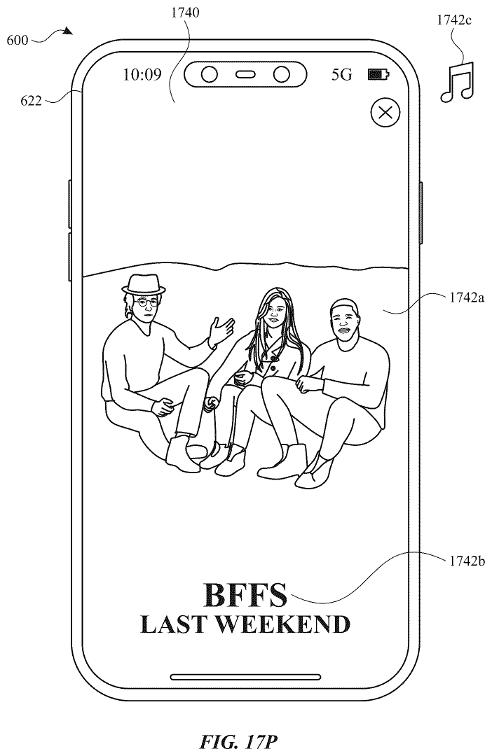

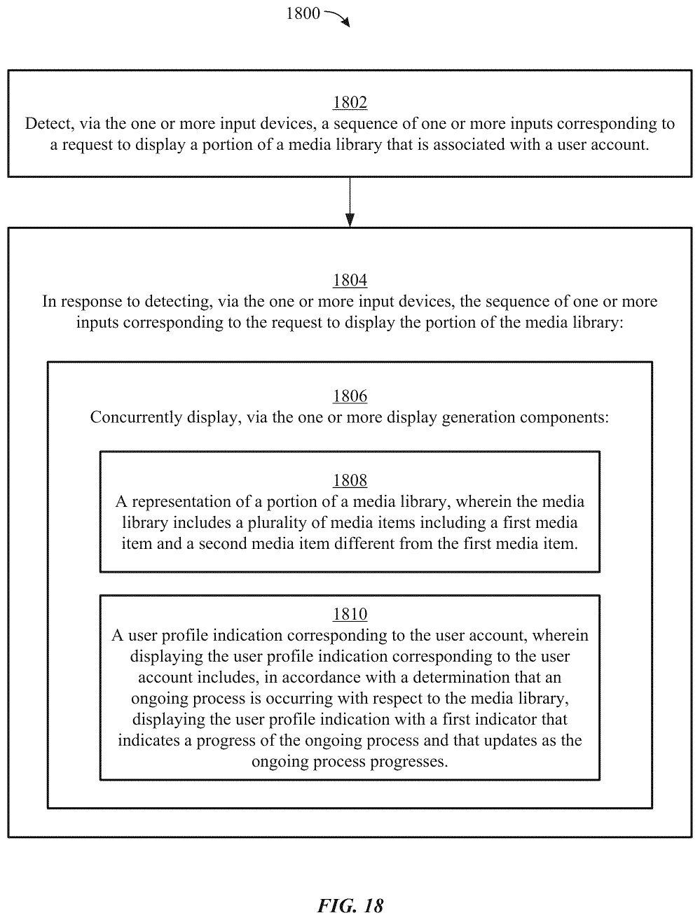

Below, FIGS. 1A-1B, 2, 3A-3G, 4A-4B, and 5A-5W provide a description of exemplary devices for performing the techniques for navigating, displaying, and/or providing content. FIGS. 6A-1-6AJ illustrate exemplary user interfaces for navigating, displaying, and/or providing content. FIG. 7 is a flow diagram illustrating methods of navigating, displaying, and/or providing content in accordance with some embodiments. FIGS. 8A-8B are a flow diagram illustrating methods of navigating, displaying, and/or providing content in accordance with some embodiments. The user interfaces in FIGS. 6A-1-6AJ are used to illustrate the processes described below, including the processes in FIG. 7 and FIGS. 8A-8B. FIGS. 9A-9Z illustrate exemplary user interfaces for navigating, displaying, and/or providing content. FIG. 10 is a flow diagram illustrating methods of navigating, displaying, and/or providing content in accordance with some embodiments. FIG. 11 is a flow diagram illustrating methods of navigating, displaying, and/or providing content in accordance with some embodiments. The user interfaces in FIGS. 9A-9Z are used to illustrate the processes described below, including the processes in FIG. 10 and FIG. 11. FIGS. 12A-1-12AU illustrate exemplary devices and user interfaces for navigating, generating, and/or presenting content. FIG. 13 is a flow diagram illustrating methods of generating and/or presenting content in accordance with some embodiments. FIG. 14 is a flow diagram illustrating methods of generating and/or presenting content in accordance with some embodiments. The user interfaces in FIGS. 12A-1-12AU are used to illustrate the processes described below, including the processes in FIG. 13 and FIG. 14. FIGS. 15A-15V-2 illustrate exemplary user interfaces for displaying and/or providing content. FIG. 16 is a flow diagram illustrating methods of displaying and/or providing content in accordance with some embodiments. The user interfaces in FIGS. 15A-15V-2 are used to illustrate the processes described below, including the processes in FIG. 16. FIGS. 17A-17P illustrate exemplary user interfaces for displaying and/or providing content. FIG. 18 is a flow diagram illustrating methods of displaying and/or providing content in accordance with some embodiments. The user interfaces in FIGS. 17A-17P are used to illustrate the processes described below, including the processes in FIG. 18.

The processes described below enhance the operability of the devices and make the user-device interfaces more efficient (e.g., by helping the user to provide proper inputs and reducing user mistakes when operating/interacting with the device) through various techniques, including by providing improved visual feedback to the user, reducing the number of inputs needed to perform an operation, providing additional control options without cluttering the user interface with additional displayed controls, performing an operation when a set of conditions has been met without requiring further user input, and/or additional techniques. These techniques also reduce power usage and improve battery life of the device by enabling the user to use the device more quickly and efficiently.

In addition, in methods described herein where one or more steps are contingent upon one or more conditions having been met, it should be understood that the described method can be repeated in multiple repetitions so that over the course of the repetitions all of the conditions upon which steps in the method are contingent have been met in different repetitions of the method. For example, if a method requires performing a first step if a condition is satisfied, and a second step if the condition is not satisfied, then a person of ordinary skill would appreciate that the claimed steps are repeated until the condition has been both satisfied and not satisfied, in no particular order. Thus, a method described with one or more steps that are contingent upon one or more conditions having been met could be rewritten as a method that is repeated until each of the conditions described in the method has been met. This, however, is not required of system or computer readable medium claims where the system or computer readable medium contains instructions for performing the contingent operations based on the satisfaction of the corresponding one or more conditions and thus is capable of determining whether the contingency has or has not been satisfied without explicitly repeating steps of a method until all of the conditions upon which steps in the method are contingent have been met. A person having ordinary skill in the art would also understand that, similar to a method with contingent steps, a system or computer readable storage medium can repeat the steps of a method as many times as are needed to ensure that all of the contingent steps have been performed.

Although the following description uses terms “first,” “second,” etc. to describe various elements, these elements should not be limited by the terms. In some embodiments, these terms are used to distinguish one element from another. For example, a first touch could be termed a second touch, and, similarly, a second touch could be termed a first touch, without departing from the scope of the various described embodiments. In some embodiments, the first touch and the second touch are two separate references to the same touch. In some embodiments, the first touch and the second touch are both touches, but they are not the same touch.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The term “if” is, optionally, construed to mean “when” or “upon” or “in response to determining” or “in response to detecting,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event],” depending on the context.

Embodiments of electronic devices, user interfaces for such devices, and associated processes for using such devices are described. In some embodiments, the device is a portable communications device, such as a mobile telephone, that also contains other functions, such as PDA and/or music player functions. Exemplary embodiments of portable multifunction devices include, without limitation, the iPhone®, iPod Touch®, and iPad® devices from Apple Inc. of Cupertino, California. Other portable electronic devices, such as laptops or tablet computers with touch-sensitive surfaces (e.g., touch screen displays and/or touchpads), are, optionally, used. It should also be understood that, in some embodiments, the device is not a portable communications device, but is a desktop computer with a touch-sensitive surface (e.g., a touch screen display and/or a touchpad). In some embodiments, the electronic device is a computer system that is in communication (e.g., via wireless communication, via wired communication) with a display generation component. The display generation component is configured to provide visual output, such as display via a CRT display, display via an LED display, or display via image projection. In some embodiments, the display generation component is integrated with the computer system. In some embodiments, the display generation component is separate from the computer system. As used herein, “displaying” content includes causing to display the content (e.g., video data rendered or decoded by display controller 156) by transmitting, via a wired or wireless connection, data (e.g., image data or video data) to an integrated or external display generation component to visually produce the content.

In the discussion that follows, an electronic device that includes a display and a touch-sensitive surface is described. It should be understood, however, that the electronic device optionally includes one or more other physical user-interface devices, such as a physical keyboard, a mouse, and/or a joystick.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, and/or a digital video player application.

The various applications that are executed on the device optionally use at least one common physical user-interface device, such as the touch-sensitive surface. One or more functions of the touch-sensitive surface as well as corresponding information displayed on the device are, optionally, adjusted and/or varied from one application to the next and/or within a respective application. In this way, a common physical architecture (such as the touch-sensitive surface) of the device optionally supports the variety of applications with user interfaces that are intuitive and transparent to the user.

Attention is now directed toward embodiments of portable devices with touch-sensitive displays. FIG. 1A is a block diagram illustrating portable multifunction device 100 with touch-sensitive display system 112 in accordance with some embodiments. Touch-sensitive display 112 is sometimes called a “touch screen” for convenience and is sometimes known as or called a “touch-sensitive display system.” Device 100 includes memory 102 (which optionally includes one or more computer-readable storage mediums), memory controller 122, one or more processing units (CPUs) 120, peripherals interface 118, RF circuitry 108, audio circuitry 110, speaker 111, microphone 113, input/output (I/O) subsystem 106, other input control devices 116, and external port 124. Device 100 optionally includes one or more optical sensors 164. Device 100 optionally includes one or more contact intensity sensors 165 for detecting intensity of contacts on device 100 (e.g., a touch-sensitive surface such as touch-sensitive display system 112 of device 100). Device 100 optionally includes one or more tactile output generators 167 for generating tactile outputs on device 100 (e.g., generating tactile outputs on a touch-sensitive surface such as touch-sensitive display system 112 of device 100 or touchpad 355 of device 300). These components optionally communicate over one or more communication buses or signal lines 103.

As used in the specification and claims, the term “intensity” of a contact on a touch-sensitive surface refers to the force or pressure (force per unit area) of a contact (e.g., a finger contact) on the touch-sensitive surface, or to a substitute (proxy) for the force or pressure of a contact on the touch-sensitive surface. The intensity of a contact has a range of values that includes at least four distinct values and more typically includes hundreds of distinct values (e.g., at least 256). Intensity of a contact is, optionally, determined (or measured) using various approaches and various sensors or combinations of sensors. For example, one or more force sensors underneath or adjacent to the touch-sensitive surface are, optionally, used to measure force at various points on the touch-sensitive surface. In some implementations, force measurements from multiple force sensors are combined (e.g., a weighted average) to determine an estimated force of a contact. Similarly, a pressure-sensitive tip of a stylus is, optionally, used to determine a pressure of the stylus on the touch-sensitive surface. Alternatively, the size of the contact area detected on the touch-sensitive surface and/or changes thereto, the capacitance of the touch-sensitive surface proximate to the contact and/or changes thereto, and/or the resistance of the touch-sensitive surface proximate to the contact and/or changes thereto are, optionally, used as a substitute for the force or pressure of the contact on the touch-sensitive surface. In some implementations, the substitute measurements for contact force or pressure are used directly to determine whether an intensity threshold has been exceeded (e.g., the intensity threshold is described in units corresponding to the substitute measurements). In some implementations, the substitute measurements for contact force or pressure are converted to an estimated force or pressure, and the estimated force or pressure is used to determine whether an intensity threshold has been exceeded (e.g., the intensity threshold is a pressure threshold measured in units of pressure). Using the intensity of a contact as an attribute of a user input allows for user access to additional device functionality that may otherwise not be accessible by the user on a reduced-size device with limited real estate for displaying affordances (e.g., on a touch-sensitive display) and/or receiving user input (e.g., via a touch-sensitive display, a touch-sensitive surface, or a physical/mechanical control such as a knob or a button).

As used in the specification and claims, the term “tactile output” refers to physical displacement of a device relative to a previous position of the device, physical displacement of a component (e.g., a touch-sensitive surface) of a device relative to another component (e.g., housing) of the device, or displacement of the component relative to a center of mass of the device that will be detected by a user with the user's sense of touch. For example, in situations where the device or the component of the device is in contact with a surface of a user that is sensitive to touch (e.g., a finger, palm, or other part of a user's hand), the tactile output generated by the physical displacement will be interpreted by the user as a tactile sensation corresponding to a perceived change in physical characteristics of the device or the component of the device. For example, movement of a touch-sensitive surface (e.g., a touch-sensitive display or trackpad) is, optionally, interpreted by the user as a “down click” or “up click” of a physical actuator button. In some cases, a user will feel a tactile sensation such as an “down click” or “up click” even when there is no movement of a physical actuator button associated with the touch-sensitive surface that is physically pressed (e.g., displaced) by the user's movements. As another example, movement of the touch-sensitive surface is, optionally, interpreted or sensed by the user as “roughness” of the touch-sensitive surface, even when there is no change in smoothness of the touch-sensitive surface. While such interpretations of touch by a user will be subject to the individualized sensory perceptions of the user, there are many sensory perceptions of touch that are common to a large majority of users. Thus, when a tactile output is described as corresponding to a particular sensory perception of a user (e.g., an “up click,” a “down click,” “roughness”), unless otherwise stated, the generated tactile output corresponds to physical displacement of the device or a component thereof that will generate the described sensory perception for a typical (or average) user.

It should be appreciated that device 100 is only one example of a portable multifunction device, and that device 100 optionally has more or fewer components than shown, optionally combines two or more components, or optionally has a different configuration or arrangement of the components. The various components shown in FIG. 1A are implemented in hardware, software, or a combination of both hardware and software, including one or more signal processing and/or application-specific integrated circuits.

Memory 102 optionally includes high-speed random access memory and optionally also includes non-volatile memory, such as one or more magnetic disk storage devices, flash memory devices, or other non-volatile solid-state memory devices. Memory controller 122 optionally controls access to memory 102 by other components of device 100.

Peripherals interface 118 can be used to couple input and output peripherals of the device to CPU 120 and memory 102. The one or more processors 120 run or execute various software programs (such as computer programs (e.g., including instructions)) and/or sets of instructions stored in memory 102 to perform various functions for device 100 and to process data. In some embodiments, peripherals interface 118, CPU 120, and memory controller 122 are, optionally, implemented on a single chip, such as chip 104. In some other embodiments, they are, optionally, implemented on separate chips.

RF (radio frequency) circuitry 108 receives and sends RF signals, also called electromagnetic signals. RF circuitry 108 converts electrical signals to/from electromagnetic signals and communicates with communications networks and other communications devices via the electromagnetic signals. RF circuitry 108 optionally includes well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. RF circuitry 108 optionally communicates with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The RF circuitry 108 optionally includes well-known circuitry for detecting near field communication (NFC) fields, such as by a short-range communication radio. The wireless communication optionally uses any of a plurality of communications standards, protocols, and technologies, including but not limited to Global System for Mobile Communications (GSM), Enhanced Data GSM Environment (EDGE), high-speed downlink packet access (HSDPA), high-speed uplink packet access (HSUPA), Evolution, Data-Only (EV-DO), HSPA, HSPA+, Dual-Cell HSPA (DC-HSPDA), long term evolution (LTE), near field communication (NFC), wideband code division multiple access (W-CDMA), code division multiple access (CDMA), time division multiple access (TDMA), Bluetooth, Bluetooth Low Energy (BTLE), Wireless Fidelity (Wi-Fi) (e.g., IEEE 802.11a, IEEE 802.11b, IEEE 802.11g, IEEE 802.11n, and/or IEEE 802.11ac), voice over Internet Protocol (VOIP), Wi-MAX, a protocol for e-mail (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), Instant Messaging and Presence Service (IMPS)), and/or Short Message Service (SMS), or any other suitable communication protocol, including communication protocols not yet developed as of the filing date of this document.

Audio circuitry 110, speaker 111, and microphone 113 provide an audio interface between a user and device 100. Audio circuitry 110 receives audio data from peripherals interface 118, converts the audio data to an electrical signal, and transmits the electrical signal to speaker 111. Speaker 111 converts the electrical signal to human-audible sound waves. Audio circuitry 110 also receives electrical signals converted by microphone 113 from sound waves. Audio circuitry 110 converts the electrical signal to audio data and transmits the audio data to peripherals interface 118 for processing. Audio data is, optionally, retrieved from and/or transmitted to memory 102 and/or RF circuitry 108 by peripherals interface 118. In some embodiments, audio circuitry 110 also includes a headset jack (e.g., 212, FIG. 2). The headset jack provides an interface between audio circuitry 110 and removable audio input/output peripherals, such as output-only headphones or a headset with both output (e.g., a headphone for one or both ears) and input (e.g., a microphone).

I/O subsystem 106 couples input/output peripherals on device 100, such as touch screen 112 and other input control devices 116, to peripherals interface 118. I/O subsystem 106 optionally includes display controller 156, optical sensor controller 158, depth camera controller 169, intensity sensor controller 159, haptic feedback controller 161, and one or more input controllers 160 for other input or control devices. The one or more input controllers 160 receive/send electrical signals from/to other input control devices 116. The other input control devices 116 optionally include physical buttons (e.g., push buttons, rocker buttons, etc.), dials, slider switches, joysticks, click wheels, and so forth. In some embodiments, input controller(s) 160 are, optionally, coupled to any (or none) of the following: a keyboard, an infrared port, a USB port, and a pointer device such as a mouse. The one or more buttons (e.g., 208, FIG. 2) optionally include an up/down button for volume control of speaker 111 and/or microphone 113. The one or more buttons optionally include a push button (e.g., 206, FIG. 2). In some embodiments, the electronic device is a computer system that is in communication (e.g., via wireless communication, via wired communication) with one or more input devices. In some embodiments, the one or more input devices include a touch-sensitive surface (e.g., a trackpad, as part of a touch-sensitive display). In some embodiments, the one or more input devices include one or more camera sensors (e.g., one or more optical sensors 164 and/or one or more depth camera sensors 175), such as for tracking a user's gestures (e.g., hand gestures and/or air gestures) as input. In some embodiments, the one or more input devices are integrated with the computer system. In some embodiments, the one or more input devices are separate from the computer system. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

A quick press of the push button optionally disengages a lock of touch screen 112 or optionally begins a process that uses gestures on the touch screen to unlock the device, as described in U.S. patent application Ser. No. 11/322,549, “Unlocking a Device by Performing Gestures on an Unlock Image,” filed Dec. 23, 2005, U.S. Pat. No. 7,657,849, which is hereby incorporated by reference in its entirety. A longer press of the push button (e.g., 206) optionally turns power to device 100 on or off. The functionality of one or more of the buttons are, optionally, user-customizable. Touch screen 112 is used to implement virtual or soft buttons and one or more soft keyboards.

Touch-sensitive display 112 provides an input interface and an output interface between the device and a user. Display controller 156 receives and/or sends electrical signals from/to touch screen 112. Touch screen 112 displays visual output to the user. The visual output optionally includes graphics, text, icons, video, and any combination thereof (collectively termed “graphics”). In some embodiments, some or all of the visual output optionally corresponds to user-interface objects.

Touch screen 112 has a touch-sensitive surface, sensor, or set of sensors that accepts input from the user based on haptic and/or tactile contact. Touch screen 112 and display controller 156 (along with any associated modules and/or sets of instructions in memory 102) detect contact (and any movement or breaking of the contact) on touch screen 112 and convert the detected contact into interaction with user-interface objects (e.g., one or more soft keys, icons, web pages, or images) that are displayed on touch screen 112. In an exemplary embodiment, a point of contact between touch screen 112 and the user corresponds to a finger of the user.

Touch screen 112 optionally uses LCD (liquid crystal display) technology, LPD (light emitting polymer display) technology, or LED (light emitting diode) technology, although other display technologies are used in other embodiments. Touch screen 112 and display controller 156 optionally detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with touch screen 112. In an exemplary embodiment, projected mutual capacitance sensing technology is used, such as that found in the iPhone® and iPod Touch® from Apple Inc. of Cupertino, California.

A touch-sensitive display in some embodiments of touch screen 112 is, optionally, analogous to the multi-touch sensitive touchpads described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety. However, touch screen 112 displays visual output from device 100, whereas touch-sensitive touchpads do not provide visual output.

A touch-sensitive display in some embodiments of touch screen 112 is described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

Touch screen 112 optionally has a video resolution in excess of 100 dpi. In some embodiments, the touch screen has a video resolution of approximately 160 dpi. The user optionally makes contact with touch screen 112 using any suitable object or appendage, such as a stylus, a finger, and so forth. In some embodiments, the user interface is designed to work primarily with finger-based contacts and gestures, which can be less precise than stylus-based input due to the larger area of contact of a finger on the touch screen. In some embodiments, the device translates the rough finger-based input into a precise pointer/cursor position or command for performing the actions desired by the user.

In some embodiments, in addition to the touch screen, device 100 optionally includes a touchpad for activating or deactivating particular functions. In some embodiments, the touchpad is a touch-sensitive area of the device that, unlike the touch screen, does not display visual output. The touchpad is, optionally, a touch-sensitive surface that is separate from touch screen 112 or an extension of the touch-sensitive surface formed by the touch screen.

Device 100 also includes power system 162 for powering the various components. Power system 162 optionally includes a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

Device 100 optionally also includes secure element 163 for securely storing information. In some embodiments, secure element 163 is a hardware component (e.g., a secure microcontroller chip) configured to securely store data or an algorithm. In some embodiments, secure element 163 provides (e.g., releases) secure information (e.g., payment information (e.g., an account number and/or a transaction-specific dynamic security code), identification information (e.g., credentials of a state-approved digital identification), and/or authentication information (e.g., data generated using a cryptography engine and/or by performing asymmetric cryptography operations)). In some embodiments, secure element 163 provides (or releases) the secure information in response to device 100 receiving authorization, such as a user authentication (e.g., fingerprint authentication; passcode authentication; detecting double-press of a hardware button when device 100 is in an unlocked state, and optionally, while device 100 has been continuously on a user's wrist since device 100 was unlocked by providing authentication credentials to device 100, where the continuous presence of device 100 on the user's wrist is determined by periodically checking that the device is in contact with the user's skin). For example, device 100 detects a fingerprint at a fingerprint sensor (e.g., a fingerprint sensor integrated into a button) of device 100. Device 100 determines whether the detected fingerprint is consistent with an enrolled fingerprint. In accordance with a determination that the fingerprint is consistent with the enrolled fingerprint, secure element 163 provides (e.g., releases) the secure information. In accordance with a determination that the fingerprint is not consistent with the enrolled fingerprint, secure element 163 forgoes providing (e.g., releasing) the secure information.

Device 100 optionally also includes one or more optical sensors 164. FIG. 1A shows an optical sensor coupled to optical sensor controller 158 in I/O subsystem 106. Optical sensor 164 optionally includes charge-coupled device (CCD) or complementary metal-oxide semiconductor (CMOS) phototransistors. Optical sensor 164 receives light from the environment, projected through one or more lenses, and converts the light to data representing an image. In conjunction with imaging module 143 (also called a camera module), optical sensor 164 optionally captures still images or video. In some embodiments, an optical sensor is located on the back of device 100, opposite touch screen display 112 on the front of the device so that the touch screen display is enabled for use as a viewfinder for still and/or video image acquisition. In some embodiments, an optical sensor is located on the front of the device so that the user's image is, optionally, obtained for video conferencing while the user views the other video conference participants on the touch screen display. In some embodiments, the position of optical sensor 164 can be changed by the user (e.g., by rotating the lens and the sensor in the device housing) so that a single optical sensor 164 is used along with the touch screen display for both video conferencing and still and/or video image acquisition.

Device 100 optionally also includes one or more depth camera sensors 175. FIG. 1A shows a depth camera sensor coupled to depth camera controller 169 in I/O subsystem 106.

Depth camera sensor 175 receives data from the environment to create a three dimensional model of an object (e.g., a face) within a scene from a viewpoint (e.g., a depth camera sensor). In some embodiments, in conjunction with imaging module 143 (also called a camera module), depth camera sensor 175 is optionally used to determine a depth map of different portions of an image captured by the imaging module 143. In some embodiments, a depth camera sensor is located on the front of device 100 so that the user's image with depth information is, optionally, obtained for video conferencing while the user views the other video conference participants on the touch screen display and to capture selfies with depth map data. In some embodiments, the depth camera sensor 175 is located on the back of device, or on the back and the front of the device 100. In some embodiments, the position of depth camera sensor 175 can be changed by the user (e.g., by rotating the lens and the sensor in the device housing) so that a depth camera sensor 175 is used along with the touch screen display for both video conferencing and still and/or video image acquisition.

Device 100 optionally also includes one or more contact intensity sensors 165. FIG. 1A shows a contact intensity sensor coupled to intensity sensor controller 159 in I/O subsystem 106. Contact intensity sensor 165 optionally includes one or more piezoresistive strain gauges, capacitive force sensors, electric force sensors, piezoelectric force sensors, optical force sensors, capacitive touch-sensitive surfaces, or other intensity sensors (e.g., sensors used to measure the force (or pressure) of a contact on a touch-sensitive surface). Contact intensity sensor 165 receives contact intensity information (e.g., pressure information or a proxy for pressure information) from the environment. In some embodiments, at least one contact intensity sensor is collocated with, or proximate to, a touch-sensitive surface (e.g., touch-sensitive display system 112). In some embodiments, at least one contact intensity sensor is located on the back of device 100, opposite touch screen display 112, which is located on the front of device 100.

Device 100 optionally also includes one or more proximity sensors 166. FIG. 1A shows proximity sensor 166 coupled to peripherals interface 118. Alternately, proximity sensor 166 is, optionally, coupled to input controller 160 in I/O subsystem 106. Proximity sensor 166 optionally performs as described in U.S. patent application Ser. No. 11/241,839, “Proximity Detector In Handheld Device”; Ser. No. 11/240,788, “Proximity Detector In Handheld Device”; Ser. No. 11/620,702, “Using Ambient Light Sensor To Augment Proximity Sensor Output”; Ser. No. 11/586,862, “Automated Response To And Sensing Of User Activity In Portable Devices”; and Ser. No. 11/638,251, “Methods And Systems For Automatic Configuration Of Peripherals,” which are hereby incorporated by reference in their entirety. In some embodiments, the proximity sensor turns off and disables touch screen 112 when the multifunction device is placed near the user's ear (e.g., when the user is making a phone call).

Device 100 optionally also includes one or more tactile output generators 167. FIG. 1A shows a tactile output generator coupled to haptic feedback controller 161 in I/O subsystem 106. Tactile output generator 167 optionally includes one or more electroacoustic devices such as speakers or other audio components and/or electromechanical devices that convert energy into linear motion such as a motor, solenoid, electroactive polymer, piezoelectric actuator, electrostatic actuator, or other tactile output generating component (e.g., a component that converts electrical signals into tactile outputs on the device). Contact intensity sensor 165 receives tactile feedback generation instructions from haptic feedback module 133 and generates tactile outputs on device 100 that are capable of being sensed by a user of device 100. In some embodiments, at least one tactile output generator is collocated with, or proximate to, a touch-sensitive surface (e.g., touch-sensitive display system 112) and, optionally, generates a tactile output by moving the touch-sensitive surface vertically (e.g., in/out of a surface of device 100) or laterally (e.g., back and forth in the same plane as a surface of device 100). In some embodiments, at least one tactile output generator sensor is located on the back of device 100, opposite touch screen display 112, which is located on the front of device 100.

Device 100 optionally also includes one or more accelerometers 168. FIG. 1A shows accelerometer 168 coupled to peripherals interface 118. Alternately, accelerometer 168 is, optionally, coupled to an input controller 160 in I/O subsystem 106. Accelerometer 168 optionally performs as described in U.S. Patent Publication No. 20050190059, “Acceleration-based Theft Detection System for Portable Electronic Devices,” and U.S. Patent Publication No. 20060017692, “Methods And Apparatuses For Operating A Portable Device Based On An Accelerometer,” both of which are incorporated by reference herein in their entirety. In some embodiments, information is displayed on the touch screen display in a portrait view or a landscape view based on an analysis of data received from the one or more accelerometers.

Device 100 optionally includes, in addition to accelerometer(s) 168, a magnetometer and a GPS (or GLONASS or other global navigation system) receiver for obtaining information concerning the location and orientation (e.g., portrait or landscape) of device 100.

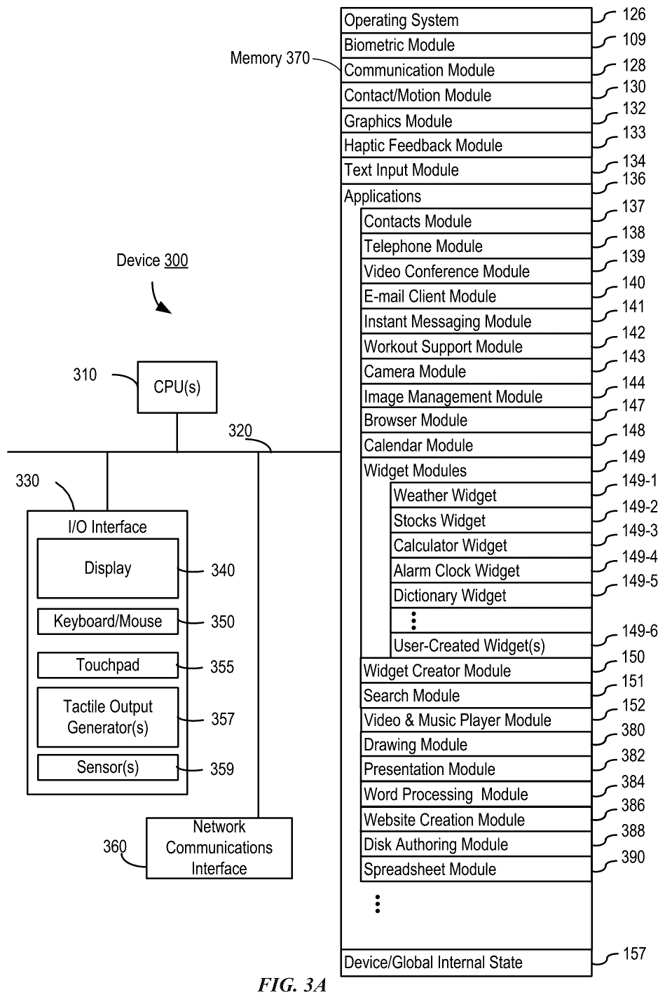

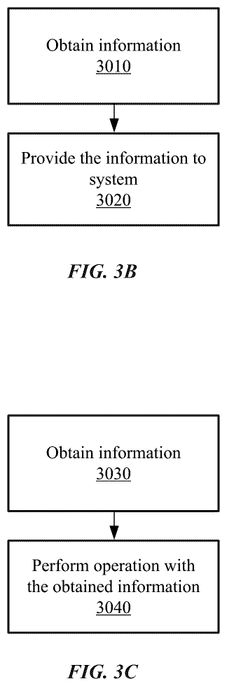

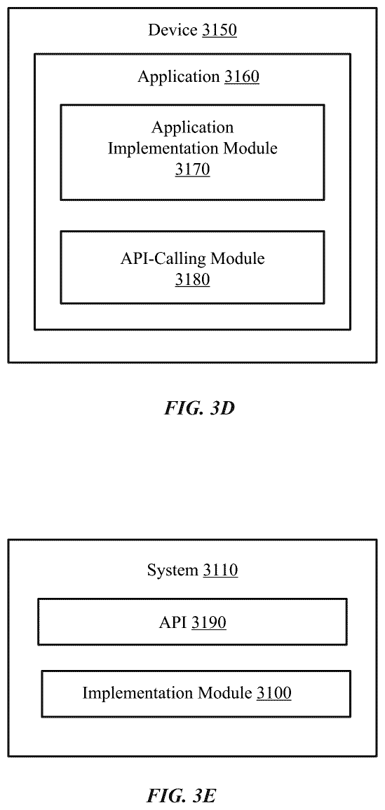

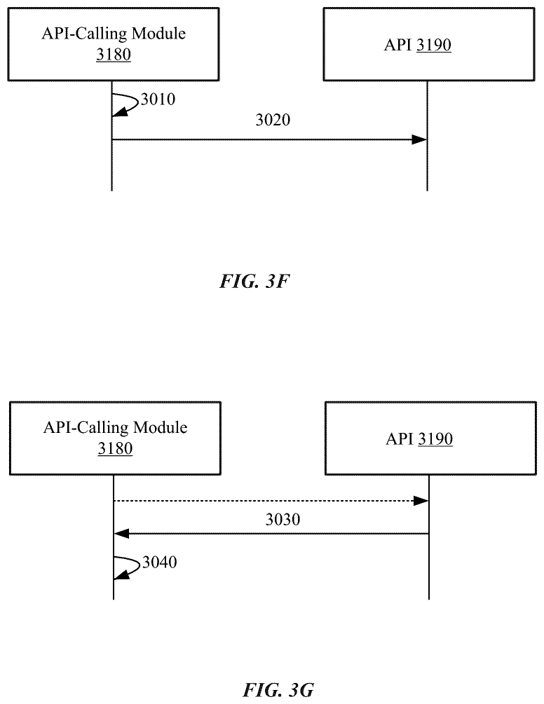

In some embodiments, the software components stored in memory 102 include operating system 126, biometric module 109, communication module (or set of instructions) 128, contact/motion module (or set of instructions) 130, graphics module (or set of instructions) 132, text input module (or set of instructions) 134, Global Positioning System (GPS) module (or set of instructions) 135, authentication module 105, and applications (or sets of instructions) 136. Furthermore, in some embodiments, memory 102 (FIG. 1A) or 370 (FIG. 3A) stores device/global internal state 157, as shown in FIGS. 1A and 3A. Device/global internal state 157 includes one or more of: active application state, indicating which applications, if any, are currently active; display state, indicating what applications, views or other information occupy various regions of touch screen display 112; sensor state, including information obtained from the device's various sensors and input control devices 116; and location information concerning the device's location and/or attitude.

Operating system 126 (e.g., Darwin, RTXC, LINUX, UNIX, OS X, IOS, WINDOWS, or an embedded operating system such as VxWorks) includes various software components and/or drivers for controlling and managing general system tasks (e.g., memory management, storage device control, power management, etc.) and facilitates communication between various hardware and software components.

Communication module 128 facilitates communication with other devices over one or more external ports 124 and also includes various software components for handling data received by RF circuitry 108 and/or external port 124. External port 124 (e.g., Universal Serial Bus (USB), FIREWIRE, etc.) is adapted for coupling directly to other devices or indirectly over a network (e.g., the Internet, wireless LAN, etc.). In some embodiments, the external port is a multi-pin (e.g., 30-pin) connector that is the same as, or similar to and/or compatible with, the 30-pin connector used on iPod® (trademark of Apple Inc.) devices.

Biometric module 109 optionally stores information about one or more enrolled biometric features (e.g., fingerprint feature information, facial recognition feature information, eye and/or iris feature information) for use to verify whether received biometric information matches the enrolled biometric features. In some embodiments, the information stored about the one or more enrolled biometric features includes data that enables the comparison between the stored information and received biometric information without including enough information to reproduce the enrolled biometric features. In some embodiments, biometric module 109 stores the information about the enrolled biometric features in association with a user account of device 100. In some embodiments, biometric module 109 compares the received biometric information to an enrolled biometric feature to determine whether the received biometric information matches the enrolled biometric feature.

Contact/motion module 130 optionally detects contact with touch screen 112 (in conjunction with display controller 156) and other touch-sensitive devices (e.g., a touchpad or physical click wheel). Contact/motion module 130 includes various software components for performing various operations related to detection of contact, such as determining if contact has occurred (e.g., detecting a finger-down event), determining an intensity of the contact (e.g., the force or pressure of the contact or a substitute for the force or pressure of the contact), determining if there is movement of the contact and tracking the movement across the touch-sensitive surface (e.g., detecting one or more finger-dragging events), and determining if the contact has ceased (e.g., detecting a finger-up event or a break in contact). Contact/motion module 130 receives contact data from the touch-sensitive surface. Determining movement of the point of contact, which is represented by a series of contact data, optionally includes determining speed (magnitude), velocity (magnitude and direction), and/or an acceleration (a change in magnitude and/or direction) of the point of contact. These operations are, optionally, applied to single contacts (e.g., one finger contacts) or to multiple simultaneous contacts (e.g., “multitouch”/multiple finger contacts). In some embodiments, contact/motion module 130 and display controller 156 detect contact on a touchpad.

In some embodiments, contact/motion module 130 uses a set of one or more intensity thresholds to determine whether an operation has been performed by a user (e.g., to determine whether a user has “clicked” on an icon). In some embodiments, at least a subset of the intensity thresholds are determined in accordance with software parameters (e.g., the intensity thresholds are not determined by the activation thresholds of particular physical actuators and can be adjusted without changing the physical hardware of device 100). For example, a mouse “click” threshold of a trackpad or touch screen display can be set to any of a large range of predefined threshold values without changing the trackpad or touch screen display hardware. Additionally, in some implementations, a user of the device is provided with software settings for adjusting one or more of the set of intensity thresholds (e.g., by adjusting individual intensity thresholds and/or by adjusting a plurality of intensity thresholds at once with a system-level click “intensity” parameter).

Contact/motion module 130 optionally detects a gesture input by a user. Different gestures on the touch-sensitive surface have different contact patterns (e.g., different motions, timings, and/or intensities of detected contacts). Thus, a gesture is, optionally, detected by detecting a particular contact pattern. For example, detecting a finger tap gesture includes detecting a finger-down event followed by detecting a finger-up (liftoff) event at the same position (or substantially the same position) as the finger-down event (e.g., at the position of an icon). As another example, detecting a finger swipe gesture on the touch-sensitive surface includes detecting a finger-down event followed by detecting one or more finger-dragging events, and subsequently followed by detecting a finger-up (liftoff) event.

Graphics module 132 includes various known software components for rendering and displaying graphics on touch screen 112 or other display, including components for changing the visual impact (e.g., brightness, transparency, saturation, contrast, or other visual property) of graphics that are displayed. As used herein, the term “graphics” includes any object that can be displayed to a user, including, without limitation, text, web pages, icons (such as user-interface objects including soft keys), digital images, videos, animations, and the like.

In some embodiments, graphics module 132 stores data representing graphics to be used. Each graphic is, optionally, assigned a corresponding code. Graphics module 132 receives, from applications etc., one or more codes specifying graphics to be displayed along with, if necessary, coordinate data and other graphic property data, and then generates screen image data to output to display controller 156.

Haptic feedback module 133 includes various software components for generating instructions used by tactile output generator(s) 167 to produce tactile outputs at one or more locations on device 100 in response to user interactions with device 100.

Text input module 134, which is, optionally, a component of graphics module 132, provides soft keyboards for entering text in various applications (e.g., contacts module 137, e-mail client module 140, IM module 141, browser module 147, and any other application that needs text input).

GPS module 135 determines the location of the device and provides this information for use in various applications (e.g., to telephone module 138 for use in location-based dialing; to camera module 143 as picture/video metadata; and to applications that provide location-based services such as weather widgets, local yellow page widgets, and map/navigation widgets).

Authentication module 105 determines whether a requested operation (e.g., requested by an application of applications 136) is authorized to be performed. In some embodiments, authentication module 105 receives for an operation to be perform that optionally requires authentication. Authentication module 105 determines whether the operation is authorized to be performed, such as based on a series of factors, including the lock status of device 100, the location of device 100, whether a security delay has elapsed, whether received biometric information matches enrolled biometric features, and/or other factors. Once authentication module 105 determines that the operation is authorized to be performed, authentication module 105 triggers performance of the operation.

Applications 136 optionally include the following modules (or sets of instructions), or a subset or superset thereof:
Contacts module 137 (sometimes called an address book or contact list);
Telephone module 138;
Video conference module 139;
E-mail client module 140;
Instant messaging (IM) module 141;
Workout support module 142;
Camera module 143 for still and/or video images;
Image management module 144;
Video player module;
Music player module;
Browser module 147;
Calendar module 148;
Widget modules 149, which optionally include one or more of: weather widget 149-1, stocks widget 149-2, calculator widget 149-3, alarm clock widget 149-4, dictionary widget 149-5, and other widgets obtained by the user, as well as user-created widgets 149-6;
Widget creator module 150 for making user-created widgets 149-6;
Search module 151;
Video and music player module 152, which merges video player module and music player module;
Notes module 153;
Map module 154; and/or
Online video module 155.

Examples of other applications 136 that are, optionally, stored in memory 102 include other word processing applications, other image editing applications, drawing applications, presentation applications, JAVA-enabled applications, encryption, digital rights management, voice recognition, and voice replication.

In conjunction with touch screen 112, display controller 156, contact/motion module 130, graphics module 132, and text input module 134, contacts module 137 are, optionally, used to manage an address book or contact list (e.g., stored in application internal state 192 of contacts module 137 in memory 102 or memory 370), including: adding name(s) to the address book; deleting name(s) from the address book; associating telephone number(s), e-mail address(es), physical address(es) or other information with a name; associating an image with a name; categorizing and sorting names; providing telephone numbers or e-mail addresses to initiate and/or facilitate communications by telephone module 138, video conference module 139, e-mail client module 140, or IM module 141; and so forth.

In conjunction with RF circuitry 108, audio circuitry 110, speaker 111, microphone 113, touch screen 112, display controller 156, contact/motion module 130, graphics module 132, and text input module 134, telephone module 138 are optionally, used to enter a sequence of characters corresponding to a telephone number, access one or more telephone numbers in contacts module 137, modify a telephone number that has been entered, dial a respective telephone number, conduct a conversation, and disconnect or hang up when the conversation is completed. As noted above, the wireless communication optionally uses any of a plurality of communications standards, protocols, and technologies.

In conjunction with RF circuitry 108, audio circuitry 110, speaker 111, microphone 113, touch screen 112, display controller 156, optical sensor 164, optical sensor controller 158, contact/motion module 130, graphics module 132, text input module 134, contacts module 137, and telephone module 138, video conference module 139 includes executable instructions to initiate, conduct, and terminate a video conference between a user and one or more other participants in accordance with user instructions.

In conjunction with RF circuitry 108, touch screen 112, display controller 156, contact/motion module 130, graphics module 132, and text input module 134, e-mail client module 140 includes executable instructions to create, send, receive, and manage e-mail in response to user instructions. In conjunction with image management module 144, e-mail client module 140 makes it very easy to create and send e-mails with still or video images taken with camera module 143.

In conjunction with RF circuitry 108, touch screen 112, display controller 156, contact/motion module 130, graphics module 132, and text input module 134, the instant messaging module 141 includes executable instructions to enter a sequence of characters corresponding to an instant message, to modify previously entered characters, to transmit a respective instant message (for example, using a Short Message Service (SMS) or Multimedia Message Service (MMS) protocol for telephony-based instant messages or using XMPP, SIMPLE, or IMPS for Internet-based instant messages), to receive instant messages, and to view received instant messages. In some embodiments, transmitted and/or received instant messages optionally include graphics, photos, audio files, video files and/or other attachments as are supported in an MMS and/or an Enhanced Messaging Service (EMS). As used herein, “instant messaging” refers to both telephony-based messages (e.g., messages sent using SMS or MMS) and Internet-based messages (e.g., messages sent using XMPP, SIMPLE, or IMPS).

In conjunction with RF circuitry 108, touch screen 112, display controller 156, contact/motion module 130, graphics module 132, text input module 134, GPS module 135, map module 154, and music player module, workout support module 142 includes executable instructions to create workouts (e.g., with time, distance, and/or calorie burning goals); communicate with workout sensors (sports devices); receive workout sensor data; calibrate sensors used to monitor a workout; select and play music for a workout; and display, store, and transmit workout data.

In conjunction with touch screen 112, display controller 156, optical sensor(s) 164, optical sensor controller 158, contact/motion module 130, graphics module 132, and image management module 144, camera module 143 includes executable instructions to capture still images or video (including a video stream) and store them into memory 102, modify characteristics of a still image or video, or delete a still image or video from memory 102.

In conjunction with touch screen 112, display controller 156, contact/motion module 130, graphics module 132, text input module 134, and camera module 143, image management module 144 includes executable instructions to arrange, modify (e.g., edit), or otherwise manipulate, label, delete, present (e.g., in a digital slide show or album), and store still and/or video images.

In conjunction with RF circuitry 108, touch screen 112, display controller 156, contact/motion module 130, graphics module 132, and text input module 134, browser module 147 includes executable instructions to browse the Internet in accordance with user instructions, including searching, linking to, receiving, and displaying web pages or portions thereof, as well as attachments and other files linked to web pages.

In conjunction with RF circuitry 108, touch screen 112, display controller 156, contact/motion module 130, graphics module 132, text input module 134, e-mail client module 140, and browser module 147, calendar module 148 includes executable instructions to create, display, modify, and store calendars and data associated with calendars (e.g., calendar entries, to-do lists, etc.) in accordance with user instructions.

In conjunction with RF circuitry 108, touch screen 112, display controller 156, contact/motion module 130, graphics module 132, text input module 134, and browser module 147, widget modules 149 are mini-applications that are, optionally, downloaded and used by a user (e.g., weather widget 149-1, stocks widget 149-2, calculator widget 149-3, alarm clock widget 149-4, and dictionary widget 149-5) or created by the user (e.g., user-created widget 149-6). In some embodiments, a widget includes an HTML (Hypertext Markup Language) file, a CSS (Cascading Style Sheets) file, and a JavaScript file. In some embodiments, a widget includes an XML (Extensible Markup Language) file and a JavaScript file (e.g., Yahoo! Widgets).

In conjunction with RF circuitry 108, touch screen 112, display controller 156, contact/motion module 130, graphics module 132, text input module 134, and browser module 147, the widget creator module 150 are, optionally, used by a user to create widgets (e.g., turning a user-specified portion of a web page into a widget).

In conjunction with touch screen 112, display controller 156, contact/motion module 130, graphics module 132, and text input module 134, search module 151 includes executable instructions to search for text, music, sound, image, video, and/or other files in memory 102 that match one or more search criteria (e.g., one or more user-specified search terms) in accordance with user instructions.

In conjunction with touch screen 112, display controller 156, contact/motion module 130, graphics module 132, audio circuitry 110, speaker 111, RF circuitry 108, and browser module 147, video and music player module 152 includes executable instructions that allow the user to download and play back recorded music and other sound files stored in one or more file formats, such as MP3 or AAC files, and executable instructions to display, present, or otherwise play back videos (e.g., on touch screen 112 or on an external, connected display via external port 124). In some embodiments, device 100 optionally includes the functionality of an MP3 player, such as an iPod (trademark of Apple Inc.).

In conjunction with touch screen 112, display controller 156, contact/motion module 130, graphics module 132, and text input module 134, notes module 153 includes executable instructions to create and manage notes, to-do lists, and the like in accordance with user instructions.

In conjunction with RF circuitry 108, touch screen 112, display controller 156, contact/motion module 130, graphics module 132, text input module 134, GPS module 135, and browser module 147, map module 154 are, optionally, used to receive, display, modify, and store maps and data associated with maps (e.g., driving directions, data on stores and other points of interest at or near a particular location, and other location-based data) in accordance with user instructions.

In conjunction with touch screen 112, display controller 156, contact/motion module 130, graphics module 132, audio circuitry 110, speaker 111, RF circuitry 108, text input module 134, e-mail client module 140, and browser module 147, online video module 155 includes instructions that allow the user to access, browse, receive (e.g., by streaming and/or download), play back (e.g., on the touch screen or on an external, connected display via external port 124), send an e-mail with a link to a particular online video, and otherwise manage online videos in one or more file formats, such as H.264. In some embodiments, instant messaging module 141, rather than e-mail client module 140, is used to send a link to a particular online video. Additional description of the online video application can be found in U.S. Provisional Patent Application No. 60/936,562, “Portable Multifunction Device, Method, and Graphical User Interface for Playing Online Videos,” filed Jun. 20, 2007, and U.S. patent application Ser. No. 11/968,067, “Portable Multifunction Device, Method, and Graphical User Interface for Playing Online Videos,” filed Dec. 31, 2007, the contents of which are hereby incorporated by reference in their entirety.

Each of the above-identified modules and applications corresponds to a set of executable instructions for performing one or more functions described above and the methods described in this application (e.g., the computer-implemented methods and other information processing methods described herein). These modules (e.g., sets of instructions) need not be implemented as separate software programs (such as computer programs (e.g., including instructions)), procedures, or modules, and thus various subsets of these modules are, optionally, combined or otherwise rearranged in various embodiments. For example, video player module is, optionally, combined with music player module into a single module (e.g., video and music player module 152, FIG. 1A). In some embodiments, memory 102 optionally stores a subset of the modules and data structures identified above. Furthermore, memory 102 optionally stores additional modules and data structures not described above.

In some embodiments, device 100 is a device where operation of a predefined set of functions on the device is performed exclusively through a touch screen and/or a touchpad. By using a touch screen and/or a touchpad as the primary input control device for operation of device 100, the number of physical input control devices (such as push buttons, dials, and the like) on device 100 is, optionally, reduced.

The predefined set of functions that are performed exclusively through a touch screen and/or a touchpad optionally include navigation between user interfaces. In some embodiments, the touchpad, when touched by the user, navigates device 100 to a main, home, or root menu from any user interface that is displayed on device 100. In such embodiments, a “menu button” is implemented using a touchpad. In some other embodiments, the menu button is a physical push button or other physical input control device instead of a touchpad.

FIG. 1B is a block diagram illustrating exemplary components for event handling in accordance with some embodiments. In some embodiments, memory 102 (FIG. 1A) or 370

(FIG. 3A) includes event sorter 170 (e.g., in operating system 126) and a respective application 136-1 (e.g., any of the aforementioned applications 137-151, 155, 380-390).

Event sorter 170 receives event information and determines the application 136-1 and application view 191 of application 136-1 to which to deliver the event information. Event sorter 170 includes event monitor 171 and event dispatcher module 174. In some embodiments, application 136-1 includes application internal state 192, which indicates the current application view(s) displayed on touch-sensitive display 112 when the application is active or executing. In some embodiments, device/global internal state 157 is used by event sorter 170 to determine which application(s) is (are) currently active, and application internal state 192 is used by event sorter 170 to determine application views 191 to which to deliver event information.

In some embodiments, application internal state 192 includes additional information, such as one or more of: resume information to be used when application 136-1 resumes execution, user interface state information that indicates information being displayed or that is ready for display by application 136-1, a state queue for enabling the user to go back to a prior state or view of application 136-1, and a redo/undo queue of previous actions taken by the user.

Event monitor 171 receives event information from peripherals interface 118. Event information includes information about a sub-event (e.g., a user touch on touch-sensitive display 112, as part of a multi-touch gesture). Peripherals interface 118 transmits information it receives from I/O subsystem 106 or a sensor, such as proximity sensor 166, accelerometer(s) 168, and/or microphone 113 (through audio circuitry 110). Information that peripherals interface 118 receives from I/O subsystem 106 includes information from touch-sensitive display 112 or a touch-sensitive surface.

In some embodiments, event monitor 171 sends requests to the peripherals interface 118 at predetermined intervals. In response, peripherals interface 118 transmits event information. In other embodiments, peripherals interface 118 transmits event information only when there is a significant event (e.g., receiving an input above a predetermined noise threshold and/or for more than a predetermined duration).

In some embodiments, event sorter 170 also includes a hit view determination module 172 and/or an active event recognizer determination module 173.

Hit view determination module 172 provides software procedures for determining where a sub-event has taken place within one or more views when touch-sensitive display 112 displays more than one view. Views are made up of controls and other elements that a user can see on the display.

Another aspect of the user interface associated with an application is a set of views, sometimes herein called application views or user interface windows, in which information is displayed and touch-based gestures occur. The application views (of a respective application) in which a touch is detected optionally correspond to programmatic levels within a programmatic or view hierarchy of the application. For example, the lowest level view in which a touch is detected is, optionally, called the hit view, and the set of events that are recognized as proper inputs are, optionally, determined based, at least in part, on the hit view of the initial touch that begins a touch-based gesture.

Hit view determination module 172 receives information related to sub-events of a touch-based gesture. When an application has multiple views organized in a hierarchy, hit view determination module 172 identifies a hit view as the lowest view in the hierarchy which should handle the sub-event. In most circumstances, the hit view is the lowest level view in which an initiating sub-event occurs (e.g., the first sub-event in the sequence of sub-events that form an event or potential event). Once the hit view is identified by the hit view determination module 172, the hit view typically receives all sub-events related to the same touch or input source for which it was identified as the hit view.

Active event recognizer determination module 173 determines which view or views within a view hierarchy should receive a particular sequence of sub-events. In some embodiments, active event recognizer determination module 173 determines that only the hit view should receive a particular sequence of sub-events. In other embodiments, active event recognizer determination module 173 determines that all views that include the physical location of a sub-event are actively involved views, and therefore determines that all actively involved views should receive a particular sequence of sub-events. In other embodiments, even if touch sub-events were entirely confined to the area associated with one particular view, views higher in the hierarchy would still remain as actively involved views.

Event dispatcher module 174 dispatches the event information to an event recognizer (e.g., event recognizer 180). In embodiments including active event recognizer determination module 173, event dispatcher module 174 delivers the event information to an event recognizer determined by active event recognizer determination module 173. In some embodiments, event dispatcher module 174 stores in an event queue the event information, which is retrieved by a respective event receiver 182.

In some embodiments, operating system 126 includes event sorter 170. Alternatively, application 136-1 includes event sorter 170. In yet other embodiments, event sorter 170 is a stand-alone module, or a part of another module stored in memory 102, such as contact/motion module 130.

In some embodiments, application 136-1 includes a plurality of event handlers 190 and one or more application views 191, each of which includes instructions for handling touch events that occur within a respective view of the application's user interface. Each application view 191 of the application 136-1 includes one or more event recognizers 180. Typically, a respective application view 191 includes a plurality of event recognizers 180. In other embodiments, one or more of event recognizers 180 are part of a separate module, such as a user interface kit or a higher level object from which application 136-1 inherits methods and other properties. In some embodiments, a respective event handler 190 includes one or more of: data updater 176, object updater 177, GUI updater 178, and/or event data 179 received from event sorter 170. Event handler 190 optionally utilizes or calls data updater 176, object updater 177, or GUI updater 178 to update the application internal state 192. Alternatively, one or more of the application views 191 include one or more respective event handlers 190. Also, in some embodiments, one or more of data updater 176, object updater 177, and GUI updater 178 are included in a respective application view 191.

A respective event recognizer 180 receives event information (e.g., event data 179) from event sorter 170 and identifies an event from the event information. Event recognizer 180 includes event receiver 182 and event comparator 184. In some embodiments, event recognizer 180 also includes at least a subset of: metadata 183, and event delivery instructions 188 (which optionally include sub-event delivery instructions).

Event receiver 182 receives event information from event sorter 170. The event information includes information about a sub-event, for example, a touch or a touch movement. Depending on the sub-event, the event information also includes additional information, such as location of the sub-event. When the sub-event concerns motion of a touch, the event information optionally also includes speed and direction of the sub-event. In some embodiments, events include rotation of the device from one orientation to another (e.g., from a portrait orientation to a landscape orientation, or vice versa), and the event information includes corresponding information about the current orientation (also called device attitude) of the device.

Event comparator 184 compares the event information to predefined event or sub-event definitions and, based on the comparison, determines an event or sub-event, or determines or updates the state of an event or sub-event. In some embodiments, event comparator 184 includes event definitions 186. Event definitions 186 contain definitions of events (e.g., predefined sequences of sub-events), for example, event 1 (187-1), event 2 (187-2), and others. In some embodiments, sub-events in an event (e.g., 187-1 and/or 187-2) include, for example, touch begin, touch end, touch movement, touch cancellation, and multiple touching. In one example, the definition for event 1 (187-1) is a double tap on a displayed object. The double tap, for example, comprises a first touch (touch begin) on the displayed object for a predetermined phase, a first liftoff (touch end) for a predetermined phase, a second touch (touch begin) on the displayed object for a predetermined phase, and a second liftoff (touch end) for a predetermined phase. In another example, the definition for event 2 (187-2) is a dragging on a displayed object. The dragging, for example, comprises a touch (or contact) on the displayed object for a predetermined phase, a movement of the touch across touch-sensitive display 112, and liftoff of the touch (touch end). In some embodiments, the event also includes information for one or more associated event handlers 190.

In some embodiments, event definitions 186 include a definition of an event for a respective user-interface object. In some embodiments, event comparator 184 performs a hit test to determine which user-interface object is associated with a sub-event. For example, in an application view in which three user-interface objects are displayed on touch-sensitive display 112, when a touch is detected on touch-sensitive display 112, event comparator 184 performs a hit test to determine which of the three user-interface objects is associated with the touch (sub-event). If each displayed object is associated with a respective event handler 190, the event comparator uses the result of the hit test to determine which event handler 190 should be activated. For example, event comparator 184 selects an event handler associated with the sub-event and the object triggering the hit test.

In some embodiments, the definition for a respective event (187) also includes delayed actions that delay delivery of the event information until after it has been determined whether the sequence of sub-events does or does not correspond to the event recognizer's event type.

When a respective event recognizer 180 determines that the series of sub-events do not match any of the events in event definitions 186, the respective event recognizer 180 enters an event impossible, event failed, or event ended state, after which it disregards subsequent sub-events of the touch-based gesture. In this situation, other event recognizers, if any, that remain active for the hit view continue to track and process sub-events of an ongoing touch-based gesture.

In some embodiments, a respective event recognizer 180 includes metadata 183 with configurable properties, flags, and/or lists that indicate how the event delivery system should perform sub-event delivery to actively involved event recognizers. In some embodiments, metadata 183 includes configurable properties, flags, and/or lists that indicate how event recognizers interact, or are enabled to interact, with one another. In some embodiments, metadata 183 includes configurable properties, flags, and/or lists that indicate whether sub-events are delivered to varying levels in the view or programmatic hierarchy.

In some embodiments, a respective event recognizer 180 activates event handler 190 associated with an event when one or more particular sub-events of an event are recognized. In some embodiments, a respective event recognizer 180 delivers event information associated with the event to event handler 190. Activating an event handler 190 is distinct from sending (and deferred sending) sub-events to a respective hit view. In some embodiments, event recognizer 180 throws a flag associated with the recognized event, and event handler 190 associated with the flag catches the flag and performs a predefined process.

In some embodiments, event delivery instructions 188 include sub-event delivery instructions that deliver event information about a sub-event without activating an event handler. Instead, the sub-event delivery instructions deliver event information to event handlers associated with the series of sub-events or to actively involved views. Event handlers associated with the series of sub-events or with actively involved views receive the event information and perform a predetermined process.

In some embodiments, data updater 176 creates and updates data used in application 136-1. For example, data updater 176 updates the telephone number used in contacts module 137, or stores a video file used in video player module. In some embodiments, object updater 177 creates and updates objects used in application 136-1. For example, object updater 177 creates a new user-interface object or updates the position of a user-interface object. GUI updater 178 updates the GUI. For example, GUI updater 178 prepares display information and sends it to graphics module 132 for display on a touch-sensitive display.

In some embodiments, event handler(s) 190 includes or has access to data updater 176, object updater 177, and GUI updater 178. In some embodiments, data updater 176, object updater 177, and GUI updater 178 are included in a single module of a respective application 136-1 or application view 191. In other embodiments, they are included in two or more software modules.

It shall be understood that the foregoing discussion regarding event handling of user touches on touch-sensitive displays also applies to other forms of user inputs to operate multifunction devices 100 with input devices, not all of which are initiated on touch screens. For example, mouse movement and mouse button presses, optionally coordinated with single or multiple keyboard presses or holds; contact movements such as taps, drags, scrolls, etc. on touchpads; pen stylus inputs; movement of the device; oral instructions; detected eye movements; biometric inputs; and/or any combination thereof are optionally utilized as inputs corresponding to sub-events which define an event to be recognized.

FIG. 2 illustrates a portable multifunction device 100 having a touch screen 112 in accordance with some embodiments. The touch screen optionally displays one or more graphics within user interface (UI) 200. In this embodiment, as well as others described below, a user is enabled to select one or more of the graphics by making a gesture on the graphics, for example, with one or more fingers 202 (not drawn to scale in the figure) or one or more styluses 203 (not drawn to scale in the figure). In some embodiments, selection of one or more graphics occurs when the user breaks contact with the one or more graphics. In some embodiments, the gesture optionally includes one or more taps, one or more swipes (from left to right, right to left, upward and/or downward), and/or a rolling of a finger (from right to left, left to right, upward and/or downward) that has made contact with device 100. In some implementations or circumstances, inadvertent contact with a graphic does not select the graphic. For example, a swipe gesture that sweeps over an application icon optionally does not select the corresponding application when the gesture corresponding to selection is a tap.

Device 100 optionally also include one or more physical buttons, such as “home” or menu button 204. As described previously, menu button 204 is, optionally, used to navigate to any application 136 in a set of applications that are, optionally, executed on device 100. Alternatively, in some embodiments, the menu button is implemented as a soft key in a GUI displayed on touch screen 112.

In some embodiments, device 100 includes touch screen 112, menu button 204, push button 206 for powering the device on/off and locking the device, volume adjustment button(s) 208, subscriber identity module (SIM) card slot 210, headset jack 212, and docking/charging external port 124. Push button 206 is, optionally, used to turn the power on/off on the device by depressing the button and holding the button in the depressed state for a predefined time interval; to lock the device by depressing the button and releasing the button before the predefined time interval has elapsed; and/or to unlock the device or initiate an unlock process. In an alternative embodiment, device 100 also accepts verbal input for activation or deactivation of some functions through microphone 113. Device 100 also, optionally, includes one or more contact intensity sensors 165 for detecting intensity of contacts on touch screen 112 and/or one or more tactile output generators 167 for generating tactile outputs for a user of device 100.

FIG. 3A is a block diagram of an exemplary multifunction device with a display and a touch-sensitive surface in accordance with some embodiments. Device 300 need not be portable. In some embodiments, device 300 is a laptop computer, a desktop computer, a tablet computer, a multimedia player device, a navigation device, an educational device (such as a child's learning toy), a gaming system, or a control device (e.g., a home or industrial controller). Device 300 typically includes one or more processing units (CPUs) 310, one or more network or other communications interfaces 360, memory 370, and one or more communication buses 320 for interconnecting these components. Communication buses 320 optionally include circuitry (sometimes called a chipset) that interconnects and controls communications between system components. Device 300 includes input/output (I/O) interface 330 comprising display 340, which is typically a touch screen display. I/O interface 330 also optionally includes a keyboard and/or mouse (or other pointing device) 350 and touchpad 355, tactile output generator 357 for generating tactile outputs on device 300 (e.g., similar to tactile output generator(s) 167 described above with reference to FIG. 1A), sensors 359 (e.g., optical, acceleration, proximity, touch-sensitive, and/or contact intensity sensors similar to contact intensity sensor(s) 165 described above with reference to FIG. 1A). Memory 370 includes high-speed random access memory, such as DRAM, SRAM, DDR RAM, or other random access solid state memory devices; and optionally includes non-volatile memory, such as one or more magnetic disk storage devices, optical disk storage devices, flash memory devices, or other non-volatile solid state storage devices. Memory 370 optionally includes one or more storage devices remotely located from CPU(s) 310. In some embodiments, memory 370 stores programs, modules, and data structures analogous to the programs, modules, and data structures stored in memory 102 of portable multifunction device 100 (FIG. 1A), or a subset thereof. Furthermore, memory 370 optionally stores additional programs, modules, and data structures not present in memory 102 of portable multifunction device 100. For example, memory 370 of device 300 optionally stores drawing module 380, presentation module 382, word processing module 384, website creation module 386, disk authoring module 388, and/or spreadsheet module 390, while memory 102 of portable multifunction device 100 (FIG. 1A) optionally does not store these modules.

Each of the above-identified elements in FIG. 3A is, optionally, stored in one or more of the previously mentioned memory devices. Each of the above-identified modules corresponds to a set of instructions for performing a function described above. The above-identified modules or computer programs (e.g., sets of instructions or including instructions) need not be implemented as separate software programs (such as computer programs (e.g., including instructions)), procedures, or modules, and thus various subsets of these modules are, optionally, combined or otherwise rearranged in various embodiments. In some embodiments, memory 370 optionally stores a subset of the modules and data structures identified above. Furthermore, memory 370 optionally stores additional modules and data structures not described above.

Implementations within the scope of the present disclosure can be partially or entirely realized using a tangible computer-readable storage medium (or multiple tangible computer-readable storage media of one or more types) encoding one or more computer-readable instructions. It should be recognized that computer-readable instructions can be organized in any format, including applications, widgets, processes, software, and/or components.

Implementations within the scope of the present disclosure include a computer-readable storage medium that encodes instructions organized as an application (e.g., application 3160) that, when executed by one or more processing units, control an electronic device (e.g., device 3150) to perform the method of FIG. 3B, the method of FIG. 3C, and/or one or more other processes and/or methods described herein.

It should be recognized that application 3160 (shown in FIG. 3D) can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application. In some embodiments, application 3160 is an application that is pre-installed on device 3150 at purchase (e.g., a first-party application). In some embodiments, application 3160 is an application that is provided to device 3150 via an operating system update file (e.g., a first-party application or a second-party application). In some embodiments, application 3160 is an application that is provided via an application store. In some embodiments, the application store can be an application store that is pre-installed on device 3150 at purchase (e.g., a first-party application store). In some embodiments, the application store is a third-party application store (e.g., an application store that is provided by another application store, downloaded via a network, and/or read from a storage device).

Referring to FIG. 3B and FIG. 3F, application 3160 obtains information (e.g., 3010). In some embodiments, at 3010, information is obtained from at least one hardware component of device 3150. In some embodiments, at 3010, information is obtained from at least one software module of device 3150. In some embodiments, at 3010, information is obtained from at least one hardware component external to device 3150 (e.g., a peripheral device, an accessory device, and/or a server). In some embodiments, the information obtained at 3010 includes positional information, time information, notification information, user information, environment information, electronic device state information, weather information, media information, historical information, event information, hardware information, and/or motion information. In some embodiments, in response to and/or after obtaining the information at 3010, application 3160 provides the information to a system (e.g., 3020).

In some embodiments, the system (e.g., 3110 shown in FIG. 3E) is an operating system hosted on device 3150. In some embodiments, the system (e.g., 3110 shown in FIG. 3E) is an external device (e.g., a server, a peripheral device, an accessory, and/or a personal computing device) that includes an operating system.

Referring to FIG. 3C and FIG. 3G, application 3160 obtains information (e.g., 3030). In some embodiments, the information obtained at 3030 includes positional information, time information, notification information, user information, environment information electronic device state information, weather information, media information, historical information, event information, hardware information, and/or motion information. In response to and/or after obtaining the information at 3030, application 3160 performs an operation with the information (e.g., 3040). In some embodiments, the operation performed at 3040 includes: providing a notification based on the information, sending a message based on the information, displaying the information, controlling a user interface of a fitness application based on the information, controlling a user interface of a health application based on the information, controlling a focus mode based on the information, setting a reminder based on the information, adding a calendar entry based on the information, and/or calling an API of system 3110 based on the information.

In some embodiments, one or more steps of the method of FIG. 3B and/or the method of FIG. 3C is performed in response to a trigger. In some embodiments, the trigger includes detection of an event, a notification received from system 3110, a user input, and/or a response to a call to an API provided by system 3110.

In some embodiments, the instructions of application 3160, when executed, control device 3150 to perform the method of FIG. 3B and/or the method of FIG. 3C by calling an application programming interface (API) (e.g., API 3190) provided by system 3110. In some embodiments, application 3160 performs at least a portion of the method of FIG. 3B and/or the method of FIG. 3C without calling API 3190.

In some embodiments, one or more steps of the method of FIG. 3B and/or the method of FIG. 3C includes calling an API (e.g., API 3190) using one or more parameters defined by the API. In some embodiments, the one or more parameters include a constant, a key, a data structure, an object, an object class, a variable, a data type, a pointer, an array, a list or a pointer to a function or method, and/or another way to reference a data or other item to be passed via the API.

Referring to FIG. 3D, device 3150 is illustrated. In some embodiments, device 3150 is a personal computing device, a smart phone, a smart watch, a fitness tracker, a head mounted display (HMD) device, a media device, a communal device, a speaker, a television, and/or a tablet. As illustrated in FIG. 3D, device 3150 includes application 3160 and an operating system (e.g., system 3110 shown in FIG. 3E). Application 3160 includes application implementation module 3170 and API-calling module 3180. System 3110 includes API 3190 and implementation module 3100. It should be recognized that device 3150, application 3160, and/or system 3110 can include more, fewer, and/or different components than illustrated in FIGS. 3D and 3E.

In some embodiments, application implementation module 3170 includes a set of one or more instructions corresponding to one or more operations performed by application 3160. For example, when application 3160 is a messaging application, application implementation module 3170 can include operations to receive and send messages. In some embodiments, application implementation module 3170 communicates with API-calling module 3180 to communicate with system 3110 via API 3190 (shown in FIG. 3E).

In some embodiments, API 3190 is a software module (e.g., a collection of computer-readable instructions) that provides an interface that allows a different module (e.g., API-calling module 3180) to access and/or use one or more functions, methods, procedures, data structures, classes, and/or other services provided by implementation module 3100 of system 3110. For example, API-calling module 3180 can access a feature of implementation module 3100 through one or more API calls or invocations (e.g., embodied by a function or a method call) exposed by API 3190 (e.g., a software and/or hardware module that can receive API calls, respond to API calls, and/or send API calls) and can pass data and/or control information using one or more parameters via the API calls or invocations. In some embodiments, API 3190 allows application 3160 to use a service provided by a Software Development Kit (SDK) library. In some embodiments, application 3160 incorporates a call to a function or method provided by the SDK library and provided by API 3190 or uses data types or objects defined in the SDK library and provided by API 3190. In some embodiments, API-calling module 3180 makes an API call via API 3190 to access and use a feature of implementation module 3100 that is specified by API 3190. In such embodiments, implementation module 3100 can return a value via API 3190 to API-calling module 3180 in response to the API call. The value can report to application 3160 the capabilities or state of a hardware component of device 3150, including those related to aspects such as input capabilities and state, output capabilities and state, processing capability, power state, storage capacity and state, and/or communications capability. In some embodiments, API 3190 is implemented in part by firmware, microcode, or other low level logic that executes in part on the hardware component.

In some embodiments, API 3190 allows a developer of API-calling module 3180 (which can be a third-party developer) to leverage a feature provided by implementation module 3100. In such embodiments, there can be one or more API-calling modules (e.g., including API-calling module 3180) that communicate with implementation module 3100. In some embodiments, API 3190 allows multiple API-calling modules written in different programming languages to communicate with implementation module 3100 (e.g., API 3190 can include features for translating calls and returns between implementation module 3100 and API-calling module 3180) while API 3190 is implemented in terms of a specific programming language. In some embodiments, API-calling module 3180 calls APIs from different providers such as a set of APIs from an OS provider, another set of APIs from a plug-in provider, and/or another set of APIs from another provider (e.g., the provider of a software library) or creator of the another set of APIs.

Examples of API 3190 can include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, photos API, camera API, and/or image processing API. In some embodiments, the sensor API is an API for accessing data associated with a sensor of device 3150. For example, the sensor API can provide access to raw sensor data. For another example, the sensor API can provide data derived (and/or generated) from the raw sensor data. In some embodiments, the sensor data includes temperature data, image data, video data, audio data, heart rate data, IMU (inertial measurement unit) data, lidar data, location data, GPS data, and/or camera data. In some embodiments, the sensor includes one or more of an accelerometer, temperature sensor, infrared sensor, optical sensor, heartrate sensor, barometer, gyroscope, proximity sensor, temperature sensor, and/or biometric sensor.

In some embodiments, implementation module 3100 is a system (e.g., operating system and/or server system) software module (e.g., a collection of computer-readable instructions) that is constructed to perform an operation in response to receiving an API call via API 3190. In some embodiments, implementation module 3100 is constructed to provide an API response (via API 3190) as a result of processing an API call. By way of example, implementation module 3100 and API-calling module 3180 can each be any one of an operating system, a library, a device driver, an API, an application program, or other module. It should be understood that implementation module 3100 and API-calling module 3180 can be the same or different type of module from each other. In some embodiments, implementation module 3100 is embodied at least in part in firmware, microcode, or hardware logic.

In some embodiments, implementation module 3100 returns a value through API 3190 in response to an API call from API-calling module 3180. While API 3190 defines the syntax and result of an API call (e.g., how to invoke the API call and what the API call does), API 3190 might not reveal how implementation module 3100 accomplishes the function specified by the API call. Various API calls are transferred via the one or more application programming interfaces between API-calling module 3180 and implementation module 3100. Transferring the API calls can include issuing, initiating, invoking, calling, receiving, returning, and/or responding to the function calls or messages. In other words, transferring can describe actions by either of API-calling module 3180 or implementation module 3100. In some embodiments, a function call or other invocation of API 3190 sends and/or receives one or more parameters through a parameter list or other structure.

In some embodiments, implementation module 3100 provides more than one API, each providing a different view of or with different aspects of functionality implemented by implementation module 3100. For example, one API of implementation module 3100 can provide a first set of functions and can be exposed to third-party developers, and another API of implementation module 3100 can be hidden (e.g., not exposed) and provide a subset of the first set of functions and also provide another set of functions, such as testing or debugging functions which are not in the first set of functions. In some embodiments, implementation module 3100 calls one or more other components via an underlying API and thus is both an API-calling module and an implementation module. It should be recognized that implementation module 3100 can include additional functions, methods, classes, data structures, and/or other features that are not specified through API 3190 and are not available to API-calling module 3180. It should also be recognized that API-calling module 3180 can be on the same system as implementation module 3100 or can be located remotely and access implementation module 3100 using API 3190 over a network. In some embodiments, implementation module 3100, API 3190, and/or API-calling module 3180 is stored in a machine-readable medium, which includes any mechanism for storing information in a form readable by a machine (e.g., a computer or other data processing system). For example, a machine-readable medium can include magnetic disks, optical disks, random access memory; read only memory, and/or flash memory devices.

An application programming interface (API) is an interface between a first software process and a second software process that specifies a format for communication between the first software process and the second software process. Limited APIs (e.g., private APIs or partner APIs) are APIs that are accessible to a limited set of software processes (e.g., only software processes within an operating system or only software processes that are approved to access the limited APIs). Public APIs that are accessible to a wider set of software processes. Some APIs enable software processes to communicate about or set a state of one or more input devices (e.g., one or more touch sensors, proximity sensors, visual sensors, motion/orientation sensors, pressure sensors, intensity sensors, sound sensors, wireless proximity sensors, biometric sensors, buttons, switches, rotatable elements, and/or external controllers). Some APIs enable software processes to communicate about and/or set a state of one or more output generation components (e.g., one or more audio output generation components, one or more display generation components, and/or one or more tactile output generation components). Some APIs enable particular capabilities (e.g., scrolling, handwriting, text entry, image editing, and/or image creation) to be accessed, performed, and/or used by a software process (e.g., generating outputs for use by a software process based on input from the software process). Some APIs enable content from a software process to be inserted into a template and displayed in a user interface that has a layout and/or behaviors that are specified by the template.

Many software platforms include a set of frameworks that provides the core objects and core behaviors that a software developer needs to build software applications that can be used on the software platform. Software developers use these objects to display content onscreen, to interact with that content, and to manage interactions with the software platform. Software applications rely on the set of frameworks for their basic behavior, and the set of frameworks provides many ways for the software developer to customize the behavior of the application to match the specific needs of the software application. Many of these core objects and core behaviors are accessed via an API. An API will typically specify a format for communication between software processes, including specifying and grouping available variables, functions, and protocols. An API call (sometimes referred to as an API request) will typically be sent from a sending software process to a receiving software process as a way to accomplish one or more of the following: the sending software process requesting information from the receiving software process (e.g., for the sending software process to take action on), the sending software process providing information to the receiving software process (e.g., for the receiving software process to take action on), the sending software process requesting action by the receiving software process, or the sending software process providing information to the receiving software process about action taken by the sending software process. Interaction with a device (e.g., using a user interface) will in some circumstances include the transfer and/or receipt of one or more API calls (e.g., multiple API calls) between multiple different software processes (e.g., different portions of an operating system, an application and an operating system, or different applications) via one or more APIs (e.g., via multiple different APIs). For example, when an input is detected the direct sensor data is frequently processed into one or more input events that are provided (e.g., via an API) to a receiving software process that makes some determination based on the input events, and then sends (e.g., via an API) information to a software process to perform an operation (e.g., change a device state and/or user interface) based on the determination. While a determination and an operation performed in response could be made by the same software process, alternatively the determination could be made in a first software process and relayed (e.g., via an API) to a second software process, that is different from the first software process, that causes the operation to be performed by the second software process. Alternatively, the second software process could relay instructions (e.g., via an API) to a third software process that is different from the first software process and/or the second software process to perform the operation. It should be understood that some or all user interactions with a computer system could involve one or more API calls within a step of interacting with the computer system (e.g., between different software components of the computer system or between a software component of the computer system and a software component of one or more remote computer systems). It should be understood that some or all user interactions with a computer system could involve one or more API calls between steps of interacting with the computer system (e.g., between different software components of the computer system or between a software component of the computer system and a software component of one or more remote computer systems).

In some embodiments, the application can be any suitable type of application, including, for example, one or more of: a browser application, an application that functions as an execution environment for plug-ins, widgets or other applications, a fitness application, a health application, a digital payments application, a media application, a social network application, a messaging application, and/or a maps application.

In some embodiments, the application is an application that is pre-installed on the first computer system at purchase (e.g., a first-party application). In some embodiments, the application is an application that is provided to the first computer system via an operating system update file (e.g., a first-party application). In some embodiments, the application is an application that is provided via an application store. In some embodiments, the application store is pre-installed on the first computer system at purchase (e.g., a first-party application store) and allows download of one or more applications. In some embodiments, the application store is a third-party application store (e.g., an application store that is provided by another device, downloaded via a network, and/or read from a storage device). In some embodiments, the application is a third-party application (e.g., an app that is provided by an application store, downloaded via a network, and/or read from a storage device). In some embodiments, the application controls the first computer system to perform methods 700, 800, 1000, 1100, 1300, 1400, 1600, and/or 1800 (FIGS. 7, 8A-8B, 10, 11, 13, 14, 16, and/or 18) by calling an application programming interface (API) provided by the system process using one or more parameters.

In some embodiments, exemplary APIs provided by the system process include one or more of: a pairing API (e.g., for establishing secure connection, e.g., with an accessory), a device detection API (e.g., for locating nearby devices, e.g., media devices and/or smartphone), a payment API, a UIKit API (e.g., for generating user interfaces), a location detection API, a locator API, a maps API, a health sensor API, a sensor API, a messaging API, a push notification API, a streaming API, a collaboration API, a video conferencing API, an application store API, an advertising services API, a web browser API (e.g., WebKit API), a vehicle API, a networking API, a WiFi API, a Bluetooth API, an NFC API, a UWB API, a fitness API, a smart home API, contact transfer API, a photos API, a camera API, and/or an image processing API.

In some embodiments, at least one API is a software module (e.g., a collection of computer-readable instructions) that provides an interface that allows a different module (e.g., API-calling module 3180) to access and use one or more functions, methods, procedures, data structures, classes, and/or other services provided by an implementation module of the system process. The API can define one or more parameters that are passed between the API-calling module and the implementation module. In some embodiments, API 3190 defines a first API call that can be provided by API-calling module 3180. The implementation module is a system software module (e.g., a collection of computer-readable instructions) that is constructed to perform an operation in response to receiving an API call via the API. In some embodiments, the implementation module is constructed to provide an API response (via the API) as a result of processing an API call. In some embodiments, the implementation module is included in the device (e.g., 3150) that runs the application. In some embodiments, the implementation module is included in an electronic device that is separate from the device that runs the application.

Attention is now directed towards embodiments of user interfaces that are, optionally, implemented on, for example, portable multifunction device 100.

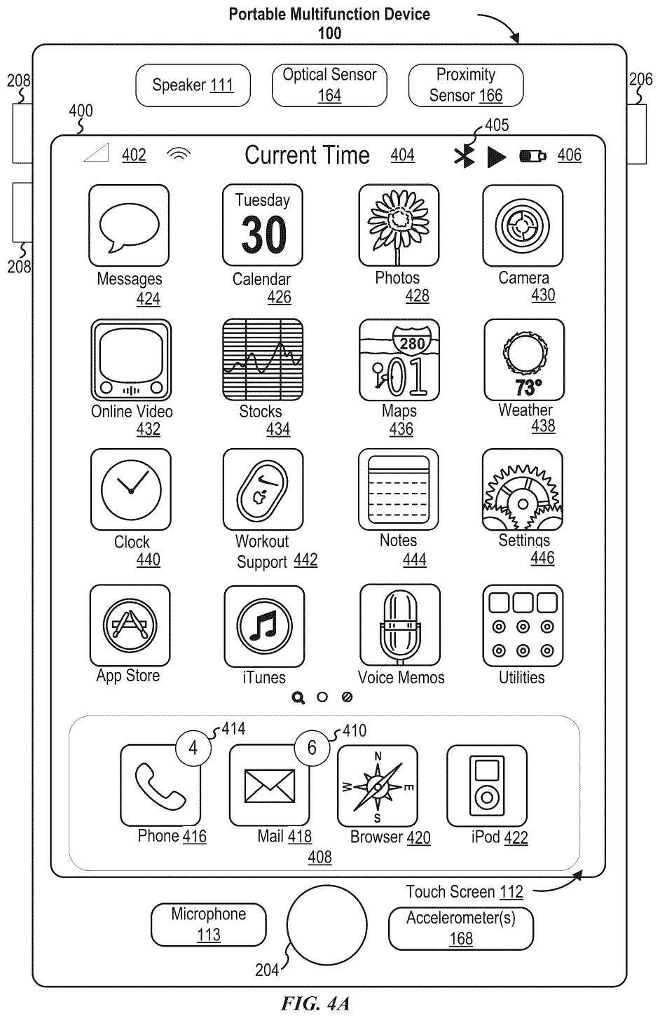

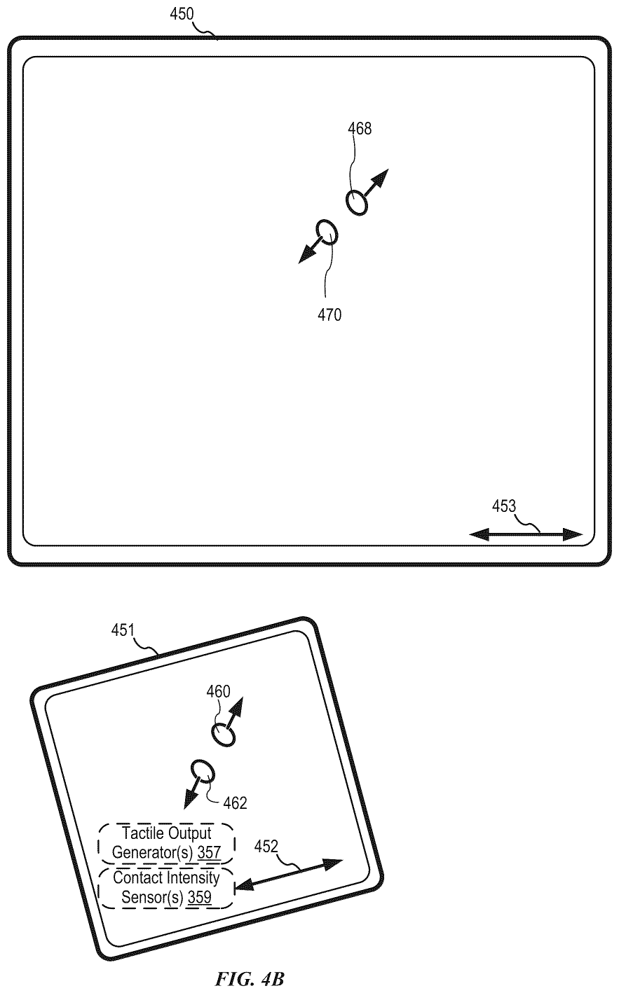

FIG. 4A illustrates an exemplary user interface for a menu of applications on portable multifunction device 100 in accordance with some embodiments. Similar user interfaces are, optionally, implemented on device 300. In some embodiments, user interface 400 includes the following elements, or a subset or superset thereof:
Signal strength indicator(s) 402 for wireless communication(s), such as cellular and Wi-Fi signals;
Time 404;
Bluetooth indicator 405;
Battery status indicator 406;
Tray 408 with icons for frequently used applications, such as:
   Icon 416 for telephone module 138, labeled “Phone,” which optionally includes an indicator 414 of the number of missed calls or voicemail messages;
   Icon 418 for e-mail client module 140, labeled “Mail,” which optionally includes an indicator 410 of the number of unread e-mails;
   Icon 420 for browser module 147, labeled “Browser;” and
   Icon 422 for video and music player module 152, also referred to as iPod (trademark of Apple Inc.) module 152, labeled “iPod;” and
Icons for other applications, such as:
   Icon 424 for IM module 141, labeled “Messages;”
   Icon 426 for calendar module 148, labeled “Calendar;”
   Icon 428 for image management module 144, labeled “Photos;”
   Icon 430 for camera module 143, labeled “Camera;”
   Icon 432 for online video module 155, labeled “Online Video;”
   Icon 434 for stocks widget 149-2, labeled “Stocks;”
   Icon 436 for map module 154, labeled “Maps;”
   Icon 438 for weather widget 149-1, labeled “Weather;”
   Icon 440 for alarm clock widget 149-4, labeled “Clock;”
   Icon 442 for workout support module 142, labeled “Workout Support;”
   Icon 444 for notes module 153, labeled “Notes;” and
   Icon 446 for a settings application or module, labeled “Settings,” which provides access to settings for device 100 and its various applications 136.

It should be noted that the icon labels illustrated in FIG. 4A are merely exemplary. For example, icon 422 for video and music player module 152 is labeled “Music” or “Music Player.” Other labels are, optionally, used for various application icons. In some embodiments, a label for a respective application icon includes a name of an application corresponding to the respective application icon. In some embodiments, a label for a particular application icon is distinct from a name of an application corresponding to the particular application icon.

FIG. 4B illustrates an exemplary user interface on a device (e.g., device 300, FIG. 3A) with a touch-sensitive surface 451 (e.g., a tablet or touchpad 355, FIG. 3A) that is separate from the display 450 (e.g., touch screen display 112). Device 300 also, optionally, includes one or more contact intensity sensors (e.g., one or more of sensors 359) for detecting intensity of contacts on touch-sensitive surface 451 and/or one or more tactile output generators 357 for generating tactile outputs for a user of device 300.

Although some of the examples that follow will be given with reference to inputs on touch screen display 112 (where the touch-sensitive surface and the display are combined), in some embodiments, the device detects inputs on a touch-sensitive surface that is separate from the display, as shown in FIG. 4B. In some embodiments, the touch-sensitive surface (e.g., 451 in FIG. 4B) has a primary axis (e.g., 452 in FIG. 4B) that corresponds to a primary axis (e.g., 453 in FIG. 4B) on the display (e.g., 450). In accordance with these embodiments, the device detects contacts (e.g., 460 and 462 in FIG. 4B) with the touch-sensitive surface 451 at locations that correspond to respective locations on the display (e.g., in FIG. 4B, 460 corresponds to 468 and 462 corresponds to 470). In this way, user inputs (e.g., contacts 460 and 462, and movements thereof) detected by the device on the touch-sensitive surface (e.g., 451 in FIG. 4B) are used by the device to manipulate the user interface on the display (e.g., 450 in FIG. 4B) of the multifunction device when the touch-sensitive surface is separate from the display. It should be understood that similar methods are, optionally, used for other user interfaces described herein.

Additionally, while the following examples are given primarily with reference to finger inputs (e.g., finger contacts, finger tap gestures, finger swipe gestures), it should be understood that, in some embodiments, one or more of the finger inputs are replaced with input from another input device (e.g., a mouse-based input or stylus input). For example, a swipe gesture is, optionally, replaced with a mouse click (e.g., instead of a contact) followed by movement of the cursor along the path of the swipe (e.g., instead of movement of the contact). As another example, a tap gesture is, optionally, replaced with a mouse click while the cursor is located over the location of the tap gesture (e.g., instead of detection of the contact followed by ceasing to detect the contact). Similarly, when multiple user inputs are simultaneously detected, it should be understood that multiple computer mice are, optionally, used simultaneously, or a mouse and finger contacts are, optionally, used simultaneously.

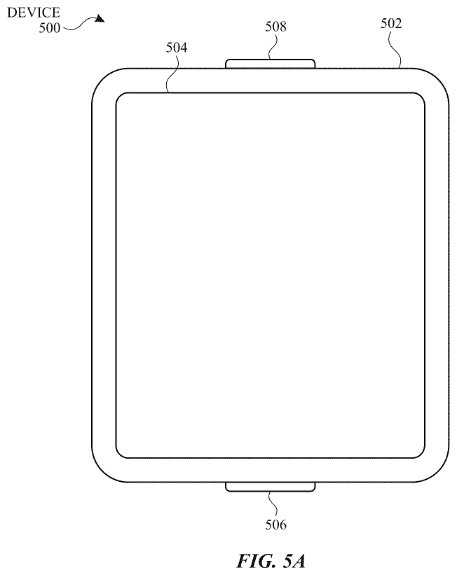

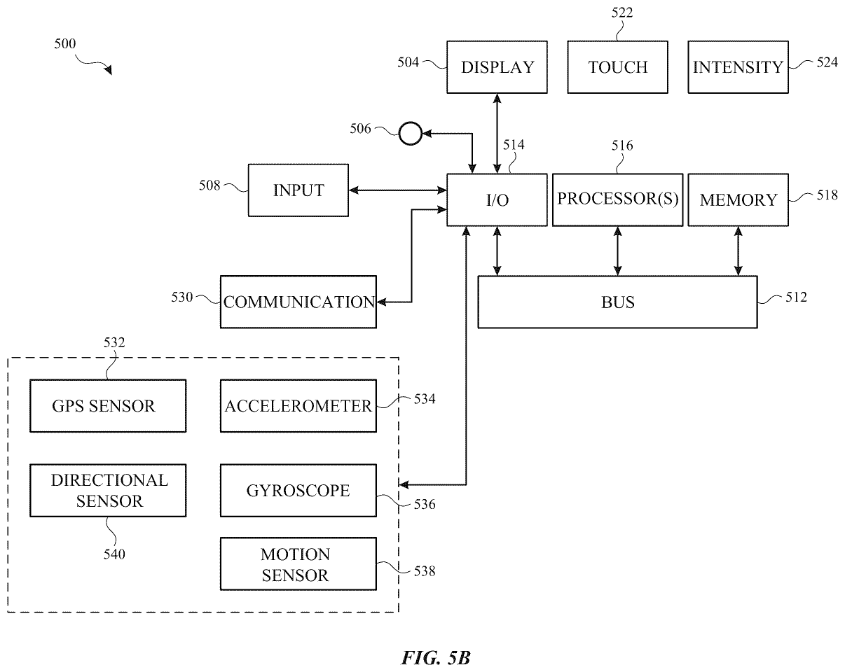

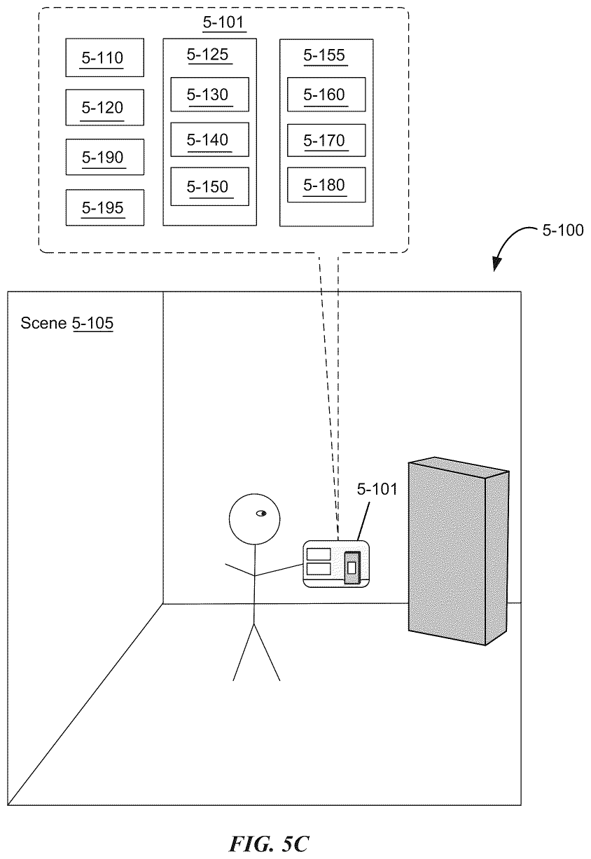

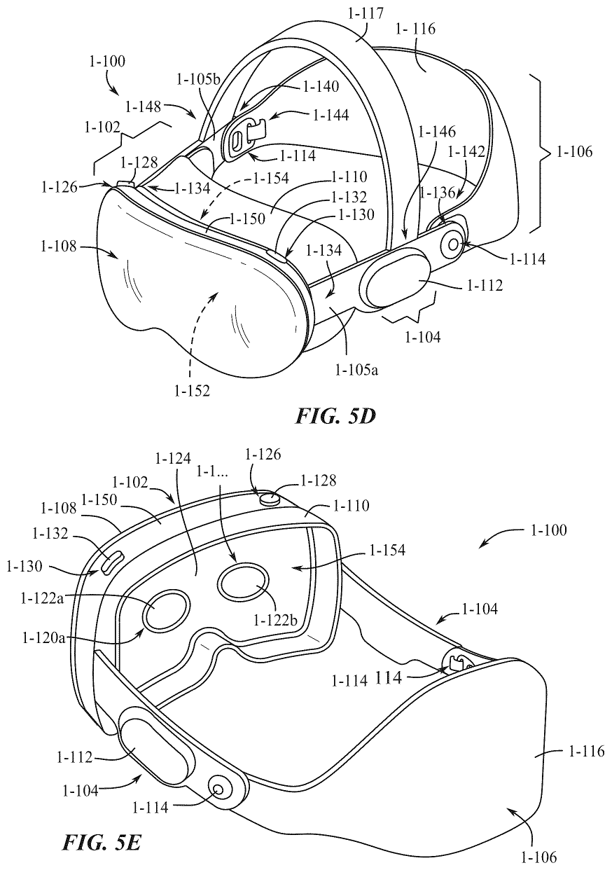

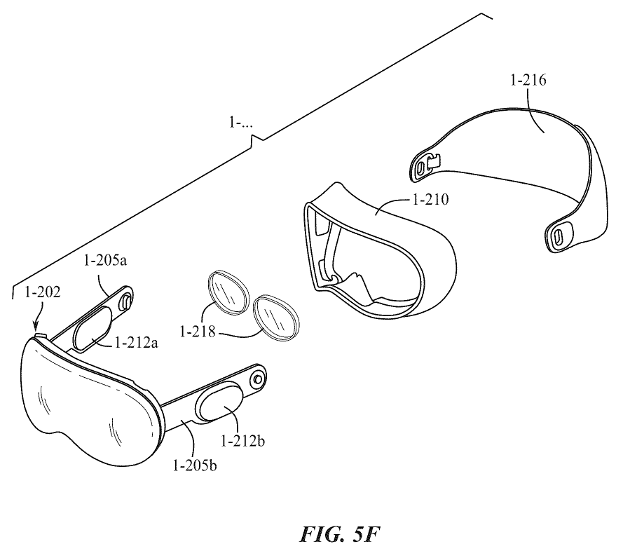

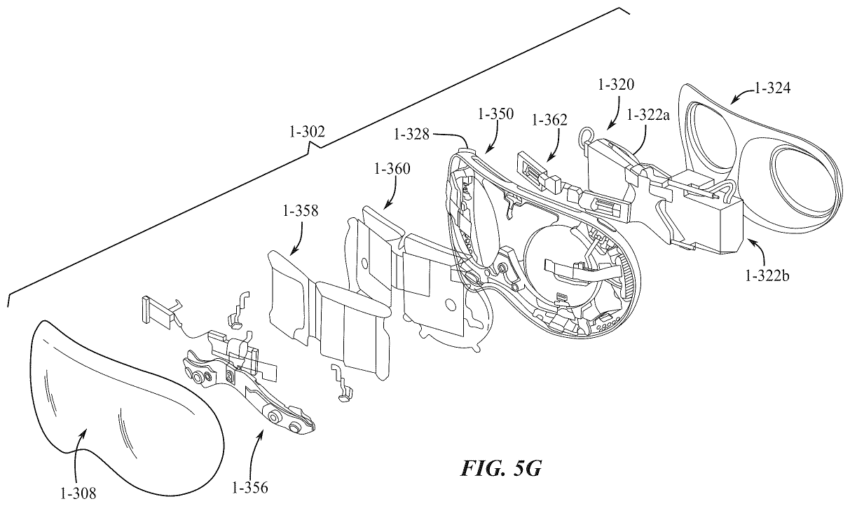

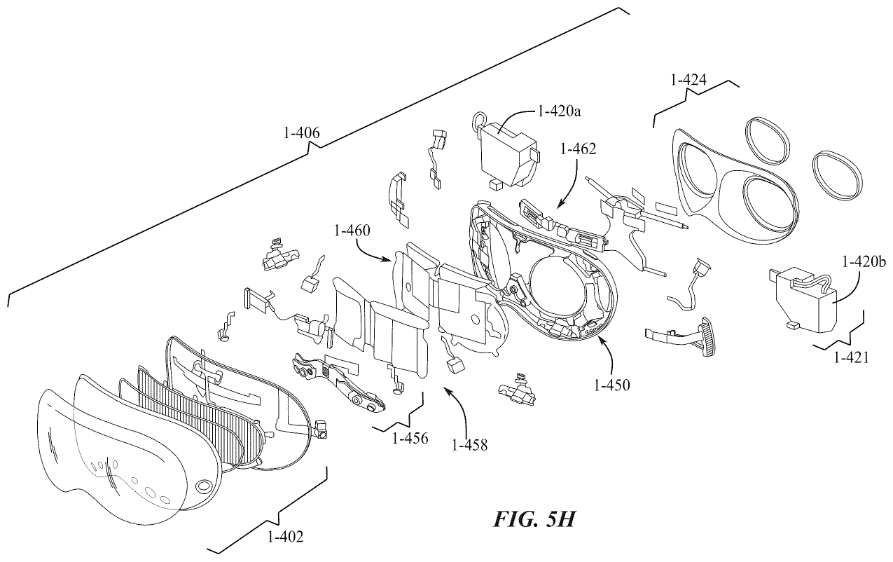

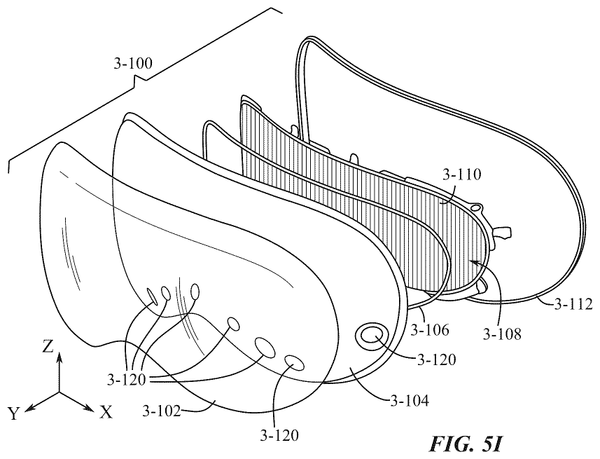

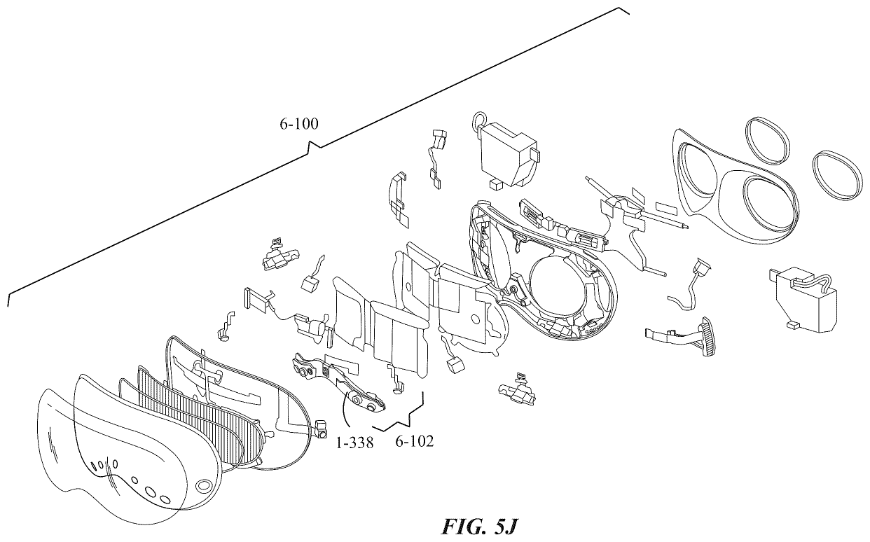

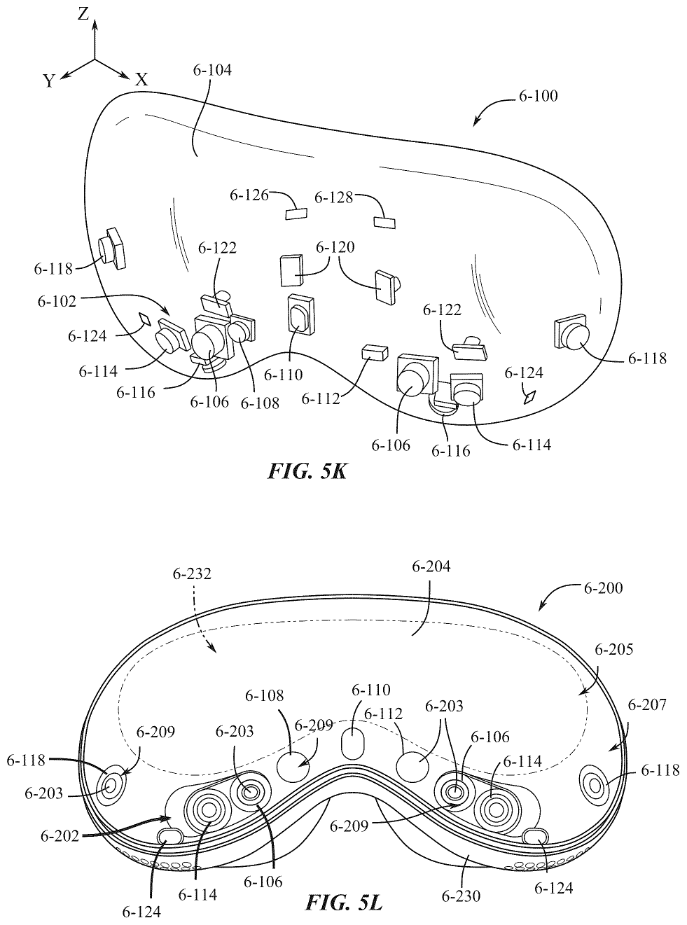

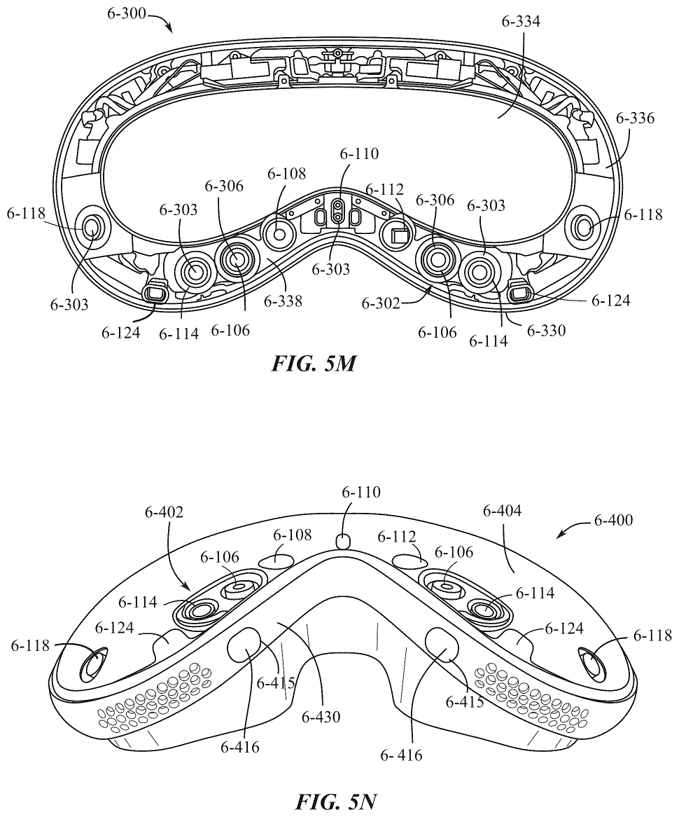

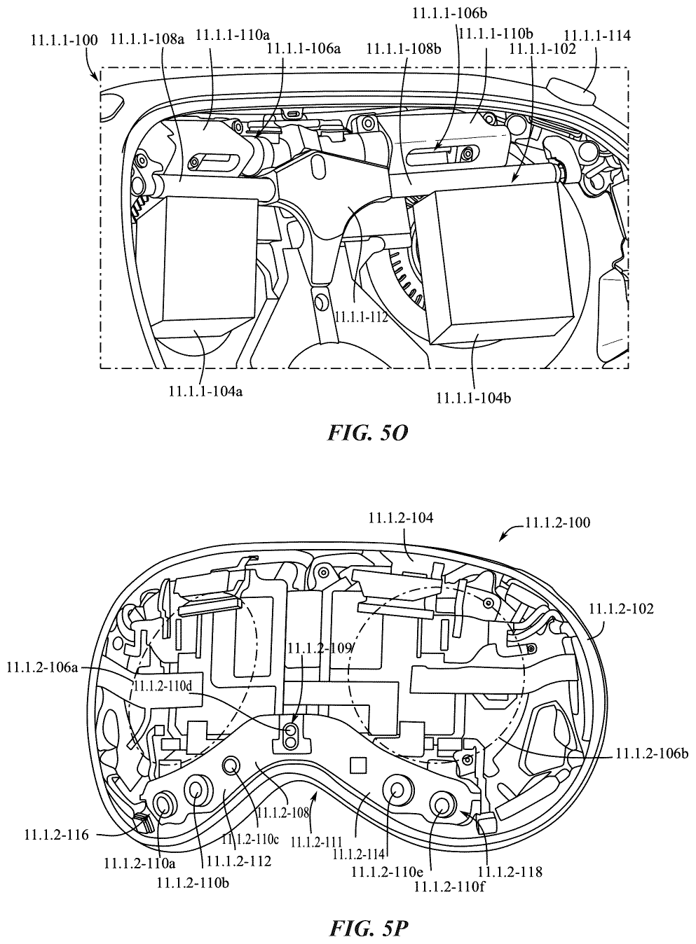

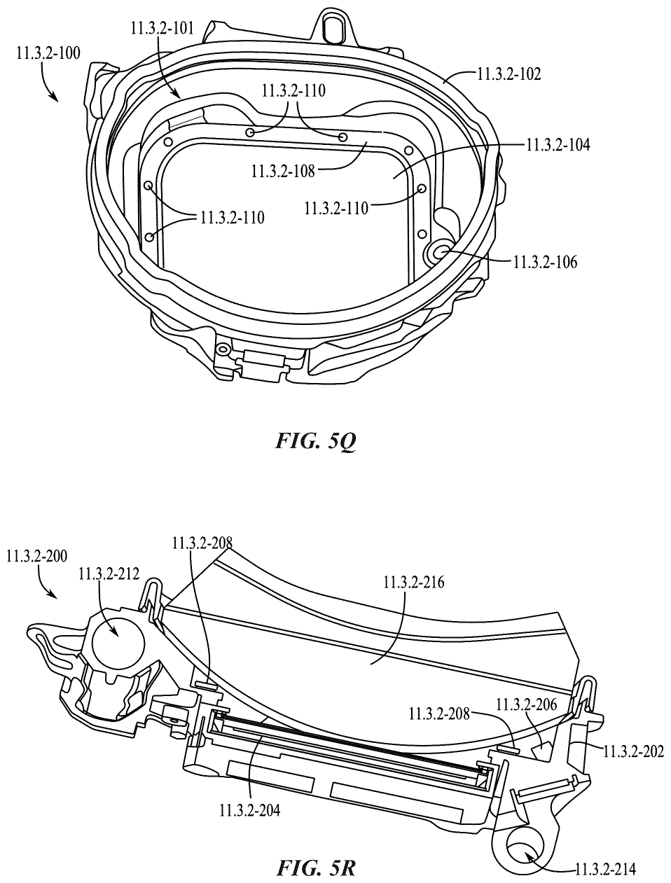

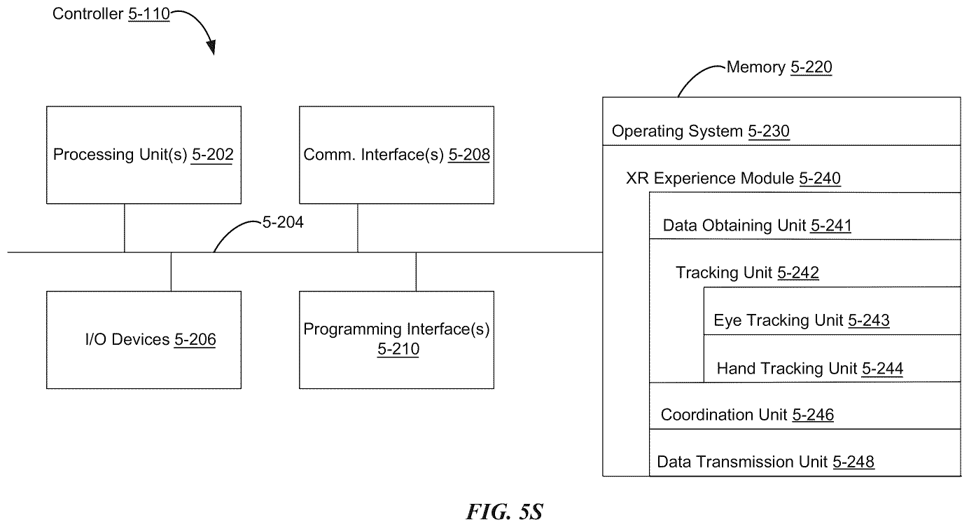

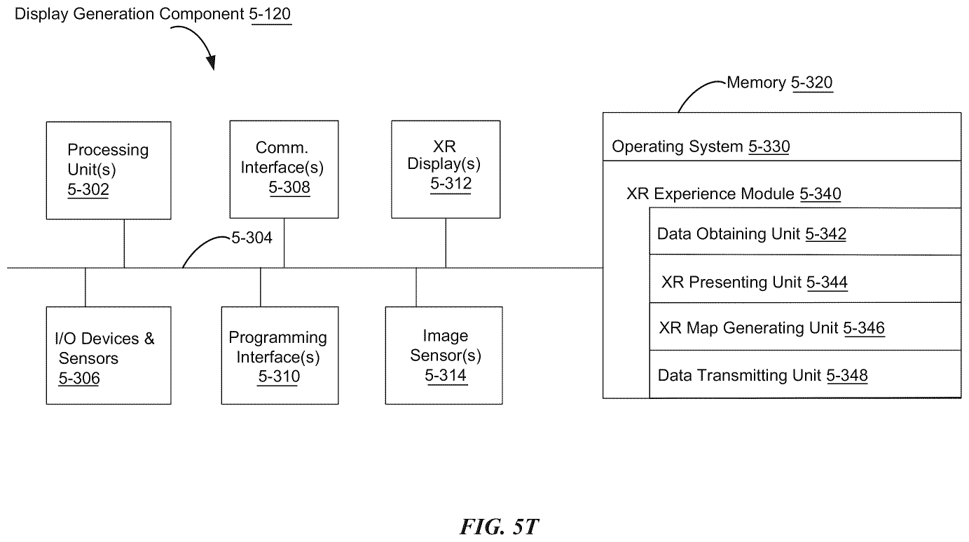

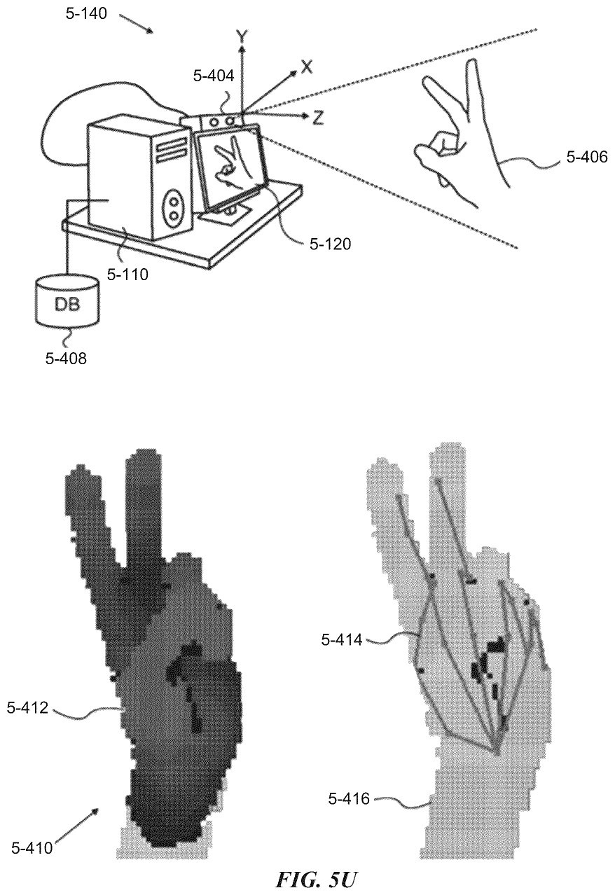

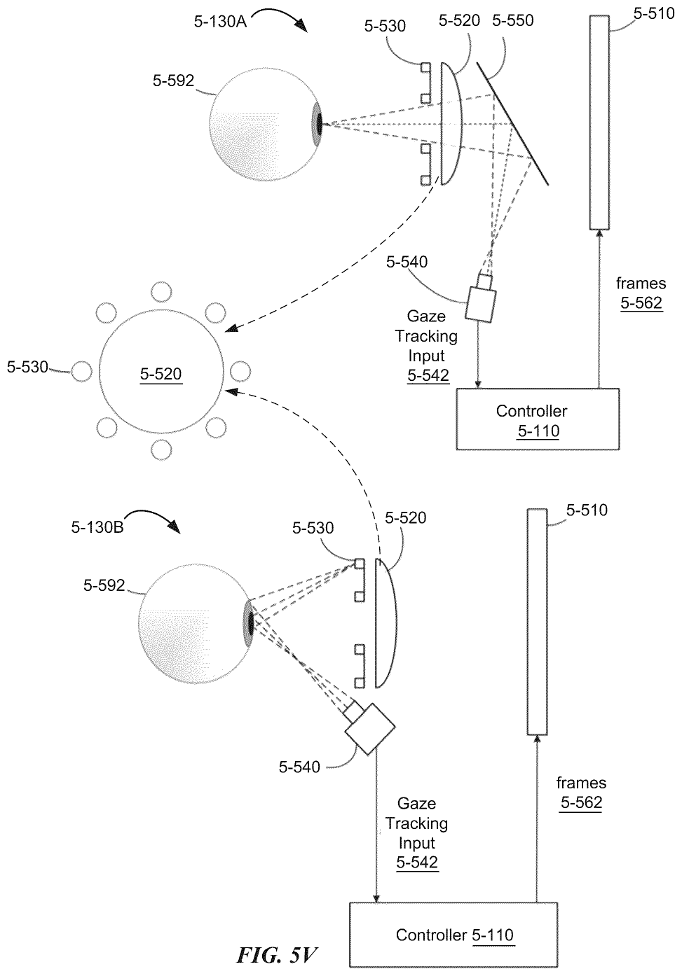

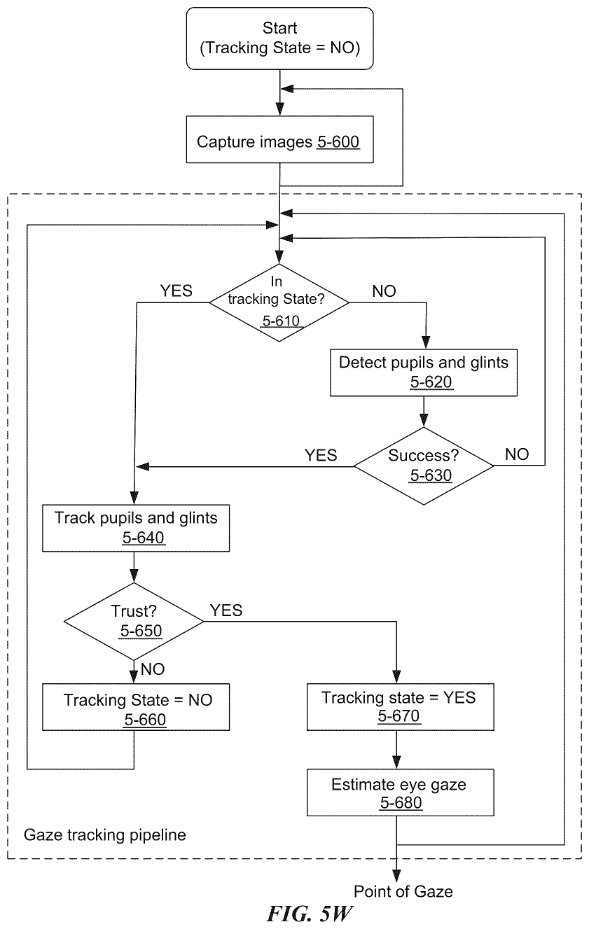

FIG. 5A illustrates exemplary personal electronic device 500. Device 500 includes body 502. In some embodiments, device 500 can include some or all of the features described with respect to devices 100 and 300 (e.g., FIGS. 1A-4B). In some embodiments, device 500 has touch-sensitive display screen 504, hereafter touch screen 504. Alternatively, or in addition to touch screen 504, device 500 has a display and a touch-sensitive surface. As with devices 100 and 300, in some embodiments, touch screen 504 (or the touch-sensitive surface) optionally includes one or more intensity sensors for detecting intensity of contacts (e.g., touches) being applied. The one or more intensity sensors of touch screen 504 (or the touch-sensitive surface) can provide output data that represents the intensity of touches. The user interface of device 500 can respond to touches based on their intensity, meaning that touches of different intensities can invoke different user interface operations on device 500.

Exemplary techniques for detecting and processing touch intensity are found, for example, in related applications: International Patent Application Serial No. PCT/US2013/040061, titled “Device, Method, and Graphical User Interface for Displaying User Interface Objects Corresponding to an Application,” filed May 8, 2013, published as WIPO Publication No. WO/2013/169849, and International Patent Application Serial No. PCT/US2013/069483, titled “Device, Method, and Graphical User Interface for Transitioning Between Touch Input to Display Output Relationships,” filed Nov. 11, 2013, published as WIPO Publication No. WO/2014/105276, each of which is hereby incorporated by reference in their entirety.

In some embodiments, device 500 has one or more input mechanisms 506 and 508. Input mechanisms 506 and 508, if included, can be physical. Examples of physical input mechanisms include push buttons and rotatable mechanisms. In some embodiments, device 500 has one or more attachment mechanisms. Such attachment mechanisms, if included, can permit attachment of device 500 with, for example, hats, eyewear, earrings, necklaces, shirts, jackets, bracelets, watch straps, chains, trousers, belts, shoes, purses, backpacks, and so forth. These attachment mechanisms permit device 500 to be worn by a user.

FIG. 5B depicts exemplary personal electronic device 500. In some embodiments, device 500 can include some or all of the components described with respect to FIGS. 1A, 1B, and 3A. Device 500 has bus 512 that operatively couples I/O section 514 with one or more computer processors 516 and memory 518. I/O section 514 can be connected to display 504, which can have touch-sensitive component 522 and, optionally, intensity sensor 524 (e.g., contact intensity sensor). In addition, I/O section 514 can be connected with communication unit 530 for receiving application and operating system data, using Wi-Fi, Bluetooth, near field communication (NFC), cellular, and/or other wireless communication techniques. Device 500 can include input mechanisms 506 and/or 508. Input mechanism 506 is, optionally, a rotatable input device or a depressible and rotatable input device, for example. Input mechanism 508 is, optionally, a button, in some examples.

Input mechanism 508 is, optionally, a microphone, in some examples. Personal electronic device 500 optionally includes various sensors, such as GPS sensor 532, accelerometer 534, directional sensor 540 (e.g., compass), gyroscope 536, motion sensor 538, and/or a combination thereof, all of which can be operatively connected to I/O section 514.

Memory 518 of personal electronic device 500 can include one or more non-transitory computer-readable storage mediums, for storing computer-executable instructions, which, when executed by one or more computer processors 516, for example, can cause the computer processors to perform the techniques described below, including processes 700, 800, 1000, and/or 1100 (FIGS. 7, 8A-8B, 10, and 11). A computer-readable storage medium can be any medium that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on CD, DVD, or Blu-ray technologies, as well as persistent solid-state memory such as flash, solid-state drives, and the like. Personal electronic device 500 is not limited to the components and configuration of FIG. 5B, but can include other or additional components in multiple configurations.

In some embodiments, as shown in FIG. 5C, the XR experience is provided to the user via an operating environment 5-100 that includes a computer system 5-101. The computer system 5-101 includes a controller 5-110 (e.g., processors of a portable electronic device or a remote server), a display generation component 5-120 (e.g., a head-mounted device (HMD), a display, a projector, a touch-screen, etc.), one or more input devices 5-125 (e.g., an eye tracking device 5-130, a hand tracking device 5-140, other input devices 5-150), one or more output devices 5-155 (e.g., speakers 5-160, tactile output generators 5-170, and other output devices 5-180), one or more sensors 5-190 (e.g., image sensors, light sensors, depth sensors, tactile sensors, orientation sensors, proximity sensors, temperature sensors, location sensors, motion sensors, velocity sensors, etc.), and optionally one or more peripheral devices 5-195 (e.g., home appliances, wearable devices, etc.). In some embodiments, one or more of the input devices 5-125, output devices 5-155, sensors 5-190, and peripheral devices 5-195 are integrated with the display generation component 5-120 (e.g., in a head-mounted device or a handheld device).

When describing an XR experience, various terms are used to differentially refer to several related but distinct environments that the user may sense and/or with which a user may interact (e.g., with inputs detected by a computer system 5-101 generating the XR experience that cause the computer system generating the XR experience to generate audio, visual, and/or tactile feedback corresponding to various inputs provided to the computer system 5-101). The following is a subset of these terms:

Physical environment: A physical environment refers to a physical world that people can sense and/or interact with without aid of electronic systems. Physical environments, such as a physical park, include physical articles, such as physical trees, physical buildings, and physical people. People can directly sense and/or interact with the physical environment, such as through sight, touch, hearing, taste, and smell.

Extended reality: In contrast, an extended reality (XR) environment refers to a wholly or partially simulated environment that people sense and/or interact with via an electronic system. In XR, a subset of a person's physical motions, or representations thereof, are tracked, and, in response, one or more characteristics of one or more virtual objects simulated in the XR environment are adjusted in a manner that comports with at least one law of physics. For example, a XR system may detect a person's head turning and, in response, adjust graphical content and an acoustic field presented to the person in a manner similar to how such views and sounds would change in a physical environment. In some situations (e.g., for accessibility reasons), adjustments to characteristic(s) of virtual object(s) in a XR environment may be made in response to representations of physical motions (e.g., vocal commands). A person may sense and/or interact with a XR object using any one of their senses, including sight, sound, touch, taste, and smell. For example, a person may sense and/or interact with audio objects that create a 3D or spatial audio environment that provides the perception of point audio sources in 3D space. In another example, audio objects may enable audio transparency, which selectively incorporates ambient sounds from the physical environment with or without computer-generated audio. In some XR environments, a person may sense and/or interact only with audio objects.

Examples of XR include virtual reality and mixed reality.

Virtual reality: A virtual reality (VR) environment refers to a simulated environment that is designed to be based entirely on computer-generated sensory inputs for one or more senses. A VR environment comprises a plurality of virtual objects with which a person may sense and/or interact. For example, computer-generated imagery of trees, buildings, and avatars representing people are examples of virtual objects. A person may sense and/or interact with virtual objects in the VR environment through a simulation of the person's presence within the computer-generated environment, and/or through a simulation of a subset of the person's physical movements within the computer-generated environment.

Mixed reality: In contrast to a VR environment, which is designed to be based entirely on computer-generated sensory inputs, a mixed reality (MR) environment refers to a simulated environment that is designed to incorporate sensory inputs from the physical environment, or a representation thereof, in addition to including computer-generated sensory inputs (e.g., virtual objects). On a virtuality continuum, a mixed reality environment is anywhere between, but not including, a wholly physical environment at one end and virtual reality environment at the other end. In some MR environments, computer-generated sensory inputs may respond to changes in sensory inputs from the physical environment. Also, some electronic systems for presenting an MR environment may track location and/or orientation with respect to the physical environment to enable virtual objects to interact with real objects (that is, physical articles from the physical environment or representations thereof). For example, a system may account for movements so that a virtual tree appears stationary with respect to the physical ground.

Examples of mixed realities include augmented reality and augmented virtuality.

Augmented reality: An augmented reality (AR) environment refers to a simulated environment in which one or more virtual objects are superimposed over a physical environment, or a representation thereof. For example, an electronic system for presenting an AR environment may have a transparent or translucent display through which a person may directly view the physical environment. The system may be configured to present virtual objects on the transparent or translucent display, so that a person, using the system, perceives the virtual objects superimposed over the physical environment. Alternatively, a system may have an opaque display and one or more imaging sensors that capture images or video of the physical environment, which are representations of the physical environment. The system composites the images or video with virtual objects, and presents the composition on the opaque display. A person, using the system, indirectly views the physical environment by way of the images or video of the physical environment, and perceives the virtual objects superimposed over the physical environment. As used herein, a video of the physical environment shown on an opaque display is called “pass-through video,” meaning a system uses one or more image sensor(s) to capture images of the physical environment, and uses those images in presenting the AR environment on the opaque display. Further alternatively, a system may have a projection system that projects virtual objects into the physical environment, for example, as a hologram or on a physical surface, so that a person, using the system, perceives the virtual objects superimposed over the physical environment. An augmented reality environment also refers to a simulated environment in which a representation of a physical environment is transformed by computer-generated sensory information. For example, in providing pass-through video, a system may transform one or more sensor images to impose a select perspective (e.g., viewpoint) different than the perspective captured by the imaging sensors. As another example, a representation of a physical environment may be transformed by graphically modifying (e.g., enlarging) portions thereof, such that the modified portion may be representative but not photorealistic versions of the originally captured images. As a further example, a representation of a physical environment may be transformed by graphically eliminating or obfuscating portions thereof.

Augmented virtuality: An augmented virtuality (AV) environment refers to a simulated environment in which a virtual or computer-generated environment incorporates one or more sensory inputs from the physical environment. The sensory inputs may be representations of one or more characteristics of the physical environment. For example, an AV park may have virtual trees and virtual buildings, but people with faces photorealistically reproduced from images taken of physical people. As another example, a virtual object may adopt a shape or color of a physical article imaged by one or more imaging sensors. As a further example, a virtual object may adopt shadows consistent with the position of the sun in the physical environment.

In an augmented reality, mixed reality, or virtual reality environment, a view of a three-dimensional environment is visible to a user. The view of the three-dimensional environment is typically visible to the user via one or more display generation components (e.g., a display or a pair of display modules that provide stereoscopic content to different eyes of the same user) through a virtual viewport that has a viewport boundary that defines an extent of the three-dimensional environment that is visible to the user via the one or more display generation components. In some embodiments, the region defined by the viewport boundary is smaller than a range of vision of the user in one or more dimensions (e.g., based on the range of vision of the user, size, optical properties or other physical characteristics of the one or more display generation components, and/or the location and/or orientation of the one or more display generation components relative to the eyes of the user). In some embodiments, the region defined by the viewport boundary is larger than a range of vision of the user in one or more dimensions (e.g., based on the range of vision of the user, size, optical properties or other physical characteristics of the one or more display generation components, and/or the location and/or orientation of the one or more display generation components relative to the eyes of the user). The viewport and viewport boundary typically move as the one or more display generation components move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location and direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include display generation components with virtual passthrough, portions of the physical environment that are visible (e.g., displayed, and/or projected) via the one or more display generation components are based on a field of view of one or more cameras in communication with the display generation components which typically move with the display generation components (e.g., moving with a head of the user for a head mounted device or moving with a hand of a user for a handheld device such as a tablet or smartphone) because the viewpoint of the user moves as the field of view of the one or more cameras moves (and the appearance of one or more virtual objects displayed via the one or more display generation components is updated based on the viewpoint of the user (e.g., displayed positions and poses of the virtual objects are updated based on the movement of the viewpoint of the user)). For display generation components with optical passthrough, portions of the physical environment that are visible (e.g., optically visible through one or more partially or fully transparent portions of the display generation component) via the one or more display generation components are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the display generation components moves (and the appearance of one or more virtual objects is updated based on the viewpoint of the user).

In some embodiments a representation of a physical environment (e.g., displayed via virtual passthrough or optical passthrough) can be partially or fully obscured by a virtual environment. In some embodiments, the amount of virtual environment that is displayed (e.g., the amount of physical environment that is not displayed) is based on an immersion level for the virtual environment (e.g., with respect to the representation of the physical environment). For example, increasing the immersion level optionally causes more of the virtual environment to be displayed, replacing and/or obscuring more of the physical environment, and reducing the immersion level optionally causes less of the virtual environment to be displayed, revealing portions of the physical environment that were previously not displayed and/or obscured. In some embodiments, at a particular immersion level, one or more first background objects (e.g., in the representation of the physical environment) are visually de-emphasized (e.g., dimmed, blurred, and/or displayed with increased transparency) more than one or more second background objects, and one or more third background objects cease to be displayed. In some embodiments, a level of immersion includes an associated degree to which the virtual content displayed by the computer system (e.g., the virtual environment and/or the virtual content) obscures background content (e.g., content other than the virtual environment and/or the virtual content) around/behind the virtual content, optionally including the number of items of background content displayed and/or the visual characteristics (e.g., colors, contrast, and/or opacity) with which the background content is displayed, the angular range of the virtual content displayed via the display generation component (e.g., 60 degrees of content displayed at low immersion, 120 degrees of content displayed at medium immersion, or 180 degrees of content displayed at high immersion), and/or the proportion of the field of view displayed via the display generation component that is consumed by the virtual content (e.g., 33% of the field of view consumed by the virtual content at low immersion, 66% of the field of view consumed by the virtual content at medium immersion, or 100% of the field of view consumed by the virtual content at high immersion). In some embodiments, the background content is included in a background over which the virtual content is displayed (e.g., background content in the representation of the physical environment). In some embodiments, the background content includes user interfaces (e.g., user interfaces generated by the computer system corresponding to applications), virtual objects (e.g., files or representations of other users generated by the computer system) not associated with or included in the virtual environment and/or virtual content, and/or real objects (e.g., pass-through objects representing real objects in the physical environment around the user that are visible such that they are displayed via the display generation component and/or a visible via a transparent or translucent component of the display generation component because the computer system does not obscure/prevent visibility of them through the display generation component). In some embodiments, at a low level of immersion (e.g., a first level of immersion), the background, virtual and/or real objects are displayed in an unobscured manner. For example, a virtual environment with a low level of immersion is optionally displayed concurrently with the background content, which is optionally displayed with full brightness, color, and/or translucency. In some embodiments, at a higher level of immersion (e.g., a second level of immersion higher than the first level of immersion), the background, virtual and/or real objects are displayed in an obscured manner (e.g., dimmed, blurred, or removed from display). For example, a respective virtual environment with a high level of immersion is displayed without concurrently displaying the background content (e.g., in a full screen or fully immersive mode). As another example, a virtual environment displayed with a medium level of immersion is displayed concurrently with darkened, blurred, or otherwise de-emphasized background content. In some embodiments, the visual characteristics of the background objects vary among the background objects. For example, at a particular immersion level, one or more first background objects are visually de-emphasized (e.g., dimmed, blurred, and/or displayed with increased transparency) more than one or more second background objects, and one or more third background objects cease to be displayed. In some embodiments, a null or zero level of immersion corresponds to the virtual environment ceasing to be displayed and instead a representation of a physical environment is displayed (optionally with one or more virtual objects such as application, windows, or virtual three-dimensional objects) without the representation of the physical environment being obscured by the virtual environment. Adjusting the level of immersion using a physical input element provides for quick and efficient method of adjusting immersion, which enhances the operability of the computer system and makes the user-device interface more efficient.

Viewpoint-locked virtual object: A virtual object is viewpoint-locked when a computer system displays the virtual object at the same location and/or position in the viewpoint of the user, even as the viewpoint of the user shifts (e.g., changes). In embodiments where the computer system is a head-mounted device, the viewpoint of the user is locked to the forward facing direction of the user's head (e.g., the viewpoint of the user is at least a portion of the field-of-view of the user when the user is looking straight ahead); thus, the viewpoint of the user remains fixed even as the user's gaze is shifted, without moving the user's head. In embodiments where the computer system has a display generation component (e.g., a display screen) that can be repositioned with respect to the user's head, the viewpoint of the user is the augmented reality view that is being presented to the user on a display generation component of the computer system. For example, a viewpoint-locked virtual object that is displayed in the upper left corner of the viewpoint of the user, when the viewpoint of the user is in a first orientation (e.g., with the user's head facing north) continues to be displayed in the upper left corner of the viewpoint of the user, even as the viewpoint of the user changes to a second orientation (e.g., with the user's head facing west). In other words, the location and/or position at which the viewpoint-locked virtual object is displayed in the viewpoint of the user is independent of the user's position and/or orientation in the physical environment. In embodiments in which the computer system is a head-mounted device, the viewpoint of the user is locked to the orientation of the user's head, such that the virtual object is also referred to as a “head-locked virtual object.”

Environment-locked virtual object: A virtual object is environment-locked (alternatively, “world-locked”) when a computer system displays the virtual object at a location and/or position in the viewpoint of the user that is based on (e.g., selected in reference to and/or anchored to) a location and/or object in the three-dimensional environment (e.g., a physical environment or a virtual environment). As the viewpoint of the user shifts, the location and/or object in the environment relative to the viewpoint of the user changes, which results in the environment-locked virtual object being displayed at a different location and/or position in the viewpoint of the user. For example, an environment-locked virtual object that is locked onto a tree that is immediately in front of a user is displayed at the center of the viewpoint of the user. When the viewpoint of the user shifts to the right (e.g., the user's head is turned to the right) so that the tree is now left-of-center in the viewpoint of the user (e.g., the tree's position in the viewpoint of the user shifts), the environment-locked virtual object that is locked onto the tree is displayed left-of-center in the viewpoint of the user. In other words, the location and/or position at which the environment-locked virtual object is displayed in the viewpoint of the user is dependent on the position and/or orientation of the location and/or object in the environment onto which the virtual object is locked. In some embodiments, the computer system uses a stationary frame of reference (e.g., a coordinate system that is anchored to a fixed location and/or object in the physical environment) in order to determine the position at which to display an environment-locked virtual object in the viewpoint of the user. An environment-locked virtual object can be locked to a stationary part of the environment (e.g., a floor, wall, table, or other stationary object) or can be locked to a moveable part of the environment (e.g., a vehicle, animal, person, or even a representation of portion of the users body that moves independently of a viewpoint of the user, such as a user's hand, wrist, arm, or foot) so that the virtual object is moved as the viewpoint or the portion of the environment moves to maintain a fixed relationship between the virtual object and the portion of the environment.

In some embodiments a virtual object that is environment-locked or viewpoint-locked exhibits lazy follow behavior which reduces or delays motion of the environment-locked or viewpoint-locked virtual object relative to movement of a point of reference which the virtual object is following. In some embodiments, when exhibiting lazy follow behavior the computer system intentionally delays movement of the virtual object when detecting movement of a point of reference (e.g., a portion of the environment, the viewpoint, or a point that is fixed relative to the viewpoint, such as a point that is between 5-300 cm from the viewpoint) which the virtual object is following. For example, when the point of reference (e.g., the portion of the environment or the viewpoint) moves with a first speed, the virtual object is moved by the device to remain locked to the point of reference but moves with a second speed that is slower than the first speed (e.g., until the point of reference stops moving or slows down, at which point the virtual object starts to catch up to the point of reference). In some embodiments, when a virtual object exhibits lazy follow behavior the device ignores small amounts of movement of the point of reference (e.g., ignoring movement of the point of reference that is below a threshold amount of movement such as movement by 0-5 degrees or movement by 0-50 cm). For example, when the point of reference (e.g., the portion of the environment or the viewpoint to which the virtual object is locked) moves by a first amount, a distance between the point of reference and the virtual object increases (e.g., because the virtual object is being displayed so as to maintain a fixed or substantially fixed position relative to a viewpoint or portion of the environment that is different from the point of reference to which the virtual object is locked) and when the point of reference (e.g., the portion of the environment or the viewpoint to which the virtual object is locked) moves by a second amount that is greater than the first amount, a distance between the point of reference and the virtual object initially increases (e.g., because the virtual object is being displayed so as to maintain a fixed or substantially fixed position relative to a viewpoint or portion of the environment that is different from the point of reference to which the virtual object is locked) and then decreases as the amount of movement of the point of reference increases above a threshold (e.g., a “lazy follow” threshold) because the virtual object is moved by the computer system to maintain a fixed or substantially fixed position relative to the point of reference. In some embodiments the virtual object maintaining a substantially fixed position relative to the point of reference includes the virtual object being displayed within a threshold distance (e.g., 1, 2, 3, 5, 15, 20, or 50 cm) of the point of reference in one or more dimensions (e.g., up/down, left/right, and/or forward/backward relative to the position of the point of reference).

In some embodiments, spatial media includes spatial visual media and/or spatial audio. In some embodiments, a spatial capture is a capture of spatial media. In some embodiments, spatial visual media (also referred to as stereoscopic media) (e.g., a spatial image and/or a spatial video) is media that includes two different images or sets of images, representing two perspectives of the same or overlapping fields-of-view, for concurrent display. A first image representing a first perspective is presented to a first eye of the viewer and a second image representing a second perspective, different from the first perspective, is concurrently presented to a second eye of the viewer. The first image and the second image have the same or overlapping fields-of-view. In some embodiments, a computer system displays the first image via a first display that is positioned for viewing by the first eye of the viewer and concurrently displays the second image via a second display, different from the first display, that is position for viewing by the second eye of the viewer. In some embodiments, the first image and the second image, when viewed together, create a depth effect and provide the viewer with depth perception for the contents of the images. In some embodiments, a first video representing a first perspective is presented to a first eye of the viewer and a second video representing a second perspective, different from the first perspective, is concurrently presented to a second eye of the viewer. The first video and the second video have the same or overlapping fields-of-view. In some embodiments, the first video and the second video, when viewed together, create a depth effect and provide the viewer with depth perception for the contents of the videos. In some embodiments, spatial audio experiences in headphones are produced by manipulating sounds in the headphone's two audio channels (e.g., left and right) so that they resemble directional sounds arriving in the ear-canal. For example, the headphones can reproduce a spatial audio signal that simulates a soundscape around the listener (also referred to as the user). An effective spatial sound reproduction can render sounds such that the listener perceives the sound as coming from a location within the soundscape external to the listener's head, just as the listener would experience the sound if encountered in the real world.

The geometry of the listener's ear, and in particular the outer ear (pinna), has a significant effect on the sound that arrives from a sound source to a listener's eardrum. The spatial audio sound experience is possible by taking into account the effect of the listener's pinna, the listener's head, and/or the listener's torso to the sound that enters to the listener's ear-canal. The geometry of the user's ear is optionally determined by using a three-dimensional scanning device that produces a three-dimensional model of at least a portion of the visible parts of the user's ear. This geometry is optionally used to produce a filter for producing the spatial audio experience. In some embodiments, spatial audio is audio that has been filtered such that a listener of the audio perceives the audio as coming from one or more directions and/or locations in three-dimensional space (e.g., from above, below, and/or in front of the listener).

An example of such a filter is a Head-Related Transfer Function (HRTF) filter. These filters are used to provide an effect that is similar to how a human ear, head, and torso filter sounds. When the geometry of the ears of a listener is known, a personalized filter (e.g., a personalized HRTF filter) can be produced so that the sound experienced by that listener through headphones (e.g., in-ear headphones, on-ear headphones, and/or over-ear headphones) is more realistic. In some embodiments, two filters are produced-one filter per ear-so that each ear of the listener has a corresponding personalized filter (e.g., personalized HRTF filter), as the ears of the listener may be of different geometry.

In some embodiments, a HRTF filter includes some (or all) acoustic information required to describe how sound reflects or diffracts around a listener's head before entering the listener's auditory system. In some embodiments, a personalized HRTF filter can be selected from a database of previously determined HRTFs for users having similar anatomical characteristics. In some embodiments, a personalized HRTF filter can be generated by numerical modeling based on the geometry of the listener's ear. One or more processors of the computer system optionally apply the personalized HRTF filter for the listener to an audio input signal to generate a spatial input signal for playback by headphones that are connected (e.g., wirelessly or by wire) to the computer system.

Hardware: There are many different types of electronic systems that enable a person to sense and/or interact with various XR environments. Examples include head-mounted systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mounted system may include speakers and/or other audio output devices integrated into the head-mounted system for providing audio output. A head-mounted system may have one or more speaker(s) and an integrated opaque display. Alternatively, a head-mounted system may be configured to accept an external opaque display (e.g., a smartphone). The head-mounted system may incorporate one or more imaging sensors to capture images or video of the physical environment, and/or one or more microphones to capture audio of the physical environment. Rather than an opaque display, a head-mounted system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In one embodiment, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface. In some embodiments, the controller 5-110 is configured to manage and coordinate a XR experience for the user. In some embodiments, the controller 5-110 includes a suitable combination of software, firmware, and/or hardware. The controller 5-110 is described in greater detail below with respect to FIG. 5S. In some embodiments, the controller 5-110 is a computing device that is local or remote relative to the scene 5-105 (e.g., a physical environment). For example, the controller 5-110 is a local server located within the scene 5-105. In another example, the controller 5-110 is a remote server located outside of the scene 5-105 (e.g., a cloud server, central server, etc.). In some embodiments, the controller 5-110 is communicatively coupled with the display generation component 5-120 (e.g., an HMD, a display, a projector, a touchscreen, etc.) via one or more wired or wireless communication channels (e.g., BLUETOOTH, IEEE 802.11x, IEEE 802.16x, IEEE 802.3x, etc.). In another example, the controller 5-110 is included within the enclosure (e.g., a physical housing) of the display generation component 5-120 (e.g., an HMD, or a portable electronic device that includes a display and one or more processors, etc.), one or more of the input devices 5-125, one or more of the output devices 5-155, one or more of the sensors 5-190, and/or one or more of the peripheral devices 5-195, or share the same physical enclosure or support structure with one or more of the above.

In some embodiments, the display generation component 5-120 is configured to provide the XR experience (e.g., at least a visual component of the XR experience) to the user. In some embodiments, the display generation component 5-120 includes a suitable combination of software, firmware, and/or hardware. The display generation component 5-120 is described in greater detail below with respect to FIG. 5T. In some embodiments, the functionalities of the controller 5-110 are provided by and/or combined with the display generation component 5-120.

According to some embodiments, the display generation component 5-120 provides an XR experience to the user while the user is virtually and/or physically present within the scene 5-105.

In some embodiments, the display generation component is worn on a part of the user's body (e.g., on his/her head, on his/her hand, etc.). As such, the display generation component 5-120 includes one or more XR displays provided to display the XR content. For example, in various embodiments, the display generation component 5-120 encloses the field-of-view of the user. In some embodiments, the display generation component 5-120 is a handheld device (such as a smartphone or tablet) configured to present XR content, and the user holds the device with a display directed towards the field-of-view of the user and a camera directed towards the scene 5-105. In some embodiments, the handheld device is optionally placed within an enclosure that is worn on the head of the user. In some embodiments, the handheld device is optionally placed on a support (e.g., a tripod) in front of the user. In some embodiments, the display generation component 5-120 is a XR chamber, enclosure, or room configured to present XR content in which the user does not wear or hold the display generation component 5-120. Many user interfaces described with reference to one type of hardware for displaying XR content (e.g., a handheld device or a device on a tripod) could be implemented on another type of hardware for displaying XR content (e.g., an HMD or other wearable computing device). For example, a user interface showing interactions with XR content triggered based on interactions that happen in a space in front of a handheld or tripod mounted device could similarly be implemented with an HMD where the interactions happen in a space in front of the HMD and the responses of the XR content are displayed via the HMD. Similarly, a user interface showing interactions with XR content triggered based on movement of a handheld or tripod mounted device relative to the physical environment (e.g., the scene 5-105 or a part of the user's body (e.g., the user's eye(s), head, or hand)) could similarly be implemented with an HMD where the movement is caused by movement of the HMD relative to the physical environment (e.g., the scene 5-105 or a part of the user's body (e.g., the user's eye(s), head, or hand)).

While pertinent features of the operating environment 5-100 are shown in FIG. 5C, those of ordinary skill in the art will appreciate from the present disclosure that various other features have not been illustrated for the sake of brevity and so as not to obscure more pertinent aspects of the example embodiments disclosed herein.

FIGS. 5C-5R illustrate various examples of a computer system that is used to perform the methods and provide audio, visual and/or haptic feedback as part of user interfaces described herein. In some embodiments, the computer system includes one or more display generation components (e.g., first and second display assemblies 1-120a, 1-120b and/or first and second optical modules 11.1.1-104a and 11.1.1-104b) for displaying virtual elements and/or a representation of a physical environment to a user of the computer system, optionally generated based on detected events and/or user inputs detected by the computer system. User interfaces generated by the computer system are optionally corrected by one or more corrective lenses 11.3.2-216 that are optionally removably attached to one or more of the optical modules to enable the user interfaces to be more easily viewed by users who would otherwise use glasses or contacts to correct their vision. While many user interfaces illustrated herein show a single view of a user interface, user interfaces in a HMD are optionally displayed using two optical modules (e.g., first and second display assemblies 1-120a, 1-120b and/or first and second optical modules 11.1.1-104a and 11.1.1-104b), one for a user's right eye and a different one for a user's left eye, and slightly different images are presented to the two different eyes to generate the illusion of stereoscopic depth, the single view of the user interface would typically be either a right-eye or left-eye view and the depth effect is explained in the text or using other schematic charts or views. In some embodiments, the computer system includes one or more external displays (e.g., display assembly 1-108) for displaying status information for the computer system to the user of the computer system (when the computer system is not being worn) and/or to other people who are near the computer system, optionally generated based on detected events and/or user inputs detected by the computer system. In some embodiments, the computer system includes one or more audio output components (e.g., electronic component 1-112) for generating audio feedback, optionally generated based on detected events and/or user inputs detected by the computer system. In some embodiments, the computer system includes one or more input devices for detecting input such as one or more sensors (e.g., one or more sensors in sensor assembly 1-356, and/or FIG. 5K) for detecting information about a physical environment of the device which can be used (optionally in conjunction with one or more illuminators such as the illuminators described in FIG. 5K) to generate a digital passthrough image, capture visual media corresponding to the physical environment (e.g., photos and/or video), or determine a pose (e.g., position and/or orientation) of physical objects and/or surfaces in the physical environment so that virtual objects ban be placed based on a detected pose of physical objects and/or surfaces. In some embodiments, the computer system includes one or more input devices for detecting input such as one or more sensors for detecting hand position and/or movement (e.g., one or more sensors in sensor assembly 1-356, and/or FIG. 5K) that can be used (optionally in conjunction with one or more illuminators such as the illuminators 6-124 described in FIG. 5K) to determine when one or more air gestures have been performed. In some embodiments, the computer system includes one or more input devices for detecting input such as one or more sensors for detecting eye movement (e.g., eye tracking and gaze tracking sensors in FIG. 5K) which can be used (optionally in conjunction with one or more lights such as lights 11.3.2-110 in FIG. 5Q) to determine attention or gaze position and/or gaze movement which can optionally be used to detect gaze-only inputs based on gaze movement and/or dwell. A combination of the various sensors described above can be used to determine user facial expressions and/or hand movements for use in generating an avatar or representation of the user such as an anthropomorphic avatar or representation for use in a real-time communication session where the avatar has facial expressions, hand movements, and/or body movements that are based on or similar to detected facial expressions, hand movements, and/or body movements of a user of the device. Gaze and/or attention information is, optionally, combined with hand tracking information to determine interactions between the user and one or more user interfaces based on direct and/or indirect inputs such as air gestures or inputs that use one or more hardware input devices such as one or more buttons (e.g., first button 1-128, button 11.1.1-114, second button 1-132, and or dial or button 1-328), knobs (e.g., first button 1-128, button 11.1.1-114, and/or dial or button 1-328), digital crowns (e.g., first button 1-128 which is depressible and twistable or rotatable, button 11.1.1-114, and/or dial or button 1-328), trackpads, touch screens, keyboards, mice and/or other input devices. One or more buttons (e.g., first button 1-128, button 11.1.1-114, second button 1-132, and or dial or button 1-328) are optionally used to perform system operations such as recentering content in three-dimensional environment that is visible to a user of the device, displaying a home user interface for launching applications, starting real-time communication sessions, or initiating display of virtual three-dimensional backgrounds. Knobs or digital crowns (e.g., first button 1-128 which is depressible and twistable or rotatable, button 11.1.1-114, and/or dial or button 1-328) are optionally rotatable to adjust parameters of the visual content such as a level of immersion of a virtual three-dimensional environment (e.g., a degree to which virtual-content occupies the viewport of the user into the three-dimensional environment) or other parameters associated with the three-dimensional environment and the virtual content that is displayed via the optical modules (e.g., first and second display assemblies 1-120a, 1-120b and/or first and second optical modules 11.1.1-104a and 11.1.1-104b).

FIG. 5D illustrates a front, top, perspective view of an example of a head-mountable display (HMD) device 1-100 configured to be donned by a user and provide virtual and altered/mixed reality (VR/AR) experiences. The HMD 1-100 can include a display unit 1-102 or assembly, an electronic strap assembly 1-104 connected to and extending from the display unit 1-102, and a band assembly 1-106 secured at either end to the electronic strap assembly 1-104. The electronic strap assembly 1-104 and the band 1-106 can be part of a retention assembly configured to wrap around a user's head to hold the display unit 1-102 against the face of the user.

In at least one example, the band assembly 1-106 can include a first band 1-116 configured to wrap around the rear side of a user's head and a second band 1-117 configured to extend over the top of a user's head. The second strap can extend between first and second electronic straps 1-105a, 1-105b of the electronic strap assembly 1-104 as shown. The strap assembly 1-104 and the band assembly 1-106 can be part of a securement mechanism extending rearward from the display unit 1-102 and configured to hold the display unit 1-102 against a face of a user.

In at least one example, the securement mechanism includes a first electronic strap 1-105a including a first proximal end 1-134 coupled to the display unit 1-102, for example a housing 1-150 of the display unit 1-102, and a first distal end 1-136 opposite the first proximal end 1-134. The securement mechanism can also include a second electronic strap 1-105b including a second proximal end 1-138 coupled to the housing 1-150 of the display unit 1-102 and a second distal end 1-140 opposite the second proximal end 1-138. The securement mechanism can also include the first band 1-116 including a first end 1-142 coupled to the first distal end 1-136 and a second end 1-144 coupled to the second distal end 1-140 and the second band 1-117 extending between the first electronic strap 1-105a and the second electronic strap 1-105b. The straps 1-105a-b and band 1-116 can be coupled via connection mechanisms or assemblies 1-114. In at least one example, the second band 1-117 includes a first end 1-146 coupled to the first electronic strap 1-105a between the first proximal end 1-134 and the first distal end 1-136 and a second end 1-148 coupled to the second electronic strap 1-105b between the second proximal end 1-138 and the second distal end 1-140.

In at least one example, the first and second electronic straps 1-105a-b include plastic, metal, or other structural materials forming the shape the substantially rigid straps 1-105a-b. In at least one example, the first and second bands 1-116, 1-117 are formed of elastic, flexible materials including woven textiles, rubbers, and the like. The first and second bands 1-116, 1-117 can be flexible to conform to the shape of the user′ head when donning the HMD 1-100.

In at least one example, one or more of the first and second electronic straps 1-105a-b can define internal strap volumes and include one or more electronic components disposed in the internal strap volumes. In one example, as shown in FIG. 5D, the first electronic strap 1-105a can include an electronic component 1-112. In one example, the electronic component 1-112 can include a speaker. In one example, the electronic component 1-112 can include a computing component such as a processor.

In at least one example, the housing 1-150 defines a first, front-facing opening 1-152. The front-facing opening is labeled in dotted lines at 1-152 in FIG. 5D because the display assembly 1-108 is disposed to occlude the first opening 1-152 from view when the HMD 1-100 is assembled. The housing 1-150 can also define a rear-facing second opening 1-154. The housing 1-150 also defines an internal volume between the first and second openings 1-152, 1-154. In at least one example, the HMD 1-100 includes the display assembly 1-108, which can include a front cover and display screen (shown in other figures) disposed in or across the front opening 1-152 to occlude the front opening 1-152. In at least one example, the display screen of the display assembly 1-108, as well as the display assembly 1-108 in general, has a curvature configured to follow the curvature of a user's face. The display screen of the display assembly 1-108 can be curved as shown to compliment the user's facial features and general curvature from one side of the face to the other, for example from left to right and/or from top to bottom where the display unit 1-102 is pressed.

In at least one example, the housing 1-150 can define a first aperture 1-126 between the first and second openings 1-152, 1-154 and a second aperture 1-130 between the first and second openings 1-152, 1-154. The HMD 1-100 can also include a first button 1-128 disposed in the first aperture 1-126 and a second button 1-132 disposed in the second aperture 1-130. The first and second buttons 1-128, 1-132 can be depressible through the respective apertures 1-126, 1-130. In at least one example, the first button 1-126 and/or second button 1-132 can be twistable dials as well as depressible buttons. In at least one example, the first button 1-128 is a depressible and twistable dial button and the second button 1-132 is a depressible button.

FIG. 5E illustrates a rear, perspective view of the HMD 1-100. The HMD 1-100 can include a light seal 1-110 extending rearward from the housing 1-150 of the display assembly 1-108 around a perimeter of the housing 1-150 as shown. The light seal 1-110 can be configured to extend from the housing 1-150 to the user's face around the user's eyes to block external light from being visible. In one example, the HMD 1-100 can include first and second display assemblies 1-120a, 1-120b disposed at or in the rearward facing second opening 1-154 defined by the housing 1-150 and/or disposed in the internal volume of the housing 1-150 and configured to project light through the second opening 1-154. In at least one example, each display assembly 1-120a-b can include respective display screens 1-122a, 1-122b configured to project light in a rearward direction through the second opening 1-154 toward the user's eyes.

In at least one example, referring to both FIGS. 5D and 5E, the display assembly 1-108 can be a front-facing, forward display assembly including a display screen configured to project light in a first, forward direction and the rear facing display screens 1-122a-b can be configured to project light in a second, rearward direction opposite the first direction. As noted above, the light seal 1-110 can be configured to block light external to the HMD 1-100 from reaching the user's eyes, including light projected by the forward-facing display screen of the display assembly 1-108 shown in the front perspective view of FIG. 5D. In at least one example, the HMD 1-100 can also include a curtain 1-124 occluding the second opening 1-154 between the housing 1-150 and the rear-facing display assemblies 1-120a-b. In at least one example, the curtain 1-124 can be elastic or at least partially elastic.

Any of the features, components, and/or parts, including the arrangements and configurations thereof shown in FIGS. 5D and 5E can be included, either alone or in any combination, in any of the other examples of devices, features, components, and parts shown in FIGS. 5F-5H and described herein. Likewise, any of the features, components, and/or parts, including the arrangements and configurations thereof shown and described with reference to FIGS. 5F-5H can be included, either alone or in any combination, in the example of the devices, features, components, and parts shown in FIGS. 5D and 5E.

FIG. 5F illustrates an exploded view of an example of an HMD 1-200 including various portions or parts thereof separated according to the modularity and selective coupling of those parts. For example, the HMD 1-200 can include a band 1-216 which can be selectively coupled to first and second electronic straps 1-205a, 1-205b. The first securement strap 1-205a can include a first electronic component 1-212a and the second securement strap 1-205b can include a second electronic component 1-212b. In at least one example, the first and second straps 1-205a-b can be removably coupled to the display unit 1-202.

In addition, the HMD 1-200 can include a light seal 1-210 configured to be removably coupled to the display unit 1-202. The HMD 1-200 can also include lenses 1-218 which can be removably coupled to the display unit 1-202, for example over first and second display assemblies including display screens. The lenses 1-218 can include customized prescription lenses configured for corrective vision. As noted, each part shown in the exploded view of FIG. 5F and described above can be removably coupled, attached, re-attached, and changed out to update parts or swap out parts for different users. For example, bands such as the band 1-216, light seals such as the light seal 1-210, lenses such as the lenses 1-218, and electronic straps such as the straps 1-205a-b can be swapped out depending on the user such that these parts are customized to fit and correspond to the individual user of the HMD 1-200.

Any of the features, components, and/or parts, including the arrangements and configurations thereof shown in FIG. 5F can be included, either alone or in any combination, in any of the other examples of devices, features, components, and parts shown in FIGS. 5D, 5E, and 5G-5H and described herein. Likewise, any of the features, components, and/or parts, including the arrangements and configurations thereof shown and described with reference to FIGS. 5D, 5E, and 5G-5H can be included, either alone or in any combination, in the example of the devices, features, components, and parts shown in FIG. 5F.

FIG. 5G illustrates an exploded view of an example of a display unit 1-302 of an HMD. The display unit 1-302 can include a front display assembly 1-308, a frame/housing assembly 1-350, and a curtain assembly 1-324. The display unit 1-302 can also include a sensor assembly 1-356, logic board assembly 1-358, and cooling assembly 1-360 disposed between the frame assembly 1-350 and the front display assembly 1-308. In at least one example, the display unit 1-302 can also include a rear-facing display assembly 1-320 including first and second rear-facing display screens 1-322a, 1-322b disposed between the frame 1-350 and the curtain assembly 1-324.

In at least one example, the display unit 1-302 can also include a motor assembly 1-362 configured as an adjustment mechanism for adjusting the positions of the display screens 1-322a-b of the display assembly 1-320 relative to the frame 1-350. In at least one example, the display assembly 1-320 is mechanically coupled to the motor assembly 1-362, with at least one motor for each display screen 1-322a-b, such that the motors can translate the display screens 1-322a-b to match an interpupillary distance of the user's eyes.

In at least one example, the display unit 1-302 can include a dial or button 1-328 depressible relative to the frame 1-350 and accessible to the user outside the frame 1-350. The button 1-328 can be electronically connected to the motor assembly 1-362 via a controller such that the button 1-328 can be manipulated by the user to cause the motors of the motor assembly 1-362 to adjust the positions of the display screens 1-322a-b.

Any of the features, components, and/or parts, including the arrangements and configurations thereof shown in FIG. 5G can be included, either alone or in any combination, in any of the other examples of devices, features, components, and parts shown in FIGS. 5D-5F and 5H and described herein. Likewise, any of the features, components, and/or parts, including the arrangements and configurations thereof shown and described with reference to FIGS. 5D-5F and 5H can be included, either alone or in any combination, in the example of the devices, features, components, and parts shown in FIG. 5G.

FIG. 5H illustrates an exploded view of another example of a display unit 1-406 of an HMD device similar to other HMD devices described herein. The display unit 1-406 can include a front display assembly 1-402, a sensor assembly 1-456, a logic board assembly 1-458, a cooling assembly 1-460, a frame assembly 1-450, a rear-facing display assembly 1-421, and a curtain assembly 1-424. The display unit 1-406 can also include a motor assembly 1-462 for adjusting the positions of first and second display sub-assemblies 1-420a, 1-420b of the rear-facing display assembly 1-421, including first and second respective display screens for interpupillary adjustments, as described above.

The various parts, systems, and assemblies shown in the exploded view of FIG. 5H are described in greater detail herein with reference to FIGS. 5D-5G as well as subsequent figures referenced in the present disclosure. The display unit 1-406 shown in FIG. 5H can be assembled and integrated with the securement mechanisms shown in FIGS. 5D-5G, including the electronic straps, bands, and other components including light seals, connection assemblies, and so forth.

Any of the features, components, and/or parts, including the arrangements and configurations thereof shown in FIG. 5H can be included, either alone or in any combination, in any of the other examples of devices, features, components, and parts shown in FIGS. 5D-5G and described herein. Likewise, any of the features, components, and/or parts, including the arrangements and configurations thereof shown and described with reference to FIGS. 5D-5G can be included, either alone or in any combination, in the example of the devices, features, components, and parts shown in FIG. 5H.

FIG. 5I illustrates a perspective, exploded view of a front cover assembly 3-100 of an HMD device described herein, for example the display assembly 1-108 of the HMD 1-100 shown in FIG. 5D or any other HMD device shown and described herein. The front cover assembly 3-100 shown in FIG. 5I can include a transparent or semi-transparent cover 3-102, shroud 3-104 (or “canopy”), adhesive layers 3-106, display assembly 3-108 including a lenticular lens panel or array 3-110, and a structural trim 3-112. The adhesive layer 3-106 can secure the shroud 3-104 and/or transparent cover 3-102 to the display assembly 3-108 and/or the trim 3-112. The trim 3-112 can secure the various components of the front cover assembly 3-100 to a frame or chassis of the HMD device.

In at least one example, as shown in FIG. 5I, the transparent cover 3-102, shroud 3-104, and display assembly 3-108, including the lenticular lens array 3-110, can be curved to accommodate the curvature of a user's face. The transparent cover 3-102 and the shroud 3-104 can be curved in two or three dimensions, e.g., vertically curved in the Z-direction in and out of the Z-X plane and horizontally curved in the X-direction in and out of the Z-X plane. In at least one example, the display assembly 3-108 can include the lenticular lens array 3-110 as well as a display panel having pixels configured to project light through the shroud 3-104 and the transparent cover 3-102. The display assembly 3-108 can be curved in at least one direction, for example the horizontal direction, to accommodate the curvature of a user's face from one side (e.g., left side) of the face to the other (e.g., right side). In at least one example, each layer or component of the display assembly 3-108, which will be shown in subsequent figures and described in more detail, but which can include the lenticular lens array 3-110 and a display layer, can be similarly or concentrically curved in the horizontal direction to accommodate the curvature of the user's face.

In at least one example, the shroud 3-104 can include a transparent or semi-transparent material through which the display assembly 3-108 projects light. In one example, the shroud 3-104 can include one or more opaque portions, for example opaque ink-printed portions or other opaque film portions on the rear surface of the shroud 3-104. The rear surface can be the surface of the shroud 3-104 facing the user's eyes when the HMD device is donned. In at least one example, opaque portions can be on the front surface of the shroud 3-104 opposite the rear surface. In at least one example, the opaque portion or portions of the shroud 3-104 can include perimeter portions visually hiding any components around an outside perimeter of the display screen of the display assembly 3-108. In this way, the opaque portions of the shroud hide any other components, including electronic components, structural components, and so forth, of the HMD device that would otherwise be visible through the transparent or semi-transparent cover 3-102 and/or shroud 3-104.

In at least one example, the shroud 3-104 can define one or more apertures transparent portions 3-120 through which sensors can send and receive signals. In one example, the portions 3-120 are apertures through which the sensors can extend or send and receive signals. In one example, the portions 3-120 are transparent portions, or portions more transparent than surrounding semi-transparent or opaque portions of the shroud, through which sensors can send and receive signals through the shroud and through the transparent cover 3-102. In one example, the sensors can include cameras, IR sensors, LUX sensors, or any other visual or non-visual environmental sensors of the HMD device.

Any of the features, components, and/or parts, including the arrangements and configurations thereof shown in FIG. 5I can be included, either alone or in any combination, in any of the other examples of devices, features, components, and parts described herein. Likewise, any of the features, components, and/or parts, including the arrangements and configurations thereof shown and described herein can be included, either alone or in any combination, in the example of the devices, features, components, and parts shown in FIG. 5I.

FIG. 5J illustrates an exploded view of an example of an HMD device 6-100. The HMD device 6-100 can include a sensor array or system 6-102 including one or more sensors, cameras, projectors, and so forth mounted to one or more components of the HMD 6-100. In at least one example, the sensor system 6-102 can include a bracket 1-338 on which one or more sensors of the sensor system 6-102 can be fixed/secured.

FIG. 5K illustrates a portion of an HMD device 6-100 including a front transparent cover 6-104 and a sensor system 6-102. The sensor system 6-102 can include a number of different sensors, emitters, receivers, including cameras, IR sensors, projectors, and so forth. The transparent cover 6-104 is illustrated in front of the sensor system 6-102 to illustrate relative positions of the various sensors and emitters as well as the orientation of each sensor/emitter of the system 6-102. As referenced herein, “sideways,” “side,” “lateral,” “horizontal,” and other similar terms refer to orientations or directions as indicated by the X-axis shown in FIG. 5L. Terms such as “vertical,” “up,” “down,” and similar terms refer to orientations or directions as indicated by the Z-axis shown in FIG. 5L. Terms such as “frontward,” “rearward,” “forward,” backward,” and similar terms refer to orientations or directions as indicated by the Y-axis shown in FIG. 5L.

In at least one example, the transparent cover 6-104 can define a front, external surface of the HMD device 6-100 and the sensor system 6-102, including the various sensors and components thereof, can be disposed behind the cover 6-104 in the Y-axis/direction. The cover 6-104 can be transparent or semi-transparent to allow light to pass through the cover 6-104, both light detected by the sensor system 6-102 and light emitted thereby.

As noted elsewhere herein, the HMD device 6-100 can include one or more controllers including processors for electrically coupling the various sensors and emitters of the sensor system 6-102 with one or more mother boards, processing units, and other electronic devices such as display screens and the like. In addition, as will be shown in more detail below with reference to other figures, the various sensors, emitters, and other components of the sensor system 6-102 can be coupled to various structural frame members, brackets, and so forth of the HMD device 6-100 not shown in FIG. 5K. FIG. 5K shows the components of the sensor system 6-102 unattached and un-coupled electrically from other components for the sake of illustrative clarity.

In at least one example, the device can include one or more controllers having processors configured to execute instructions stored on memory components electrically coupled to the processors. The instructions can include, or cause the processor to execute, one or more algorithms for self-correcting angles and positions of the various cameras described herein overtime with use as the initial positions, angles, or orientations of the cameras get bumped or deformed due to unintended drop events or other events.

In at least one example, the sensor system 6-102 can include one or more scene cameras 6-106. The system 6-102 can include two scene cameras 6-102 disposed on either side of the nasal bridge or arch of the HMD device 6-100 such that each of the two cameras 6-106 correspond generally in position with left and right eyes of the user behind the cover 6-103. In at least one example, the scene cameras 6-106 are oriented generally forward in the Y-direction to capture images in front of the user during use of the HMD 6-100. In at least one example, the scene cameras are color cameras and provide images and content for MR video pass through to the display screens facing the user's eyes when using the HMD device 6-100. The scene cameras 6-106 can also be used for environment and object reconstruction.

In at least one example, the sensor system 6-102 can include a first depth sensor 6-108 pointed generally forward in the Y-direction. In at least one example, the first depth sensor 6-108 can be used for environment and object reconstruction as well as user hand and body tracking. In at least one example, the sensor system 6-102 can include a second depth sensor 6-110 disposed centrally along the width (e.g., along the X-axis) of the HMD device 6-100. For example, the second depth sensor 6-110 can be disposed above the central nasal bridge or accommodating features over the nose of the user when donning the HMD 6-100. In at least one example, the second depth sensor 6-110 can be used for environment and object reconstruction as well as hand and body tracking. In at least one example, the second depth sensor can include a LIDAR sensor.

In at least one example, the sensor system 6-102 can include a depth projector 6-112 facing generally forward to project electromagnetic waves, for example in the form of a predetermined pattern of light dots, out into and within a field of view of the user and/or the scene cameras 6-106 or a field of view including and beyond the field of view of the user and/or scene cameras 6-106. In at least one example, the depth projector can project electromagnetic waves of light in the form of a dotted light pattern to be reflected off objects and back into the depth sensors noted above, including the depth sensors 6-108, 6-110. In at least one example, the depth projector 6-112 can be used for environment and object reconstruction as well as hand and body tracking.

In at least one example, the sensor system 6-102 can include downward facing cameras 6-114 with a field of view pointed generally downward relative to the HDM device 6-100 in the Z-axis. In at least one example, the downward cameras 6-114 can be disposed on left and right sides of the HMD device 6-100 as shown and used for hand and body tracking, headset tracking, and facial avatar detection and creation for display a user avatar on the forward-facing display screen of the HMD device 6-100 described elsewhere herein. The downward cameras 6-114, for example, can be used to capture facial expressions and movements for the face of the user below the HMD device 6-100, including the cheeks, mouth, and chin.

In at least one example, the sensor system 6-102 can include jaw cameras 6-116. In at least one example, the jaw cameras 6-116 can be disposed on left and right sides of the HMD device 6-100 as shown and used for hand and body tracking, headset tracking, and facial avatar detection and creation for display a user avatar on the forward-facing display screen of the HMD device 6-100 described elsewhere herein. The jaw cameras 6-116, for example, can be used to capture facial expressions and movements for the face of the user below the HMD device 6-100, including the user's jaw, cheeks, mouth, and chin.

In at least one example, the sensor system 6-102 can include side cameras 6-118. The side cameras 6-118 can be oriented to capture side views left and right in the X-axis or direction relative to the HMD device 6-100. In at least one example, the side cameras 6-118 can be used for hand and body tracking, headset tracking, and facial avatar detection and re-creation.

In at least one example, the sensor system 6-102 can include a plurality of eye tracking and gaze tracking sensors for determining an identity, status, and gaze direction of a user's eyes during and/or before use. In at least one example, the eye/gaze tracking sensors can include nasal eye cameras 6-120 disposed on either side of the user's nose and adjacent the user's nose when donning the HMD device 6-100. The eye/gaze sensors can also include bottom eye cameras 6-122 disposed below respective user eyes for capturing images of the eyes for facial avatar detection and creation, gaze tracking, and iris identification functions.

In at least one example, the sensor system 6-102 can include infrared illuminators 6-124 pointed outward from the HMD device 6-100 to illuminate the external environment and any object therein with IR light for IR detection with one or more IR sensors of the sensor system 6-102. In at least one example, the sensor system 6-102 can include a flicker sensor 6-126 and an ambient light sensor 6-128. In at least one example, the flicker sensor 6-126 can detect overhead light refresh rates to avoid display flicker. In one example, the infrared illuminators 6-124 can include light emitting diodes and can be used especially for low light environments for illuminating user hands and other objects in low light for detection by infrared sensors of the sensor system 6-102.

In at least one example, multiple sensors, including the scene cameras 6-106, the downward cameras 6-114, the jaw cameras 6-116, the side cameras 6-118, the depth projector 6-112, and the depth sensors 6-108, 6-110 can be used in combination with an electrically coupled controller to combine depth data with camera data for hand tracking and for size determination for better hand tracking and object recognition and tracking functions of the HMD device 6-100. In at least one example, the downward cameras 6-114, jaw cameras 6-116, and side cameras 6-118 described above and shown in FIG. 5K can be wide angle cameras operable in the visible and infrared spectrums. In at least one example, these cameras 6-114, 6-116, 6-118 can operate only in black and white light detection to simplify image processing and gain sensitivity.

Any of the features, components, and/or parts, including the arrangements and configurations thereof shown in FIG. 5K can be included, either alone or in any combination, in any of the other examples of devices, features, components, and parts shown in FIGS. 5L-5N and described herein. Likewise, any of the features, components, and/or parts, including the arrangements and configurations thereof shown and described with reference to FIGS. 5L-5N can be included, either alone or in any combination, in the example of the devices, features, components, and parts shown in FIG. 5K.

FIG. 5L illustrates a lower perspective view of an example of an HMD 6-200 including a cover or shroud 6-204 secured to a frame 6-230. In at least one example, the sensors 6-203 of the sensor system 6-202 can be disposed around a perimeter of the HDM 6-200 such that the sensors 6-203 are outwardly disposed around a perimeter of a display region or area 6-232 so as not to obstruct a view of the displayed light. In at least one example, the sensors can be disposed behind the shroud 6-204 and aligned with transparent portions of the shroud allowing sensors and projectors to allow light back and forth through the shroud 6-204. In at least one example, opaque ink or other opaque material or films/layers can be disposed on the shroud 6-204 around the display area 6-232 to hide components of the HMD 6-200 outside the display area 6-232 other than the transparent portions defined by the opaque portions, through which the sensors and projectors send and receive light and electromagnetic signals during operation. In at least one example, the shroud 6-204 allows light to pass therethrough from the display (e.g., within the display region 6-232) but not radially outward from the display region around the perimeter of the display and shroud 6-204.

In some examples, the shroud 6-204 includes a transparent portion 6-205 and an opaque portion 6-207, as described above and elsewhere herein. In at least one example, the opaque portion 6-207 of the shroud 6-204 can define one or more transparent regions 6-209 through which the sensors 6-203 of the sensor system 6-202 can send and receive signals. In the illustrated example, the sensors 6-203 of the sensor system 6-202 sending and receiving signals through the shroud 6-204, or more specifically through the transparent regions 6-209 of the (or defined by) the opaque portion 6-207 of the shroud 6-204 can include the same or similar sensors as those shown in the example of FIG. 5K, for example depth sensors 6-108 and 6-110, depth projector 6-112, first and second scene cameras 6-106, first and second downward cameras 6-114, first and second side cameras 6-118, and first and second infrared illuminators 6-124. These sensors are also shown in the examples of FIGS. 5M and 5N. Other sensors, sensor types, number of sensors, and relative positions thereof can be included in one or more other examples of HMDs.

Any of the features, components, and/or parts, including the arrangements and configurations thereof shown in FIG. 5L can be included, either alone or in any combination, in any of the other examples of devices, features, components, and parts shown in FIGS. 5K and 5M-5N and described herein. Likewise, any of the features, components, and/or parts, including the arrangements and configurations thereof shown and described with reference to FIGS. 5K and 5M-5N can be included, either alone or in any combination, in the example of the devices, features, components, and parts shown in FIG. 5L.

FIG. 5M illustrates a front view of a portion of an example of an HMD device 6-300 including a display 6-334, brackets 6-336, 6-338, and frame or housing 6-330. The example shown in FIG. 5M does not include a front cover or shroud in order to illustrate the brackets 6-336, 6-338. For example, the shroud 6-204 shown in FIG. 5L includes the opaque portion 6-207 that would visually cover/block a view of anything outside (e.g., radially/peripherally outside) the display/display region 6-334, including the sensors 6-303 and bracket 6-338.

In at least one example, the various sensors of the sensor system 6-302 are coupled to the brackets 6-336, 6-338. In at least one example, the scene cameras 6-306 include tight tolerances of angles relative to one another. For example, the tolerance of mounting angles between the two scene cameras 6-306 can be 0.5 degrees or less, for example 0.3 degrees or less. In order to achieve and maintain such a tight tolerance, in one example, the scene cameras 6-306 can be mounted to the bracket 6-338 and not the shroud. The bracket can include cantilevered arms on which the scene cameras 6-306 and other sensors of the sensor system 6-302 can be mounted to remain un-deformed in position and orientation in the case of a drop event by a user resulting in any deformation of the other bracket 6-226, housing 6-330, and/or shroud.

Any of the features, components, and/or parts, including the arrangements and configurations thereof shown in FIG. 5M can be included, either alone or in any combination, in any of the other examples of devices, features, components, and parts shown in FIGS. 5K-5L and 5N and described herein. Likewise, any of the features, components, and/or parts, including the arrangements and configurations thereof shown and described with reference to FIGS. 5K-5L and 5N can be included, either alone or in any combination, in the example of the devices, features, components, and parts shown in FIG. 5M.

FIG. 5N illustrates a bottom view of an example of an HMD 6-400 including a front display/cover assembly 6-404 and a sensor system 6-402. The sensor system 6-402 can be similar to other sensor systems described above and elsewhere herein, including in reference to FIGS. 5K-5M. In at least one example, the jaw cameras 6-416 can be facing downward to capture images of the user's lower facial features. In one example, the jaw cameras 6-416 can be coupled directly to the frame or housing 6-430 or one or more internal brackets directly coupled to the frame or housing 6-430 shown. The frame or housing 6-430 can include one or more apertures/openings 6-415 through which the jaw cameras 6-416 can send and receive signals.

Any of the features, components, and/or parts, including the arrangements and configurations thereof shown in FIG. 5N can be included, either alone or in any combination, in any of the other examples of devices, features, components, and parts shown in FIGS. 5K-5M and described herein. Likewise, any of the features, components, and/or parts, including the arrangements and configurations thereof shown and described with reference to FIGS. 5K-5M can be included, either alone or in any combination, in the example of the devices, features, components, and parts shown in FIG. 5N.

FIG. 5O illustrates a rear perspective view of an inter-pupillary distance (IPD) adjustment system 11.1.1-102 including first and second optical modules 11.1.1-104a-b slidably engaging/coupled to respective guide-rods 11.1.1-108a-b and motors 11.1.1-110a-b of left and right adjustment subsystems 11.1.1-106a-b. The IPD adjustment system 11.1.1-102 can be coupled to a bracket 11.1.1-112 and include a button 11.1.1-114 in electrical communication with the motors 11.1.1-110a-b. In at least one example, the button 11.1.1-114 can electrically communicate with the first and second motors 11.1.1-110a-b via a processor or other circuitry components to cause the first and second motors 11.1.1-110a-b to activate and cause the first and second optical modules 11.1.1-104a-b, respectively, to change position relative to one another.

In at least one example, the first and second optical modules 11.1.1-104a-b can include respective display screens configured to project light toward the user's eyes when donning the HMD 11.1.1-100. In at least one example, the user can manipulate (e.g., depress and/or rotate) the button 11.1.1-114 to activate a positional adjustment of the optical modules 11.1.1-104a-b to match the inter-pupillary distance of the user's eyes. The optical modules 11.1.1-104a-b can also include one or more cameras or other sensors/sensor systems for imaging and measuring the IPD of the user such that the optical modules 11.1.1-104a-b can be adjusted to match the IPD.

In one example, the user can manipulate the button 11.1.1-114 to cause an automatic positional adjustment of the first and second optical modules 11.1.1-104a-b. In one example, the user can manipulate the button 11.1.1-114 to cause a manual adjustment such that the optical modules 11.1.1-104a-b move further or closer away, for example when the user rotates the button 11.1.1-114 one way or the other, until the user visually matches her/his own IPD. In one example, the manual adjustment is electronically communicated via one or more circuits and power for the movements of the optical modules 11.1.1-104a-b via the motors 11.1.1-110a-b is provided by an electrical power source. In one example, the adjustment and movement of the optical modules 11.1.1-104a-b via a manipulation of the button 11.1.1-114 is mechanically actuated via the movement of the button 11.1.1-114.

Any of the features, components, and/or parts, including the arrangements and configurations thereof shown in FIG. 5O can be included, either alone or in any combination, in any of the other examples of devices, features, components, and parts shown in any other figures shown and described herein. Likewise, any of the features, components, and/or parts, including the arrangements and configurations thereof shown and described with reference to any other figure shown and described herein, either alone or in any combination, in the example of the devices, features, components, and parts shown in FIG. 5O.

FIG. 5P illustrates a front perspective view of a portion of an HMD 11.1.2-100, including an outer structural frame 11.1.2-102 and an inner or intermediate structural frame 11.1.2-104 defining first and second apertures 11.1.2-106a, 11.1.2-106b. The apertures 11.1.2-106a-b are shown in dotted lines in FIG. 5P because a view of the apertures 11.1.2-106a-b can be blocked by one or more other components of the HMD 11.1.2-100 coupled to the inner frame 11.1.2-104 and/or the outer frame 11.1.2-102, as shown. In at least one example, the HMD 11.1.2-100 can include a first mounting bracket 11.1.2-108 coupled to the inner frame 11.1.2-104. In at least one example, the mounting bracket 11.1.2-108 is coupled to the inner frame 11.1.2-104 between the first and second apertures 11.1.2-106a-b.

The mounting bracket 11.1.2-108 can include a middle or central portion 11.1.2-109 coupled to the inner frame 11.1.2-104. In some examples, the middle or central portion 11.1.2-109 may not be the geometric middle or center of the bracket 11.1.2-108. Rather, the middle/central portion 11.1.2-109 can be disposed between first and second cantilevered extension arms extending away from the middle portion 11.1.2-109. In at least one example, the mounting bracket 108 includes a first cantilever arm 11.1.2-112 and a second cantilever arm 11.1.2-114 extending away from the middle portion 11.1.2-109 of the mount bracket 11.1.2-108 coupled to the inner frame 11.1.2-104.

As shown in FIG. 5P, the outer frame 11.1.2-102 can define a curved geometry on a lower side thereof to accommodate a user's nose when the user dons the HMD 11.1.2-100. The curved geometry can be referred to as a nose bridge 11.1.2-111 and be centrally located on a lower side of the HMD 11.1.2-100 as shown. In at least one example, the mounting bracket 11.1.2-108 can be connected to the inner frame 11.1.2-104 between the apertures 11.1.2-106a-b such that the cantilevered arms 11.1.2-112, 11.1.2-114 extend downward and laterally outward away from the middle portion 11.1.2-109 to compliment the nose bridge 11.1.2-111 geometry of the outer frame 11.1.2-102. In this way, the mounting bracket 11.1.2-108 is configured to accommodate the user's nose as noted above. The nose bridge 11.1.2-111 geometry accommodates the nose in that the nose bridge 11.1.2-111 provides a curvature that curves with, above, over, and around the user's nose for comfort and fit.

The first cantilever arm 11.1.2-112 can extend away from the middle portion 11.1.2-109 of the mounting bracket 11.1.2-108 in a first direction and the second cantilever arm 11.1.2-114 can extend away from the middle portion 11.1.2-109 of the mounting bracket 11.1.2-10 in a second direction opposite the first direction. The first and second cantilever arms 11.1.2-112, 11.1.2-114 are referred to as “cantilevered” or “cantilever” arms because each arm 11.1.2-112, 11.1.2-114, includes a distal free end 11.1.2-116, 11.1.2-118, respectively, which are free of affixation from the inner and outer frames 11.1.2-102, 11.1.2-104. In this way, the arms 11.1.2-112, 11.1.2-114 are cantilevered from the middle portion 11.1.2-109, which can be connected to the inner frame 11.1.2-104, with distal ends 11.1.2-102, 11.1.2-104 unattached.

In at least one example, the HMD 11.1.2-100 can include one or more components coupled to the mounting bracket 11.1.2-108. In one example, the components include a plurality of sensors 11.1.2-110a-f. Each sensor of the plurality of sensors 11.1.2-110a-f can include various types of sensors, including cameras, IR sensors, and so forth. In some examples, one or more of the sensors 11.1.2-110a-f can be used for object recognition in three-dimensional space such that it is important to maintain a precise relative position of two or more of the plurality of sensors 11.1.2-110a-f. The cantilevered nature of the mounting bracket 11.1.2-108 can protect the sensors 11.1.2-110a-f from damage and altered positioning in the case of accidental drops by the user. Because the sensors 11.1.2-110a-f are cantilevered on the arms 11.1.2-112, 11.1.2-114 of the mounting bracket 11.1.2-108, stresses and deformations of the inner and/or outer frames 11.1.2-104, 11.1.2-102 are not transferred to the cantilevered arms 11.1.2-112, 11.1.2-114 and thus do not affect the relative positioning of the sensors 11.1.2-110a-f coupled/mounted to the mounting bracket 11.1.2-108.

Any of the features, components, and/or parts, including the arrangements and configurations thereof shown in FIG. 5P can be included, either alone or in any combination, in any of the other examples of devices, features, components, and described herein. Likewise, any of the features, components, and/or parts, including the arrangements and configurations thereof shown and described herein can be included, either alone or in any combination, in the example of the devices, features, components, and parts shown in FIG. 5P.

FIG. 5Q illustrates an example of an optical module 11.3.2-100 for use in an electronic device such as an HMD, including HDM devices described herein. As shown in one or more other examples described herein, the optical module 11.3.2-100 can be one of two optical modules within an HMD, with each optical module aligned to project light toward a user's eye. In this way, a first optical module can project light via a display screen toward a user's first eye and a second optical module of the same device can project light via another display screen toward the user's second eye.

In at least one example, the optical module 11.3.2-100 can include an optical frame or housing 11.3.2-102, which can also be referred to as a barrel or optical module barrel. The optical module 11.3.2-100 can also include a display 11.3.2-104, including a display screen or multiple display screens, coupled to the housing 11.3.2-102. The display 11.3.2-104 can be coupled to the housing 11.3.2-102 such that the display 11.3.2-104 is configured to project light toward the eye of a user when the HMD of which the display module 11.3.2-100 is a part is donned during use. In at least one example, the housing 11.3.2-102 can surround the display 11.3.2-104 and provide connection features for coupling other components of optical modules described herein.

In one example, the optical module 11.3.2-100 can include one or more cameras 11.3.2-106 coupled to the housing 11.3.2-102. The camera 11.3.2-106 can be positioned relative to the display 11.3.2-104 and housing 11.3.2-102 such that the camera 11.3.2-106 is configured to capture one or more images of the user's eye during use. In at least one example, the optical module 11.3.2-100 can also include a light strip 11.3.2-108 surrounding the display 11.3.2-104. In one example, the light strip 11.3.2-108 is disposed between the display 11.3.2-104 and the camera 11.3.2-106. The light strip 11.3.2-108 can include a plurality of lights 11.3.2-110. The plurality of lights can include one or more light emitting diodes (LEDs) or other lights configured to project light toward the user's eye when the HMD is donned. The individual lights 11.3.2-110 of the light strip 11.3.2-108 can be spaced about the strip 11.3.2-108 and thus spaced about the display 11.3.2-104 uniformly or non-uniformly at various locations on the strip 11.3.2-108 and around the display 11.3.2-104.

In at least one example, the housing 11.3.2-102 defines a viewing opening 11.3.2-101 through which the user can view the display 11.3.2-104 when the HMD device is donned. In at least one example, the LEDs are configured and arranged to emit light through the viewing opening 11.3.2-101 and onto the user's eye. In one example, the camera 11.3.2-106 is configured to capture one or more images of the user's eye through the viewing opening 11.3.2-101.

As noted above, each of the components and features of the optical module 11.3.2-100 shown in FIG. 5Q can be replicated in another (e.g., second) optical module disposed with the HMD to interact (e.g., project light and capture images) of another eye of the user.

Any of the features, components, and/or parts, including the arrangements and configurations thereof shown in FIG. 5Q can be included, either alone or in any combination, in any of the other examples of devices, features, components, and parts shown in FIG. 5R or otherwise described herein. Likewise, any of the features, components, and/or parts, including the arrangements and configurations thereof shown and described with reference to FIG. 5R or otherwise described herein can be included, either alone or in any combination, in the example of the devices, features, components, and parts shown in FIG. 5Q.

FIG. 5R illustrates a cross-sectional view of an example of an optical module 11.3.2-200 including a housing 11.3.2-202, display assembly 11.3.2-204 coupled to the housing 11.3.2-202, and a lens 11.3.2-216 coupled to the housing 11.3.2-202. In at least one example, the housing 11.3.2-202 defines a first aperture or channel 11.3.2-212 and a second aperture or channel 11.3.2-214. The channels 11.3.2-212, 11.3.2-214 can be configured to slidably engage respective rails or guide rods of an HMD device to allow the optical module 11.3.2-200 to adjust in position relative to the user's eyes for match the user's interpapillary distance (IPD). The housing 11.3.2-202 can slidably engage the guide rods to secure the optical module 11.3.2-200 in place within the HMD.

In at least one example, the optical module 11.3.2-200 can also include a lens 11.3.2-216 coupled to the housing 11.3.2-202 and disposed between the display assembly 11.3.2-204 and the user's eyes when the HMD is donned. The lens 11.3.2-216 can be configured to direct light from the display assembly 11.3.2-204 to the user's eye. In at least one example, the lens 11.3.2-216 can be a part of a lens assembly including a corrective lens removably attached to the optical module 11.3.2-200. In at least one example, the lens 11.3.2-216 is disposed over the light strip 11.3.2-208 and the one or more eye-tracking cameras 11.3.2-206 such that the camera 11.3.2-206 is configured to capture images of the user's eye through the lens 11.3.2-216 and the light strip 11.3.2-208 includes lights configured to project light through the lens 11.3.2-216 to the users' eye during use.

Any of the features, components, and/or parts, including the arrangements and configurations thereof shown in FIG. 5R can be included, either alone or in any combination, in any of the other examples of devices, features, components, and parts and described herein. Likewise, any of the features, components, and/or parts, including the arrangements and configurations thereof shown and described herein can be included, either alone or in any combination, in the example of the devices, features, components, and parts shown in FIG. 5R.

FIG. 5S is a block diagram of an example of the controller 5-110 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments, the controller 5-110 includes one or more processing units 5-202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 5-206, one or more communication interfaces 5-208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 5-210, a memory 5-220, and one or more communication buses 5-204 for interconnecting these and various other components.

In some embodiments, the one or more communication buses 5-204 include circuitry that interconnects and controls communications between system components. In some embodiments, the one or more I/O devices 5-206 include at least one of a keyboard, a mouse, a touchpad, a joystick, one or more microphones, one or more speakers, one or more image sensors, one or more displays, and/or the like.

The memory 5-220 includes high-speed random-access memory, such as dynamic random-access memory (DRAM), static random-access memory (SRAM), double-data-rate random-access memory (DDR RAM), or other random-access solid-state memory devices. In some embodiments, the memory 5-220 includes non-volatile memory, such as one or more magnetic disk storage devices, optical disk storage devices, flash memory devices, or other non-volatile solid-state storage devices. The memory 5-220 optionally includes one or more storage devices remotely located from the one or more processing units 5-202. The memory 5-220 comprises a non-transitory computer readable storage medium. In some embodiments, the memory 5-220 or the non-transitory computer readable storage medium of the memory 5-220 stores the following programs, modules and data structures, or a subset thereof including an optional operating system 5-230 and an XR experience module 5-240.

The operating system 5-230 includes instructions for handling various basic system services and for performing hardware dependent tasks. In some embodiments, the XR experience module 5-240 is configured to manage and coordinate one or more XR experiences for one or more users (e.g., a single XR experience for one or more users, or multiple XR experiences for respective groups of one or more users). To that end, in various embodiments, the XR experience module 5-240 includes a data obtaining unit 5-241, a tracking unit 5-242, a coordination unit 5-246, and a data transmitting unit 5-248.

In some embodiments, the data obtaining unit 5-241 is configured to obtain data (e.g., presentation data, interaction data, sensor data, location data, etc.) from at least the display generation component 5-120 of FIG. 5C, and optionally one or more of the input devices 5-125, output devices 5-155, sensors 5-190, and/or peripheral devices 5-195. To that end, in various embodiments, the data obtaining unit 5-241 includes instructions and/or logic therefor, and heuristics and metadata therefor.

In some embodiments, the tracking unit 5-242 is configured to map the scene 5-105 and to track the position/location of at least the display generation component 5-120 with respect to the scene 5-105 of FIG. 5C, and optionally, to one or more of the input devices 5-125, output devices 5-155, sensors 5-190, and/or peripheral devices 5-195. To that end, in various embodiments, the tracking unit 5-242 includes instructions and/or logic therefor, and heuristics and metadata therefor. In some embodiments, the tracking unit 5-242 includes hand tracking unit 5-244 and/or eye tracking unit 5-243. In some embodiments, the hand tracking unit 5-244 is configured to track the position/location of one or more portions of the user's hands, and/or motions of one or more portions of the user's hands with respect to the scene 5-105 of FIG. 5C, relative to the display generation component 5-120, and/or relative to a coordinate system defined relative to the user's hand. The hand tracking unit 5-244 is described in greater detail below with respect to FIG. 5U. In some embodiments, the eye tracking unit 5-243 is configured to track the position and movement of the user's gaze (or more broadly, the user's eyes, face, or head) with respect to the scene 5-105 (e.g., with respect to the physical environment and/or to the user (e.g., the user's hand)) or with respect to the XR content displayed via the display generation component 5-120. The eye tracking unit 5-243 is described in greater detail below with respect to FIG. 5V.

In some embodiments, the coordination unit 5-246 is configured to manage and coordinate the XR experience presented to the user by the display generation component 5-120, and optionally, by one or more of the output devices 5-155 and/or peripheral devices 5-195. To that end, in various embodiments, the coordination unit 5-246 includes instructions and/or logic therefor, and heuristics and metadata therefor.

In some embodiments, the data transmitting unit 5-248 is configured to transmit data (e.g., presentation data, location data, etc.) to at least the display generation component 5-120, and optionally, to one or more of the input devices 5-125, output devices 5-155, sensors 5-190, and/or peripheral devices 5-195. To that end, in various embodiments, the data transmitting unit 5-248 includes instructions and/or logic therefor, and heuristics and metadata therefor.

Although the data obtaining unit 5-241, the tracking unit 5-242 (e.g., including the eye tracking unit 5-243 and the hand tracking unit 5-244), the coordination unit 5-246, and the data transmitting unit 5-248 are shown as residing on a single device (e.g., the controller 5-110), it should be understood that in other embodiments, any combination of the data obtaining unit 5-241, the tracking unit 5-242 (e.g., including the eye tracking unit 5-243 and the hand tracking unit 5-244), the coordination unit 5-246, and the data transmitting unit 5-248 may be located in separate computing devices.

Moreover, FIG. 5S is intended more as functional description of the various features that may be present in a particular implementation as opposed to a structural schematic of the embodiments described herein. As recognized by those of ordinary skill in the art, items shown separately could be combined and some items could be separated. For example, some functional modules shown separately in FIG. 5S could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 5T is a block diagram of an example of the display generation component 5-120 in accordance with some embodiments. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the display generation component 5-120 (e.g., HMD) includes one or more processing units 5-302 (e.g., microprocessors, ASICs, FPGAs, GPUs, CPUs, processing cores, and/or the like), one or more input/output (I/O) devices and sensors 5-306, one or more communication interfaces 5-308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 5-310, one or more XR displays 5-312, one or more optional interior- and/or exterior-facing image sensors 5-314, a memory 5-320, and one or more communication buses 5-304 for interconnecting these and various other components.

In some embodiments, the one or more communication buses 5-304 include circuitry that interconnects and controls communications between system components. In some embodiments, the one or more I/O devices and sensors 5-306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some embodiments, the one or more XR displays 5-312 are configured to provide the XR experience to the user. In some embodiments, the one or more XR displays 5-312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some embodiments, the one or more XR displays 5-312 correspond to diffractive, reflective, polarized, holographic, etc. waveguide displays. For example, the display generation component 5-120 (e.g., HMD) includes a single XR display. In another example, the display generation component 5-120 includes a XR display for each eye of the user. In some embodiments, the one or more XR displays 5-312 are capable of presenting MR and VR content. In some embodiments, the one or more XR displays 5-312 are capable of presenting MR or VR content.

In some embodiments, the one or more image sensors 5-314 are configured to obtain image data that corresponds to at least a portion of the face of the user that includes the eyes of the user (and may be referred to as an eye-tracking camera). In some embodiments, the one or more image sensors 5-314 are configured to obtain image data that corresponds to at least a portion of the user's hand(s) and optionally arm(s) of the user (and may be referred to as a hand-tracking camera). In some embodiments, the one or more image sensors 5-314 are configured to be forward-facing so as to obtain image data that corresponds to the scene as would be viewed by the user if the display generation component 5-120 (e.g., HMD) was not present (and may be referred to as a scene camera). The one or more optional image sensors 5-314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 5-320 includes high-speed random-access memory, such as DRAM, SRAM, DDR RAM, or other random-access solid-state memory devices. In some embodiments, the memory 5-320 includes non-volatile memory, such as one or more magnetic disk storage devices, optical disk storage devices, flash memory devices, or other non-volatile solid-state storage devices. The memory 5-320 optionally includes one or more storage devices remotely located from the one or more processing units 5-302. The memory 5-320 comprises a non-transitory computer readable storage medium. In some embodiments, the memory 5-320 or the non-transitory computer readable storage medium of the memory 5-320 stores the following programs, modules and data structures, or a subset thereof including an optional operating system 5-330 and a XR presentation module 5-340.

The operating system 5-330 includes instructions for handling various basic system services and for performing hardware dependent tasks. In some embodiments, the XR presentation module 5-340 is configured to present XR content to the user via the one or more XR displays 5-312. To that end, in various embodiments, the XR presentation module 5-340 includes a data obtaining unit 5-342, a XR presenting unit 5-344, a XR map generating unit 5-346, and a data transmitting unit 5-348.

In some embodiments, the data obtaining unit 5-342 is configured to obtain data (e.g., presentation data, interaction data, sensor data, location data, etc.) from at least the controller 5-110 of FIG. 5C. To that end, in various embodiments, the data obtaining unit 5-342 includes instructions and/or logic therefor, and heuristics and metadata therefor.

In some embodiments, the XR presenting unit 5-344 is configured to present XR content via the one or more XR displays 5-312. To that end, in various embodiments, the XR presenting unit 5-344 includes instructions and/or logic therefor, and heuristics and metadata therefor.

In some embodiments, the XR map generating unit 5-346 is configured to generate a XR map (e.g., a 3D map of the mixed reality scene or a map of the physical environment into which computer-generated objects can be placed to generate the extended reality) based on media content data. To that end, in various embodiments, the XR map generating unit 5-346 includes instructions and/or logic therefor, and heuristics and metadata therefor.

In some embodiments, the data transmitting unit 5-348 is configured to transmit data (e.g., presentation data, location data, etc.) to at least the controller 5-110, and optionally one or more of the input devices 5-125, output devices 5-155, sensors 5-190, and/or peripheral devices 5-195. To that end, in various embodiments, the data transmitting unit 5-348 includes instructions and/or logic therefor, and heuristics and metadata therefor.

Although the data obtaining unit 5-342, the XR presenting unit 5-344, the XR map generating unit 5-346, and the data transmitting unit 5-348 are shown as residing on a single device (e.g., the display generation component 5-120 of FIG. 5C), it should be understood that in other embodiments, any combination of the data obtaining unit 5-342, the XR presenting unit 5-344, the XR map generating unit 5-346, and the data transmitting unit 5-348 may be located in separate computing devices.

Moreover, FIG. 5T is intended more as a functional description of the various features that could be present in a particular implementation as opposed to a structural schematic of the embodiments described herein. As recognized by those of ordinary skill in the art, items shown separately could be combined and some items could be separated. For example, some functional modules shown separately in FIG. 5T could be implemented in a single module and the various functions of single functional blocks could be implemented by one or more functional blocks in various embodiments. The actual number of modules and the division of particular functions and how features are allocated among them will vary from one implementation to another and, in some embodiments, depends in part on the particular combination of hardware, software, and/or firmware chosen for a particular implementation.

FIG. 5U is a schematic, pictorial illustration of an example embodiment of the hand tracking device 5-140. In some embodiments, hand tracking device 5-140 (FIG. 5C) is controlled by hand tracking unit 5-244 (FIG. 5S) to track the position/location of one or more portions of the user's hands, and/or motions of one or more portions of the user's hands with respect to the scene 5-105 of FIG. 5C (e.g., with respect to a portion of the physical environment surrounding the user, with respect to the display generation component 5-120, or with respect to a portion of the user (e.g., the user's face, eyes, or head), and/or relative to a coordinate system defined relative to the user's hand). In some embodiments, the hand tracking device 5-140 is part of the display generation component 5-120 (e.g., embedded in or attached to a head-mounted device). In some embodiments, the hand tracking device 5-140 is separate from the display generation component 5-120 (e.g., located in separate housings or attached to separate physical support structures).

In some embodiments, the hand tracking device 5-140 includes image sensors 5-404 (e.g., one or more IR cameras, 3D cameras, depth cameras, and/or color cameras, etc.) that capture three-dimensional scene information that includes at least a hand 5-406 of a human user. The image sensors 5-404 capture the hand images with sufficient resolution to enable the fingers and their respective positions to be distinguished. The image sensors 5-404 typically capture images of other parts of the user's body, as well, or possibly all of the body, and may have either zoom capabilities or a dedicated sensor with enhanced magnification to capture images of the hand with the desired resolution. In some embodiments, the image sensors 5-404 also capture 2D color video images of the hand 5-406 and other elements of the scene. In some embodiments, the image sensors 5-404 are used in conjunction with other image sensors to capture the physical environment of the scene 5-105 or serve as the image sensors that capture the physical environments of the scene 5-105. In some embodiments, the image sensors 5-404 are positioned relative to the user or the user's environment in a way that a field of view of the image sensors or a portion thereof is used to define an interaction space in which hand movement captured by the image sensors are treated as inputs to the controller 5-110.

In some embodiments, the image sensors 5-404 output a sequence of frames containing 3D map data (and possibly color image data, as well) to the controller 5-110, which extracts high-level information from the map data. This high-level information is typically provided via an Application Program Interface (API) to an application running on the controller, which drives the display generation component 5-120 accordingly. For example, the user may interact with software running on the controller 5-110 by moving his hand 5-406 and changing his hand posture.

In some embodiments, the image sensors 5-404 project a pattern of spots onto a scene containing the hand 5-406 and capture an image of the projected pattern. In some embodiments, the controller 5-110 computes the 3D coordinates of points in the scene (including points on the surface of the user's hand) by triangulation, based on transverse shifts of the spots in the pattern. This approach is advantageous in that it does not require the user to hold or wear any sort of beacon, sensor, or other marker. It gives the depth coordinates of points in the scene relative to a predetermined reference plane, at a certain distance from the image sensors 5-404. In the present disclosure, the image sensors 5-404 are assumed to define an orthogonal set of x, y, z axes, so that depth coordinates of points in the scene correspond to z components measured by the image sensors. Alternatively, the image sensors 5-404 (e.g., a hand tracking device) may use other methods of 3D mapping, such as stereoscopic imaging or time-of-flight measurements, based on single or multiple cameras or other types of sensors.

In some embodiments, the hand tracking device 5-140 captures and processes a temporal sequence of depth maps containing the user's hand, while the user moves his hand (e.g., whole hand or one or more fingers). Software running on a processor in the image sensors 5-404 and/or the controller 5-110 processes the 3D map data to extract patch descriptors of the hand in these depth maps. The software matches these descriptors to patch descriptors stored in a database 5-408, based on a prior learning process, in order to estimate the pose of the hand in each frame. The pose typically includes 3D locations of the user's hand joints and fingertips.

The software may also analyze the trajectory of the hands and/or fingers over multiple frames in the sequence in order to identify gestures. The pose estimation functions described herein may be interleaved with motion tracking functions, so that patch-based pose estimation is performed only once in every two (or more) frames, while tracking is used to find changes in the pose that occur over the remaining frames. The pose, motion, and gesture information are provided via the above-mentioned API to an application program running on the controller 5-110. This program may, for example, move and modify images presented on the display generation component 5-120, or perform other functions, in response to the pose and/or gesture information.

In some embodiments, a gesture includes an air gesture. An air gesture is a gesture that is detected without the user touching (or independently of) an input element that is part of a device (e.g., computer system 5-101, one or more input device 5-125, and/or hand tracking device 5-140) and is based on detected motion of a portion (e.g., the head, one or more arms, one or more hands, one or more fingers, and/or one or more legs) of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments, input gestures used in the various examples and embodiments described herein include air gestures performed by movement of the user's finger(s) relative to other finger(s) (or part(s) of the user's hand) for interacting with an XR environment (e.g., a virtual or mixed-reality environment), in accordance with some embodiments. In some embodiments, an air gesture is a gesture that is detected without the user touching an input element that is part of the device (or independently of an input element that is a part of the device) and is based on detected motion of a portion of the user's body through the air including motion of the user's body relative to an absolute reference (e.g., an angle of the user's arm relative to the ground or a distance of the user's hand relative to the ground), relative to another portion of the user's body (e.g., movement of a hand of the user relative to a shoulder of the user, movement of one hand of the user relative to another hand of the user, and/or movement of a finger of the user relative to another finger or portion of a hand of the user), and/or absolute motion of a portion of the user's body (e.g., a tap gesture that includes movement of a hand in a predetermined pose by a predetermined amount and/or speed, or a shake gesture that includes a predetermined speed or amount of rotation of a portion of the user's body).

In some embodiments in which the input gesture is an air gesture (e.g., in the absence of physical contact with an input device that provides the computer system with information about which user interface element is the target of the user input, such as contact with a user interface element displayed on a touchscreen, or contact with a mouse or trackpad to move a cursor to the user interface element), the gesture takes into account the user's attention (e.g., gaze) to determine the target of the user input (e.g., for direct inputs, as described below). Thus, in implementations involving air gestures, the input gesture is, for example, detected attention (e.g., gaze) toward the user interface element in combination (e.g., concurrent) with movement of a user's finger(s) and/or hands to perform a pinch and/or tap input, as described in more detail below.

In some embodiments, input gestures that are directed to a user interface object are performed directly or indirectly with reference to a user interface object. For example, a user input is performed directly on the user interface object in accordance with performing the input gesture with the user's hand at a position that corresponds to the position of the user interface object in the three-dimensional environment (e.g., as determined based on a current viewpoint of the user). In some embodiments, the input gesture is performed indirectly on the user interface object in accordance with the user performing the input gesture while a position of the user's hand is not at the position that corresponds to the position of the user interface object in the three-dimensional environment while detecting the user's attention (e.g., gaze) on the user interface object. For example, for direct input gesture, the user is enabled to direct the user's input to the user interface object by initiating the gesture at, or near, a position corresponding to the displayed position of the user interface object (e.g., within 0.5 cm, 1 cm, 5 cm, or a distance between 0-5 cm, as measured from an outer edge of the option or a center portion of the option). For an indirect input gesture, the user is enabled to direct the user's input to the user interface object by paying attention to the user interface object (e.g., by gazing at the user interface object) and, while paying attention to the option, the user initiates the input gesture (e.g., at any position that is detectable by the computer system) (e.g., at a position that does not correspond to the displayed position of the user interface object).

In some embodiments, input gestures (e.g., air gestures) used in the various examples and embodiments described herein include pinch inputs and tap inputs, for interacting with a virtual or mixed-reality environment, in accordance with some embodiments. For example, the pinch inputs and tap inputs described below are performed as air gestures.

In some embodiments, a pinch input is part of an air gesture that includes one or more of: a pinch gesture, a long pinch gesture, a pinch and drag gesture, or a double pinch gesture. For example, a pinch gesture that is an air gesture includes movement of two or more fingers of a hand to make contact with one another, that is, optionally, followed by an immediate (e.g., within 0-1 seconds) break in contact from each other. A long pinch gesture that is an air gesture includes movement of two or more fingers of a hand to make contact with one another for at least a threshold amount of time (e.g., at least 1 second), before detecting a break in contact with one another. For example, a long pinch gesture includes the user holding a pinch gesture (e.g., with the two or more fingers making contact), and the long pinch gesture continues until a break in contact between the two or more fingers is detected. In some embodiments, a double pinch gesture that is an air gesture comprises two (e.g., or more) pinch inputs (e.g., performed by the same hand) detected in immediate (e.g., within a predefined time period) succession of each other. For example, the user performs a first pinch input (e.g., a pinch input or a long pinch input), releases the first pinch input (e.g., breaks contact between the two or more fingers), and performs a second pinch input within a predefined time period (e.g., within 1 second or within 2 seconds) after releasing the first pinch input.

In some embodiments, a pinch and drag gesture that is an air gesture (e.g., an air drag gesture or an air swipe gesture) includes a pinch gesture (e.g., a pinch gesture or a long pinch gesture) performed in conjunction with (e.g., followed by) a drag input that changes a position of the user's hand from a first position (e.g., a start position of the drag) to a second position (e.g., an end position of the drag). In some embodiments, the user maintains the pinch gesture while performing the drag input, and releases the pinch gesture (e.g., opens their two or more fingers) to end the drag gesture (e.g., at the second position). In some embodiments, the pinch input and the drag input are performed by the same hand (e.g., the user pinches two or more fingers to make contact with one another and moves the same hand to the second position in the air with the drag gesture). In some embodiments, the pinch input is performed by a first hand of the user and the drag input is performed by the second hand of the user (e.g., the user's second hand moves from the first position to the second position in the air while the user continues the pinch input with the user's first hand). In some embodiments, an input gesture that is an air gesture includes inputs (e.g., pinch and/or tap inputs) performed using both of the user's two hands. For example, the input gesture includes two (e.g., or more) pinch inputs performed in conjunction with (e.g., concurrently with, or within a predefined time period of) each other. For example, a first pinch gesture performed using a first hand of the user (e.g., a pinch input, a long pinch input, or a pinch and drag input), and, in conjunction with performing the pinch input using the first hand, performing a second pinch input using the other hand (e.g., the second hand of the user's two hands).

In some embodiments, a tap input (e.g., directed to a user interface element) performed as an air gesture includes movement of a user's finger(s) toward the user interface element, movement of the user's hand toward the user interface element optionally with the user's finger(s) extended toward the user interface element, a downward motion of a user's finger (e.g., mimicking a mouse click motion or a tap on a touchscreen), or other predefined movement of the user's hand. In some embodiments a tap input that is performed as an air gesture is detected based on movement characteristics of the finger or hand performing the tap gesture movement of a finger or hand away from the viewpoint of the user and/or toward an object that is the target of the tap input followed by an end of the movement. In some embodiments the end of the movement is detected based on a change in movement characteristics of the finger or hand performing the tap gesture (e.g., an end of movement away from the viewpoint of the user and/or toward the object that is the target of the tap input, a reversal of direction of movement of the finger or hand, and/or a reversal of a direction of acceleration of movement of the finger or hand).

In some embodiments, attention of a user is determined to be directed to a portion of the three-dimensional environment based on detection of gaze directed to the portion of the three-dimensional environment (optionally, without requiring other conditions). In some embodiments, attention of a user is determined to be directed to a portion of the three-dimensional environment based on detection of gaze directed to the portion of the three-dimensional environment with one or more additional conditions such as requiring that gaze is directed to the portion of the three-dimensional environment for at least a threshold duration (e.g., a dwell duration) and/or requiring that the gaze is directed to the portion of the three-dimensional environment while the viewpoint of the user is within a distance threshold from the portion of the three-dimensional environment in order for the device to determine that attention of the user is directed to the portion of the three-dimensional environment, where if one of the additional conditions is not met, the device determines that attention is not directed to the portion of the three-dimensional environment toward which gaze is directed (e.g., until the one or more additional conditions are met).

In some embodiments, the detection of a ready state configuration of a user or a portion of a user is detected by the computer system. Detection of a ready state configuration of a hand is used by a computer system as an indication that the user is likely preparing to interact with the computer system using one or more air gesture inputs performed by the hand (e.g., a pinch, tap, pinch and drag, double pinch, long pinch, or other air gesture described herein). For example, the ready state of the hand is determined based on whether the hand has a predetermined hand shape (e.g., a pre-pinch shape with a thumb and one or more fingers extended and spaced apart ready to make a pinch or grab gesture or a pre-tap with one or more fingers extended and palm facing away from the user), based on whether the hand is in a predetermined position relative to a viewpoint of the user (e.g., below the user's head and above the user's waist and extended out from the body by at least 15, 20, 25, 30, or 50 cm), and/or based on whether the hand has moved in a particular manner (e.g., moved toward a region in front of the user above the user's waist and below the user's head or moved away from the user's body or leg). In some embodiments, the ready state is used to determine whether interactive elements of the user interface respond to attention (e.g., gaze) inputs.

In scenarios where inputs are described with reference to air gestures, it should be understood that similar gestures could be detected using a hardware input device that is attached to or held by one or more hands of a user, where the position of the hardware input device in space can be tracked using optical tracking, one or more accelerometers, one or more gyroscopes, one or more magnetometers, and/or one or more inertial measurement units and the position and/or movement of the hardware input device is used in place of the position and/or movement of the one or more hands in the corresponding air gesture(s). In scenarios where inputs are described with reference to air gestures, it should be understood that similar gestures could be detected using a hardware input device that is attached to or held by one or more hands of a user. User inputs can be detected with controls contained in the hardware input device such as one or more touch-sensitive input elements, one or more pressure-sensitive input elements, one or more buttons, one or more knobs, one or more dials, one or more joysticks, one or more hand or finger coverings that can detect a position or change in position of portions of a hand and/or fingers relative to each other, relative to the user's body, and/or relative to a physical environment of the user, and/or other hardware input device controls, where the user inputs with the controls contained in the hardware input device are used in place of hand and/or finger gestures such as air taps or air pinches in the corresponding air gesture(s). For example, a selection input that is described as being performed with an air tap or air pinch input could be alternatively detected with a button press, a tap on a touch-sensitive surface, a press on a pressure-sensitive surface, or other hardware input. As another example, a movement input that is described as being performed with an air pinch and drag (e.g., an air drag gesture or an air swipe gesture) could be alternatively detected based on an interaction with the hardware input control such as a button press and hold, a touch on a touch-sensitive surface, a press on a pressure-sensitive surface, or other hardware input that is followed by movement of the hardware input device (e.g., along with the hand with which the hardware input device is associated) through space. Similarly, a two-handed input that includes movement of the hands relative to each other could be performed with one air gesture and one hardware input device in the hand that is not performing the air gesture, two hardware input devices held in different hands, or two air gestures performed by different hands using various combinations of air gestures and/or the inputs detected by one or more hardware input devices that are described above.

In some embodiments, the software may be downloaded to the controller 5-110 in electronic form, over a network, for example, or it may alternatively be provided on tangible, non-transitory media, such as optical, magnetic, or electronic memory media. In some embodiments, the database 5-408 is likewise stored in a memory associated with the controller 5-110. Alternatively or additionally, some or all of the described functions of the computer may be implemented in dedicated hardware, such as a custom or semi-custom integrated circuit or a programmable digital signal processor (DSP). Although the controller 5-110 is shown in FIG. 5U, by way of example, as a separate unit from the image sensors 404, some or all of the processing functions of the controller may be performed by a suitable microprocessor and software or by dedicated circuitry within the housing of the image sensors 5-404 (e.g., a hand tracking device) or otherwise associated with the image sensors 5-404. In some embodiments, at least some of these processing functions may be carried out by a suitable processor that is integrated with the display generation component 5-120 (e.g., in a television set, a handheld device, or head-mounted device, for example) or with any other suitable computerized device, such as a game console or media player. The sensing functions of image sensors 5-404 may likewise be integrated into the computer or other computerized apparatus that is to be controlled by the sensor output.

FIG. 5U further includes a schematic representation of a depth map 5-410 captured by the image sensors 5-404, in accordance with some embodiments. The depth map, as explained above, comprises a matrix of pixels having respective depth values. The pixels 5-412 corresponding to the hand 5-406 have been segmented out from the background and the wrist in this map. The brightness of each pixel within the depth map 5-410 corresponds inversely to its depth value, e.g., the measured z distance from the image sensors 5-404, with the shade of gray growing darker with increasing depth. The controller 5-110 processes these depth values in order to identify and segment a component of the image (e.g., a group of neighboring pixels) having characteristics of a human hand. These characteristics, may include, for example, overall size, shape, and motion from frame to frame of the sequence of depth maps.

FIG. 5U also schematically illustrates a hand skeleton 5-414 that controller 5-110 ultimately extracts from the depth map 5-410 of the hand 5-406, in accordance with some embodiments. In FIG. 5U, the hand skeleton 5-414 is superimposed on a hand background 5-416 that has been segmented from the original depth map. In some embodiments, key feature points of the hand (e.g., points corresponding to knuckles, fingertips, center of the palm, end of the hand connecting to wrist, etc.) and optionally on the wrist or arm connected to the hand are identified and located on the hand skeleton 5-414. In some embodiments, location and movements of these key feature points over multiple image frames are used by the controller 5-110 to determine the hand gestures performed by the hand or the current state of the hand, in accordance with some embodiments.

FIG. 5V illustrates an example embodiment of the eye tracking device 5-130 (FIG. 5C). In some embodiments, the eye tracking device 130 is controlled by the eye tracking unit 5-243 (FIG. 5S) to track the position and movement of the user's gaze with respect to the scene 5-105 or with respect to the XR content displayed via the display generation component 5-120. In some embodiments, the eye tracking device 5-130 is integrated with the display generation component 5-120. For example, in some embodiments, when the display generation component 5-120 is a head-mounted device such as headset, helmet, goggles, or glasses, or a handheld device placed in a wearable frame, the head-mounted device includes both a component that generates the XR content for viewing by the user and a component for tracking the gaze of the user relative to the XR content. In some embodiments, the eye tracking device 5-130 is separate from the display generation component 5-120. For example, when display generation component is a handheld device or a XR chamber, the eye tracking device 5-130 is optionally a separate device from the handheld device or XR chamber. In some embodiments, the eye tracking device 5-130 is a head-mounted device or part of a head-mounted device. In some embodiments, the head-mounted eye-tracking device 5-130 is optionally used in conjunction with a display generation component that is also head-mounted, or a display generation component that is not head-mounted. In some embodiments, the eye tracking device 5-130 is not a head-mounted device and is optionally used in conjunction with a head-mounted display generation component. In some embodiments, the eye tracking device 5-130 is not a head-mounted device and is optionally part of a non-head-mounted display generation component.

In some embodiments, the display generation component 5-120 uses a display mechanism (e.g., left and right near-eye display panels) for displaying frames including left and right images in front of a user's eyes to thus provide 3D virtual views to the user. For example, a head-mounted display generation component may include left and right optical lenses (referred to herein as eye lenses) located between the display and the user's eyes. In some embodiments, the display generation component may include or be coupled to one or more external video cameras that capture video of the user's environment for display. In some embodiments, a head-mounted display generation component may have a transparent or semi-transparent display through which a user may view the physical environment directly and display virtual objects on the transparent or semi-transparent display. In some embodiments, display generation component projects virtual objects into the physical environment. The virtual objects may be projected, for example, on a physical surface or as a holograph, so that an individual, using the system, observes the virtual objects superimposed over the physical environment. In such cases, separate display panels and image frames for the left and right eyes may not be necessary.

As shown in FIG. 5V, in some embodiments, eye tracking device 5-130 (e.g., a gaze tracking device) includes at least one eye tracking camera (e.g., infrared (IR) or near-IR (NIR) cameras), and illumination sources (e.g., IR or NIR light sources such as an array or ring of LEDs) that emit light (e.g., IR or NIR light) towards the user's eyes. The eye tracking cameras may be pointed towards the user's eyes to receive reflected IR or NIR light from the light sources directly from the eyes, or alternatively may be pointed towards “hot” mirrors located between the user's eyes and the display panels that reflect IR or NIR light from the eyes to the eye tracking cameras while allowing visible light to pass. The eye tracking device 5-130 optionally captures images of the user's eyes (e.g., as a video stream captured at 60-120 frames per second (fps)), analyze the images to generate gaze tracking information, and communicate the gaze tracking information to the controller 5-110. In some embodiments, two eyes of the user are separately tracked by respective eye tracking cameras and illumination sources. In some embodiments, only one eye of the user is tracked by a respective eye tracking camera and illumination sources.

In some embodiments, the eye tracking device 5-130 is calibrated using a device-specific calibration process to determine parameters of the eye tracking device for the specific operating environment 5-100, for example the 3D geometric relationship and parameters of the LEDs, cameras, hot mirrors (if present), eye lenses, and display screen. The device-specific calibration process may be performed at the factory or another facility prior to delivery of the AR/VR equipment to the end user. The device-specific calibration process may be an automated calibration process or a manual calibration process. A user-specific calibration process may include an estimation of a specific user's eye parameters, for example the pupil location, fovea location, optical axis, visual axis, eye spacing, etc. Once the device-specific and user-specific parameters are determined for the eye tracking device 5-130, images captured by the eye tracking cameras can be processed using a glint-assisted method to determine the current visual axis and point of gaze of the user with respect to the display, in accordance with some embodiments.

As shown in FIG. 5V, the eye tracking device 5-130 (e.g., 5-130A or 5-130B) includes eye lens(es) 5-520, and a gaze tracking system that includes at least one eye tracking camera 5-540 (e.g., infrared (IR) or near-IR (NIR) cameras) positioned on a side of the user's face for which eye tracking is performed, and an illumination source 5-530 (e.g., IR or NIR light sources such as an array or ring of NIR light-emitting diodes (LEDs)) that emit light (e.g., IR or NIR light) towards the user's eye(s) 5-592. The eye tracking cameras 5-540 may be pointed towards mirrors 5-550 located between the user's eye(s) 5-592 and a display 5-510 (e.g., a left or right display panel of a head-mounted display, or a display of a handheld device, a projector, etc.) that reflect IR or NIR light from the eye(s) 5-592 while allowing visible light to pass (e.g., as shown in the top portion of FIG. 5V), or alternatively may be pointed towards the user's eye(s) 5-592 to receive reflected IR or NIR light from the eye(s) 5-592 (e.g., as shown in the bottom portion of FIG. 5V).

In some embodiments, the controller 5-110 renders AR or VR frames 5-562 (e.g., left and right frames for left and right display panels) and provides the frames 5-562 to the display 5-510. The controller 5-110 uses gaze tracking input 5-542 from the eye tracking cameras 5-540 for various purposes, for example in processing the frames 5-562 for display. The controller 5-110 optionally estimates the user's point of gaze on the display 5-510 based on the gaze tracking input 5-542 obtained from the eye tracking cameras 5-540 using the glint-assisted methods or other suitable methods. The point of gaze estimated from the gaze tracking input 5-542 is optionally used to determine the direction in which the user is currently looking.

The following describes several possible use cases for the user's current gaze direction and is not intended to be limiting. As an example use case, the controller 5-110 may render virtual content differently based on the determined direction of the user's gaze. For example, the controller 5-110 may generate virtual content at a higher resolution in a foveal region determined from the user's current gaze direction than in peripheral regions. As another example, the controller may position or move virtual content in the view based at least in part on the user's current gaze direction. As another example, the controller may display particular virtual content in the view based at least in part on the user's current gaze direction. As another example use case in AR applications, the controller 5-110 may direct external cameras for capturing the physical environments of the XR experience to focus in the determined direction. The autofocus mechanism of the external cameras may then focus on an object or surface in the environment that the user is currently looking at on the display 5-510. As another example use case, the eye lenses 5-520 may be focusable lenses, and the gaze tracking information is used by the controller to adjust the focus of the eye lenses 5-520 so that the virtual object that the user is currently looking at has the proper vergence to match the convergence of the user's eyes 5-592. The controller 5-110 may leverage the gaze tracking information to direct the eye lenses 5-520 to adjust focus so that close objects that the user is looking at appear at the right distance.

In some embodiments, the eye tracking device is part of a head-mounted device that includes a display (e.g., display 5-510), two eye lenses (e.g., eye lens(es) 5-520), eye tracking cameras (e.g., eye tracking camera(s) 5-540), and light sources (e.g., illumination sources 5-530 (e.g., IR or NIR LEDs)) mounted in a wearable housing. The light sources emit light (e.g., IR or NIR light) towards the user's eye(s) 5-592. In some embodiments, the light sources may be arranged in rings or circles around each of the lenses as shown in FIG. 5V. In some embodiments, eight illumination sources 5-530 (e.g., LEDs) are arranged around each lens 5-520 as an example. However, more or fewer illumination sources 5-530 may be used, and other arrangements and locations of illumination sources 5-530 may be used.

In some embodiments, the display 5-510 emits light in the visible light range and does not emit light in the IR or NIR range, and thus does not introduce noise in the gaze tracking system. Note that the location and angle of eye tracking camera(s) 5-540 is given by way of example and is not intended to be limiting. In some embodiments, a single eye tracking camera 5-540 is located on each side of the user's face. In some embodiments, two or more NIR cameras 5-540 may be used on each side of the user's face. In some embodiments, a camera 5-540 with a wider field of view (FOV) and a camera 540 with a narrower FOV may be used on each side of the user's face. In some embodiments, a camera 5-540 that operates at one wavelength (e.g., 850 nm) and a camera 5-540 that operates at a different wavelength (e.g., 940 nm) may be used on each side of the user's face.

Embodiments of the gaze tracking system as illustrated in FIG. 5V may, for example, be used in computer-generated reality, virtual reality, and/or mixed reality applications to provide computer-generated reality, virtual reality, augmented reality, and/or augmented virtuality experiences to the user.

FIG. 5W illustrates a glint-assisted gaze tracking pipeline, in accordance with some embodiments. In some embodiments, the gaze tracking pipeline is implemented by a glint-assisted gaze tracking system (e.g., eye tracking device 5-130 as illustrated in FIGS. 5C and 5V). The glint-assisted gaze tracking system may maintain a tracking state. Initially, the tracking state is off or “NO”. When in the tracking state, the glint-assisted gaze tracking system uses prior information from the previous frame when analyzing the current frame to track the pupil contour and glints in the current frame. When not in the tracking state, the glint-assisted gaze tracking system attempts to detect the pupil and glints in the current frame and, if successful, initializes the tracking state to “YES” and continues with the next frame in the tracking state.

As shown in FIG. 5W, the gaze tracking cameras may capture left and right images of the user's left and right eyes. The captured images are then input to a gaze tracking pipeline for processing beginning at 5-610. As indicated by the arrow returning to element 5-600, the gaze tracking system may continue to capture images of the user's eyes, for example at a rate of 60 to 120 frames per second. In some embodiments, each set of captured images may be input to the pipeline for processing. However, in some embodiments or under some conditions, not all captured frames are processed by the pipeline.

At 5-610, for the current captured images, if the tracking state is YES, then the method proceeds to element 5-640. At 5-610, if the tracking state is NO, then as indicated at 5-620 the images are analyzed to detect the user's pupils and glints in the images. At 5-630, if the pupils and glints are successfully detected, then the method proceeds to element 5-640. Otherwise, the method returns to element 5-610 to process next images of the user's eyes.

At 5-640, if proceeding from element 5-610, the current frames are analyzed to track the pupils and glints based in part on prior information from the previous frames. At 5-640, if proceeding from element 5-630, the tracking state is initialized based on the detected pupils and glints in the current frames. Results of processing at element 5-640 are checked to verify that the results of tracking or detection can be trusted. For example, results may be checked to determine if the pupil and a sufficient number of glints to perform gaze estimation are successfully tracked or detected in the current frames. At 5-650, if the results cannot be trusted, then the tracking state is set to NO at element 5-660, and the method returns to element 5-610 to process next images of the user's eyes. At 5-650, if the results are trusted, then the method proceeds to element 5-670. At 5-670, the tracking state is set to YES (if not already YES), and the pupil and glint information is passed to element 5-680 to estimate the user's point of gaze.

FIG. 5W is intended to serve as one example of eye tracking technology that may be used in a particular implementation. As recognized by those of ordinary skill in the art, other eye tracking technologies that currently exist or are developed in the future may be used in place of or in combination with the glint-assisted eye tracking technology describe herein in the computer system 5-101 for providing XR experiences to users, in accordance with various embodiments.

In some embodiments, the captured portions of real-world environment 5-602 are used to provide a XR experience to the user, for example, a mixed reality environment in which one or more virtual objects are superimposed over representations of real-world environment 5-602.

Thus, the description herein describes some embodiments of three-dimensional environments (e.g., XR environments) that include representations of real-world objects and representations of virtual objects. For example, a three-dimensional environment optionally includes a representation of a table that exists in the physical environment, which is captured and displayed in the three-dimensional environment (e.g., actively via cameras and displays of a computer system, or passively via a transparent or translucent display of the computer system). As described previously, the three-dimensional environment is optionally a mixed reality system in which the three-dimensional environment is based on the physical environment that is captured by one or more sensors of the computer system and displayed via a display generation component. As a mixed reality system, the computer system is optionally able to selectively display portions and/or objects of the physical environment such that the respective portions and/or objects of the physical environment appear as if they exist in the three-dimensional environment displayed by the computer system. Similarly, the computer system is optionally able to display virtual objects in the three-dimensional environment to appear as if the virtual objects exist in the real world (e.g., physical environment) by placing the virtual objects at respective locations in the three-dimensional environment that have corresponding locations in the real world. For example, the computer system optionally displays a vase such that it appears as if a real vase is placed on top of a table in the physical environment. In some embodiments, a respective location in the three-dimensional environment has a corresponding location in the physical environment. Thus, when the computer system is described as displaying a virtual object at a respective location with respect to a physical object (e.g., such as a location at or near the hand of the user, or at or near a physical table), the computer system displays the virtual object at a particular location in the three-dimensional environment such that it appears as if the virtual object is at or near the physical object in the physical world (e.g., the virtual object is displayed at a location in the three-dimensional environment that corresponds to a location in the physical environment at which the virtual object would be displayed if it were a real object at that particular location).

In some embodiments, real world objects that exist in the physical environment that are displayed in the three-dimensional environment (e.g., and/or visible via the display generation component) can interact with virtual objects that exist only in the three-dimensional environment. For example, a three-dimensional environment can include a table and a vase placed on top of the table, with the table being a view of (or a representation of) a physical table in the physical environment, and the vase being a virtual object.

In a three-dimensional environment (e.g., a real environment, a virtual environment, or an environment that includes a mix of real and virtual objects), objects are sometimes referred to as having a depth or simulated depth, or objects are referred to as being visible, displayed, or placed at different depths. In this context, depth refers to a dimension other than height or width. In some embodiments, depth is defined relative to a fixed set of coordinates (e.g., where a room or an object has a height, depth, and width defined relative to the fixed set of coordinates). In some embodiments, depth is defined relative to a location or viewpoint of a user, in which case, the depth dimension varies based on the location of the user and/or the location and angle of the viewpoint of the user. In some embodiments where depth is defined relative to a location of a user that is positioned relative to a surface of an environment (e.g., a floor of an environment, or a surface of the ground), objects that are further away from the user along a line that extends parallel to the surface are considered to have a greater depth in the environment, and/or the depth of an object is measured along an axis that extends outward from a location of the user and is parallel to the surface of the environment (e.g., depth is defined in a cylindrical or substantially cylindrical coordinate system with the position of the user at the center of the cylinder that extends from a head of the user toward feet of the user). In some embodiments where depth is defined relative to viewpoint of a user (e.g., a direction relative to a point in space that determines which portion of an environment that is visible via a head mounted device or other display), objects that are further away from the viewpoint of the user along a line that extends parallel to the direction of the viewpoint of the user are considered to have a greater depth in the environment, and/or the depth of an object is measured along an axis that extends outward from a line that extends from the viewpoint of the user and is parallel to the direction of the viewpoint of the user (e.g., depth is defined in a spherical or substantially spherical coordinate system with the origin of the viewpoint at the center of the sphere that extends outwardly from a head of the user). In some embodiments, depth is defined relative to a user interface container (e.g., a window or application in which application and/or system content is displayed) where the user interface container has a height and/or width, and depth is a dimension that is orthogonal to the height and/or width of the user interface container. In some embodiments, in circumstances where depth is defined relative to a user interface container, the height and or width of the container are typically orthogonal or substantially orthogonal to a line that extends from a location based on the user (e.g., a viewpoint of the user or a location of the user) to the user interface container (e.g., the center of the user interface container, or another characteristic point of the user interface container) when the container is placed in the three-dimensional environment or is initially displayed (e.g., so that the depth dimension for the container extends outward away from the user or the viewpoint of the user). In some embodiments, in situations where depth is defined relative to a user interface container, depth of an object relative to the user interface container refers to a position of the object along the depth dimension for the user interface container. In some embodiments, multiple different containers can have different depth dimensions (e.g., different depth dimensions that extend away from the user or the viewpoint of the user in different directions and/or from different starting points). In some embodiments, when depth is defined relative to a user interface container, the direction of the depth dimension remains constant for the user interface container as the location of the user interface container, the user and/or the viewpoint of the user changes (e.g., or when multiple different viewers are viewing the same container in the three-dimensional environment such as during an in-person collaboration session and/or when multiple participants are in a real-time communication session with shared virtual content including the container). In some embodiments, for curved containers (e.g., including a container with a curved surface or curved content region), the depth dimension optionally extends into a surface of the curved container. In some situations, z-separation (e.g., separation of two objects in a depth dimension), z-height (e.g., distance of one object from another in a depth dimension), z-position (e.g., position of one object in a depth dimension), z-depth (e.g., position of one object in a depth dimension), or simulated z dimension (e.g., depth used as a dimension of an object, dimension of an environment, a direction in space, and/or a direction in simulated space) are used to refer to the concept of depth as described above.

In some embodiments, a user is optionally able to interact with virtual objects in the three-dimensional environment using one or more hands as if the virtual objects were real objects in the physical environment. For example, as described above, one or more sensors of the computer system optionally capture one or more of the hands of the user and display representations of the hands of the user in the three-dimensional environment (e.g., in a manner similar to displaying a real world object in three-dimensional environment described above), or in some embodiments, the hands of the user are visible via the display generation component via the ability to see the physical environment through the user interface due to the transparency/translucency of a portion of the display generation component that is displaying the user interface or due to projection of the user interface onto a transparent/translucent surface or projection of the user interface onto the user's eye or into a field of view of the user's eye. Thus, in some embodiments, the hands of the user are displayed at a respective location in the three-dimensional environment and are treated as if they were objects in the three-dimensional environment that are able to interact with the virtual objects in the three-dimensional environment as if they were physical objects in the physical environment. In some embodiments, the computer system is able to update display of the representations of the user's hands in the three-dimensional environment in conjunction with the movement of the user's hands in the physical environment.

In some of the embodiments described below, the computer system is optionally able to determine the “effective” distance between physical objects in the physical world and virtual objects in the three-dimensional environment, for example, for the purpose of determining whether a physical object is directly interacting with a virtual object (e.g., whether a hand is touching, grabbing, holding, etc. a virtual object or within a threshold distance of a virtual object). For example, a hand directly interacting with a virtual object optionally includes one or more of a finger of a hand pressing a virtual button, a hand of a user grabbing a virtual vase, two fingers of a hand of the user coming together and pinching/holding a user interface of an application, and any of the other types of interactions described here. For example, the computer system optionally determines the distance between the hands of the user and virtual objects when determining whether the user is interacting with virtual objects and/or how the user is interacting with virtual objects. In some embodiments, the computer system determines the distance between the hands of the user and a virtual object by determining the distance between the location of the hands in the three-dimensional environment and the location of the virtual object of interest in the three-dimensional environment. For example, the one or more hands of the user are located at a particular position in the physical world, which the computer system optionally captures and displays at a particular corresponding position in the three-dimensional environment (e.g., the position in the three-dimensional environment at which the hands would be displayed if the hands were virtual, rather than physical, hands). The position of the hands in the three-dimensional environment is optionally compared with the position of the virtual object of interest in the three-dimensional environment to determine the distance between the one or more hands of the user and the virtual object. In some embodiments, the computer system optionally determines a distance between a physical object and a virtual object by comparing positions in the physical world (e.g., as opposed to comparing positions in the three-dimensional environment). For example, when determining the distance between one or more hands of the user and a virtual object, the computer system optionally determines the corresponding location in the physical world of the virtual object (e.g., the position at which the virtual object would be located in the physical world if it were a physical object rather than a virtual object), and then determines the distance between the corresponding physical position and the one of more hands of the user. In some embodiments, the same techniques are optionally used to determine the distance between any physical object and any virtual object. Thus, as described herein, when determining whether a physical object is in contact with a virtual object or whether a physical object is within a threshold distance of a virtual object, the computer system optionally performs any of the techniques described above to map the location of the physical object to the three-dimensional environment and/or map the location of the virtual object to the physical environment.

In some embodiments, the same or similar technique is used to determine where and what the gaze of the user is directed to and/or where and at what a physical stylus held by a user is pointed. For example, if the gaze of the user is directed to a particular position in the physical environment, the computer system optionally determines the corresponding position in the three-dimensional environment (e.g., the virtual position of the gaze), and if a virtual object is located at that corresponding virtual position, the computer system optionally determines that the gaze of the user is directed to that virtual object. Similarly, the computer system is optionally able to determine, based on the orientation of a physical stylus, to where in the physical environment the stylus is pointing. In some embodiments, based on this determination, the computer system determines the corresponding virtual position in the three-dimensional environment that corresponds to the location in the physical environment to which the stylus is pointing, and optionally determines that the stylus is pointing at the corresponding virtual position in the three-dimensional environment.

Similarly, the embodiments described herein may refer to the location of the user (e.g., the user of the computer system) and/or the location of the computer system in the three-dimensional environment. In some embodiments, the user of the computer system is holding, wearing, or otherwise located at or near the computer system. Thus, in some embodiments, the location of the computer system is used as a proxy for the location of the user. In some embodiments, the location of the computer system and/or user in the physical environment corresponds to a respective location in the three-dimensional environment. For example, the location of the computer system would be the location in the physical environment (and its corresponding location in the three-dimensional environment) from which, if a user were to stand at that location facing a respective portion of the physical environment that is visible via the display generation component, the user would see the objects in the physical environment in the same positions, orientations, and/or sizes as they are displayed by or visible via the display generation component of the computer system in the three-dimensional environment (e.g., in absolute terms and/or relative to each other). Similarly, if the virtual objects displayed in the three-dimensional environment were physical objects in the physical environment (e.g., placed at the same locations in the physical environment as they are in the three-dimensional environment, and having the same sizes and orientations in the physical environment as in the three-dimensional environment), the location of the computer system and/or user is the position from which the user would see the virtual objects in the physical environment in the same positions, orientations, and/or sizes as they are displayed by the display generation component of the computer system in the three-dimensional environment (e.g., in absolute terms and/or relative to each other and the real world objects).

In the present disclosure, various input methods are described with respect to interactions with a computer system. When an example is provided using one input device or input method and another example is provided using another input device or input method, it is to be understood that each example may be compatible with and optionally utilizes the input device or input method described with respect to another example. Similarly, various output methods are described with respect to interactions with a computer system. When an example is provided using one output device or output method and another example is provided using another output device or output method, it is to be understood that each example may be compatible with and optionally utilizes the output device or output method described with respect to another example. Similarly, various methods are described with respect to interactions with a virtual environment or a mixed reality environment through a computer system. When an example is provided using interactions with a virtual environment and another example is provided using mixed reality environment, it is to be understood that each example may be compatible with and optionally utilizes the methods described with respect to another example. As such, the present disclosure discloses embodiments that are combinations of the features of multiple examples, without exhaustively listing all features of an embodiment in the description of each example embodiment.

As used here, the term “affordance” refers to a user-interactive graphical user interface object that is, optionally, displayed on the display screen of devices 100, 300, and/or 500 (FIGS. 1A, 3A, and 5A-5B). For example, an image (e.g., icon), a button, and text (e.g., hyperlink) each optionally constitute an affordance.

As used herein, the term “focus selector” refers to an input element that indicates a current part of a user interface with which a user is interacting. In some implementations that include a cursor or other location marker, the cursor acts as a “focus selector” so that when an input (e.g., a press input) is detected on a touch-sensitive surface (e.g., touchpad 355 in FIG. 3A or touch-sensitive surface 451 in FIG. 4B) while the cursor is over a particular user interface element (e.g., a button, window, slider, or other user interface element), the particular user interface element is adjusted in accordance with the detected input. In some implementations that include a touch screen display (e.g., touch-sensitive display system 112 in FIG. 1A or touch screen 112 in FIG. 4A) that enables direct interaction with user interface elements on the touch screen display, a detected contact on the touch screen acts as a “focus selector” so that when an input (e.g., a press input by the contact) is detected on the touch screen display at a location of a particular user interface element (e.g., a button, window, slider, or other user interface element), the particular user interface element is adjusted in accordance with the detected input. In some implementations, focus is moved from one region of a user interface to another region of the user interface without corresponding movement of a cursor or movement of a contact on a touch screen display (e.g., by using a tab key or arrow keys to move focus from one button to another button); in these implementations, the focus selector moves in accordance with movement of focus between different regions of the user interface. Without regard to the specific form taken by the focus selector, the focus selector is generally the user interface element (or contact on a touch screen display) that is controlled by the user so as to communicate the user's intended interaction with the user interface (e.g., by indicating, to the device, the element of the user interface with which the user is intending to interact). For example, the location of a focus selector (e.g., a cursor, a contact, or a selection box) over a respective button while a press input is detected on the touch-sensitive surface (e.g., a touchpad or touch screen) will indicate that the user is intending to activate the respective button (as opposed to other user interface elements shown on a display of the device).

As used in the specification and claims, the term “characteristic intensity” of a contact refers to a characteristic of the contact based on one or more intensities of the contact. In some embodiments, the characteristic intensity is based on multiple intensity samples. The characteristic intensity is, optionally, based on a predefined number of intensity samples, or a set of intensity samples collected during a predetermined time period (e.g., 0.05, 0.1, 0.2, 0.5, 1, 2, 5, 10 seconds) relative to a predefined event (e.g., after detecting the contact, prior to detecting liftoff of the contact, before or after detecting a start of movement of the contact, prior to detecting an end of the contact, before or after detecting an increase in intensity of the contact, and/or before or after detecting a decrease in intensity of the contact). A characteristic intensity of a contact is, optionally, based on one or more of: a maximum value of the intensities of the contact, a mean value of the intensities of the contact, an average value of the intensities of the contact, a top 10 percentile value of the intensities of the contact, a value at the half maximum of the intensities of the contact, a value at the 90 percent maximum of the intensities of the contact, or the like. In some embodiments, the duration of the contact is used in determining the characteristic intensity (e.g., when the characteristic intensity is an average of the intensity of the contact over time). In some embodiments, the characteristic intensity is compared to a set of one or more intensity thresholds to determine whether an operation has been performed by a user. For example, the set of one or more intensity thresholds optionally includes a first intensity threshold and a second intensity threshold. In this example, a contact with a characteristic intensity that does not exceed the first threshold results in a first operation, a contact with a characteristic intensity that exceeds the first intensity threshold and does not exceed the second intensity threshold results in a second operation, and a contact with a characteristic intensity that exceeds the second threshold results in a third operation. In some embodiments, a comparison between the characteristic intensity and one or more thresholds is used to determine whether or not to perform one or more operations (e.g., whether to perform a respective operation or forgo performing the respective operation), rather than being used to determine whether to perform a first operation or a second operation.

As described herein, content is automatically generated by one or more computers in response to a request to generate the content. The automatically-generated content is optionally generated on-device (e.g., generated at least in part by a computer system at which a request to generate the content is received) and/or generated off-device (e.g., generated at least in part by one or more nearby computers that are available via a local network or one or more computers that are available via the internet). This automatically-generated content optionally includes visual content (e.g., images, graphics, and/or video), audio content, and/or text content.

In some embodiments, novel automatically-generated content that is generated via one or more artificial intelligence (AI) processes is referred to as generative content (e.g., generative images, generative graphics, generative video, generative audio, and/or generative text). Generative content is typically generated by an AI process based on a prompt that is provided to the AI process. An AI process typically uses one or more AI models to generate an output based on an input. An AI process optionally includes one or more pre-processing steps to adjust the input before it is used by the AI model to generate an output (e.g., adjustment to a user-provided prompt, creation of a system-generated prompt, and/or AI model selection). An AI process optionally includes one or more post-processing steps to adjust the output by the AI model (e.g., passing AI model output to a different AI model, upscaling, downscaling, cropping, formatting, and/or adding or removing metadata) before the output of the AI model used for other purposes such as being provided to a different software process for further processing or being presented (e.g., visually or audibly) to a user. An AI process that generates generative content is sometimes referred to as a generative AI process.

A prompt for generating generative content can include one or more of: one or more words (e.g., a natural language prompt that is written or spoken), one or more images, one or more drawings, and/or one or more videos. AI processes can include machine learning models including neural networks. Neural networks can include transformer-based deep neural networks such as large language models (LLMs). Generative pre-trained transformer models are a type of LLM that can be effective at generating novel generative content based on a prompt. Some AI processes use a prompt that includes text to generate either different generative text, generative audio content, and/or generative visual content. Some AI processes use a prompt that includes visual content and/or an audio content to generate generative text (e.g., a transcription of audio and/or a description of the visual content). Some multi-modal AI processes use a prompt that includes multiple types of content (e.g., text, images, audio, video, and/or other sensor data) to generate generative content. A prompt sometimes also includes values for one or more parameters indicating an importance of various parts of the prompt. Some prompts include a structured set of instructions that can be understood by an AI process that include phrasing, a specified style, relevant context (e.g., starting point content and/or one or more examples), and/or a role for the AI process.

Generative content is generally based on the prompt but is not deterministically selected from pre-generated content and is, instead, generated using the prompt as a starting point. In some embodiments, pre-existing content (e.g., audio, text, and/or visual content) is used as part of the prompt for creating generative content (e.g., the pre-existing content is used as a starting point for creating the generative content). For example, a prompt could request that a block of text be summarized or rewritten in a different tone, and the output would be generative text that is summarized or written in the different tone. Similarly a prompt could request that visual content be modified to include or exclude content specified by a prompt (e.g., removing an identified feature in the visual content, adding a feature to the visual content that is described in a prompt, changing a visual style of the visual content, and/or creating additional visual elements outside of a spatial or temporal boundary of the visual content that are based on the visual content). In some embodiments, a random or pseudo-random seed is used as part of the prompt for creating generative content (e.g., the random or pseud-random seed content is used as a starting point for creating the generative content). For example, when generating an image from a diffusion model, a random noise pattern is iteratively denoised based on the prompt to generate an image that is based on the prompt. While specific types of AI processes have been described herein, it should be understood that a variety of different AI processes could be used to generate generative content based on a prompt.

Attention is now directed towards embodiments of user interfaces (“UI”) and associated processes that are implemented on an electronic device, such as portable multifunction device 100, device 300, or device 500.

FIGS. 6A-1-6AJ illustrate exemplary user interfaces for navigating, displaying, and/or presenting content, in accordance with some embodiments. The user interfaces in these figures are used to illustrate the processes described below, including the processes in FIG. 7 and FIGS. 8A-8B.

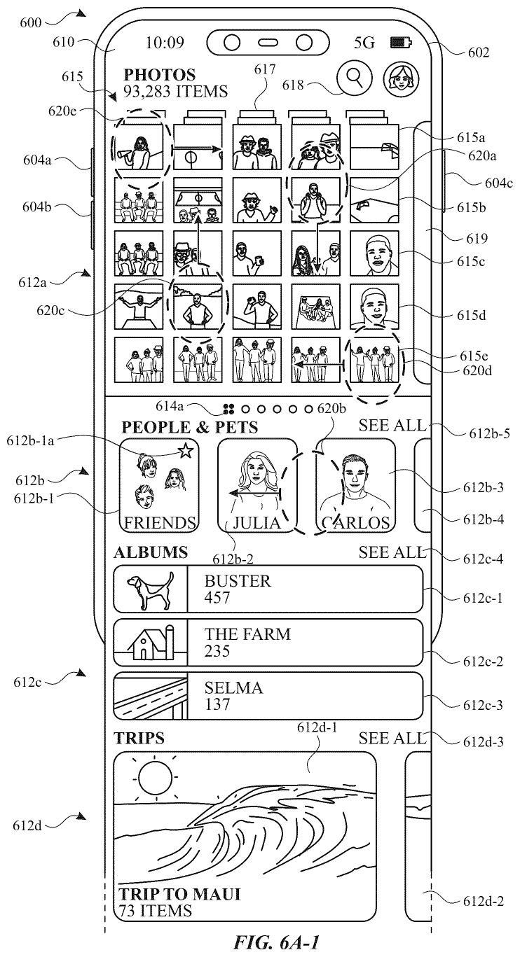

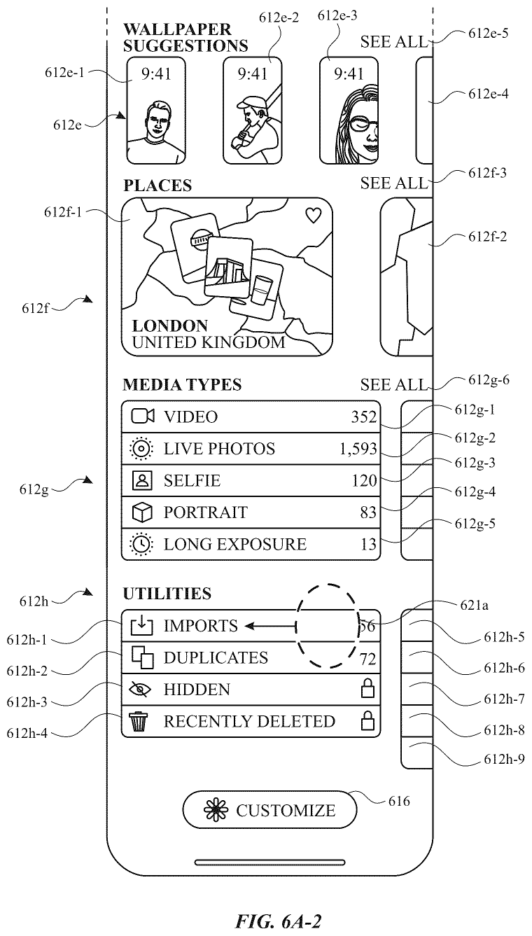

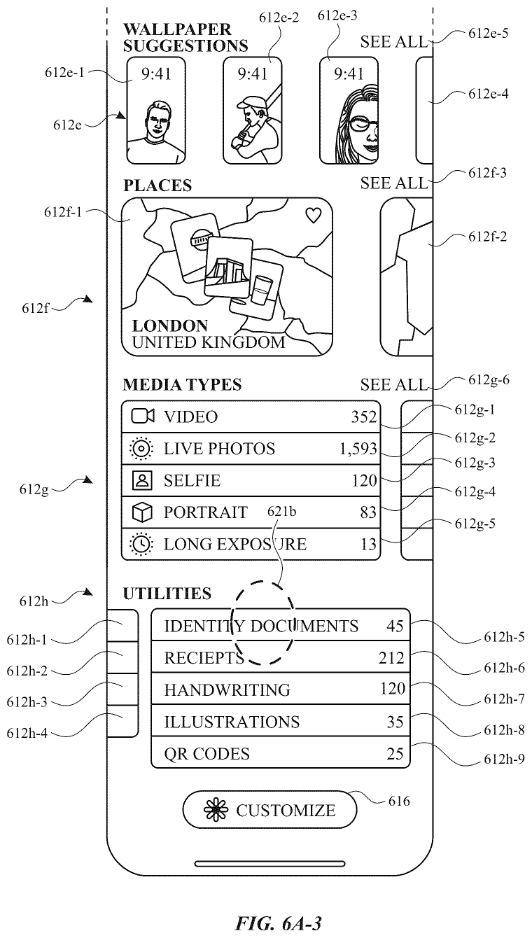

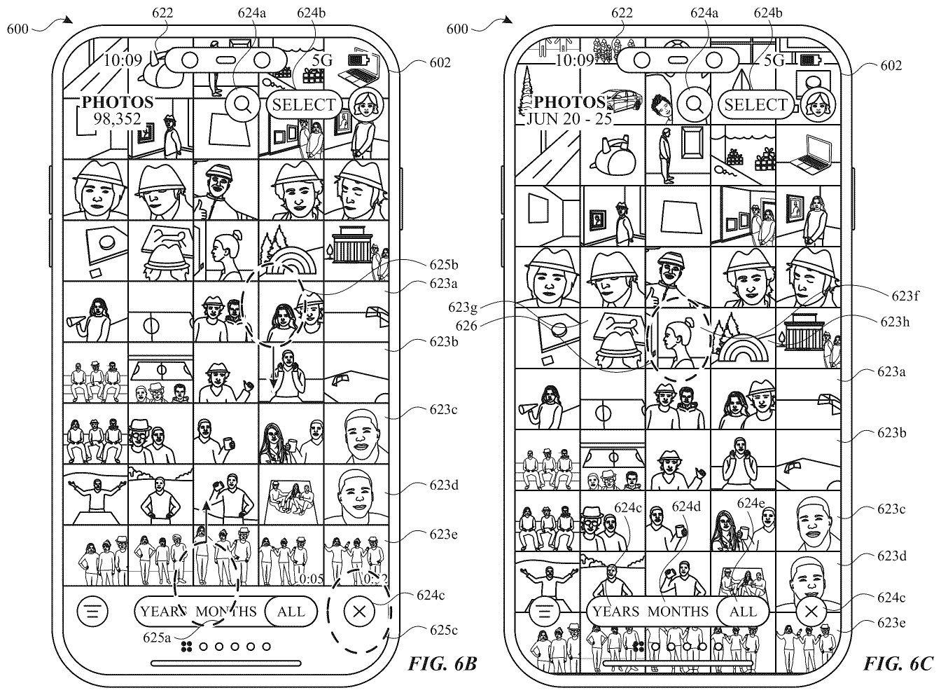

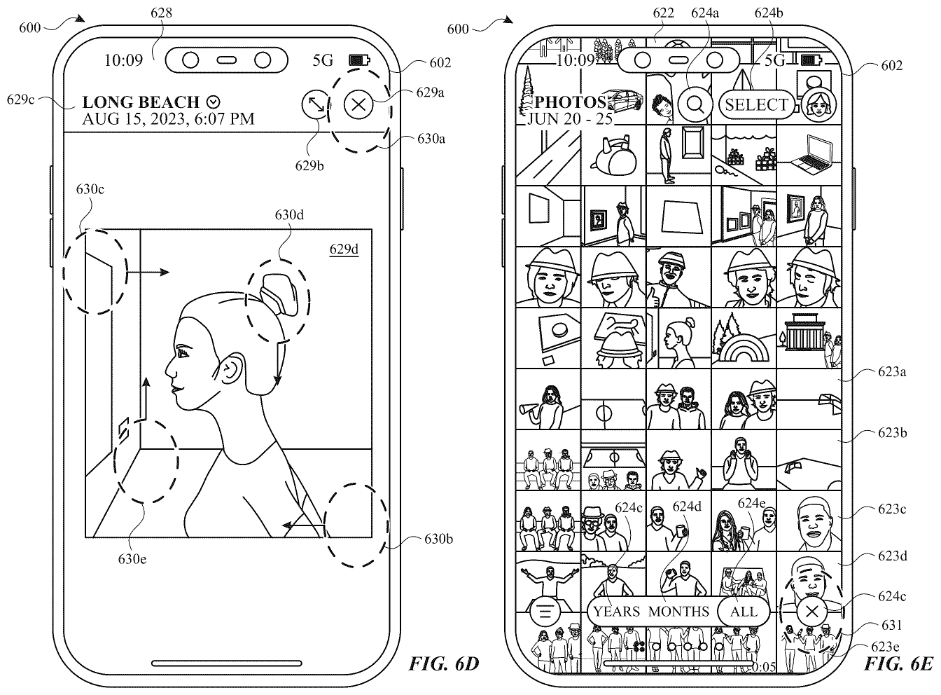

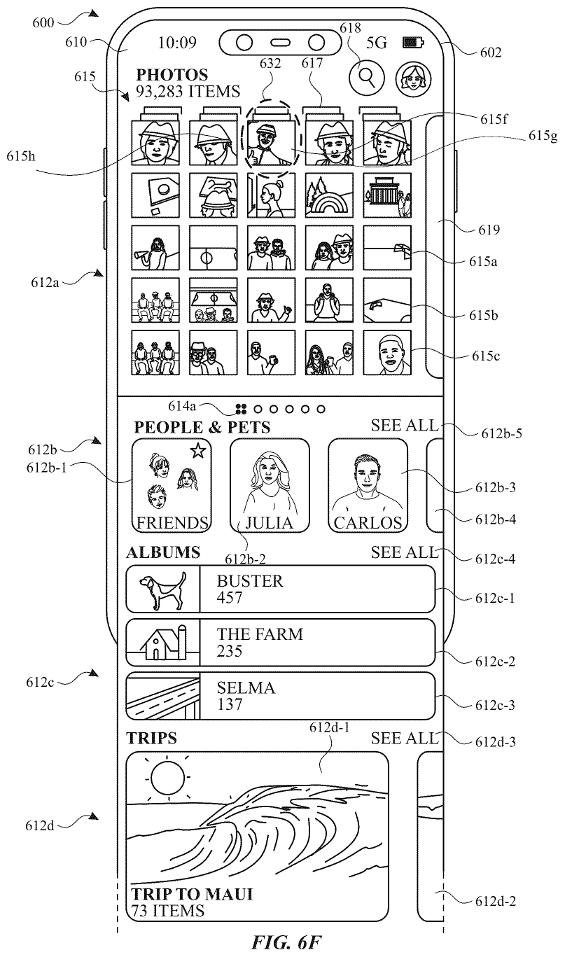

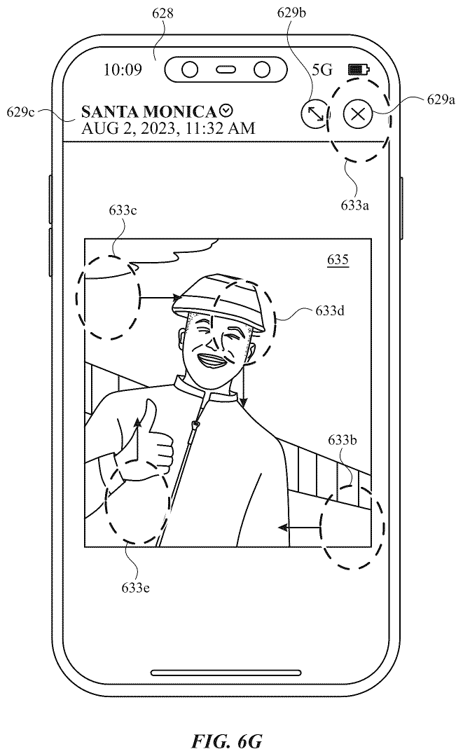

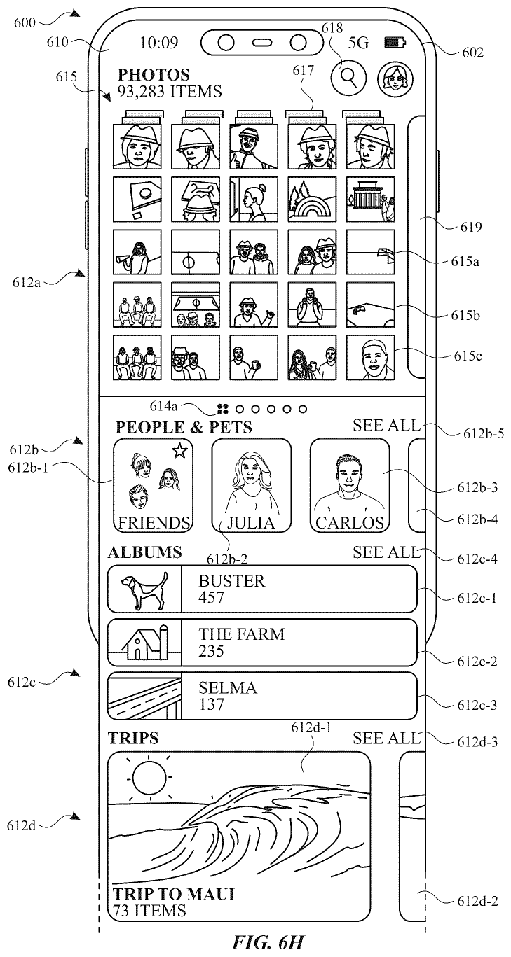

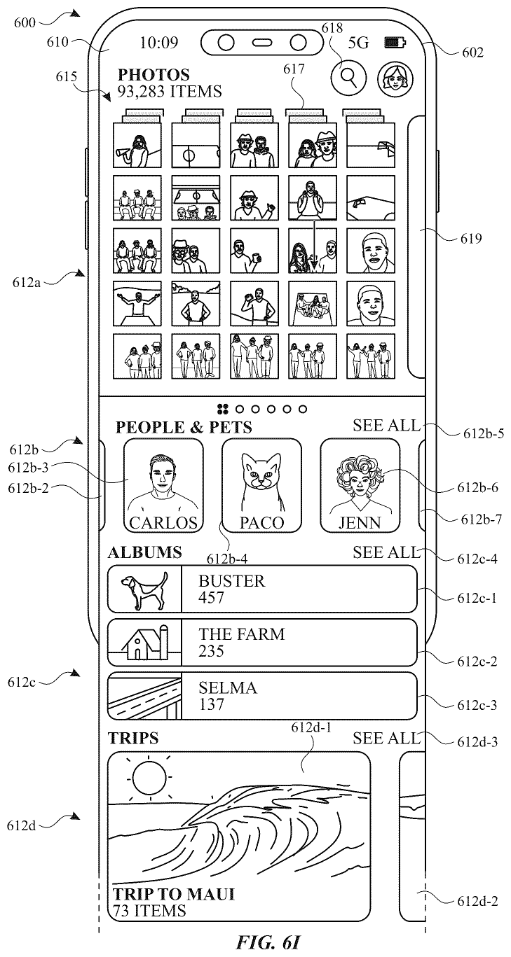

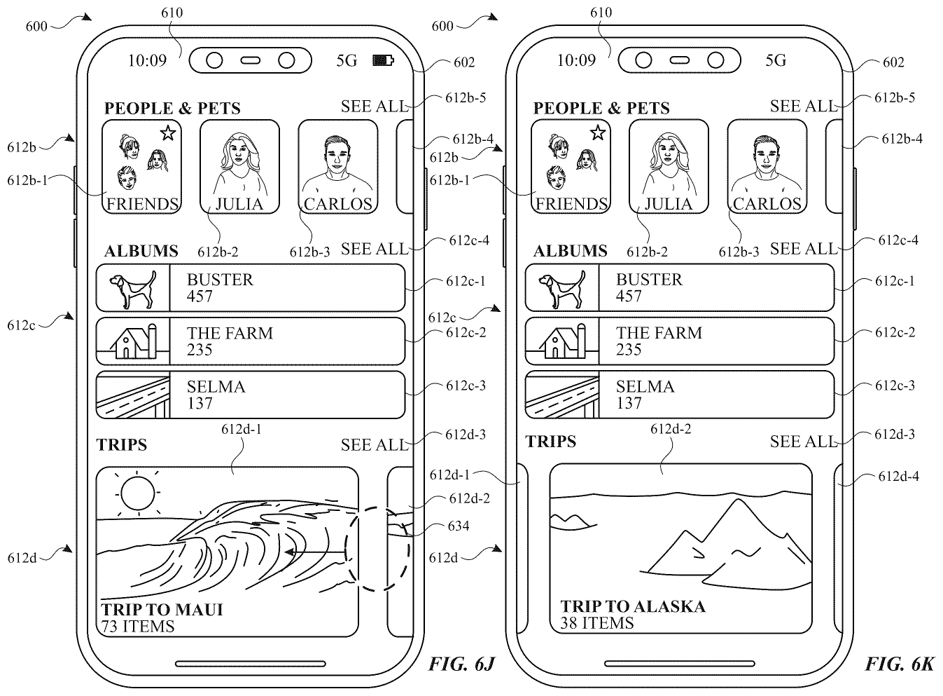

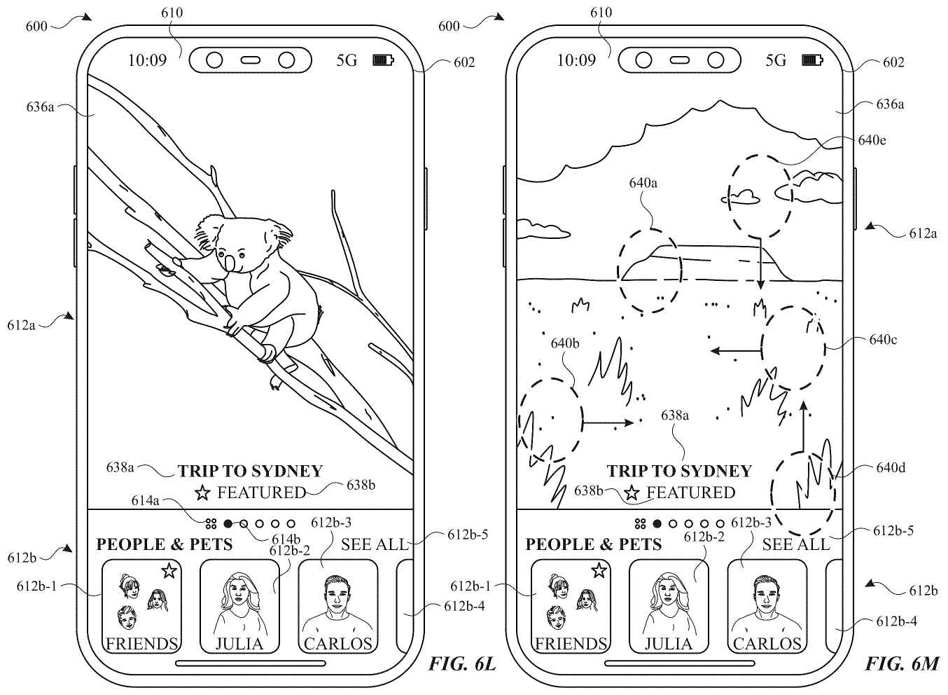

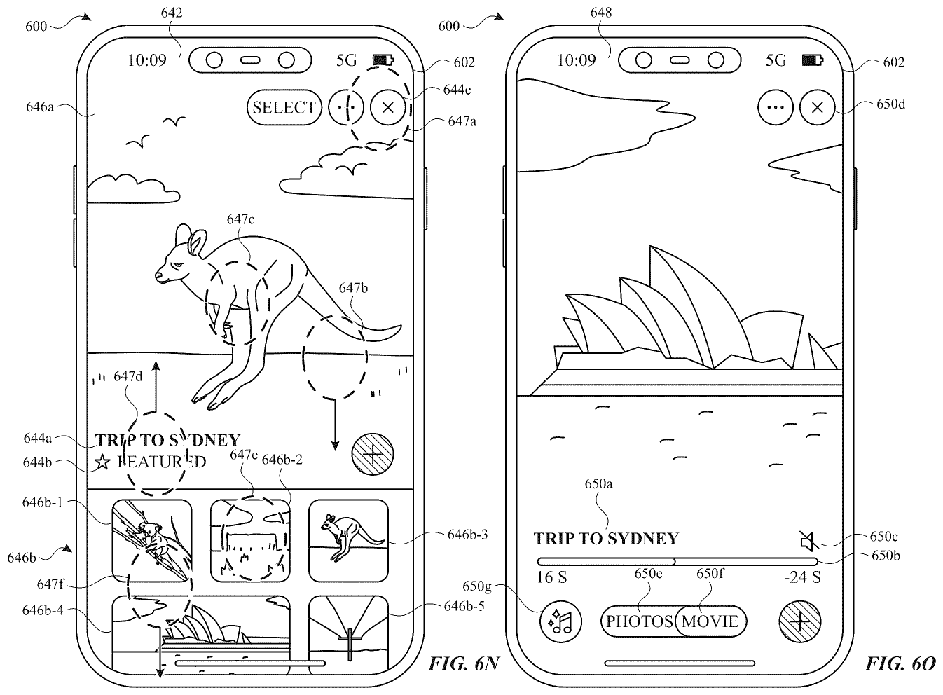

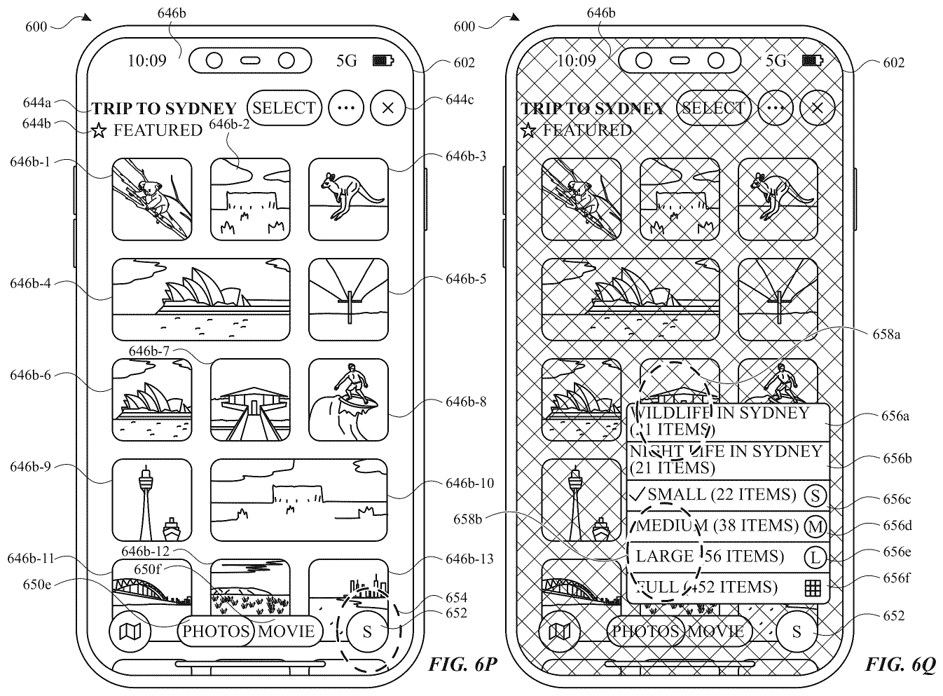

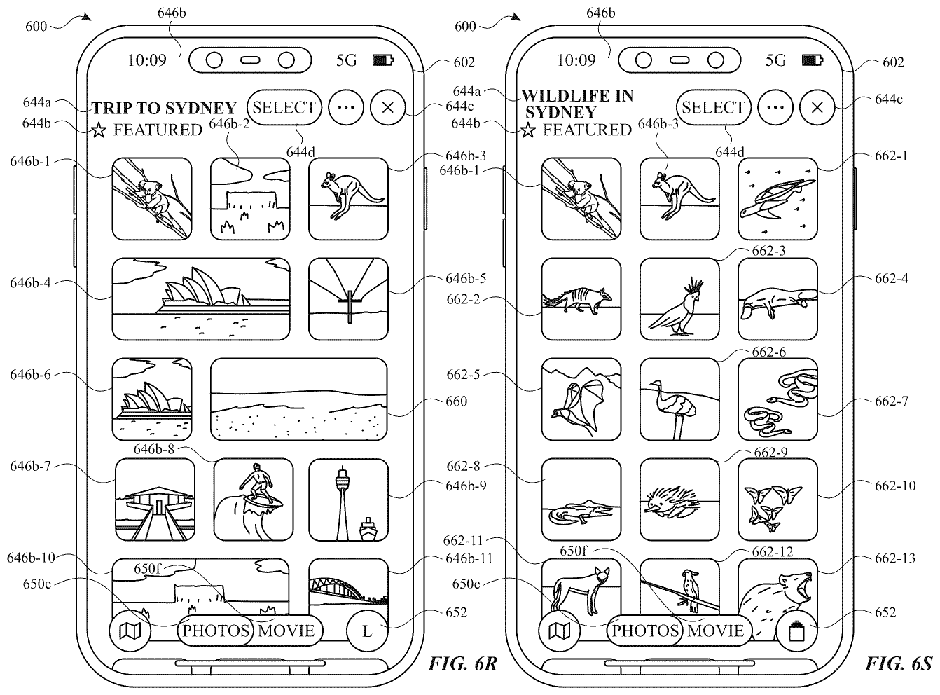

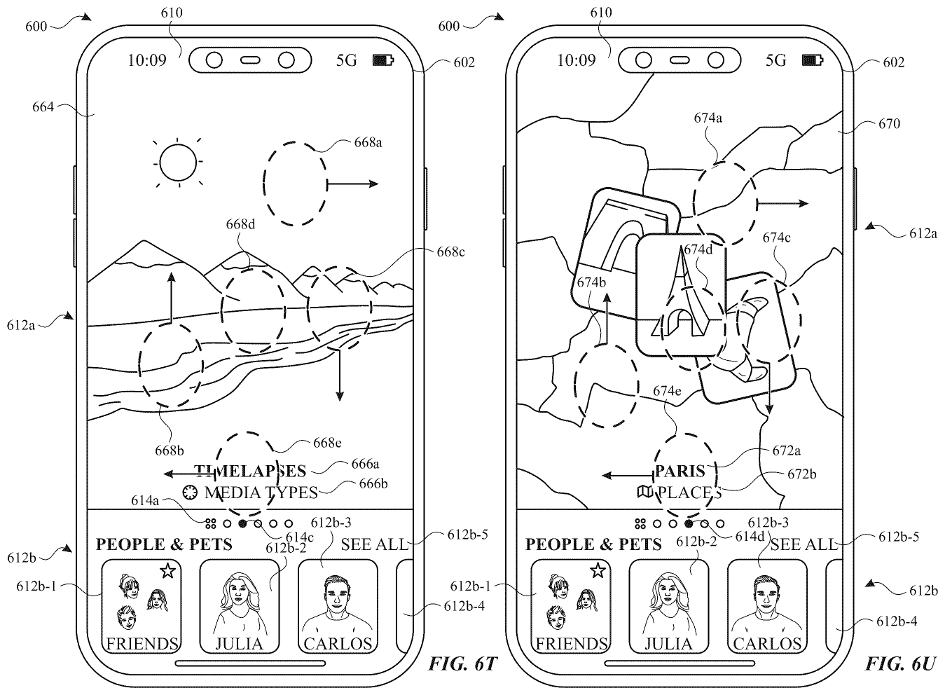

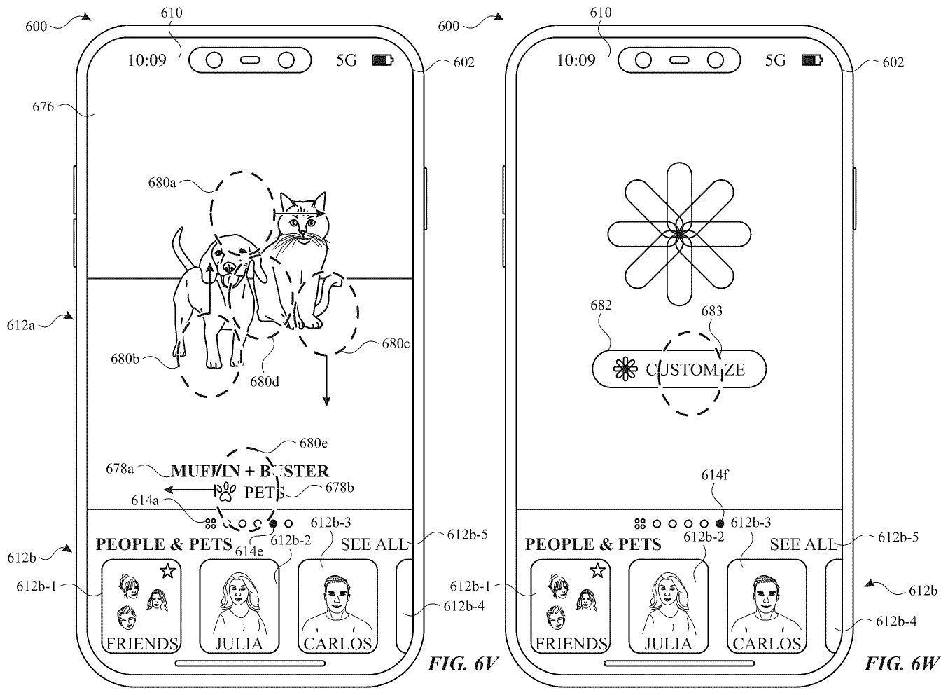

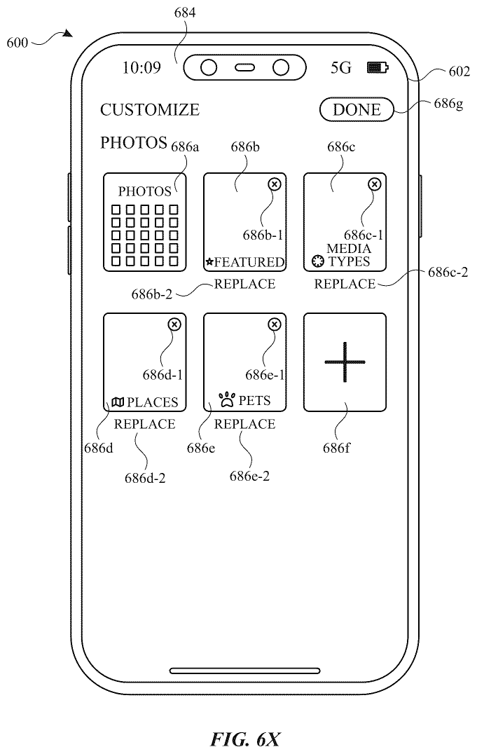

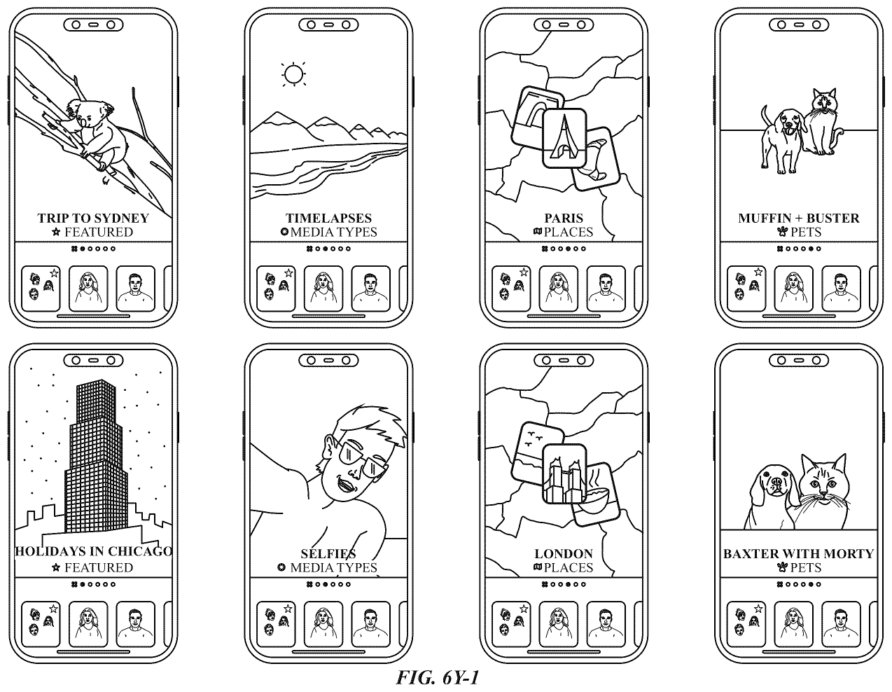

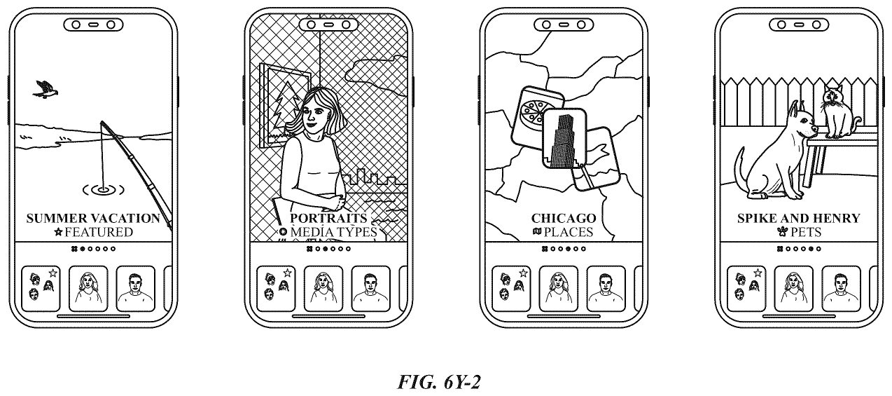

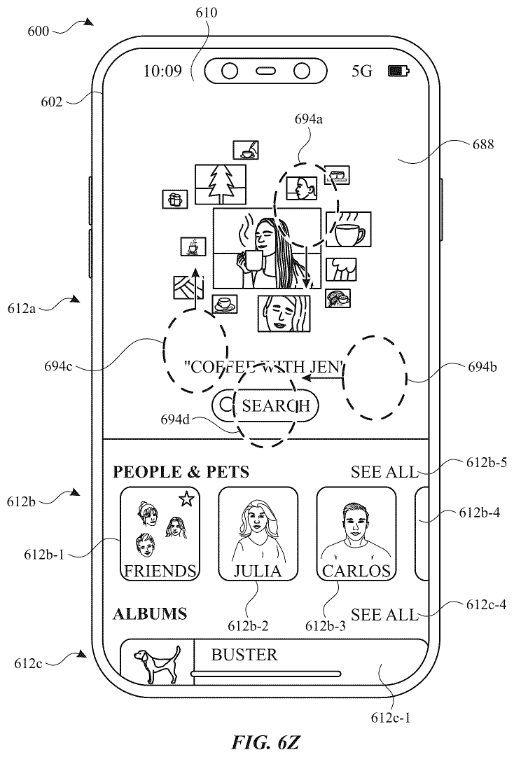

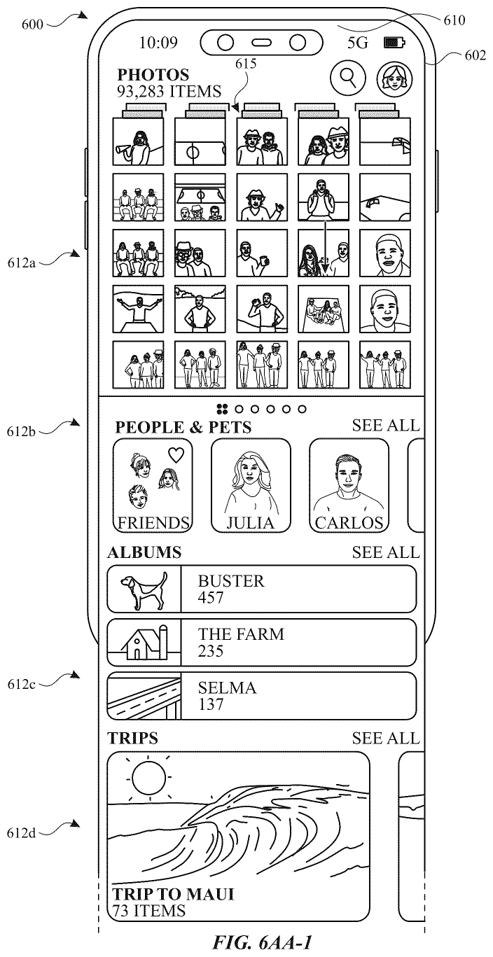

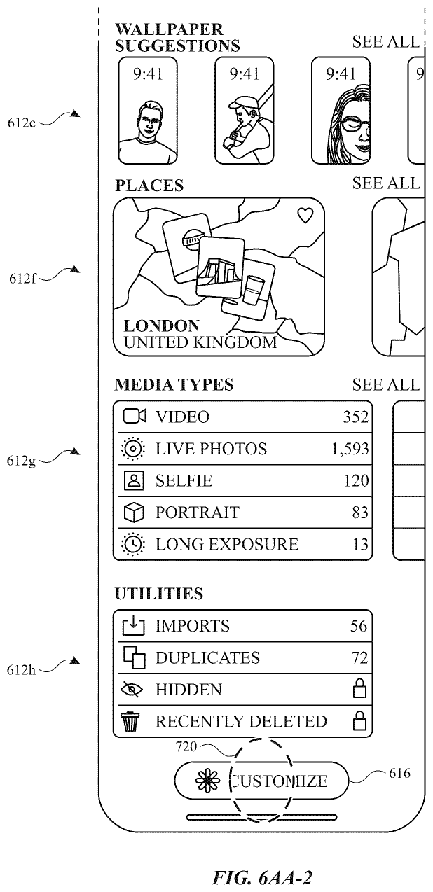

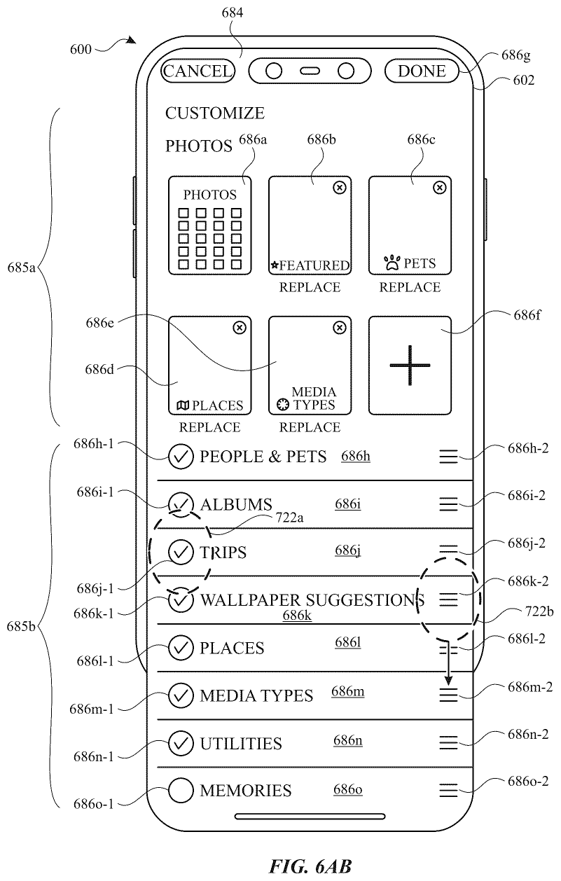

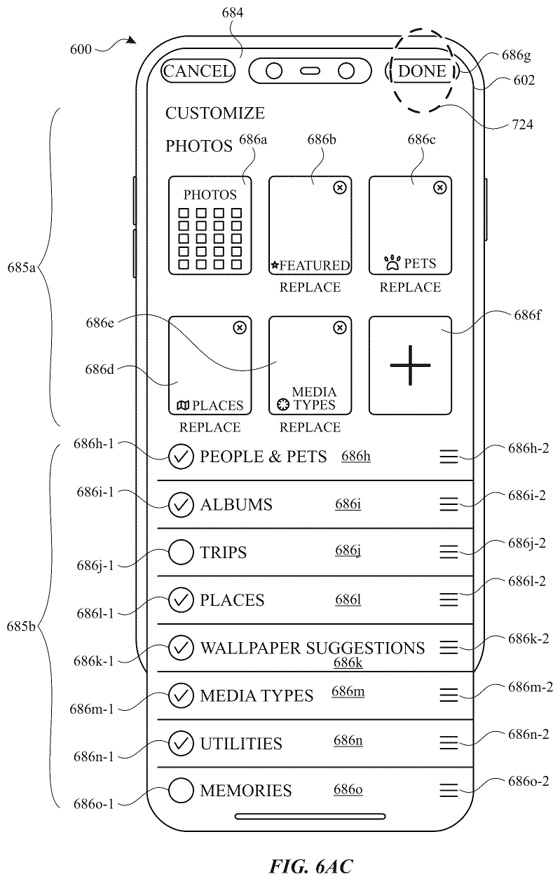

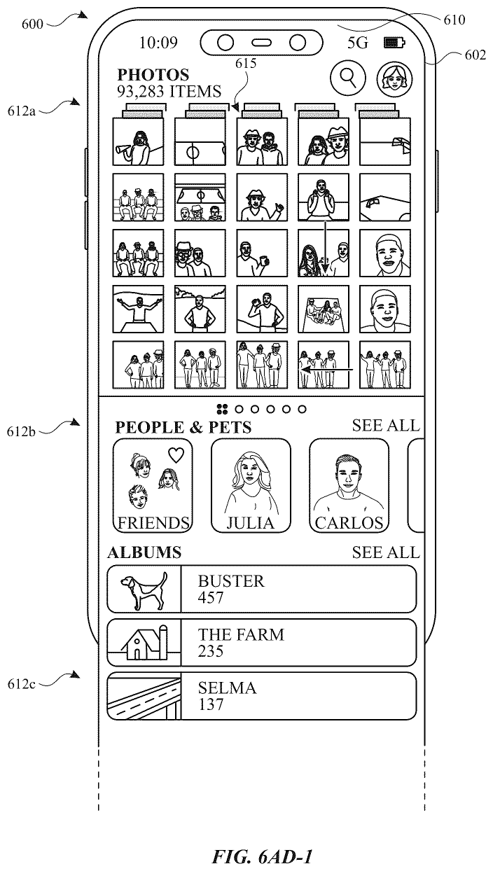

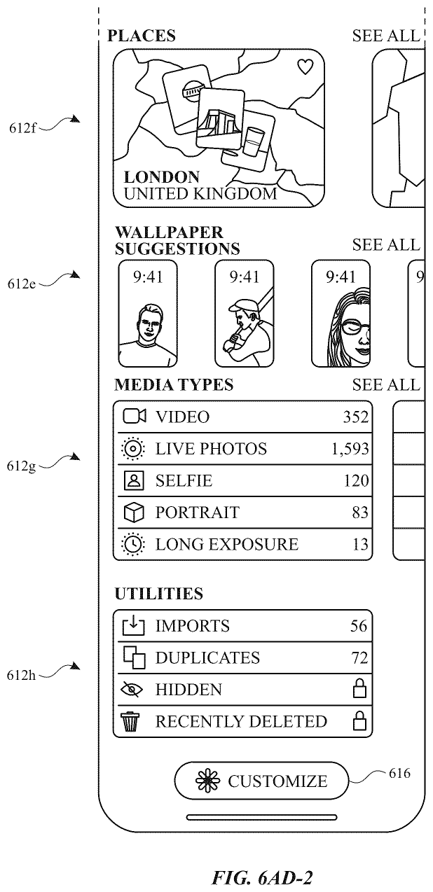

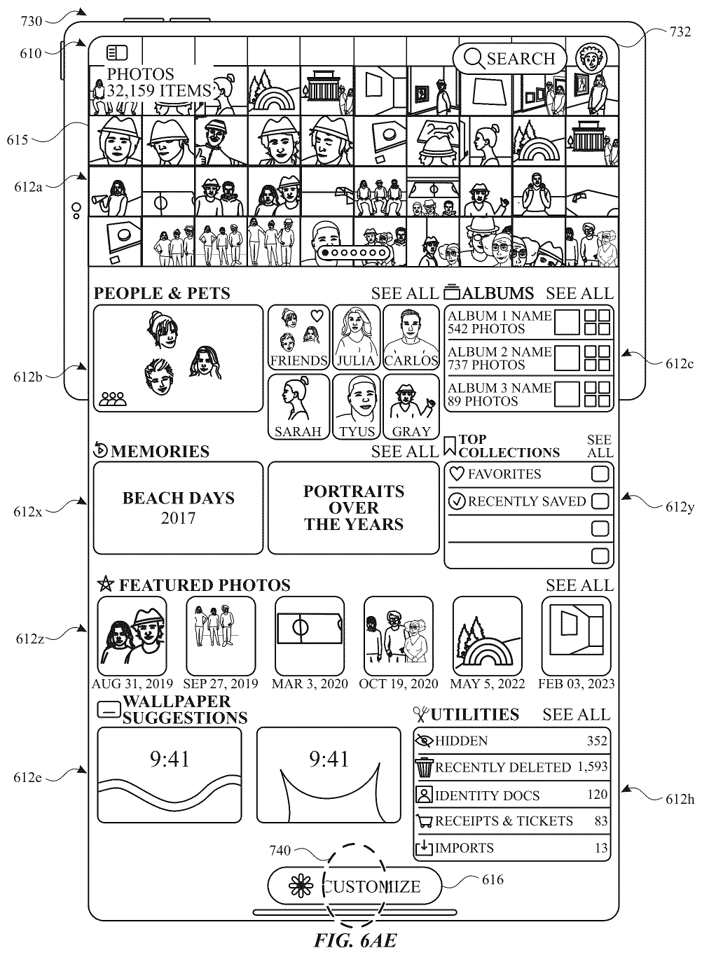

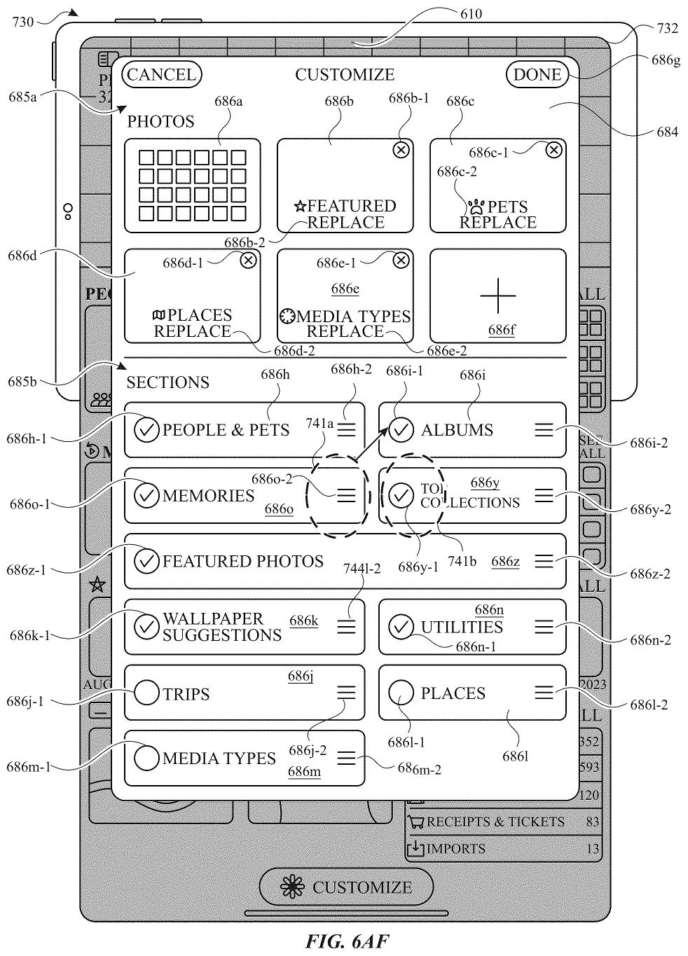

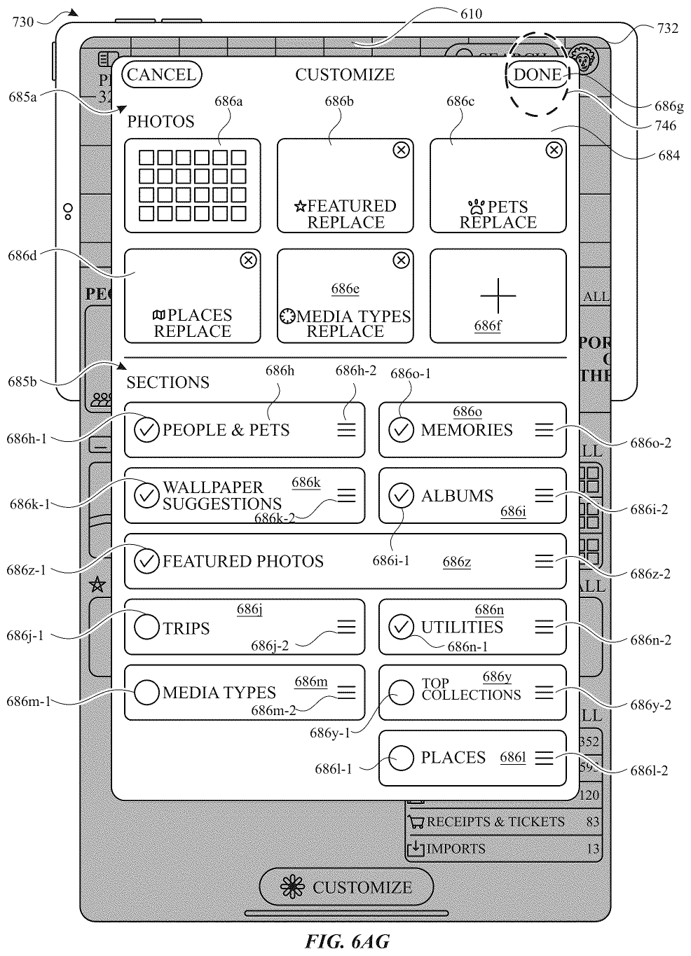

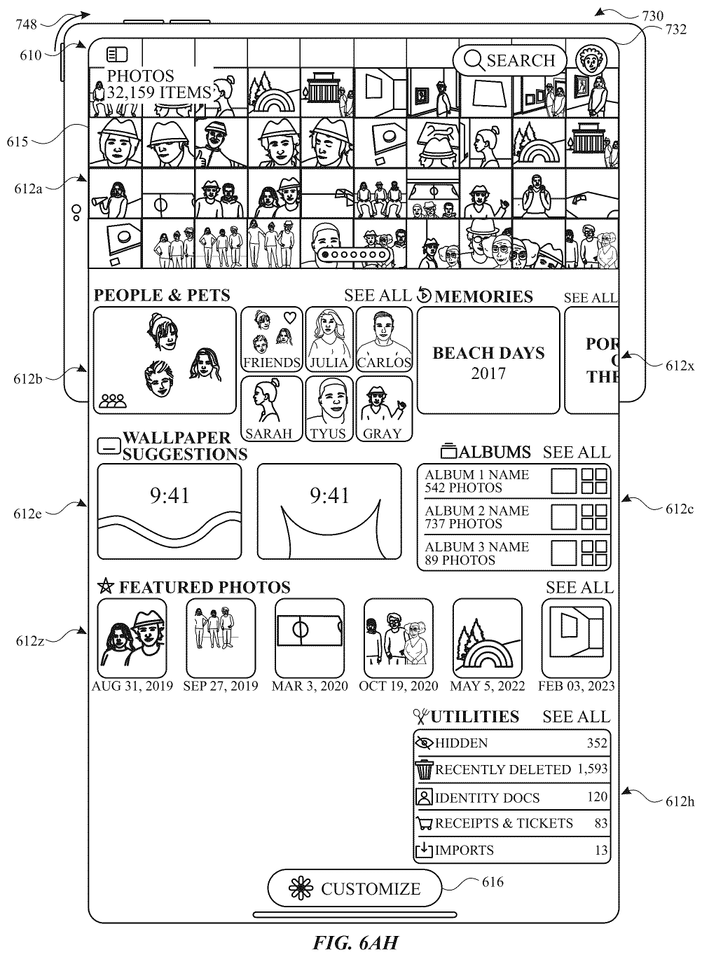

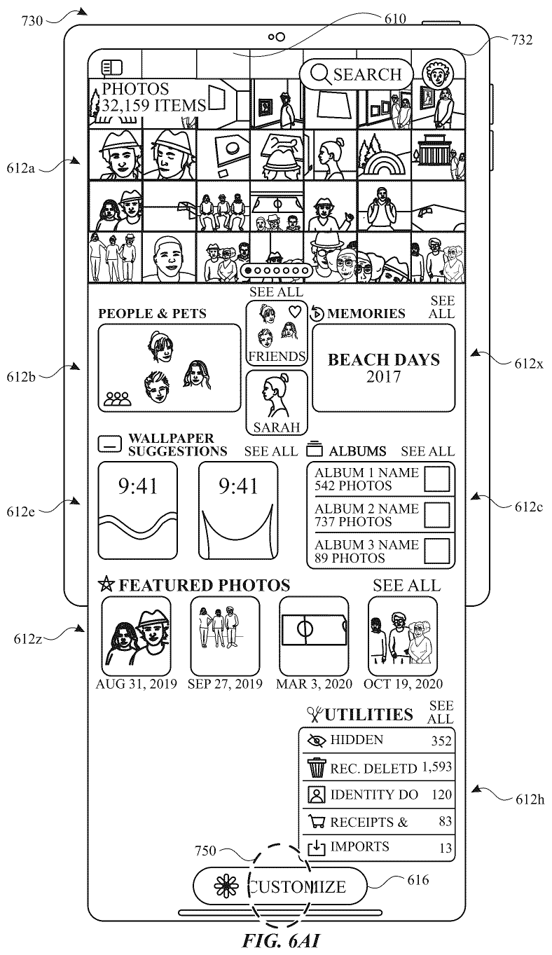

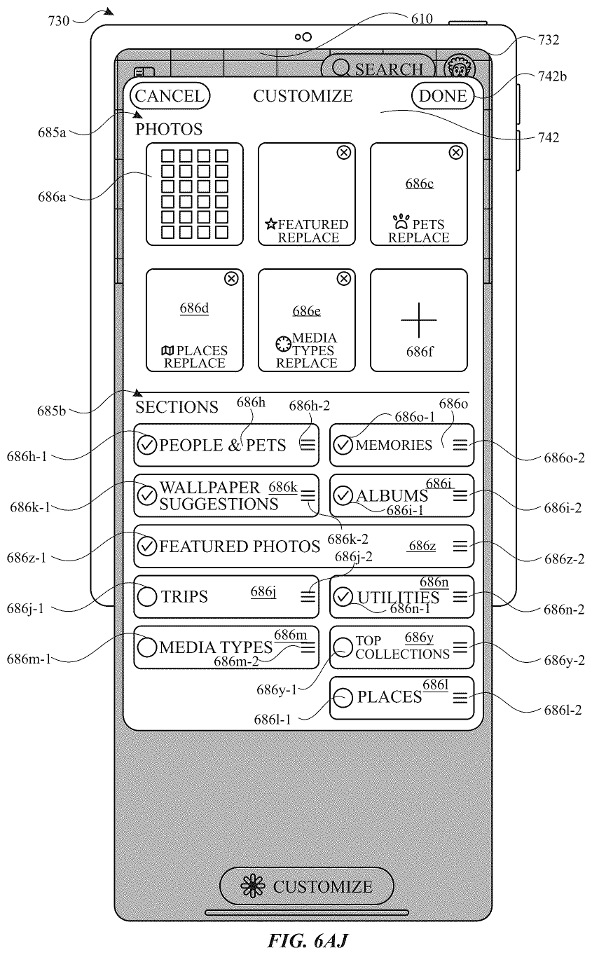

FIGS. 6A-1 and 6A-2 illustrate computer system 600, which is a smart phone with touch-sensitive display 602 and buttons 604a-604c. Although the depicted embodiments show an example in which computer system 600 is a smart phone, in other embodiments, computer system 600 is a different type of computer system (e.g., a tablet, a laptop computer, a desktop computer, a wearable device, and/or a headset). At FIGS. 6A-1 and 6A-2, computer system 600 displays user interface 610. FIG. 6A-1 displays an upper portion of user interface 610 while FIG. 6A-2 displays a lower portion of user interface 610. User interface 610 displays different content items from a media library corresponding to computer system 600 and/or a user of computer system 600 (e.g., a user account logged into computer system 600). User interface 610 includes search option 618, which, when selected (e.g., in response to a computer system detecting a selection input), causes the computer system to display a search user interface for searching media items of the media library. For example, in some embodiments, search option 618, when selected (e.g., in response to a computer system detecting a selection input), causes the computer system to display search user interface 688 (e.g., FIG. 6Z and/or FIG. 9A) or search user interface 902 (e.g., FIG. 9B), which will be described in greater detail below. User interface 610 also includes various regions 612a, 612b, 612c, 612d, 612e, 612f, 612g, 612h, each of which will be described in turn below.

In FIG. 6A-1, region 612a of user interface 610 displays media grid 615 that includes thumbnails of a plurality of different media items of the media library, including thumbnails 615a-615e. As will be described in greater detail below, a user is able to interact with region 612a to scroll through representations of a plurality of different collections of media items. In FIG. 6A-1, indication 614a (which corresponds with media grid 615 and/or is representative of media grid 615) is darkened to indicate that the user is looking at a leftmost collection of the plurality of different collections that are accessible within region 612a. Region 612a also includes indication 619, which provides the user with an indication that additional collections of media items are accessible to the right of media grid 615 (e.g., by swiping left on media grid 615). In some embodiments, computer system 600 automatically scrolls media grid 615 to the left (and, optionally, displays at least a portion of a representation of a first media collection (e.g., 636a in FIG. 6L)) (e.g., after a threshold duration of time without user input and/or when the user initially opens user interface 610) to provide the user with an indication that additional collections of media items are accessible to the right of media grid 615.

In some embodiments, media grid 615 is representative of the media library as a whole (or, in some embodiments, at least a majority of the media library). In some embodiments, a user is able to provide a user input (e.g., user input 620a, to be described in greater detail below), to expand media grid 615 to, optionally, scroll through the entirety of the media library. In some embodiments, in a default display position depicted in FIG. 6A-1, media grid 615 displays a set of the most recently added (e.g., most recently captured) media items in the media library. In some embodiments, media grid 615 is ordered such that more recent media items are displayed lower and to the right, while older media items are displayed higher and to the left. For example, in some embodiments, a bottom-rightmost media item (e.g., thumbnail 615e) is a most recent media item added to the media library, and media items to the left of a respective media item in the same row are older than the respective media item, and rows of media items that are higher than a respective row of media items are older than the respective row of media items. In the depicted embodiments, media grid 615 is displayed as a three-dimensional stack of media items, that includes a top layer (e.g., the 5 by 5 grid of media items shown in FIG. 6A-1), and one or more additional layers 617 positioned behind the top layer.

Region 612b includes representations of a plurality of different media collections pertaining to the category “People & Pets.” In FIG. 6A-1, this includes representation 612b-1 representative of a first media collection (e.g., a media collection that includes photos and/or videos of friends of the user); representation 612b-2 representative of a second media collection (e.g., a media collection that includes photos and/or videos of Julia); representation 612b-3 representative of a third media collection (e.g., a media collection that includes photos and/or videos of Carlos); and representation 612b-4 representative of a fourth media collection. At least some of representations 612b-1, 612b-2, 612b-3, 612b-4, when selected (e.g., in response to a computer system detecting a selection input), cause the computer system to display a user interface associated with the corresponding media collection and/or that displays media items that are contained within the corresponding media collection. For example, representation 612b-2, when selected (e.g., in response to a computer system detecting a selection input), causes the computer system to display photos and/or videos of Julia. In some embodiments, representation 612b-3, when selected (e.g., in response to a computer system detecting a selection input), causes the computer system to display photos and/or videos of Carlos. Region 612b also includes option 612b-5 that, when selected (e.g., in response to a computer system detecting a selection input), causes the computer system to display a set (e.g., a listing and/or a grid) of all media collections that belong to the “People & Pets” category.

In some embodiments, certain media collections are static media collections, and other media collections are dynamic media collections. For example, in FIG. 6A-1, representation 612b-1 corresponds to a dynamic media collection, and is displayed with indication 612b-1a to indicate that representation 612b-1 corresponds to a dynamic media collection. In some embodiments, the contents of dynamic media collections and/or criteria for inclusion in a dynamic media collection are periodically and automatically modified by computer system 600. For example, in some embodiments, at a first time (e.g., a first day and/or a first date), the dynamic media collection represented by representation 612b-1 includes media items featuring and/or depicting a first person and/or a first pet; and at a second time, the dynamic media collection represented by representation 612b-1 includes media items featuring and/or depicting a second person and/or a second pet. In some embodiments, inclusion criteria for inclusion in the dynamic media collection is determined randomly (e.g., the person and/or pet is selected randomly by computer system 600). In some embodiments, inclusion criteria for inclusion in the dynamic media collection is determined based on contextual information pertaining to computer system 600 and/or a user of computer system 600 (e.g., featuring a person and/or a pet that the user recently saw, and/or featuring a person and/or a pet that the user recently traveled with). Representations 612b-2 and 612b-3 are representative of static media collections (e.g., displayed without indication 612b-1a), and, in some embodiments, the contents of those static media collections and/or the criteria for inclusion in those static media collections remains static and is not changed automatically by computer system 600. For example, the static media collection represented by representation 612b-2 includes photos and/or videos that are determined to depict the person Julia, and the criteria for inclusion in this static media collection is not changed by computer system 600.

Region 612c includes representations 612c-1, 612c-2, 612c-3 of different media albums (e.g., different media collections). At least some of representations 612c-1, 612c-2, 612c-3, when selected (e.g., in response to a computer system detecting a selection input), cause the computer system to display a user interface associated with the corresponding media album and/or that displays media items that are contained within the corresponding media album. For example, representation 612c-1, when selected (e.g., in response to a computer system detecting a selection input), causes the computer system to display photos and/or videos within the media album titled “Buster.” In some embodiments, representation 612c-2, when selected (e.g., in response to a computer system detecting a selection input), causes the computer system to display photos and/or videos within the media album titled “The Farm”. In FIG. 6A-1, representation 612c-1, representation 612c-2, and representation 612c-3 includes a title corresponding to the respective media album, a number of media items that are contained within the respective media item, and a representative media item contained within the respective media item. In some embodiments, one or more media albums are created by a user, and media items are placed into a respective media album by the user. In some embodiments, one or more media albums are automatically generated by computer system 600. Region 612c also includes option 612c-4 that, when selected (e.g., in response to a computer system detecting a selection input), causes the computer system to display a set (e.g., a listing and/or a grid) of all media albums that are stored on computer system 600.

Region 612d includes representations of a plurality of different media collections pertaining to the category “Trips.” In FIG. 6A-1, this includes representation 612d-1 representative of a first media collection (e.g., a media collection that includes photos and/or videos of a trip to Maui); and representation 612d-2 representative of a second media collection (e.g., a media collection that includes photos and/or videos of a different trip). A plurality of different representations (e.g., 612d-1, and/or 612d-2), when selected (e.g., in response to computer system 600 detecting a selection input), causes computer system 600 to display a different user interface associated with the corresponding media collection and/or that displays media items that are contained within the corresponding media collection. For example, representation 612d-1, when selected (e.g., in response to a computer system detecting a selection input), causes the computer system to display photos and/or videos from a trip to Maui. Region 612d also includes option 612d-3 that, when selected (e.g., in response to a computer system detecting a selection input), causes the computer system to display a set (e.g., a listing and/or a grid) of all media collections that belong to the “Trips” category.

Region 612e includes representations 612e-1, 612e-2, 612e-3, 612e-4 of different media items (e.g., thumbnails of media items) that have been selected based on wallpaper selection criteria. In the depicted embodiments, representations 612e-1, 612e-2, 612e-3, 612e-4 are displayed as a previews of corresponding lock-screen views of computer system 600 if the respective media item is used as wallpaper. In some embodiments, media items are selected based on wallpaper selection criteria that indicate whether a media item would be suitable for use as a device wallpaper (e.g., the media item includes negative space in a particular region). Region 612e also includes option 612e-5 that, when selected (e.g., in response to a computer system detecting a selection input), causes the computer system to display a set (e.g., a listing and/or a grid) of all media items that meet the wallpaper selection criteria.

Region 612f includes representations of a plurality of different media collections pertaining to the category “Places.” In FIG. 6A-2, this includes representation 612f-1 representative of a first media collection (e.g., a media collection that includes photos and/or videos captured in and/or depicting London); and representation 612f-2 representative of a second media collection (e.g., a media collection that includes photos and/or videos depicting and/or captured in a different geographic location). A plurality of different representations (e.g., 612f-1 and/or 612f-2), when selected (e.g., in response to a computer system detecting a selection input), causes the computer system to display a user interface associated with the corresponding media collection and/or that displays media items that are contained within the corresponding media collection. For example, representation 612f-1, when selected (e.g., in response to a computer system detecting a selection input), causes the computer system to display photos and/or videos that depict and/or that were captured in London. Region 612f also includes option 612f-3 that, when selected (e.g., in response to a computer system detecting a selection input), causes the computer system to display a set (e.g., a listing and/or a grid) of all media collections that belong to the “Places” category.

Region 612g includes options 612g-1, 612g-2, 612g-3, 612g-4, 612g-5 corresponding to different media types. For example, in FIG. 6A-2, option 612g-1 corresponds to videos, option 612g-2 corresponds to live photos (e.g., photos that includes a plurality of frames), option 612g-3 corresponds to selfies (e.g., photos taken with a user-facing camera of computer system 600 and/or a user-facing camera of a different computer system), option 612g-4 corresponds to portrait photos (e.g., photos with a shallow depth of field, photos with less than a threshold level of depth of field, and/or photos with a simulated shallow depth of field), and option 612g-5 corresponds to long exposure photos (e.g., photos in which a shutter is open and/or visual data is captured for greater than a threshold duration of time). A plurality of different options (e.g., 612g-1, 612g-2, 612g-3, 612g-4, and/or 612g-5), when selected (e.g., in response to a computer system detecting a selection input), causes the computer system to display a user interface associated with the corresponding media type and/or that displays representations of media items of the corresponding media type (e.g., without displaying representations of media items that do not belong to the corresponding media type). For example, option 612g-1, when selected (e.g., in response to a computer system detecting a selection input), causes the computer system to display representations (e.g., thumbnails) of videos in the media library (e.g., without displaying representations of non-videos). In some embodiments, option 612g-2, when selected (e.g., in response to a computer system detecting a selection input), causes the computer system to display representations of live photos in the media library. In some embodiments, option 612g-3, when selected (e.g., in response to a computer system detecting a selection input), causes the computer system to display representations of selfies. In some embodiments, option 612g-4, when selected (e.g., in response to a computer system detecting a selection input), causes the computer system to display representations of portrait photos. In some embodiments, option 612g-5, when selected (e.g., in response to a computer system detecting a selection input), causes the computer system to display representations of long-exposure photos. Region 612g also includes option 612g-6 that, when selected (e.g., in response to a computer system detecting a selection input), causes the computer system to display options corresponding to all the different media types of a plurality of different media types recognized by computer system 600.

Region 612h includes options 612h-1, 612h-2, 612h-3, 612h-4, 612h-5, 612h-6, 612h-7, 612h-8, 612h-9 corresponding to different categories of media and/or different media types. In FIG. 6A-2, options 612h-1 through 612h-4 are shown fully, while options 612h-5 through 612h-9 are at least partially off screen. As shown in FIGS. 6A-2 and 6A-3, a user can navigate to options 612h-5 through 612h-9 via user input, such as user input 621a, which is a swipe left input within region 612h. In FIGS. 6A-2 and 6A-3, option 612h-1 corresponds to imported media (e.g., media imported from and/or received from another computer system). In FIGS. 6A-2 and 6A-3, option 612h-2 corresponds to duplicate media (e.g., media that is contained within the media library more than one time). In FIGS. 6A-2 and 6A-3, option 612h-3 corresponds to hidden media (e.g., media in the media library that has been selected by a user and/or computer system 600 to be hidden). In FIGS. 6A-2 and 6A-3, option 612h-4 corresponds to recently deleted media (e.g., media items that were deleted from the media library within the last 7 days, the last 10 days, the last 21 days, or the last 30 days). In FIGS. 6A-2 and 6A-3, option 612h-5 corresponds to identity documents (e.g., media depicting a state ID, a passport, and/or a driver's license). In FIGS. 6A-2 and 6A-3, option 612h-6 corresponds to receipts (e.g., media depicting a receipt). In FIGS. 6A-2 and 6A-3, option 612h-7 corresponds to handwriting media (e.g., media depicting handwriting). In FIGS. 6A-2 and 6A-3, option 612h-8 corresponds to illustrations (e.g., media depicting a drawing). In FIGS. 6A-2 and 6A-3, option 612h-9 corresponds to QR codes (e.g., media depicting a QR code). A plurality of different options (e.g., 612h-1, 612h-2, 612h-3, 612h-4, 612h-5, 612h-6, 612h-7, 612h-8, and/or 612h-9), when selected (e.g., in response to a computer system detecting a selection input), causes the computer system to display a user interface associated with the corresponding media type and/or that displays representations of media items of the corresponding media type (e.g., without displaying representations of media items that do not belong to the corresponding media type) (e.g., user input 621b selecting option 612h-5 causes computer system 600 to display a user interface associated with identity documents and/or display representations of identity document media items). For example, in some embodiments, option 612h-1, when selected (e.g., in response to a computer system detecting a selection input), causes the computer system to display a user interface associated with imported media and/or that displays representations (e.g., thumbnails) of imported media.

In some embodiments, option 612h-2, when selected (e.g., in response to a computer system detecting a selection input), causes the computer system to display a user interface associated with duplicate media and/or that displays representations (e.g., thumbnails) of duplicate media. In some embodiments, option 612h-3, when selected (e.g., in response to a computer system detecting a selection input), causes the computer system to display a user interface associated with hidden media and/or that displays representations (e.g., thumbnails) of hidden media. In some embodiments, option 612h-4, when selected (e.g., in response to a computer system detecting a selection input), causes the computer system to display a user interface associated with recently deleted media and/or that displays representations (e.g., thumbnails) of recently deleted media. In some embodiments, option 612h-5, when selected (e.g., in response to a computer system detecting a selection input) (e.g., user input 621b), causes the computer system to display a user interface associated with identity documents and/or that displays representations (e.g., thumbnails) of identity documents. In some embodiments, option 612h-6, when selected (e.g., in response to a computer system detecting a selection input), causes the computer system to display a user interface associated with receipts and/or that displays representations (e.g., thumbnails) of receipts. In some embodiments, option 612h-7, when selected (e.g., in response to a computer system detecting a selection input), causes the computer system to display a user interface associated with handwriting media and/or that displays representations (e.g., thumbnails) of handwriting media. In some embodiments, option 612h-8, when selected (e.g., in response to a computer system detecting a selection input), causes the computer system to display a user interface associated with illustrations and/or that displays representations (e.g., thumbnails) of illustrations. In some embodiments, option 612h-9, when selected (e.g., in response to a computer system detecting a selection input), causes the computer system to display a user interface associated with QR codes and/or that displays representations (e.g., thumbnails) of QR codes.

User interface 610 also includes customize option 616. In some embodiments, customize option 616, when selected (e.g., in response to a computer system detecting a selection input), causes the computer system to display a user interface for modifying one or more aspects of user interface 610. For example, in some embodiments, customize option 616, when selected (e.g., in response to a computer system detecting a selection input), causes the computer system to display user interface 684 shown in FIG. 6X, which will be described in greater detail below.

FIG. 6A-1 depicts five different scenarios in which computer system 600 receives five different user inputs: user input 620a (e.g., a movement input and/or a swipe down within region 612a), user input 620b (e.g., a movement input and/or a swipe left within region 612b), user input 620c (e.g., a movement input and/or a swipe up within region 612a), user input 620d (e.g., a movement input and/or a swipe left within region 612a), and user input 620e (e.g., a movement input and/or a swipe right within region 612a). Each of these different user inputs and the resulting actions taken by computer system 600 will be described in greater detail below.

At FIG. 6B, in response to user input 620a in FIG. 6A-1 (e.g., a movement input and/or a swipe down within region 612a), computer system 600 ceases display of user interface 610, and expands media grid 615 into expanded media grid user interface 622. Expanded media grid user interface 622 occupies a great amount of display space than media grid 615. Expanded media grid user interface 622 includes thumbnails of a plurality of media items of the media library (e.g., including thumbnails 623a-623h), and displays more media items than media grid 615. Furthermore, in the depicted embodiments, whereas media grid 615 was displayed as a three-dimensional stack, expanded media grid user interface 622 is displayed as a single two-dimensional grid. Expanded media grid user interface 622 includes search option 624a, select option 624b, and close option 624c. Search option 624a, when selected (e.g., in response to a computer system detecting a selection input), causes the computer system to display a search user interface for searching the media library. For example, in some embodiments, search option 624a, when selected (e.g., in response to a computer system detecting a selection input), causes the computer system to display search user interface 688 (e.g., FIG. 6Z and/or FIG. 9A) or search user interface 902 (e.g., FIG. 9B), which will be described in greater detail below (e.g., with reference to FIGS. 6Z, 9A, and/or 9B). Select option 624b, when selected (e.g., in response to a computer system detecting a selection input), causes the computer system to engage a selection mode in which a user can select multiple media items within expanded media grid user interface 622. Close option 624c, when selected (e.g., in response to a computer system detecting a selection input), causes the computer system to cease display of expanded media grid user interface 622 and, optionally, re-display user interface 610.

FIG. 6B depicts three different scenarios in which computer system 600 receives three different user inputs: user input 625a (e.g., a movement input and/or a swipe up, and/or a movement input and/or swipe up in a region proximate a bottom edge of expanded media grid user interface 622), user input 625b (e.g., a movement input and/or a swipe down within expanded media grid user interface 622), and user input 625c (e.g., a selection input and/or a tap input corresponding to selection of close option 624c). In response to user input 625a and/or user input 625c, computer system 600 ceases display of expanded media grid user interface 622 and, in some embodiments, re-displays user interface 610 (e.g., returning to the state shown in FIG. 6A-1).

At FIG. 6C, in response to user input 625b from FIG. 6B, computer system 600 displays downward scrolling of expanded media grid user interface 622 (e.g., movement of expanded media grid user interface 622 downwards to reveal additional media items that were positioned above the media items that were displayed in FIG. 6B). In this way, a user is able to scroll through media items of the media library. At FIG. 6C, computer system 600 detects user input 626, which is a tap input corresponding to selection of thumbnail 623f.

At FIG. 6D, in response to user input 626, computer system 600 ceases display of expanded media grid user interface 622, and displays user interface 628. User interface 628 displays media item 629d, which corresponds to thumbnail 623f. Media item 629d is displayed at a size larger than it was shown in expanded media grid user interface 622 (e.g., as thumbnail 623f). In the depicted embodiments, media item 629d is displayed without displaying any other media items of the media library. User interface 628 includes close option 629a, expand option 629b, and media information 629c. Close option 629a, when selected (e.g., in response to a computer system detecting a selection input), causes the computer system to cease display of user interface 628 and re-display expanded media grid user interface 622 (e.g., returning to the state shown in FIG. 6C). Expand option 629b, when selected (e.g., in response to a computer system detecting a selection input), causes the computer system to display media item 629d in a full-screen mode. In some embodiments, the full-screen mode ceases display of media information 629c and, in some embodiments, darkens a background surrounding media item 629d. Media information 629c includes date, time, and location information indicating the date and time on which media item 629d was captured and the location of capture.

FIG. 6D depicts five different scenarios in which computer system 600 receives five different user inputs: user input 630a (e.g., a selection input and/or a tap input corresponding to selection of close option 629a), user input 630b (e.g., a movement input and/or a swipe left input), user input 630c (e.g., a movement input and/or a swipe right input), user input 630d (e.g., a movement input and/or a swipe down input), and user input 630e (e.g., a movement input and/or a swipe up input). In response to user input 630a, computer system 600 ceases display of user interface 628 and re-displays expanded media grid user interface 622 (e.g., returning to the state shown in FIG. 6C). In response to user input 630b, computer system 600 replaces display of media item 629d with a subsequent media item in the media library (e.g., a media item represented by thumbnail 623h in FIG. 6C). In response to user input 630c, computer system 600 replaces display of media item 629d with a previous media item in the media library (e.g., a media item represented by thumbnail 623g in FIG. 6C). In response to user input 630d, computer system 600 ceases display of user interface 628 and re-displays expanded media grid user interface 622 (e.g., returning to the state shown in FIG. 6C). In response to user input 630e, computer system 600 displays additional media information and/or metadata pertaining to media item 629d, such as focal length information, zoom information, resolution information, and/or file size information.

At FIG. 6E, in response to user input 630a, computer system 600 ceases display of user interface 628 and re-displays expanded media grid user interface 622. At FIG. 6E, expanded media grid user interface 622 has been slightly scrolled up from its previous state in FIG. 6B such that thumbnails in expanded media grid user interface 622 are slightly shifted downwards relative to the state shown in FIG. 6B (e.g., in response to previous user input 625b of FIG. 6B). At FIG. 6E, computer system 600 detects user input 631 (e.g., a selection input and/or a tap input) corresponding to selection of close option 624c.

At FIG. 6F, in response to user input 631, computer system 600 ceases display of expanded media grid user interface 622, and re-displays user interface 610 with media grid 615 displayed within region 612a. However, in FIG. 6F, based on user selection of close option 624c after the user having scrolled to a different portion of the media library within expanded media grid user interface 622, the positions of media items within media grid 615 have also shifted downwards relative to the default arrangement shown in FIG. 6A-1. In some embodiments, when a user selects close option 624c after having navigated to a particular portion of the media library within expanded media grid user interface 622, a corresponding portion of the media library is displayed within media grid 615 (e.g., media grid 615 displays representations of media items that were displayed within expanded media grid user interface 622 when the user selected close option 624c). In some embodiments, after a threshold duration of time, media grid 615 re-displays the default set and/or default arrangement of media items shown in FIG. 6A-1 (e.g., a set of the most recent media items). At FIG. 6F, computer system 600 detects user input 632, (e.g., a selection input and/or a tap input) corresponding to selection of representation 615f within media grid 615.

At FIG. 6G, in response to user input 632, computer system 600 re-displays user interface 628, but user interface 628 displays media item 635 corresponding to selected representation 615f. FIG. 6G depicts five different scenarios in which computer system 600 receives five different user inputs: user input 633a (e.g., a selection input and/or a tap input corresponding to selection of close option 629a), user input 633b (e.g., a movement input and/or a swipe left input), user input 633c (e.g., a movement input and/or a swipe right input), user input 633d (e.g., a movement input and/or a swipe down input), and user input 633e (e.g., a movement input and/or a swipe up input). In response to user input 633a, computer system 600 ceases display of user interface 628 and re-displays user interface 610 (e.g., returning to the state shown in FIG. 6F). In response to user input 633b, computer system 600 replaces display of media item 635 with a subsequent media item in the media library (e.g., a media item represented by representation 615g in FIG. 6F). In response to user input 633c, computer system 600 replaces display of media item 635 with a previous media item in the media library (e.g., a media item represented by representation 615h in FIG. 6F). In response to user input 633d, computer system 600 ceases display of user interface 628 and re-displays user interface 610 (e.g., returning to the state shown in FIG. 6F). In response to user input 633e, computer system 600 displays additional media information and/or metadata pertaining to media item 635, such as focal length information, zoom information, resolution information, and/or file size information.

At FIG. 6H, in response to user input 633a, computer system 600 ceases display of user interface 628, and re-displays user interface 610.

Returning now to the user inputs shown in FIG. 6A-1, at FIG. 6I, in response to user input 620b in FIG. 6A-1 (e.g., a movement input and/or a swipe left within region 612b), computer system 600 displays scrolling of representations 612b-1, 612b-2, 612b-3, and 612b-4 to the left within region 612b, and reveals additional representations 612b-6, 612b-7. In some embodiments, one or more of regions 612a, 612b, 612d, 612e, 612f, 612g, and/or 612h is scrollable with a horizontal (e.g., left or right) user input within the respective region.

Once again returning to the user inputs shown in FIG. 6A-1, at FIG. 6J, in response to user input 620c in FIG. 6A-1 (e.g., a movement input and/or a swipe up within region 612a), computer system 600 displays upward scrolling of user interface 610. At FIG. 6J, computer system 600 detects user input 634 (e.g., a movement input and/or a swipe left input within region 612d). At FIG. 6K, in response to user input 634, computer system 600 displays scrolling of representations 612d-1, 612d-2 to the left, and reveals additional representation 612d-4. In FIG. 6K, it can be seen that representation 612d-2 corresponds to a trip to Alaska, and is representative of a media collection that includes media items captured during a trip to Alaska.

Returning to the user inputs shown in FIG. 6A-1, at FIG. 6L, in response to user input 620d in FIG. 6A-1 (e.g., a movement input and/or a swipe left within region 612a), computer system 600 ceases display of media grid 615 within region 612a of user interface 610, and replaces media grid 615 with animated media collection representation 636a. Furthermore, in response to user input 620d, indication 614a is no longer darkened (indicating that media grid 615 is not displayed within region 612a), and indication 614b is now darkened (e.g., indicating that a first media collection representation positioned to the right of media grid 615 is being presented within region 612a). Regions of user interface 610 below region 612a are not changed or affected by user input 620d.

Animated media collection representation 636a is associated with a first media collection that is entitled “Trip to Sydney” and that includes a plurality of media items captured during a trip to Sydney. Animated media collection representation 636a automatically displays different media items from the first media collection over time (e.g., as a video, slideshow, and/or animation). In FIG. 6L, animated media collection representation 636a depicts a photo of a koala bear, and then in FIG. 6M, animated media collection representation 636a updates to display a different photo that is in the Trip to Sydney media collection.

FIG. 6M depicts five different scenarios in which computer system 600 receives five different user inputs: user input 640a (e.g., a selection input and/or a tap input corresponding to selection of animated media collection representation 636a), user input 640b (e.g., a movement input and/or a swipe right input within region 612a), user input 640c (e.g., a movement input and/or a swipe left input within region 612a), user input 640d (e.g., a movement input and/or a swipe up input within region 612a); and user input 640e (e.g., a movement input and/or a swipe down input within region 612a). In response to user input 640a, computer system 600 ceases display of user interface 610 and displays user interface 642, which will be discussed below with reference to FIG. 6N. In response to user input 640b, computer system 600 replaces display of animated media collection representation 636a in region 612a with media grid 615 (e.g., returning to the state shown in FIG. 6A-1). In response to user input 640c, computer system 600 replaces display of animated media collection representation 636a in region 612a with animated media collection representation 664, which will be described in greater detail below with reference to FIG. 6T. In response to user input 640d, computer system 600 displays upward scrolling of user interface 610. In response to user input 640e, computer system 600 ceases display of user interface 610 and displays user interface 642, which will be discussed below with reference to FIG. 6N.

At FIG. 6N, in response to user input 640a and/or user input 640e of FIG. 6M, computer system 600 ceases display of user interface 610 and displays user interface 642. User interface 642 corresponds to the Trip to Sydney media collection, and includes media collection title information 644a as well as media collection category information 644b. Media collection category information 644b indicates the category of the media collection. For example, in FIG. 6N, the Trip to Sydney media collection is in the “featured” category. Other media collection categories include, for example, people, pets, trips, places, and/or media types. User interface 642 also includes close option 644c that, when selected (e.g., in response to a computer system detecting a selection input), causes the computer system to cease display of user interface 642 and re-display user interface 610 (e.g., returning to the state shown in FIG. 6M).

User interface 642 includes animated media collection representation 646a and media grid portion 646b. In some embodiments, animated media collection representation 646a is the same video and/or animation as animated media collection representation 636a of FIGS. 6L-6M. In some embodiments, animated media collection representation 646a continues to play the content that was being played within animated media collection representation 636a within user interface 610 as user interface 610 ceases to be displayed and user interface 642 is displayed. In some embodiments, animated media collection representation 646a includes additional media items from the Trip to Sydney media collection that were not included in animated media collection representation 636a. In some embodiments, animated media collection representation 646a includes different transitions or different media effects than animated media collection representation 636a. For example, in some embodiments, animated media collection representation 646a includes additional and/or more complex media transitions and/or effects than animated media collection representation 636a. Media grid portion 646b includes thumbnails of media items that are within the Trip to Sydney media collection, including thumbnails 646b-1 through 646b-5.

FIG. 6N depicts six different scenarios in which computer system 600 receives six different user inputs: user input 647a (e.g., a selection input and/or a tap input corresponding to selection of close option 644c), user input 647b (e.g., a movement input and/or a swipe down input within animated media collection representation 646a), user input 647c (e.g., a selection input and/or a tap input within animated media collection representation 646a), user input 647d (e.g., a movement input and/or a swipe up input, and/or a movement input and/or a swipe up input within animated media collection representation 646a); user input 647e (e.g., a selection input and/or a tap input corresponding to selection of thumbnail 646b-2); and user input 647f (e.g., a movement input and/or a swipe down input within media grid portion 646b). In response to user input 647a, computer system 600 ceases display of user interface 642 and re-displays user interface 610 (e.g., returning to the state shown in FIG. 6M). In response to user input 647b, computer system 600 ceases display of user interface 642 and re-displays user interface 610 (e.g., returning to the state shown in FIG. 6M). In response to user input 647c, computer system 600 displays an expanded version of animated media collection representation 646a, as will be described with reference to FIG. 6O. In response to user input 647d, computer system 600 expands media grid region 646b, as will be described in greater detail with reference to FIG. 6P. In response to user input 647e, computer system 600 displays user interface 628 described above, with user interface 628 depicting the media item corresponding to selected thumbnail 646b-2. In response to user input 647f, computer system 600 displays an expanded version of animated media collection representation 646a, as will be described with reference to FIG. 6O.

At FIG. 6O, in response to user input 647c and/or user input 647f of FIG. 6N, computer system 600 displays expanded animated media collection representation 648. Expanded animated media collection representation 648 expands animated media collection representation 646a to a greater size. In some embodiments, expanded animated media collection representation 648 is the same video and/or animation as animated media collection representation 636a and/or animated media collection representation 646a. In some embodiments, expanded animated media collection representation 648 continues to play the content that was being played within animated media collection representation 646a within user interface 642 as user interface 642 ceases to be displayed. In some embodiments, expanded animated media collection representation 648 includes additional media items from the Trip to Sydney media collection that were not included in animated media collection representation 636a and/or animated media collection representation 646a. In some embodiments, expanded animated media collection representation 648 includes different transitions or different media effects than animated media collection representation 636a and/or animated media collection representation 646a. For example, in some embodiments, expanded animated media collection representation 648 includes additional and/or more complex media transitions and/or effects than animated media collection representation 636a and/or animated media collection representation 646a. At FIG. 6O, computer system 600 also displays title information 650a, scrubber 650b, mute option 650c, close option 650d, photos option 650e, movie option 650f, and music option 650g. Mute option 650c, when selected (e.g., in response to a computer system detecting a selection input), causes the computer system to selectively mute or unmute expanded animated media collection representation 648. For example, when expanded animated media collection representation 648 is muted, selection of mute option 650d causes computer system 600 to unmute expanded animated media collection representation 648; and, optionally, when expanded animated media collection representation 648 is not muted, selection of mute option 650d causes computer system 600 to mute expanded animated media collection representation 648. Close option 650d, when selected (e.g., in response to a computer system detecting a selection input), causes the computer system to cease display of expanded animated media collection representation 648 and re-display user interface 642 (e.g., return to the state shown in FIG. 6N). Photos option 650e, when selected (e.g., in response to a computer system detecting a selection input), causes the computer system to display an expanded media grid, as shown in FIG. 6P. Music option 650g, when selected (e.g., in response to a computer system detecting a selection input), causes the computer system to initiate a process for changing one or more music tracks that are applied to and/or that play during playback of expanded animated media collection representation 648.

At FIG. 6P, in response to user input 647d in FIG. 6N, computer system 600 expands media grid region 646b to a greater size, and ceases display of animated media collection representation 646a. In FIG. 6P, expansion of media grid region 646b shifts thumbnails 646b-1 through 646b-5 upwards, and displays additional thumbnails 646b-6 through 646b-13 that are also representative of media items contained within the “TRIP TO SYDNEY” media collection. At FIG. 6P, and, optionally, in response to user input 647d, computer system 600 also displays photos option 650e, movie option 650f, and option 652. Movie option 650f, when selected (e.g., in response to a computer system detecting a selection input), causes the computer system to display expanded animated media collection representation 650f, as shown in FIG. 6P. At FIG. 6P, computer system 600 detects user input 654 (e.g., a selection input and/or a tap input) corresponding to selection of option 652.

At FIG. 6Q, in response to user input 654, computer system 600 displays options 656a-656f. Option 656a corresponds to a first theme filter for filtering the content of the Trip to Sydney media collection based on a first theme. For example, in FIG. 6Q, option 656a, when selected (e.g., in response to a computer system detecting a selection input), causes the computer system to filter the displayed media items to included only media items from the Trip to Sydney media collection that also depict wildlife. Option 656b corresponds to a second theme filter for filtering the content of the Trip to Sydney media collection based on a second theme. For example, in FIG. 6Q, option 656b, when selected (e.g., in response to a computer system detecting a selection input), causes the computer system to filter the displayed media items to include only media items from the Trip to Sydney media collection that also depict the theme of “night life.” Option 656c corresponds to a small collection size, and is currently selected. Option 656d corresponds to a medium collection size, and, when selected (e.g., in response to a computer system detecting a selection input), causes the computer system to increase the number of media items that are included in the Trip to Sydney media collection (e.g., by adding in additional media items from the trip to Sydney that were filtered out based on filtering criteria). Option 656e corresponds to a large collection size, and, when selected (e.g., in response to a computer system detecting a selection input), causes the computer system to even further increase the number of media items that are included in the Trip to Sydney media collection (e.g., by adding in additional media items from the trip to Sydney that were filtered out based on filtering criteria). Option 656f corresponds to a full collection size and, when selected (e.g., in response to a computer system detecting a selection input), causes the computer system to add all media items pertaining to and/or captured during a trip to Sydney to the Trip to Sydney media collection. FIG. 6Q depicts two example scenarios in which computer system 600 detects two different user inputs: user input 658a which is a user input (e.g., a selection input and/or a tap input) corresponding to selection of option 656a, and user input 658b which is a user input (e.g., a selection input and/or a tap input) corresponding to selection of option 656e. In some embodiments, changes to the media collection via selection of one of options 656a-656f also result in corresponding changes to animated media collection representation 636a, animated media collection representation 646a, and/or expanded animated media collection representation 648 (e.g., removing and/or adding media items from these animated representations).

At FIG. 6R, in response to user input 658b, computer system 600 adds additional media items to the Trip to Sydney media collection, as indicated by the addition of thumbnail 660 in media grid region 646b. Additionally, option 652 is visually modified to indicate that the user has selected the “large” size option for the media collection.

At FIG. 6S, in response to user input 658a of FIG. 6Q, computer system 600 filters the media items of the Trip to Sydney media collection to only those that are determined to depict wildlife. Media grid region 646b is updated such that title information 644a reflects the selected theme, and the displayed thumbnails remove previously-included thumbnails that did not depict wildlife, while maintaining previously-included thumbnails 646b-1 and 646b-3 based on their depiction of wildlife. New thumbnails 662-1 through 662-13 are now visible within media grid region 646b based on the removal of thumbnails that did not depict wildlife. Additionally, option 652 is visually modified to indicate that the user has applied a theme selection to the media collection.

Returning now to the user inputs shown in FIG. 6M, at FIG. 6T, in response to user input 640c in FIG. 6M (e.g., a movement input and/or a swipe left within region 612a), computer system 600 replaces display of animated media collection representation 636a with animated media collection representation 664 within region 612a of user interface 610. Animated media collection representation 636a was representative of a Trip to Sydney media collection, and animated media collection representation 664 is representative of a different “Timelapses” media collection that includes timelapse videos, as indicated by title information 666a. The “Timelapses” media collection is a “media type” collection, as indicated by collection type information 666b. In response to user input 640c, indication 614b (representative of the Trip to Sydney media collection) is no longer darkened, and indication 614c, representative of the Timelapses media collection, is now darkened. As previously discussed above with reference to animated media collection representation 636a, animated media collection representation 664 displays different media items within the Timelapses media collection over time.

FIG. 6T depicts five different scenarios in which computer system 600 receives five different user inputs: user input 668a (e.g., a movement input and/or a swipe right user input within region 612a), user input 668b (e.g., a movement input and/or a swipe up input within region 612a), user input 668c (e.g., a movement input and/or a swipe down input within region 612a), user input 668d (e.g., a selection input and/or a tap input within region 612a); and user input 668e (e.g., a movement input and/or a swipe left input within region 612a). In response to user input 668a, computer system 600 replaces display of animated media collection representation 664 with animated media collection representation 636a within region 612a (e.g., returning to the state shown in FIG. 6M). In response to user input 668b, computer system 600 displays upward scrolling of user interface 610. In response to user input 668c, computer system 600 ceases display of user interface 610, and displays a user interface that corresponds to the Timelapses media collection (e.g., user interface 642, but with content that corresponds to the Timelapses media collection rather than the Trip to Sydney media collection). In response to user input 668d, computer system 600 ceases display of user interface 610, and displays a user interface that corresponds to the Timelapses media collection (e.g., user interface 642, but with content that corresponds to the Timelapses media collection rather than the Trip to Sydney media collection). In response to user input 668e, computer system 600 replaces display of animated media collection representation 664, representative of the Timelapses media collection, with animated media collection representation 670 (e.g., FIG. 6U) that corresponds to a different media collection.

At FIG. 6U, in response to user input 668e, computer system 600 replaces display of animated media collection 664, representative of the Timelapses media collection, with animated media collection representation 670, which is representative of a “Paris” media collection, as indicated by title information 672a. Collection category information 672b indicates that the Paris media collection is a “Places”-type media collection. In response to user input 668e, indication 614c (representative of the Timelapses media collection) is no longer darkened, and indication 614d, representative of the Paris media collection, is now darkened. As previously discussed above with reference to animated media collection representation 636a, animated media collection representation 670 displays different media items within the Paris media collection over time.

FIG. 6U depicts five different scenarios in which computer system 600 receives five different user inputs: user input 674a (e.g., a movement input and/or a swipe right user input within region 612a), user input 674b (e.g., a movement input and/or a swipe up input within region 612a), user input 674c (e.g., a movement input and/or a swipe down input within region 612a), user input 674d (e.g., a selection input and/or a tap input within region 612a); and user input 674e (e.g., a movement input and/or a swipe left input within region 612a). In response to user input 674a, computer system 600 replaces display of animated media collection representation 670 with animated media collection representation 664 within region 612a (e.g., returning to the state shown in FIG. 6T). In response to user input 674b, computer system 600 displays upward scrolling of user interface 610. In response to user input 674c, computer system 600 ceases display of user interface 610, and displays a user interface that corresponds to the Paris media collection (e.g., user interface 642, but with content that corresponds to the Paris media collection rather than the Trip to Sydney media collection). In response to user input 674d, computer system 600 ceases display of user interface 610, and displays a user interface that corresponds to the Paris media collection (e.g., user interface 642, but with content that corresponds to the Paris media collection rather than the Trip to Sydney media collection). In response to user input 674e, computer system 600 replaces display of animated media collection representation 670, representative of the Paris media collection, with animated media collection representation 676 (e.g., FIG. 6V) that corresponds to a different media collection.

At FIG. 6V, in response to user input 674e, computer system 600 replaces display of animated media collection 670, representative of the Paris media collection, with animated media collection representation 676, which is representative of a “Muffin+Buster” media collection, as indicated by title information 678a. Collection category information 678b indicates that the Muffin+Buster media collection is a “Pets”-type media collection. In response to user input 674e, indication 614d (representative of the Paris media collection) is no longer darkened, and indication 614e, representative of the Muffin+Buster media collection, is now darkened. As previously discussed above with reference to animated media collection representation 636a, animated media collection representation 676 displays different media items within the Muffin+Buster media collection over time.

FIG. 6V depicts five different scenarios in which computer system 600 receives five different user inputs: user input 680a (e.g., a movement input and/or a swipe right user input within region 612a), user input 680b (e.g., a movement input and/or a swipe up input within region 612a), user input 680c (e.g., a movement input and/or a swipe down input within region 612a), user input 680d (e.g., a selection input and/or a tap input within region 612a); and user input 680e (e.g., a movement input and/or a swipe left input within region 612a). In response to user input 680a, computer system 600 replaces display of animated media collection representation 676 with animated media collection representation 670 within region 612a (e.g., returning to the state shown in FIG. 6U). In response to user input 680b, computer system 600 displays upward scrolling of user interface 610. In response to user input 680c, computer system 600 ceases display of user interface 610, and displays a user interface that corresponds to the Muffin+Buster media collection (e.g., user interface 642, but with content that corresponds to the Muffin+Buster media collection rather than the Trip to Sydney media collection). In response to user input 680d, computer system 600 ceases display of user interface 610, and displays a user interface that corresponds to the Muffin+Buster media collection (e.g., user interface 642, but with content that corresponds to the Muffin+Buster media collection rather than the Trip to Sydney media collection). In response to user input 680e, computer system 600 ceases display of animated media collection representation 676 within region 612a. In the example embodiments shown in the figures, the Muffin+Buster media collection is the final media collection that is accessible within region 612a of user interface 610.

At FIG. 6W, in response to user input 680e, computer system 600 ceases display of animated media collection representation 676 within region 612a, and displays customize option 682 within region 612a. Additionally, in response to user input 680e, indication 614e (representative of the Muffin+Buster media collection) is no longer darkened, and indication 614f, which is a rightmost indication of indications 614a-614f, is now darkened. At FIG. 6W, computer system 600 detects user input 683 (e.g., a selection input and/or a tap input) corresponding to selection of customize option 682.

At FIG. 6X, in response to user input 683, computer system 600 ceases display of user interface 610, and displays customization user interface 684. Customization user interface 684 includes one or more options that, when selected (e.g., in response to a computer system detecting a selection input), causes the computer system to modify the appearance and/or display of user interface 610. In FIG. 6X, customization user interface 684 includes representations 686a-686e, as well as add option 686f. Representations 686a-686e are indicative of the number, order, and types of media collections that are represented with region 612a of user interface 610. For example, in FIG. 6X, representation 686a is representative of media grid 615.

Representation 686b is representative of a featured-type media collection; representation 686c is representative of a media types-type media collection; representation 686d is representative of a places-type media collection; and representation 686e is representative of a pets-type media collection. Representations 686a-686e in FIG. 6X indicate that region 612a will include media grid 615, followed by a featured-type media collection, followed by a media types-type media collection, followed by a places-type media collection, followed by a pets-type media collection. This is what was also depicted in FIGS. 6A-1-6V as, within region 612a, media grid 615 was followed by the Trip to Sydney media collection (e.g., a featured-type media collection for a specific place), which was followed by the Timelapses media collection (which was a media types-type media collection for a specific type of media), which was followed by the Paris media collection (which was a places-type media collection for a specific place), which was followed by the Muffin+Buster media collection (which was a pets-type media collection for a specific group of pets). A user is able to re-arrange at least some of representations 686a-686e (e.g., via a movement input and/or a drag input) to change the order in which media collections are presented within region 612a. A user is also able to remove certain media collection-types (e.g., via options 686b-1, 686c-1, 686d-1, and/or 686e-1). A user is also able to add different media collection and/or media collection types (e.g., via option 686f). A user is also able to replace a particular media collection type with a different media collection type (e.g., via options 686b-2, 686c-2, 686d-2, and/or 686e-2). In some embodiments, representation 686a cannot be moved and cannot be removed, such that media grid 615 will always occupy the first position within region 612a.

As discussed above, representations 686b-686e, respectively, correspond to a different media collection types, rather than any particular media collection. In some embodiments, while media collection types will maintain the same order and position within region 612a over time (e.g., unless a user changes the order and/or position of media collection types via user interface 684), the actual media collections that are presented within a media collection type in region 612a changes periodically. For example, in FIG. 6X, media grid 615 (represented by representation 686a) is followed by a featured media collection, which is followed by a media types media collection, which is followed by a places media collection, which is followed by a pets media collection, and this order will remain consistent within region 612a without user input. However, the featured media collection can change from a first featured media collection to a different featured media collection from one day to another; and the media types media collection can change from a first media types media collection to a different media types media collection from one day to the next; and so forth. FIGS. 6Y-1 and 6Y-2 provide example depictions of these features. The top row of FIG. 6Y-1 represents a first time, in which a first featured media collection (e.g., Trip to Sydney) is followed by a first media types media collection (e.g., Timelapses), which is followed by a first places media collection (e.g., Paris), which is followed by a first pets media collection (e.g., Muffin+Buster). The second row of FIG. 6Y-1 represents a second time, in which the order of media collection types stays the same, but the actual media collections change. At the second time, a second feature media collection (e.g., Holidays in Chicago) is followed by a second media types media collection (e.g., Selfies), which is followed by a second places media collection (e.g., London), which is followed by a second pets media collection (e.g., Baxter with Morty). FIG. 6Y-2 represents a third time, in which the order of media collection types continues to stay the same, but the actual media collections once again change. At the third time, a third feature media collection (e.g., Summer Vacation) is followed by a third media types media collection (e.g., Portraits), which is followed by a third places media collection (e.g., Chicago), which is followed by a third pets media collection (e.g., Spike and Henry). In this way, region 612a in user interface 610 maintains some consistency (e.g., by keeping the same types of media collections arranged in the same order), but presents the user with different sets of content over time (e.g., by changing the actual media collections that are presented within each media collection type).

Returning now to the user inputs shown in FIG. 6A-1, at FIG. 6Z, in response to user input 620e in FIG. 6A-1 (e.g., a movement input and/or a swipe right within region 612a), computer system 600 displays search user interface 610 within region 612a. Search user interface 688 will be described in greater detail below with reference to FIG. 9A. FIG. 6Z depicts four different scenarios in which computer system 600 detects four different user inputs: user input 694a (e.g., a movement input and/or a swipe down input within region 612a), user input 694b (e.g., a movement input and/or a swipe left input within region 612a), user input 694c (e.g., a movement input and/or a swipe up input within region 612a), and user input 694d (e.g., a selectin input and/or a tap input within region 612a and/or a tap input corresponding to selection of a search field). In response to user input 694a, computer system 600 ceases display of user interface 610 and enlarges search user interface 688, as will be described in greater detail below with reference to FIGS. 9A-9B. In response to user input 694b, computer system 600 replaces display of search user interface 688 with media grid 615 (e.g., returning to the state shown in FIG. 6A-1). In response to user input 694c, computer system 600 displays upward scrolling of user interface 610. In response to user input 694d, computer system 600 ceases display of user interface 610 and enlarges search user interface 688, as will be described in greater detail below with reference to FIGS. 9A-9B.

At FIG. 6AA-1 and FIG. 6AA-2, computer system 600 displays user interface 610, various features of which were described above. As described above, user interface 6AA-2 includes customize option 616 that, when selected, causes computer system 600 to display customization user interface 684. At FIG. 6AA-2, while displaying user interface 610 and customize option 616, computer system 600 detects user input 720 (e.g., a selection input and/or a tap input) corresponding to selection of customize option 616.

At FIG. 6AB, in response to user input 720, computer system 600 displays customize user interface 684. Various features of customize user interface 684 were described above, including representations 686a-686e and option 686f. As described above, representations 686a-686e are representative of media collections that are displayed within region 612a of user interface 610. FIG. 6AB depicts an embodiment of customize user interface 684 in which, in addition to displaying representations 686a-686e and option 686f shown within region 685a (e.g., a region that corresponds to region 612a in user interface 610), customize user interface also includes region 685b that corresponds to one or more sections (e.g., sections 612b-612h) that are displayed underneath region 612a in user interface 610. In FIG. 6AB, region 685b includes sections 686h-686o. Section 686h corresponds to a “People & Pets” section (e.g., section 612b in user interface 610), and includes display option 686h-1 and position option 686h-2. Display option 686h-1 is selectable by a user to selectively enable or disable corresponding section 612b in user interface 610. When display option 686h-1 is in an enabled state (as it is shown in FIG. 6AB), corresponding section 612b is displayed within user interface 610, and when display option 686h-1 is in a disabled state, corresponding section 612b is not displayed within user interface 610. In FIG. 6AB, display option 686h-1 is shown with a check mark to indicate that it is in the enabled state, and corresponding section 612b will be displayed within user interface 610. Position option 686h-2 is selectable by a user to move section 686h within region 685b (e.g., via drag input), which causes corresponding movement of corresponding section 612 within user interface 610, as will be demonstrated and explained in the next figures. Similarly, section 686i corresponds to an “Albums” section (e.g., section 612c in user interface 610), and includes display option 686i-1 for selectively enabling or disabling section 686i and/or corresponding section 612c, and position option 686l-2 for selectively moving section 686i and/or corresponding section 612c. Section 686j corresponds to a “Trips” section (e.g., section 612d in user interface 610), and includes display option 686j-1 for selectively enabling or disabling section 686j and/or corresponding section 612d, and position option 686j-2 for selectively moving section 686j and/or corresponding section 612d. Section 686k corresponds to a “Wallpaper Suggestions” section (e.g., section 612e in user interface 610), and includes display option 686k-1 for selectively enabling or disabling section 686k and/or corresponding section 612e, and position option 686k-2 for selectively moving section 686k and/or corresponding section 612e. Section 686l corresponds to a “Places” section (e.g., section 612f in user interface 610), and includes display option 686l-1 for selectively enabling or disabling section 686l and/or corresponding section 612f, and position option 686l-2 for selectively moving section 686l and/or corresponding section 612f. Section 686m corresponds to a “Media Types” section (e.g., section 612g in user interface 610), and includes display option 686m-1 for selectively enabling or disabling section 686m and/or corresponding section 612g, and position option 686m-2 for selectively moving section 686m and/or corresponding section 612g. Section 686n corresponds to a “Utilities” section (e.g., section 612h in user interface 610), and includes display option 686n-1 for selectively enabling or disabling section 686n and/or corresponding section 612h, and position option 686n-2 for selectively moving section 686n and/or corresponding section 612h. Section 686o corresponds to a “Memories” section, and includes display option 686o-1 for selectively enabling or disabling section 686o and/or a corresponding section within user interface 610, and position option 686o-2 for selectively moving section 686o and/or a corresponding section in user interface 610. In FIG. 6AB, display option 686o-1 is in a disabled state (e.g., as indicated by the absence of a check mark). Accordingly, a “Memories” section corresponding to section 686o is not displayed within user interface 610 in FIGS. 6AA-1 and 6AA-2. At FIG. 6AB, computer system 600 detects user input 722a (e.g., a tap input corresponding to option 686j-1) and user input 722b (e.g., a drag input corresponding to option 686k-2).

At FIG. 6AC, in response to user input 722a, computer system 600 displays option 686j-1 transition from an enabled state to a disabled state (e.g., by removing the check mark shown in option 686j-1). Option 686j-1 being in the disabled state indicates that corresponding section 612d will no longer be displayed within user interface 610. Furthermore, in response to user input 722b, computer system 600 displays section 686k move from a position above section 686l to a position below section 686k. Movement of section 686k indicates that corresponding section 612e (e.g., “Wallpaper Suggestions”) will be displayed at a lower position within user interface 610 (and, for example, “Places” section 612f, which was previously displayed below “Wallpaper Suggestions” section 612e, will now be displayed above section 612e within user interface 610). At FIG. 6AC, computer system 600 detects user input 724 (e.g., a tap input and/or a selection input corresponding to selection of option 686g).

At FIGS. 6AD-1-6AD-2, in response to user input 724, computer system 600 re-displays user interface 610. In FIGS. 6AD-1-6AD-2, based on previous user input 722a disabling “Trips” section 612d, “Trips” section 612d is no longer displayed within region 610. Furthermore, based on previous user input 722b moving “Wallpaper Suggestions” section 612e, “Wallpaper Suggestions” section 612e is now displayed at a new position within user interface 610 below “Places” section 612f.

FIG. 6AE depicts computer system 730, which is a tablet device that includes touch-sensitive display 732. Although the depicted embodiments show an example in which computer system 730 is a tablet, in other embodiments, computer system 730 is a different type of computer system (e.g., a smart phone, a laptop computer, a desktop computer, a wearable device, and/or a headset). At FIG. 6AE, computer system 730 displays user interface 610, various features of which have been described above. However, in FIG. 6AE, based on computer system 730 having a different size and/or a different aspect ratio than computer system 600, user interface 610 is displayed with one or more differences than when it was displayed on computer system 600. For example, in FIG. 6AE, the portion of user interface 610 that is displayed underneath region 612a is displayed having two columns rather than a single column. A left column includes section 612b (e.g., a “People & Pets” section), section 612x (e.g., a “Memories” section), and section 612e (e.g., a “Wallpaper Suggestion” section); while a right column includes section 612c (e.g., an “Albums” section), section 612y (e.g., a “Top Collections” section), and section 612h (e.g., a “Utilities” section). Section 612z (e.g., a “Featured Photos” section) spans both the left column and the right column (e.g., spans the entire width of user interface 610). In some embodiments, sections displayed within the left column of user interface 610 are displayed at a first width (e.g., a ⅔ width); while sections displayed within the right column of user interface 610 are displayed at a second width (e.g., a ⅓ width) that is narrower than the left column. In some embodiments, the width of a section can be changed by moving the section from the left column to the right column or from the right column to the left column (e.g., via customize user interface 684, as will be described in greater detail below). In some embodiments, section 612z is a featured section that spans both the left column and the right column, and has a fixed width that spans both columns (e.g., in some embodiments, the width of section 612z cannot be changed by a user). At FIG. 6AE, computer system 730 detects user input 740 (e.g., a tap input and/or a selection input corresponding to selection of customize option 616).

At FIG. 6AF, in response to user input 740, computer system 730 displays customize user interface 684, various features of which were described above. Customize user interface 684 includes various sections 686h, 686i, 686j, 686k, 686l, 686m, 686n, 686o, 686y, 686z that are representative of sections within user interface 610. For example, section 686h is representative of a “People and Pets” section in user interface 610 (e.g., section 612b), and includes display option 686h-1 that is selectable to selectively enable or disable the corresponding section within user interface 610, and position option 686h-2 that is selectable to move the corresponding section within user interface 610. Section 686i is representative of an “Albums” section in user interface 610 (e.g., section 612c), and includes display option 686l-1 that is selectable to selectively enable or disable the corresponding section within user interface 610, and position option 686i-2 that is selectable to move the corresponding section within user interface 610. Section 686o is representative of a “Memories” section in user interface 610 (e.g., section 612x), and includes display option 686o-1 that is selectable to selectively enable or disable the corresponding section within user interface 610, and position option 686o-2 that is selectable to move the corresponding section within user interface 610. Section 686y is representative of a “Top Collections” section in user interface 610 (e.g., section 612y), and includes display option 686y-1 that is selectable to selectively enable or disable the corresponding section within user interface 610, and position option 686y-2 that is selectable to move the corresponding section within user interface 610. Section 686z is representative of a “Feature Photos” section in user interface 610 (e.g., section 612z), and includes display option 686z-1 that is selectable to selectively enable or disable the corresponding section within user interface 610, and position option 686z-2 that is selectable to move the corresponding section within user interface 610. Section 686k is representative of a “Wallpaper Suggestions” section in user interface 610 (e.g., section 612e), and includes display option 686k-1 that is selectable to selectively enable or disable the corresponding section within user interface 610, and position option 686k-2 that is selectable to move the corresponding section within user interface 610. Section 686n is representative of a “Utilities” section in user interface 610 (e.g., section 612h), and includes display option 686h-1 that is selectable to selectively enable or disable the corresponding section within user interface 610, and position option 686h-2 that is selectable to move the corresponding section within user interface 610. Section 686j is representative of a “Trips” section in user interface 610 (e.g., not shown in FIG. 6AE based on the “Trips” section being disabled), and includes display option 686j-1 that is selectable to selectively enable or disable the corresponding section within user interface 610, and position option 686j-2 that is selectable to move the corresponding section within user interface 610. Section 686l is representative of a “Places” section in user interface 610 (e.g., not shown in FIG. 6AE based on the “Places” section being disabled), and includes display option 686l-1 that is selectable to selectively enable or disable the corresponding section within user interface 610, and position option 686l-2 that is selectable to move the corresponding section within user interface 610. Section 686j is representative of a “Media Types” section in user interface 610 (e.g., not shown in FIG. 6AE based on the “Media Types” section being disabled), and includes display option 686j-1 that is selectable to selectively enable or disable the corresponding section within user interface 610, and position option 686j-2 that is selectable to move the corresponding section within user interface 610.

In FIG. 6AF, based on computer system 730 displaying content at a different size and/or a different aspect ratio, customize user interface 684 is displayed with some differences than when it was displayed, for example, in FIG. 6AB and FIG. 6AC above. For example, section 685b includes two columns: a left column and a right column. Furthermore, sections that are displayed in the left column are displayed with a first width (e.g., a ⅔ width) while sections that are displayed in the right column are displayed with a second width (e.g., a ⅓ width) that is narrower than the sections in the left column. In FIG. 6AF, sections 686h, 686o, 686k, 686j, and 686m are displayed in the left column having the larger width; sections 686i, 686y, 686n, and 686l are displayed in the right column having the narrower width; and section 686z is displayed spanning both columns. At FIG. 6AF, computer system 730 detects user input 741a (e.g., a drag input corresponding to a user request to move position option 686o-2 and/or more section 686o) and user input 741b (e.g., a tap input and/or a selection input corresponding to selection of display option 686y-1).

At FIG. 6AG, in response to user input 741a, computer system 730 displays section 686o moved from the second row of the left column to the first row of the right column, which also causes section 686o to be displayed at a smaller width than when it was in the left column. Additionally, based on movement of section 686o, sections 686k, 686j, and 686m are moved upwards in the left column and sections 686i, 686n, 686y, and 686l are moved downwards in the right column. Additionally, in response to user input 741b, computer system 730 now displays display option 686y-1 in the disabled state (e.g., without a checkmark), indicating that Top Collections section 612y (which is represented by section 686y) will no longer be displayed within user interface 610. Furthermore, based on section 686y no longer being in the enabled state, section 686y is moved below all of the enabled sections in the right column. At FIG. 6AG, computer system 730 detects user input 746 (e.g., a tap input and/or a section input corresponding to selection of option 686g).

At FIG. 6AH, in response to user input 746, computer system 730 ceases display of customize user interface 684 and re-displays user interface 610. In FIG. 6AH, user interface 610 is displayed with one or more changes based on and/or in response to user inputs 741a and 741b. For example, in FIG. 6AH, section 612y (e.g., the “Top Collections” section) is no longer displayed based on user input 641b. Furthermore, in FIG. 6AH, section 612x is displayed at the top of the right column based on user input 641a, and section 612x is displayed with a narrower width based on movement of section 612x from the left column to the right column. Sections 612e and 612c are also displayed at different positions within user interface 610 based on user inputs 641a and 641b, with section 612c being moved to the second row of the right column (e.g., based on movement of section 612x to the top row of the right column), and section 612e moving upwards in the left column to fill the space previously occupied by section 612x. At FIG. 6AH, computer system 730 detects user input 748 rotating computer system 730 from a landscape orientation to a portrait orientation.

At FIG. 6AI, in response to user input 748 (e.g., in response to a change in orientation of computer system 730), computer system 730 modifies user interface 684 by modifying the size of one or more portions of user interface 684. For example, in FIG. 6AI, the left column and the right column of user interface 610 are narrowed to accommodate the narrower aspect ratio. It can be seen that sections 612b, 612c, 612e, 612z, and 612h now display less content than they did in FIG. 6AH in the landscape orientation. However, relative positions of sections relative to one another are maintained. Furthermore, in FIG. 6AI, “Wallpaper Suggestions” section 612e displays wallpaper suggestions having a portrait orientation aspect ratio that matches the current orientation of computer system 730, whereas in FIG. 6AH, “Wallpaper Suggestions” section 612 displayed wallpaper suggestions having a landscape orientation aspect ratio that matched the orientation of computer system 730 in FIG. 6AH. At FIG. 6AI, computer system 730 detects user input 750 (e.g., a tap input and/or a selection input corresponding to selection of customize option 616).

At FIG. 6AJ, in response to user input 750, computer system 730 re-displays customize user interface 684. Based on the change in orientation of computer system 730 and/or based on the current orientation of computer system 730, customize user interface 684 is displayed differently than it was in FIG. 6AG. For example, the left column of region 685b is displayed having a narrower width than it did in FIG. 6AG when computer system 730 was in the landscape orientation, and the right column of region 685b is also displayed having a narrower width than it did in FIG. 6AG when computer system 730 was in the landscape orientation. However, the right column of region 685b is still displayed with a narrower width than the left column of region 685b, even when computer system 730 is in the portrait orientation.

FIG. 7 is a flow diagram illustrating a method for navigating, displaying, and/or presenting content using a computer system in accordance with some embodiments. Method 700 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., a display, a touch-sensitive display, and/or a display controller) (e.g., 602) and one or more input devices (e.g., a touch-sensitive surface, a touch-sensitive display, a button, a rotatable input mechanism, a depressible and rotatable input mechanism, a camera, an accelerometer, and/or an inertial measurement unit (IMU)) (e.g., 602, and/or 604a-604c). Some operations in method 700 are, optionally, combined, the orders of some operations are, optionally, changed, and some operations are, optionally, omitted.

As described below, method 700 provides an intuitive way for navigating, displaying, and/or presenting content. The method reduces the cognitive burden on a user for navigating and/or accessing content, thereby creating a more efficient human-machine interface. For battery-operated computing devices, enabling a user to navigate and/or access content faster and more efficiently conserves power and increases the time between battery charges.

The computer system (e.g., 600) displays (702), via the one or more display generation components (e.g., 602), a representation of a media library (e.g., 615) (e.g., a media library associated with the computer system; a media library associated with a user (e.g., a user of the computer system); and/or a media library associated with a user account), wherein the media library includes a plurality of media items (e.g., images, photos, and/or videos) including a first media item and a second media item different from the first media item. In some embodiments, the representation of the media library includes representations (e.g., previews, thumbnails, snapshots, and/or frames) of one or more media items (e.g., a first subset and/or a first plurality) of the plurality of media items in the media library. While displaying the representation of the media library (704), the computer system detects (706), via the one or more input devices (e.g., 602), a first user input (e.g., 620a, 620b, 620c, 620d, and/or 620e) (e.g., a touch input, a touchscreen input, a swipe input, a gesture, an air gesture, and/or a mechanical input (e.g., via one or more physical buttons and/or physically rotatable input mechanisms)). In response to detecting the first user input (708): in accordance with a determination that the first user input includes movement (and, optionally, more than a threshold amount of movement) in a first direction (710) (e.g., in some embodiments, in accordance with a determination that the first user input is a swipe input and/or a gesture with movement in the first direction) (in some embodiments, without including movement in the second direction), the computer system updates (712), via the one or more display generation components, an appearance of the representation of the media library, including navigating through (e.g., scrolling through) representations (e.g., previews, thumbnails, snapshots, and/or frames) of a first plurality of the plurality of media items of the media library in a first scroll direction (e.g., in FIG. 6A-1 and FIG. 6B, in response to user input 620a in a downward direction, computer system 600 displays media grid 615 move downward and expand into expanded grid user interface 622). In some embodiments, updating the appearance of the representation of the media library includes displaying scrolling of a first representation (e.g., 615a, 615b, 615c, 615d, and/or 615e) (e.g., a preview, a thumbnail, a snapshot, and/or a frame) representative of the first media item in the first scroll direction; and displaying scrolling of a second representation (e.g., 615a, 615b, 615c, 615d, and/or 615e) (e.g., a preview, a thumbnail, a snapshot, and/or a frame) representative of the second media item in the first scroll direction. In some embodiments, the first scroll direction corresponds to the first direction (e.g., representation 615a, 615b, 615c, 615d, and/or 615e move downwards in response to downward swipe user input 620a). In some embodiments, the first scroll direction is the same as the first direction. In some embodiments, the first scroll direction is different from the first direction (e.g., opposite the first direction). In some embodiments, the first representation representative of the first media item is displayed prior to detecting the first user input (e.g., as part of the representation of the media library) (e.g., 615a, 615b, 615c, 615d, and/or 615e in FIG. 6A-1); and the second representation representative of the second media item is not displayed prior to detecting the first user input (e.g., is not displayed as part of the representation of the media library; and/or is displayed in response to detecting the first user input) (e.g., additional thumbnails in user interface 622 that are not shown in media grid 615). In some embodiments, updating the appearance of the representation of the media library, including navigating through representations of the first plurality of the plurality of media items of the media items of the media library in the first scroll direction, is performed in accordance with a determination that the first user input includes more than a threshold amount of movement in the first direction. In some embodiments, in accordance with a determination that the first user input does not include more than the threshold amount of movement in the first direction, the computer system forgoes updating the appearance of the representation of the media library and/or forgoes navigating through representations of the first plurality of the plurality of media items of the media library in the first scroll direction.

In response to detecting the first user input (708): in accordance with a determination that the first user input includes movement (and, optionally, more than a threshold amount of movement) in a second direction different from the first direction (714) (e.g., user input 620d in a leftward direction) (e.g., in some embodiments, in accordance with a determination that the first user input is a swipe input and/or a gesture with movement in the second direction) (in some embodiments, without including movement in the first direction), the computer system displays (716), via the one or more display generation components, at least a portion of a representation of a first media collection (e.g., 619 and/or 636a) of media items from the media library that was not displayed prior to (e.g., immediately prior to) detecting the first user input (e.g., from FIG. 6A-1 to FIG. 6L, in response to user input 620d, computer system 600 displays animated media collection representation 636a slide into display 602 from a right edge of display 602). In some embodiments, the first media collection (e.g., “Trip to Sydney” media collection in FIG. 6L) includes a first subset of the plurality of media items of the media library; and the first subset of the plurality of media items is selected for inclusion in the first media collection based on a first set of criteria (e.g., the first subset of the plurality of media items is included in the first media collection based on the first subset of the plurality of media items satisfying the first set of criteria (in some embodiments, a second subset of the plurality of media items is excluded from the first media collection based on the second subset of the plurality of media items not satisfying the first set of criteria)). In some embodiments, displaying at least a portion of the representation of the first media collection of media items from the media library that was not displayed prior to detecting the first user input is performed in accordance with a determination that the first user input includes more than a threshold amount of movement in the second direction. In some embodiments, in accordance with a determination that the first user input does not include more than the threshold amount of movement in the second direction, the computer system forgoes displaying the portion of the representation of the first media collection of media items from the media library that was not displayed prior to detecting the first user input (e.g., forgoes displaying any portion of the representation of the first media collection of media items from the media library that was not displayed prior to detecting the first user input).

In some embodiments, in accordance with the determination that first user input includes movement in the first direction, the computer system updates the appearance of the representation of the media library (e.g., 615) (e.g., displays navigating through and/or scrolling of the representation of the media library) without displaying the representation of the first media collection (e.g., 636a). In some embodiments, in accordance with the determination that the first user input includes movement in the second direction, the computer system displays the representation of the first media collection (e.g., 636a) without updating the appearance of the representation of the media library (e.g., 615) (e.g., without displaying navigating through and/or scrolling of the first plurality of representations in the first scroll direction). Allowing a user to navigate media items in the media library with a user input in a first direction, and navigate media collections with a user input in a second direction, allows the user to explore different types of media items with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first media collection (e.g., Trip to Sydney media collection in FIG. 6L) is part of a set of media collections that are accessible via user inputs that include movement in the second direction (e.g., one or more media collections) (e.g., media collections shown in FIGS. 6T-6V, and/or FIGS. 6Y-1 and 6Y-2); and the set of media collections includes one or more of: a media collection including media corresponding to one or more trips (e.g., FIG. 6L), a media collection including media corresponding to one or more pets (e.g., FIG. 6V), a media collection including media corresponding to one or more recent events (e.g., FIG. 6L, a recent trip), a media collection including media corresponding to one or more places (e.g., FIG. 6U), a media collection including media corresponding to one or more search terms, a media collection including media corresponding to one or more albums (e.g., albums, folders, and/or collections of media items automatically generated and/or aggregated by the computer system; and/or albums, folders, and/or collections of media items manually created by a user), and a media collection including media corresponding to one or more featured items (e.g., FIG. 6L) (e.g., images, photos, and/or videos selected (e.g., automatically selected) by the computer system (e.g., based on selection criteria)). In some embodiments, the set of media collections includes a respective media collection pertaining to a first trip (e.g., FIG. 6L) (e.g., a respective media collection that includes a subset of media items of the media library that are selected for inclusion in the respective media collection based on the subset of media items pertaining to the first trip). In some embodiments, the set of media collections includes a respective media collection pertaining to a first pet (e.g., FIG. 6V) (e.g., a respective media collection that includes a subset of media items of the media library that are selected for inclusion in the respective media collection based on the subset of media items pertaining to the first pet). In some embodiments, the set of media collections includes a respective media collection pertaining to a first event (e.g., a respective media collection that includes a subset of media items of the media library that are selected for inclusion in the respective media collection based on the subset of media items pertaining to the first event). In some embodiments, the set of media collections includes a respective media collection pertaining to a first place (e.g., FIG. 6U) (e.g., a geographic location, a city, a country, a continent, and/or a venue) (e.g., a respective media collection that includes a subset of media items of the media library that are selected for inclusion in the respective media collection based on the subset of media items pertaining to the first place). In some embodiments, the set of media collections includes a respective media collection pertaining to a first set of search terms (e.g., a respective media collection that includes a subset of media items of the media library that are selected for inclusion in the respective media collection based on the subset of media items pertaining to the first set of search terms). In some embodiments, the set of media collections includes a respective media collection pertaining to a first album (e.g., a respective media collection that includes a subset of media items of the media library that are selected for inclusion in the respective media collection based on the subset of media items pertaining to the first album and/or belonging to the first album). Allowing a user to navigate media items in the media library with a user input in a first direction, and navigate media collections with a user input in a second direction, allows the user to explore different types of media items with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the representation of the first media collection (e.g., 636a and/or 646a) of media items from the media library, the computer system detects, via the one or more input devices, a second user input (e.g., 640a, 640b, 640c, 640d, and/or 640e) (e.g., a touch input, a touchscreen input, a swipe input, a gesture, an air gesture, and/or a mechanical input (e.g., via one or more physical buttons and/or physically rotatable input mechanisms)). In response to detecting the second user input: in accordance with a determination that the second user input includes movement (and, optionally, more than a threshold amount of movement) in the first direction (e.g., in some embodiments, in accordance with a determination that the first user input is a swipe input and/or a gesture with movement in the first direction) (in some embodiments, without including movement in the second direction) (e.g., user input 640e is a downward swipe with movement in the same direction as user input 620a), the computer system updates, via the one or more display generation components, an appearance of the representation of the first media collection (e.g., 636a, 646a, and/or 642), including navigating through (e.g., scrolling through) representations of at least some of the first subset of the plurality of media items in the first scroll direction (e.g., in some embodiments, in response to user input 640e, computer system 600 displays user interface 642, including displaying and/or scrolling thumbnails 646b-1 through 646b-5 of media items in the media collection). In some embodiments, navigating through the representations of at least some of the first subset of the plurality of media items includes displaying scrolling of a first representation (e.g., 646b-1, 646b-2, 646b-3, 646b-4, and/or 646b-5) (e.g., a preview, a thumbnail, a snapshot, and/or a frame) of a first media item of the first subset of the plurality of media items in the first scroll direction; and displaying scrolling of a second representation (e.g., 646b-1, 646b-2, 646b-3, 646b-4, and/or 646b-5) (e.g., a preview, a thumbnail, a snapshot, and/or a frame) of a second media item of the first subset of the plurality of media items in the first scroll direction. In some embodiments, the first scroll direction corresponds to the first direction. In some embodiments, the first scroll direction is the same as the first direction. In some embodiments, the first scroll direction is different from the first direction (e.g., opposite the first direction). In some embodiments the first representation of the first media item of the first subset of the plurality of media items is not displayed prior to detecting the first swipe input (e.g., is displayed in response to detecting the first user input). In some embodiments, in response to detecting the second user input: in accordance with a determination that the first swipe input includes movement (and, optionally, more than a threshold amount of movement) in the second direction different from the first direction (e.g., user input 640c) (e.g., a movement input and/or a swipe input and/or a gesture with movement in the second direction) (in some embodiments, without including movement in the first direction), the computer system displays, via the one or more display generation components, a representation of a second media collection (e.g., 664) of media items from the media library different from the first media collection. In some embodiments, the second media collection (e.g., the timelapses media collection in FIG. 6T) includes a second subset of the plurality of media items of the media library different from the first subset of the plurality of media items of the media library; and the second subset of the plurality of media items is selected for inclusion in the second media collection based on a second set of criteria different from the first set of criteria (e.g., the second subset of the plurality of media items is included in the second media collection based on the second subset of the plurality of media items satisfying the second set of criteria (in some embodiments, a third subset of the plurality of media items is excluded from the second media collection based on the third subset of the plurality of media items not satisfying the second set of criteria)). Allowing a user to navigate media items in the first media collection with a user input in the first direction, and transition to a second media collection with a user input in the second direction allows the user to navigate different types of media items with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the representation of the first media collection (e.g., 636a, 664, 670, and/or 676), the computer system detects, via the one or more input devices, a third user input (e.g., 640c, 668e, 674e, and/or 680e) (e.g., a touch input, a touchscreen input, a swipe input, a gesture, an air gesture, and/or a mechanical input (e.g., via one or more physical buttons and/or physically rotatable input mechanisms)) that includes movement in the second direction (e.g., a movement input and/or a swipe input, a touch input, and/or an air gesture that includes movement in the second direction). In response to detecting the third user input that includes movement in the second direction: in accordance with a determination that the first media collection is not a final media collection in an ordered set of media collections (e.g., at least one collection of media items is ordered after the first media collection in the ordered set of media collection) (e.g., at least one collection of media items is ready for display on the next side of the representation of the first media collection of media items (e.g., at least one collection of media items is ready for display on the right side of the representation of the first media collection of media items when the second swipe is a swipe to left gesture)) (e.g., FIGS. 6M, 6T, and/or 6U), the computer system displays, via the one or more display generation components, a representation of a third media collection of media items from the media library different from the first media collection (e.g., 664, 670, and/or 676). In some embodiments, the third media collection is ordered subsequent to (e.g., immediately subsequent to) the first media collection in the ordered set of media collections; the third media collection includes a third subset of the plurality of media items of the media library different from the first subset of the plurality of media items of the media library; and the third subset of the plurality of media items is selected for inclusion in the third media collection based on a third set of criteria different from the first set of criteria (e.g., the third subset of the plurality of media items is included in the third media collection based on the third subset of the plurality of media items satisfying the third set of criteria (in some embodiments, a fourth subset of the plurality of media items is excluded from the third media collection based on the fourth subset of the plurality of media items not satisfying the third set of criteria)).

In response to detecting the third user input that includes movement in the second direction: in accordance with a determination that the first media collection is a final media collection in the ordered set of media collections (e.g., FIG. 6V) (e.g., there are no media collections subsequent to the first media collection in the ordered set of media collections): the computer system displays, via the one or more display generation components, a first customize affordance (e.g., 682) that, when selected (e.g., in response to a computer system detecting a selection input), causes the computer system to initiate a process for modifying a first user interface (e.g., 610) corresponding to the ordered set of media collections (e.g., a first user interface in which the ordered set of media collection is displayed and/or is accessible). While displaying the first customize affordance (e.g., 682), the computer system detects, via the one or more input devices, a selection input (e.g., 683) corresponding to selection of the first customize affordance (e.g., a touch input, a touchscreen input, a tap input, a click input, a swipe input, a gesture, an air gesture, and/or a mechanical input (e.g., via one or more physical buttons and/or physically rotatable input mechanisms)). In response to detecting the selection input (e.g., 683) corresponding to selection of the first customize affordance (e.g., 682), the computer system displays, via the one or more display generation components, one or more options (e.g., 684, 686a, 686b, 686c, 686d, 686e, 686f, 686b-1, 686c-1, 686d-1, 686e-1, 686b-2, 686c-2, 686d-2, and/or 686e-2) for modifying the first user interface (e.g., 610). In some embodiments, the one or more options for modifying the first user interface includes one or more options for modifying the ordered set of media collections (e.g., 684, 686a, 686b, 686c, 686d, 686e, 686f, 686b-1, 686c-1, 686d-1, 686e-1, 686b-2, 686c-2, 686d-2, and/or 686e-2). In some embodiments, displaying the one or more options for modifying the first user interface includes displaying representations of one or more media collections (e.g., 686a, 686b, 686c, 686d, and/or 686e) in the ordered set of media collections. Allowing a user to access options to modify a first user interface by continuing the same input for navigating the collection of media items enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and efficiently. Furthermore, doing so also provides the user with feedback about a state of the system (e.g., whether or not there are additional media collections to navigate through in the ordered set of media collections).

In some embodiments, displaying the one or more options for modifying the first user interface (e.g., 610) includes displaying a first option (e.g., 686f) that, when selected (e.g., in response to a computer system detecting a selection input), causes the computer system to initiate a process for adding a new media collection to the ordered set of media collections (in some embodiments, adding a new collection of media items includes creating and/or generating a new collection of media items). In some embodiments, while displaying the first option, the computer system detects, via the one or more input devices, one or more user inputs that includes selection of the first option. In response to detecting the one or more user inputs, the computer system modifies the first user interface by adding a new media collection to the ordered set of media collections (e.g., while maintaining other media collections that are in the ordered set of media collections) (e.g., displaying the new media collection within the first user interface). Allowing a user to access options to modify a first user interface by continuing the same input for navigating the collection of media items enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and efficiently. Furthermore, doing so also provides the user with feedback about a state of the system (e.g., whether or not there are additional media collections to navigate through in the ordered set of media collections).

In some embodiments, displaying the one or more options for modifying the first user interface includes displaying a second option that, when selected (e.g., in response to a computer system detecting a selection input), causes the computer system to initiate a process for reordering the ordered set of media collections (e.g., each of tiles and/or representations 686b, 686c, 686d, and/or 686e are movable to reorder the ordered set of media collections). In some embodiments, displaying the second option includes displaying representations of the ordered set of media collections that are movable to reorder the ordered set of media collections. In some embodiments, while displaying the second option, the computer system detects, via the one or more input devices, one or more user inputs that includes selection of the second option. In response to detecting the one or more user inputs, the computer system modifies the first user interface by reordering the ordered set of media collections. Allowing a user to access options to modify a first user interface by continuing the same input for navigating the collection of media items enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and efficiently. Furthermore, doing so also provides the user with feedback about a state of the system (e.g., whether or not there are additional media collections to navigate through in the ordered set of media collections).

In some embodiments, the ordered set of media collections includes: the first media collection that includes the first subset of the plurality of media items in the media library (e.g., Trip to Sydney media collection and/or the media collection represented by representation 686b); and the representation of the media library (e.g., 615, and/or 686) that corresponds to a media library collection that includes a majority of media items in the media library (e.g., all media items, or all media items that have not been hidden or otherwise excluded from display in the media library). In some embodiments, the first media collection is movable between a plurality of different positions in the ordered set of media collections (e.g., representation 686b is movable); and the representation of the media library (e.g., 615 and/or 686a) is not movable from a fixed position within the ordered set of media collections (e.g., in some embodiments, the media library collection cannot be used by user input; and/or in some embodiments, the media library collection is fixed in the first position or the last position of the ordered set of media collections). Allowing a user to modify a the ordered set of media collections, but preventing the user from moving the representation of the media library and/or the media library collection, enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, displaying the one or more options for modifying the first user interface includes displaying a third option that, when selected (e.g., in response to a computer system detecting a selection input), causes the computer system to initiate a process for removing a respective media collection from the ordered set of media collections (e.g., 686b-1, 686c-1, 686d-1, 686e-1, 686b-2, 686c-2, 686d-2, and/or 686e-2). In some embodiments, while displaying the third option, the computer system detects, via the one or more input devices, one or more user inputs that includes selection of the third option. In response to detecting the one or more user inputs, the computer system modifies the first user interface (e.g., 610) by removing a respective media collection from the ordered set of media collections (e.g., ceasing to display the respective media collection within the first user interface; making the respective media collection unavailable and/or inaccessible within the first user interface; and/or making the respective media collection unavailable and/or inaccessible within the first user interface via user input that includes movement in the second direction). Allowing a user to access options to modify a first user interface by continuing the same input for navigating the collection of media items enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and efficiently. Furthermore, doing so also provides the user with feedback about a state of the system (e.g., whether or not there are additional media collections to navigate through in the ordered set of media collections).

In some embodiments, the ordered set of media collections includes: the first media collection that includes the first subset of the plurality of media items in the media library (e.g., Trip to Sydney media collection; and/or the media collection represented by representation 686b); and the representation of the media library (e.g., 615 and/or 686a) that corresponds to a media library collection that includes a majority of media items in the media library (e.g., all media items, or all media items that have not been hidden or otherwise excluded from display in the media library). In some embodiments, the first media collection is removable from the ordered set of media collections (e.g., representation 686b is removable) (e.g., in some embodiments, displaying the one or more options for modifying the first user interface includes displaying an option that, when selected (e.g., in response to a computer system detecting a selection input), causes the computer system to initiate a process for removing the first media collection from the ordered set of media collections); and the representation of the media library is not removable from the ordered set of media collections (e.g., representation 686a and/or media grid 615 are not removable) (e.g., in some embodiments, displaying the one or more options for modifying the first user interface does not include displaying an option that, when selected (e.g., in response to a computer system detecting a selection input), causes the computer system to initiate a process for removing the representation of the media library and/or the media library collection from the ordered set of media collections (e.g., representation 686b is displayed with option 686b-1, but representation 686a is not displayed with a corresponding option to remove representation 686a). Allowing a user to modify a the ordered set of media collections, but preventing the user from removing the representation of the media library and/or the media library collection, enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, the first subset of the plurality of media items is selected for inclusion in the first media collection based on information about the media library (e.g., based on types of media captured (e.g., video, portrait photos, panoramic photos, and/or Live Photos), based on metadata, and/or based on content of the media items (e.g., things marked as favorites, identified pets, identified people, and/or identified trips)). Automatically generating media collections for viewing by a user allows the user to explore different types of media items with fewer inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first media collection (e.g., Trip to Sydney media collection, Paris media collection, Timelapses media collection, and/or Muffin+Buster media collection) is part of a first ordered set of media collections that includes a plurality of media collections arranged in a first order. In some embodiments, the first ordered set of media collections includes: the first media collection, wherein media items are selected for inclusion in the first media collection based on a first type of selection criteria (e.g., pets, place, media types, people, trips, shared media items, and/or albums); and a second respective media collection different from the first media collection, wherein media items are selected for inclusion in the second respective media collection based on a second type of selection criteria (e.g., pets, place, media types, people, trips, shared media items, and/or albums) different from the first type of selection criteria. In some embodiments, at a first time, the computer system displays, via the one or more display generation components: a representation of the first media collection at a first position within the ordered set of media collections, wherein the first media collection includes a first set of media items that are selected based on the first type of selection criteria (e.g., in the top row of FIG. 6Y-1, the Paris media collection is selected based on a places selection criteria); and a representation of the second respective media collection at a second position within the ordered set of media collections, wherein the second respective media collection includes a second set of media items (e.g., different from the first set of media items) that are selected based on the second type of selection criteria (e.g., in the top row of FIG. 6Y-1, the Muffin+Buster media collection is selected based on a pets selection criteria). At a second time subsequent to the first time (e.g., bottom row of FIG. 6Y-1), the computer system displays, via the one or more display generation components: a representation of a third respective media collection at the first position within the ordered set of media collections, wherein the third respective media collection includes a third set of media items that are different from the first set of media items and that are selected based on the first type of selection criteria (e.g., in the bottom row of FIG. 6Y-1, the London media collection is selected based on a places selection criteria); and a representation of a fourth respective media collection at the second position within the ordered set of media collections, wherein the fourth respective media collection includes a fourth set of media items that are different from the second set of media items and that are selected based on the second type of selection criteria (e.g., in the bottom row of FIG. 6Y-1, the Baxter with Morty media collection is selected based on a pets selection criteria). In some embodiments, the first ordered set of media collections maintains a fixed order with respect to the types of selection criteria used to populate the media collections (e.g., in FIG. 6Y-1, featured then media types, then places, then pets), but the content of the media collections changes over time (e.g., in FIG. 6Y-1, and FIG. 6Y-2, the media collections change as the order of the collection types stays the same) (e.g., in some embodiments, the types of selection criteria remain the same and remain in a fixed position within the first ordered set of media collections, but the specific selection criteria change over time). For example, in some embodiments, the first ordered set of media collections has a media types collection type at a first position in the ordered set of media collections, a places collection type at a second position in the ordered set of media collections, and a pets collection type at a third position in the ordered set of media collections, In some embodiments, the order of these collection types stays consistent over time, but the specific content and/or collection of content corresponding to each collection type changes over time. For example, in some embodiments, at the first time, the first position in the ordered set of media collections has a first media type collection corresponding to a first media type (e.g., videos, photos, panoramic images, and/or timelapse videos) and at the second time, the first position in the ordered set of media collections has a second media type collection corresponding to a second media type. In some embodiments, at the first time, the second position in the ordered set of media collections has a first places collection corresponding to a first place (e.g., a first location and/or a first geographic region), and at the second time, the second position in the ordered set of media collections has a second places collection corresponding to a second place (e.g., a second location and/or a second geographic region). In some embodiments, at the first time, the third position in the ordered set of media collections has a first pets collection corresponding to a first pet and/or a first set of pets, and at the second time, the third position in the ordered set of media collections has a second pets collection corresponding to a second pet and/or a second set of pets. Maintaining the fixed order of the set of media collections while the content of the media collections changes over time allows a user to apply familiar operations but still be able to explore different sets of media items. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, a first slideshow, wherein the first slideshow is populated using media items from the first media collection (e.g., in some embodiments, a slideshow is populated using media items in the “Trip to Sydney” media collection of FIG. 6N). In some embodiments, the first media collection is used to populate slide shows in a variety of different places and/or contexts (e.g., slideshows displayed within one or more widgets, slideshows displayed as TV screen savers, slideshows displayed within one or more watch faces, and/or slideshows displayed within one or more lock screens. Automatically populating slideshows using a media collection allows for performance of this operation with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the representation of the media library (e.g., 615) includes displaying the representation of the media library as a three-dimensional stack (e.g., FIG. 6A-1), including: displaying representations of a first set of media items of the media library at a top layer of the three-dimensional stack (e.g., thumbnails shown in top layer or media grid 615 in FIG. 6A-1); and displaying representations of a second set of media items of the media library behind the top layer of the three-dimensional stack (e.g., 617). Allowing a user to navigate media items in the media library with a user input in a first direction, and navigate media collections with a user input in a second direction, allows the user to explore different types of media items with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, updating the appearance of the representation of the media library includes displaying the three-dimensional stack flatten into a two-dimensional grid of media items (e.g., from FIG. 6A-1 to FIG. 6B). Displaying the three-dimensional stack of media items flatten into a two-dimensional grid enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the representation of the media library (e.g., 615), the computer system detects, via the one or more input devices, a selection input (e.g., 632) (e.g., a touch input, a touchscreen input, a tap input, a gesture, an air gesture, and/or a mechanical input (e.g., via one or more physical buttons and/or physically rotatable input mechanisms)) corresponding to selection of a representation of the first media item (e.g., 615f). In response to detecting the selection input corresponding to selection of the representation of the first media item, the computer system displays, via the one or more display generation components, expansion of the first media item to occupy a greater display area of the one or more display generation components than was occupied by the representation of the first media item prior to detecting the first user input (e.g., FIG. 6G) (e.g., expanding the first media item from a first size to a second size that is greater than the first size; and/or expanding the first media item from a first area to a second area that is greater than the first area) (and, optionally, displaying shrinking of the representation of the media library to occupy a smaller display area of the one or more display generation components; and/or ceasing display of the representation of the media library (e.g., ceasing display of the first representation and the second representation)). Allowing a user to expand the first media item in response to user input enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, concurrently with the representation of the media library (e.g., 615), at least a portion of a respective region (e.g., regions below region 612a in FIG. 610, including regions 612b, 612c, 612d, 612e, 612f, 612g, and/or 612h), wherein the respective region includes one or more sections of information from the media library (e.g., “People & Pets,” “Albums,” “Trips,” “Wallpaper Suggestions,” “Places,” “Media Types,” “Utilities,” etc.). In some embodiments, sections of the respective region are arranged in a vertical direction within the respective region. In some embodiments, not all sections of the respective region are displayed concurrently with the representation of the media library and some sections that are not previously displayed are displayed in response to a user input (e.g., swipe gesture). Displaying the respective region concurrently with the representation of the media library allows a user to access information from the media library with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the first user input: in accordance with the determination that the first user input includes movement in the first direction (e.g., 620a), the computer system ceases display of the respective region (e.g., in FIG. 6B, computer system 600 no longer displays regions 612b, 612c, 612d, 612e, 612f, 612g, and/or 612h). In some embodiments, updating the appearance of the representation of the media library (e.g., 615) includes displaying an expanded representation of the media library (e.g., 622) that occupies a greater display area than the representation of the media library. In some embodiments, while displaying the expanded representation of the media library (e.g., 622), the computer system detects a close user input (e.g., a touch input, a touchscreen input, a swipe input, a tap input, a gesture, an air gesture, and/or a mechanical input (e.g., via one or more physical buttons and/or physically rotatable input mechanisms)) corresponding to a user request to cease display of the expanded representation of the media library (e.g., 625a, 625c and/or 631). In response to detecting the close user input: the computer system ceases to display the expanded representation of the media library (e.g., 622) (e.g., in some embodiments, displaying shrinking of the expanded representation of the media library to re-display the representation of the media library that occupies a smaller display area of the one or more display generation components); and re-displays the at least the portion of the respective region (e.g., in FIG. 6F, computer system 600 re-displays region 612b and region 612c). Ceasing display of the respective region when the media library is expanded, and re-displaying the respective region when the media library is collapsed, enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the representation of the media library (e.g., 615) includes displaying representations of a first set of media items (e.g., a most recent set of media items and/or a most recently captured and/or most recently received set of media items) (e.g., 615 in FIG. 6A-1). In some embodiments, detecting the close user input comprises detecting the close user input while representations of a second set of media items different from the first set of media items is displayed within the expanded representation of the media library (e.g., detecting closer user input 631 in FIG. 6E). In some embodiments, the close user input comprises selection of a close affordance (e.g., 624c). In some embodiments, in response to detecting the close user input (e.g., 631), including selection of the close affordance (e.g., 624c), the computer system re-displays the representation of the media library (e.g., 615 in FIG. 6F), wherein: re-displaying the representation of the media library includes displaying, within the representation of the media library, representations of a third set of media items different from the first set of media items, wherein the third set of media items corresponds to the second set of media items (e.g., the third set of media items includes one or more media items that are in the second set of media items) (e.g., in FIG. 6F, media grid 615 displays different media items than it did in FIG. 6A-1). Maintaining the location of the media library within the representation of the media library when the user closes the expanded representation of the media library enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, subsequent to detecting the close user input (e.g., 631), in accordance with a determination that a threshold duration of time has elapsed (e.g., after 5 minutes, 8 minutes, 15 minutes, and/or 1 hour) since detecting the close user input: the computer system ceases display of the representations of the third set of media items within the representation of the media library; and re-displays representations of the first set of media items within the representation of the media library (e.g., returns from displaying media grid 615 as shown in FIG. 6F to displaying media grid 615 as shown in FIG. 6A-1). In some embodiments, subsequent to detecting the close user input, in accordance with a determination that less than the threshold duration of time has elapsed since detecting the close user input, the computer system maintains display of the representations of the third set of media items within the representation of the media library (e.g., 615 in FIG. 6F). Automatically resetting the position of the media library within the representation of the media library after a threshold duration of time enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the close user input includes a drag gesture in a respective direction (e.g., user input 625a) (e.g., a drag up gesture, a drag gesture that includes movement in an upward direction, a drag gesture that starts from a respective portion of the user interface such as a drag up from a bottom portion of the user interface or from a bottom edge of the user interface or a drag down from a top portion of the user interface or a drag down from a top edge of the user interface). Ceasing display of the respective region when the media library is expanded, and re-displaying the respective region when the media library is collapsed, enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the first user input: in accordance with a determination that the first user input includes movement in a third direction different from the first direction and the second direction (e.g., user input 620c) (e.g., in some embodiments, a third direction that is opposite the first direction) (e.g., in some embodiments, the third direction is an upward direction and/or the first user input is a drag up gesture, and the first direction is a downward direction and/or the first user input is a drag down gesture), the computer system displays navigating through one or more additional sections of the respective region (e.g., 612b, 612c, 612d, 612e, 612f, 612g, and/or 612h) (e.g., one or more additional sections that were not displayed prior to detecting the first user input). In some embodiments, the one or more additional sections of the respective region are individually editable by a user. In some embodiments, a user is able to specify what content (or what category of content) is included in at least some of the one or more additional sections of the respective region. In some embodiments, a user is able to specify the order of at least some of the one or more additional sections of the respective region. Allowing a user to navigate through additional sections of the respective region via a user input allows the user to access additional information with fewer inputs. Furthermore, doing so also enhances the operability of the system and makes the user-system interface more efficient (e.g., by preventing erroneous inputs and helping the user to improves the battery life of the device by enabling the user to use the system more quickly and efficiently.

In some embodiments, the respective region includes: a first section (e.g., 612b, 612c, 612d, 612e, 612f, 612g, and/or 612h) corresponding to a first category of content of a plurality of categories; and a second section distinct from the first section (e.g., 612b, 612c, 612d, 612e, 612f, 612g, and/or 612h) (e.g., different from the first section; visually distinct from the first section; separate from the first section; and/or non-overlapping with the first section) and corresponding to a second category of content different from the first category of content. In some embodiments, the first section (e.g., 612b, 612c, 612d, 612e, 612f, 612g, and/or 612h) includes: a first dynamic collection object (e.g., 612b-1) that corresponds to a first dynamically-selected sub-category of content of a plurality of different sub-categories of content within the first category of content; and a first static collection object (e.g., 612b-2) that corresponds to a first static sub-category of content within the first category of content. In some embodiments, the first dynamic collection object is displayed in a first manner indicating that the first dynamic collection object corresponds to a dynamically-selected sub-category of content (e.g., with indication 612b-1a); and the first static collection object is displayed in a second manner indicating that the first static collection object corresponds to a static sub-category of content (e.g., without indication 612b-1a). In some embodiments, dynamically-selected sets of content and/or sub-categories of content are temporary collections of content that dynamically (e.g., automatically) change over time. For example, in some embodiments, the first dynamically-selected set of content and/or sub-category of content is a temporary set of content that is not stored as a collection for more than a threshold duration of time (e.g., a day, two days, three days, or a week). In some embodiments, the first dynamically-selected set of content and/or sub-category of content is a temporary set of content that is presented as a collection of content for less than a threshold duration of time (e.g., a day, two days, three days, or a week). In some embodiments, a static set of content and/or sub-category of content is a collection of content that is persistently maintained as a collection of content (e.g., until the user removes and/or deletes the collection of content). For example, in some embodiments, a static set of content and/or sub-category of content includes an album or folder of content that has been created by a user and/or an album or folder of content that has been automatically generated by the computer system but is persistently maintained (e.g., for greater than a threshold duration of time and/or until removed and/or deleted by a user).

In some embodiments, the second section includes: a second dynamic collection object that corresponds to a second dynamically-selected sub-category of content of a plurality of different sub-categories of content within the second category of content (e.g., in some embodiments, one or regions 612c, 612d, 612e, and/or 612f includes a dynamic collection object such as dynamic collection object 612b-1); and a second static collection object that corresponds to a second static sub-category of content within the second category of content, wherein: the second dynamic collection object is displayed in the first manner indicating that the second dynamic collection object corresponds to a dynamically-selected sub-category of content; and the second static collection object is displayed in the second manner indicating that the second static collection object corresponds to a static sub-category of content.

In some embodiments, the first section further includes a second static collection object (e.g., 612b-3 and/or 612b-4) that corresponds to a second static sub-category of content of the plurality of different sub-categories of content within the first type of content, and the second static collection object is displayed in the second manner indicating that that second static collection object corresponds to a static sub-category of content. For example, in some embodiments, the first category of content is a pets category, and the first dynamic collection object changes over time so that at a first time, the first dynamic collection object corresponds to a first pet of a plurality of pets; and at a second time, the first dynamic collection object corresponds to a second pet of the plurality of pets. In some embodiments in which the first category of content is a pets category, the first static collection object is and/or corresponds to a folder or album of media depicting a first pet. In some embodiments, the first section also includes a second static collection object that corresponds to a second static sub-category of content within the first category of content (e.g., a second pet different from the first pet).

In another example, in some embodiments, the first category is a friends category, and the first dynamic collection object changes over time so that at a first time, the first dynamic collection object corresponds to a first friend of a plurality of friends; and at a second time, the first dynamic collection object corresponds to a second friend of the plurality of friends. In some embodiments, in which the first category of content is a friends category, the first static collection object is and/or corresponds to a folder or album of media depicting a first friend. In some embodiments, the first section also includes a second static collection object that corresponds to a second static sub-category of content within the first category of content (e.g., a second friend different from the first friend). In some embodiments, dynamically-selected sets of content and/or sub-categories change (e.g., from a first sub-category of content to a second sub-category of content (e.g., from a first pet to a second pet; and/or a from a first friend to a second friend)) randomly (e.g., random selection of a second sub-category of content). In some embodiments, dynamically-selected sets of content and/or sub-categories change (e.g., from a first sub-category of content to a second sub-category of content (e.g., from a first pet to a second pet; and/or a from a first friend to a second friend)) based on contextual information (e.g., contextual information corresponding to a user of the computer system and/or context information corresponding to a media library (e.g., to feature and/or include recently favorited media items, recently shared media items, media items pertaining to a recent event, media items pertaining to a recently visited location, and/or media items pertaining to a recently seen person and/or animal). Displaying dynamic sets of content that automatically change over time allows a user to view different categories and/or sets of media without user input. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the first user input: in accordance with a determination that the first user input includes movement in the third direction different from the first direction and the second direction (e.g., user input 620c), the computer system ceases to display at least a portion of the representation of the media library (e.g., 615) (e.g., displaying the representation of the media library scrolling off of the display) (e.g., FIG. 6J). Ceasing to display at least a portion of the representation of the media library allows a user to access a greater number of sections of the respective region on the limited display area and reduces the number of inputs to find and reach certain sections. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the respective region includes a utilities section (e.g., 612h), wherein the utilities section includes: a first option (e.g., 612h-1, 612h-2, 612h-3, 612h-4, 612h-5, 612h-6, 612h-7, 612h-8, and/or 612h-9) that, when selected (e.g., in response to a computer system detecting a selection input), causes the computer system to display representations of one or more media items that include a first type of detected content within the media (e.g., without displaying representations of media items that do not include the first type of detected content); and a second option (e.g., 612h-1, 612h-2, 612h-3, 612h-4, 612h-5, 612h-6, 612h-7, 612h-8, and/or 612h-9), different from the first option, that, when selected (e.g., in response to a computer system detecting a selection input), causes the computer system to display representations of one or more media items that include a second type of detected content within the media (e.g., without displaying representations of media items that do not include the second type of detected content within the media), wherein the second type of content is different from the first type of content. In some embodiments, the type of detected content is an annotation (e.g., an added note or mark) or a type of feature detected within the content such as: a media item that includes and/or depicts an identity document (e.g., driver's license and/or student ID card); a media item that includes and/or depicts a receipt; a media item that includes and/or depicts handwriting; a media item that includes and/or depicts an illustration; and/or a media item that includes and/or depicts a QR code). In some embodiments, one or more media items include the first type of detected content and the second type of detected content and are displayed in response to selection of the first option and/or in response to selection of the second option. In some embodiments, in accordance with a determination that the media library does not include media items (e.g., any media items) that include the first type of detected content within the media, the utilities section does not include the first option (e.g., 612h-1, 612h-2, 612h-3, 612h-4, 612h-5, 612h-6, 612h-7, 612h-8, and/or 612h-9). In some embodiments, in accordance with a determination that the media library does not include media items (e.g., any media items) that include the second type of detected content, the utilities section does not include the second option (e.g., 612h-1, 612h-2, 612h-3, 612h-4, 612h-5, 612h-6, 612h-7, 612h-8, and/or 612h-9).

In some embodiments, the utilities section (e.g., 612h) includes one or more selectable objects that are persistently displayed (e.g., even if there are no media items in the media library that satisfy inclusion criteria pertaining to those selectable objects and/or even if there are no media items that depict a respective type of content corresponding to the respective option). For example, in some embodiments, a duplicates object (e.g., 612h-2) (e.g., that, when selected (e.g., in response to a computer system detecting a selection input), causes the computer system to display representations of duplicate media items), a hidden media items object (e.g., 612h-3) (e.g., that, when selected (e.g., in response to a computer system detecting a selection input), causes the computer system to display representations of hidden media items), and/or a recently deleted object (e.g., 612h-4) (e.g., that, when selected (e.g., in response to a computer system detecting a selection input), causes the computer system to display representations of recently deleted media items) is persistently displayed in the utilities section. In some embodiments, certain options are displayed within the utilities section (e.g., 612h) based on a determination that one or more media items in the media library satisfy inclusion criteria corresponding to the option and/or based on a determination that one or more media items in the media library include a respective type of content corresponding to a respective option. For example, in some embodiments, when the media library includes one or more identity documents, one or more receipts, one or more media items depicting handwriting, one or more media items depicting illustrations, and/or one or more media items depicting QR codes, the utilities section includes an identity documents object (e.g., 612h-5), a receipt object (e.g., 612h-6), a handwriting object (e.g., 612h-7), an illustration object (e.g., 612h-8), and/or a QR code object (e.g., 612h-9), respectively. In some embodiments, when the media library does not include any identity documents, receipts, handwriting, illustrations, and/or QR codes, the utilities section does not include an identity documents object (e.g., 612h-5), a receipt object (e.g., 612h-6), a handwriting object (e.g., 612h-7), an illustration object (e.g., 612h-8), and/or a QR code object (e.g., 612h-9), respectively. Displaying a utilities section with selectable options for viewing different types of media items enhances the operability of the system and makes the user-system interface more efficient (e.g., by preventing erroneous inputs and helping the user to improves the battery life of the device by enabling the user to use the system more quickly and

In some embodiments, the first media collection is part of an ordered set of media collections; and displaying navigating through one or more additional sections of the respective region includes displaying, within the respective region, a customize affordance (e.g., 616) that, when selected (e.g., in response to a computer system detecting a selection input), causes the computer system to initiate a process for modifying a media collection user interface (e.g., 610 and/or 612a) corresponding to the ordered set of media collections (e.g., a media collection user interface in which the ordered set of media collection is displayed and/or is accessible). While displaying the customize affordance (e.g., 616), the computer system detects, via the one or more input devices, a selection input corresponding to selection of the customize affordance (e.g., a touch input, a touchscreen input, a swipe input, a gesture, an air gesture, and/or a mechanical input (e.g., via one or more physical buttons and/or physically rotatable input mechanisms)). In response to detecting the one or more user inputs, the computer system displays, via the one or more display generation components, one or more options (e.g., 684, 686a, 686b, 686c, 686d, 686e, 686f, 686b-1, 686c-1, 686d-1, 686e-1, 686b-2, 686c-2, 686d-2, and/or 686e-2) for modifying the media collection user interface (e.g., 610). In some embodiments, the one or more options for modifying the media collection user interface includes one or more options for modifying the ordered set of media collections. In some embodiments, displaying the one or more options for modifying the media collection user interface includes displaying representations of one or more media collections (e.g., 686a, 686b, 686c, 686d, and/or 686e) in the ordered set of media collections. Allowing a user to access options to modify a media collection user interface enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, in response to detecting the first user input: in accordance with a determination that the first user input (e.g., 620b) includes movement in the second direction and the first user input is directed to (e.g., position at and/or located at) the respective region (e.g., 612b), the computer system updates, via the one or more display generation components, an appearance of the respective region (e.g., 612b), including navigating through media representations included in a first section (e.g., 612b) of the respective region (e.g., FIG. 6A-1 to FIG. 6I) (e.g., displaying scrolling of the media representations (e.g., in the second direction)). In some embodiments, the media representations are arranged in a horizontal direction within a section (e.g., 612b). In some embodiments, not all media representations included in a section are displayed concurrently, and some media representations that are not previously displayed are displayed in response to the first user input (e.g., region 612b in FIG. 6A-1 to FIG. 6I). In some embodiments, navigating through the media representations included in the first section includes displaying scrolling of a first media representation (e.g., 612b-1, 612b-2, and/or 612b-3) (e.g., a preview, a thumbnail, a snapshot, and/or a frame) included in the section (e.g., in the second scroll direction) and displaying scrolling of a second media representation (e.g., 612b-1, 612b-2, and/or 612b-3) (e.g., a preview, a thumbnail, a snapshot, and/or a frame) included in the section (e.g., in the second scroll direction)). Allowing a user to navigate through media representations via a user input allows the user to access additional media representations in a section with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the first user input: in accordance with the determination that the first user input includes movement in the second direction (e.g., user input 620d), the computer system displays the representation of the first media collection (e.g., 615) while maintaining display of the at least a portion of the respective region (e.g., 612b) (e.g., without changing and/or modifying display of the respective region) (e.g., such that the representation of the first media collection and the respective region are concurrently displayed). Maintaining display of the respective region while other portions of the user interface are changed enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more sections of information from the media library includes a wallpaper suggestion section (e.g., 612e) that includes representations of one or more media items that are selected (e.g., automatically selected and/or selected by the computer system and/or one or more external computer systems) (e.g., based on selection criteria) as recommendations to be used for wallpaper on the computer system (e.g., as a background image and/or background media item for a home screen user interface and/or for a lock screen user interface and/or other user interfaces). In some embodiments, the representations of one or more media items that are selected as recommendations to be used for wallpaper on the computer system includes representations of one or more media items from the library (e.g., images, still-image of a video, still-image of a live photo, a portion of a video, a live photo). In some embodiments, the one or more media items that are selected as recommendations to be used for wallpaper are automatically selected by the computer system and/or a server. In some embodiments, in accordance with a determination that the computer system is oriented in a first orientation (e.g., portrait or landscape) (e.g., FIG. 6AH), the computer system (e.g., 730) displays the representations of the one or more media items that are selected as recommendations to be used for wallpaper at a first size and/or a first aspect ratio (e.g., a size and/or an aspect ratio in which its width is greater than its height) (e.g., a size and/or an aspect ratio in which its height is greater than its width) (e.g., in FIG. 6AH, section 612e includes two media items, and they are displayed in a landscape orientation based on computer system 730 being oriented in the landscape orientation). In some embodiments, in accordance with a determination that the computer system (e.g., 730) is oriented in a second orientation (e.g., portrait or landscape) (e.g., FIG. 6AI) different from the first orientation, the computer system displays the set of media item representations at a second size and/or a second aspect ratio (e.g., a size and/or aspect ratio in which its width is greater than its height) (e.g., a size and/or an aspect ratio in which its height is greater than its width) different from the first size and/or the first aspect ratio (e.g., in FIG. 6AI, section 612e includes two media items, and they are displayed in a portrait orientation based on computer system 730 being oriented in the portrait orientation). Displaying a section for media items suggested for wallpaper for viewing by a user allows the user to explore wallpaper candidates with fewer inputs. Doing so also enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and

In some embodiments, while displaying at least a portion of the respective region (e.g., region below section 612a in user interface 610, and/or sections 612b-612z), the computer system (e.g., 600 and/or 730) detects, via the one or more input devices, a first set of user inputs (e.g., 720, 740, and/or 750) (e.g., a touch input, a touchscreen input, a swipe input, a gesture, an air gesture, and/or a mechanical input (e.g., via one or more physical buttons and/or physically rotatable input mechanisms)). In response to detecting the first set of user inputs, the computer system displays, via the one or more display generation components, a second user interface (e.g., 684) that includes one or more selectable options (e.g., 686h-1, 686h-2, 686i-1 686l-2, 686 j-1, 686j-2, 686l-1, 686l-2, 686k-1, 686k-2, 686m-1, 686m-2, 686n-1, 686n-2, 686o-1, 686o-2, 686y-1, 686y-2, 686z-1, and/or 686z-2) that, when selected by a user, modify the respective region in response to user input, wherein modifying the respective region includes modifying spatial arrangement of the one or more sections of information (e.g., 612b, 612c, 612d, 612e, 612f, 612g, 612h, 612x, 612y, and/or 612z) from the media library in the respective region. In some embodiments, spatial arrangement of the one or more selectable objects corresponding to the one or more sections in the second user interface corresponds to spatial arrangement of the corresponding one or more sections of information in the respective region. In some embodiments, the second user interface (e.g., 684) includes one or more selectable objects corresponding to the one or more sections of information from the media library. In some embodiments, the one or more selectable objects corresponding to the one or more sections of information from the media library included in the second user interface are arranged in one or more columns. Allowing a user to access a user interface to modify the respective region, including modifying spatial arrangement of one or more sections of information from the media library, enhances the operability of the system and makes the user system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, the second user interface (e.g., 684) includes a first section display option (e.g., 686h-1, 686l-1 686 j-1, 686l-1, 686k-1, 686m-1, 686n-1, 686o-1, 686y-1, and/or 686z-1) corresponding to a respective section (e.g., 612b, 612c, 612d, 612e, 612f, 612g, 612h, 612x, 612y, and/or 612z) of the one or more sections. In some embodiments, the first section display option provides a visual indication of whether the respective section is in an enabled state or a disabled state (e.g., in FIGS. 6AC and/or 6AF, display options with a check mark indicate an enabled state and display options without a check mark indicate a disabled state). In the enabled state, the respective section is displayed within the respective region. In the disabled state, the respective section is not displayed within the respective region. In some embodiments, while the respective section of the one or more sections is in the enabled state, the computer system receives, via the one or more input devices, one or more user inputs (e.g., 722a and/or 741b) corresponding to selection of the first section display option (e.g., a touch input, a touchscreen input, a swipe input, a gesture, an air gesture, and/or a mechanical input (e.g., via one or more physical buttons and/or physically rotatable input mechanisms) directed to the first section display option). In response to receiving the one or more user inputs corresponding to selection of the first section display option, the computer system disables the respective section (e.g., transitioning the respective section from the enabled state to the disabled state) (e.g., in FIG. 6AC, in response to user input 722a, computer system 600 causes section 686j and/or corresponding section 612d to be disabled; and in FIG. 6AG, in response to user input 741b, computer system 730 causes section 686y and/or corresponding section 612y to be disabled); and causes the respective section to not be displayed within the respective region (e.g., in FIGS. 6AD-1-6AD-2, based on user input 722a, computer system 600 causes 612d to no longer be displayed within user interface 610; and in FIG. 6AH, based on user input 741b, computer system 730 causes section 612y to no longer be displayed within user interface 610). In some embodiments, while the respective section of the one or more sections is in the disabled state, the computer system receives, via the one or more input devices, one or more user inputs corresponding to selection of the first section display option; and in response to receiving the one or more user inputs corresponding to selection of the first section display option, the computer system enables the respective section; and causes the respective section to be displayed within the respective region. Allowing a user to access a user interface to modify the respective region, including spatial arrangement of one or more sections of information from the media library, enhances the operability of the system and makes the user system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, the second user interface (e.g., 684) includes a fifth option (e.g., 686h-2, 686i-2 686 j-2, 686l-2, 686k-2, 686m-2, 686n-2, 686o-2, 686y-2, and/or 686z-2) (in some embodiments, the fifth option is included in a respective selectable object corresponding to a respective section of the one or more sections of information from the media library) that, when selected, causes the computer system to initiate a process for modifying a size of a respective section of the one or more sections. In some embodiments, the size is based on (e.g., proportional to) the dimensions of the display generation components and/or to the dimensions of a user interface (e.g., the second user interface and/or a media library user interface) (e.g., the size of the respective region can be modified to be one-fourth the size, one-third the size, two-thirds the size, and/or three-fourths the size of the display and/or user interface). In some embodiments, the size is based on (e.g., proportional) the dimensions of a virtual display displayed on the display generation components. In some embodiments, sections displayed in a first region of the respective region are displayed at first size (e.g., a first width and/or a first height) (e.g., a left column of region 685b), and sections displayed in a second region of the respective region (e.g., a right column of region 685b) are displayed at a second size (e.g., a second width and/or a second height). In some embodiments, the fifth option is an option that, when selected, causes the computer system to initiate a process for modifying a size of a respective section by moving the respective region from the first region of the respective region to the second region of the respective region. Allowing a user to access a user interface to modify the respective region, including spatial arrangement of one or more sections of information from the media library, enhances the operability of the system and makes the user system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, while displaying the second user interface (e.g., 684) including the fifth option (e.g., 686h-2, 686i-2 686 j-2, 686l-2, 686k-2, 686m-2, 686n-2, 686o-2, 686y-2, and/or 686z-2), the computer system receives, via the one or more input devices, a user input (e.g., 722b and/or 741a) that includes selection of the fifth option, wherein the user input that includes selection of the fifth option corresponds to a user request to move the respective section that corresponds to the fifth option within the respective region. In response to receiving the user input (e.g., 722b and/or 741a) that includes selection of the fifth option (e.g., 686k-2 and/or 686o-2): in accordance with a determination that the fifth option is moved to a first location (e.g., left or right side of the second user interface; and/or a left region or a right region of the second user interface) of the second user interface, the computer system displays, via the one or more display generation components, the respective section of the one or more sections at a first size (e.g., a first area, a first height, and/or a first width) (e.g., in FIGS. 6AF-6AG, based on section 686o being moved to the right column of region 685b, section 686o is displayed at a particular width in FIG. 6AG); and in accordance with a determination that the fifth option is moved to a second location (e.g., left or right side of the second user interface; and/or a left region or a right region of the second user interface) of the second user interface (e.g., 684), wherein the second location of the second user interface is different from the first location of the second user interface, the computer system displays, via the one or more display generation components, the respective section of the one or more sections at a second size (e.g., a second area, a second height, and/or a second width) different from the first size (e.g., in FIGS. 6AF-6AG, had section 686o been moved to a position in the left column of region 685b, section 686o would have been displayed at a different width than it is in shown in FIG. 6AG (e.g., the same width as it is shown as having in FIG. 6AF)). In some embodiments, the second user interface (e.g., 684) has a different appearance than the representation of the media library and/or the respective region (e.g., 610). In some embodiments, a component of the second user interface (e.g., sections 686h-686z in user interface 864) that is representative of a respective section in the respective region (e.g., sections 612b-612z in user interface 610) has a different appearance than the respective section. In some embodiments, a component of the second user interface (e.g., sections 686h-686z in user interface 864) that is representative of a respective section in the respective region (e.g., sections 612b-612z in user interface 610) has a different size than the respective section. In some embodiments, moving the fifth option from the first location of the second user interface to the second location of the second user interface causes a corresponding section of the respective region to be moved within the respective region (e.g., movement of section 686o in FIGS. 6AF-6AG causes movement of corresponding section 612x within user interface 610). In some embodiments, moving the fifth option from the first location of the second user interface to the second location of the second user interface causes a corresponding section of the respective region to change in size from a first respective size to a second respective size different from the first respective size (e.g., movement of section 686o and/or position option 686o-2 in FIGS. 6AF-6AG causes movement of corresponding section 612x within user interface 610 and a change in size of corresponding section 612x). In some embodiments, the change in size from the respective size to the second respective size is not visible and/or is not displayed until the second user interface is no longer displayed and/or the respective region is displayed. Allowing a user to access a user interface to modify the respective region, including spatial arrangement of one or more sections of information from the media library, enhances the operability of the system and makes the user system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, the second user interface (e.g., 684) includes a plurality of columns (e.g., a left column and a right column of region 685b), including a first column that includes representations of a first subset of the one or more sections, and a second column that includes representations of a second subset of the one or more sections different from the first subset. In some embodiments, displaying the second user interface (e.g., 684) includes: in accordance with a determination that the computer system is oriented in a first orientation (e.g., portrait mode or landscape mode) (e.g., FIG. 6AG), displaying, via the one or more display generation components, the first column (e.g., in some embodiments, the first subset of the one or more sections in the first column) having a first width (e.g., in FIG. 6AG, the left column of region 685b and/or the right column of region 685b has a first width); and in accordance with a determination that the computer system (e.g., 730) is oriented in a second orientation different from the first orientation (e.g., portrait mode or landscape mode) (e.g., FIG. 6AJ), displaying, via the one or more display generation components, the first column (e.g., in some embodiments, the first subset of the one or more sections in the first column) having a second width different from the first width (in some embodiments, the first width is wider than the second width) (in some embodiments, the second width is wider than the first width) (e.g., the left column of region 685b in FIG. 6AJ is narrower than the left column of region 685b in FIG. 6AG; and/or the right column of region 685b in FIG. 6AJ is narrower than the right column of region 685b in FIG. 6AG. In some embodiments, displaying the second user interface (e.g., 684) includes: in accordance with a determination that the computer system is oriented in a first orientation (e.g., landscape or portrait) (e.g., FIG. 6AG), displaying, via the one or more display generation components, a first column having a first width and a second column having a second width, wherein the second column is narrower than the first column (e.g., the second width is narrower than the first width) (e.g., the right column of region 685b is narrower than the left column of region 685b in FIG. 6AG); and in accordance with a determination that the computer system is oriented in a second orientation (e.g., portrait or landscape) different from the first orientation (e.g., FIG. 6AJ), displaying, via the one or more display generation components, a third column having a third width and a fourth column having a fourth width, wherein the fourth column is narrower than the first column, the second column, and the third column (e.g., the fourth width is narrower than the first width, the second width, and the third width) (e.g., the right column of region 685b in FIG. 6AJ is narrower than the left column of region 685b in FIG. 6AJ, and is also narrower than the left and right columns of region 685b in FIG. 6AG). In some embodiments, the third column (e.g., the left column in FIG. 6AJ) is narrower than the first column (e.g., the left column in FIG. 6AG) (e.g., the third width is narrower than the first width). In some embodiments, while the computer system is oriented in the first orientation (e.g., FIG. 6AG), the computer system displays the second user interface with the first column having a first width and the second column having a second width that is wider than the first width; while displaying the second user interface with the first column having the first width and the second column having the second width that is wider than the first width, the computer system detects that its orientation has changed from the first orientation to the second orientation (e.g., user input 748); and in response to detecting that the orientation of the computer system has changed from the first orientation to the second orientation, the computer system displays second user interface (e.g., 684) with the first column having a third width that is narrower than the first width; and the second column having a fourth width that is narrower than the second width and wider than the third width (e.g., FIG. 6AJ). In some embodiments, the widths at which the one or more sections and/or the plurality of columns are displayed in the second user interface corresponds to the widths at which the one or more sections and/or the plurality of columns are displayed within the respective region and/or are indicative of the widths at which the one or more sections would be displayed within the respective region. Allowing a user to access a user interface to modify the respective region, including spatial arrangement of one or more sections of information from the media library, enhances the operability of the system and makes the user system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, the one or more sections of information (e.g., 612b-612z) from the media library are ordered within the second user interface (e.g., 684) in a first order (e.g., a first sequential order) (e.g., representative sections 686h-686z, respective of section 612b-612z, are displayed within user interface 684 in a particular order). In some embodiments, the second user interface includes a sixth option (e.g., 686h-2, 686i-2 686 j-2, 686l-2, 686k-2, 686m-2, 686n-2, 686o-2, 686y-2, and/or 686z-2), that, when selected, causes the computer system (e.g., 600 and/or 730) to initiate a process for reordering the one or more sections. In some embodiments, while displaying the second user interface (e.g., 684) with the one or more sections of information from the media library arranged in the first order, the computer system receives, via the one or more input devices, a reordering input (e.g., 722b and/or 741a) that includes selection of the sixth option (e.g., 686k-2 and/or 686o-2). In response to receiving the reordering input that includes selection of the sixth option, the computer system displays, via the one or more display generation components, reordering the one or more sections of information from the first order to a second order different from the first order (e.g., from FIGS. 6AB-6AC, in response to user input 722b, sections 686h-686o are reordered; and from FIGS. 6AF-6AG, in response to user input 741a, sections 686h-686z are ordered). In some embodiments, reordering of the one or more sections of information from the first order to the second order is visible when the respective section is displayed (e.g., within user interface 610) and/or is not visible while the second user interface (e.g., 684) is displayed. In some embodiments, subsequent to reordering the one or more sections of information from the first order to the second order, the computer system receives one or more user inputs (e.g., 724 and/or 746) corresponding to a request to display the respective region (e.g., within user interface 610); and in response to receiving the one or more user inputs, the computer system displays the respective region, including displaying the one or more sections of information in the second order. In some embodiments, the reordering input (e.g., 722b and/or 741a) comprises a drag input. In some embodiments, the sixth option (e.g., 686k-2 and/or 686o-2) corresponds to a respective section (e.g., option 686k-2 corresponds to section 686k and/or section 612e; and/or option 686o-2 corresponds to section 686o and/or section 612x) of the one or more sections. In some embodiments, the reordering input corresponds to a user request to move the respective section from a first location in the second user interface to a second location in the second user interface. In some embodiments, the reordering of the one or more sections from the first order to the second order is performed based on movement of the respective section from the first location to the second location. In some embodiments, the order of the one or more sections (e.g., 686h-686z) within the second user interface (e.g., 684) corresponds to, is indicative of, and/or is determinative of the order of the one or more sections (e.g., 612b-612z) within the respective region. In some embodiments, changing the position of a respective region within the second user interface changes the position of the respective region within the respective region. In some embodiments, changing the order of the one or more sections within the second user interfaces changes the order of the one or more sections within the respective region. Allowing a user to access a user interface to modify the respective region, including spatial arrangement of one or more sections of information from the media library, enhances the operability of the system and makes the user system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, in response to detecting the first user input: in accordance with a determination that the first user input includes movement in a fourth direction different from the first direction and the second direction (e.g., user input 620e) (e.g., in some embodiments, in accordance with a determination that the first user input is a swipe input and/or a gesture with movement in the fourth direction) (in some embodiments, without including movement in the first direction and/or the second direction), the computer system displays, via the one or more display generation components, a search user interface (e.g., 688) (e.g., a search user interface that includes a text entry field for entry of search terms). Providing access to a search user interface from the media library reduces the number of inputs required to search media items in the media library. Furthermore, doing so also enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and

In some embodiments, the computer system displays, via the one or more display generation components, and concurrently with the representation of the media library (e.g., 615), a search affordance (e.g., 618). While displaying the search affordance, the computer system detects, via the one or more input devices, a selection input corresponding to selection of the search affordance (e.g., 618) (e.g., a touch input, a touchscreen input, a swipe input, a tap input, a gesture, an air gesture, and/or a mechanical input (e.g., via one or more physical buttons and/or physically rotatable input mechanisms)). In response to detecting the selection input corresponding to selection of the search affordance, the computer system displays, via the one or more display generation components, a search user interface (e.g., 688 and/or 902 in FIG. 9B) (e.g., a search user interface that includes a text entry field for entry of search terms). Providing access to a search user interface from the media library reduces the number of inputs required to search media items in the media library. Furthermore, doing so also enhances the operability of the system and makes the user-system interface more efficient (e.g., by preventing erroneous inputs and helping the user to provide proper inputs and reducing errors), which, additionally, reduces power usage and improves the battery life of the device by enabling the user to use the system more quickly and efficiently.

In some embodiments, while displaying the representation of the first media collection (e.g., 636a) of media items from the media library, the computer system detects, via the one or more input devices, a selection input (e.g., 640a and/or 640e) (e.g., a touch input, a touchscreen input, a swipe input, a gesture, an air gesture, and/or a mechanical input (e.g., via one or more physical buttons and/or physically rotatable input mechanisms)) corresponding to selection of the representation of the first media collection (e.g., 636a). In response to detecting the selection input, the computer system displays, via the one or more display generation components, a media collection user interface (e.g., 642) representative of the first media collection, including concurrently displaying (e.g., within the media collection user interface): an animated media representation (e.g., 646a) that corresponds to a second plurality of media items selected from the first media collection, wherein displaying the animated media representation includes sequentially displaying different media items in the second plurality of media items over time (e.g., a representation of a collection of media items that includes visual movement and/or changing visuals over time) (e.g., displaying a video and/or slideshow that sequentially displays representations of different media items from the second plurality of media items over time); and a media collection region (e.g., 646b) (e.g., a media collection region separate from and/or different from the animated media representation) that includes concurrently displaying representations of at least some of the first plurality of media items of the first media collection (e.g., 646b-1 through 646b-5), including a first representation representative of a first media item and a second representation representative of a second media item different from the first media item. While displaying the media collection user interface (e.g., 642), the computer system detects, via the one or more input devices, a fourth user input (e.g., a touch input, a touchscreen input, a swipe input, a gesture, an air gesture, and/or a mechanical input (e.g., via one or more physical buttons and/or physically rotatable input mechanisms)). In response to detecting the fourth user input: in accordance with a determination that the fourth user input includes movement in the first direction and that the fourth user input is directed toward (or, optionally, directed to) the animated media representation (e.g., 646a) (e.g., user input 647b) (e.g., the second user input is initiated from a position that is positioned within the animated media representation), the computer system ceases display of the media collection user interface (e.g., 642) and re-displays the representation of the first media collection of media items (e.g., 636a, and/or returning to the state shown in FIG. 6M) (e.g., within a scrollable carousel and/or ordered set of representations of media collections); and in accordance with a determination that the fourth user input includes movement in the first direction and that the fourth user input is directed toward (or, optionally, directed to) the media collection region (e.g., 646b) (e.g., user input 647f) (e.g., the second user input is initiated from a position that is positioned within the media collection region), the computer system displays, via the one or more display generation components, expansion of the animated media representation to occupy a greater display area of the one or more display generation components than was occupied by the animated media representation prior to detecting the fourth user input (e.g., FIGS. 6N to 60) (e.g., expanding the animated media representation (e.g., 646a) from a first size (e.g., FIG. 6N) to a second size (e.g., 648 in FIG. 6O) that is greater than the first size; and/or expanding the animated media representation from a first area to a second area that is greater than the first area) (and, optionally, displaying shrinking of the media collection region (e.g., 646b) to occupy a smaller display area of the one or more display generation components; and/or ceasing display of the media collection region (e.g., ceasing display of the first representation and the second representation (e.g., FIG. 6O))). Ceasing display of the media collection user interface when the second user input corresponds to the animated media representation, and expanding the animated media representation when the second user input corresponds to the media collection region allows a user to perform these operations with fewer inputs. Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 700 (e.g., FIG. 7) are also applicable in an analogous manner to the methods described below. For example, method 800, method 1000, method 1100, method 1300, method 1400, method 1600, and/or method 1800 optionally include one or more of the characteristics of the various methods described above with reference to method 700. For example, the media library in method 700 is the media library in method 800, method 1300, method 1400, method 1600, and/or method 1800; and/or the queries recited in method 1000 and/or method 1100 are queries within the media library recited in method 700, method 800, method 1300, method 1400, method 1600, and/or method 1800. For brevity, these details are not repeated below.

FIGS. 8A-8B are a flow diagram illustrating a method for navigating, displaying, and/or presenting content using a computer system in accordance with some embodiments. Method 800 is performed at a computer system (e.g., 100, 300, 500 and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 602, and/or 604a-604c) (e.g., a touch-sensitive surface, a touch-sensitive display, a button, a rotatable input mechanism, a depressible and rotatable input mechanism, a camera, an accelerometer, and/or an inertial measurement unit (IMU)). Some operations in method 800 are, optionally, combined, the orders of some operations are, optionally, changed, and some operations are, optionally, omitted.

As described below, method 800 provides an intuitive way for navigating, displaying, and/or presenting content. The method reduces the cognitive burden on a user for navigating and/or accessing content, thereby creating a more efficient human-machine interface. For battery-operated computing devices, enabling a user to navigate and/or access content faster and more efficiently conserves power and increases the time between battery charges.

The computer system (e.g., 600) displays (802), via the one or more display generation components (e.g., 602), a first representation (e.g., 642) of a first media collection (e.g., Trip to Sydney media collection in FIG. 6N). In some embodiments, the first media collection includes a first plurality of media items (e.g., images, photos, and/or videos) from a media library (804) (e.g., a media library associated with the computer system; a media library associated with a user (e.g., a user of the computer system); and/or a media library associated with a user account). In some embodiments, the first plurality of media items is selected for inclusion in the first media collection based on a first set of criteria (e.g., the first plurality of media items is included in the first media collection based on the first plurality of media items satisfying the first set of criteria. In some embodiments, a second plurality of media items of the media library is excluded from the first media collection based on the second plurality of media items not satisfying the first set of criteria. In some embodiments, displaying the first representation (e.g., 642) of the first media collection includes (806) concurrently displaying: an animated media representation (e.g., 646a) that corresponds to a second plurality of media items selected from the first media collection, wherein displaying the animated media representation includes sequentially displaying different media items in the second plurality of media items over time (e.g., a representation of a collection of media items that includes visual movement and/or changing visuals over time) (e.g., displaying a video and/or slideshow that sequentially displays representations of different media items from the second plurality of media items over time); and a media collection region (e.g., 646b) (e.g., a media collection region separate from and/or different from the animated media representation) that includes concurrently displaying representations (e.g., 646b-1 through 646b-5) of at least some of the first plurality of media items of the first media collection, including a first representation (e.g., 646b-1, 646b-2, 646b-3, 646-b4, and/or 646b-5) representative of a first media item and a second representation (e.g., 646b-1, 646b-2, 646b-3, 646-b4, and/or 646b-5) representative of a second media item different from the first media item. While displaying the first representation of the first media collection (e.g., 642) (808) (e.g., including concurrently displaying the animated collection representation and the representation region), the computer system detects (810), via the one or more input devices, a first user input (e.g., a touch input, a touchscreen input, a swipe input, a gesture, an air gesture, and/or a mechanical input (e.g., via one or more physical buttons and/or physically rotatable input mechanisms)). In response to detecting the first user input (812): in accordance with a determination that the first user input includes movement in a first direction (814) (e.g., user input 647f) (e.g., in some embodiments, in accordance with a determination that the first user input is a swipe input and/or a gesture with movement in the first direction) (in some embodiments, without including movement in the second direction), the computer system displays (816), via the one or more display generation components, expansion of the animated media representation (e.g., 646a) to occupy a greater display area of the one or more display generation components than was occupied by the animated media representation prior to detecting the first user input (e.g., FIG. 6N to FIG. 6O, animated media collection representation 646a expands into expanded animated media collection representation 648) (e.g., expanding the animated media representation from a first size to a second size that is greater than the first size; and/or expanding the animated media representation from a first area to a second area that is greater than the first area) (and, optionally, displaying shrinking of the media collection region to occupy a smaller display area of the one or more display generation components; and/or ceasing display of the media collection region (e.g., ceasing display of the first representation and the second representation)); and in accordance with a determination that the first user input includes movement in a second direction different from the first direction (818) (e.g., user input 647d) (e.g., in some embodiments, in accordance with a determination that the first user input is a swipe input and/or a gesture with movement in the second direction) (in some embodiments, without including movement in the first direction), the computer system displays (820), via the one or more display generation components, expansion of the media collection region (e.g., 646b) to occupy a greater display area of the one or more display generation components than was occupied by the media collection region prior to detecting the first user input (e.g., from FIG. 6N to FIG. 6P, media grid region 646b expands to occupy a larger display area) (e.g., expanding the media collection region from a first size to a second size that is greater than the first size; and/or expanding the media collection region from a first area to a second area that is greater than the first area) (and, optionally, displaying shrinking of the animated media representation to occupy a smaller display area of the one or more display generation components; and/or ceasing display of the animated media representation). In some embodiments, displaying expansion of the media collection region (e.g., 646b) includes displaying a third representation (e.g., 646b-9) representative of a third media item different from the first media item and the second media item and that was not displayed prior to detecting the first user input (e.g., 647d) (e.g., the third representation is displayed in response to detecting the first user input and in accordance with a determination that the first user input includes movement in the second direction). In some embodiments, displaying the third representation comprises displaying the third representation while maintaining display of the first representation (e.g., 646b-1) and the second representation (e.g., 646b-2).

In some embodiments, in accordance with the determination that first user input includes movement in the first direction (e.g., user input 647f), the computer system displays expansion of the animated media representation (e.g., 646a) without displaying expansion of the media collection region (e.g., 646b). In some embodiments, in accordance with the determination that the first user input includes movement in the second direction (e.g., user input 647d), the computer system displays expansion of the media collection region (e.g., 646b) without displaying expansion of the animated media representation (e.g., 646a). In some embodiments, sequentially displaying different media items over time includes displaying a first media item at a first time; displaying a second media item at second time subsequent to the first time; and ceasing display of the first media item at a third time subsequent to the first time (e.g., a third time that is the same as the second time or different from the second time). In some embodiments, sequentially displaying different media items over time includes displaying a first set of one or more media items, and ceasing display of at least some of the first set of one or more media items as additional and/or different media items are displayed. Allowing a user to view expanded versions of the animated media representation or the media collection region based on the direction of the first user input allows the user to explore a collection of media items in different presentation formats with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the first user input: in accordance with the determination that the first user input includes movement in the first direction (e.g., user input 647f), the computer system displays, via the one or more display generation components, movement of the first representation (e.g., 646b-1) representative of the first media item and the second representation (e.g., 646b-1) representative of the second media item in the first direction (e.g., displays scrolling of representations 646b-1 through 646b-5 downward) (e.g., displaying an animation of movement of the representations of the at least some of the first plurality of media items of the first media collection in the first direction). Allowing a user to view expanded versions of the animated media representation or the media collection region based on the direction of the first user input allows the user to explore a collection of media items in different presentation formats with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the first user input: in accordance with the determination that the first user input includes movement in the first direction (e.g., user input 647), the computer system ceases to display the first representation (e.g., 646b-1) representative of the first media item (e.g., FIG. 6O). In some embodiments, the computer system also ceases to display the second representation (e.g., 646b-2) representative of the second media item. In some embodiments, the computer system ceases to display the media collection region (e.g., 646b) (e.g., FIG. 6O) and/or representations of at least some of the first plurality of media items of the first media collection. Hiding the media collection region when the first user input includes movement in the first direction enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying expansion of the media collection region (e.g., 646b) to occupy the greater display area includes displaying movement of the first representation (e.g., 646b-1) representative of the first media item and the second representation (e.g., 646b-2) representative of the second media item in the second direction (e.g., displaying an animation of movement of the representations of the at least some of the first plurality of media items of the first media collection in the second direction) (e.g., from FIG. 6N to FIG. 6P, representations 646b-1 through 646b-5 are moved up). In some embodiments, displaying expansion of the media collection further includes displaying an animation of movement of a representation of a media item that was not previously displayed in the media collection region in the second direction (e.g., thumbnails 646b-6 through 646b-13). Displaying movement of the representations of media items in the media collection region in the second direction enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying expansion of the media collection region (e.g., 646b) to occupy the greater display area includes displaying a third representation (e.g., 646b-6, 646b-7, 646b-8, 646b-9, 646b-10, and/or 646b-11) representative of a third media item, wherein the third representation representative of the third media item is not displayed in the media collection region prior to detecting the first user input (e.g., FIG. 6N). In some embodiments, displaying expansion of the media collection region (e.g., 646b) to occupy the greater display area includes displaying a fourth representation (e.g., 646b-6, 646b-7, 646b-8, 646b-9, 646b-10, and/or 646b-11) representative of a fourth media item, wherein the fourth representation representative of the fourth media item is not displayed in the media collection region prior to detecting the first user input. Displaying additional media items in the media collection region in response to user input allows the user to explore a collection of media with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying expansion of the animated media representation (e.g., 646a expanding to 648) to occupy a greater display area comprises displaying an expanded animated media representation (e.g., 648) (e.g., replacing display of the animated media representation with the expanded animated media representation; and/or ceasing display of the animated media representation and displaying the expanded animated media representation). In some embodiments, the expanded animated media representation (e.g., 648) corresponds to a third plurality of media items selected from the first media collection. In some embodiments, the third plurality of media items includes the second plurality of media items and one or more additional content items that are not in the second plurality of media items. In some embodiments, displaying the expanded animated media representation (e.g., 648) includes sequentially displaying different media items in the third plurality of media items over time (e.g., a representation of a collection of media items that includes visual movement and/or changing visuals over time) (e.g., displaying a video and/or slideshow that sequentially displays representations of different media items from the third plurality of media items over time). In some embodiments, sequentially displaying different media items over time includes displaying a first media item at a first time; displaying a second media item at second time subsequent to the first time; and ceasing display of the first media item at a third time subsequent to the first time (e.g., a third time that is the same as the second time or different from the second time). In some embodiments, sequentially displaying different media items over time includes displaying a first set of one or more media items, and ceasing display of at least some of the first set of one or more media items as additional and/or different media items are displayed. In some embodiments, the expanded animated media representation (e.g., 648) includes additional media items that are not included in the animated media representation (e.g., 646a). Adding additional media items to the animated media representation when the user interacts with the animated media representation (e.g., to expand it to the expanded media representation) allows a user to view additional content when the user indicates an interest in viewing the content without expending unnecessary resources when the user does not indicate an interest in viewing the content. Furthermore, doing so also enhances the operability of the system and makes the user-system interface more efficient (e.g., by preventing erroneous inputs and helping the user to improves the battery life of the device by enabling the user to use the system more quickly and

In some embodiments, the animated collection representation (e.g., 646a) (e.g., prior to expansion and/or prior to the first user input) includes a first set of transition animations (e.g., cut, jump cut, wipe, fade in/out, mosaic, blur, dissolve, and/or gradient wipe) between media items. In some embodiments, displaying expansion of the animated media representation (e.g., 646a) to occupy a greater display area comprises displaying an expanded animated media representation (e.g., 648) (e.g., replacing display of the animated media representation with the expanded animated media representation; and/or ceasing display of the animated media representation and displaying the expanded animated media representation). In some embodiments, the expanded animated media representation (e.g., 648) includes a second set of transition animations between media items (e.g., cut, jump cut, wipe, fade in/out, mosaic, blur, dissolve, gradient wipe, spin, and/or zoom in/out) different from the first set of transition animations. In some embodiments, the second set of transition animations includes more complex and/or more resource-intensive transition animations than the first set of transition animations. In some embodiments, the second set of transition animations includes more different types of transitions animations than the first set of transition animations. For example, in some embodiments, the second set of transition animations includes a mosaic transition, a blur transition, a dissolve transition, a zoom in transition, and/or a zoom out transition that is not included in the first set of transition animations. Adding in different types of transitions animations when the user interacts with the animated media representation (e.g., to expand it to the expanded media representation) allows a user to view higher-quality and/or more resource-intensive content when the user indicates an interest in viewing the content without expending unnecessary resources when the user does not indicate an interest in viewing the content. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the media collection region (e.g., 646b) (e.g., prior to or after expansion of the media collection region in response to the first user input), the computer system detects, via the one or more input devices, a first set of user inputs (e.g., 654 and/or 658b) (e.g., one or more user inputs) (e.g., a touch input, a touchscreen input, a swipe input, a tap input, a gesture, an air gesture, and/or a mechanical input (e.g., via one or more physical buttons and/or physically rotatable input mechanisms)) (e.g., a first set of user inputs that includes one or more user inputs corresponding to selection of a curation level (e.g., small, medium, large, and/or all media items)). In response to detecting the first set of user inputs (e.g., 654 and/or 658b), the computer system modifies (e.g., increasing or decreasing) the number of media items in the first media collection (e.g., from a first number of media items to a second number of media items different from the first number of media items). Allowing a user to switch a degree of curation of a media collection allows the user to adjust the amount of information displayed on the display to a desired level. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the first set of user inputs (e.g., 654 and/or 658b) (e.g., in some embodiments, in response to modifying the number of media items in the first media collection), the computer system modifies (e.g., increasing or decreasing) a number of media items included in the animated media representation (e.g., 646a) (e.g., from a first number of media items to a second number of media items different from the first number of media items) (e.g., in some embodiments, modifying the animated media representation to include a second number of media items whereas it previously included a first number of media items prior to detecting the first set of user inputs). In some embodiments, media items included in the animated media representation (e.g., 646a) are displayed sequentially over time as the animated media representation plays. Modifying the number of media items included in the animated media representation includes decreasing or increasing the number of media items that are displayed sequentially over time as the animated media representation plays. Allowing a user to switch a degree of curation of a media collection allows the user to adjust the amount of information displayed on the display to a desired level. Furthermore, allowing the user to switch a degree of curation of a media collection enhances the operability of the system and makes the user-system interface more efficient (e.g., by preventing erroneous inputs and helping the user to improves the battery life of the device by enabling the user to use the system more quickly and

In some embodiments, displaying the media collection region (e.g., 646b) includes displaying representations of a first number of media items within the media collection region. In some embodiments, in response to detecting the first set of user inputs (e.g., 654 and/or 658b), the computer system displays representations of a second number of media items within the media collection region different from the first number of media items (e.g., from FIG. 6P to FIG. 6R, the number of media items displayed within media grid region 646b changes). Allowing a user to switch a degree of curation of a media collection allows the user to adjust the amount of information displayed on the display to a desired level. Furthermore, allowing the user to switch a degree of curation of a media collection enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system detects, via the one or more input devices, a selection input (e.g., 654) (e.g., a touch input, a touchscreen input, a swipe input, a tap input, a gesture, an air gesture, and/or a mechanical input (e.g., via one or more physical buttons and/or physically rotatable input mechanisms)) corresponding to selection of a theme selection affordance (e.g., 652). In response to detecting the selection input (e.g., 654) corresponding to selection of the theme selection affordance, the computer system displays, via the one or more display generation components, a first theme option (e.g., 656a and/or 656b) that, when selected (e.g., in response to a computer system detecting a selection input), causes the computer system to generate a first themed animated media representation corresponding to the first theme option (e.g., to generate a first theme animated media representation corresponding to the first theme option that plays different media items over time). In some embodiments, generating the first themed animated media representation includes generating a new animated media representation that was not included in the media library prior to detecting the third user input. Providing an option to select a theme for generating an animated media representation allows a user to generate a new animated media representation based on the theme desired by the user with fewer inputs. Furthermore, doing so also enhances the operability of the system and makes the user-system interface more efficient (e.g., by preventing erroneous inputs and helping the user to improves the battery life of the device by enabling the user to use the system more quickly and

In some embodiments, the first theme option (e.g., 656a and/or 656b) is determined based on content in the first media collection (e.g., based on content depicted in media items in the first media collection and/or based on identified objects, places, and/or themes in media items of the first media collection). Providing an option to select a theme for generating an animated media representation allows a user to generate a new animated media representation based on the theme desired by the user with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first theme option (e.g., 656a and/or 656b), the computer system detects, via the one or more input devices, a selection input (e.g., 658a) (e.g., a touch input, a touchscreen input, a swipe input, a gesture, an air gesture, and/or a mechanical input (e.g., via one or more physical buttons and/or physically rotatable input mechanisms)) corresponding to selection of the first theme option. In response to detecting the selection input (e.g., 658a) corresponding to selection of the first theme option, the computer system generates a second animated media representation that corresponds to a third plurality of media items and displays different media items in the third plurality of media items over time (e.g., a representation of a collection of media items that includes visual movement and/or changing visuals over time) (e.g., displaying a video and/or slideshow that sequentially displays representations of different media items from the third plurality of media items over time), wherein the third plurality of media items is selected from the first plurality of media items based on the first theme option (e.g., based on the third plurality of media items satisfying theme criteria and/or based on the third plurality of media items being determined to correspond to the first theme option) (e.g., a new animated media representation, such as 646a, but using the media items shown in FIG. 6S that correspond to the selected theme option). In some embodiments, the third plurality of media items is different from the first plurality of media items. In some embodiments, the third plurality of media items is a subset of the first plurality of media items and includes fewer media items than the first plurality of media items. In some embodiments, the third plurality of media items includes a first subset of the first plurality of media items that correspond to the first theme option (e.g., FIG. 6S), and excludes a second subset of the first plurality of media items that do not correspond to the first theme option. In some embodiments, generating the second animated media representation comprises displaying the second animated media representation. In some embodiments, displaying the second animated media representation includes displaying different media items in the third plurality of media items over time. Providing an option to select a theme for generating an animated media representation allows a user to generate a new animated media representation based on the theme desired by the user with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, a media collection navigation user interface (e.g., 610) that is different from the first representation of the first media collection (e.g., 642), wherein the media collection navigation user interface includes a first animated collection representation (e.g., 636a) that corresponds to the first media collection and the animated media representation (e.g., 646a). In some embodiments, the media collection navigation user interface (e.g., 610) includes representations of suggested collections of media items (e.g., Features, and/or Cities) and/or representations of pre-existing collections of media items that are selected based on one or more of trips, pets, recent events, places, search terms, albums). In some embodiments, the first animated collection representation (e.g., 636a) sequentially displays a plurality of media items selected from the first media collection over time (e.g., in a video and/or a slideshow). In some embodiments, the first animated collection representation (e.g., 636a) is the same as the animated media representation (e.g., 646a). In some embodiments, the first animated collection representation (e.g., 636a) is different from the animated media representation (e.g., 646a). In some embodiments, the first animated media representation (e.g., 636a) is a condensed version of the animated media representation (e.g., 646a) (e.g., includes fewer media items than the animated media representation). Providing a media collection navigation user interface allows a user to navigate through media items with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first animated collection representation (e.g., 636a) within the media collection navigation user interface (e.g., 610), the computer system detects, via the one or more input devices, a navigation input (e.g., 640c) (e.g., one or more user inputs) (e.g., a touch input, a touchscreen input, a swipe input, a tap input, a gesture, an air gesture, and/or a mechanical input (e.g., via one or more physical buttons and/or physically rotatable input mechanisms)). In response to detecting the navigation input (e.g., 640c), the computer system displays navigation from (e.g., scrolling through) the first animated collection representation (e.g., 636a) that corresponds to the first media collection to a second animated collection representation (e.g., 664) that is different from the first animated collection representation and corresponds to a second media collection different from the first media collection. In some embodiments, the second animated collection representation (e.g., 664) sequentially displays a plurality of media items selected from the second media collection over time (e.g., in a video and/or a slideshow). Providing a media collection navigation user interface allows a user to navigate through media items with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying expansion of the animated media representation (e.g., 646a) includes transitioning from displaying the animated media representation (e.g., 646a) to displaying an expanded animated media representation (e.g., 648) (e.g., an expanded animated media representation that occupies a greater display area than the animated media representation). In some embodiments, the expanded media representation (e.g., 648) includes a different set of media items (e.g., more media items) than the animated media representation (e.g., 646a). In some embodiments, the expanded media representation (e.g., 648) includes a different set of transition animations (e.g., more or different transition animations) than the animated media representation (e.g., 646a). In some embodiments, the first animated collection representation (e.g., 636a) includes a first set of media items selected from the first media collection; and the expanded animated media representation (e.g., 648) includes a second set of media items that includes the first set of media items and one or more additional media items from the first media collection that are not included in the first set of media items. In some embodiments, the expanded animated media representation (e.g., 648) includes additional media items that are not in the first respective animated collection representation (e.g., 636a). Displaying more media items in the expanded animated media representation allows a user to view more media items when the user expresses an interest in viewing media items (e.g., via user input), and allows the computer system to conserve resources when the user does not express an interest in viewing the media items. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 800 (e.g., FIGS. 8A-8B) are also applicable in an analogous manner to the methods described above and/or below. For example, method 700, method 1000, method 1100, method 1300, method 1400, method 1600, and/or method 1800 optionally include one or more of the characteristics of the various methods described above with reference to method 800. For example, the media library in method 700 is the media library in method 800, method 1300, method 1400, method 1600, and/or method 1800; and/or the queries recited in method 1000 and/or method 1100 are queries within the media library recited in method 700, method 800, method 1300, method 1400, method 1600, and/or method 1800. For brevity, these details are not repeated below.

FIGS. 9A-9Z illustrate exemplary user interfaces for navigating, displaying, and/or presenting content, in accordance with some embodiments. The user interfaces in these figures are used to illustrate the processes described below, including the processes in FIG. 10 and FIG. 11.

FIG. 9A illustrates computer system 600, which is a smart phone with touch-sensitive display 602 and buttons 604a-604c. Although the depicted embodiments show an example in which computer system 600 is a smart phone, in other embodiments, computer system 600 is a different type of computer system (e.g., a tablet, a laptop computer, a desktop computer, a wearable device, and/or a headset). At FIG. 9A, computer system 600 displays search user interface 688 within region 612a of user interface 610, described above with reference to FIGS. 6A-1-6AJ. Search user interface 688 includes search bar 690. Search user interface 688 also includes query recommendation 692a and sample query results 692b. In some embodiments, query recommendation 692a is an example query recommendation that is presented by computer system 600 to, for example, provide the user with an example of a query that the user can enter to search through a media library. Sample query results 692b present representations of one or more media items of the media library that are responsive to query recommendation 690. In some embodiments, query recommendation 692a automatically changes over time to display different query recommendations, and sample query results 692b also change over time based on the changing query recommendations. These features are described in greater detail below with reference to FIGS. 9B through 9H. At FIG. 9A, computer system 600 detects user input 690 (e.g., a selection input and/or a tap input) corresponding to selection of search bar 690.

At FIG. 9B, in response to user input 690, computer system 600 ceases display of user interface 610, and displays search user interface 902. In some embodiments, replacing display of user interface 610 with search user interface 902 includes ceasing display of one or more regions 612b-612f of user interface 610, and displaying keyboard 906. Search user interface 902 includes search field 904, keyboard 906, microphone option 905, and done button 908. Search field 904, when selected (e.g., in response to a computer system detecting a selection input), causes the computer system to display a cursor within search field 904 and/or allow for a user to enter search terms (e.g., via keyboard 906 and/or via spoken input). Microphone option 905, when selected (e.g., in response to a computer system detecting a selection input), causes the computer system to activate a microphone and/or initiate spoken input for a user to speak search terms to be entered into search field 904. In some embodiments, done option 908, when selected (e.g., in response to a computer system detecting a selection input), causes the computer system to initiate a search query based on search terms entered into search field 904. In some embodiments, done option 908, when selected (e.g., in response to a computer system detecting a selection input), causes the computer system to cease display of user interface 902 and re-display user interface 610 (e.g., return to the state shown in FIG. 9A). In some embodiments, a user initiates a search query by selecting a “RETURN” key in keyboard 906. In some embodiments, a search is automatically performed as the user enters terms into search field 904 without additional user input.

As discussed above, in some embodiments, search user interface 688 and/or search user interface 902 automatically displays one or more query recommendations 692a to provide the user with examples of search queries that the user can enter and/or request. In FIG. 9B, computer system 600 automatically displays (e.g., without user input), query recommendation 692a that displays the terms “COFFEE WITH JEN.” In FIG. 9B, computer system 600 automatically displays (e.g., without user input), sample query results 692b, which includes representations of various media items from the media library that are responsive to the query recommendation “COFFEE WITH JEN.”

At FIG. 9C, computer system 600 automatically animates a transition from a first query recommendation to a second query recommendation. At FIG. 9C, computer system 600 ceases display of the terms “COFFEE WITH JEN,” and instead displays the word “HOLIDAYS” within query recommendation 692a. At FIG. 9C, computer system 600 also ceases display of representations of media items that were responsive to the “COFFEE WITH JEN” query, and displays representations of media items that are responsive to the query recommendation “HOLIDAYS.” At FIG. 9C-1, computer system 600 continues to animate sample query results 692b to include representations of additional media items that are responsive to the query recommendation “HOLIDAYS.”

At FIG. 9D, computer system 600 automatically animates query recommendation 692a to add additional terms, such that query recommendation 692a now displays “HOLIDAYS IN CHICAGO.” In FIG. 9D, based on the addition of additional search terms to query recommendation 692a, computer system 600 updates sample query results 692b to remove media items that are no longer responsive to the query recommendation 692a, while maintaining display of media items that are still responsive to query recommendation 692a. At FIG. 9D, computer system 600 also updates sample query results 692b to display representations of additional media items that are responsive to query recommendation 692a.

At FIG. 9E, computer system 600 automatically animates query recommendation 692a to further add additional terms, such that query recommendation 692a now displays “HOLIDAYS IN CHICAGO WITH FAMILY.” In FIG. 9E, based on the addition of additional search terms to query recommendation 692a, computer system 600 updates sample query results 692b to remove media items that are no longer responsive to the query recommendation 692a, while maintaining display of media items that are still responsive to query recommendation 692a. At FIG. 9E, computer system 600 also updates sample query results 692b to display representations of additional media items that are responsive to query recommendation 692a.

At FIG. 9F, computer system 600 automatically animates a transition from a second query recommendation to a third query recommendation. At FIG. 9F, computer system 600 ceases display of the terms “HOLIDAYS IN CHICAGO WITH FAMILY,” and instead displays the word “BAXTER” within query recommendation 692a. At FIG. 9F, computer system 600 also ceases display of representations of media items that were responsive to the “HOLIDAYS IN CHICAGO WITH FAMILY” query, and displays representations of media items that are responsive to the query recommendation “BAXTER.” At FIG. 9F-1, computer system 600 continues to animate sample query results 692b to include representations of additional media items that are responsive to the query recommendation “BAXTER.”

At FIG. 9G, computer system 600 automatically animates query recommendation 692a to add additional terms, such that query recommendation 692a now displays “BAXTER WITH MORTY.” In FIG. 9G, based on the addition of additional search terms to query recommendation 692a, computer system 600 updates sample query results 692b to remove media items that are no longer responsive to the query recommendation 692a, while maintaining display of media items that are still responsive to query recommendation 692a. At FIG. 9G, computer system 600 also updates sample query results 692b to display representations of additional media items that are responsive to query recommendation 692a. At FIG. 9H, computer system 600 further animates sample query results 692b to include representations of additional media items that are responsive to the query recommendation 692a. While the animation of query recommendation 692a and sample query results 692b has been depicted and described within the context of search user interface 902, in some embodiments, similar and/or the same animations are presented with search user interface 688.

At FIG. 9H, computer system 600 detects user input 910 (e.g., a selection input and/or a tap input) corresponding to selection of query recommendation 692a (e.g., “BAXTER WITH MORTY”).

At FIG. 9I, in response to user input 910, computer system 600 ceases display of search user interface 902, and displays results user interface 912. Results user interface 912 includes three regions 916a, 916b, 916c (shown in FIG. 9J). Region 916a is a collections region, that includes one or more media collections that are responsive to the search query. In FIG. 9I, region 916a includes collection representation 916a-1 that is representative of a first media collection, and collection representation 916a-2 that is representative of a second media collection. Region 916a also includes option 916a-3 that, when selected (e.g., in response to a computer system detecting a selection input), causes the computer system to display additional collections that are responsive to the search query but are not shown in results user interface 912. In some embodiments, collection representation 916a-1, when selected (e.g., in response to a computer system detecting a selection input), causes the computer system to display a user interface that corresponds to the corresponding media collection (e.g., user interface 642 of FIG. 6N, but corresponding to the BAXTER WITH MORTY media collection rather than the TRIP TO SYDNEY media collection). In some embodiments, collection representation 916a-2, when selected (e.g., in response to a computer system detecting a selection input), causes the computer system to display a user interface that corresponds to its corresponding media collection.

Region 916b is a top results region, and includes thumbnails and/or representations of one or more media items that are responsive to the query and satisfy one or more priority criteria (e.g., one or more priority criteria indicating that the media items are particularly responsive to the query and/or depict content that may be of particular interest to the user). Region 916c, which is visible in FIG. 9J, includes thumbnails and/or representations of all media items in the media library that are responsive to the search query shown in search field 904.

At FIG. 9I, computer system 600 detects user input 918, which includes one or more user inputs via keyboard 906 to enter additional search terms into search field 904. At FIG. 9J, in response to user input 918, computer system 600 displays the additional search term “IN 2023” within search field 904. Additionally, in response to user input 918, computer system 600 updates display of regions 916a, 916b, 916c to further filter and/or limit search results based on the additional search terms. At FIG. 9J, computer system 600 detects user input 919 (e.g., a selection input and/or a tap input) corresponding to selection of option 914.

At FIG. 9K, in response to user input 919, computer system 600 clears search field 904, ceases display of results user interface 912, and re-displays search user interface 902. At FIG. 9K, computer system 600 detects user input 920, which includes one or more user inputs via keyboard 906 to enter search terms into search field 904. At FIG. 9L, in response to user input 920, computer system 600 displays the search term “APRIL” within search field 904, and displays results user interface 912.

In FIG. 9L, computer system 600 determines that the search term “April” has multiple possible meanings. For example, the term April could be the first name of a contact that is stored in computer system 600, or the term April could stand for the month. In FIG. 9L, results user interface 912 includes search results that correspond to both meanings (e.g., collection 916a-5 corresponding to the person named April, and collection 916a-6 corresponding to the month April). Furthermore, based on the determination that the term “April” has multiple possible meanings, computer system 600 displays disambiguation user interface 922, which prompts the user to clarify the meaning of the term April. Disambiguation user interface 922 includes option 922a and option 922b. In some embodiments, option 922a, when selected (e.g., in response to a computer system detecting a selection input), causes the computer system to store information indicating that April means the name of a person and/or assign the term “April” with a meaning consistent with the user's selection. In some embodiments, option 922b, when selected (e.g., in response to a computer system detecting a selection input), causes the computer system to store information indicating that the term April means the month and/or assign the term “April” with a meaning consistent with the user's selection. Option 922a is displayed with an icon of a person to indicate that it corresponds to one or more people, and is also displayed with the number “25” to indicate that there are 25 search results that match this meaning. Option 922b is displayed with an icon of a calendar to indicate that it corresponds to a date and/or month, and is also displayed with the number “343” to indicate that there are 343 search results that match this meaning. At FIG. 9L, computer system 600 detects user input 924 (e.g., a selection input and/or a tap input) corresponding to selection of option 922a.

At FIG. 9M, in response to user input 924, computer system 600 ceases display of disambiguation user interface 922, and also updates the search results shown in results user interface 912 such that search results that are not responsive to the selected meaning of the term “April” are removed, while search results that are responsive to the selected meaning of the term “April” are maintained. For example, collections region 916a is updated to remove collection 916a-6 while collection 916a-5 is maintained. Similarly, top results region 916b is updated to remove representations of media items that correspond to the month April and not the person April, while maintaining representations of media items that correspond to the person April. At FIG. 9M, computer system 600 displays suggestions user interface 925. Suggestions user interface 925 provides the user with options 925a-925c for additional search terms and/or additional search filters to further limit the search results. In FIG. 9M, suggestions user interface 925 includes: option 925a, option 925b, and option 925c. Option 925a corresponds to the location Santa Cruz and, when selected (e.g., in response to a computer system detecting a selection input), causes the computer system to limit the search results to media items captured in and/or corresponding to Santa Cruz. Option 926b corresponds to a person Marie B. and, when selected (e.g., in response to a computer system detecting a selection input), causes the computer system to limit the search results to media items that depict and/or correspond to Marie B. Option 925c corresponds to the year 2022 and, when selected (e.g., in response to a computer system detecting a selection input), causes the computer system to limit the search results to media items that were captured in 2022 or otherwise correspond to the year 2022. Option 925a is displayed with the number 25 to indicate that there are 25 search results that are responsive to the search terms “APRIL” and “SANTA CRUZ.” Option 925b is displayed with the number 5 to indicate that there are 5 search results that are responsive to the search terms “APRIL” and “MARIE B.” Option 925c is displayed with the number 37 to indicate that there are 37 search results that are responsive to the search terms “APRIL” and “2022.” At FIG. 9M, computer system 600 detects user input 927 (e.g., a selection input and/or a tap input) corresponding to selection of option 925a.

At FIG. 9N, in response to user input 927, computer system 600 adds the term “SANTA CRUZ” to search field 904, and also updates the search results shown in results user interface 912 such that search results that are not responsive to the additional search terms “Santa Cruz” are removed, while search results that are responsive to the additional search terms “Santa Cruz” (e.g., as well as the original search term “April”) are maintained. At FIG. 9N, computer system 600 detects user input 928 (e.g., a selection input and/or a tap input) corresponding to selection of search term 926a (e.g., “April”).

At FIG. 9O, in response to user input 928, computer system 600 re-displays disambiguation user interface 922 corresponding to the term “April.” In this way, a user can select a term to display a disambiguation user interface for the term and change the selected meaning for the term and/or select a meaning for the term. At FIG. 9O, computer system 600 detects user input 932 (e.g., a selection input and/or a tap input) corresponding to selection of a backspace and/or delete key in keyboard 906.

At FIG. 9P in response to user input 932, computer system 600 deletes the term “Santa Cruz” and ceases to display the term within search field 904. Furthermore, in response to user input 932, computer system 600 updates the query results shown in results user interface 912 to include all media items that are responsive to the term “April” without the filter of the additional term “Santa Cruz” (e.g., returning results user interface 912 to the state that was shown and described above in FIG. 9M). At FIG. 9P, computer system 600 detects user input 934, which is one or more user inputs via keyboard 906 to enter the additional search terms “with Grandma.”

At FIG. 9Q, in response to user input 934, computer system 600 displays the additional search terms “with Grandma” within search field 904. At FIG. 9Q, based on a determination that the term “Grandma” has multiple potential meanings (e.g., the term “Grandma” could refer to multiple different people), computer system 600 displays disambiguation user interface 936. Disambiguation user interface 936 asks the users to identify the person the user is referring to with the term “Grandma.” At FIG. 9Q, computer system 600 detects user input 938 corresponding to selection of disambiguation user interface 936.

At FIG. 9R, in response to user input 938, computer system 600 displays user interface 940. User interface 940 includes face region 942a that includes thumbnails of a plurality of faces. In the depicted embodiment, a user is able to select a respective thumbnail to identify the person to be associated with the term “Grandma.” User interface 940 also includes contacts region 942a that includes a plurality of contact options. A user is able to select a respective contact option to identify the person to be associated with the term “Grandma.”

In some embodiments, different search terms result in different disambiguation user interfaces. In FIG. 9S, the user has entered the search terms “Wedding Anniversary.” In response to the user entering the search terms “Wedding Anniversary,” computer system 600 displays disambiguation user interface 936, which includes option 946a that when selected (e.g., in response to a computer system detecting a selection input), causes the computer system to initiate a process for identifying and/or receiving a date that corresponds to the search terms “Wedding Anniversary.” In some embodiments, computer system 600 stores the meaning of the term “anniversary” differently based on the other words that accompany it. For example, computer system 600 stores a first date for the search terms “wedding anniversary” and a second, different date for the search terms “work anniversary.” At FIG. 9S, computer system 600 detects user input 951a (e.g., a selection input and/or a tap input) corresponding to selection of option 946a. In some embodiments, in response to user input 951a, computer system 600 displays a date picker user interface that includes one or more selectable options and/or fields for a user to enter date information (e.g., month, date, and/or year).

In FIG. 9T, the user has entered the search term “Home.” In response to the user entering the search term “Home,” computer system 600 displays disambiguation user interface 948, which includes option 948a that, when selected (e.g., in response to a computer system detecting a selection input), causes the computer system to initiate a process for identifying and/or receiving an address that corresponds to the search term “Home.” At FIG. 9T, computer system 600 detects user input 951b (e.g., a selection input and/or a tap input) corresponding to selection of option 948a. In some embodiments, in response to user input 951b, computer system 600 displays an address user interface and/or a map that includes one or more selectable options and/or fields for a user to enter address information (e.g., street address, city, state, country, and/or zip code).

In FIG. 9U, the user has entered the search terms “During my vacation rental.” In response to the user entering these search terms, computer system 600 displays disambiguation user interface 950, which includes option 950a that, when selected (e.g., in response to a computer system detecting a selection input), causes the computer system to initiate a process for identifying and/or receiving a date range for the user's vacation rental. At FIG. 9U, computer system 600 detects user input 951c (e.g., a selection input and/or a tap input) corresponding to selection of option 950a. In some embodiments, in response to user input 951c, computer system 600 displays a date picker user interface that includes one or more selectable options and/or fields for a user to enter date information (e.g., month, date, and/or year).

In FIG. 9V, the user has entered the search terms “At my vacation rental.” Although the terms are similar to those entered in FIG. 9U, computer system 600 treats the terms differently based on the search terms in FIG. 9U including the word “during” and the search terms in FIG. 9V including the word “at.” In FIG. 9V, in response to the user entering the search terms “at my vacation rental,” computer system 600 displays disambiguation user interface 952, which includes option 952a that, when selected (e.g., in response to a computer system detecting a selection input), causes the computer system to initiate a process for identifying and/or receiving an address of the user's vacation rental. At FIG. 9V, computer system 600 detects user input 951d (e.g., a selection input and/or a tap input) corresponding to selection of option 952a. In some embodiments, in response to user input 951d, computer system 600 displays an address user interface and/or a map that includes one or more selectable options and/or fields for a user to enter address information (e.g., street address, city, state, country, and/or zip code).

FIGS. 9W-9Z depict an example feature in which computer system 600 performs a search within a limited subset of media items of a media library. In FIG. 9W, computer system 600 displays media collection user interface 954. Media collection user interface 954 corresponds to a collection of media items that depict a person named Emily (e.g., a media collection user interface similar to user interface 642 described with reference to FIG. 6N). Media collection user interface 954 includes animated media collection representation 956a (e.g., a video and/or slideshow of media items depicting Emily), and a grid region 956b that includes thumbnails of media items depicting Emily. Media collection user interface 954 includes search option 958a. At FIG. 9W, computer system 600 detects user input 960 (e.g., a selection input and/or a tap input) corresponding to selection of search option 958a.

At FIG. 9X, in response to user input 960, computer system 600 displays keyboard 964 and search field 962. At FIG. 9X, computer system 600 detects user input 966, which includes one or more user inputs via keyboard 964 to enter the search term “April.” At FIG. 9Y, in response to user input 966, computer system 600 displays the term “April” within search field 962 (e.g., search term 974b). However, because computer system 600 received this search query while displaying media collection user interface 954 (which corresponds to a media collection that is a subset of media items in a media library that depict a person named Emily), computer system 600 limited the search to media items within the Emily media collection, and also automatically displays the term “Emily” within search field 962 (e.g., search term 974a). Search term 974a is displayed with a corresponding option 974a-1 that, when selected (e.g., in response to a computer system detecting a selection input), causes the computer system to remove search term 974a from the search query. Search term 974b is displayed with a corresponding option 974b-1 that, when selected (e.g., in response to a computer system detecting a selection input), causes the computer system to remove search term 974b from the search query. In FIG. 9Y, in response to user input 966, computer system 600 displays results user interface 968, which displays results 970 of media items within the Emily media collection that match the term “April.” Results user interface 968 also includes option 972a, which, when selected (e.g., in response to a computer system detecting a selection input), causes the computer system to perform the entered search query (e.g., the search term “April”), but within the entire media library, rather than solely within the Emily media collection. FIG. 9Y depicts two example scenarios. In a first scenario, computer system detects user input 978a (e.g., a selection input and/or a tap input) corresponding to selection of option 972a. In a second scenario, computer system detects user input 978b (e.g., a selection input and/or a tap input) corresponding to selection of option 974a-1. In the depicted embodiment, these two user inputs yield the same result. User input 978a causes the search on the search term “April” to be performed within the entire media library, and user input 978b also causes the search on the search term “April” to be performed within the entire media library (e.g., by removing the automatically added search term “Emily”). At FIG. 9Z, in response to user input 978a and/or user input 978b, computer system 600 displays results user interface 912, which displays search results for the search term “April” within the entire media library (e.g., as was described above with reference to FIG. 9L).

FIG. 10 is a flow diagram illustrating a method for navigating, displaying, and/or presenting content using a computer system in accordance with some embodiments. Method 1000 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) (and, optionally, one or more input devices (e.g., a touch-sensitive surface, a touch-sensitive display, a button, a rotatable input mechanism, a depressible and rotatable input mechanism, a camera, an accelerometer, and/or an inertial measurement unit (IMU))). Some operations in method 1000 are, optionally, combined, the orders of some operations are, optionally, changed, and some operations are, optionally, omitted.

As described below, method 1000 provides an intuitive way for navigating, displaying, and/or presenting content. The method reduces the cognitive burden on a user for navigating and/or accessing content, thereby creating a more efficient human-machine interface. For battery-operated computing devices, enabling a user to navigate and/or access content faster and more efficiently conserves power and increases the time between battery charges.

The computer system (e.g., 600) displays (1002), via the one or more display generation components (e.g., 602), a search user interface (e.g., 688 and/or 902). The computer system displays (1004), within the search user interface (e.g., 688 and/or 902), a representation of a first query (e.g., 692a in FIG. 9B) (e.g., a representation of the first query that includes one or more search terms of the first query) and a representation of a first set of content (e.g., 692b in FIG. 9B) (e.g., from a set of content such as a media library (e.g., a media library associated with the computer system; a media library associated with a user (e.g., a user of the computer system); and/or a media library associated with a user account)) (e.g., a set of media items (e.g., images, photos, and/or videos)) that is responsive to the first query (e.g., a text query, an audio query, and/or a spoken query). In some embodiments, the representation of the first query is displayed concurrently with the representation of the first set of content. In some embodiments, the representation of the first query is displayed before the representation of the first set of content is displayed.

After displaying the representation of the first query (e.g., 692a in FIG. 9B) and the representation of the first set of content (e.g., 692b in FIG. 9B) (1006): the computer system automatically (e.g., without user input) (e.g., after a threshold duration of time (e.g., after displaying the representation of the first query and/or the representation of the first set of content for 1 second, 2 seconds, 3 seconds, 4 seconds, 5 seconds, 7 seconds, or 10 seconds)) ceases display (1008) of the representation of the first set of content that is responsive to the first query (e.g., FIG. 9C); and automatically displays (1010) a representation of a second query (e.g., 692a in FIG. 9C) (e.g., a representation of the second query that includes one or more search terms of the second query) and a representation of a second set of content (e.g., 692b in FIG. 9C) (e.g., from a set of content such as a media library (e.g., a media library associated with the computer system; a media library associated with a user (e.g., a user of the computer system); and/or a media library associated with a user account)) (e.g., a set of media items (e.g., images, photos, and/or videos)) that is responsive to the second query (e.g., a text query, an audio query, and/or a spoken query), wherein the second set of content is different from the first set of content and the second query is different from the first query. In some embodiments, the representation of the second query is displayed concurrently with the representation of the second set of content. In some embodiments, the representation of the second query is displayed before the representation of the second set of content is displayed. In some embodiments, the search user interface includes a text entry field (e.g., 904) for entering a search query. Automatically displaying a representation of a search query and related results allows the user to explore media items with fewer inputs. Furthermore, doing so also provides the user with an indication that the user is able to enter search queries to search media items, which enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the representation of the first query includes a first set of one or more terms (e.g., one or more words, one or more phrases, and/or one or more search terms) of the first query (e.g., 692a in FIG. 9B); and the representation of the second query includes a second set of one or more terms (e.g., one or more words, one or more phrases, and/or one or more search terms) of the second query (e.g., 692a in FIG. 9C). In some embodiments, the second set of one or more terms is different from the first set of one or more terms. Automatically displaying a representation of a search query and related results allows the user to explore media items with fewer inputs. Furthermore, doing so also provides the user with an indication that the user is able to enter search queries to search media items, which enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the representation of the first query (e.g., 692a) comprises: at a first time, displaying, via the one or more display generation components, a first term (e.g., a word and/or a phrase) of the first query (e.g., without displaying a second term of the first query) (e.g., 692a in FIG. 9C); and at a second time subsequent to the first time, displaying, via the one or more display generation components, a second term (e.g., a word and/or a phrase) of the first query concurrently with the first term of the first query (e.g., 692a in FIG. 9D), wherein the second term of the first query was not displayed at the first time. In some embodiments, displaying the representation of the second query comprises: at a third time (e.g., a third time subsequent to the first time and the second time and/or a third time different from the first time and the second time), displaying, via the one or more display generation components, a first term (e.g., a word and/or a phrase) of the second query (e.g., without displaying a second term of the second query) (e.g., 692a in FIG. 9F); and at a fourth time subsequent to the third time, displaying, via the one or more display generation components, a second term (e.g., a word and/or a phrase) of the second query concurrently with the first term of the second query (e.g., 692a in FIG. 9G), wherein the second term of the second query was not displayed at the third time. In some embodiments, the terms of the first query are animated and/or displayed over time. In some embodiments, as additional terms of the first query are displayed and/or animated, the representation of the first set of content (e.g., 692b) responsive to the first query is updated to reflect the additional terms that are displayed (e.g., to further filter media content based on the additional terms). In some embodiments, the terms of the second query are animated and/or displayed over time. In some embodiments, as additional terms of the second query are displayed and/or animated, the representation of the second set of content (e.g., 692b) responsive to the second query is updated to reflect the additional terms that are displayed (e.g., to further filter media content based on the additional terms). Automatically displaying a representation of a search query and related results allows the user to explore media items with fewer inputs. Furthermore, doing so also provides the user with an indication that the user is able to enter search queries to search media items, which enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the representation of the first set of content (e.g., 692b) that is responsive to the first query comprises: at a first respective time, displaying, via the one or more display generation components, a representation of a first set of one or more media items (e.g., one or more thumbnails, images, videos, and/or video frames) of the first set of content that is responsive to the first query (e.g., without displaying a second media item of the first set of content) (e.g., 692b in FIG. 9F); and at a second respective time subsequent to the first respective time, displaying, via the one or more display generation components, a representation of a second set of one or more media items (e.g., one or more thumbnails, images, videos, and/or video frames) of the first set of content that is responsive to the first query, wherein the second set of one or more media items of the first set of content is different from the first set of one or more media items of the first set of content (e.g., 692b in FIG. 9F-1). In some embodiments, the second set of one or more media items of the first set of content excludes at least a respective media item that was included in the first set of one or more media items of the first set of content where the respective media item was responsive to a first portion of the first query but was not responsive to a second portion of the first query (e.g., 692b in FIG. 9G excludes one or more media items that were included in 692b in FIG. 9F-1). In some embodiments, the second set of one or more media items of the first set of content includes at least a respective media item that was not in the first set of one or more media items of the first set of content where the respective media item is more relevant to a second portion of the first query than to a first portion of the first query (e.g., 692b in FIG. 9G includes one or more media items that were not included in 6t92b in FIG. 9F-1).

In some embodiments, displaying the representation of the second set of content that is responsive to the second query comprises: at a third respective time (e.g., a third respective time subsequent to the first respective time and the second respective time and/or a third respective time different from the first respective time and the second respective time), displaying, via the one or more display generation components, a representation of a first set of one or more media items (e.g., one or more thumbnails, images, videos, and/or video frames) of the second set of content that is responsive to the second query (e.g., without displaying a second media item of the second set of content) (e.g., 692b in FIG. 9C-1); and at a fourth respective time subsequent to the second respective time, displaying, via the one or more display generation components, a representation of a second set of one or more media items (e.g., one or more thumbnails, images, videos, and/or video frames) of the second set of content that is responsive to the second query, wherein the second set of one or more media items of the second set of content is different from the first set of one or more media items of the second set of content (e.g., 692b in FIG. 9D). In some embodiments, the second set of one or more media items of the second set of content excludes at least a respective media item that was included in the first set of one or more media items of the second set of content where the respective media item was responsive to a first portion of the second query but was not responsive to a second portion of the second query (e.g., 692b in FIG. 9D excludes one or more media items that were included in 692b in FIG. 9C-1). In some embodiments, the second set of one or more media items of the second set of content includes at least a respective media item that was not in the first set of one or more media items of the second set of content where the respective media item is more relevant to a second portion of the second query than to a first portion of the second query (e.g., 692b in FIG. 9D includes one or more media items that were not in 692b in FIG. 9C-1). In some embodiments, the representation of the first set of content is displayed and/or animated over time. In some embodiments, the representation of the second set of content is displayed and/or animated over time. In some embodiments, the terms of the first query (e.g., 692a) are animated and/or displayed over time. In some embodiments, as additional terms of the first query are displayed and/or animated, the representation of the first set of content responsive to the first query (e.g., 692b) is updated to reflect the additional terms that are displayed (e.g., to further filter media content based on the additional terms by removing content). In some embodiments, the terms of the second query (e.g., 692a) are animated and/or displayed over time. In some embodiments, as additional terms of the second query are displayed and/or animated, the representation of the second set of content responsive to the second query (e.g., 692b) is updated to reflect the additional terms that are displayed (e.g., to further filter media content based on the additional terms by removing content). Automatically displaying a representation of a search query and related results allows the user to explore media items with fewer inputs. Furthermore, doing so also provides the user with an indication that the user is able to enter search queries to search media items, which enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the search user interface (e.g., 688 and/or 902) further comprises: displaying, concurrently with the representation of the first query (e.g., 692a) and the representation of the first set of content (e.g., 692b), a search field (e.g., 904) (e.g., a text box and/or a selectable text box into which a user can manually enter search terms), wherein the search field is displayed in an empty state (e.g., without text, search terms, and/or user-entered content displayed within the search field); and displaying, concurrently with the representation of the second query and the representation of the second set of content, the search field (e.g., 904) in the empty state. In some embodiments, the search field in the empty state is maintained while the representation of the first query and the representation of the first set of content ceases to be displayed and transitions into the representation of the second query and the representation of the second set of content (e.g., FIGS. 9A through 9H). Displaying an empty search field along with the representations of the first and second queries and the representations of the first and second sets of content provides the user with an indication that the user can manually enter search terms. Furthermore, maintaining the search field in the empty state allows the user to enter search terms without being interrupted by the automatically generated example search queries, which enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the search user interface (e.g., 688 and/or 902) further comprises: after displaying the representation of the second query (e.g., 692a in FIG. 9E) and the representation of the second set of content (e.g., 692b in FIG. 9E): automatically (e.g., without user input) (e.g., after a threshold duration of time (e.g., after displaying the representation of the second query and/or the representation of the second set of content for 0.1, 0.2, 0.5, 1, 2, 3, 4, 5, 7, or 10 seconds)) ceasing display of the representation of the second set of content that is responsive to the second query (e.g., FIG. 9F); and automatically displaying a representation of a third query (e.g., 692a in FIG. 9F) (e.g., a representation of the third query that includes one or more search terms of the third query) and a representation of a third set of content (e.g., 692b in FIG. 9F) (e.g., from a set of content such as a media library (e.g., a media library associated with the computer system; a media library associated with a user (e.g., a user of the computer system); and/or a media library associated with a user account)) (e.g., a set of media items (e.g., images, photos, and/or videos)) that is responsive to the third query (e.g., a text query, an audio query, and/or a spoken query), wherein the third set of content is different from the first set of content and the second set of content and the third query is different from the first query and the second query. In some embodiments, the representation of the third query is displayed concurrently with the representation of the third set of content. In some embodiments, the representation of the third query is displayed before the representation of the third set of content is displayed. In some embodiments, displaying the search user interface (e.g., 688 and/or 902) further comprises continuously replacing, over time, a representation of a currently displayed query with a representation of a different query, and replacing display of a currently displayed representation of content that is responsive to the currently displayed query with a representation of different content that is responsive to the different (e.g., newly displayed) query. This can be done repeatedly for an arbitrary number of different queries. Automatically displaying representations of different queries and related results allows the user to explore media items with fewer inputs. Furthermore, doing so also provides the user with an indication that the user is able to enter search queries to search media items, which enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first query and the second query (e.g., 692a in FIGS. 9A-9E) are automatically selected (e.g., without user input) by the computer system (e.g., 600) (e.g., based on selection criteria). Automatically displaying representations of different queries and related results allows the user to explore media items with fewer inputs. Furthermore, doing so also provides the user with an indication that the user is able to enter search queries to search media items, which enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the representation of the second query (e.g., 692a) and the representation of the second set of content that is responsive to the second query (e.g., 692b), the computer system detects (e.g., via one or more input devices) a first user input (e.g., 910) (e.g., one or more user inputs) (e.g., a touch input, a tap input, a gesture input, an air gesture input, and/or a hardware input (e.g., via one or more buttons and/or one or more physically rotatable input mechanisms)) corresponding to selection of the representation of the second set of content (e.g., 692b) (in some embodiments, user input 910 selects the representation of the second set of content 692b). In response to detecting the first user input corresponding to selection of the representation of the second set of content: the computer system displays, via the one or more display generation components, a search results user interface (e.g., 912), wherein the search results user interface includes representations of (e.g., thumbnails, previews, snapshots, and/or frames) a respective set of content (e.g., from a set of content such as a media library (e.g., a media library associated with the computer system; a media library associated with a user (e.g., a user of the computer system); and/or a media library associated with a user account)) (e.g., a set of media items (e.g., images, photos, and/or videos)) that is responsive to the second query. In some embodiments, the respective set of content includes the second set of content and/or is the same as the second set of content. In some embodiments, in response to detecting the first user input (e.g., 910) corresponding to selection of the representation of the second set of content, the computer system ceases display of the search user interface (e.g., 902) and/or replaces display of the search user interface (e.g., 902) with the search results user interface (e.g., 912). In some embodiments, the search results user interface is displayed as part of the search user interface and/or displayed concurrently with the search user interface. Allowing a user to provide a user input to access search results of the second query allows the user to perform this operation with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays (e.g., within the search user interface and/or concurrently with the representation of the second query and the representation of the second set of content) a search entry field (e.g., 904) (e.g., a text box and/or a selectable text box into which a user can manually enter search terms) (e.g., in some embodiments, in an empty state (e.g., without text, search terms, and/or user-entered content displayed within the search entry field)). While displaying the representation of the second query (e.g., 692a) and the representation of the second set of content that is responsive to the second query (e.g., 692b) and the search entry field (e.g., 904), the computer system detects (e.g., via one or more input devices) a user input (e.g., 910) (e.g., one or more user inputs) (e.g., a touch input, a tap input, a gesture input, an air gesture input, and/or a hardware input (e.g., via one or more buttons and/or one or more physically rotatable input mechanisms)) corresponding to selection of the representation of the second set of content (e.g., in some embodiments, user input 910 selects representation 692b rather than representation 692a). In response to detecting the user input (e.g., 910) corresponding to selection of the representation of the second set of content, the computer system displays a second representation of the second query (e.g., text corresponding to the second query) within the search entry field (e.g., text “Baxter with Morty” within search field 904 in FIG. 9I). In some embodiments, in response to detecting the user input corresponding to selection of the representation of the second set of content, the computer system displays representations of a respective set of content that is responsive to the second query (e.g., displays search results corresponding to and/or responsive to the second query). Displaying the second query in the search entry field in response to a user input selecting the representation of the second set of content allows a user to conduct a search corresponding to the second query with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the second query within the search entry field (e.g., 904), the computer system detects one or more user inputs (e.g., 918) (e.g., touch inputs, tap inputs, gesture inputs, air gesture inputs, and/or hardware inputs (e.g., via one or more buttons and/or one or more physically rotatable input mechanisms)) corresponding to a user request to modify the search entry field (e.g., add, remove, and/or modify text in the search entry field and/or modify the second query). For example, inputs corresponding to requests to type on a hardware or software keyboard (e.g., 906). In response to detecting the one or more user inputs corresponding to the user request to modify the search entry field, the computer system displays, within the search entry field (e.g., 904), a modified query different from the second query (e.g., text in 904 changing from FIGS. 9I to 9J); and displays, via the one or more display generation components, representations of (e.g., thumbnails, previews, snapshots, and/or frames) a second respective set of content (e.g., from a set of content such as a media library (e.g., a media library associated with the computer system; a media library associated with a user (e.g., a user of the computer system); and/or a media library associated with a user account)) (e.g., a set of media items (e.g., images, photos, and/or videos)) that is responsive to the modified query (and, in some embodiments, is not responsive to the second query) (e.g., 912 in FIG. 9J). Allowing a user to modify the search query in the search entry field enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, concurrently with the representation of the second query (e.g., 692a) and the representation of the second set of content (e.g., 692b) (e.g., within the search user interface and/or concurrently with the representation of the second query and the representation of the second set of content), a text entry field (e.g., 904) (e.g., a text box and/or a selectable text box into which a user can manually enter search terms) (e.g., in some embodiments, in an empty state (e.g., without text, search terms, and/or user-entered content displayed within the search entry field)). While displaying the text entry field (e.g., 904) concurrently with the representation of the second query (e.g., 692a) and the representation of the second set of content (e.g., 692b), the computer system detects (e.g., via one or more input devices) one or more user inputs (e.g., touch inputs, tap inputs, gesture inputs, air gesture inputs, and/or hardware inputs (e.g., via one or more buttons and/or one or more physically rotatable input mechanisms)) corresponding to a user request to enter a search query into the text entry field (e.g., one or more user inputs via keyboard 906). For example, inputs corresponding to requests to type on a hardware or software keyboard (e.g., 906). In response to detecting the one or more user inputs corresponding to a user request to enter the search query into the text entry field, the computer system ceases display of the representation of the second query (e.g., 692a) and the representation of the second set of content (e.g., 692b); and displays, via the one or more display generation components, representations of (e.g., thumbnails, previews, snapshots, and/or frames) a set of results content (e.g., from a set of content such as a media library (e.g., a media library associated with the computer system; a media library associated with a user (e.g., a user of the computer system); and/or a media library associated with a user account)) (e.g., a set of media items (e.g., images, photos, and/or videos)) that is responsive to the search query (and, in some embodiments, is not responsive to the second query) (e.g., 912). Ceasing display of the representation of the second query and the representation of the second set of content in response to a user manually entering a search query provides the user with an indication that the computer system is performing the user-requested query. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

While displaying the representations of the set of results content that is responsive to the search query (e.g., 912 in FIG. 9I), the computer system detects (e.g., via one or more input devices) one or more user inputs (e.g., 918) (e.g., touch inputs, tap inputs, gesture inputs, air gesture inputs, and/or hardware inputs (e.g., via one or more buttons and/or one or more physically rotatable input mechanisms)) corresponding to a user request to modify the search query by adding one or more search terms to the search query, wherein the user request to modify the search query by adding one or more search terms to the search query results in a modified search query. For example, inputs corresponding to requests to type on a hardware or software keyboard (e.g., 906). In response to detecting the one or more user inputs (e.g., 918) corresponding to the user request to modify the search query by adding one or more search terms to the search query, the computer system displays, via the one or more display generation components, representations of (e.g., thumbnails, previews, snapshots, and/or frames) a second set of results content (e.g., from a set of content such as a media library (e.g., a media library associated with the computer system; a media library associated with a user (e.g., a user of the computer system); and/or a media library associated with a user account)) (e.g., a set of media items (e.g., images, photos, and/or videos)) that is responsive to the modified search query (and, in some embodiments, is not responsive to the search query), wherein the second set of results content is different from the set of results content (e.g., 912 in FIG. 9J). In some embodiments, the second set of results content (e.g., 912 in FIG. 9J) includes a first set of content items that were included in the set of results content (e.g., 912 in FIG. 9I), and excludes a second set of content items that were included in the set of results content (e.g., 912 in FIG. 9I). Allowing a user to modify search terms enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the representations of the set of results content that is responsive to the search query comprises displaying the representations of the set of results content within a search results user interface (e.g., 912), wherein the search results user interface includes: a first region (e.g., a first contiguous region) (e.g., 916b) that includes representations of a first subset of the set of results content that have been selected by the computer system as meeting result priority criteria (e.g., a set of criteria that is indicative of the first subset being highly responsive to the search query and/or a set of criteria that is indicative of the first subset meeting a threshold level of responsiveness to the search query); a second region (e.g., 916a) (e.g., a second contiguous region) different from the first region (e.g., non-overlapping with the first region and/or visually distinct from the first region) that includes a representation of a first media collection (e.g., a set of two or more media items) (e.g., 916a-1) that is responsive to the search query and a representation of a second media collection (e.g., 916a-2) (e.g., a set of two or more media items) that is responsive to the search query and is different from the representation of the first media collection; and a third region (e.g., 916c) (e.g., a third contiguous region) different from the first region and the second region (e.g., non-overlapping with the first region and the second region and/or visually distinct from the first region and the second region) that includes representations of a second subset of the set of results content different from the first subset of the set of results content (e.g., representations of all the results content and/or an “all results” region). In some embodiments, the second subset of the set of results content includes the first subset of the set of results content. Displaying search results separated into different categories of results enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of content (e.g., 692b in FIG. 9E) is selected from a media library corresponding to a user of the computer system (e.g., a media library stored on the computer system; a media library that is accessible by the computer system; a media library that is accessible by the user of the computer system; and/or a media library corresponding to a user account that is associated with the user of the computer system) based on the first query; and the second set of content (e.g., 692b in FIG. 9H) is selected from the media library corresponding to the user of the computer system based on the second query. Automatically displaying a representation of a search query and related results allows the user to explore media items with fewer inputs. Furthermore, doing so also provides the user with an indication that the user is able to enter search queries to search media items, which enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 1000 (e.g., FIG. 10) are also applicable in an analogous manner to the methods described above and/or below. For example, method 700, method 800, method 1100, method 1300, method 1400, method 1600, and/or method 1800 optionally include one or more of the characteristics of the various methods described above with reference to method 1000. For example, the media library in method 700 is the media library in method 800, method 1300, method 1400, method 1600, and/or method 1800; and/or the queries recited in method 1000 and/or method 1100 are queries within the media library recited in method 700, method 800, method 1300, method 1400, method 1600, and/or method 1800. For brevity, these details are not repeated below.

FIG. 11 is a flow diagram illustrating a method for navigating, displaying, and/or presenting content using a computer system in accordance with some embodiments. Method 1100 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 602, and/or 604a-604c) (e.g., a touch-sensitive surface, a touch-sensitive display, a button, a rotatable input mechanism, a depressible and rotatable input mechanism, a camera, an accelerometer, and/or an inertial measurement unit (IMU)). Some operations in method 1100 are, optionally, combined, the orders of some operations are, optionally, changed, and some operations are, optionally, omitted.

As described below, method 1100 provides an intuitive way for navigating, displaying, and/or presenting content. The method reduces the cognitive burden on a user for navigating and/or accessing content, thereby creating a more efficient human-machine interface. For battery-operated computing devices, enabling a user to navigate and/or access content faster and more efficiently conserves power and increases the time between battery charges.

The computer system receives (1102), via the one or more input devices, a first user input (e.g., 920, 927, and/or 928) (e.g., one or more touch inputs, one or more audio inputs, one or more hardware inputs, and/or one or more gesture inputs) that corresponds to (e.g., that identifies, indicates, and/or specifies) a first term in a search query that includes multiple terms (e.g., a first word and/or a first phrase) (e.g., a first term that is part of a search query). In some embodiments, the first user input that corresponds to the first term includes one or more user inputs to manually enter and/or type in the search query that includes the first user input via inputs on a software or hardware keyboard (e.g., user input 910). In some embodiments, the first user input that corresponds to the first term includes one or more user inputs selecting a suggested search term to enter the suggested search term into the search query (e.g., user input 927). In some embodiments, the first user input that corresponds to the first term includes one or more user inputs selecting a pre-populated query that is automatically generated by the computer system (e.g., to use the pre-populated query as the search query and/or to enter the pre-populated query into the search query). In response to receiving the first user input that corresponds to the first term (1104): in accordance with a determination that the first term meets ambiguity criteria (1106) (e.g., the first term is determined to correspond to multiple entities, is determined to correspond to multiple possible interpretations, and/or is determined to correspond to multiple meanings), the computer system displays (1108), via the one or more display generation components, a first prompt (e.g., 922, 938, 946, 948, 950, and/or 952) prompting a user to provide one or more user inputs clarifying the meaning of the first term without changing other terms in the search query (e.g., displaying a disambiguation user interface for the user to select from multiple entities and/or multiple possible meanings for the first term; and/or displaying a prompt asking the user to provide more information about the first term). In some embodiments, in response to receiving the first user input that corresponds to the first term: in accordance with a determination that the first term does not meet the ambiguity criteria (e.g., the first term is not determined to correspond to multiple entities, is not determined to correspond to multiple possible interpretations, and/or is not determined to correspond to multiple meanings), the computer system forgoes displaying the first prompt. In some embodiments, in response to receiving the first user input that corresponds to the first term: in accordance with a determination that the first term meets the ambiguity criteria, the computer system displays, concurrently with the first prompt (e.g., 922, 938, 946, 948, 950, and/or 952), a first set of query results (e.g., 912 in FIG. 9L) (e.g., a first set of content, a first set of media items, and/or representations of a first set of media items) that is responsive to (e.g., that correspond to and/or are associated with) the first term. In some embodiments, in response to receiving the first user input that corresponds to the first term: in accordance with a determination that the first term does not meet the ambiguity criteria, the computer system displays the first set of query results without displaying the first prompt. Displaying a prompt prompting a user to provide clarification of ambiguous terms improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the determination that the first term meets ambiguity criteria comprises a determination that the first term meets ambiguity criteria based on a second term (e.g., based on one or more other terms in the search query) in the search query different from the first term. In some embodiments, a first term in a search query is determined to be ambiguous (e.g., determined to meet ambiguity criteria) based on one or more other terms in the search query. For example, in some embodiments, a first term in a search query would not be ambiguous without the presence of a second term in the search query, but is ambiguous when the second term is included in the search query (e.g., in one example, “Mom” is not ambiguous, but “Amber's mom” is ambiguous). Displaying a prompt prompting a user to provide clarification of ambiguous terms improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first prompt (e.g., 922, 938, 946, 948, 950, and/or 952) prompting the user to provide one or more user inputs clarifying the meaning of the first term, the computer system receives, via the one or more input devices, one or more user inputs (e.g., 924) (e.g., one or more touch inputs, one or more gesture inputs, one or more air gesture inputs, and/or one or more hardware inputs (e.g., via one or more buttons and/or physically rotatable input mechanisms)) clarifying the meaning of the first term (e.g., one or more user inputs selecting from one or more options for clarifying the meaning of the first term). In response to receiving the one or more user inputs clarifying the meaning of the first term, the computer system maintains (e.g., saving and/or storing) first information indicating a relationship between the first term and one or more other terms in the search query (e.g., in FIG. 9R, one or more user inputs identifying “grandma” would permit computer system 600 to maintain information indicating the identity to the person “grandma” in the context of additional term “April”; and/or in FIG. 9S, one or more user inputs identifying the date of the wedding anniversary would permit computer system 600 to maintain information indicating the date of the word “anniversary” in the context of the word “wedding”). In some embodiments, the computer system maintains first information indicating a relationship between the first term and one or more other terms in the search query such that, when the user performs the same search query at a later time (e.g., in a subsequent query), the computer system does not need to request additional information to perform the search. Maintaining information about the relationship between different terms in a search query for future use improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, maintaining first information indicating a relationship between the first term and one or more other terms in the search query includes maintaining first information indicating a relationship between a first person (e.g., a first contact and/or a first name) (e.g., a first person identified by and/or corresponding to the first term in the search query) and a second person different from the first person (e.g., a second person identified by and/or corresponding to the one or more other terms in the search query) (e.g., in FIG. 9Q, identifying who is April's grandam). For example, in some embodiments, the first term identifies a first person (e.g., grandma, in the search query “Sarah's grandma”) and the second term identifies a second person (e.g., Sarah, in the search query “Sarah's grandma”). In this example, in some embodiments, the computer system receives one or more user inputs identifying the person “Sarah's grandma” and the computer system maintains first information indicating the relationship between the terms “Sarah's” and “grandma” (e.g., maintains first information identifying the person “Sarah's grandma”) (e.g., for use in future search instances). Maintaining information about the relationship between different terms in a search query for future use improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, maintaining first information indicating a relationship between the first term and one or more other terms in the search query includes maintaining first information indicating a relationship between a first person (e.g., a first contact and/or a first name) (e.g., a first person identified by and/or corresponding to the first term in the search query; and/or a first person identified and/or corresponding to one or more other terms in the search query) and a first event (e.g., an event identified by and/or corresponding to the first term in the search query; and/or an event identified by and/or corresponding to the one or more other terms in the search query) (e.g., a birthday, an anniversary, and/or a trip) (e.g., in FIG. 9S, receiving information indicating the relationship between a user of computer system 600 and a wedding anniversary date). For example, in some embodiments, the first term identifies a first event (e.g., anniversary, in the search query “Sarah's anniversary”) and the second term identifies a first person (e.g., Sarah, in the search query “Sarah's anniversary”). In this example, in some embodiments, the computer system receives one or more user inputs identifying the event “Sarah's anniversary” and the computer system maintains first information indicating the relationship between the terms “Sarah's” and “anniversary” (e.g., maintains first information identifying the date of “Sarah's anniversary”) (e.g., for use in future search instances). Maintaining information about the relationship between different terms in a search query for future use improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to receiving the one or more user inputs clarifying the meaning of the first term, the computer system updates contact information corresponding to a first contact (e.g., a first person and/or a first contact stored on the computer system) (e.g., adding information to a contact card for the first contact including a birthday, anniversary, address, phone number, email address, work address, and/or relationship information indicating a relationship between the first contact and a different person and/or different contact). In some embodiments, the contact information corresponding to the first contact is accessible (e.g., viewable) and editable by a user (e.g., via a user interface) (e.g., is accessible and editable by a user after the computer system updates the contact information corresponding to the first contact). Maintaining information about the relationship between different terms in a search query for future use improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, a representation of the search query (e.g., within a text entry box and/or a text entry field), including concurrently displaying: a representation of the first term (e.g., 926a) (e.g., text that includes the first term and/or a visual object that includes the first term); and a representation of a second term of the search query (e.g., 926b) (e.g., text that includes the second term and/or a visual object that includes the second term) different from the first term. While displaying the representation of the search query, the computer system receives, via the one or more input devices, a selection input (e.g., 928) (e.g., one or more inputs) (e.g., one or more touch inputs, one or more tap inputs, one or more gesture inputs, one or more air gesture inputs, and/or one or more hardware inputs (e.g., via one or more buttons and/or one or more physical rotatable input mechanisms)) corresponding to selection of the representation of the first term (e.g., 926a). In response to receiving the selection input corresponding to selection of the representation of the first term, the computer system displays, via the one or more display generation components, a disambiguation user interface (e.g., 922) corresponding to the first term. In some embodiments, the disambiguation user interface prompts the user to provide one or more user inputs clarifying the meaning of the first term. In some embodiments, the disambiguation user interface is the same as and/or substantially the same as the first prompt. In some embodiments, the disambiguation user interface is different from the first prompt. Displaying a disambiguation user interface for a user to provide clarification of ambiguous terms improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the disambiguation user interface (e.g., 948) includes a first location option (e.g., 948a) for identifying a first location (e.g., a first address, a first city, a first state, a first country, a first geographic location and/or a first venue). In some embodiments, the disambiguation user interface includes a map. In some embodiments, the disambiguation user interface includes a text entry field for a user to enter text to search for a location. In some embodiments, the disambiguation user interface provides autocomplete suggestions for user-provided (e.g., user-typed) location information. Displaying a disambiguation user interface for a user to provide clarification of ambiguous terms improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the disambiguation user interface (e.g., 946) includes a first date option (e.g., 946a) for identifying a first date (e.g., month; day of the month; year; day of the week; month and day of the month; month and year; and/or month, day of the month, and year). In some embodiments, the disambiguation user interface includes a text entry field for a user to enter date information. In some embodiments, the disambiguation user interface includes a date-picker user interface element (e.g., a calendar, one or more drop down lists, one or more rotatable lists, and/or other interactive elements) with one or more options for a user to select a year, month, day, and/or a date range. Displaying a disambiguation user interface for a user to provide clarification of ambiguous terms improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the disambiguation user interface corresponding to the first term comprises: in accordance with a determination that the first term satisfies a first set of criteria (e.g., the first term is determined to include a first word, and/or the first term is of a first type and/or category), displaying, via the one or more display generation components, a first disambiguation user interface (e.g., a first set of disambiguation options and/or a first type of disambiguation user interface) (e.g., without displaying a second disambiguation user interface); and in accordance with a determination that the first term satisfies a second set of criteria different from the first set of criteria (e.g., the first term is determined to include a second word, and/or the first term is of a second type and/or category), displaying, via the one or more display generation components, a second disambiguation user interface (e.g., a second set of disambiguation options and/or a second type of disambiguation user interface) (e.g., without displaying the first disambiguation user interface) different from the first disambiguation user interface (e.g., in FIGS. 9L, 9Q, 9S, 9T, 9U, and/or 9V, different disambiguation user interfaces 922, 936, 946, 948, 950, and/or 952 are displayed for different search terms and/or different combinations of search terms). Displaying different disambiguation user interfaces for different ambiguous terms enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the disambiguation user interface corresponding to the first term comprises: in accordance with a determination that a combination of one or more terms of the search query different from the first term satisfy a first respective set of criteria (e.g., the one or more other terms are determined to include a first respective word, the one or more other terms are arranged in a first order, and/or the one or more other terms are of a first type and/or category), displaying, via the one or more display generation components, a first respective disambiguation user interface (e.g., a first set of disambiguation options and/or a first type of disambiguation user interface) (e.g., without displaying a second respective disambiguation user interface); and in accordance with a determination that the combination of one or more terms of the search query different from the first term satisfy a second respective set of criteria (e.g., the one or more other terms are determined to include a second respective word, the one or more other terms are arranged in a second order, and/or the one or more other terms are of a second type and/or category) different from the first respective set of criteria, displaying, via the one or more display generation components, a second respective disambiguation user interface (e.g., a second set of disambiguation options and/or a second type of disambiguation user interface) (e.g., without displaying the first disambiguation user interface) different from the first respective disambiguation user interface (e.g., in FIGS. 9U and 9V, the term “vacation rental” results in different disambiguation user interfaces based on the other terms in the search query). For example, in some embodiments, when the first term is accompanied by a first set of words, the disambiguation user interface is a first respective disambiguation user interface, and when the first term is accompanied by a second set of words, the disambiguation user interface is a second respective disambiguation user interface different from the first respective disambiguation user interface. For example, in some embodiments, the search query “during my vacation rental” (where, in this example, the first term is “vacation rental”) results in a date picker disambiguation user interface, and the search query “at my vacation rental” (where, once again, the first term is “vacation rental”) results in a location picker disambiguation user interface. Displaying different disambiguation user interfaces based on words in the search query other than the first term enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first prompt (e.g., 922) prompting the user to provide one or more user inputs clarifying the meaning of the first term: the computer system displays, via the one or more display generation components, a search field (e.g., 904) that displays a representation of the search query, including the first term. In some embodiments, the computer system displays (e.g., concurrently with the search field that displays the representation of the search query and the first prompt), via the one or more display generation components, a first set of search results responsive to the search query (e.g., representations of a first set of media items and/or a first set of content that is responsive to the search query) (e.g., 912 in FIG. 9L). In some embodiments, the computer system receives, via the one or more input devices, a first set of user inputs (e.g., 924) (e.g., one or more user inputs) (e.g., one or more touch inputs, one or more gesture inputs, one or more air gesture inputs, and/or one or more hardware inputs (e.g., via one or more buttons and/or physically rotatable input mechanisms)) corresponding to user clarification of the meaning of the first term (e.g., one or more user inputs corresponding to selection of a first meaning corresponding to the first term; one or more user inputs corresponding to selection of a first definition corresponding to the first term; one or more user inputs identifying a first person corresponding to the first term; one or more user inputs identifying a first date corresponding to the first term; and/or one or more user inputs identifying a first location corresponding to the first term). In some embodiments, in response to receiving the first set of user inputs (e.g., 924) corresponding to user clarification of the meaning of the first term, the computer system displays, via the one or more display generation components, a second set of search results responsive to the search query (e.g., representations of a second set of media items and/or a second set of content that is responsive to the search query) and different from the first set of search results (e.g., replacing display of the first set of search results with the second set of search results) (e.g., 912 in FIG. 9M) without modifying display of the search field that displays the representation of the search query (e.g., without adding terms and/or changing terms in the search field and/or in the representation of the search query) (e.g., 904 in FIG. 9M), wherein the second set of search results is different from the first set of search results based on the first set of user inputs corresponding to user clarification of the meaning of the first term. In some embodiments, the meaning of the first term is modified and/or one or more filters are applied to the meaning of the first term when the user provides one or more user inputs clarifying the meaning of the first term. In some embodiments, modifying the meaning of the first term results in a change in the set of search results that result from the first term being included in the search query. Automatically modifying search results based on user clarification of ambiguous terms improves the quality of search results provided to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the determination that the first term meets ambiguity criteria includes a determination that the first term is included in a list of ambiguous terms. In some embodiments, ambiguous terms are determined based on a list of ambiguous terms. Automatically identifying ambiguous terms and prompting the user for clarification improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the determination that the first term meets ambiguity criteria is performed based on one or more machine learning models (e.g., one or more logistic regression models, support vector machines, naïve bayes models, decision trees, linear regressions models, random forest models, K-Means models, and/or hierarchical clustering models). In some embodiments, ambiguous terms are determined based on one or more machine learning models. Automatically identifying ambiguous terms and prompting the user for clarification improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays (e.g., concurrently with the search field that displays the representation of the search query and the first prompt), via the one or more display generation components, a first set of search results responsive to the search query (e.g., representations of a first set of media items and/or a first set of content that is responsive to the search query) (e.g., 912 in FIG. 9M). While displaying the first set of search results responsive to the search query, the computer system receives, via the one or more input devices, one or more user inputs (e.g., 927) (e.g., one or more user inputs) (e.g., one or more touch inputs, one or more gesture inputs, one or more air gesture inputs, and/or one or more hardware inputs (e.g., via one or more buttons and/or physically rotatable input mechanisms)) corresponding to a user request to modify the search query to a modified search query, wherein the modified search query includes one or more additional terms that are not in the search query (e.g., the one or more user inputs includes user entry of one or more additional search terms to add to the search query) (e.g., in FIGS. 9M to 9N, adding the words “Santa Cruz” to the search query). In response to receiving the one or more user inputs corresponding to the user request to modify the search query to the modified search query, the computer system replaces display of the first set of search results responsive to the search query (e.g., 912 in FIG. 9M) with a second set of search results responsive to the modified search query (e.g., 912 in FIG. 9N) (e.g., representations of a second set of media items and/or a second set of content that is responsive to the modified search query) and different from the first set of search results (e.g., including one or more search results that were not included in the first set of search results and/or excluding one or more search results that were included in the first set of search results). In some embodiments, search results are modified as additional terms are added to the search query. Automatically modifying search results based on user input entering additional search terms improves the quality of search results provided to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, a first user interface (e.g., 954) that corresponds to a first subset of content (e.g., a folder and/or a collection of content) from a set of content (e.g., a media library; a media library that corresponds to the computer system; and/or a media library that corresponds to a user of the computer system). While displaying the first user interface that corresponds to the first subset of content, the computer system receives, via the one or more input devices, a search input (e.g., 960 and/or 966) (e.g., one or more user inputs) (e.g., one or more touch inputs, one or more audio inputs, one or more hardware inputs, and/or one or more gesture inputs) that corresponds to a second search query (e.g., one or more user inputs entering the second search query and/or one or more user inputs defining the second search query) (e.g., a search input that corresponds to a user request to conduct a search based on the second search query). In response to receiving the search input that corresponds to the second search query, the computer system displays, via the one or more display generation components, a respective set of search results (e.g., 968 and/or 970) (e.g., representations of one or more content items and/or media items) from the first subset of content that is responsive to the second search query, wherein the respective set of search results excludes one or more potential search results from the set of content that are responsive to the second search query but are not in the first subset of content (e.g., the search results include only search results from the first subset of content (e.g., based on the search being initiated from the first user interface that corresponds to the first subset of content)). In some embodiments, the respective set of search results excludes and/or does not include any search results and/or content that is not in the first subset of content. Limiting the scope of a search when the search is initiated from a particular context enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, concurrently with the respective set of search results (e.g., 970), a first option (e.g., 972a) that, when selected (e.g., in response to a computer system detecting a selection input), causes the computer system to perform a search based on the second search query in the set of content (e.g., without limiting the search to the first subset of content). While displaying the first option (e.g., 972a), the computer system receives, via the one or more input devices, a selection input (e.g., 978a) (e.g., one or more user inputs) (e.g., one or more touch inputs, one or more audio inputs, one or more hardware inputs, and/or one or more gesture inputs) corresponding to selection of the first option. In response to receiving the selection input corresponding to selection of the first option, the computer system updates display of the respective set of search results to include the one or more potential search results from the set of content that are responsive to the second search query but are not in the first subset of content (e.g., 912 in FIG. 9Z) (e.g., in some embodiments, performing a query based on the second search query on the entire set of content rather than limiting the query to the first subset of content). In some embodiments, updating display of the respective set of search results includes adding one or more search results that were not included in the respective set of search results prior to receiving the selection input. In some embodiments, updating display of the respective set of search results includes removing and/or ceasing display of one or more search results that were included in the respective set of search results prior to receiving the selection input (e.g., replacing one or more search results with more relevant and/or different search results based on the expansion of the search set). Providing the user with an option to expand the scope of a search when a search has been limited to a certain context and/or a certain subset of content allows the user to perform this operation with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the respective set of search results (e.g., 968 and/or 970), the computer system displays, via the one or more display generation components, a search entry field (e.g., 962) (e.g., a text box and/or a selectable text box into which a user can manually enter search terms) that includes: a representation of the second search query (e.g., 974b in search field 962 in FIG. 9Y) (e.g., text indicating and/or identifying the second search query); and a representation of one or more additional terms that correspond to the first subset of content (e.g., one or more additional terms that represent the first subset of content and/or one or more additional terms that correspond to a name of the first subset of content) and are not included in the second search query (e.g., 974a). Displaying, with the second search query, the one or more additional terms that correspond to the first subset of content when a search has been limited to the first subset of content provides the user with an indication that the search has been limited to the first subset of content. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the respective set of search results (e.g., 968 and/or 970) and the search entry field (e.g., 962) that includes the representation of the second search query (e.g., 974b) and the representation of the one or more additional terms that correspond to the first subset of content (e.g., 974a), the computer system receives, via the one or more input devices, one or more user inputs (e.g., one or more touch inputs, one or more audio inputs, one or more hardware inputs, and/or one or more gesture inputs) corresponding to a user request to remove the one or more additional terms that correspond to the first subset of content (e.g., without removing the representation of the second search query and/or the second search query) (e.g., 978b). In response to receiving the one or more user inputs corresponding to the user request to remove the one or more additional terms that correspond to the first subset of content, the computer system updates display of the respective set of search results to include the one or more potential search results from the set of content that are responsive to the second search query but are not in the first subset of content (e.g., in some embodiments, performing a query based on the second search query on the entire set of content rather than limiting the query to the first subset of content) (e.g., 912 in FIG. 9Z). In some embodiments, updating display of the respective set of search results includes adding one or more search results that were not included in the respective set of search results prior to receiving the selection input. In some embodiments, updating display of the respective set of search results includes removing and/or ceasing display of one or more search results that were included in the respective set of search results prior to receiving the selection input (e.g., replacing one or more search results with more relevant and/or different search results based on the expansion of the search set). Allowing a user to expand the scope of a search by removing the one or more additional terms that correspond to the first subset of content allows the user to perform this operation with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system receives, via the one or more input devices, a search query user input (e.g., one or more touch inputs, one or more audio inputs, one or more hardware inputs, and/or one or more gesture inputs) that corresponds to (e.g., that identifies, indicates, and/or specifies) a second search query (e.g., one or more user inputs that enter the second search query (e.g., via a hardware or software keyboard); and/or one or more user inputs that correspond to user selection of a second search query). In response to receiving the search query user input that corresponds to the second search query: in accordance with a determination that disambiguation information corresponding to the second search query (e.g., corresponding to a first term and/or a first phrase in the second search query) was previously received (e.g., from a user and/or via user input) (e.g., prior to receiving the search query user input), the computer system displays, via the one or more input devices, a first set of search results based on the second search query and the disambiguation information (e.g., a set of search results that is filtered based on the disambiguation information and/or a set of search results that excludes one or more search results based on the disambiguation information); and in accordance with a determination that disambiguation information corresponding to the second search query (e.g., corresponding to a first term and/or a first phrase in the second search query) was not previously received (e.g., from a user and/or via user input) (e.g., prior to receiving the search query user input) (e.g., disambiguation information corresponding to the second search query is not available), the computer system displays, via the one or more input devices, a second set of search results based on the second search query that is different from the first set of search results (e.g., in some embodiments, the second set of search results includes one or more search results that would have been filtered out and/or excluded based on the disambiguation information). For example, in some embodiments, prior to receiving disambiguation information about the terms “wedding anniversary” in FIG. 9S, computer system 600 displays a first set of search results. However, in some embodiments, after receiving disambiguation information from the user defining a date to be associated with the terms “wedding anniversary,” when computer system 600 receives a subsequent query with the terms “wedding anniversary,” computer system 600 filters based on the previously-received date information, and displays a second set of search results that is different from the first set of search results based on the previously-received disambiguation information. In another example, in FIG. 9Q, the search “April with Grandma” results in a first set of search results prior to receiving disambiguation information. However, in some embodiments, after receiving disambiguation information defining who is “Grandma,” subsequent iterations of the same search will result in a second set of search results different from the first set of search results based on the received disambiguation information.

In some embodiments, user provision of different disambiguation information results in different search results for the same query. For example, in some embodiments, in response to receiving the search query user input that corresponds to the second search query: in accordance with a determination that first disambiguation information corresponding to the second search query was previously received (e.g., first disambiguation information indicating a first meaning and/or first definition for the second search query), the computer system displays, via the one or more input devices, a third set of search results based on the first disambiguation information; and in accordance with a determination that second disambiguation information corresponding to the second search query and different from the first disambiguation information was previously received (e.g., second disambiguation information indicating a second meaning and/or second definition for the second search query different from the first meaning and/or the first definition), the computer system displays, via the one or more input devices, a fourth set of search results different from the third set of search results based on the second disambiguation information. Maintaining disambiguation information about terms in search queries (e.g., based on user input) and filtering search results based on this disambiguation information improves the quality of search results provided to a user, and assists in avoiding the provision of irrelevant search results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 1100 (e.g., FIG. 11) are also applicable in an analogous manner to the methods described above. For example, method 700, method 800, method 1000, method 1300, method 1400, method 1600, and/or method 1800 optionally include one or more of the characteristics of the various methods described above with reference to method 1100. For example, the media library in method 700 is the media library in method 800, method 1300, method 1400, method 1600, and/or method 1800; and/or the queries recited in method 1000 and/or method 1100 are queries within the media library recited in method 700, method 800, method 1300, method 1400, method 1600, and/or method 1800. For brevity, these details are not repeated below.

FIGS. 12A-1-12AU illustrate exemplary devices and user interfaces for navigating, generating, and/or presenting content, in accordance with some embodiments. The user interfaces in these figures are used to illustrate the processes described below, including the processes in FIG. 13 and FIG. 14.

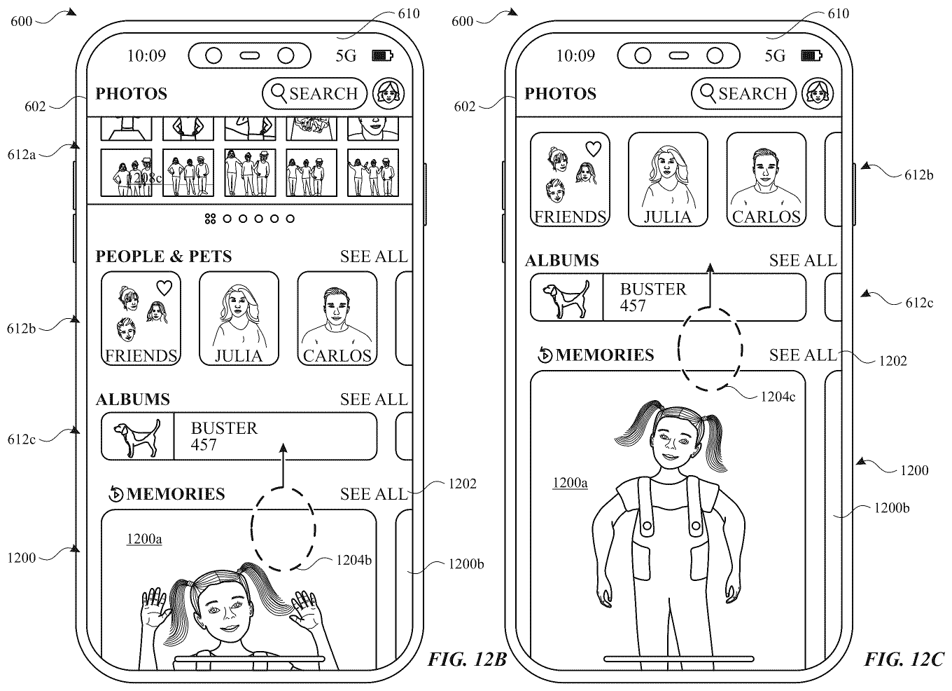

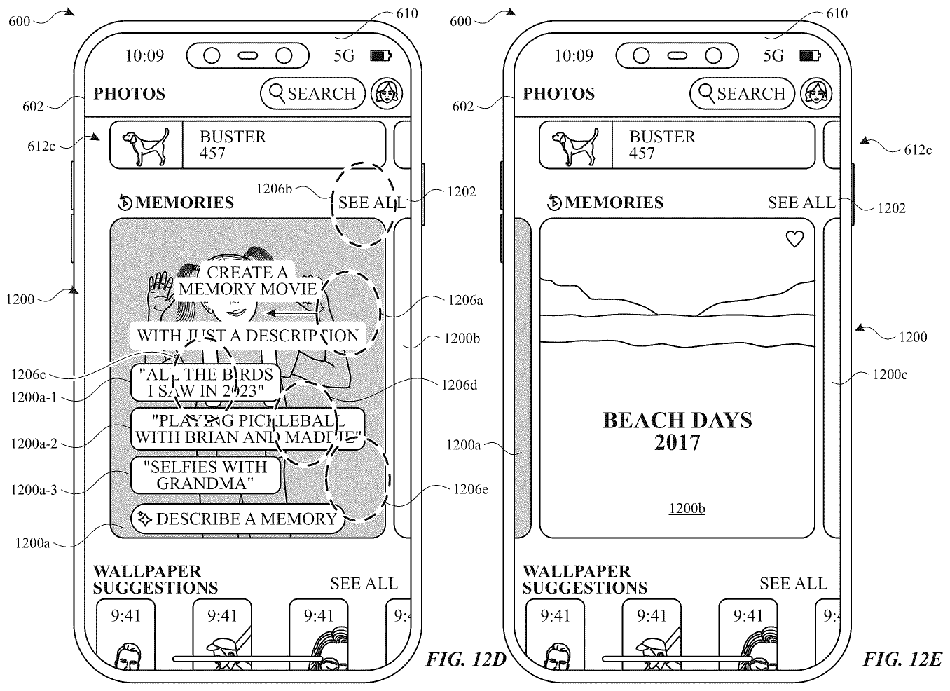

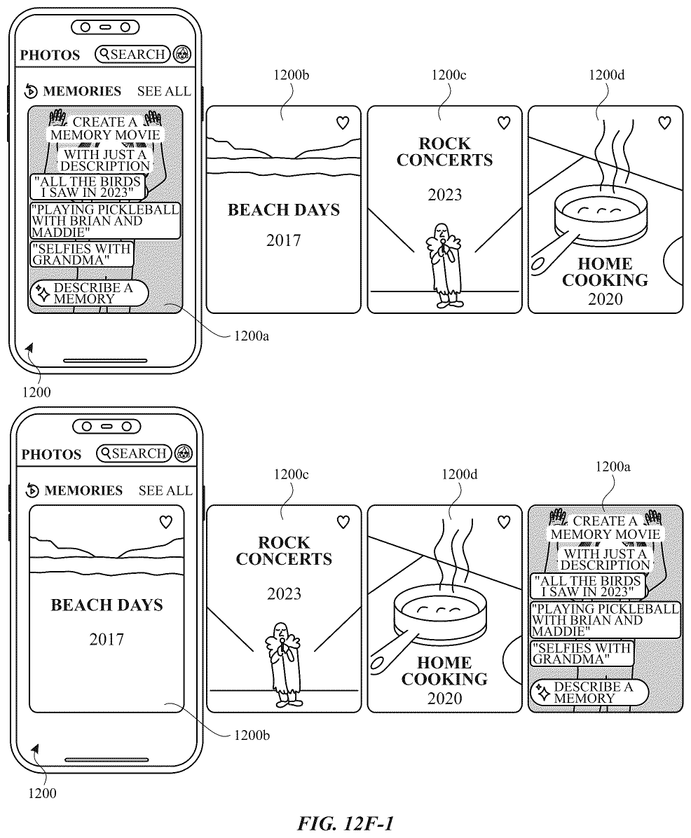

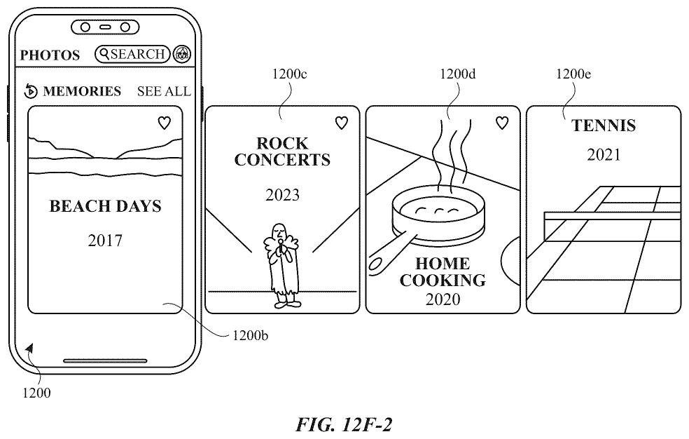

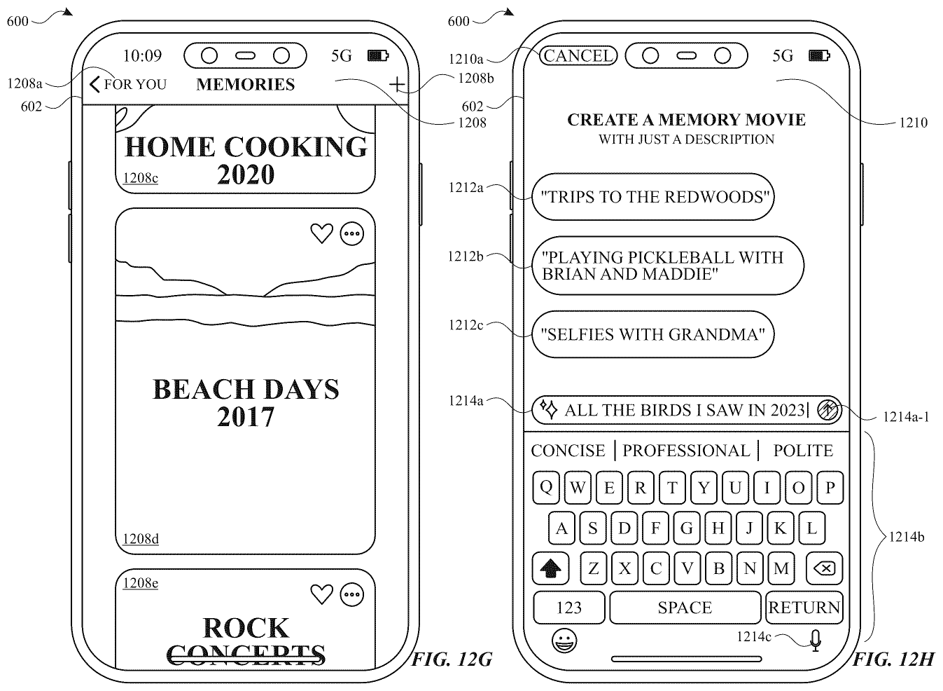

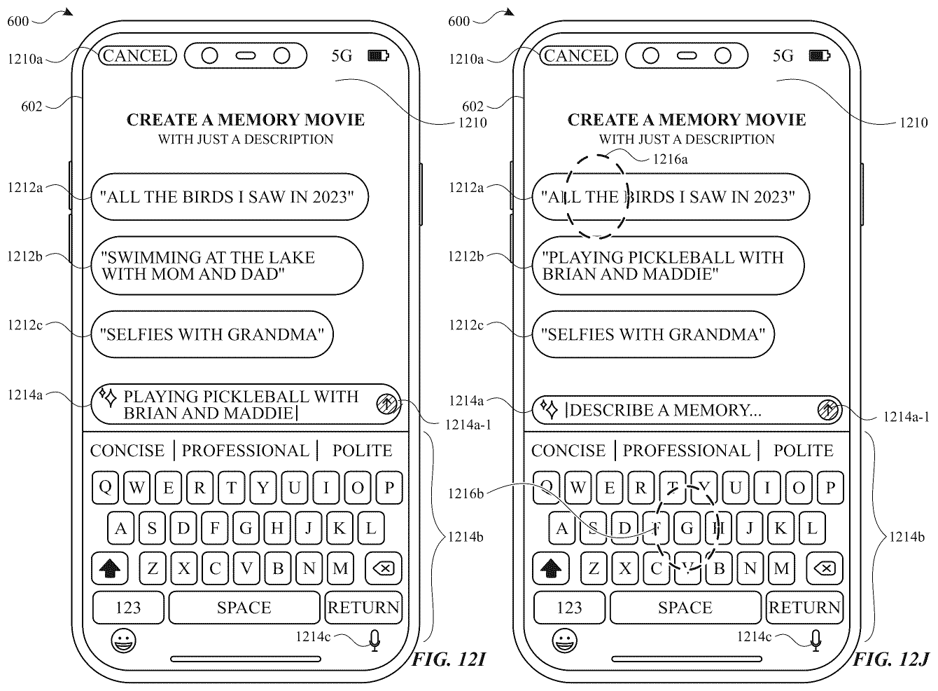

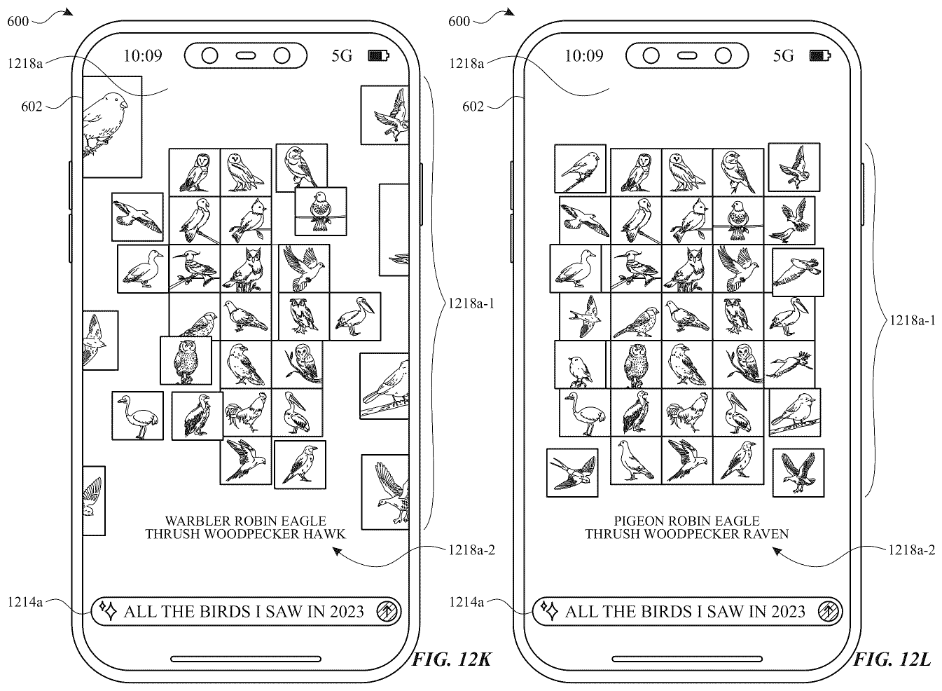

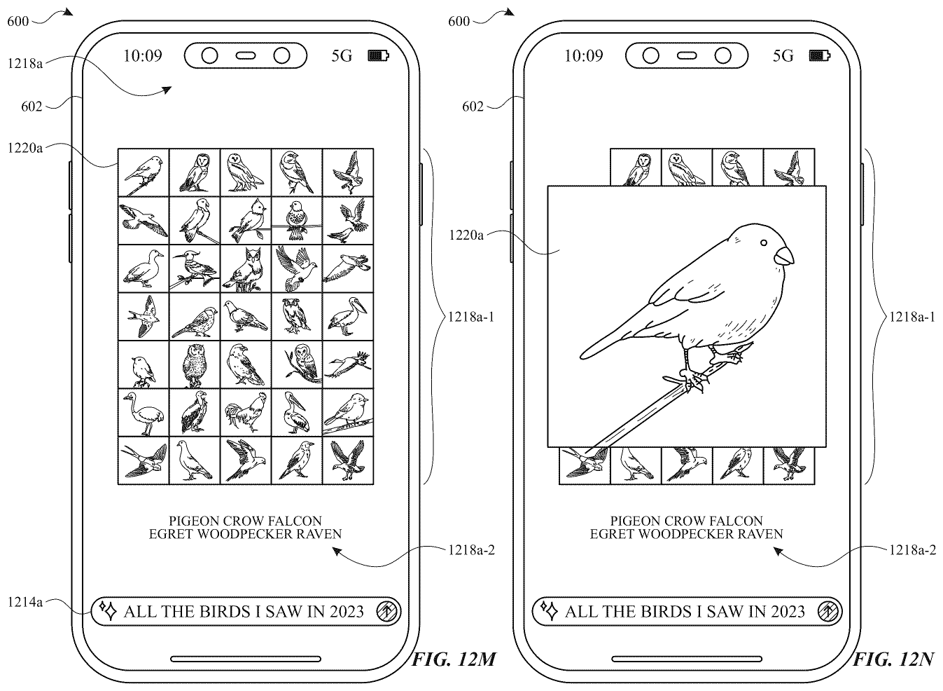

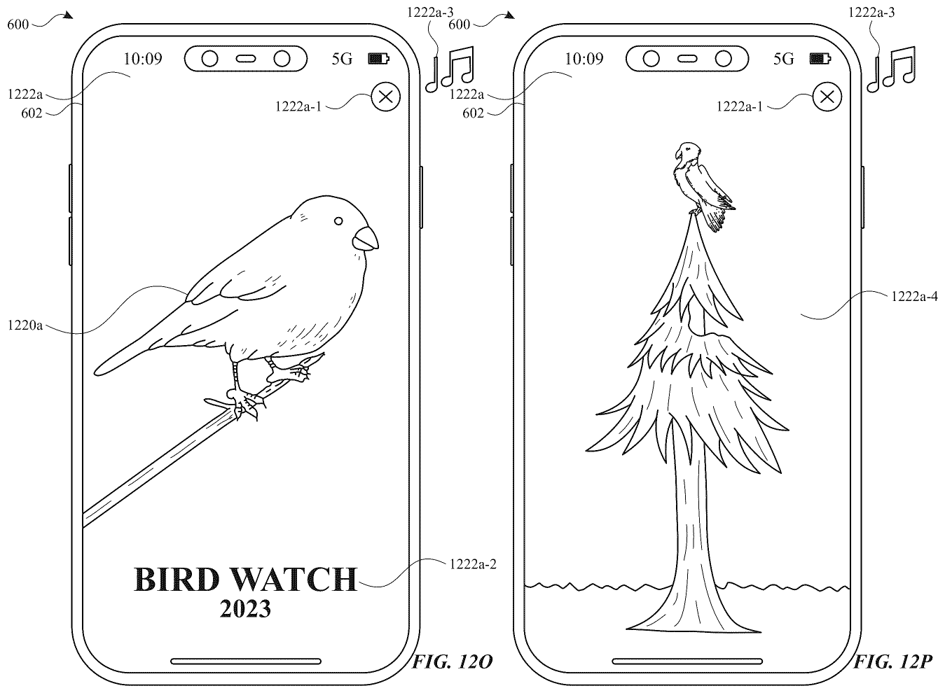

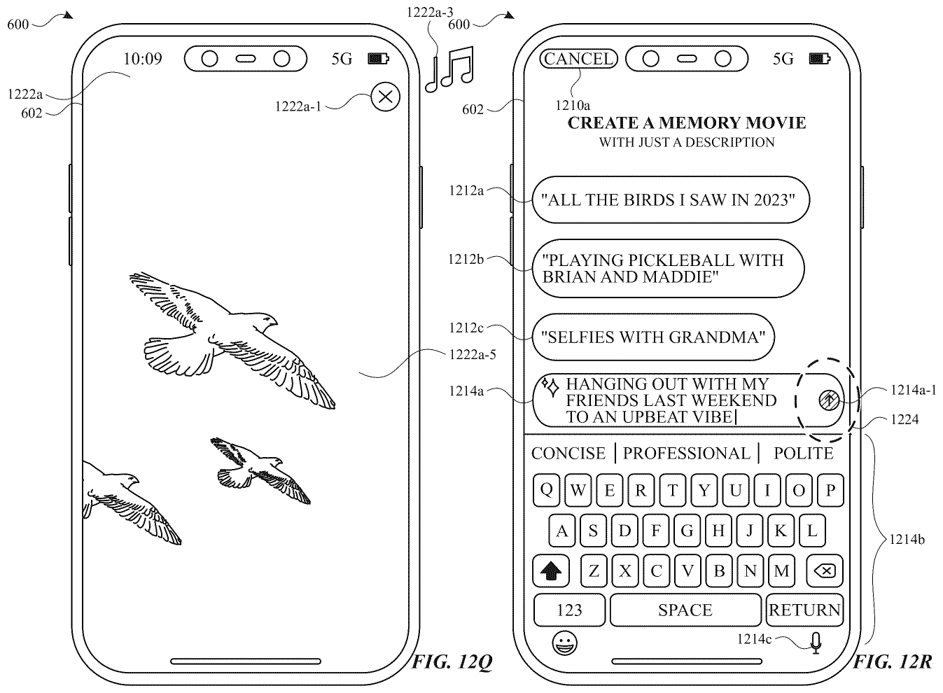

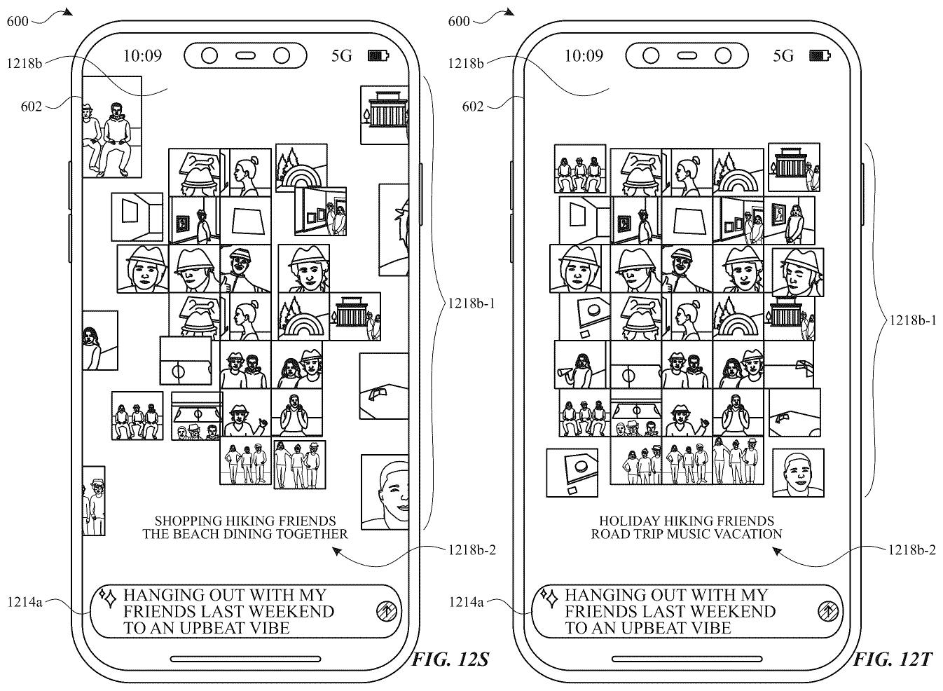

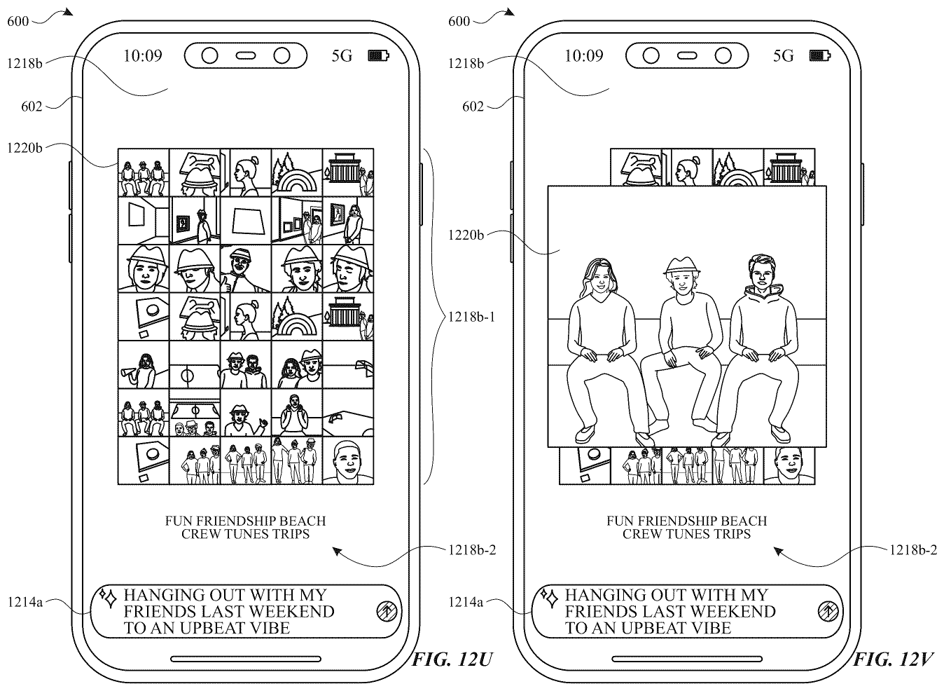

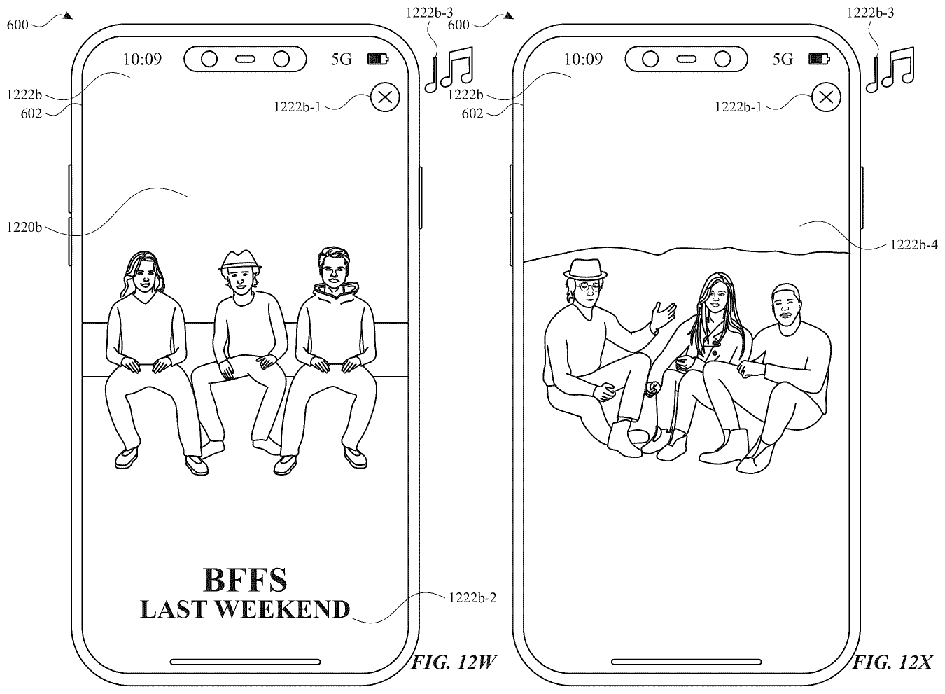

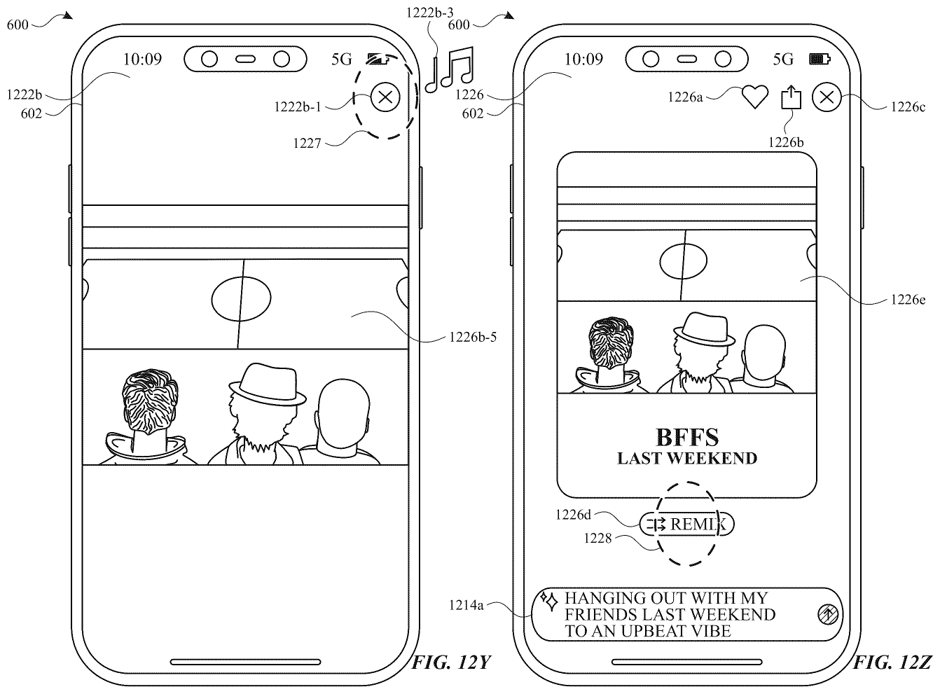

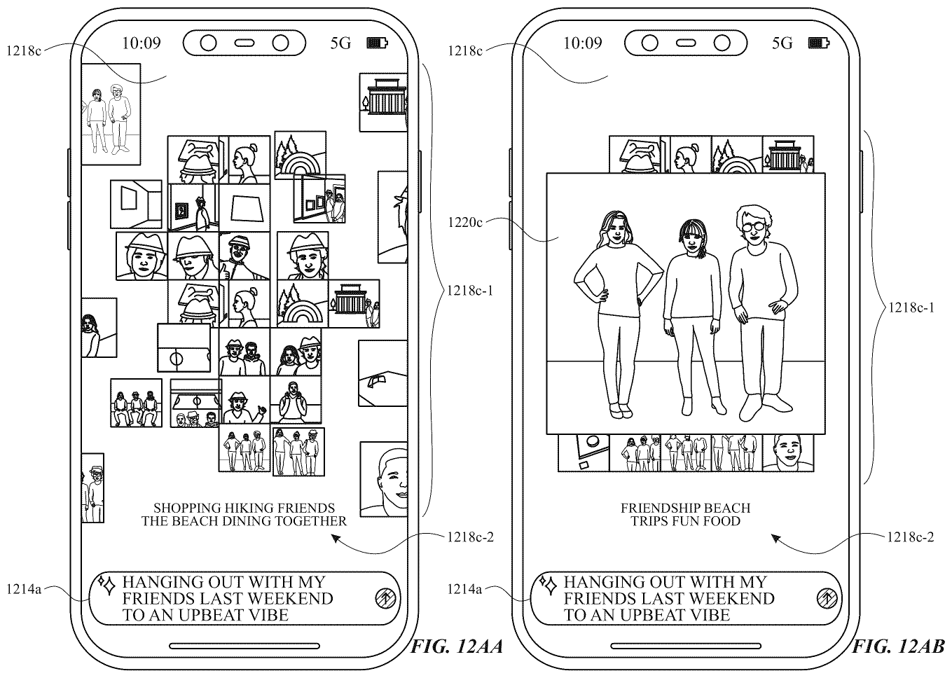

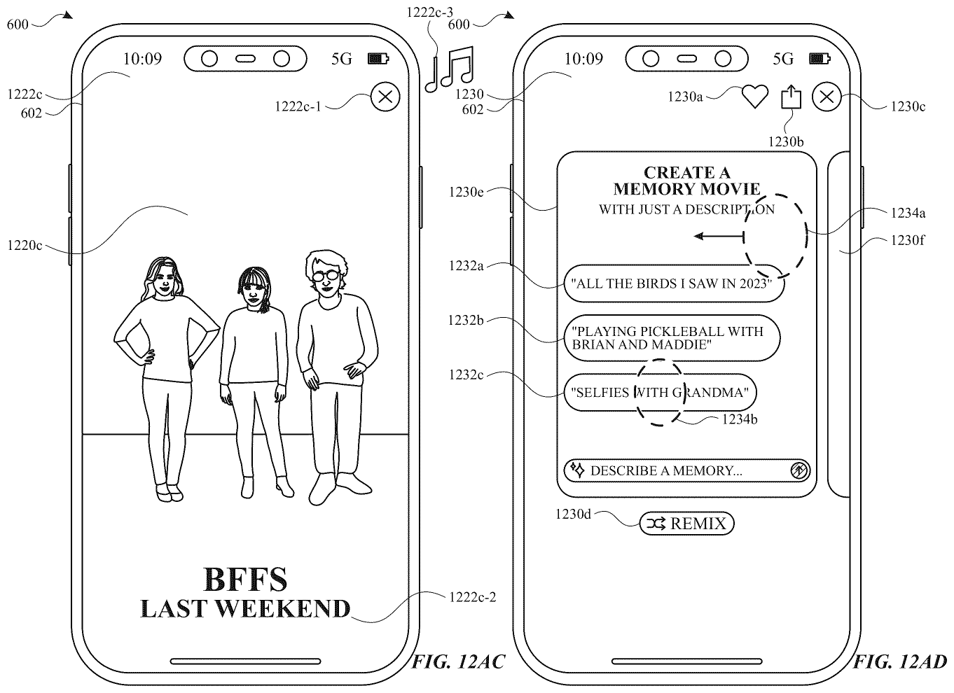

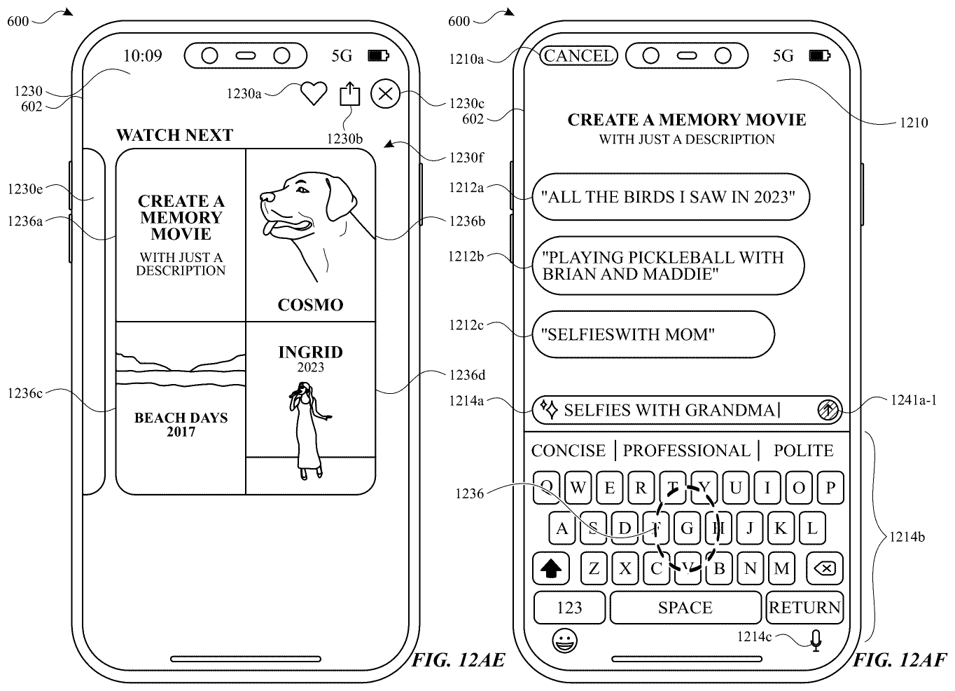

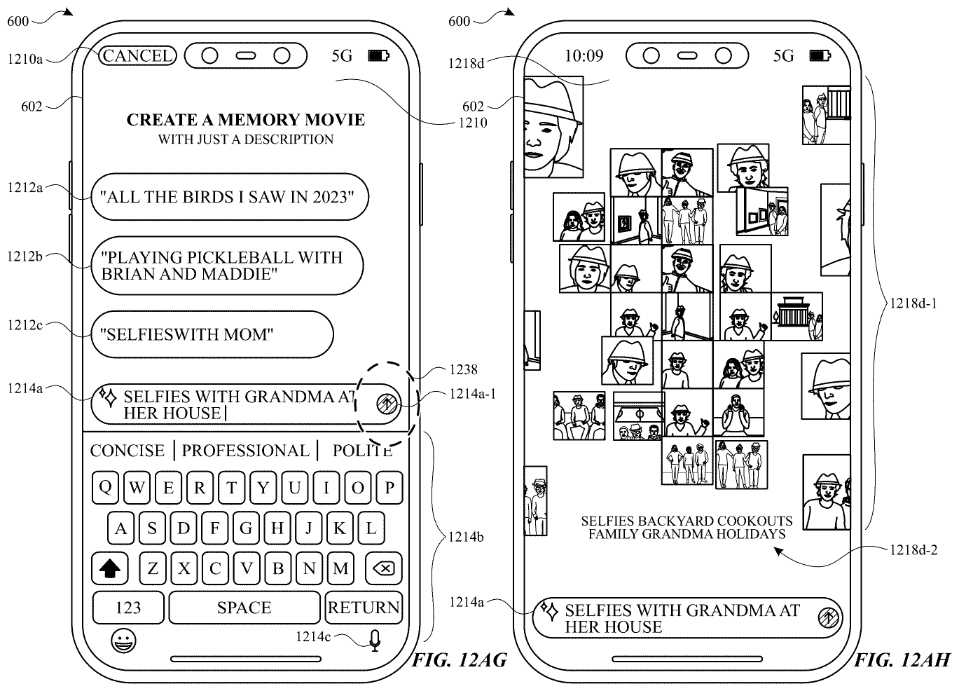

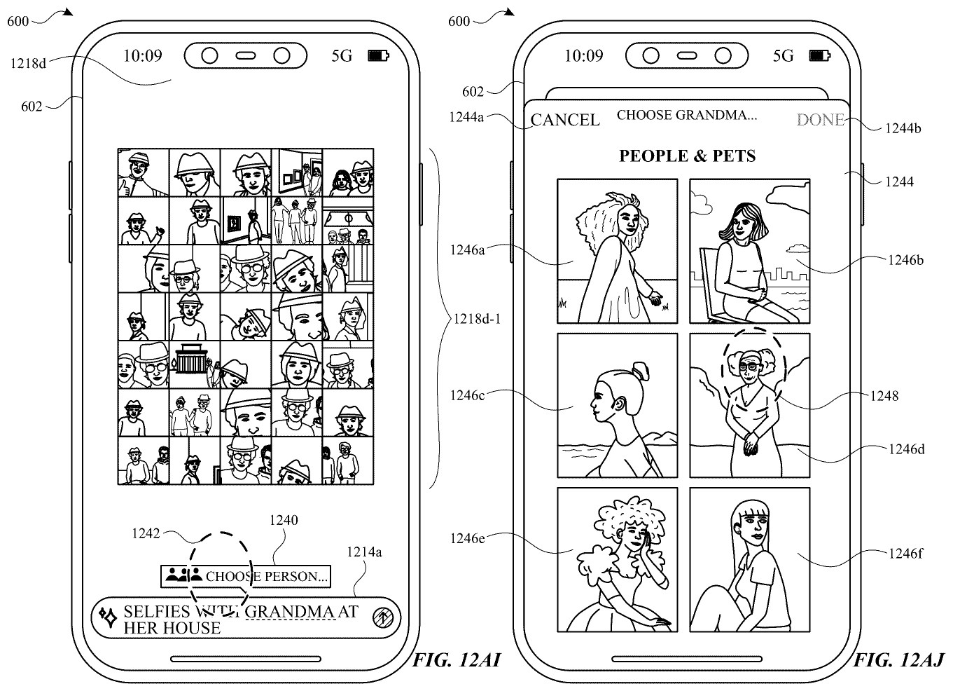

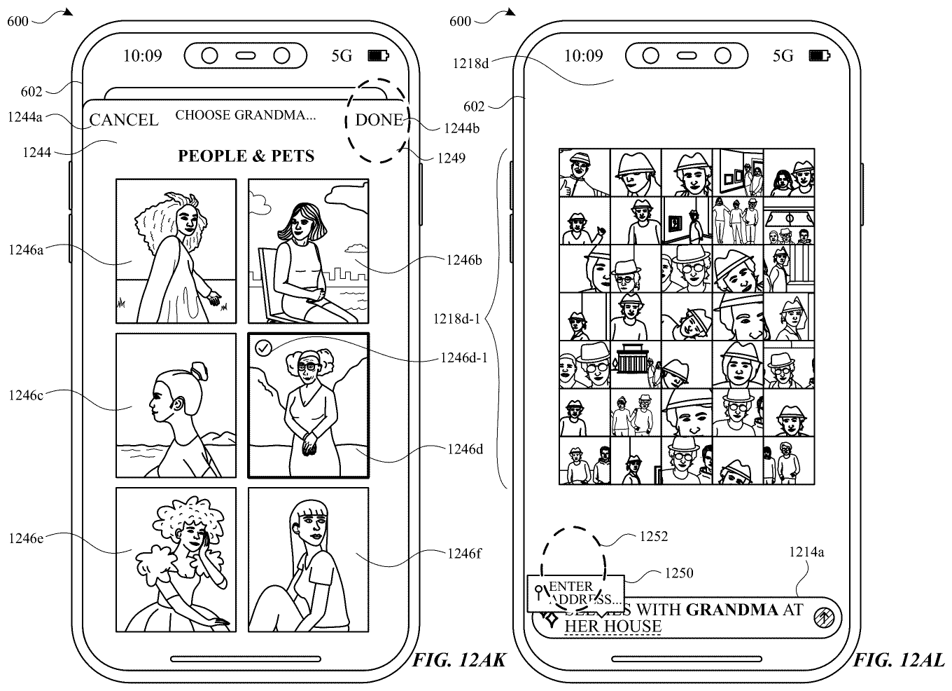

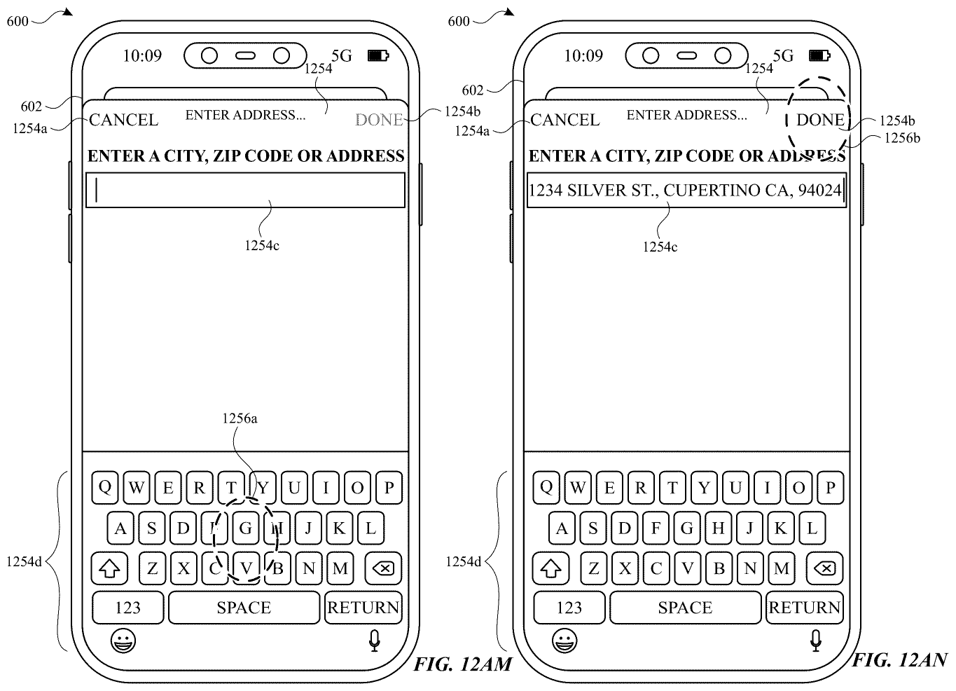

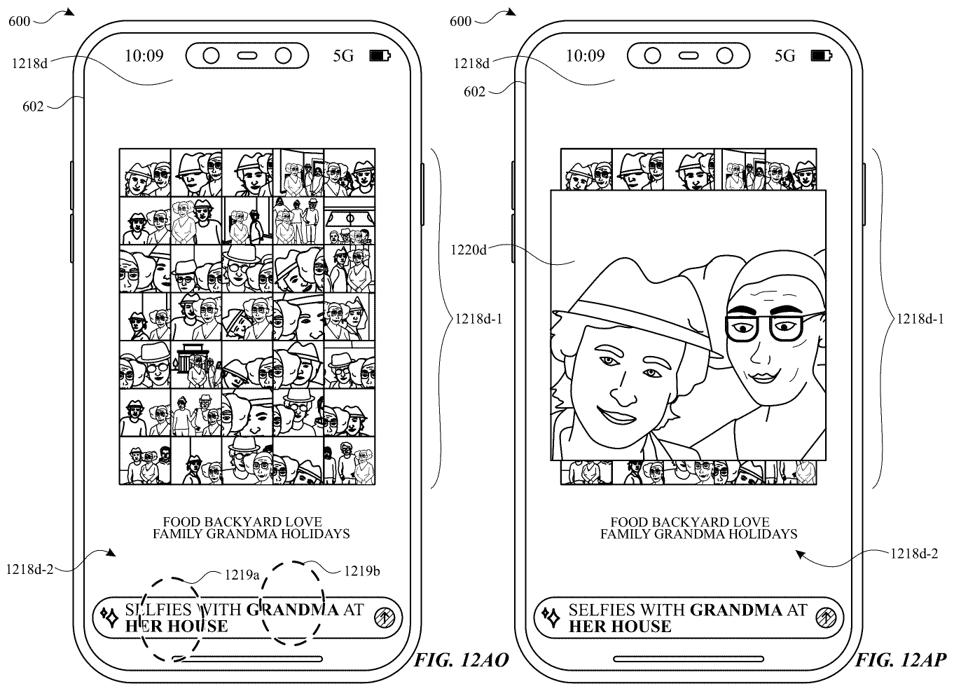

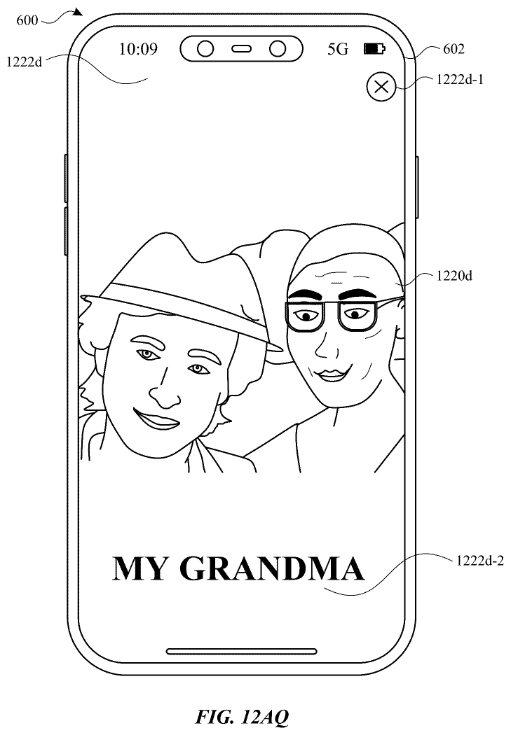

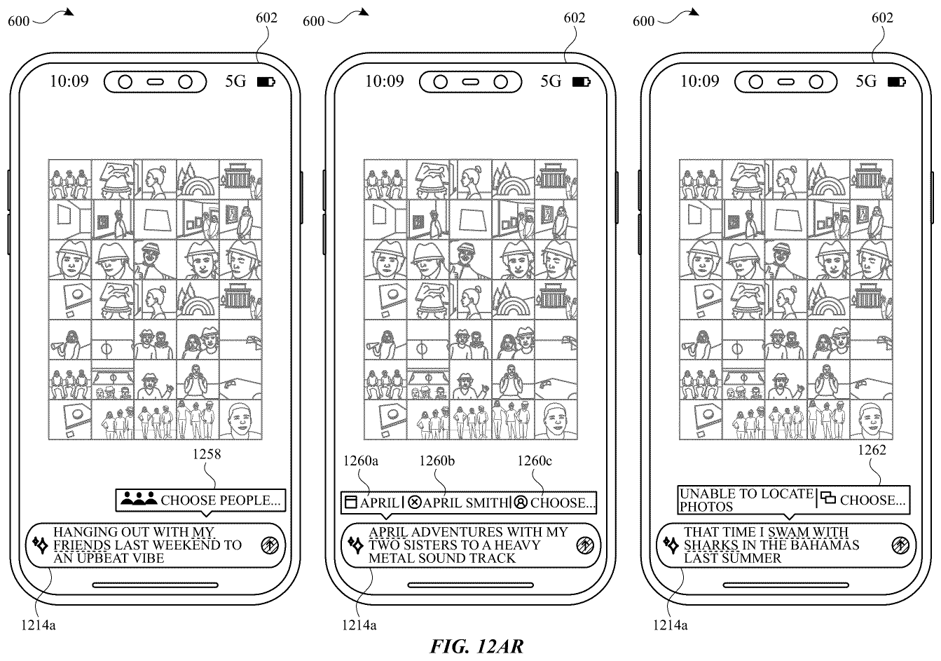

FIGS. 12A-1 and 12A-2 illustrate computer system 600, which is a smart phone with touch-sensitive display 602. Although the depicted embodiments show an example in which computer system 600 is a smart phone, in other embodiments, computer system 600 is a different type of computer system (e.g., a tablet, a laptop computer, a desktop computer, a wearable device, and/or a headset). At FIGS. 12A-1 and 12A-2, computer system 600 displays user interface 610, various features of which were described above, for example, with reference to FIGS. 6A-1 through 6AJ. In FIG. 12A-1, user interface 610 includes additional section 1200, which is a “Memories” section that displays representations of one or more memory collections that, in some embodiments, have been generated by computer system 600 and/or one or more external computer systems (e.g., one or more remote computer systems and/or one or more remote servers). In some embodiments, a memory collection comprises a plurality of media items (e.g., videos and/or photos) that have been selected from a media library corresponding to a user, and are combined into a slideshow, animation, and/or video that displays the plurality of media items in a sequence, and optionally with a music track and/or one or more transitions applied. In some embodiments, playback of a memory collection can be paused by a user. In some embodiments, while a memory collection is playing, a user is able to provide user inputs to skip forward to view different media items in the memory collection and/or to go backwards to re-display media items in the memory collection. At FIG. 12A-1, computer system 600 detects user input 1204a, which is a swipe up user input.

At FIG. 12B, in response to user input 1204a, computer system 600 displays upward scrolling of user interface 610. In the depicted scenario, upward scrolling of user interface 610 causes section 1200, which was previously not displayed, to come into view on display 602. Section 1200 includes option 1200a, corresponding to an option to generate a new memory collection based on one or more terms provided by a user, as will be described in greater detail below. At FIG. 12B, option 1200a is displayed with an animation in which one or more media items from the media library associated with the user of computer system 600 are displayed within option 1200a. In the depicted figures, the animation in option 1200a displays playback of a video, selected from the media library, of a child dancing. At FIG. 12B, computer system 600 detects user input 1204b, which is a swipe up user input. In some embodiments, user input 1204b is a continuation of user input 1204a. At FIG. 12C, in response to user input 1204a, computer system 600 displays further upward scrolling of user interface 610, which causes more of section 1200 and more of option 1200a to be displayed. At FIG. 12C, option 1200a continues to display the animation in which the video of a child dancing is displayed. At FIG. 12C, computer system 600 detects user input 1204c, which is a swipe up user input. In some embodiments, user input 1204c is a continuation of user input 1204a and/or user input 1204b.

At FIG. 12D, in response to user input 1204c, computer system 600 displays further upward scrolling of user interface 610, which now causes the entirety of option 1200a to come into view. At FIG. 12D, based on greater than a threshold amount of option 1200a being displayed (e.g., the entirety of option 1200a being displayed), option 1200a now displays additional information. In some embodiments, based on greater than a threshold amount of option 1200a being displayed, the animation in which media items are displayed is also visually deemphasized (e.g., blurred, darkened, and/or desaturated) and/or slowed down. In FIG. 12D, option 1200a now displays a text prompt prompting the user to create a memory collection with a description, as well as selectable options 1200a-1, 1200a-2, and 1200a-3. Selectable option 1200a-1 includes a first set of suggested text for generating a memory collection and, when selected, initiates a process for generating a memory collection based on the first set of suggested text, as will be described in greater detail below. Selectable option 1200a-2 includes a second set of suggested text for generating a memory collection and, when selected, initiates a process for generating a memory collection based on the second set of suggested text. Selectable option 1200a-3 includes a third set of suggested text for generating a memory collection and, when selected, initiates a process for generating a memory collection based on the third set of suggested text. In some embodiments, the suggested text displayed in selectable options 1200a-1 through 1200a-3 is determined based on metadata associated with media items contained in the media library. For example, the metadata identifies one or more concepts and/or objects depicted in the media items, the locations at which media items were captured, and/or the times and/or dates at which media items were captured. FIG. 12D depicts five example scenarios in which computer system 600 detects five different user inputs: user input 1206a (e.g., a swipe left input within section 1200); user input 1206b (e.g., a tap input corresponding to selection of option 1202); user input 1206c (e.g., a tap input corresponding to selection of selectable option 1200a-1); user input 1206d (e.g., a tap input corresponding to selection of selectable option 1200a-2); and user input 1206e (e.g., a tap input corresponding to selection of option 1200a without selecting any of selectable options 1200a-1 through 1200a-3). Each of these different scenarios and user inputs will be described below.

At FIG. 12E, in response to user input 1206a in FIG. 12D, computer system 600 displays scrolling of section 1200 to the left to reveal additional memory representation 1200b that is representative of a memory collection entitled Beach Days 2017 that includes, for example, media items that were captured at the beach during the calendar year 2017. In some embodiments, memory representation 1200b, when selected, causes computer system 600 to initiate playback of the Beach Days 2017 memory collection. In this way, a user can scroll through section 1200 to view additional memory representations that, when selected, cause computer system 600 to initiate playback of a corresponding memory collection.

In FIGS. 12D-12E, option 1200a corresponding to a user option to generate a new memory collection based on a user-provided text prompt is displayed as a first (e.g., leftmost) option and/or representation within section 1200. However, in some embodiments, option 1200a is moved to different positions within section 1200 based on, for example, a state of a memory collection generation service that generates memory collections based on user-provided text prompts. For example, in some embodiments, the memory collection generation service includes one or more external computer systems (e.g., one or more external servers) that generate memory collections based on users' media libraries and user-provided text prompts. In some embodiments, when the memory collection generation service is available to generate new memory collections, option 1200a is displayed in a prominent position, such as the leftmost position it is shown in FIG. 12D, and as shown at the top of FIG. 12F-1, in which it will be the first option displayed within section 1200a. In some embodiments, in such scenarios, additional memories (e.g., representations 1200b, 1200c, 1200d) are available to the right of option 1200a and are displayed when the user provides a scrolling input within section 1200 (e.g., user input 1206a). However, in some embodiments, when the memory collection generation service is not available and/or when the memory collection generation service is under a large load and/or is not performing efficiently, option 1200a is de-emphasized within section 1200, and displayed in a different position within section 1200 such that a user must provide one or more scrolling inputs (e.g., user input 1206a) in order to see option 1200a. This example scenario is shown at the bottom of FIG. 12F-1, in which memory representation 1200b is the first option shown within section 1200, and two other memory representations 1200c, 1200d are displayed before the user reaches and/or computer system 600 displays option 1200a. In some embodiments, when the memory collection generation service is not available and/or when the memory collection generation service is under a larger load and/or is not performing efficiently, option 1200a is not included within section 1200, such that a user is not able to access option 1200a within section 1200 and/or user interface 610. Additionally, in some embodiments, when computer system 600 does not have a sufficiently strong internet connection, does not have a sufficiently strong connection to the memory collection generation service, and/or is in a restricted communication mode (e.g., airplane mode), option 1200a is not included within section 1200 such that a user is not able to access option 1200a within section 1200 and/or user interface 610. This example scenario and/or embodiment is shown in FIG. 12F-2. In some embodiments, a user is able to access the option to generate new memory collections based on a text prompt in other user interfaces, such as user interface 1208 shown in FIG. 12G.

At FIG. 12G, in response to user input 1206b in FIG. 12D, computer system 600 displays user interface 1208. User interface 1208 displays representations of one or more previously-generated memory collections, including representation 1208c, representation 1208d, and representation 1208e that, when selected, cause computer system 600 to initiate playback of a corresponding memory collection. User interface 1208 also includes option 1208b that, when selected, initiates a process for generating a new memory collection based on a user-provided text prompt. Accordingly, option 1208b provides the user with another avenue by which to generate new memory collections based on a user-provided text prompt in addition to option 1200a discussed above. In some embodiments, option 1208b is persistently displayed within user interface 1208, even when option 1200a is not displayed within section 1200.

At FIG. 12H, in response to user input 1206c in FIG. 12D, computer system 600 displays memory generation user interface 1210. Memory generation user interface 1210 includes selectable options 1212a-1212c. Option 1212a includes a first set of suggested text for generating a memory collection and, when selected, initiates a process for generating a memory collection based on the first set of suggested text, as will be described in greater detail below. Option 1212b includes a second set of suggested text for generating a memory collection and, when selected, initiates a process for generating a memory collection based on the second set of suggested text. Option 1212c includes a third set of suggested text for generating a memory collection and, when selected, initiates a process for generating a memory collection based on the third set of suggested text. In some embodiments, the suggested text displayed in selectable options 1212a-1212c is determined based on metadata associated with media items contained in the media library. For example, the metadata identifies one or more concepts and/or objects depicted in the media items, the locations at which media items were captured, and/or the times and/or dates at which media items were captured.

Memory generation user interface 1210 also include text field 1214a, which displays text that has been entered and/or selected by the user, and keyboard 1214b for the user to enter text into text field 1214a. Text field 1214a-1 is displayed with transmit option 1214a-1 which, when selected, causes computer system 600 to begin generation of a memory collection based on the text that is displayed within text field 1214a. In some embodiments, computer system 600 generates the memory collection. In some embodiments, one or more external computer systems generate the memory collection, and in response to a user input selecting transmit option 1214a-1, computer system 600 transmits a request, including the text displayed in text field 1214a, to the one or more external computer systems. Memory generation user interface 1210 also includes microphone option 1214c that, when selected, causes computer system 600 to receive audio input (e.g., spoken input) to enter text into text field 1214a.

In FIG. 12H, text field 1214a displays the text “All the Birds I saw in 2023” in response to user input 1206c in FIG. 12D and/or based on the user selecting selectable option 1200a-1 in FIG. 12D. In some embodiments, a user can revise the text that is prefilled in text field 1214a (e.g., via keyboard 1214b and/or microphone option 1214c). Additionally, in FIG. 12H, selectable option 1212b includes the suggested text from selectable option 1212a-2 in FIG. 12D, and selectable option 1212c includes the suggested text from selectable option 1212a-3 in FIG. 12D, but selectable option 1212a includes new suggested text based on the user selecting selectable option 1200a-1 in FIG. 12D and the suggested text from selectable option 1200a-1 already being added to text field 1214a.

At FIG. 12I, in response to user input 1206d in FIG. 12D, computer system 600 displays memory generation user interface 1210. Memory generation user interface 1210 once again includes selectable options 1212a-1212c, text field 1214a, and keyboard 1214b. However, based on user input 1206d in FIG. 12D selecting selectable option 1200a-2, text field 1214a is pre-filled with the suggested text corresponding to selectable option 1200a-2, e.g., “Playing Pickleball With Brian and Maddie.” In FIG. 12I, selectable option 1212a includes the suggested text from selectable option 1212a-1 in FIG. 12D, and selectable option 1212c includes the suggested text from selectable option 1212a-3 in FIG. 12D, but selectable option 121ba includes new suggested text based on the user selecting selectable option 1200a-2 in FIG. 12D and the suggested text from selectable option 1200a-2 already being added to text field 1214a.

At FIG. 12J, in response to user input 1206e in FIG. 12D, computer system 600 displays memory generation user interface 1210. However, because the user did not select any of the suggested text in FIG. 12D, computer system 600 displays text field 1214a without any pre-filled text, and selectable options 1212a-1212c include the same suggested text that was shown in 1200a-1 through 1200a-3, respectively. FIG. 12J depicts two example scenarios in which computer system 600 receives two different user inputs: user input 1212a, which is a tap input corresponding to selection of selectable option 1212a, and user input 1212b, which is one or more user inputs interacting with keyboard 1214b. Each of these scenarios and user inputs will be discussed below.

At FIG. 12K, in response to user input 1216a in FIG. 12J, computer system 600 initiates generation of a new memory collection based on the text prompt “All the Birds I Saw in 2023,” which is the suggested text that was selected by the user by selecting selectable option 1212a. In some embodiments, computer system 600 initiates generation of the new memory collection by providing the text prompt to one or more external computer systems that are tasked with generating the new memory collection (e.g., based one or more artificial intelligence processes and/or one or more generative AI processes).

While the new memory collection is being generated, at FIG. 12K, computer system 600 displays animation 1218a and also displays text field 1214a that displays the text prompt based on which the memory collection is being generated. Animation 1218a includes media item region 1218a-1 and text region 1218a-2. Media item region 1218a-1 displays various media items from the media library corresponding to the user that are responsive to the text prompt provided by the user. Text region 1218a-2 displays various words and/or phrases that are related to the text prompt provided by the user. In some embodiments, the words and/or phrases that are displayed in text region 1218a-2 as part of animation 1218a include at least one or more words and/or phrases that are not explicitly included in the text prompt provided by the user (e.g., as displayed in text field 1214a). In some embodiments, the media items displayed in media item region 1218a-1 and/or the text displayed in text region 1218a-2 change over time as the animation progresses. In some embodiments, as animation 1218a progresses, the media items shown in media item region 1218a-1 become progressively more relevant to and/or responsive to the text prompt, and/or the text shown in text region 1218a-2 becomes progressively more relevant to and/or responsive to the text prompt.

At FIG. 12L, computer system 600 displays continued progression of animation 1218a. In some embodiments, as animation 1218a progresses, the media items shown in media item region 1218a-1 move and/or change in size to form a grid pattern, and the media items in media item region 1218a-1 move closer to forming a tight grid with equally sized, non-overlapping, adjacent media items. At FIG. 12M, animation 1218a is nearly completed, and the media items in media item region have aligned to form a grid with equally-sized media items directly adjacent to one another.

Furthermore, in some embodiments, as animation 1218a nears its end, a media item that is chosen as the first media item in the memory collection is displayed in the top left corner of media item region 1218a-1. In FIG. 12M, media item 1220a has been selected as the first media item in the memory collection, and is displayed in the top left corner of media item region 1218a-1. At FIG. 12N, as animation 1218a concludes, media item 1220a is animated such that it increases in size until in FIG. 12O, media item 1220a is displayed taking up the entire display region. Additionally, in FIG. 12O, playback of memory collection 1222a begins, with media item 1220a displayed concurrently with memory collection title 1222a-2, and computer system 600 outputs audio output 1222a-3 that is part of newly generated memory collection 1222a. At FIG. 12O, computer system 600 displays option 1222a-1 which, when selected, ceases and/or ends playback of memory collection 1222a.

At FIG. 12P, computer system 600 continues playback of memory collection 1222a, including displaying a subsequent media item 1222a-4 and continuing output of audio output 1222a-3. At FIG. 12Q, computer system 600 continues playback of memory collection 1222a, including displaying a subsequent media item 1222a-5 and continuing output of audio output 1222a-3.

At FIG. 12R, in response to user input 1216b in FIG. 12J, computer system 600 displays text within text field 1214a based on the user's interaction with keyboard 1214b. At FIG. 12R, computer system 600 detects user input 1224 (e.g., a tap input and/or a selection input corresponding to selection of option 1214a-1).

At FIG. 12S, in response to user input 1224, computer system 600 initiates generation of a new memory collection based on the user-provided text (e.g., by generating the new memory collection and/or transmitting the user-provided text to one or more external computer systems for generation of the new memory collection). Additionally, at FIG. 12S, in response to user input 1224, computer system 600 displays animation 1218b and also displays text field 1214a that displays the text prompt based on which the memory collection is being generated. Animation 1218b includes media item region 1218b-1 and text region 1218b-2. Media item region 1218b-1 displays various media items from the media library that are responsive to the text prompt provided by the user. Text region 1218b-2 displays various words and/or phrases that are related to the text prompt provided by the user. In some embodiments, the words and/or phrases that are displayed in text region 1218b-2 as part of animation 1218b include at least one or more words and/or phrases that are not explicitly included in the text prompt provided by the user (e.g., as displayed in text field 1214a). In some embodiments, the media items displayed in media item region 1218b-1 and/or the text displayed in text region 1218b-2 change over time as the animation progresses. In some embodiments, as animation 1218b progresses, the media items shown in media item region 1218b-1 become progressively more relevant to and/or responsive to the text prompt, and/or the text shown in text region 1218b-2 becomes progressively more relevant to and/or responsive to the text prompt.

At FIG. 12T, computer system 600 displays continued progression of animation 1218b. In some embodiments, as animation 1218b progresses, the media items shown in media item region 1218b-1 move and/or change in size to form a grid pattern, and the media items in media item region 1218b-1 move closer to forming a tight grid with equally sized, non-overlapping, adjacent media items. At FIG. 12U, animation 1218b is nearly completed, and the media items in media item region have aligned to form a grid with equally-sized media items directly adjacent to one another. Furthermore, in some embodiments, as animation 1218b nears its end, a media item that is chosen as the first media item in the memory collection is displayed in the top left corner of media item region 1218b-1. In FIG. 12U, media item 1220b has been selected as the first media item in the memory collection, and is displayed in the top left corner of media item region 1218b-1. At FIG. 12V, as animation 1218b concludes, media item 1220b is animated such that it increases in size until in FIG. 12W, media item 1220b is displayed taking up the entire display region. Additionally, in FIG. 12W, playback of memory collection 1222b begins, with media item 1220b displayed concurrently with memory collection title 1222b-2, and computer system 600 outputs audio output 1222b-3 that is part of newly generated memory collection 1222b. At FIG. 12W, computer system 600 displays option 1222b-1 which, when selected, ceases and/or ends playback of memory collection 1222b.

At FIG. 12X, computer system 600 continues playback of memory collection 1222b, including displaying a subsequent media item 1222b-4 and continuing output of audio output 1222b-3. At FIG. 12Y, computer system 600 continues playback of memory collection 1222b, including displaying a subsequent media item 1222b-5 and continuing output of audio output 1222b-3. At FIG. 12Y, computer system 600 detects user input 1227 (e.g., a tap input and/or a selection input corresponding to selection of option 1222b-1).

At FIG. 12Z, in response to user input 1227, computer system 600 ceases playback of memory collection 1222b, and displays user interface 1226. User interface 1226 includes options 1226a-1226d, platter 1226e, and text field 1214a. Option 1226a, when selected, causes computer system 600 to add memory collection 1222b to a set of favorite memory collections. Option 1226b, when selected, causes computer system 600 to initiate a process for sharing memory collection 1222b to one or more external computer systems and/or one or more external users. Option 1226c, when selected, causes computer system 600 to cease display of user interface 1226. Option 1226d, when selected, causes computer system 600 to initiate a process for generating a new memory collection that is different from memory collection 1222b based on the same text prompt that was used to create memory collection 1222b, as shown in text field 1214a. Platter 1226e represents memory collection 1222b. In some embodiments, platter 1226e, when selected, causes computer system 600 to restart playback of memory collection 1222b and/or resume playback of memory collection 1222b. At FIG. 12Z, computer system 600 detects user input 1228 (e.g., a tap input and/or a selection input corresponding to selection of option 1226d).

At FIG. 12AA, in response to user input 1228, computer system 600 initiates generation of a new memory collection based on the user-provided text that is shown in text field 1214a, and displays animation 1218c indicating that the new memory collection is being created. In various embodiments, animation 1218c incorporates the same features and characteristics as those described above with reference to animations 1218a, 1218b. At FIG. 12AB, animation 1218c concludes with media item 1220c growing in size until in FIG. 12AB, media item 1220c occupies the entire display region, and computer system 600 initiates playback of newly created memory collection 1222c. In the depicted embodiments, initiating playback of newly created memory collection 1222c includes displaying first media item 1220c and title information 1222c-2, and outputting audio track 1222c-3. In some embodiments, audio track 1222c-3 is selected by computer system 600 and/or one or more external computer systems based on the text prompt provided by the user including the terms “an upbeat vibe.” For example, audio track 1222c-3 is selected based on audio track 1222c-3 being determined to have musical qualities that correspond to the phrase “upbeat vibe” (e.g., based on beats per minute and/or tempo information, musical cords and/or notes present in audio track 1222c-3, and/or metadata associated with audio track 1222c-3).

At FIG. 12AD, playback of memory collection 1222c has completed (e.g., computer system 600 has reached the end of memory collection 1222c). In response to completing playback of memory collection 1222c, computer system 600 displays user interface 1230. User interface 1230 includes options 1230a-d, and platter 1230e. Option 1230a, when selected, causes computer system 600 to add memory collection 1222c to a set of favorite memory collections. Option 1230b, when selected, causes computer system 600 to initiate a process for sharing memory collection 1222c to one or more external computer systems and/or one or more external users. Option 1230c, when selected, causes computer system 600 to cease display of user interface 1230. Option 1230d, when selected, causes computer system 600 to initiate a process for generating a new memory collection that is different from memory collection 1222c based on the same text prompt that was used to create memory collection 1222c.

Platter 1230e includes selectable options 1232a-1232c. Option 1232a includes a first set of suggested text for generating a memory collection and, when selected, initiates a process for generating a memory collection based on the first set of suggested text. Option 1232b includes a second set of suggested text for generating a memory collection and, when selected, initiates a process for generating a memory collection based on the second set of suggested text. Option 1232c includes a third set of suggested text for generating a memory collection and, when selected, initiates a process for generating a memory collection based on the third set of suggested text. In some embodiments, the suggested text displayed in selectable options 1232a-1232c is determined based on metadata associated with media items contained in the media library. FIG. 12AD depicts two example scenarios in which computer system 600 detects two different user inputs: user input 1234a (e.g., a swipe left user input within platter 1230e); and user input 1234b (e.g., a tap input and/or a selection input corresponding to selection of selectable option 1232c). Each of these example scenarios and user inputs will be discussed below.

At FIG. 12AE, in response to user input 1234a in FIG. 12AD, computer system 600 displays scrolling of platter 1230e and displays platter 1236a. Platter 1236a includes four different regions 1236a-1236d. Region 1236a corresponds to generation of a new memory collection and, when selected, causes computer system 600 to display memory generation user interface 1210. Region 1236b corresponds to a memory collection entitled “Cosmo,” and when selected, causes computer system 600 to initiate playback of the memory collection entitled “Cosmo.” Region 1236c corresponds to a memory collection entitled “Beach Days 2017,” and when selected, causes computer system 600 to initiate playback of the memory collection entitled “Beach Days 2017.” Region 1236d corresponds to a memory collection entitled “Ingrid 2013,” and when selected, causes computer system 600 to initiate playback of the memory collection entitled “Ingrid 2013.”

At FIG. 12AF, in response to user input 1234b in FIG. 12AD, computer system 600 displays memory generation user interface 1210. At FIG. 12AF, text field 1214a is pre-filled with the text that was displayed in selectable option 1232c based on user selection of selectable option 1232c. At FIG. 12AF, computer system 600 detects user input 1236, which includes one or more user inputs interacting with keyboard 1214b.

At FIG. 12AG, in response to user input 1236, computer system 600 updates display of text field 1214a to include the additional terms “at her house” such that text field 1214a now includes the text “Selfies with Grandma at her house.” At FIG. 12AG, computer system 600 detects user input 1238 (e.g., a tap input and/or selection input corresponding to selection of transmit option 1214a-1).

At FIG. 12AH, in response to user input 1238, computer system 600 initiates generation of a new memory collection based on the text prompt “Selfies with Grandma at her house,” and displays animation 1218d. In various embodiments, animation 1218d includes media item region 1218d-1 and text region 1218d-2, and incorporates the features and/or characteristics of animations 1218a, 1218b described above.

At FIG. 12AI, during animation 1218d, computer system 600 detects that user clarification is needed for one or more terms in the user-provided text prompt. At FIG. 12AI, computer system 600 and/or one or more external computer systems has determined that clarification of the term “Grandma” is needed (e.g., based on a lack of information about the term “Grandma” and/or a lack of information about who the user is referring to with the term “Grandma.”). At FIG. 12AI, based on a determination that user clarification is needed for the term “Grandma,” computer system 600 pauses and/or interrupts display of animation 1218d, and displays prompt 1240. Prompt 1240 prompts the user to choose a person that corresponds with the term “Grandma.” At FIG. 12AI, computer system 600 detects user input 1242 (e.g., a tap input and/or a selection input corresponding to selection of prompt 1242).

At FIG. 12AJ, in response to user input 1242, computer system 600 displays user interface 1244. User interface 1244 includes option 1244a, option 1244b, and images 1246a-1246f. Option 1244a, when selected, causes computer system 600 to cease display of user interface 1244. Option 1244b, when selected, causes computer system 600 to save and/or transmit user clarification information indicative of one or more selections made by the user within user interface 1244, and the user clarification information is used to generate the new memory collection. In some embodiments, images 1246a-1246f includes one or more images selected from the media library and that depict various individuals. A user can select one or more images to indicate which images depict the individual that the user was referring to with the term “Grandma.” At FIG. 12AJ, computer system 600 detects user input 1248 (e.g., a tap input and/or a selection input corresponding to selection of image 1246d). At FIG. 12AK, in response to user input 1248, computer system 600 displays image 1246d with selection indication 1246d-1. At FIG. 12AK, computer system 600 detects user input 1249 corresponding to selection of option 1244b.

At FIG. 12AL, in response to user input 1249, computer system 600 ceases display of user interface 1244, and saves and/or transmits information (e.g., to one or more external computer systems) corresponding to the user selection of image 1246d so that the information can be used to generate the new memory collection. In some embodiments and/or scenarios, in response to user input 1249, computer system 600 resumes and/or restarts animation 1218d. However, in FIG. 12AL, computer system 600 detects that user clarification is needed for one or more additional terms in the user-provided text prompt. At FIG. 12AL, computer system 600 and/or one or more external computer systems has determined that clarification of the phrase “her house” is needed (e.g., based on a lack of information about the phrase “her house” and/or a lack of information about what location the user is referring to with the phrase “her house”). At FIG. 12AL, based on a determination that user clarification is needed for the phrase “her house,” computer system 600 pauses and/or interrupts display of animation 1218d, and displays prompt 1250. Prompt 1250 prompts the user to specify a location that corresponds with the phrase “her house.” At FIG. 12AL, computer system 600 detects user input 1252 (e.g., a tap input and/or a selection input corresponding to selection of prompt 1250).

At FIG. 12AM, in response to user input 1252, computer system 600 displays user interface 1254. User interface 1254 includes option 1254a that, when selected, causes computer system 600 to cease display of user interface 1254. User interface 1254 also includes option 1254b that, when selected, causes computer system 600 to save and/or transmit (e.g., to one or more external computer systems) information entered into text field 1254c by the user (e.g., for use in generating the new memory collection). User interface 1254 also includes keyboard 1254d, via which a user is able to enter location information into text field 1254c. At FIG. 12AM, computer system 600 detects user input 1256a, which includes one or more user inputs interacting with keyboard 1256a. At FIG. 12AN, in response to user input 1256a, computer system 600 displays user-entered text within text field 1254c. At FIG. 12AN, computer system 600 detects user input 1256b (e.g., a tap input and/or a selection input corresponding to selection of option 1254b).

At FIG. 12AO, in response to user input 1256b, computer system 600 ceases display of user interface 1254, and re-displays (e.g., restarts and/or resumes) animation 1218d. In some embodiments, the terms “Grandma” and “her house” in text field 1214a are selectable by a user for the user to provide additional clarification about those terms and/or for the user to change the clarification information that the user provided about those terms. For example, in some embodiments, the term “Grandma” is selectable (e.g., user input 1219a) to re-display user interface 1244; and/or in some embodiments, the phrase “her house” is selectable (e.g., user input 1219b) to re-display user interface 1254.

At FIG. 12AP, animation 1218d concludes with media item 1220d growing in size until, in FIG. 12AQ, media item 1220d occupies the entirety of display 602, and computer system 600 initiates playback of new memory collection 1222d. In some embodiments, new memory collection 1222d has been generated using the user clarification information provided by the user via user interface 1244 and user interface 1254.

FIG. 12AR depicts different example scenarios and example prompts in which user clarification is needed to generate a new memory collection. In the left figure in FIG. 12AR, computer system 600 detects that user clarification is needed for the phrase “my friends,” and displays prompt 1258 prompting the user to choose one or more people to be included in the phrase “my friends.” In some embodiments, prompt 1258, when selected, displays a user interface within which the user can identify one or more individuals (e.g., user interface 1244). In the middle figure in FIG. 12AR, computer system 600 detects that user clarification is needed for the term “April.” In FIG. 12AR, a determination has been made (e.g., by computer system 600 and/or one or more external computer systems) that the term “April” can correspond to an individual or to the month April. Based on this determination, computer system 600 displays options 1260a-1260c. Option 1260a, which corresponds to the month April, and is selectable by a user to indicate that the user intended for the term “April” to mean the month of April. Option 1260b corresponds to a person named April Smith (e.g., a contact stored on computer system 600), and is selectable by a user to indicate that the user intended for the term “April” to mean the person April Smith. Option 1260c, when selected, causes computer system 600 to display a user interface via which the user can specify a person that the user intended the term “April” to refer to (e.g., user interface 1244). On the right side of FIG. 12AR, computer system 600 detects that user clarification is needed because media items corresponding to the user-provided text could not be identified. Accordingly, computer system 600 displays prompt 1262 requesting that the user identify one or more media items that are responsive to the user-provided prompt.

FIGS. 12AS-12AT depict example scenarios in which computer system 600 detects that the user-provided text prompt includes one or more impermissible and/or disallowed concepts. For example, impermissible, unavailable, high risk, and/or disallowed concepts can include inappropriate concepts, illegal concepts, concepts that violate copyright and/or trademark, concepts that violate user privacy, and/or other impermissible concepts. At FIG. 12AT, based on a determination that the user-provided text requests use of a third-party style, computer system 600 displays prompt 1264 indicating that the user-provided text includes impermissible, unavailable, high risk, and/or disallowed concepts.

FIG. 12AU depicts an example scenario in which computer system 600 detects that a memory collection generation service is not available. Based on this determination, computer system 600 displays user interface 1266.

FIG. 13 is a flow diagram illustrating methods of generating and/or presenting content in accordance with some embodiments. Method 1300 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 602) (e.g., a touch-sensitive surface, a touch-sensitive display, a button, a rotatable input mechanism, a depressible and rotatable input mechanism, a camera, an accelerometer, and/or an inertial measurement unit (IMU)). Some operations in method 1300 are, optionally, combined, the orders of some operations are, optionally, changed, and some operations are, optionally, omitted.

As described below, method 1300 provides an intuitive way for generating and/or presenting content. The method reduces the cognitive burden on a user for generating and/or accessing content, thereby creating a more efficient human-machine interface. For battery-operated computing devices, enabling a user to navigate and/or access content faster and more efficiently conserves power and increases the time between battery charges.

The computer system (e.g., 600) concurrently displays (1302), via the one or more display generation components (e.g., 602): a representation of a media library (e.g., 610, 612a, and/or 615) (1308) (e.g., a media library associated with the computer system; a media library associated with a user (e.g., a user of the computer system); and/or a media library associated with a user account) (e.g., a user interface and/or a portion of a user interface that is representative of and/or corresponds to the media library; a user interface and/or a portion of a user interface that displays thumbnails of a subset of media items from the media library; and/or a user interface and/or a portion of a user interface that represents and/or corresponds to a subset of the media library), wherein the media library includes a plurality of media items (e.g., images, photos, and/or videos) including a first media item and a second media item different from the first media item and the representation of the media library includes representations (e.g., previews, thumbnails, snapshots, and/or frames) of multiple different media items (e.g., a first subset and/or a first plurality) from the media library; and a memory generation option (e.g., 1200a) (1310) (e.g., a button and/or an affordance) (e.g., a memory generation option that, when selected, causes the computer system to initiate a process for generating a memory collection (e.g., an automatically-generated memory collection and/or generative memory collection content; automatically-generated visual content and/or generative visual content; and/or automatically-generated audio content and/or generative audio content) that includes a plurality of media items that are selected from the media library based on a respective set of terms (e.g., a respective set of terms entered by a user and/or an automatically generated respective of terms) without user selection of the plurality of media items to be included in the memory collection (e.g., automatically and/or using an AI process or a generative AI process)). While concurrently displaying the representation of the media library and the memory generation option (1312), the computer system receives (1314), via the one or more input devices, a selection input (e.g., 1206a, 1206c, 1206d, and/or 1206e) (e.g., one or more inputs) (e.g., one or more touch inputs, one or more gesture inputs, one or more air gesture inputs, one or more spoken inputs, and/or one or more hardware inputs) corresponding to selection of the memory generation option (e.g., 1200a). In response to receiving the selection input corresponding to selection of the memory generation option (1316): the computer system initiates (1318) a process for generating a memory collection (e.g., FIGS. 12I-12W) (e.g., a slideshow, a slideshow video, and/or an animation that displays a plurality of media items from the media library over time) (e.g., an automatically-generated memory collection and/or a generative memory collection that includes automatically-generated visual content and/or generative visual content; and/or automatically-generated audio content and/or generative audio content) that includes a plurality of media items that are automatically selected (e.g., using an AI process or a generative AI process) (e.g., selected by the computer system and/or by one or more external computer systems separate from the computer system (e.g., one or more remote servers)) from the media library based on a respective set of terms (e.g., a set of terms entered by a user and/or an automatically generated (e.g., using an AI process or a generative AI process) set of suggested terms that are accepted by the user) wherein the plurality of media items includes one or more media items that were not selected by the user to be included in the memory collection. In some embodiments, the memory collection comprises and/or is a slideshow that displays a plurality of media items over time. In some embodiments, the memory collection includes an ordered set of media items that are displayed over time during playback of the memory collection. In some embodiments, the memory collection is set to music (e.g., 1222a-3, 1222b-3, and/or 1222c-1). In some embodiments, the music is automatically selected (e.g., using an AI process or a generative AI process) (e.g., by the computer system and/or one or more external computer systems separate from the computer system) and/or automatically applied (e.g., using an AI process or a generative AI process) to the memory collection. In some embodiments, the memory collection includes one or more transitions (e.g., a plurality of transitions) that are applied between media items and/or collections of media items. In some embodiments, the one or more transitions are automatically generated transitions (e.g., using an AI process or a generative AI process) (e.g., by the computer system and/or one or more external computer systems separate from the computer system) and/or automatically applied transitions (e.g., using an AI process or a generative AI process). In some embodiments, the memory collection includes one or more headers (e.g., 1222a-2, 1222b-2, and/or 1222c-2) (e.g., titles, text headers, and/or other headers) that are displayed during playback of the memory collection. In some embodiments, the one or more headers are automatically selected, generated, and/or applied (e.g., using an AI process or a generative AI process) (e.g., by the computer system and/or one or more external computer systems separate from the computer system). In some embodiments, the memory collection can be paused (e.g., via user input) during playback. In some embodiments, a user can navigate through different media items in the memory collection (e.g., via user input) during playback of the memory collection. For example, in some embodiments, in response to a first user input during playback of the memory collection, the computer system navigates to and/or displays a previous media item (e.g., in an ordered sequence of media items), and in response to a second user input during playback of the memory collection, the computer system navigates to and/or displays a subsequent media item (e.g., in an ordered sequence of media items). In some embodiments, initiating the process for generating a memory collection that includes a plurality of media items that are automatically selected from the media library based on the respective set of terms includes: in accordance with a determination that the respective set of terms includes a first set of terms, initiating a process for generating (e.g., generating and/or causing one or more external computer systems to generate) a first memory collection that includes a first plurality of media items that are automatically selected (e.g., using an AI process or a generative AI process) from the media library based on the first set of terms (e.g., FIGS. 12J-12Q); and in accordance with a determination that the respective set of terms includes a second set of terms different from the first set of terms, initiating a process for generating (e.g., generating and/or causing one or more external computer systems to generate) a second memory collection that is different from the first memory collection and includes a second plurality of media items that are automatically selected (e.g., using an AI process or a generative AI process) from the media library based on the second set of terms, wherein the second plurality of media items are different from the first plurality of media items (e.g., FIGS. 12R-12W). Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system (e.g., 600) displays, via the one or more display generation components and concurrently with the memory generation option (e.g., 1200a), representations of (e.g., previews, thumbnails, cover photos, snapshots, frames, and/or graphical user interface objects) one or more featured media items that have been automatically selected (e.g., using an AI process or a generative AI process) (e.g., by the computer system and/or one or more external computer systems separate from the computer system) from the media library (e.g., 612b, 612c, 612e, and/or 612f) (e.g., images, photos, and/or videos selected (e.g., automatically selected) by the computer system (e.g., based on selection criteria)). In some embodiments, the representations of one or more featured media items are displayed as part of the representation of the media library (e.g., 610). In some embodiments, the representations of one or more featured media items are displayed concurrently with the representation of the media library (e.g., 615). In some embodiments, the memory collection is, optionally, generated based on an artificial intelligence (AI) process such as a generative AI process that takes the media library (e.g., including media items; metadata associated with the media library; and/or metadata associated with the media items), and the respective set of terms as part of a prompt and/or an input to generate the memory collection. Displaying a memory generation option that, when selected, initiates a process for generating a memory collection (e.g., an automatically-generated memory collection and/or a generative memory collection that includes automatically-generated visual content and/or generative visual content; and/or automatically-generated audio content and/or generative audio content) based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the representations of one or more featured media items that have been automatically selected from the library (e.g., using an AI process or a generative AI process) include representations of one or more memory collections (e.g., 1200b, 1200c, and/or 1200d) (e.g., slideshows, slideshow videos, and/or animations that display a plurality of media items from the media library over time) that have been generated (e.g., by the computer system and/or one or more external computer systems separate from the computer system) (e.g., automatically or based on user input) using media items from the media library (e.g., automatically-generated memory collections and/or a generative memory collections that include automatically-generated visual content and/or generative visual content; and/or automatically-generated audio content and/or generative audio content). In some embodiments, the representations of one or more memory collections include a representation of a first memory collection that has been generated (e.g., an automatically-generated memory collection and/or a generative memory collection that includes automatically-generated visual content and/or generative visual content; and/or automatically-generated audio content and/or generative audio content) using a first set of media items from the media library; and a representation of a second memory collection that is different from the first memory collection and that has been generated (e.g., an automatically-generated memory collection and/or a generative memory collection that includes automatically-generated visual content and/or generative visual content; and/or automatically-generated audio content and/or generative audio content) using a second set of media items from the media library that is different from the first set of media items. Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, playback of a first memory collection (e.g., 1222a, 1222b, 1222c, and/or 1222d) (e.g., a slideshow, a slideshow video, and/or a video animation that displays a plurality of media items from the media library over time) that includes a first plurality of media items from the media library. In some embodiments, the computer system completes playback of the first memory collection (e.g., the end of the first memory collection has been reached and/or a user has terminated playback of the memory collection) (e.g., FIG. 12AD). After playback of the first memory collection has completed (e.g., immediately after, in response to completing, or in response to completing playback), the computer system displays, via the one or more display generation components, the memory generation option (e.g., 1230e) (e.g., a memory generation option that, when selected, causes the computer system to initiate a process for generating a memory collection (e.g., an automatically-generated memory collection and/or a generative memory collection that includes automatically-generated visual content and/or generative visual content; and/or automatically-generated audio content and/or generative audio content) that includes a plurality of media items that are automatically selected (e.g., using an AI process or a generative AI process) (e.g., selected by the computer system) from the media library based on a respective set of terms (e.g., a set of terms entered by a user and/or an automatically generated set of suggested terms that are accepted by the user) wherein the plurality of media items includes one or more media items that were not selected by the user to be included in the memory collection). In some embodiments, after playback of the first memory collection has completed, the computer system concurrently displays the representation of the media library (e.g., 1230f in FIGS. 12AD-12AE) and the memory generation option (e.g., 1230e). Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the representation of the media library (e.g., 612b, 612c, 612d, 612e, 1200b, 1200c, and/or 1200d) and the memory generation option (e.g., 1200a) are part of a first user interface (e.g., 610). In some embodiments, at a first time subsequent to concurrently displaying the representation of the media library and the memory generation option, the computer system receives, via the one or more input devices, a user request to display the first user interface (e.g., 610) (e.g., one or more inputs) (e.g., one or more touch inputs, one or more gesture inputs, one or more air gesture inputs, one or more spoken inputs, and/or one or more hardware inputs). In response to receiving the user request to display the first user interface, the computer system displays, via the one or more display generation components, the first user interface (e.g., 610), including: in accordance with a determination that a memory collection generation service (e.g., a service provided by and/or performed by one or more external computer systems separate from the computer system) is in a first state (e.g., the memory collection generation service is operating; the memory collection generation service is available; and/or the memory collection generation service has greater than a threshold amount of bandwidth available), displaying, within the first user interface, the memory generation option (e.g., 1200a) (e.g., as shown in FIGS. 12A-1 through 12D; and/or at the top of FIG. 12F-1); and in accordance with a determination that the memory collection generation service is in a second state different from the first state (e.g., the memory collection generation service is not operating; the memory collection generation service is not available; and/or the memory collection generation service has less than a threshold amount of bandwidth available), forgoing displaying the memory generation option within the first user interface (e.g., as shown at the bottom of FIG. 12F-1 and/or in FIG. 12F-2). Displaying the memory generation option when the memory collection generation service is in a first state (e.g., operating correctly and/or efficiently) and forgoing display of the memory generation option when the memory collection generation service is in a second state (e.g., not operating and/or operating slowly) enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Furthermore, doing so also provides the user with visual feedback about a state of the system (e.g., whether or not the memory collection generation service is available).

In some embodiments, the first state and the second state are based on a server load of requests to generate memory collections at the memory collection generation service. In some embodiments, the first state corresponds to a smaller server load of requests to generate memory collections than the second state. In some embodiments, the first state is indicative of less than a threshold amount of server load (e.g., greater than a threshold amount of server bandwidth available), and the second state is indicative of greater than the threshold amount of server load (e.g., less than a threshold amount of server bandwidth available). Displaying the memory generation option when the memory collection generation service is in a first state (e.g., operating correctly and/or efficiently) and forgoing display of the memory generation option when the memory collection generation service is in a second state (e.g., not operating and/or operating slowly) enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Furthermore, doing so also provides the user with visual feedback about a state of the system (e.g., whether or not the memory collection generation service is available).

In some embodiments, while the memory collection generation service is in the first state, the computer system receives, via the one or more input devices, a first user input (e.g., 1206b) corresponding to a request to display a second user interface (e.g., 1208) (e.g., one or more inputs) (e.g., one or more touch inputs, one or more gesture inputs, one or more air gesture inputs, one or more spoken inputs, and/or one or more hardware inputs). In response to receiving the first user input, the computer system displays, via the one or more display generation components, the second user interface (e.g., 1208) with a second memory generation option (e.g., 1208b) different from the memory generation option (e.g., 1200a) (e.g., visually different from the memory generation; displayed in a different user interface than the memory generation option; and/or displayed in a different position within a user interface than the memory generation option) while the memory collection generation service is in the first state, wherein the second memory generation option (e.g., 1208b), when selected, causes the computer system to initiate a process for generating a memory collection (e.g., a slideshow, a slideshow video, and/or an animation that displays a plurality of media items from the media library over time) (e.g., an automatically-generated memory collection and/or a generative memory collection that includes automatically-generated visual content and/or generative visual content; and/or automatically-generated audio content and/or generative audio content) that includes a plurality of media items that are automatically selected (e.g., using an AI process or a generative AI process) (e.g., selected by the computer system and/or by one or more external computer systems separate from the computer system (e.g., one or more remote servers)) from the media library based on a respective set of terms (e.g., a set of terms entered by a user and/or an automatically generated set of suggested terms that are accepted by the user) wherein the plurality of media items includes one or more media items that were not selected by the user to be included in the memory collection. While the memory collection generation service is in the second state, the computer system receives, via the one or more input devices, a second user input (e.g., 1206b) corresponding to a request to display the second user interface (e.g., 1208) (e.g., one or more inputs) (e.g., one or more touch inputs, one or more gesture inputs, one or more air gesture inputs, one or more spoken inputs, and/or one or more hardware inputs). In response to receiving the second user input, the computer system displays, via the one or more display generation components, the second user interface (e.g., 1208) with the second memory generation option (e.g., 1208b) while the memory collection generation service is in the second state. In some embodiments, the second memory generation option (e.g., 1208b) is displayed and/or is selectable regardless of whether the memory collection generation service is in the first state or the second state. In some embodiments, while displaying the second memory generation option, the computer system receives, via the one or more input devices, a selection input corresponding to selection of the second memory generation option; and in response to receiving the selection input corresponding to selection of the second memory generation option, the computer system initiates a process for generating a memory collection (e.g., a slideshow, a slideshow video, and/or an animation that displays a plurality of media items from the media library over time) (e.g., by displaying memory generation user interface 1210) (e.g., an automatically-generated memory collection and/or a generative memory collection that includes automatically-generated visual content and/or generative visual content; and/or automatically-generated audio content and/or generative audio content) that includes a plurality of media items that are automatically selected (e.g., using an AI process or a generative AI process) (e.g., selected by the computer system and/or by one or more external computer systems separate from the computer system (e.g., one or more remote servers)) from the media library based on a respective set of terms (e.g., a set of terms entered by a user and/or an automatically generated set of suggested terms (e.g., using an AI process or a generative AI process) that are accepted by the user) wherein the plurality of media items includes one or more media items that were not selected by the user to be included in the memory collection. Displaying a second memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first user input (e.g., 1206b) and the second user input (e.g., 1206b) correspond to user requests to display a memory collection user interface (e.g., 1208), wherein the memory collection user interface includes representations of a plurality of memory collections (e.g., 1208c, 1208d, and/or 1208e) (e.g., slideshows, slideshow videos, and/or animations that display a plurality of media items from the media library over time) that have been generated (e.g., by the computer system and/or one or more external computer systems separate from the computer system) (e.g., automatically or based on user input) (e.g., automatically-generated memory collections and/or generative memory collections that include automatically-generated visual content and/or generative visual content; and/or automatically-generated audio content and/or generative audio content) using media items from the media library, including a representation of a first memory collection that has been generated using a first set of media items from the media library and a representation of a second memory collection that is different from the first memory collection and that has been generated using a second set of media items from the media library that is different from the first set of media items; and the second memory generation option (e.g., 1208b) is displayed within the memory collection user interface (e.g., 1208). Displaying a second memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to improves the battery life of the device by enabling the user to use the system more quickly and

In some embodiments, while the memory collection generation service is in the second state, the computer system receives, via the one or more input devices, a user request (e.g., 1206a) (e.g., one or more inputs) (e.g., one or more touch inputs, one or more gesture inputs, one or more air gesture inputs, one or more spoken inputs, and/or one or more hardware inputs) to navigate (e.g., scroll and/or move) representations of one or more featured memory collections (e.g., 1200, 1200b, 1200c, and/or 1200d) (e.g., memory collections that have been selected by the computer system and/or one or more external computer systems for display within a user interface). In response to receiving the user request to navigate the representations of one or more featured memory collections (e.g., 1206a), the computer system displays, via the one or more display generation components, a third memory generation option (e.g., 1200a at the bottom of FIG. 12F-1) different from the memory generation option (e.g., visually different from the memory generation; displayed in a different user interface than the memory generation option; and/or displayed in a different position within a user interface than the memory generation option) while the memory collection generation service is in the second state, wherein the third memory generation option (e.g., 1200a at the bottom of FIG. 12F-1), when selected, causes the computer system to initiate a process for generating a memory collection (e.g., a slideshow, a slideshow video, and/or an animation that displays a plurality of media items from the media library over time) (e.g., an automatically-generated memory collection and/or a generative memory collection that includes automatically-generated visual content and/or generative visual content; and/or automatically-generated audio content and/or generative audio content) that includes a plurality of media items that are automatically selected (e.g., using an AI process or a generative AI process) (e.g., selected by the computer system and/or by one or more external computer systems separate from the computer system (e.g., one or more remote servers)) from the media library based on a respective set of terms (e.g., a set of terms entered by a user and/or an automatically generated set of suggested terms (e.g., generated using an AI process or a generative AI process) that are accepted by the user) wherein the plurality of media items includes one or more media items that were not selected by the user to be included in the memory collection. In some embodiments, while displaying the third memory generation option (e.g., 1200a at the bottom of FIG. 12F-1), the computer system receives, via the one or more input devices, a selection input corresponding to selection of the third memory generation option; and in response to receiving the selection input corresponding to selection of the third memory generation option, the computer system initiates a process for generating a memory collection (e.g., a slideshow, a slideshow video, and/or an animation that displays a plurality of media items from the media library over time) (e.g., by displaying user interface 610) (e.g., an automatically-generated memory collection and/or a generative memory collection that includes automatically-generated visual content and/or generative visual content; and/or automatically-generated audio content and/or generative audio content) that includes a plurality of media items that are automatically selected (e.g., using an AI process or a generative AI process) (e.g., selected by the computer system and/or by one or more external computer systems separate from the computer system (e.g., one or more remote servers)) from the media library based on a respective set of terms (e.g., a set of terms entered by a user and/or an automatically generated set of suggested terms (e.g., generated using an AI process or a generative AI process) that are accepted by the user) wherein the plurality of media items includes one or more media items that were not selected by the user to be included in the memory collection. Displaying a third memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

While the memory generation option (e.g., 1200a) is not displayed, the computer system receives, via the one or more input devices, a navigation input (e.g., 1204a) (e.g., one or more inputs) (e.g., one or more touch inputs, one or more gesture inputs, one or more air gesture inputs, one or more spoken inputs, and/or one or more hardware inputs) (e.g., a navigation input corresponding to a user request to scroll and/or otherwise navigate a respective user interface). In response to receiving the navigation input, the computer system displays, via the one or more display generation components, the memory generation option (e.g., 1200a in FIG. 12B); and displays, via the one or more display generation components, scrolling of (e.g., movement of) the memory generation option (e.g., 1200a in FIGS. 12B-12D). At a first respective time during scrolling of the memory generation option and while a first portion of the memory generation option is displayed (e.g., 1200a in FIG. 12B), where the first portion is less than all of the memory generation option (e.g., a portion of the memory generation option is displayed via the one or more display generation components and a different portion of the memory generation option is not displayed via the one or more display generation components), the computer system displays the memory generation option with playback of animated content (e.g., moving content; and/or moving content that displays one or more media items from the media library) (in some embodiments, the animated content includes playback of a first video from the media library) (in some embodiments, the animated content includes playback of a first video from the media library at a slowed down speed) (e.g., 1200a in FIGS. 12B-12C shows animation within 1200a), wherein the playback of the animated content is displayed with a first set of visual characteristics (e.g., non-blurred and/or with a first level of blurring (e.g., no blurring); at a first level of color saturation and/or a default level of color saturation; and/or undimmed, at a first level of brightness, and/or at a default brightness level); and at a second respective time subsequent to the first respective time, and while a second portion of the memory generation option is displayed (e.g., 1200a in FIG. 12D), wherein the second portion includes the first portion and is larger than the first portion (e.g., more of, or the entirety of, the memory generation option is displayed via the one or more display generation components), the computer system displays the memory generation option with continued playback of the animated content, wherein the continued playback of the animated content is displayed with a second set of visual characteristics different from the first set of visual characteristics (e.g., in FIG. 12D, the animation is blurred and/or darkened) (e.g., blurred and/or with a second level of blurring that is more blurred than the first set of visual characteristics; desaturated and/or with a second level of color saturation that is less saturated than the first set of visual characteristics; and/or dimmed and/or at a second level of brightness that is less bright than the first set of visual characteristics). Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the memory generation option with continued playback of the animated content further comprises: while the second portion of the memory generation option is displayed (e.g., 1200a in FIG. 12D), displaying, within the memory generation option (e.g., 1200a) and overlaid on the continued playback of the animated content, a first set of information (e.g., 1200a-1, 1200a-2, and/or 1200a-3), wherein the first set of information is not displayed while the first portion of the memory generation option is displayed without displaying the second portion of the memory generation option (e.g., 1200a in FIGS. 12B-12C) (e.g., is not displayed prior to the memory generation option being entirely displayed and/or prior to the second portion of the memory generation option being displayed). In some embodiments, the first set of information includes a first set of terms (e.g., a first predetermined set of terms and/or a first suggested set of terms). In some embodiments, the first set of information includes a second set of terms (e.g., a second predetermined set of terms and/or a second suggested set of terms). In some embodiments, the first set of information includes one or more instructions for generating a memory collection. Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the memory generation option (e.g., 1200a) includes: a first selection target (e.g., 1200a-1) (e.g., a first user interface object; a first affordance; and/or a first portion of); and a second selection target (e.g., 1200a-2) different from the first selection target (e.g., a second user interface object and/or a second affordance); and while displaying the memory generation option with the first set of information, the computer system receives, via the one or more input devices, a selection input (e.g., 1206c, 1206d, and/or 1206e) (e.g., one or more inputs) (e.g., one or more touch inputs, one or more gesture inputs, one or more air gesture inputs, one or more spoken inputs, and/or one or more hardware inputs) (e.g., a navigation input corresponding to a user request to scroll and/or otherwise navigate a respective user interface). In response to receiving the selection input: in accordance with a determination that the selection input corresponds to selection of the first selection target (e.g., user input 1206c selecting option 1200a-1), the computer system displays, via the one or more display generation components, a memory generation user interface (e.g., 1210) in a first state (e.g., with a first set of information displayed and/or with a first set of visual components) (e.g., 1210 in FIG. 12H); and in accordance with a determination that the selection input corresponds to selection of the second selection target (e.g., user input 1206d selecting option 1200a-2), the computer system displays, via the one or more display generation components, the memory generation user interface (e.g., 1210) in a second state different from the first state (e.g., with a second set of information displayed and/or with a second set of visual components) (e.g., 1210 in FIG. 12I). Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first selection target (e.g., 1200a-1, 1200a-2, and/or 1200a-3) corresponds to a first set of terms (e.g., a first set of words; a first set of text characters; and/or a first set of phrases). Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the second selection target (e.g., 1200a-1, 1200a-2, and/or 1200a-3) corresponds to a second set of terms different from the first set of terms (e.g., a first set of words; a first set of text characters; and/or a first set of phrases). In some embodiments, the memory generation user interface (e.g., 1210) includes a text entry field (e.g., 1214a) (e.g., a term input field; a search field; and/or a field into which text can be entered (e.g., by a user)). In some embodiments, in response to receiving the selection input: in accordance with a determination that the selection input corresponds to selection of the first selection target (e.g., user input 1206c selecting option 1200a-1), the computer system displays, via the one or more display generation components, the first set of text within the text entry field without displaying the second set of text within the text entry field (e.g., 1214a in FIG. 12H); and in accordance with a determination that the selection input corresponds to selection of the second selection target (e.g., user input 1206d selecting option 1200a-2), the computer system displays, via the one or more display generation components, the second set of text within the text entry field without displaying the first set of text within the text entry field (e.g., 1214a in FIG. 12I). Displaying a memory generation option that includes multiple suggested sets of terms that, when selected, initiate a process for generating a memory collection based on the selected set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to receiving the selection input: in accordance with a determination that the selection input corresponds to selection of the first selection target (e.g., user input 1206c selecting option 1200a-1), the computer system displays, via the one or more display generation components, a first animation in which the first set of text is moved into the text entry field (e.g., from the memory generation option) (e.g., 1214a in FIG. 12H); and in accordance with a determination that the selection input corresponds to selection of the second selection target (e.g., user input 1206d selecting option 1200a-2), displaying, via the one or more display generation components, a second animation in which the second set of text is moved into the text entry field (e.g., from the memory generation option) (e.g., 1214a in FIG. 12I). Displaying a memory generation option that includes multiple suggested sets of terms that, when selected, initiate a process for generating a memory collection based on the selected set of terms allows the user to generate memory collections with fewer inputs. Additionally, displaying an animation in which the selected text moves into the text entry field provides the user with an indication that selection of a set of terms causes the set of terms to be displayed in the text entry field. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the second selection target corresponds to no terms (e.g., in some embodiments, the second selection target is and/or includes the portions of option 1200a in FIG. 12D that are not within any of selectable options 1200a-1 through 1200a-3) (e.g., in some embodiments, user input 1206e in FIG. 12D corresponds to selection of a second selection target that corresponds to no terms). In some embodiments, selection of the second selection target corresponds to selection of no terms; and/or selection of the second selection target corresponds to a user request to display the memory generation user interface (e.g., 1210) without terms entered into a text entry field (e.g., 1214a) (e.g., FIG. 12J). Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the memory generation user interface (e.g., 1210) includes a text entry field (e.g., 1214a) (e.g., a term input field; a search field; and/or a field into which text can be entered (e.g., by a user)). In some embodiments, in response to receiving the selection input: in accordance with a determination that the selection input corresponds to selection of the first selection target (e.g., user input 1206c selecting option 1200a-1), the computer system displays, via the one or more display generation components, a first animation in which the first set of text is moved into the text entry field (e.g., from the memory generation option) (e.g., 1214a in FIG. 12H); and in accordance with a determination that the selection input corresponds to selection of the second selection target (e.g., user input 1206e that does not select any of options 1200-1 through 1200a-3), the computer system displays, via the one or more display generation components, the text entry field without displaying an animation of text moving into the text entry field (e.g., 1214a in FIG. 12J). Displaying a memory generation option that, when selected, initiates a process for generating a memory collection based on a respective set of terms allows the user to generate memory collections with fewer inputs. Doing so also provides the user with an indication that memory collections can be generated based on a respective set of terms. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of terms (e.g., within selectable option 1200a-1, selectable option 1200a-2, or selectable option 1200a-3) is determined (e.g., by the computer system and/or by one or more external computer systems) (e.g., using an AI process or a generative AI process) based on content in the media library (e.g., based on media items in the media library; based on content depicted in media items in the media library; and/or based on concepts, words, terms, and/or phrases corresponding to content depicted in media items in the media library). Automatically determining relevant terms based on a context of the media library allows the user to generate interesting and/or relevant memory collections with fewer inputs. Furthermore, doing so also enhances the operability of the system and makes the user-system interface more efficient (e.g., by preventing erroneous inputs and helping the user to improves the battery life of the device by enabling the user to use the system more quickly and

In some embodiments, the first set of terms (e.g., within selectable option 1200a-1, selectable option 1200a-2, or selectable option 1200a-3) is determined (e.g., by the computer system and/or by one or more external computer systems) (e.g., using an AI process or a generative AI process) based on content in the media library (e.g., photographs, videos, and/or media items in the media library) that is determined to be contextually relevant at the time the memory generation option is displayed (e.g., based on content and/or metadata of media items that were recently captured and/or added to the media library (e.g., that were captured and/or added to the media library within the last hour, within the last day, within the last three days, or within the last week)). Automatically determining relevant terms based on a context of the media library allows the user to generate interesting and/or relevant memory collections with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, at a first time, the computer system displays, via the one or more display generation components, the memory generation option (e.g., 1200a) with the first selection target (e.g., selectable option 1200a-1, selectable option 1200a-2, and/or selectable option 1200a-3) having a first respective set of terms (e.g., in some embodiments, at the first time, the first selection target corresponds to a first respective set of terms) based on a context of the computer system (e.g., in some embodiments, a context of the media library) at the first time (e.g., text within selectable option 1200a-1, selectable option 1200a-2, or selectable option 1200a-3); and at a second time, subsequent to the first time, the computer system displays, via the one or more display generation components, the memory generation option (e.g., 1200a) with the first selection target (e.g., selectable option 1200a-1, selectable option 1200a-2, and/or selectable option 1200a-3) having a second respective set of terms different from the first respective set of terms (e.g., in some embodiments, at the second time, the first selection target corresponds to a second respective set of terms) based on a context of the computer system (e.g., in some embodiments, a context of the media library) at the second time. In some embodiments, text suggestions that are presented in the memory generation option (e.g., 1200a) (e.g., within selectable option 1200a-1, selectable option 1200a-2, and/or selectable option 1200a-3) change and/or are different at different times (e.g., based on contextual information and/or based on a context of the computer system and/or the media library). In some embodiments, the context of the computer system includes one or more of: a current time; a current date; metadata corresponding to media items contained in the media library (e.g., metadata indicative of one or more locations and/or one or more dates of capture); information indicative of one or more trips taken by a user of the computer system (e.g., calendar information and/or media item metadata), information indicative of one or more events (e.g., birthdays, anniversaries, graduations, conventions, vacations, and/or other events) (e.g., calendar information and/or media item metadata), and/or other information indicative of media items that may be relevant to and/or interesting to the user. Automatically determining relevant terms based on a context of the media library allows the user to generate interesting and/or relevant memory collections with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the memory generation user interface (e.g., 1210) includes a text field (e.g., 1214a) (e.g., a field in which text is displayed and/or a user can enter text). In some embodiments, while displaying the memory generation user interface, the computer system receives, via the one or more input devices, a text entry user input (e.g., 1236) (e.g., one or more user inputs directed to entry of text) (e.g., one or more touch inputs, one or more gesture inputs, one or more air gesture inputs, one or more spoken inputs, one or more activations of keys of a software keyboard or a hardware keyboard and/or one or more other hardware inputs). In response to receiving the text entry user input, the computer system displays text within the text field that was not displayed prior to receiving the text entry user input (e.g., 1214a in FIGS. 12AF-12AG). In some embodiments, a first set of text is displayed within the text field prior to receiving the text entry user input (e.g., FIG. 12AF), and in response to receiving the text entry user input, the first set of text is modified (e.g., FIG. 12AG). In some embodiments, no text is displayed within the text field prior to receiving the text entry user, and in response to receiving the text entry user input, text is displayed within the text field. Allowing a user to modify text for generating a memory collection allows a user to generate memory collections with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the memory generation user interface (e.g., 1210) comprises a first suggestion selection target (e.g., in some embodiments, a first respective selection target that corresponds to the first selection target) (e.g., 1212a, 1212b, and/or 1212c) that corresponds to a first set of suggested terms (e.g., in some embodiments, the first selection target and the first suggestion selection target corresponds to the same set of terms). In some embodiments, while displaying the memory generation user interface (e.g., 1210), the computer system receives, via the one or more input devices, a selection input (e.g., 1216a) (e.g., one or more user inputs directed to the first suggestion selection target) (e.g., one or more touch inputs, one or more gesture inputs, one or more air gesture inputs, one or more spoken inputs, and/or one or more hardware inputs) corresponding to selection of the first suggestion selection target. In response to receiving the selection input (e.g., 1216a) corresponding to selection of the first suggestion selection target (e.g., 1212a), the computer system (e.g., 600) causes a first memory collection to be generated (e.g., generating the first memory collection; causing one or more external computer systems separate from the computer system to generate the first memory collection; and/or transmitting a request to one or more external computer systems to generate the first memory collection) (e.g., an automatically-generated memory collection and/or a generative memory collection that includes automatically-generated visual content and/or generative visual content; and/or automatically-generated audio content and/or generative audio content) (e.g., generated using an AI process or a generative AI process) based on the first set of suggested terms (e.g., FIGS. 12J-120), wherein the first memory collection comprises a first plurality of media items that are automatically selected from the media library (e.g., using an AI process or a generative AI process) based on the first set of suggested terms, and wherein the first plurality of media items includes one or more media items that were not selected by the user to be included in the first memory collection. In some embodiments, the memory generation user interface (e.g., 1210) comprises a second suggestion selection target (e.g., 1212a, 1212b, and/or 1212c) different from the first suggestion selection target and that corresponds to a second set of suggested terms different from the first respective set of suggested terms. In some embodiments, while displaying the memory generation user interface (e.g., 1210), the computer system receives, via the one or more input devices, a selection input corresponding to selection of the second suggestion selection target (e.g., 1212a, 1212b, and/or 1212c); and in response to receiving the selection input corresponding to selection of the second suggestion selection target, the computer system causes a second memory collection to be generated (e.g., an automatically-generated memory collection and/or a generative memory collection that includes automatically-generated visual content and/or generative visual content; and/or automatically-generated audio content and/or generative audio content) based on the second set of suggested terms, wherein the memory collection comprises a second plurality of media items that are different from the first plurality of media items and are automatically selected from the media library (e.g., using an AI process or a generative AI process) based on the second set of suggested terms, wherein the second plurality of media items includes one or more media items that were not selected by the user to be included in the second memory collection. Displaying selection targets that, when selected, cause generation of a memory collection based on a respective set of terms allows the user to generate memory collections with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to receiving the selection input (e.g., 1206c, 1206d, 1206e. 1216a, 1224, and/or a combination of one or more user inputs that include 1206c, 1206d, and/or 1206e) (and/or, in some embodiments, in response to receiving the selection input and one or more additional user inputs), the computer system causes the memory collection to be generated (e.g., generating the memory collection; causing one or more external computer systems separate from the computer system to generate the memory collection; and/or transmitting a request to one or more external computer systems to generate the memory collection) (e.g., an automatically-generated memory collection and/or a generative memory collection that includes automatically-generated visual content and/or generative visual content; and/or automatically-generated audio content and/or generative audio content), wherein the memory collection includes a plurality of media items that are automatically selected from the media library (e.g., using an AI process or a generative AI process) based on the respective set of terms, and wherein the plurality of media items includes one or more media items that were not selected by the user to be included in the memory collection. Displaying a memory generation potion that, when selected, causes generation of a memory collection based on a respective set of terms allows the user to generate memory collections with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 1300 (e.g., FIG. 13) are also applicable in an analogous manner to the methods described above. For example, method 700, method 800, method 1000, method 1100, method 1400, method 1600, and/or method 1800 optionally include one or more of the characteristics of the various methods described above with reference to method 1300. For example, the media library in method 700 is the media library in method 800, method 1300, method 1400, method 1600, and/or method 1800; and/or the queries recited in method 1000 and/or method 1100 are queries within the media library recited in method 700, method 800, method 1300, method 1400, method 1600, and/or method 1800. For brevity, these details are not repeated below.

FIG. 14 is a flow diagram illustrating a method for generating and/or presenting content in accordance with some embodiments. Method 1400 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 602) (e.g., a touch-sensitive surface, a touch-sensitive display, a button, a rotatable input mechanism, a depressible and rotatable input mechanism, a camera, an accelerometer, and/or an inertial measurement unit (IMU)). Some operations in method 1400 are, optionally, combined, the orders of some operations are, optionally, changed, and some operations are, optionally, omitted.

As described below, method 1400 provides an intuitive way for generating and/or presenting content. The method reduces the cognitive burden on a user for generating and/or accessing content, thereby creating a more efficient human-machine interface. For battery-operated computing devices, enabling a user to navigate and/or access content faster and more efficiently conserves power and increases the time between battery charges.

The computer system detects (1402), via the one or more input devices, a user request (e.g., one or more inputs) (e.g., one or more touch inputs, one or more gesture inputs, one or more air gesture inputs, one or more spoken inputs, and/or one or more hardware inputs) to generate a memory collection (e.g., a slideshow, a slideshow video, and/or an animation that displays a plurality of media items from the media library over time) (e.g., 1216a, 1224, 1228, and/or 1238) (e.g., an automatically-generated memory collection and/or a generative memory collection that includes automatically-generated visual content and/or generative visual content; and/or automatically-generated audio content and/or generative audio content), wherein the request to generate the memory collection includes one or more terms (e.g., one or more words and/or one or more phrases) entered by a user. In response to detecting the user request to generate a memory collection (1404): in accordance with a determination that the one or more terms includes a first set of one or more terms, the computer system generates (1406) a first memory collection (e.g., an automatically-generated memory collection and/or a generative memory collection that includes automatically-generated visual content and/or generative visual content; and/or automatically-generated audio content and/or generative audio content) that includes a first plurality of media items that are automatically selected (e.g., selected by the computer system) (e.g., using an AI process or a generative AI process) from a media library associated with the user (e.g., a media library associated with the computer system; a media library associated with a user (e.g., a user of the computer system); and/or a media library associated with a user account) based on the first set of one or more terms entered by the user, wherein the first plurality of media items includes one or more media items that were not selected by the user to be included in the first memory collection (e.g., FIGS. 12J-12Q). In some embodiments, the first memory collection includes media items selected based on a first set of one or more recognized concepts from the first set of one or more terms. In response to detecting the user request to generate a memory collection (1404): in accordance with a determination that the one or more terms includes a second set of one or more terms that are different from the first set of one or more terms, the computer system generates (1408) a second memory collection (e.g., an automatically-generated memory collection and/or a generative memory collection that includes automatically-generated visual content and/or generative visual content; and/or automatically-generated audio content and/or generative audio content) that includes a second plurality of media items that are automatically selected (e.g., selected by the computer system and/or automatically selected) (e.g., using an AI process or a generative AI process) from the media library associated with the user (e.g., a media library associated with the computer system; a media library associated with a user (e.g., a user of the computer system); and/or a media library associated with a user account) based on the second set of one or more terms entered by the user, wherein the second plurality of media items includes one or more media items that were not selected by the user to be included in the second memory collection and the second plurality of media items is different from the first plurality of media items (e.g., FIGS. 12R-12W). In some embodiments, the second memory collection includes media items selected based on a second set of one or more recognized concepts from the second set of one or more terms where the second set of one or more recognized concepts are different from the first set of one or more recognized concepts. In some embodiments, in response to detecting the user request to generate the memory video, the computer system displays the first memory video (e.g., plays the first memory video). In some embodiments, generating the first memory collection comprises causing one or more external computer systems separate from the computer system to generate the first memory collection based on the first set of one or more terms entered by the user. In some embodiments, generating the first memory collection comprises transmitting a request to one or more external computer systems separate from the computer system to generate the first memory collection based on the first set of one or more terms entered by the user. In some embodiments, generating the second memory collection comprises causing one or more external computer systems separate from the computer system to generate the second memory collection based on the second set of one or more terms entered by the user. In some embodiments, generating the second memory collection comprises transmitting a request to one or more external computer systems separate from the computer system to generate the second memory collection based on the second set of one or more terms entered by the user. Allowing a user to generate a memory collection by entering one or more terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more terms includes a plurality of terms entered by the user (e.g., as shown in text field 1214a in FIGS. 12K-12V). Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first memory collection and/or the second memory collection are generated using an artificial intelligence process (e.g., one or more machine learning models (e.g., linear regression, decision trees, random forest, logistic regression, k-nearest neighbors, and/or neural networks); one or more large language models; and/or one or more generative AI models). In some embodiments, the contents of the media library (e.g., media items contained in the media library); metadata of the media library (e.g., metadata of the media items in the media library); and/or the first set of one or more terms entered by the user are used as part of a prompt used by the artificial intelligence process for generating the memory collection. Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more terms identify a first person represented in the media library (e.g., “Grandma” in FIG. 12AI) (e.g., a first person that is depicted in the media library; and/or a first person that is depicted in one or more media items of the media library). In some embodiments, the first person is a person that has previously been identified by a user of the computer system and/or has been identified on the computer system. For example, in some embodiments, the first person corresponds to a face that has been identified in one or more media items and named (e.g., by a user of the computer system); and/or, in some embodiments, the first person is associated with a contact and/or contact information stored on the computer system (e.g., stored automatically on the computer system and/or by the user of the computer system). In some embodiments, the one or more terms identify a first group of people (e.g., two or more people and/or a plurality of people) represented in the media library (e.g., “my friends” in FIG. 12R). Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more terms identify the first person by name (e.g., the one or more terms include the name of the first person) (“Brian and Maddie” in FIG. 12I). Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more terms identify the first person using one or more relationship descriptor terms that describe a relationship of the first person relative to a second person different from the first person (e.g., “Grandma” in FIG. 12AI). In some embodiments, the one or more relationship terms describe a relationship of the first person relative to a user of the computer system (e.g., “Grandma” or “mom”). In some embodiments the one or more relationship terms describe a relationship of the first person relative to a person different from the user of the computer system (e.g., “Sarah's mom”). Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more terms identify a first location (e.g., a place, a geographic location, a building, an address, a region, and/or a landmark) represented in the media library (e.g., “the Redwoods” in FIG. 12H) (e.g., a first location that is depicted in the media library; a first location that is depicted in one or more media items of the media library; and/or a first location at which one or more media items in the media library were captured). Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more terms identify a first time (e.g., a date, a range of dates, one or more months of the year, and/or one or more years) represented in the media library (e.g., “2023” in FIG. 12H; and/or “last weekend” in FIG. 12R) (e.g., a first time on which media items in the media library were captured; a first time on which media items in the media library were saved; and/or a first time on which media items in the media library were received). Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more terms include one or more multi-word phrases corresponding to concepts represented by media items in the media library (e.g., “upbeat vibe” in FIG. 12R and/or “last weekend” in FIG. 12R) (e.g., multi-word phrases that identify concepts represented by and/or depicted in media items in the media library). Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the one or more terms include one or more references to music available in a music application (e.g., “upbeat vibe” in FIG. 12R) (e.g., one or more terms that identify a first song, a first artist, a first music genre, a first music tempo, and/or a first musical characteristic). In some embodiments, the music application is a music application that is separate from a media library application and/or a memory collection generation application. Allowing a user to generate a memory collection by entering a plurality of terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the user request to generate a memory collection: in accordance with a determination that the one or more terms includes a third set of terms (e.g., one or more words and/or one or more phrases) entered by a user and that one or more terms of the third set of terms meets ambiguity criteria (e.g., the one or more terms are determined to correspond to multiple entities, are determined to correspond to multiple possible interpretations, and/or are determined to correspond to multiple meanings), the computer system displays, via the one or more display generation components, a first prompt (e.g., 1240, 1252, 1258, 1260a, 1260b, 1260c, and/or 1262) prompting a user to provide one or more user inputs clarifying the meaning of the one or more terms (e.g., displaying a disambiguation user interface for the user to select from multiple entities and/or multiple possible meanings for the one or more terms; and/or displaying a prompt asking the user to provide more information about the one or more terms) (e.g., in some embodiments, without changing other terms in the third set of terms). In some embodiments, while displaying the first prompt, the computer system receives one or more user inputs clarifying the meaning of the one or more terms (e.g., 1242, 1248, 1249, 1252, 1256a, and/or 1256b). In response to receiving the one or more user inputs clarifying the meaning of the one or more terms, the computer system ceases display of the first prompt and generates a third memory collection (e.g., an automatically-generated memory collection and/or a generative memory collection that includes automatically-generated visual content and/or generative visual content; and/or automatically-generated audio content and/or generative audio content) that includes a third plurality of media items that are automatically selected (e.g., using an AI process or a generative AI process) from the media library associated with the user based on the third set of terms entered by the user, wherein the third plurality of media items includes one or more media items that were not selected by the user to be included in the memory collection (e.g., FIGS. 12AI-12AT). In some embodiments, in response to detecting the user request to generate the third memory collection: in accordance with a determination that the third set of terms does not meet ambiguity criteria (e.g., the third set of terms are not determined to correspond to multiple entities, are not determined to correspond to multiple possible interpretations, and/or are not determined to correspond to multiple meanings), the computer system forgoes displaying the first prompt (e.g., FIGS. 12J-12Q and/or FIGS. 12R-12W). In some embodiments, in response to detecting the user request to generate the third memory collection: in accordance with a determination that the third set of terms does not meet ambiguity criteria, the computer system generates a third memory collection (e.g., an automatically-generated memory collection and/or a generative memory collection that includes automatically-generated visual content and/or generative visual content; and/or automatically-generated audio content and/or generative audio content) that includes a third plurality of media items that are automatically selected from the media library (e.g., using an AI process or a generative AI process) associated with the user based on the third set of terms entered by the user, wherein the third plurality of media items includes one or more media items that were not selected by the user to be included in the memory collection (e.g., FIGS. 12J-12Q and/or FIGS. 12R-12W). Displaying a prompt prompting a user to provide clarification of ambiguous terms improves the quality of results provided to a user (e.g., the quality of memory collections generated for a user), and assists in avoiding the provision of irrelevant results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first prompt prompting the user to provide one or more user inputs clarifying the meaning of the one or more terms comprises displaying (e.g., concurrently displaying) two or more disambiguation options (e.g., the center figure in FIG. 12AR), including: a first disambiguation option that corresponds to a first category (e.g., a person, a thing, a place, and/or a time) (e.g., 1260a and/or 1260b); and a second disambiguation option that is different from the first disambiguation option and that corresponds to a second category different from the first category (e.g., a person, a thing, a place, and/or a time) (e.g., 1260a and/or 1260b). Displaying a prompt prompting a user to provide clarification of ambiguous terms improves the quality of results provided to a user (e.g., the quality of memory collections generated for a user), and assists in avoiding the provision of irrelevant results to a user. Furthermore, doing so also enhances the operability of the system and makes the user-system interface more efficient (e.g., by preventing erroneous inputs and helping the user to improves the battery life of the device by enabling the user to use the system more quickly and

In some embodiments, the computer system detects one or more user inputs clarifying the meaning of one or more terms (e.g., 1242, 1248, and/or 1249). In response to detecting the one or more user inputs clarifying the meaning of the one or more terms (e.g., in some embodiments, while the first prompt is no longer displayed): in accordance with a determination that a second collection of one or more words of the third set of terms different from the one or more terms of the third set of terms meets the ambiguity criteria (e.g., the second collection of one or more terms are determined to correspond to multiple entities, are determined to correspond to multiple possible interpretations, and/or are determined to correspond to multiple meanings), the computer system displays, via the one or more display generation components, a second prompt (e.g., 1250) prompting the user to provide one or more user inputs clarifying the meaning of the second collection of one or more terms (e.g., displaying a disambiguation user interface for the user to select from multiple entities and/or multiple possible meanings for the second collection of one or more terms; and/or displaying a prompt asking the user to provide more information about the second collection of one or more terms) (e.g., in some embodiments, without changing other terms in the third set of terms). In some embodiments, in response to detecting the one or more user inputs clarifying the meaning of the one or more terms, the computer system ceases display of the first prompt (e.g., 1240). In some embodiments, while displaying the second prompt (e.g., 1250), the computer system receives one or more user inputs clarifying the meaning of the second collection of one or more terms (e.g., 1252, 1256a, and/or 1256b); and in response to receiving the one or more user inputs clarifying the meaning of the second collection of one or more terms, the computer system ceases display of the second prompt (e.g., 1250) and/or generates a third memory collection (e.g., an automatically-generated memory collection and/or a generative memory collection that includes automatically-generated visual content and/or generative visual content; and/or automatically-generated audio content and/or generative audio content) that includes a third plurality of media items that are automatically selected from the media library (e.g., using an AI process or a generative AI process) associated with the user based on the third set of terms entered by the user (e.g., FIGS. 12AO-12AR), wherein the third plurality of media items includes one or more media items that were not selected by the user to be included in the memory collection. Displaying a prompt prompting a user to provide clarification of ambiguous terms improves the quality of results provided to a user (e.g., the quality of memory collections generated for a user), and assists in avoiding the provision of irrelevant results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the user request to generate a memory collection: in accordance with a determination that the one or more terms includes a fourth set of terms (e.g., one or more words and/or one or more phrases) entered by a user and that one or more terms of the fourth set of terms are not identified in the media library (e.g., the one or more terms of the fourth set of terms are determined not to correspond to the media library and/or to any media items in the media library), the computer system displays, via the one or more display generation components, a fourth prompt (e.g., 1258 and/or 1262) prompting a user to provide one or more user inputs to change the one or more terms of the fourth set of terms and/or to clarify the meaning of the one or more terms of the fourth set of terms. Displaying a prompt prompting a user to provide clarification of and/or to change ambiguous terms improves the quality of results provided to a user (e.g., the quality of memory collections generated for a user), and assists in avoiding the provision of irrelevant results to a user. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the user request to generate a memory collection: in accordance with a determination that the one or more terms includes a fifth set of terms (e.g., one or more words and/or one or more phrases) entered by a user and that one or more terms of the fifth set of terms include one or more unsupported concepts (e.g., concepts that are determined to be problematic or are likely to generate problematic content) (e.g., in some embodiments, in accordance with a determination that the fifth set of terms satisfy a set of criteria indicative of problematic content) (e.g., copyrighted content, inappropriate content, graphic content, obscene content, and/or illegal content), the computer system displays, via the one or more display generation components, a fifth prompt (e.g., 1264) indicating that one or more terms of the fifth set of terms have been determined to include one or more unsupported concepts. Displaying a prompt informing the user that the user's entered text includes unsupported concepts provides visual feedback about a state of the system, and enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the user request to generate a memory collection: in accordance with a determination that a remote memory generation service (e.g., a service provided by and/or provided using one or more external computer systems separate from the computer system) is unavailable to generate the memory collection, the computer system displays, via the one or more display generation components, a prompt indicating that the remote memory generation service is unavailable to generate the memory collection (e.g., 1266). Displaying a prompt informing the user that a remote memory generation service is unavailable provides visual feedback about a state of the system, and enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, subsequent to generating the first memory collection, the computer system displays, via the one or more display generation components, playback of the first memory collection (e.g., playing the memory collection) (e.g., FIGS. 120-12Q; FIGS. 12W-12Y; FIG. 12AC; and/or FIG. 12AR). In some embodiments, subsequent to generating the first memory collection, the computer system outputs playback of the first memory collection (e.g., including displaying visual content of the first memory collection and outputting audio content of the first memory collection). Allowing a user to generate a memory collection by entering one or more terms allows the user to generate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, subsequent to generating the first memory collection, the computer system displays, via the one or more display generation components, a regenerate option (e.g., 1226d and/or 1230d) that, when selected, causes the computer system to generate a new memory collection (e.g., an automatically-generated memory collection and/or a generative memory collection that includes automatically-generated visual content and/or generative visual content; and/or automatically-generated audio content and/or generative audio content) that includes a new plurality of media items that is different from the first plurality of media items and that is automatically selected from the media library (e.g., using an AI process or a generative AI process) based on the first set of one or more terms entered by the user. While displaying the regenerate option (e.g., 1226d and/or 1230d), the computer system receives, via the one or more input devices, a selection input (e.g., 1228) (e.g., one or more inputs) (e.g., one or more touch inputs, one or more gesture inputs, one or more air gesture inputs, one or more spoken inputs, and/or one or more hardware inputs) corresponding to selection of the regenerate option. In response to receiving the selection input corresponding to selection of the regenerate option: the computer system generates a first new memory collection (e.g., FIGS. 12Z-12AC) (e.g., an automatically-generated memory collection and/or a generative memory collection that includes automatically-generated visual content and/or generative visual content; and/or automatically-generated audio content and/or generative audio content) that includes a first new plurality of media items that is different from the first plurality of media items and that is automatically selected from the media library (e.g., using an AI process or a generative AI process) based on the first set of one or more terms entered by the user, wherein the first new plurality of media items includes one or more media items that were not selected by the user to be included in the first new memory collection. In some embodiments, the first memory collection and the first new memory collection are generated using one or more AI processes (e.g., generative AI processes). In some embodiments, the first memory collection and the first new memory collection are different (e.g., the first new plurality of media items and the first plurality of media items are different) based on the one or more AI processes being non-deterministic, random, and/or pseudorandom in the way in which they generate memory collections. Displaying an option that is selected to re-generate a memory collection using the same set of terms allows the user to regenerate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, subsequent to generating the first memory collection, the computer system displays, via the one or more display generation components, playback of the first memory collection (or, in some embodiments, outputting playback of the first memory collection including displaying visual playback of visual content of the first memory collection and outputting audio playback of audio content of the first memory collection) (e.g., FIG. 12AC), wherein displaying the regenerate option (e.g., 1230d) subsequent to generating the first memory collection comprises displaying the regenerate option subsequent to completing playback of the first memory collection (e.g., in some embodiments, in response to completing playback of the first memory collection) (e.g., 1230d in FIG. 12AD). Displaying an option that is selected to re-generate a memory collection using the same set of terms allows the user to regenerate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, subsequent to generating the first memory collection, the computer system displays, via the one or more display generation components, playback of the first memory collection (or, in some embodiments, outputting playback of the first memory collection including displaying visual playback of visual content of the first memory collection and outputting audio playback of audio content of the first memory collection) (e.g., FIGS. 12W-12Y). While displaying playback of the first memory collection, the computer system receives, via the one or more input devices, a user request (e.g., one or more inputs) (e.g., one or more touch inputs, one or more gesture inputs, one or more air gesture inputs, one or more spoken inputs, and/or one or more hardware inputs) to terminate playback (e.g., end playback and/or cease playback) of the first memory collection (e.g., 1227), wherein: displaying the regenerate option subsequent to generating the first memory collection comprises displaying the regenerate option in response to receiving the user request to terminate playback of the first memory collection (e.g., 1226d in FIG. 12Z). Displaying an option that is selected to re-generate a memory collection using the same set of terms allows the user to regenerate memory collections with fewer inputs. Doing so also allows the user to view relevant and/or interesting sets of content with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while generating the first memory collection that includes the first plurality of media items that are automatically selected from the media library associated with the user based on the first set of one or more terms entered by the user, the computer system displays, via the one or more display generation components, a first animation (e.g., 1218a, 1218b, 1218c, and/or 1218d) that indicates progress toward generating the first memory collection (e.g., a first animation that changes over time; and/or a first animation that indicates when generation of the first memory collection is completed and/or nearly completed). In some embodiments, generating the first memory collection, the second memory collection, and/or any memory collection based on a set of terms includes displaying the first animation (and/or a variation of the first animation that differs based on media items selected for the memory collection and/or the set of terms provided to generate the memory collection). In some embodiments, while generating the second memory collection that includes the second plurality of media items that are automatically selected from the media library associated with the user based on the second set of one or more terms entered by the user, the computer system displays a second animation that indicates progress toward generating the second memory collection, wherein the second animation is different from the first animation. Displaying the first animation while the first memory collection is being generated provides the user with visual feedback about a state of the system (e.g., that the system is generating a memory collection). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1218a, 1218b, 1218c, and/or 1218d) includes displaying indications of one or more media items (e.g., thumbnails, snapshots, frames, and/or clips) in the media library that are determined to be relevant to the first set of one or more terms entered by the user (e.g., 1218a-1, 1218b-1, 1218c-1, and/or 1218d-1). Displaying the first animation while the first memory collection is being generated provides the user with visual feedback about a state of the system (e.g., that the system is generating a memory collection). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1218a, 1218b, 1218c, and/or 1218d) includes displaying indications of one or more identified concepts (e.g., one or more words and/or phrases) that are determined to be relevant to the first set of one or more terms entered by the user (e.g., 1218a-2, 1218b-2, 1218c-2, and/or 1218d-2) (e.g., displaying one or more words and/or phrases that are determined to be relevant to the first set of one or more terms entered by the user but are different from the one or more terms entered by the user). Displaying the first animation while the first memory collection is being generated provides the user with visual feedback about a state of the system (e.g., that the system is generating a memory collection). Doing so also enhances the operability of the system and makes the user-system interface more efficient (e.g., by preventing erroneous inputs and helping the user to improves the battery life of the device by enabling the user to use the system more quickly and

In some embodiments, displaying the indications of one or more identified concepts (e.g., 1218a-2, 1218b-2, 1218c-2, and/or 1218d-2) that are determined to be relevant to the first set of one or more terms entered by the user includes displaying a first plurality of terms that are not included in the first set of one or more terms entered by the user (e.g., the one or more identified concepts are concepts that are related to the first set of one or more terms entered by the user but are not explicitly included in the first set of one or more terms entered by the user). Displaying the first animation while the first memory collection is being generated provides the user with visual feedback about a state of the system (e.g., that the system is generating a memory collection). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1218a, 1218b, 1218c, and/or 1218d) comprises: displaying, at a first time, a first set of visual elements (e.g., 1218a-1, 1218b-1, 1218c-1, 1218d-1, 1218a-2, 1218b-2, 1218c-2, and/or 1218d-2) (e.g., a first set of images, a first set of thumbnails, and/or a first set of text) (e.g., one or more visual elements) fading in to view; displaying, at a second time, the first set of visual elements fading out of view (e.g., in some embodiments, media items in 1218a-1, 1218b-1, 1218c-1, and/or 1218d-1 fade out of view; and/or text in 1218a-2, 1218b-2, 1218c-2, and/or 1218d-2 fades out of view); displaying, at a third time subsequent to the second time, a second set of visual elements (e.g., a second set of images, a second set of thumbnails, and/or a second set of text) (e.g., one or more visual elements) different from the first set of visual elements fading in to view (e.g., in some embodiments, a new set of media items in 1218a-1, 1218b-1, 1218c-1, and/or 1218d-1 fade into view; and/or new text in 1218a-2, 1218b-2, 1218c-2, and/or 1218d-2 fades into view); and displaying, at a fourth time subsequent to the third time, the second set of visual elements fading out of view (e.g., in some embodiments, the new set of media items in 1218a-1, 1218b-1, 1218c-1, and/or 1218d-1 fade out of view; and/or new text in 1218a-2, 1218b-2, 1218c-2, and/or 1218d-2 fades out of view). In some embodiments, as the first animation progresses, individual visual elements fade in and out of view. Displaying the first animation while the first memory collection is being generated provides the user with visual feedback about a state of the system (e.g., that the system is generating a memory collection). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1218a, 1218b, 1218c, and/or 1218d) comprises: displaying a first media item of the media library expanding in size (e.g., 1220a in FIGS. 12M-12N; 1220b in FIGS. 12U-12V; 1220c in FIG. 12AB; and/or 1220d in FIGS. 12AP-12AQ); and subsequent to displaying the first media item of the media library expanding in size (e.g., immediately subsequent to displaying the first media item expanding in size and/or as part of displaying the first media item expanding in size), displaying the first media item as a cover media item for the first memory collection (e.g., 1220a in FIG. 12O; 1220b in FIG. 12Y; 1220c in FIG. 12AC; and/or 1200d in FIG. 12AQ) (e.g., displaying the first media item as the initial media item in the first memory collection; and/or displaying the first media item as the initial media item in the first memory collection and concurrently with title text for the first memory collection). Displaying the first animation while the first memory collection is being generated provides the user with visual feedback about a state of the system (e.g., that the system is generating a memory collection). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1218a, 1218b, 1218c, and/or 1218d) comprises: displaying, at a first time, a first set of visual elements (e.g., 1218a-1, 1218b-1, 1218c-1, 1218d-1, 1218a-2, 1218b-2, 1218c-2, and/or 1218d-2) (e.g., a first set of images, a first set of thumbnails, and/or a first set of text) (e.g., one or more visual elements); and displaying, at a second time subsequent to the first time, a second set of visual elements (e.g., 1218a-1, 1218b-1, 1218c-1, 1218d-1, 1218a-2, 1218b-2, 1218c-2, and/or 1218d-2) (e.g., a second set of images, a second set of thumbnails, and/or a second set of text) (e.g., one or more visual elements) different from the first set of visual elements (e.g., without displaying the first set of visual elements), wherein the second set of visual elements is displayed later than the first set of visual elements based on a determination that the second set of visual elements is more relevant to the first set of one or more terms entered by the user than the first set of visual elements (e.g., based on relevance criteria and/or based on relevance score). Displaying the first animation while the first memory collection is being generated provides the user with visual feedback about a state of the system (e.g., that the system is generating a memory collection). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1218a, 1218b, 1218c, and/or 1218d) comprises: displaying representations of a first set of media items of the media library (e.g., a first set of media items determined to be responsive to and/or relevant to the first set of one or more terms entered by the user) in an arrangement with a first degree of overlap between representations of media items (e.g., a grid in which representations of media items are displayed adjacent to one another in a non-overlapping or substantially non-overlapping manner) (e.g., 1218a-1 in FIG. 12M in which media items are non-overlapping); and in accordance with a determination that generation of the first memory collection is completed, displaying the representations of the first set of media items of the media library changing in size and/or position so that they have a degree of overlap between representations of media items that is greater than the first degree of overlap (e.g., in some embodiments, after FIG. 12M, media items in 1218a-1 change in size and/or move so that they overlap and/or group together into a stack of media items) (e.g., shuffling or sorting the representations of media items into a stack, such as a stack in which representations of media items are stacked on top of each other and/or overlap each other). Displaying the first animation while the first memory collection is being generated provides the user with visual feedback about a state of the system (e.g., that the system is generating a memory collection). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first animation (e.g., 1218a, 1218b, 1218c, and/or 1218d), the computer system displays, within the first animation, a first set of visual elements (e.g., 1218a-1, 1218b-1, 1218c-1, 1218d-1, 1218a-2, 1218b-2, 1218c-2, and/or 1218d-2) (e.g., representations of a first set of media items in the media library that are responsive to the first set of one or more terms entered by the user; and/or one or more terms that are relevant and/or responsive to the first set one or more terms entered by the user). While displaying the first set of visual elements within the first animation, the computer system detects that user clarification is needed to generate the first memory collection based on the first set of one or more terms entered by the user (e.g., user clarification is needed to disambiguate and/or clarify the meaning of one or more terms; and/or user clarification is needed to change and/or modify one or more terms). In response to detecting that user clarification is needed to generate the first memory collection based on the first set of one or more terms entered by the user, the computer system displays, via the one or more display generation components, visual modification of the first set of visual elements (e.g., in FIG. 12AI, in some embodiments, media item region 1218d-1 and/or text region 1218d-2 is blurred, dimmed, saturation, and/or no longer displayed; and/or in some embodiments, in FIG. 12AI, animation 1218d is paused and/or stopped) (e.g., displaying blurring, dimming, desaturation, and/or shrinking of the first set of visual elements; displaying shuffling of the first set of visual elements; displaying slowing down of movement of the first set of visual elements; displaying slowing down of the first animation; and/or displaying the first animation in a paused and/or suspended state). In some embodiments, detecting that user clarification is needed includes one or more of: a determination that one or more terms entered by the user meet ambiguity criteria; a determination that one or more terms entered by the user are not identified in the media library; a determination that the one or more terms include one or more unsupported concepts; and/or a determination that a remote memory generation service is unavailable to generate memory collections. In some embodiments, in response to detecting that user clarification is needed, the computer system pauses and/or suspends the first animation (e.g., 1218a, 1218b, 1218c, and/or 1218d). In some embodiments, the computer system receives one or more user inputs providing user clarification (e.g., one or more user inputs clarifying the meaning of one or more terms; one or more user inputs changing one or more terms; and/or one or more other user inputs) (e.g., 1242, 1248, 1249, 1252, 1256a, and/or 1256b); and in response to the one or more user inputs providing user clarification, the computer system resumes or restarts the first animation. Displaying the first animation changing visually when user clarification is needed provides the user with visual feedback about a state of the system (e.g., that the system requires user input to generate the first memory collection). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 1400 (e.g., FIG. 14) are also applicable in an analogous manner to the methods described above. For example, method 700, method 800, method 1000, method 1100, method 1300, method 1600, and/or method 1800 optionally include one or more of the characteristics of the various methods described above with reference to method 1400. For example, the media library in method 700 is the media library in method 800, method 1300, method 1400, method 1600, and/or method 1800; and/or the queries recited in method 1000 and/or method 1100 are queries within the media library recited in method 700, method 800, method 1300, method 1400, method 1600, and/or method 1800. For brevity, these details are not repeated below.

FIGS. 15A-15V-2 illustrate exemplary devices and user interfaces for displaying and/or providing content, in accordance with some embodiments. The user interfaces in these figures are used to illustrate the processes described below, including the processes in FIG. 16.

FIG. 15A illustrates computer system 1500, which is a head-mounted device (HMD) that includes display module 1502 and one or more input devices (e.g., one or more input sensors (e.g., one or more cameras, eye gaze trackers, hand movement trackers, and/or head movement trackers) and/or one or more physical input devices (e.g., one or more physical buttons and/or rotatable input mechanisms). In some embodiments, computer system 1500 includes a pair of display modules that provide stereoscopic content to different eyes of the same user. For example, computer system 1500 includes display module 1502 (e.g., which provides content to a left eye of the user) and a second display module (e.g., which provides content to a right eye of the user). In some embodiments, the second display module displays a slightly different image than display module 1502 to generate the illusion of stereoscopic depth. In some embodiments, computer system 1500 includes one or more outward-facing cameras and/or sensors for detecting the physical environment that surrounds computer system 1500 and also for detecting gestures (e.g., air gestures) performed by the user. Although the depicted embodiments show an example in which computer system 1500 is a head-mounted device, in other embodiments, computer system 1500 is a different type of computer system (e.g., a smartphone, a tablet, a laptop computer, a desktop computer, and/or another wearable device).

At FIG. 15A, computer system 1500 displays user interface 1504. User interface 1504 corresponds to a media library (e.g., a media library that corresponds to computer system 1500 and/or that corresponds to a user account (e.g., a user account logged into computer system 1500)), and displays representations of a plurality of different media items from the media library, including representation 1508a representative of a first media item, representation 1508b representative of a second media item, and representation 1508c representative off a third media item. User interface 1504 also includes options 1506a-1506f. Option 1506a, when selected, causes computer system 1500 to filter the media library to identify media items that are spatial media items that include stereoscopic depth information, and to display representations of those spatial media items (e.g., without displaying representations of non-spatial media items that do not include stereoscopic depth information). In some embodiments, the media library includes one or more spatial media items and one or more non-spatial media items. In some embodiments, spatial media items include stereoscopic depth information that allow computer system 1500 (or another computer system that is configured to display stereoscopic content) to display the media item with stereoscopic depth. In some embodiments, displaying a media item with stereoscopic depth comprises displaying a first version and/or a first component of the media item to a left eye of a user, and displaying a second version and/or a second component of the media item that is different from the first version and/or the first component to the right eye of the user. In some embodiments, stereoscopic depth information for a spatial media item includes information for displaying the two different versions and/or the two different visual components of the spatial media item concurrently to different eyes of the user. In some embodiments, non-spatial media items are displayed such that the same visual content is displayed to the two eyes of the user, and the non-spatial media item is displayed as a two-dimensional media item without stereoscopic depth.

Option 1506b, when selected, causes computer system 1500 to display a user interface that includes representations of one or more memory collections (various embodiments of which were described above with reference to FIGS. 12A-12AU). Option 1506c, when selected, causes computer system 1500 to display user interface 1504. Option 1506d, when selected, causes computer system 1500 to display a user interface that includes representations of one or more media albums (e.g., collections of media items). Option 1506e, when selected, causes computer system 1500 to display a user interface that includes representations of one or more panoramic media items. Option 1506f, when selected, causes computer system 1500 to display a search user interface for searching through the media library based on one or more search terms. FIG. 15A depicts three example scenarios in which computer system 1500 detects three different user inputs: pinch air gesture 1510 while the user looks at representation 1508a (e.g., as indicated by gaze indication 1510a); pinch air gesture 1510 while the user looks at representation 1508b (e.g., as indicated by gaze indication 1510b); and pinch air gesture 1510 while the user looks at representation 1508c (e.g., as indicated by gaze indication 1510c). Each of these scenarios and corresponding user inputs will be discussed below.

At FIG. 15B, in response to computer system 1500 detecting pinch air gesture 1510 while the user looks at representation 1508a (representative of a first media item 1515a), computer system 1500 displays first media item 1515a within user interface 1514. User interface 1514 includes display region 1516a, option 1516b, option 1516c, and ribbon 1516d. First media item 151a is displayed within display region 1516a. Option 1516b, when selected, causes computer system 1500 to cease display of user interface 1514 and, optionally, re-display user interface 1504. Ribbon 1516d displays a representation of media item 1515a, as well as representations of other media items in the media library. In some embodiments, a user can provide user input via ribbon 1516d to scroll and/or navigate to other media items to display the other media items within display region 1516a or user interface 1514.

In the depicted scenario, media item 1515a is a non-spatial media item. For example, in some embodiments, media item 1515a was captured by a camera as a two-dimensional image that does not include stereoscopic depth information. As such, media item 1515a is displayed within user interface 1514 as a two-dimensional image without stereoscopic depth. Based on a determination that media item 1515a is a non-spatial media item, user interface 1514 displays media item 1515a with option 1516c. Option 1516c is a spatial conversion option that, when selected, causes computer system 1500 to initiate a process for converting non-spatial media item 1515a into a spatial media item. In some embodiments, computer system 1500 and/or one or more external computer systems convert a non-spatial media item into a spatial media item using one or more artificial intelligence (AI) processes, such as one or more generative AI processes. In some embodiments, computer system 1500 and/or one or more external computer systems convert a non-spatial media item into a spatial media item by using one or more AI processes to identify one or more objects depicted in the media item, determine estimated depths for the one or more objects, and generate two different visual components (e.g., two different versions) of the media item (e.g., a left eye component to be presented to the left eye of a user and a right eye component to be presented to the right eye of a user). In some embodiments, using one or more AI processes to generate the two different visual components of the media item includes using one or more AI processes to generate infill visual content to be displayed between the estimated depth layers of the media item (e.g., infill visual content that is not present in the original non-spatial media item). In some embodiments, the original non-spatial media item is used as one of the two different visual components (e.g., the original non-spatial media item is used as the left eye component or as the right eye component). In some embodiments, two visual components that are each different from the original non-spatial media item are generated (e.g., a left eye component that is different from the original media item and a right eye component that is different from the original media item and the left eye component).

At FIG. 15B, computer system 1500 detects a selection input corresponding to selection of option 1516c (e.g., pinch air gesture 1518a while the user is looking at option 1516c (e.g., as indicated by gaze indication 1518b)). At FIG. 15C, in response to detecting the selection input corresponding to selection of option 1516c, computer system 1500 initiates conversion of media item 1515a from a non-spatial media item to a spatial media item. In FIG. 15C, computer system 1500 displays animation 1520 indicating that conversion of media item 1515a is taking place. FIGS. 15D-15F demonstrate various example features and/or embodiments of animation 1520. In some embodiments, animation 1520 includes displaying a color gradient moving through different detected and/or estimated depth layers of media item 1515a. For example, in FIGS. 15D-15F, the color gradient includes three different colors. Furthermore, in FIGS. 15D-15F, media item 1515a is determined to include three different layers of objects: a first depth layer 1522a that includes a baby; a second depth layer 1522b that includes a man; and a third depth layer 1522c that includes the background environment behind the baby and the man. At FIG. 15D, objects in first depth layer 1522a are displayed with a first color of the color gradient; objects in second depth layer 1522b are displayed with a second color of the color gradient; and objects in third depth layer 1522c are displayed with a third color of the color gradient. At FIG. 15E, objects in first depth layer 1522a are displayed with the second color of the color gradient; objects in second depth layer 1522b are displayed with the third color of the color gradient; and objects in third depth layer 1522c are displayed with the first color of the color gradient. At FIG. 15F, objects in first depth layer 1522a are displayed with the third color of the color gradient; objects in second depth layer 1522b are displayed with the first color of the color gradient; and objects in third depth layer 1522c are displayed with the second color of the color gradient. In some embodiments, animation 1520 further includes moving a blurring layer over media item 1515a such that different portions of media item 1515a are blurred or not blurred as animation 1520 progresses.

At FIG. 15G, computer system 1500 has completed conversion of media item 1515a from a non-spatial media item to a spatial media item. After conversion of media item 1515a, computer system 1500 ceases display of animation 1520, and displays media item 1515a within user interface 1514 as a spatial media item. In some embodiments, spatial media items are displayed differently within user interface 1514 than non-spatial media items. For example, in some embodiments, spatial media items are displayed with a stereoscopic visual treatment (e.g., FIG. 15G) while non-spatial media items are displayed with a non-stereoscopic visual treatment (e.g., FIG. 15B). Some differences of the stereoscopic visual treatment and the non-stereoscopic visual treatment, according to various embodiments, are shown in FIGS. 15B and 15G, as well as the top two rows of FIG. 15I. In FIG. 15I, computer system 1500 is displayed with both of its display modules, left display module 1502 and right display module 1502-1. In some embodiments, the stereoscopic visual treatment includes displaying media item 1515a with a first amount of stereoscopic depth (e.g., non-zero stereoscopic depth), whereas the non-stereoscopic visual treatment includes displaying media item 1515a without stereoscopic depth (e.g., as a flat two-dimensional image). As can be seen in the second row of FIG. 15I, displaying media item 1515a with the first amount of stereoscopic depth includes displaying a first visual component (e.g., a first version) of media item 1515a to a left eye of the user (e.g., via left display module 1502), and displaying a second, different visual component (e.g., a second version) of media item 1515a to a right eye of the user (e.g., via right display module 1502-1). In contrast, in the top row of FIG. 15I, when media item 1515a is displayed with the non-stereoscopic visual treatment, the same image is displayed on both left display module 1502 and right display module 1502-1. In some embodiments, the stereoscopic visual treatment includes displaying user interface 1514 with a blurred border, whereas the non-stereoscopic visual treatment includes displaying user interface 1514 without the blurred border.

In FIG. 15G, based on media item 1515a now being a spatial media item, computer system 1500 displays immersive viewing option 1516e within user interface 1514 and no longer displays spatial conversion option 1516c within user interface 1514. Immersive viewing option 1516e, when selected, causes computer system 1500 to display media item 1515a in an immersive viewing mode, as will be described in greater detail below with reference to FIG. 15G. In some embodiments, spatial conversion option 1516c and immersive viewing option 1516e are both displayed at the same position within user interface 1514 such that immersive viewing option 1516e replaces spatial conversion option 1516c when media item 1515a is converted to a spatial media item. In some embodiments, based on media item 1515a being a converted spatial media item that was converted from being a non-spatial media item to being a spatial media item, computer system 1500 displays option 1516f within user interface 1514. Option 1516f, when selected, causes computer system 1500 to transition from displaying media item 1515a with the stereoscopic visual treatment to displaying media item 1515b with the non-stereoscopic visual treatment, as will be described in greater detail below with reference to FIGS. 15N-15Q.

At FIG. 15G, computer system 1500 detects a selection input corresponding to selection of immersive viewing option 1516e (e.g., pinch air gesture 1524a while the user is looking at immersive viewing option 1516e, as indicated by gaze indication 1524b). At FIG. 15H, in response to detecting the selection input corresponding to selection of immersive viewing option 1516e, computer system 1500 ceases display of user interface 1514, and displays media item 1515a in an immersive viewing mode. In some embodiments, displaying media item 1515a in the immersive viewing mode includes darkening, blurring, and/or otherwise obscuring areas outside of media item 1515a, and displaying media item 1515a with an increased amount of stereoscopic depth compared to when media item 1515a was displayed in user interface 1514 with the stereoscopic visual treatment. This can be seen in the second and third rows of FIG. 15I. In the third row of FIG. 15I, media item 1515a is displayed in the immersive viewing mode, and includes a greater amount of stereoscopic depth than the second row in which media item 1515a is displayed within user interface 1514 with the stereoscopic visual treatment. The immersive viewing mode also includes option 1528 that, when selected, causes computer system to exit the immersive viewing mode and, optionally, re-display media item 1515a within user interface 1514 (e.g., returning to the state shown in FIG. 15G).

Returning now to the user inputs shown in FIG. 15A, at FIG. 15J, in response to computer system 1500 detecting pinch air gesture 1510 while the user looks at representation 1508a (representative of a second media item 1515b), computer system 1500 displays media item 1515b within user interface 1514. Media item 1515b is a non-spatial media item. Accordingly, computer system 1500 displays media item 1515b with the non-stereoscopic visual treatment (e.g., without a blurred border and without stereoscopic depth). Furthermore, in FIG. 15J, computer system 1500 determines that media item 1515b is a non-spatial media item that does not qualify for conversion to a spatial media item. This may occur, for example, if media item 1515b is a video and/or has other characteristics that preclude it from being converted to a spatial media item. Based on the determination that media item 1515b is a non-spatial media item that does not qualify for conversion to a spatial media item, user interface 1514 is displayed without spatial conversion option 1516c. And based on a determination that media item 1515b is a non-spatial media item, user interface 1514 also does not include immersive viewing option 1516e.

Once again returning to the user inputs shown in FIG. 15A, at FIG. 15K, in response to computer system 1500 detecting pinch air gesture 1510 while the user looks at representation 1508a (representative of a third media item 1515c), computer system 1500 displays media item 1515c within user interface 1514. At FIG. 15K, based on a determination that media item 1515c is a spatial media item, media item 1515c is displayed within user interface 1514 with the stereoscopic visual treatment (e.g., with a non-zero amount of stereoscopic depth and/or with a blurred border around media item 1515c). Furthermore, based on a determination that media item 1515c is a spatial media item, user interface 1514 includes immersive viewing option 1516e. In some embodiments, native spatial media items (e.g., spatial media items that were captured by two or more cameras and with stereoscopic depth information; and/or spatial media items that were not converted from non-spatial media items) are treated differently than converted spatial media items (e.g., spatial media items that were converted from non-spatial media items). In some embodiments, when a media item is a native spatial media item, user interface 1514 does not include option 1516f to display the media item with the non-stereoscopic visual treatment. Accordingly in FIG. 15K, user interface 1514 does not include option 1516f.

At FIG. 15K, computer system 1500 detects a selection input corresponding to selection of immersive viewing option 1516e (e.g., pinch air gesture 1530a while the user looks at immersive viewing option 1516e, as indicated by gaze indication 1530b). At FIG. 15L, in response to detecting the selection input corresponding to selection of immersive viewing option 1516e, computer system 1500 displays media item 1515c in the immersive viewing mode. In the depicted embodiment, when media item 1515c is in the immersive viewing mode, it is displayed with greater stereoscopic depth than when media item 1515c is displayed within user interface 1514. For example, in FIGS. 15K-15L, media item 1515c includes a first depth layer 1532a that includes a woman, and a second depth layer 1532b that is behind the first depth layer 1532a. In FIG. 15L, in the immersive viewing mode, the first depth layer 1532a has a greater simulated distance from the second depth layer 1532b than in FIG. 15K when media item 1515c is displayed within user interface 1514.

At FIG. 15L, computer system 1500 detects a selection input corresponding to selection of option 1528 (e.g., pinch air gesture 1534a while the user looks at option 1528, as indicated by gaze indication 1534b). At FIG. 15M, in response to detecting the selection input corresponding to selection of option 1528, computer system 1500 ceases displaying media item 1515c in the immersive viewing mode, and re-displays media item 1515c within user interface 1514.

At FIG. 15N, computer system 1500 displays converted spatial media item 1515a within user interface 1514 with the stereoscopic visual treatment, as described above. At FIG. 15N, computer system 1500 detects a selection input corresponding to selection of option 1516f (e.g., pinch air gesture 1536a while the user looks at option 1516f, as indicated by gaze indication 1536b). At FIG. 15O, in response to the selection input corresponding to selection of option 1516f, computer system 1500 now displays converted spatial media item 1515a within user interface with the non-stereoscopic visual treatment. In some embodiments, selection of option 1516f while media item 1515a is displayed with the non-stereoscopic visual treatment causes computer system 1500 to display media item 1515a with the stereoscopic visual treatment. In FIG. 15O, while media item 1515a is displayed with the non-stereoscopic visual treatment, immersive viewing option 1516e is disabled. Furthermore, in FIG. 15O, user interface 1514 does not include spatial conversion option 1516c due to the fact that media item 1515a is a spatial media item (e.g., a converted spatial media item), even if it is being displayed with the non-stereoscopic visual treatment.

At FIG. 15O, computer system 1500 detects a selection input corresponding to selection of option 1516g (e.g., pinch air gesture 1538a while the user looks at option 1516g, as indicated by gaze indication 1538b). At FIG. 15P, in response to the selection input corresponding to selection of option 1516g, computer system 1500 displays discard option 1540 that, when selected, causes computer system 1500 to discard stereoscopic depth information corresponding to media item 1515a. In some embodiments, discarding stereoscopic depth information corresponding to media item 1515a (e.g., stereoscopic depth information that was generated as part of converting media item 1515a from a non-spatial media item to a spatial media item) converts media item 1515a back to a non-spatial media item. In some embodiments, a user is given the option to discard stereoscopic depth information for converted spatial media items, but is not given the option to discard stereoscopic depth information for native spatial media items.

At FIG. 15P, computer system 1500 detects a selection input corresponding to selection of discard option 1540 (e.g., pinch air gesture 1542a while the user looks at discard option 1540, as indicated by gaze indication 1542b). At FIG. 15Q, in response to detecting the selection input corresponding to selection of discard option 1540, computer system 1500 discards and/or deletes stereoscopic depth information for media item 1515a. Furthermore, at FIG. 15Q, in response to detecting the selection input corresponding to selection of discard option 1540, computer system 1500 replaces display of immersive viewing option 1516e with spatial conversion option 1516c, and ceases display of option 1516f.

In some embodiments, when a user chooses to view a converted spatial media item with the non-stereoscopic visual treatment for greater than a threshold duration of time, stereoscopic depth information for the converted spatial media item is automatically deleted, and the converted spatial media item is converted back to a non-spatial media item. This is done, for example, to conserve computing resources and/or storage space. In general, it may be preferable to maintain stereoscopic depth information for converted spatial media items due to the computing resources and time that it takes to convert a non-spatial media item to a spatial media item. However, if it is relatively clear that the user does not have interest in viewing a particular media item as a spatial media item (e.g., the viewer has turned off the stereoscopic visual treatment for the spatial media item for a threshold duration of time), in some embodiments, computer system 1500 conserves storage space and resources by deleting the stereoscopic depth information.

At FIG. 15R, computer system 1500 displays media item 1515d within user interface 1514. Media item 1515d is a non-spatial media item. In some embodiments, media item 1515d is displayed with display option 1544 based on a determination that media item 1515d includes a plurality of frames, and includes a static representation and a non-static (e.g., moving) representations. In some embodiments, media item 1515d is represented by the static (e.g., non-moving) representation until one or more criteria are satisfied (e.g., the user interacts with media item 1515d), and when the one or more criteria are satisfied, media item 1515d is represented by the non-static (e.g., moving) representation that includes transitioning between the plurality of frames in media item 1515d. When display option 1544 is enabled (as shown in FIG. 15R), media item 1515d is represented by both the static representation and the non-static representation, as just described. However, when display option 1544 is disabled, media item 1515d is represented by only the static representations, and the non-static representation is not displayed even when the one or more criteria are satisfied.

At FIG. 15R, computer system 1500 detects a selection input corresponding to selection of spatial conversion option 1516c (e.g., pinch air gesture 1546a while the user looks at spatial conversion option 1516c, as indicated by gaze indication 1546b). At FIG. 15S, in response to detecting the selection input corresponding to selection of spatial conversion option 1516c, computer system 1500 converts media item 1515d from a non-spatial media item to a spatial media item and displays media item 1515d with the stereoscopic visual treatment. In some embodiments, when a media item is displayed with the stereoscopic visual treatment (e.g., with stereoscopic depth), display option 1544 is automatically disabled. Accordingly, in FIG. 15S, display option 1544 is disabled.

At FIG. 15S, computer system 1500 detects a selection input corresponding to selection of display option 1544 (e.g., pinch air gesture 1550a while the user looks at display option 1544, as indicated by gaze indication 1550b). At FIG. 15T, in response to detecting the selection input corresponding to selection of display option 1544, computer system 1500 disables display option 1544 (e.g., computer system 1500 displays display option 1544 in a manner that indicates that display option 1544 is disabled). Furthermore, in some embodiments, when display option 1544 is enabled for a media item, the media item is automatically displayed with the non-stereoscopic visual treatment. Accordingly, in FIG. 15T, in response to detecting the selection input corresponding to selection of display option 1544, computer system 1500 transitions from displaying spatial media item 1515d with the stereoscopic visual treatment to displaying media item 1515d with the non-stereoscopic visual treatment.

At FIG. 15U, computer system 1500 displays user interface 1504. As discussed above, in some embodiments, user interface 1504 includes option 1506a that, when selected, causes computer system 1500 to display representations of spatial media items without displaying representations of non-spatial media items. At FIG. 15U, option 1506a is selected, and computer system 1500 displays, within user interface 1504, representations of spatial media items without displaying representations of non-spatial media items. In some embodiments, option 1506a is displayed within user interface 1504 based on a determination that computer system 1500 is configured to display and/or able to display spatial media items with stereoscopic depth. In some embodiments, computer systems that are not configured to display and/or are not able to display spatial media items do not include an option to display representations of spatial media items without displaying representations of non-spatial media items. For example, in FIGS. 15V-1-15V-2, computer system 600 is a computer system that is not configured to display spatial media items with stereoscopic depth (e.g., computer system 600 includes only one display component and is not configured to display different visual components to different eyes of a user at the same time). Based on a determination that computer system 600 is not configured to display spatial media items with stereoscopic depth, user interface 610 in FIGS. 15V-1-15V-2 does not include option 1506a and/or any other option to display representations of spatial media items without displaying representations of non-spatial media items.

FIG. 16 is a flow diagram illustrating a method for displaying and/or providing content in accordance with some embodiments. Method 1600 is performed at a computer system (e.g., 100, 300, 500, 600, and/or 1500) (e.g., a smart phone, a smart watch, a tablet, a laptop, a desktop, a wearable device, wrist-worn device, and/or head-mounted device) that is in communication with one or more display generation components (e.g., 1502 and/or 1502-1) (e.g., a visual output device, a 3D display, a display having at least a portion that is transparent or translucent on which images can be projected (e.g., a see-through display), a projector, a heads-up display, and/or a display controller) and one or more input devices (e.g., a touch-sensitive surface (e.g., a touch-sensitive display); a mouse; a keyboard; a remote control; a visual input device (e.g., one or more cameras (e.g., an infrared camera, a depth camera, a visible light camera, and/or a gaze tracking camera)); an audio input device; a biometric sensor (e.g., a fingerprint sensor, a face identification sensor, a gaze tracking sensor, and/or an iris identification sensor) and/or one or more mechanical input devices (e.g., a depressible input mechanism; a button; a rotatable input mechanism; a crown; and/or a dial)). Some operations in method 1600 are, optionally, combined, the orders of some operations are, optionally, changed, and some operations are, optionally, omitted.

As described below, method 1600 provides an intuitive way for displaying and/or providing content. The method reduces the cognitive burden on a user for navigating and/or accessing content, thereby creating a more efficient human-machine interface. For battery-operated computing devices, enabling a user to navigate and/or access content faster and more efficiently conserves power and increases the time between battery charges.

The computer system (e.g., 1500) displays (1602), via the one or more display generation components (e.g., 1502 and/or 1502-1), a representation of a media library (e.g., 1504) (e.g., a media library associated with the computer system; a media library associated with a user (e.g., a user of the computer system); and/or a media library associated with a user account), wherein the media library includes a plurality of media items (e.g., images, photos, and/or videos) including a first media item and a second media item different from the first media item. In some embodiments, the representation of the media library includes representations (e.g., previews, thumbnails, snapshots, and/or frames) of one or more media items (e.g., 1508a, 1508b, and/or 1508c) (e.g., a first subset and/or a first plurality) of the plurality of media items in the media library. While displaying the representation of the media library (1604), the computer system detects (1606), via the one or more input devices, a request (e.g., a user input and/or one or more user inputs corresponding to a request to display the first media item) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) to display the first media item (e.g., user inputs 1510, 1510a, 1510b, and/or 1510c). In response to detecting the request to display the first media item (1608): in accordance with a determination that first criteria are satisfied, wherein the first criteria include a requirement that the first media item is a non-spatial media item (e.g., a two-dimensional image and/or a two-dimensional video) (e.g., a media item that is displayed in the same manner to the right eye and the left eye of a user; and/or a media item that is not displayed differently to the right eye and the left eye of a user) in order for the first criteria to be met, the computer system displays (1610), via the one or more display generation components, the first media item with a spatial conversion option (e.g., 1516c) (e.g., concurrently displays the first media item and the spatial conversion option; and/or displays the spatial conversion option concurrently with at least a portion of the first media item) that, when selected, causes the computer system to initiate a process for converting (e.g., in some embodiments, using an AI process or a generative AI process) the first media item from a non-spatial media item to a spatial media item that includes stereoscopic depth (e.g., in some embodiments, a spatial media item that includes automatically-generated visual content and/or generative visual content). In some embodiments, a spatial media item includes a first visual component corresponding to a viewpoint of a right eye (e.g., a first still image component that corresponds to an image from a viewpoint of the right eye and/or a first video component that corresponds to a sequence of images that corresponds to a sequence of images from a viewpoint of the right eye) and a second visual component different from the first visual component and that corresponds to a viewpoint of a left eye (e.g., a second still image component that corresponds to an image from a viewpoint of the left eye and/or a second video component that corresponds to a sequence of images that corresponds to a sequence of images from a viewpoint of the left eye) that, when viewed concurrently, create an illusion of a spatial representation of captured visual content. In some embodiments, viewing the first visual component with a first eye and the second visual component with a second eye creates an illusion of a three-dimensional representation of the media referred to as stereoscopic depth. In some embodiments, a spatial media item includes stereoscopic depth information (e.g., that enables the spatial media item to be displayed with stereoscopic depth).

In some embodiments, in response to detecting the request to display the first media item: in accordance with a determination that the first criteria are not satisfied (e.g., in accordance with a determination that the first media item is a spatial media item and/or in accordance with a determination that the first media item cannot be converted into a spatial media item), the computer system (e.g., 1500) displays the first media item (e.g., 1515a, 1515b, 1515c, and/or 1515d) without displaying the spatial conversion option (e.g., 1516c). In some embodiments, a spatial media item includes a first visual component corresponding to a viewpoint of a right eye and a second visual component different from the first visual component and that corresponds to a viewpoint of a left eye that, when viewed concurrently, create an illusion of a spatial representation of captured visual content. In some embodiments, non-spatial media does not include separate visual components that are displayed to different eyes of a user. For example, in some embodiments, non-spatial media includes a single visual component that is displayed (e.g., concurrently displayed) to the left eye and the right eye of the user. In some embodiments, while displaying the first media item with the spatial conversion option (e.g., 1516c), the computer system detects a selection input (e.g., a user input and/or one or more user inputs directed to the spatial conversion option) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the spatial conversion option (e.g., user inputs 1518a and 1518b). In response to detecting the selection input corresponding to selection of the spatial conversion option, the computer system initiates a process for converting the first media item from a non-spatial media item to a spatial media item (e.g., in some embodiments, a spatial media item that includes automatically-generated visual content and/or generative visual content). Providing the user with a selectable option to convert a non-spatial media item to a spatial media item allows a user to perform these operations with fewer inputs. Doing so also provides the user with a suggestion and/or an indication that the first media item can be converted to spatial media. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the representation of the media library (e.g., 1504) comprises concurrently displaying a plurality of representations of media items (e.g., 1508a, 1508b, and/or 1508c) in the representation of the media library, including a representation of a non-spatial media item (e.g., the first media item), wherein the representation of the non-spatial media item is displayed without displaying the spatial conversion option (e.g., media item 1515a is represented in user interface 1504 by representation 1508a, and is displayed in user interface 1504 without displaying spatial conversion option 1516c; but in FIG. 15B, media item 1515a is displayed within user interface 1514 with spatial conversion option 1516c). Providing the user with a selectable option to convert a non-spatial media item to a spatial media item allows a user to perform these operations with fewer inputs. Doing so also provides the user with a suggestion and/or an indication that the first media item can be converted to spatial media. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the request to display the first media: in accordance with a determination that second criteria different from the first criteria are satisfied, wherein the second criteria include a requirement that the first media item is a spatial media item that includes stereoscopic depth information (e.g., that enables the spatial media item to be displayed with stereoscopic depth) in order for the second criteria to be met, the computer system displays, via the one or more display generation components, the first media item with a first set of visual characteristics (e.g., a first stereoscopic depth, a first saturation, a first brightness, and/or a first size) and with a spatial viewing option (e.g., 1516e) (e.g., concurrently displaying the first media item and the spatial viewing option; and/or displaying the spatial viewing option concurrently with at least a portion of the first media item) that, when selected, causes the computer system to display the first media item in a spatial viewing mode (e.g., FIG. 15H and/or FIG. 15L) in which the first media item is displayed with a second set of visual characteristics (e.g., a second stereoscopic depth, a second saturation, a second brightness, and/or a second size) different from the first set of visual characteristics. In some embodiments, while displaying the first media item with the first set of visual characteristics and with the spatial viewing option (e.g., 1516e), the computer system receives, via the one or more input devices, a selection input corresponding to selection of the spatial viewing option (e.g., user inputs 1524a, 1524b) (e.g., a user input and/or one or more user inputs directed to the spatial viewing option) (e.g., one or more touch inputs directed to the spatial viewing option, one or more touchscreen inputs directed to the spatial viewing option, one or more gestures directed to the spatial viewing option, one or more air gestures directed to the spatial viewing option, one or more spoken inputs directed to the spatial viewing option, and/or one or more mechanical inputs (e.g., via one or more physical buttons and/or physically rotatable input mechanisms) directed to the spatial viewing option). In response to receiving the selection input corresponding to selection of the spatial viewing option, the computer system transitions from displaying the first media item with the first set of visual characteristics (e.g., 1515a in FIG. 15G) to displaying the first media item with the second set of visual characteristics (e.g., 1515a in FIG. 15H). In some embodiments, displaying the first media item with the second set of visual characteristics (e.g., 1515a in FIG. 15H) includes displaying the first media item with greater depth between a first depth layer and a second depth layer of the first media item than when the first media item is displayed with the first set of visual characteristics (e.g., 1515a in FIG. 15G). In some embodiments, displaying the first media item with the second set of visual characteristics includes ceasing display of a border surrounding the first media item. In some embodiments, displaying the first media item with the second set of visual characteristics includes dimming regions surrounding the first media item (e.g., a passthrough environment surrounding the first media item). In some embodiments, displaying the first media item with the second set of visual characteristics includes ceasing display of one or more selectable options corresponding to the first media item. Providing the user with a selectable option to display the first media item in a spatial viewing mode allows a user to perform these operations with fewer inputs. Doing so also provides the user with a suggestion and/or an indication that the first media item is viewable in the spatial viewing mode. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first media item with the spatial conversion option (e.g., 1516c) comprises displaying the spatial conversion option at a first display position (e.g., a first position within a user interface and/or a first position relative to or on the first media item); and displaying the first media item with the spatial viewing option (e.g., 1516e) comprises displaying the spatial viewing option at the first display position (e.g., at the same position as the spatial conversion option). Providing the user with a selectable option to display the first media item in a spatial viewing mode allows a user to perform these operations with fewer inputs. Doing so also provides the user with a suggestion and/or an indication that the first media item is viewable in the spatial viewing mode. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first media item (e.g., 1515a) with the spatial conversion option (e.g., 1516c), the computer system receives, via the one or more input devices, a selection input (e.g., a user input and/or one or more user inputs) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the spatial conversion option (e.g., user inputs 1518a-1518b). In response to receiving the selection input corresponding to selection of the spatial conversion option, the computer system (e.g., 1500) displays, via the one or more display generation components, replacement of the spatial conversion option (e.g., 1516c) with a spatial viewing option (e.g., 1516e) that, when selected, causes the computer system to transition from displaying the first media item with a first set of visual characteristics (e.g., a first stereoscopic depth, a first saturation, a first brightness, and/or a first size) (e.g., 1515a in FIG. 15G) to displaying the first media item in a spatial viewing mode in which the first media item is displayed with a second set of visual characteristics (e.g., a second stereoscopic depth, a second saturation, a second brightness, and/or a second size) different from the first set of visual characteristics (e.g., 1515a in FIG. 15H). In some embodiments, while displaying the first media item with the first set of visual characteristics (e.g., 1515a in FIG. 15G) and with the spatial viewing option (e.g., 1516e), the computer system receives, via the one or more input devices, a selection input corresponding to selection of the spatial viewing option (e.g., a user input and/or one or more user inputs directed to the spatial viewing option) (e.g., one or more touch inputs directed to the spatial viewing option, one or more touchscreen inputs directed to the spatial viewing option, one or more gestures directed to the spatial viewing option, one or more air gestures directed to the spatial viewing option, one or more spoken inputs directed to the spatial viewing option, and/or one or more mechanical inputs (e.g., via one or more physical buttons and/or physically rotatable input mechanisms) directed to the spatial viewing option) (e.g., user inputs 1524a, 1524b). In response to receiving the selection input corresponding to selection of the spatial viewing option, the computer system transitions from displaying the first media item with the first set of visual characteristics (e.g., FIG. 15G) to displaying the first media item with the second set of visual characteristics (e.g., FIG. 15H). In some embodiments, displaying the first media item with the second set of visual characteristics includes displaying the first media item with greater depth between a first depth layer and a second depth layer of the first media item than when the first media item is displayed with the first set of visual characteristics. In some embodiments, displaying the first media item with the second set of visual characteristics includes ceasing display of a border surrounding the first media item. In some embodiments, displaying the first media item with the second set of visual characteristics includes dimming regions surrounding the first media item (e.g., a passthrough environment surrounding the first media item). In some embodiments, displaying the first media item with the second set of visual characteristics includes ceasing display of one or more selectable options corresponding to the first media item. Providing the user with a selectable option to convert a non-spatial media item to a spatial media item allows a user to perform these operations with fewer inputs. Doing so also provides the user with a suggestion and/or an indication that the first media item can be converted to spatial media. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first media item with the spatial conversion option (e.g., 1516dc), the computer system receives, via the one or more input devices, a selection input (e.g., a user input and/or one or more user inputs directed to the spatial conversion option) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the spatial conversion option (e.g., user inputs 1518a, 1518b). In response to receiving the selection input corresponding to selection of the spatial conversion option, the computer system displays, via the one or more display generation components, the first media item with a three-dimensional effect in which one or more visual elements of the first media item are displayed at a first simulated depth (e.g., a first stereoscopic depth) and other visual elements of the first media item are displayed at a second simulated depth (e.g., a second stereoscopic depth) different from the first simulated depth (e.g., FIG. 15G and/or the second row of FIG. 15I). In some embodiments, prior to receiving the selection input corresponding to selection of the spatial conversion option, the first media item is displayed without the three-dimensional effect and/or as a two-dimensional image in which the one or more visual elements of the first media item are displayed at the same stereoscopic depth as the other visual elements of the first media item (e.g., all visual elements of the first media item are displayed at the same stereoscopic depth) (e.g., FIG. 15C). Providing the user with a selectable option to convert a non-spatial media item to a spatial media item allows a user to perform these operations with fewer inputs. Doing so also provides the user with a suggestion and/or an indication that the first media item can be converted to spatial media. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first media item with the spatial conversion option (e.g., 1516c), the computer system receives, via the one or more input devices, a selection input (e.g., a user input and/or one or more user inputs directed to the spatial conversion option) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the spatial conversion option (e.g., user inputs 1518a, 1518b). In response to receiving the selection input corresponding to selection of the spatial conversion option, the computer system displays, via the one or more display generation components, a first animation (e.g., 1520) while converting the first media item from a non-spatial media item to a spatial media item (e.g., in some embodiments, converting the first media item using an AI process or a generative AI process) that includes simulated depth (e.g., stereoscopic depth) (e.g., a first animation indicative of the first media item being converted from a non-spatial media item to a spatial media item). Displaying the first animation while the first media item is being converted from a non-spatial media item to a spatial media item provides the user with visual feedback about a state of the system (e.g., the system is converting the first media item). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1520) includes displaying an indication of a determined three-dimensional shape of one or more visual elements of the first media item (e.g., in some embodiments, the first animation indicates and/or identifies the boundaries of one or more three-dimensional objects in the first media item). Displaying the first animation while the first media item is being converted from a non-spatial media item to a spatial media item provides the user with visual feedback about a state of the system (e.g., the system is converting the first media item). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1520) includes displaying animation of the spatial conversion option (e.g., 1516c) (e.g., displaying visual modification of the spatial conversion option). Displaying the first animation while the first media item is being converted from a non-spatial media item to a spatial media item provides the user with visual feedback about a state of the system (e.g., the system is converting the first media item). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1520) includes blurring at least a first portion of the first media item (e.g., 1515a) (e.g., blurring a portion of the content or all of the content that has not been converted to spatial media). Displaying the first animation while the first media item is being converted from a non-spatial media item to a spatial media item provides the user with visual feedback about a state of the system (e.g., the system is converting the first media item). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1520) includes moving the boundary of a distortion layer (e.g., a blurring layer) across the first media item (e.g., 1515a) (e.g., moving the boundary from one edge toward another edge such as moving the boundary of the distortion layer from a bottom of the first media item toward a top of the first media item, where a portion of the first media item that is on a first side of the boundary of the distortion layer is distorted and a portion of the first media item that is on a second side of the boundary of the distortion layer is not distorted). In some embodiments, moving the boundary of the distortion layer across the first media item (e.g., 1515a) causes a distorting effect (e.g., a blurring effect and/or a de-saturating effect) to be applied differently to different portions of the first media item and/or for the distorting effect to move across the first media item. Displaying the first animation while the first media item is being converted from a non-spatial media item to a spatial media item provides the user with visual feedback about a state of the system (e.g., the system is converting the first media item). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1520) includes displaying movement of a color gradient across different simulated depths (e.g., 1522a, 1522b, and/or 1522c) (e.g., across visual elements displayed at different depths of the first media item) of the first media item (e.g., 1515a) (e.g., in some embodiments, different depths detected by the computer system and/or by one or more external computer systems (e.g., using one or more machine learning models)) (e.g., in some embodiments, different depths detected using an AI process or a generative AI process) (e.g., FIGS. 15D-15F). In some embodiments, the computer system and/or one or more external computer systems determine (e.g., based one or more machine learning models and/or algorithms) that a first set of visual elements in the first media item correspond to a first depth (e.g., 1522a) (e.g., in some embodiments, using an AI process or a generative AI process) and a second set of visual elements in the first media item correspond to a second depth (e.g., 1522b) different from the first depth (e.g., in some embodiments, using an AI process or a generative AI process) (and, optionally, a third set of visual elements in the first media item correspond to a third depth (e.g., 1522c) different from the first depth and the third depth (e.g., in some embodiments, using an AI process or a generative AI process)). In some embodiments, the color gradient includes a first color and a second color different from the first color (and, optionally, a third color different from the first color and the second color). In some embodiments, displaying movement of the color gradient across the different depths of the first media item includes: at a first time, displaying a first depth (e.g., 1522a) of the first media item (e.g., the first set of visual elements corresponding to the first depth) in the first color and a second depth (e.g., 1522b) of the first media item (e.g., the second set of visual elements corresponding to the second depth) in the second color (and, optionally, displaying, at the first time, the third depth of the first media item (e.g., the third set of visual elements corresponding to the third depth) in the third color) (e.g., FIG. 15d); and at a second time subsequent to the first time, displaying the first depth (e.g., 1522a) of the first media item (e.g., the first set of visual elements in the first media item) in the second color and ceasing to display the second depth (e.g., 1522b) of the first media item (e.g., the second set of visual elements in the first media item) in the second color (e.g., FIG. 15E) (e.g., in some embodiments, displaying the second depth of the first media item in a third color different from the first color and the second color) (and, in some embodiments, displaying the third depth of the first media item (e.g., the third set of visual elements in the first media item) in the first color, the second color, or a fourth color different from the first color, the second color, and the third color). Displaying the first animation while the first media item is being converted from a non-spatial media item to a spatial media item provides the user with visual feedback about a state of the system (e.g., the system is converting the first media item). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first animation (e.g., 1502) includes displaying highlighting of different depths (e.g., 1522a, 1522b, and/or 1522c) (e.g., displaying highlighting of visual elements displayed at different depths of the first media item) (e.g., in some embodiments, displaying increased brightness a respective depth relative to other depths) of the first media item at different times (e.g., in some embodiments, different depths detected by the computer system and/or by one or more external computer systems (e.g., using one or more machine learning models)). In some embodiments, the computer system and/or one or more external computer systems determine (e.g., based one or more machine learning models and/or algorithms) (e.g., in some embodiments, using an AI process or a generative AI process) that a first set of visual elements in the first media item correspond to a first depth (e.g., 1522a) and a second set of visual elements in the first media item correspond to a second depth (e.g., 1522b) different from the first depth (and, optionally, a third set of visual elements in the first media item correspond to a third depth (e.g., 1522c) different from the first depth and the third depth). In some embodiments, displaying highlighting of different depths of the first media item at different times includes: at a first time, displaying a first depth of the first media item (e.g., the first set of visual elements corresponding to the first depth) highlighted (e.g., with increased brightness relative to other depths) without highlighting one or more other depths of the first media item including the second depth (and, optionally, the third depth) (e.g., FIG. 15D); and at a second time subsequent to the first time, displaying the second depth of the first media item (e.g., the second set of visual elements in the first media item) highlighted without highlighting one or more other depths of the first media item including the first depth (and, optionally, the third depth) (e.g., FIG. 15E). Displaying the first animation while the first media item is being converted from a non-spatial media item to a spatial media item provides the user with visual feedback about a state of the system (e.g., the system is converting the first media item). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the request to display the first media item: in accordance with a determination that the first media item is a non-spatial media item that cannot be converted to a spatial media item (e.g., based on the first media item being a particular type of media item (e.g., a video, a multi-frame image, a moving image, a media item that includes content that cannot be processed to determine estimated depth information, and/or a live photo)), the computer system displays, via the one or more display generation components, the first media item without displaying the spatial conversion option (e.g., 1515b in FIG. 15J). Forgoing displaying the spatial conversion option when the first media item cannot be converted to a spatial media item enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the spatial conversion option (e.g., 1516c) is displayed with a brightness (e.g., with a brightness that is outside of a standard range and/or a predefined range for content display) that is above a threshold brightness (e.g., above a predefined brightness threshold and/or a respective brightness level) (e.g., the first content is high-dynamic-range (HDR) content, wide dynamic range content, extended dynamic range content, and/or expanded dynamic range content). In some embodiments, displaying the representation of the media library (e.g., 1504) and/or displaying the first media item (e.g., 1515a, 1515b, 1515c, and/or 1515d) includes displaying the representation of the media library and/or displaying the first media item using a first brightness range (e.g., a non-HDR brightness range and/or a standard brightness range). In some embodiments, the spatial conversion option (e.g., 1516c) is displayed at a brightness level that is above the first brightness range. In some embodiments, a dynamic range is the range of brightness (e.g., a range between the brightest level to the darkest level) and/or colors (e.g., a range and/or variation in colors). When referring to a display, in some embodiments, a dynamic range is a range of brightness and/or a range of colors that the display can display (e.g., produce). In some embodiments, an HDR display can display a range of brightness from 0.05 nits (e.g., cd/m2) to 1,000 nits (e.g., cd/m2). In some embodiments, an HDR display includes a range of brightness from 0.0005 nits (e.g., cd/m2) to 540 nits (e.g., cd/m2). In some embodiments, an HDR display is capable of displaying a brightness of at least 1,000 nits (or, optionally, a range of 1,000 nits to 4,000 nits). In some embodiments, a non-HDR display can display a maximum brightness that is less than a maximum brightness of an HDR display. In some embodiments, a non-HDR display can display a maximum brightness of less than 1,000 nits (or, optionally, a maximum brightness of 100 nits). Providing the user with a selectable option to convert a non-spatial media item to a spatial media item allows a user to perform these operations with fewer inputs. Doing so also provides the user with a suggestion and/or an indication that the first media item can be converted to spatial media. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, converting the first media item (e.g., 1515a) from a non-spatial media item to a spatial media item that includes stereoscopic depth (e.g., in some embodiments, a spatial media item that includes automatically-generated visual content and/or generative visual content) includes using one or more machine learning models (e.g., in some embodiments, using an AI process or a generative AI process) (e.g., the computer system uses one or more machine learning models and/or one or more external computer system use one or more machine learning models) to estimate the depths of objects depicted in the first media item (e.g., 1522a, 1522b, and/or 1522c) (e.g., to estimate the depths of objects depicted in the first media item relative to one another (e.g., to estimate that a first set of objects in the first media item are positioned in front of a second set of objects in the first media item; and/or to estimate that a first set of objects in the first media item are positioned behind a second set of objects in the first media item). Providing the user with a selectable option to convert a non-spatial media item to a spatial media item, and automatically estimating the depths of various objects in the media item using machine learning, allows a user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, converting the first media item (e.g., 1515a) from a non-spatial media item to a spatial media item that includes stereoscopic depth includes using one or more generative models (e.g., one or more generative artificial intelligence models and/or one or more generative AI models) (e.g., an AI process or a generative AI process) (e.g., the computer system uses one or more generative models and/or one or more external computer system use one or more generative models) to create infill (e.g., automatically-generated visual content and/or generative visual content) (e.g., content that is not in the first media item and/or content that is displayed between different depth layers of the first media item when the first media item is displayed as spatial media with stereoscopic depth) to synthetically generate at least one of a left view of the first media item (e.g., a left view that is configured to be and/or will be displayed to a left eye of a user while a right view that is different from the left view is concurrently displayed to a right eye of the user (e.g., to generate the illusion and/or the impression of depth)) and a right view of the first media item (e.g., a right view that is configured to be and/or will be displayed to a right eye of a user while a left view that is different from the right view is concurrently displayed to a left eye of the user (e.g., to generate the illusion and/or the impression of depth)) that is different from the left view of the first media item (e.g., as shown in the second row of FIG. 15I, in which display module 1502 displays a left view of media item 1515a and display module 1502-1 displays a right view of media item 1515a). In some embodiments, the computer system synthetically generates (e.g., using an AI process or a generative AI process) the left view of the media item and the right view of the first media item (e.g., by shifting the first media item in a first direction to generate the left view and shifting the first media item in a second direction to generate the right view). In some embodiments, the computer system synthetically generates (e.g., using an AI process or a generative AI process) the left view of the media item (e.g., by shifting the first media item in a direction) and uses the first media item as the right view of the media item. In some embodiments, the computer system synthetically generates the right view of the media item (e.g., by shifting the first media item in a direction) and uses the first media item as the left view of the media item. Providing the user with a selectable option to convert a non-spatial media item to a spatial media item, including automatically generating infill to generate different left and right views, allows a user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Additionally, creating infill to synthetically generate the left view and/or the right view of the first media item is a task that cannot be performed by most humans.

In some embodiments, displaying the first media item (e.g., 1515a) with the spatial conversion option (e.g., 1516c) comprises displaying the first media item with a first set of visual characteristics indicative of the first media item being a non-spatial media item (e.g., displaying the first media item without stereoscopic depth and/or displaying the first media item with a first type of border) (e.g., FIG. 15B). While displaying the first media item with the first set of visual characteristics (e.g., FIG. 15B) and with the spatial conversion option (e.g., 1516c), the computer system receives, via the one or more input devices, a selection input (e.g., a user input and/or one or more user inputs directed to the spatial conversion option) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the spatial conversion option (e.g., user inputs 1518a, 1518b). In response to receiving the selection input corresponding to selection of the spatial conversion option: the computer system displays, via the one or more display generation components, the first media item with a second set of visual characteristics indicative of the first media item being a spatial media item (e.g., displaying the first media item with stereoscopic depth and/or displaying the first media item with a second type of border and/or a blurred border) (e.g., FIG. 15G); and displays, concurrently with the first media item with the second set of visual characteristics, a selectable object (e.g., 1516f) that, when selected, causes the computer system to transition from displaying the first media item with the second set of visual characteristics to displaying the first media item with the first set of visual characteristics. In some embodiments, the selectable object (e.g., 1516f), when selected, enables or disables a spatial treatment setting of the first media item (e.g., enables or disables a spatial treatment setting for the first media item). For example, if the selectable object is selected while the spatial treatment setting of the first media item is enabled (e.g., and the first media item is displayed with the second set of visual characteristics), the spatial treatment setting of the first item is disabled (e.g., and the first media item is displayed with the first set of visual characteristics). If the selectable object is selected while the spatial treatment setting of the first media item is disabled (e.g., and the first media item is displayed with the first set of visual characteristics), the spatial treatment setting of the first item is enabled (e.g., and the first media item is displayed with the second set of visual characteristics). In some embodiments, disabling the spatial viewing option enables viewing of a higher resolution image that does not have stereoscopic depth (e.g., a higher resolution two-dimensional image).

In some embodiments, the computer system concurrently displays the first media item (e.g., 1515a) and the selectable object (e.g., 1516f). While concurrently displaying the first media item and the selectable object, the computer system receives a selection input corresponding to selection of the selectable object. In response to receiving the selection input corresponding to selection of the selectable object: in accordance with a determination that the first media item is displayed with the first set of visual characteristics (e.g., FIG. 15B and/or FIG. 15O) when the selection input corresponding to selection of the selectable object is received, the computer system transitions from displaying the first media with the first set of visual characteristics (e.g., FIG. 15B and/or FIG. 15O) to displaying the computer system with the second set of visual characteristics (e.g., FIG. 15G and/or FIG. 15N); and in accordance with a determination that the first media item is displayed with the second set of visual characteristics (e.g., FIG. 15G and/or FIG. 15N) when the selection input corresponding to selection of the selectable object is received, the computer system transitions from displaying the first media with the second set of visual characteristics to displaying the computer system with the first set of visual characteristics (e.g., FIG. 15B and/or FIG. 15O). Providing the user with a selectable option to selectively enable or disable spatial media treatment of a media item allows a user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to receiving the selection input corresponding to selection of the spatial conversion option (e.g., 1516c), the computer system displays, concurrently with the first media item with the second set of visual characteristics and the selectable object (e.g., 1516f), a spatial viewing option (e.g., 1516e) that, when selected, causes the computer system to display the first media item in a spatial viewing mode in which the first media item is displayed with a third set of visual characteristics (e.g., a third stereoscopic depth, a third saturation, a third brightness, and/or a third size) different from the first set of visual characteristics and the second set of visual characteristics (e.g., FIG. 15H). While concurrently displaying the first media item with the second set of visual characteristics (e.g., FIG. 15G), the selectable object (e.g., 1516f), and the spatial viewing option (e.g., 1516e), the computer system receives, via the one or more input devices, a selection input (e.g., a user input and/or one or more user inputs directed to the selectable object) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the selectable object (e.g., 1516f) (e.g., user inputs 1536a, 1536b). In response to receiving the selection input corresponding to selection of the selectable object, the computer system ceases display of the spatial viewing option (e.g., in FIG. 15O, option 1516e is disabled). In some embodiments, in response to receiving the selection input corresponding to selection of the selectable object, the computer system transitions from displaying the first media item with the second set of visual characteristics to displaying the first media item with the first set of visual characteristics. Ceasing display of the spatial viewing option when the selectable object is selected (and, in some embodiments, the first media item is displayed as a non-spatial media item), enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to receiving the selection input corresponding to selection of the spatial conversion option (e.g., 1516c), the first media item is converted from a non-spatial media item to a spatial media item that includes stereoscopic depth (e.g., by the computer system and/or by one or more external computer systems separate from the computer system). In some embodiments, converting the first media item from a non-spatial media item to a spatial media item includes generating (e.g., using an AI process or a generative AI process) calculated spatial information corresponding to the first media item (e.g., calculated spatial information that is used to display the first media item with stereoscopic depth). In some embodiments, in response to receiving the selection input corresponding to selection of the selectable object (e.g., 1516f), the computer system transitions a spatial treatment setting of the first media item from an enabled state to a disabled state (e.g., in some embodiments, the spatial treatment setting of the first media item is in an enabled state when the first media item is displayed with the second set of visual characteristics and the spatial treatment setting of the first media item is in a disabled state when the first media item is displayed with the first set of visual characteristics). Subsequent to transitioning the spatial treatment setting of the first media item from the enabled state to the disabled state: in accordance with a determination that the spatial treatment setting of the first media item has been in the disabled state for greater than a threshold duration of time (e.g., greater than 12 hours, greater than 1 day, greater than 3 days, greater than 5 days, or greater than one week), the computer system discards (e.g., deleting and/or ceasing to maintain) the calculated spatial information corresponding to the first media item. In some embodiments, subsequent to transitioning the spatial treatment setting of the first media item from the enabled state to the disabled state: in accordance with a determination that the spatial treatment setting of the first media item has been in the disabled state for less than the threshold duration of time, the computer system maintains the calculated spatial information corresponding to the first media item and/or forgoes discarding the calculated spatial information corresponding to the first media item. In some embodiments, the computer system receives, via the one or more input devices, a user request to display the first media item with the second set of visual characteristics (e.g., a user request to display the first media item as spatial media and/or a user request to display the first media item with stereoscopic depth and/or simulated depth) (e.g., as shown in FIG. 15G). In some embodiments, the user request to display the first media item with the second set of visual characteristics includes selection of the selectable object (e.g., 1516f) or selection of the spatial conversion option (e.g., 1516c). In some embodiments, the selectable object (e.g., 1516f) is displayed at a first display position (e.g., when the first media item has corresponding stereoscopic depth information, spatial information, and/or calculated spatial information); and the spatial conversion option (e.g., 1516c) is also displayed at the first display position (e.g., when the first media item does not have corresponding stereoscopic depth information, spatial information, and/or calculated spatial information). In some embodiments, the user request to display the first media item with the second set of visual characteristics includes one or more user inputs corresponding to the first display position. In response to receiving the user request to display the first media item with the second set of visual characteristics: in accordance with a determination that calculated spatial information corresponding to the first media item is available (e.g., in some embodiments, in accordance with a determination that the spatial treatment setting of the first media item has been in the disabled state for less than the threshold duration of time), the computer system displays the first media item with the second set of visual characteristics in a first amount of time; and in accordance with a determination that calculated spatial information corresponding to the first media item is not available (e.g., has been discarded or has not yet been generated) (e.g., in some embodiments, in accordance with a determination that the spatial treatment setting of the first media item has been in the disabled state for greater than the threshold duration of time), the computer system displays the first media item with the second set of visual characteristics in a second amount of time that is longer than the first amount of time. In some embodiments, it takes longer for the computer system to display the first media item with the second set of visual characteristics when calculated spatial information corresponding to the first media item is not available because spatial information must first be calculated and/or generated for the first media item before displaying the first media item with the second set of visual characteristics.

In some embodiments, in response to receiving the user request to display the first media item with the second set of visual characteristics (e.g., as shown in FIG. 15G): in accordance with a determination that calculated spatial information corresponding to the first media item is not available (e.g., in some embodiments, in accordance with a determination that the spatial treatment setting of the first media item has been in the disabled state for greater than the threshold duration of time), the computer system displays a conversion animation (e.g., 1520, 1520-1, 1520-2, and/or 1520-3) (e.g., a conversion animation indicative of converting the first media item from non-spatial media to spatial media) prior to displaying the first media item with the second set of visual characteristics; and in accordance with a determination that calculated spatial information corresponding to the first media item is available (e.g., in some embodiments, in accordance with a determination that the spatial treatment setting of the first media item has been in the disabled state for less than the threshold duration of time), the computer system displays the first media item with the second set of visual characteristics without displaying the conversion animation. In some embodiments, the computer system maintains calculated spatial information for the first media item when the spatial treatment setting of the first media item is disabled because it takes time and computing resources to re-generate and/or re-calculate the calculated spatial information. However, if the spatial treatment setting of the first media item is disabled for greater than the threshold duration of time, this can be seen as an indication that the user is not interested in seeing the first media item with the spatial treatment setting (e.g., for example, because the simulated three-dimensional treatment is unsatisfactory or is not interesting to the user) and, in such scenarios, the calculated spatial information can be discarded in order to conserve memory and/or other computing resources. Discarding calculated spatial information when the spatial treatment setting of the first media item has been in the disabled state for greater than a threshold duration of time conserves computing resources (e.g., storage space and/or memory), and makes the computer system more efficient.

In some embodiments, in response to receiving the selection input corresponding to selection of the selectable object (e.g., 1516f), the computer system concurrently displays, via the one or more display generation components: the first media item (e.g., 1515a) with the first set of visual characteristics (e.g., a first set of visual characteristics indicative of the first media item being non-spatial media and/or the spatial treatment setting of the first media item being in the disabled state) (e.g., as shown in FIG. 15M); and the selectable object (e.g., 1516f). Subsequent to discarding the calculated spatial information corresponding to the first media item (e.g., based on discarding the calculated spatial information corresponding to the first media item), the computer system displays, via the one or more display generation components, the first media item with the first set of visual characteristics without displaying the selectable object (and, optionally, concurrently with the spatial conversion option) (e.g., as shown in FIG. 15Q). In some embodiments, when the calculated spatial information corresponding to the first media item, the selectable object (e.g., 1516f) is replaced with the spatial conversion option (e.g., 1516c). Discarding calculated spatial information when the spatial treatment setting of the first media item has been in the disabled state for greater than a threshold duration of time conserves computing resources (e.g., storage space and/or memory), and makes the computer system more efficient. Furthermore, ceasing display of the selectable object when the calculated spatial information is discarded enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to receiving the selection input corresponding to selection of the spatial conversion option (e.g., 1516c), the first media item (e.g., 1515a) is converted from a non-spatial media item to a spatial media item that includes stereoscopic depth (e.g., by the computer system and/or by one or more external computer systems separate from the computer system) (e.g., in some embodiments, using an AI process or a generative AI process). In some embodiments, converting the first media item from a non-spatial media item to a spatial media item includes generating calculated spatial information (e.g., in some embodiments, using an AI process or a generative AI process) corresponding to the first media item (e.g., calculated spatial information that is used to display the first media item with stereoscopic depth). In some embodiments, subsequent to converting the first media item from the spatial media item to the spatial media, including generating the calculated spatial information corresponding to the first media item, the computer system receives, via the one or more input devices, a user request (e.g., one or more user inputs corresponding to a user request to discard the calculated spatial information corresponding to the first media item) to discard the calculated spatial information corresponding to the first media item (e.g., user inputs 1542a, 1542b). In response to receiving the user request to discard the calculated spatial information corresponding to the first media item, the computer system discards (e.g., deletes and/or ceases to maintain) the calculated spatial information corresponding to the first media item. In some embodiments, the computer system maintains calculated spatial information for the first media item because it takes time and computing resources to re-generate and/or re-calculate the calculated spatial information. However, if the user is not interested in seeing the first media item with the spatial treatment setting (e.g., for example, because the simulated three-dimensional treatment is unsatisfactory or is not interesting to the user), the calculated spatial information can be discarded in order to conserve memory and/or other computing resources. Allowing a user to discard the calculated spatial information corresponding to the first media item conserves computing resources (e.g., storage space and/or memory), and makes the computer system more efficient.

In some embodiments, subsequent to converting the first media item from the spatial media item to the spatial media, the computer system displays, via the one or more display generation components, the first media item with the first set of visual characteristics (e.g., indicating that the spatial treatment setting of the first media item has been disabled) without displaying the spatial conversion option (e.g., 1516c) (e.g., in some embodiments, the spatial conversion option is not displayed based calculated spatial information corresponding to the first media item being available and/or accessible by the computer system) (e.g., FIG. 15N). In response to receiving the user request to discard the calculated spatial information corresponding to the first media item (e.g., user inputs 1542, 1542b), the computer system displays the spatial conversion option (e.g., 1516c) concurrently with the first media item (e.g., 1515a) (e.g., the first media item with the first set of visual characteristics (e.g., indicating that the first media item is a non-spatial media item)) (e.g., FIG. 15Q). Automatically re-displaying the spatial conversion option when the calculated spatial information is discarded provides the user with visual feedback about a state of the system (e.g., that the system no longer has spatial information for the first media item), and enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, subsequent to converting the first media item from the spatial media item to the spatial media, the computer system concurrently displays, via the one or more display generation components, the first media item (e.g., 1515a) with the first set of visual characteristics (e.g., indicating that the spatial treatment setting of the first media item has been disabled) and a selectable object (e.g., 1516e) associated with changing a spatial viewing state of the media item (e.g., FIG. 15O) which, when selected, causes the computer system to transition from displaying the first media item with the first set of visual characteristics to displaying the first media item with a second set of visual characteristics different from the first set of visual characteristics (e.g., with a different border; and/or with greater stereoscopic depth). In response to receiving the user request to discard the calculated spatial information corresponding to the first media item (e.g., user inputs 1542a, 1542b), the computer system ceases display of the selectable object (e.g., 1516e); and displays the first media item (e.g., 1515a) with the first set of visual characteristics without displaying the selectable object (e.g., FIG. 15Q). Automatically ceasing display of the selectable object when the calculated spatial information is discarded enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first media item with the spatial conversion option (e.g., 1516c), the computer system receives, via the one or more input devices, a selection input (e.g., a user input and/or one or more user inputs directed to the spatial conversion option) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the spatial conversion option (e.g., user inputs 1518a, 1518b). In response to receiving the selection input corresponding to selection of the spatial conversion option, the computer system displays, via the one or more display generation components, the first media item with stereoscopic depth (e.g., non-zero stereoscopic depth and/or as a three-dimensional media item) (e.g., FIG. 15G). While displaying the first media item with stereoscopic depth, the computer system receives, via the one or more input devices, a first user input (e.g., one or more user inputs) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)). In response to receiving the first user input, the computer system displays, via the one or more display generation components, a media library user interface (e.g., 1504) that includes representations of two or more media items in the media library (e.g., representation of at least a subset of the plurality of media items in the media library), including a representation of the first media item (e.g., 1508a), wherein the representation of the first media item is displayed without stereoscopic depth (e.g., the representation of the first media item is a two-dimensional representation). In some embodiments, the media library user interface is the representation of the media library. In some embodiments, the representation of the media library is part of the media library user interface. Providing the user with a selectable option to convert a non-spatial media item to a spatial media item allows a user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, a first media item (e.g., 1515d) without stereoscopic depth (e.g., as a two-dimensional media item) (e.g., FIG. 15R), wherein: the first media item comprises a plurality of frames; the first media item is represented by a static representation (e.g., a still and/or an unmoving representation) and an animated representation (e.g., a moving and/or changing representation) different from the static representation when a viewing setting (e.g., 1544) of the first media item is in an enabled state; and the first media item is represented by the static representation and not the animated representation when the viewing setting (e.g., 1544) of the first media item is in a disabled state. In some embodiments, when the viewing setting of the first media item is in the enabled state, the first media item transitions from the static representation to the animated representation when certain criteria are met (e.g., when the first media item is selected, when a user input on the first media item is detected, and/or when the first media item scrolls onto a display and/or a certain portion of a display). In some embodiments, when the viewing setting of the first media item is in the disabled state, the first media item is represented by the static representation, and not the animated representation, even when the criteria are met (e.g., the first media item stays in a static and/or unmoving state even when the criteria are met). While displaying the first media item (e.g., 1515d) without stereoscopic depth (e.g., FIG. 15R), the computer system receives, via the one or more input devices, a user request (e.g., one or more user inputs corresponding to a request to display the first media item with stereoscopic depth) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) to display the first media item with stereoscopic depth (e.g., with non-zero stereoscopic depth) (e.g., user inputs 1546a, 1546b). In response to receiving the user request to display the first media item with stereoscopic depth, the computer system displays, via the one or more display generation components, the first media item with stereoscopic depth (e.g., FIG. 15S); and transitions the viewing setting (e.g., 1544) of the first media item from the enabled state to the disabled state (e.g., FIG. 15S). Automatically disabling the viewing setting when the first media item is displayed with stereoscopic depth enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the first media item with stereoscopic depth (e.g., FIG. 15S), the computer system receives, via the one or more input devices, a user request (e.g., one or more user inputs corresponding to a user request to transition the live photo setting of the first media item from the disabled state to the enabled state) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) to transition the viewing setting of the first media item from the disabled state to the enabled state (e.g., user inputs 1550a, 1550b). In response to receiving the user request to transition the viewing setting of the first media item from the disabled state to the enabled state, the computer system transitions the viewing setting (e.g., 1544) of the first media item from the disabled state to the enabled state; and displays, via the one or more display generation components, the first media item without stereoscopic depth (e.g., FIG. 15T). Automatically transitioning the media item from being displayed with stereoscopic depth to being displayed without stereoscopic depth when the viewing setting is enabled enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, a first media item (e.g., 1515a, 1515b, 1515c, and/or 1515d) without stereoscopic depth (e.g., as a two-dimensional media item) (e.g., 1515d in FIG. 15R), wherein: the first media item comprises a plurality of frames; the first media item is represented by a static representation (e.g., a still and/or an unmoving representation) and an animated representation (e.g., a moving and/or changing representation) different from the static representation when a viewing setting (e.g., 1544) of the first media item is in an enabled state; and the first media item (e.g., 1515d) is represented by the static representation and not the animated representation when the viewing setting (e.g., 1544) of the first media item is in a disabled state. In some embodiments, when the viewing setting of the first media item is in the enabled state, the first media item transitions from the static representation to the animated representation when certain criteria are met (e.g., when the first media item is selected, when a user input on the first media item is detected, and/or when the first media item scrolls onto a display and/or a certain portion of a display). In some embodiments, when the viewing setting of the first media item is in the disabled state, the first media item is represented by the static representation, and not the animated representation, even when the criteria are met (e.g., the first media item stays in a static and/or unmoving state even when the criteria are met). While displaying the first media item without stereoscopic depth, the computer system receives, via the one or more input devices, a user request (e.g., one or more user inputs corresponding to a user request to display the first media item with stereoscopic depth) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) to display the first media item with stereoscopic depth (e.g., with non-zero stereoscopic depth) (e.g., user inputs 1546a, 15446b). In response to receiving the user request to display the first media item with stereoscopic depth, the computer system displays, via the one or more display generation components, the first media item with stereoscopic depth (e.g., 1544d in FIG. 15S); and maintains the viewing setting (e.g., 1544) of the first media item in the enabled state (e.g., in some embodiments, in FIG. 15S, rather than automatically disabling display setting 1544, computer system 1500 maintains display setting 1544 in the enabled stated). In some embodiments, while displaying the first media item with stereoscopic depth (e.g., FIG. 15S) with the viewing setting (e.g., 1544) of the first media item in the enabled state, the computer system receives, via the one or more input devices, a user request to disable the viewing setting of the first media item. In response to receiving the user request to disable the viewing setting of the first media item, the computer system transitions the viewing setting of the first media item from the enabled state to the disabled state while maintaining display of the first media item with stereoscopic depth. In some embodiments, the viewing setting of the first media item is controllable independently of a spatial viewing setting of the first media item (e.g., a spatial viewing setting in which the first media item is displayed with stereoscopic depth when the spatial viewing setting is enabled and without stereoscopic depth when the spatial viewing setting is disabled). Allowing a user to independently control stereoscopic depth of an image and the viewing setting enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, a media library user interface (e.g., 1504) that includes representations of two or more media items of the plurality of media items in the media library (in some embodiments, the media library user interface is the representation of the media library; or the representation of the media library is part of the media library user interface), including: visually emphasizing representations of two or more media items that have been converted (e.g., in some embodiments, using an AI process or a generative AI process) from being non-spatial media items to being spatial media items (e.g., media items that have been converted from being non-spatial media items to being spatial media items based on user input and/or user request (e.g., based on selection of spatial conversion options corresponding to the media items) and/or automatically (e.g., in some embodiments, using an AI process or a generative AI process) without user input). In some embodiments, visually emphasizing representations of two or more media items that have been converted from being non-spatial media items to being spatial media items includes displaying the representations of the two or more media items that have been converted with a set of visual characteristics (e.g., brightness, color, saturation, a border, and/or other visual indication) indicating that the media items have been converted from being non-spatial media items to being spatial media items. In some embodiments, visually emphasizing representations of two or more media items that have been converted from being non-spatial media items to being spatial media items includes displaying the representations of the two or more media items that have been converted within a particular location in a user interface (e.g., a location in a user interface that is near the top of a scrolling view that contains other information about the media library) (e.g., 1504 in FIG. 15U and/or a user interface corresponding to option 1506a). Providing the user with a visual indication of one or more media items that have been converted from being non-spatial media items to being spatial media items provides the user with visual feedback about a state of the system (e.g., that the system has converted those media items). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the representations of two or more media items (e.g., 1508a, 1508b, and/or 1508c) that have been converted from being non-spatial media items to being spatial media items includes a representation of a first converted media item that has been converted from being a non-spatial media item to being a spatial media item, wherein the first converted media item was converted from being a non-spatial media item to being a spatial media item automatically (e.g., in some embodiments, using an AI process or a generative AI process) without user input (e.g., based on automatic selection of the first converted media item by the computer system for conversion (e.g., based on selection criteria)). Automatically converting certain media items from non-spatial media items to spatial media items allows for such operations to be performed without user input. Additionally, automatically converting certain media items from non-spatial media items to spatial media items allows for these operations to be performed when the user is not using the computer for other purposes and/or when the computer system is plugged in, thereby conserving computing resources and/or battery power for user-initiated operations. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system (e.g., 1500 and/or 600) displays, via the one or more display generation components, a media library user interface (e.g., 1504 and/or 610) that includes representations of two or more media items (e.g., 1508a, 1508b, 1508c, and/or 615) of the plurality of media items in the media library (in some embodiments, the media library user interface is the representation of the media library; or the representation of the media library is part of the media library user interface), including: in accordance with a determination that the computer system is configured to display spatial media with stereoscopic depth (e.g., computer system 1500) (e.g., in accordance with a determination that the computer system is capable of displaying stereoscopic depth), visually emphasizing representations of two or more media items that have been converted from being non-spatial media items to being spatial media items (e.g., within user interface 1504); and in accordance with a determination that the computer system is not configured to display spatial media with stereoscopic depth (e.g., in accordance with a determination that the computer system is not capable of displaying stereoscopic depth) (e.g., computer system 600), displaying the media library user interface (e.g., 610) without visually emphasizing representations of media items that have been converted from being non-spatial media items to being spatial media items (e.g., user interface 610 does not include an option for displaying spatial media items (such as option 1506a in user interface 1504); and/or, in some embodiments, media library representation 615 does not visually emphasize converted spatial media items). In some embodiments, visually emphasizing representations of two or more media items that have been converted from being non-spatial media items to being spatial media items includes displaying the representations of the two or more media items that have been converted with a set of visual characteristics (e.g., brightness, color, saturation, a border, and/or other visual indication) indicating that the media items have been converted from being non-spatial media items to being spatial media items. Visually emphasizing spatial media items when the computer system is capable of displaying stereoscopic depth, and forgoing highlighting spatial media items when the computer system is not capable of displaying stereoscopic depth, enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, via the one or more display generation components, a media library user interface (e.g., 1504) that includes representations of two or more media items of the plurality of media items in the media library (in some embodiments, the media library user interface is the representation of the media library; or the representation of the media library is part of the media library user interface), wherein the media library user interface includes a converted media option (e.g., 1506a) that, when selected, causes the computer system to display representations of media items that have been converted from being non-spatial media items to being spatial media items without displaying representations of non-spatial media items. In some embodiments, the converted media option, when selected, causes the computer system to display representations of media spatial media items, including representations of spatial media items that have been converted from non-spatial media items to spatial media items and representations of non-converted and/or native spatial media items that were captured with spatial information (e.g., stereoscopic depth information), without displaying representations of non-spatial media items. Providing the user with a converted media option that filters the media library to display only converted media items allows a user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system receives, via the one or more input devices, a user request (e.g., a user input and/or one or more user inputs) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) to display a first respective media item (e.g., user inputs 1510, 1510a, 1510b, and/or 1510c). In response to receiving the user request to display the first respective media item: in accordance with a determination that the first respective media item is a non-spatial media item, the computer system displays, via the one or more display generation components, the first respective media item with a first set of visual characteristics (e.g., without stereoscopic depth; and/or with a first border) indicative of the first respective media item being a non-spatial media item (e.g., 1515a in FIG. 15B and/or 1515b in

FIG. 15J); in accordance with a determination that the first respective media item is a native spatial media item that has stereoscopic depth and was captured with stereoscopic depth, the computer system displays, via the one or more display generation components, the first respective media item with a second set of visual characteristics (e.g., with stereoscopic depth; and/or with a second border different from the first border) indicative of the first respective media item being a spatial media item with stereoscopic depth (e.g., 1515c in FIG. 15K); and in accordance with a determination that the first respective media item is a converted spatial media item that was converted from being a non-spatial media item to being a spatial media item with stereoscopic depth, the computer system displays, via the one or more display generation components, the first respective media item with the second set of visual characteristics (e.g., 1515a in FIG. 15G). In some embodiments, displaying the first respective media item with the second set of visual characteristics includes displaying the first respective media item with a visual effect (e.g., a graphical element and/or effect; a blurred region), wherein the visual effect obscures at least a first portion of the first respective media item and extends inwards from at least the first edge of the first respective media item towards an interior (e.g., a center) of the first respective media item. In some embodiments, the content included in the first respective media item that is covered by the visual effect is visible (e.g., visible to a user of the computer system) (e.g., the visual effect has a degree of translucency). In some embodiments, content included in the first respective media item obscures a portion of the visual effect (e.g., content included in the first respective media item blocks a user from viewing a portion of the visual effect). Displaying spatial media items differently from non-spatial media items provides the user with visual feedback about a state of the device (e.g., whether the device is displaying spatial media or non-spatial media). Doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 1600 (e.g., FIG. 16) are also applicable in an analogous manner to the methods described above. For example, method 700, method 800, method 1000, method 1100, method 1300, method 1400, and/or method 1800 optionally include one or more of the characteristics of the various methods described above with reference to method 1600. For example, the media library in method 700 is the media library in method 800, method 1300, method 1400, method 1600, and/or method 1800; and/or the queries recited in method 1000 and/or method 1100 are queries within the media library recited in method 700, method 800, method 1300, method 1400, method 1600, and/or method 1800. For brevity, these details are not repeated below.

FIGS. 17A-17P illustrate exemplary user interfaces for displaying and/or providing content, in accordance with some embodiments. The user interfaces in these figures are used to illustrate the processes described below, including the processes in FIG. 18.

FIG. 17A illustrates computer system 600, which is a smart phone with touch-sensitive display 602. Although the depicted embodiments show an example in which computer system 600 is a smart phone, in other embodiments, computer system 600 is a different type of computer system (e.g., a tablet, a laptop computer, a desktop computer, a wearable device, and/or a headset). At FIG. 17A, computer system 600 displays user interface 610, various features of which were described above, for example, with reference to FIGS. 6A-1 through 6AJ. In FIG. 17A, user interface 610 includes user profile icon 1702a and search field 1702b. Search field 1702b, when selected, causes computer system 600 to display a keyboard for the user to enter one or more terms to search through the media library. In some embodiments, search field 1702b in FIG. 17A is the same as search field 618 described above with reference to FIGS. 6A-1-6AJ. User profile icon 1702a, when selected, causes computer system 600 to display a user profile user interface that includes information pertaining to the media library and/or a user account associated with the media library, as will be described in greater detail below.

At FIG. 17A, computer system 600 detects user input 1704 (e.g., a tap input and/or a selection input corresponding to selection of user profile icon 1702a). At FIG. 17B, in response to user input 1704, computer system 600 displays user interface 1706. User interface 1706 corresponds to a user account (e.g., a user account that owns the media library represented in user interface 610). User interface 1706 includes option 1708a, profile image 1707 (e.g., an image, an avatar, and/or visual icon selected by the user to represent the user account); user information 1708b (e.g., the name of the user associated with the user account); media library information 1708c (e.g., total number of media items in the media library, total number of photos in the media library, and/or total number of videos in the media library); and cloud sync information 1708d (e.g., indicating in FIG. 17B that the media library has been stored in cloud storage and/or the media library is synchronized with cloud storage). Option 1708a, when selected, causes computer system 600 to cease display of user interface 1706 (and, optionally, re-display user interface 610). User interface 1706 also includes media set representations 1708e and media set representation 1708f. Media set representation 1708e is representative of a set of media items that has been shared with the user (e.g., shared with the user account). In some embodiments, media set representation 1708e and/or corresponding option 1708e-1, when selected, cause computer system 600 to display a user interface that displays representations of additional media items that have been shared with the user. Media set representation 1708f is representative of a set of media items that the user (e.g., the user account) has shared with other users and/or that has been shared with the user using links (e.g., URL links) to cloud storage. In some embodiments, media set representation 1708f and/or corresponding option 1708f-1, when selected, cause computer system 600 to display a user interface that displays representations of additional media items that have been shared with the user via cloud links and/or that the user has shared via cloud links.

At FIG. 17C, computer system 600 determines that the user account has used all of its allotted cloud storage space (e.g., that the user account's allotted cloud storage space is full). Based on the determination that the allotted cloud storage space associated with the user account is full, computer system 600 displays, within user interface 610, notification 1710 indicating that the user account's allotted cloud storage space is full, and that media items in the media library are no longer being backed up or synced to cloud storage. Furthermore, based on a determination that there is an active notification for the user account, computer system 600 also displays notification indication 1712 on user profile indication 1702a. Notification 1710 includes a selectable portion 1710b that, when selected, causes computer system 600 to initiate a process for increasing the amount of cloud storage allotted to the user account. At FIG. 17C, computer system 600 detects user input 1714 (e.g., a tap input and/or a selection input corresponding to option 1710a). At FIG. 17D, in response to user input 1714, computer system 600 ceases display of notification 1710 within user interface 610.

At FIG. 17D, computer system 600 detects user input 1716 (e.g., a tap input and/or a selection input corresponding to selection of user profile icon 1702a). At FIG. 17E, in response to user input 1716, computer system 600 displays user interface 1706. User interface 1706 includes notification 1718, which also notifies the user that cloud storage space for the user account is full. Notification 1718 includes selectable option 1718b which, when selected, causes computer system 600 to initiate a process for increasing the amount of cloud storage space allotted to the user account. Notification 1718 also includes option 1718a which, when selected, causes computer system 600 to cease display of notification 1718 within user interface 1706. Furthermore, in FIG. 17E, cloud sync information 1708d in user interface 1706 indicates that there are 87 media items in the media library that have not yet been synced with cloud storage (e.g., due to the cloud storage being full).

At FIG. 17F, computer system 600 receives notification information indicative of one or more notifications pertaining to the user account and/or the media library. In response to receiving the notification information indicative of one or more notifications, computer system 600 displays user profile icon 1702a with indication 1720. In some embodiments, different types of notifications result in user profile icon 1702a being displayed with different types of indications. For example, in some embodiments, notifications with a first level of urgency (e.g., cloud storage is full) and/or notifications of a first type cause computer system 600 to display user profile icon 1702a with notification 1712, while notifications with a second level of urgency (e.g., notifications pertaining to shared media items (e.g., media items shared by the user account with other user accounts and/or media items shared by other users accounts with the user account); and/or notifications pertaining to cloud storage being below a threshold but not yet full) and/or notifications of a second type cause computer system 600 to display user profile icon 1702a with notification 1720. Furthermore, certain types of notifications are displayed in user interface 610 and in user interface 1706 (e.g., notifications with a first level of urgency and/or notifications of a first type), while other types of notifications (e.g., notifications with a second level of urgency and/or notifications of a second type) are displayed only in user interface 1706 and are not displayed in user interface 610. For example, in FIG. 17F, computer system 600 has received notification information pertaining to the user account and/or the media library, but notifications are not displayed within user interface 610 based on a determination that the notifications are not notifications of a first type. At FIG. 17F, computer system 600 detects user input 1722 (e.g., a tap input and/or a selection input corresponding to selection of user profile icon 1702a).

At FIG. 17G, in response to user input 1722, computer system 600 displays user interface 1706. At FIG. 17G, user interface 1706 includes notifications 1724a, 1724b, 1724c, and 1724d. Notification 1724a informs the user that cloud storage for the user account is running low. Notification 1724a includes option 1724a-1 that, when selected, causes computer system 600 to cease display of notification 1724a within user interface 1706. Notification 1724b informs the user that another user named Sharon McLeary has invited the user account to join a shared album entitled “Ladies of NYC.” Notification 1724b includes option 1724b-1 that, when selected, causes computer system 600 to cease display of notification 1724b within user interface 1706. Notification 1724c informs the user that another user named Sharon McLeary has invited the user account to join a shared library (e.g., has invited the user account to access Sharon McLeary's media library). Notification 1724c includes option 1724c-1 that, when selected, causes computer system 600 to cease display of notification 1724c within user interface 1706. Notification 1724d informs the user that another user named Sharon McLeary has commented on a photo in a shared album that the user account is participating in. Notification 1724d includes option 1724d-1 that, when selected, causes computer system 600 to cease display of notification 1724d within user interface 1706.

At FIG. 17H, computer system 600 displays user interface 610. At FIG. 17H, computer system 600 receives information indicating that the media library is currently being synchronized to cloud storage (e.g., computer system 600 is transmitting media item information to be saved to cloud storage and/or computer system 600 is receiving media item information from a cloud storage), and based on this information, displays user profile icon 1702a with indication 1726. Indication 1726 is indicative of an ongoing process pertaining to the user account and/or the media library (e.g., an ongoing cloud synchronization process). Indication 1726 is also indicative of how close the ongoing process is to completion. For example, when the process first starts, indication 1726 is displayed at a first size. When the process progresses, indication 1726 grows in size to surround more of user profile icon 1702a. When the process is completed, indication 1726 grows to a size in which indication 1726 completely encircles and/or surrounds user profile icon 1702a. At FIG. 17H, computer system 600 detects user input 1727 (e.g., a tap input and/or a selection input corresponding to selection of user profile icon 1702a).

At FIG. 17I, in response to user input 1727, computer system 600 displays user interface 1706. User interface 1706 includes indication 1728 which partially encircles profile image 1707. In some embodiments, indication 1728 is indicative of an ongoing process pertaining to the user account and/or the media library (e.g., an ongoing cloud synchronization process). Indication 1728 is also indicative of how close the ongoing process is to completion. For example, when the process first starts, indication 1728 is displayed at a first size. When the process progresses, indication 1728 grows in size to surround more of profile image 1707. When the process is completed, indication 1728 grows to a size in which indication 1728 completely encircles and/or surrounds profile image 1707. User interface 1706 also includes progress bar 1708d-2, which is also indicative of an ongoing process pertaining to the user account and/or the media library, and grows in size (e.g., gets more filled up) as the process progresses. User interface 1706 also includes ongoing process information 1708d, which indicates that an ongoing process is syncing 9 items to cloud storage. User interface 1706 also includes option 1708d-1 that, when selected, causes computer system 600 to pause the ongoing process (e.g., pause the cloud synchronization process). At FIG. 17I, computer system 600 detects user input 1730 (e.g., a tap input and/or a selection input corresponding to selection of option 1708d-1.

At FIG. 17J, in response to user input 1730, computer system 600 displays indication 1707 and progress bar 1708d-2 are displayed in a different color to indicate that the cloud synchronization process has been paused. Furthermore, option 1708d-1 changes to option 1708d-3 which, when selected, causes computer system 600 to resume the cloud synchronization process. At FIG. 17J, computer system 600 detects user input 1732 (e.g., a selection input corresponding to selection of option 1708a).

At FIG. 17K, in response to user input 1732, computer system 600 ceases display of user interface 1706 and re-displays user interface 610. At FIG. 17K, computer system 600 displays user profile icon 1702a with indication 1726, as was the case in FIG. 17H, but indication 1726 is displayed in a different color to indicate that the cloud synchronization process is currently paused. FIG. 17K depicts five different example scenarios in which computer system 600 receives five different user inputs: user input 1738a (e.g., a downward swipe input within region 612a); user input 1738b (e.g., a swipe up user input within region 612a); user input 1738c (e.g., a swipe left input within region 612a); user input 1738d (e.g., a tap input and/or a selection input corresponding to selection of media item 1734); and user input 1738e (e.g., a tap input and/or a selection input corresponding to selection of memory collection representation 1736). Each of these different scenarios and user inputs will be described below.

At FIG. 17L, in response to user input 1738a, computer system 600 displays downward scrolling of region 612a to display expanded media grid user interface 622, various features and/or characteristics of which were described above, for example, with reference to FIGS. 6A-1-6AJ. While expanded media grid user interface 622 is displayed, computer system 600 maintains display of search field 1702b and user profile icon 1702a overlaid on expanded media grid user interface 622. In some embodiments, search field 1702b and user profile icon 1702a do not change positions or move as user interface 610 and/or expanded media grid user interface 622 are scrolled.

At FIG. 17M, in response to user input 1738b, computer system 600 displays upward scrolling of user interface 610. While upward scrolling of user interface 610 is displayed, computer system 600 maintains display of search field 1702b and user profile icon 1702a overlaid on user interface 610. In some embodiments, search field 1702b and user profile icon 1702a do not change positions or move as user interface 610 is scrolled.

At FIG. 17N, in response to user input 1738c, computer system 600 displays leftward scrolling of region 612a to display media collection representation 636a, described about with reference to FIGS. 6A-1-6AJ. As region 612a is scrolled and media collection representation 636a is displayed within region 612a, computer system 600 ceases display of search field 1702b and user profile icon 1702a.

At FIG. 17O, in response to user input 1738d, computer system 600 displays user interface 628 (described above) with the selected media item. Search field 1702b and user profile icon 1702a are not displayed within user interface 628.

At FIG. 17P, in response to user input 1738e, computer system 600 initiates playback of the selected memory collection 1740. While computer system 600 displays playback of a memory collection, search field 1702b and user profile icon 1702a are not displayed.

FIG. 18 is a flow diagram illustrating a method for navigating, displaying, and/or presenting content using a computer system in accordance with some embodiments. Method 1800 is performed at a computer system (e.g., 100, 300, 500, and/or 600) (e.g., a smart phone, a smart watch, a tablet, a laptop, a desktop, a wearable device, wrist-worn device, and/or head-mounted device) that is in communication with one or more display generation components (e.g., 602) (e.g., a display, a touch-sensitive display, and/or a display controller) and one or more input devices (e.g., 602) (e.g., a touch-sensitive surface, a touch-sensitive display, a button, a rotatable input mechanism, a depressible and rotatable input mechanism, a camera, an accelerometer, and/or an inertial measurement unit (IMU)). Some operations in method 1800 are, optionally, combined, the orders of some operations are, optionally, changed, and some operations are, optionally, omitted.

As described below, method 1800 provides an intuitive way for navigating, displaying, and/or presenting content. The method reduces the cognitive burden on a user for navigating and/or accessing content, thereby creating a more efficient human-machine interface. For battery-operated computing devices, enabling a user to navigate and/or access content faster and more efficiently conserves power and increases the time between battery charges.

The computer system detects (1802), via the one or more input devices, a sequence of one or more inputs (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to a request to display a portion of a media library (e.g., 610 and/or 615) that is associated with a user account. In response to detecting, via the one or more input devices, the sequence of one or more inputs corresponding to the request to display the portion of the media library (1804), the computer system concurrently displays (1806), via the one or more display generation components (e.g., 602): a representation of a portion of a media library (1808) (e.g., 610 and/or 615) (e.g., a media library associated with the computer system; a media library associated with a user (e.g., a user of the computer system); and/or a media library associated with a user account), wherein the media library includes a plurality of media items (e.g., images, photos, and/or videos) including a first media item and a second media item different from the first media item; and a user profile indication (1810) (e.g., 1702a) corresponding to the user account (e.g., a user account that is associated with the computer system and/or a user account that is logged into the computer system). In some embodiments, the user profile indication includes a visual representation of a user and/or a visual element that corresponds to the user account. In some embodiments, the user profile indication is indicative of and/or identifies a user account. In some embodiments, displaying the user profile indication corresponding to the user account includes, in accordance with a determination that an ongoing process (e.g., a particular type of ongoing process and/or an ongoing process of a predetermined set of processes) is occurring with respect to the media library (e.g., in some embodiments, with respect to a media library associated with the user account; and/or, in some embodiments, with respect to the user account), displaying the user profile indication (e.g., 1702a) with a first indicator (e.g., 1712, 1720, and/or 1726) that indicates a progress of the ongoing process (e.g., that indicates a degree of completion of the ongoing process and/or indicates a current status of the ongoing process) and that updates as the ongoing process progresses (e.g., that changes visually as the ongoing process progresses and/or that changes visually as the ongoing process changes). In some embodiments, the representation of the media library includes representations (e.g., previews, thumbnails, snapshots, and/or frames) of one or more media items (e.g., a first subset and/or a first plurality) of the plurality of media items in the media library. In some embodiments, in accordance with a determination that an ongoing process (e.g., of a predetermined set of processes) is not occurring with respect to the user account, the user profile indication (e.g., 1702a) is displayed without the first indicator (e.g., 1712, 1720, and/or 1726). Displaying the user profile indication with the first indicator when an ongoing process is occurring with respect to the media library provides the user with visual feedback about a state of the system (e.g., that an ongoing process is occurring). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the user profile indication corresponding to the user account further includes: in accordance with a determination that an ongoing process is not occurring with respect to the media library, displaying the user profile indication (e.g., 1702a) without the first indicator (e.g., 1702a in FIG. 17A). Displaying the user profile indication without the first indicator when an ongoing process is not occurring with respect to the media library provides the user with visual feedback about a state of the system (e.g., that an ongoing process is not occurring). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the user profile indication with the first indicator includes: in accordance with a determination that the ongoing process has a first state (e.g., a first state of progression and/or a first state of completion), displaying the first indicator with a first appearance (e.g., a first size, a first shape, and/or a first color) (e.g., 1726 in FIG. 17H); and in accordance with a determination that the ongoing process has a second state different from the first state (e.g., a second state of progression and/or a second state of completion), displaying the first indicator with a second appearance different from the first appearance (e.g., a second size, a second shape, and/or a second color) (e.g., 1726 in FIG. 17K). Displaying the user profile indication with the first indicator when an ongoing process is occurring with respect to the media library provides the user with visual feedback about a state of the system (e.g., that an ongoing process is occurring). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first indicator with the first appearance comprises displaying the first indicator with a first color that is indicative of a first state of progression (e.g., paused or active) of the ongoing process (e.g., 1726 in FIG. 17H); and displaying the first indicator with the second appearance comprises displaying the first indicator with a second color that is different from the first color and is indicative of a second state of progression of the ongoing process different from the first state of progression (e.g., active or paused) (e.g., 1726 in FIG. 17K). Changing the color of the first indication when the ongoing process changes states provides the user with visual feedback about a state of the system (e.g., the state of the ongoing process). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the first indicator with the first appearance comprises displaying the first indicator with a first shape (e.g., a first shape indicative of a first state of progression and/or a first state of completion) (e.g., 1726 in FIG. 17K); and displaying the first indicator with the first appearance comprises displaying the first indicator with a second shape different from the first shape (e.g., a second shape indicative of a second state of progression and/or a second state of completion) (e.g., in some embodiments, when the process has progressed further, indication 1726 is displayed at a larger size and/or surrounding more of profile icon 2702a). Changing the shape of the first indication when the ongoing process changes states provides the user with visual feedback about a state of the system (e.g., the state of the ongoing process). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the ongoing process is a cloud synchronization process (e.g., a process that includes saving data to a cloud platform and/or synchronizing data on a cloud platform); and the first indicator (e.g., 1726) is indicative of progress of the cloud synchronization process and updates as the cloud synchronization process progresses. In some embodiments, the ongoing process is a media library content processing operation (e.g., the computer system and/or one or more external computer systems reviewing media items for one or more faces and/or other recognized objects); and the first indicator is indicative of progress of the media library content processing operation and updates as the media library content processing operation progresses. Displaying the user profile indication with the first indicator when an ongoing process is occurring with respect to the media library provides the user with visual feedback about a state of the system (e.g., that an ongoing process is occurring). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, displaying the user profile indication (e.g., 1702a) corresponding to the user account further includes: in accordance with a determination that a first alert (e.g. a notification and/or a warning) is active with respect to the user account, displaying the user profile indication (e.g., 1702a) with an alert indicator (e.g., 1712 and/or 1720) that is indicative of an active alert. In some embodiments, displaying the user profile indication corresponding to the user account further includes: in accordance with a determination that the first alert is not active with respect to the user account (e.g., no alert is active with respect to the user account), displaying the user profile indication without the alert indicator (e.g., FIG. 17A). Displaying the user profile indication with the alert indicator when an alert is received and/or is active provides the user with visual feedback about a state of the system (e.g., that an alert has been received). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, while displaying the user profile indication (e.g., 1702a) corresponding to the user account (or, optionally, while concurrently displaying the representation of the portion of the media library and the user profile indication corresponding to the user account), the computer system receives, via the one or more input devices, a selection input (e.g., one or more user inputs directed to the user profile indication) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the user profile indication (e.g., user inputs 1704, 1716, 1722, and/or 1727). In response to receiving the selection input corresponding to selection of the user profile indication, the computer system displays, via the one or more display generation components, a first set of information corresponding to the user account (e.g., user interface 1706). In some embodiments, the first set of information corresponding to the user account is dynamic based on a state of the account (e.g., changes based on a state of the account; changes over time; and/or changes based on changes to the account) (e.g., user interface 1706 in FIG. 17B displays different information than user interface 1706 in FIG. 17E). In some embodiments, in response to receiving the selection input corresponding to selection of the user profile indication, the computer system displays a profile user interface that includes the first set of information corresponding to the user account. Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of information corresponding to the user account includes a summary of media items contained in the media library (e.g., 1708c) (e.g., a size of the media library, an amount of storage space being used by the media library, a total number of media items contained in the media library, a total number of photographs contained in the media library, and/or a total number of videos contained in the media library). Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Providing the user with a summary of media items contained in the media library also provides the user with visual feedback about a state of the system.

In some embodiments, the first set of information corresponding to the user account includes cloud synchronization status information (e.g., 1708d) that is indicative of a status of a cloud synchronization process with respect to the media library that is associated with the user account (e.g., cloud synchronization status information that indicates that cloud synchronization is up to date; cloud synchronization status information that indicates that cloud synchronization is ongoing; cloud synchronization status information that indicates how many media items are being synchronized to a cloud platform and/or are not yet synchronized to the cloud platform (e.g., are not yet uploaded to the cloud platform and/or are not yet downloaded from the cloud platform); and/or cloud synchronization status information that indicates that cloud synchronization is paused). Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Providing the user with cloud synchronization status information also provides the user with visual feedback about a state of the system.

In some embodiments, the first set of information corresponding to the user account includes one or more sharing notifications (e.g., 1708e, 1708f, 1724b, 1724c, and/or 1724d) that pertain to media items (e.g., images, photographs, videos, albums, and/or collections of media items) that have been shared with the user account by one or more other user accounts (e.g., one or more other users). Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Providing the user with sharing notifications also provides the user with visual feedback about a state of the system.

In some embodiments, the one or more sharing notifications includes a plurality of shared album activity notifications (e.g., 1724b and/or 1724d), including: a first shared album activity notification (e.g., 1724b and/or 1724d) that is indicative of a first set of one or more changes to a first shared album (e.g., a shared collection of media items) that has been shared with the user account (e.g., a first shared album activity notification that is indicative of one or more media items being added to the first shared album; one or more media items being removed from the first shared album; and/or a title of the first shared album being modified); and a second shared album activity notification (e.g., 1724b and/or 1724d) that is indicative of a second set of one or more changes to a second shared album that has been shared with the user account (e.g., a second shared album activity notification that is indicative of one or more media items being added to the second shared album; one or more media items being removed from the second shared album; and/or a title of the second shared album being modified); and the plurality of shared album activity notifications are displayed in a first stack in which the first shared album activity notification overlaps (e.g., completely or partially) the second album active activity notification (e.g., in some embodiments, notifications 1724b and 1724d are displayed in a stack and/or are stacked on top of one another). In some embodiments, the first shared album activity notification and the second shared album activity notification are concurrently displayed. Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Providing the user with sharing notifications also provides the user with visual feedback about a state of the system.

In some embodiments, the one or more sharing notifications further includes a first shared collection invitation notification (e.g., 1724c) that is indicative of the user account having been invited by another user account to join a shared collection of media items (e.g., to add media items to the shared collection of media items and/or to view media items in the shared collection of media item); and the first shared collection invitation notification (e.g., 1724c) is displayed separately from the first stack of shared album activity notifications (e.g., 1724b and/or 1724d).

Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Providing the user with sharing notifications also provides the user with visual feedback about a state of the system.

In some embodiments, the first set of information corresponding to the user account includes one or more cloud synchronization notifications (e.g., 1718, 1708d, 1724a, 1708d-2, and/or 1728) pertaining to cloud synchronization of the media library to a cloud platform (e.g., cloud synchronization notifications that indicate that cloud synchronization is up to date; cloud synchronization notifications that indicate that cloud synchronization is ongoing; cloud synchronization notifications that indicate how many media items are being synchronized to a cloud platform and/or are not yet synchronized to the cloud platform (e.g., are not yet uploaded to the cloud platform and/or are not yet downloaded from the cloud platform); cloud synchronization notifications that indicate that cloud synchronization is paused; cloud synchronization notifications that indicate that cloud storage is full; cloud synchronization notifications that indicate how much space is remaining in cloud storage; and/or cloud synchronization notifications that indicate one or more errors pertaining to cloud synchronization of the media library). Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently. Providing the user with cloud synchronization notifications also provides the user with visual feedback about a state of the system.

In some embodiments, the first set of information corresponding to the user account (e.g., user interface 1706) includes a first feature option that, when selected, causes a first feature of the media library to transition between an enabled state and a disabled state (e.g., from enabled to disabled if the feature is enabled when the option is selected; and/or from disabled to enabled if the feature is disabled when the option is selected) (e.g., in some embodiments, user interface 1706 includes one or more options that allow the user to selectively opt into one or more shared albums, opt out of one or more shared albums and/or for the user to enable and/or disable a media item sharing feature). In some embodiments, the first set of information corresponding to the user account includes one or more selectable options for selectively enabling or disabling one or more features of the media library. For example, in some embodiments, the one or more selectable options includes a first selectable option that is selectable to cause a first section of the media library to be displayed within a media library user interface when the first section is currently disabled or to cause the first section of the media library to no longer be displayed within the media library when the first section is currently enabled. Providing the user with selection options to enable or disable media library features allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of information corresponding to the user account (e.g., user interface 1706) includes a first feature reset option that, when selected, causes a first feature of the media library (e.g., a people suggestion feature and/or a suggested memories feature) to be reset (e.g., recalculated and/or regenerated) (e.g., in some embodiments, user interface 1706 includes one or more options that, when selected, cause computer system 600 to re-sync with a cloud storage platform). In some embodiments, the first set of information corresponding to the user account includes one or more selectable reset options for resetting one or more features of the media library. For example, in some embodiments, the media library includes a people suggestion feature in which the computer system suggests one or more people that have been identified in media items in the media library. In some embodiments, the one or more selectable reset options includes a first selectable reset option that is selectable to cause the people suggestion feature to be reset and for the people suggestions to be recalculated and/or regenerated. Providing the user with reset options to reset media library features allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of information corresponding to the user account (e.g., user interface 1706) includes a first feature setup option that, when selected, causes a first feature of the media library (e.g., a people suggestion feature and/or a suggested memories feature) to be set up (e.g., for the computer system to enable and/or initiate use of the first feature; for the computer system to receive user input authorizing use of the first feature; and/or for the computer system to receive user input of information necessary for use of the first feature) (e.g., in some embodiments, user interface 1706 includes one or more options for the user to join and/or opt into one or more shared albums and/or shared libraries; and/or for the user to enable a media item sharing feature). Providing the user with setup options to set up media library features allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of information corresponding to the user account (e.g., user interface 1706) includes a first display option that, when selected, causes a first display feature that pertains to display of media libraries within a media library user interface to transition between an enabled state and a disabled state (e.g., from enabled to disabled if the feature is enabled when the option is selected; and/or from disabled to enabled if the feature is disabled when the option is selected) (e.g., in some embodiments, user interface 1706 includes an option to enable or disable auto-playing media items while viewing user interface 610 and/or user interface 622; and/or an option to enable or disable display of shared album notifications). In some embodiments, the computer system receives a user request to display a media library user interface (e.g., 610 and/or 622) (e.g., in some embodiments, the media library user interface is the representation of the portion of the media library and/or includes the representation of the portion of the media library) that includes representations of two or more media items of the media library. In response to receiving the user request to display the media library user interface, the computer system displays the media library user interface (e.g., 610 and/or 622), including: in accordance with a determination that the first display option is in an enabled state, displaying the media library user interface with a first visual effect that corresponds to the first display option (e.g., an auto-play visual effect that automatically plays media items as the user scrolls through the media library user interface); and in accordance with a determination that the first display option is in a disabled state, displaying the media library user interface without the first visual effect (e.g., without automatically playing media items as the user scrolls through the media library user interface). Providing the user with options to enable or disable display features allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of information corresponding to the user account (e.g., 1706) includes a first section of media items that includes representations of one or more media items that have been shared with the user account by one or more other user accounts (e.g., 1708e and/or 1708f). Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first set of information corresponding to the user account (e.g., 1706) includes a first section of media items that includes representations of one or more media items that pertain to a first event (e.g., a holiday, a birthday, an anniversary, a trip, and/or a gathering). In some embodiments, the one or more media items are automatically determined as pertaining to the first event (e.g., based on selection criteria) by the computer system and/or by one or more external computer system. Providing the user with a selectable option to display information corresponding to the user account allows the user to perform these operations with fewer inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the computer system displays, concurrently with the representation of the portion of the media library (e.g., 610 and/or 615) and the user profile indication (e.g., 1702a), a first notification (e.g., a first notification pertaining to the media library and/or the user account) (e.g., 1710). While displaying the first notification (e.g., 1710), the computer system receives, via the one or more input devices, a user request (e.g., one or more user inputs corresponding to a user request to cease display of the first notification) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) to cease display of the first notification (e.g., user input 1714). In response to receiving the user request to cease display of the first notification, the computer system ceases display of the first notification (e.g., FIG. 17D, notification 1710 is no longer displayed) while maintaining display of the representation of the portion of the media library (e.g., 610 and/or 615) and the user profile indication (e.g., 1702a). Subsequent to receiving the user request to cease display of the first notification, the computer system receives, via the one or more input devices, a selection input (e.g., one or more user inputs directed to the user profile indication) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to selection of the user profile indication (e.g., user input 1716). In response to receiving the selection input corresponding to selection of the user profile indication, the computer system displays, via the one or more display generation components, a profile user interface (e.g., 1706) corresponding to the user account (and, optionally, ceasing display of the representation of the portion of the media library), wherein the profile user interface includes a representation of the first notification (e.g., 1718) (e.g., a representation that displays the same information as the first notification and/or displays additional information pertaining to the first notification). Displaying the first notification provides the user with visual feedback pertaining to the state of the computer system. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the first notification (e.g., 1710) is displayed underneath (e.g., in some embodiments, immediately underneath) the representation of the portion of the media library (e.g., 615); and the first notification (e.g., 1710) is displayed above (e.g., in some embodiments, immediately above) representations of two or more collections of media items in the media library (e.g., 1200 and/or 612b) (e.g., collections that include two or more media items from the media library), wherein the representations of the two or more collections of media items in the media library includes: a representation of a first collection of media items (e.g., 1200) that includes a first plurality of media items from the media library; and a representation of a second collection of media items (e.g., 612b) that includes a second plurality of media items from the media library different from the first plurality of media items. Displaying the first notification provides the user with visual feedback pertaining to the state of the computer system. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the user profile indication (e.g., 1702a) is overlaid on the representation of the portion of the media library (e.g., 615). Displaying the user profile indication with the first indicator when an ongoing process is occurring with respect to the media library provides the user with visual feedback about a state of the system (e.g., that an ongoing process is occurring). Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, in response to detecting the sequence of one or more inputs corresponding to the request to display the portion of the media library, the computer system displays, concurrently with the representations of the portion of the media library (e.g., 615) and the user profile indication (e.g., 1702a), a search field (e.g., 1702b) (e.g., a search field into which a user can enter search terms and/or text to search for media items in the media library that are responsive to the entered search terms), wherein the search field (e.g., 1702b) is positioned adjacent to the user profile indication (e.g., 1702a). In some embodiments, search field 1702b in FIG. 17A is the same as search field 618 described with reference to FIGS. 6A-1-6AJ. Displaying a search field for searching for media items in the media library allows a user to perform search with fewer user inputs. Furthermore, doing so also enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the representation of the portion of the media library (e.g., 615) is part of a media library user interface (e.g., 610 and/or 622). While concurrently displaying the representation of the portion of the media library (e.g., 615) and the user profile indication (e.g., 1702a), the computer system receives, via the one or more input devices, a navigation input (e.g., one or more user inputs corresponding to a user request to navigate the media library user interface) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to a user request to navigate the media library user interface (e.g., scroll through the media library user interface and/or display additional portions of the media library user interface that are not currently displayed) (e.g., 1738a and/or 1738b). In response to receiving the navigation input corresponding to the user request to navigate the media library user interface, the computer system displays, via the one or more display generation components, navigation of the media library user interface (e.g., 610) (e.g., scrolling of the media library user interface) including movement of the representation of the portion of the media library (e.g., 615) (and, in some embodiments, including ceasing display of the representation of the portion of the media library), while maintaining display of the user profile indication (e.g., 1702a) (and, in some embodiments, without displaying movement of the user profile indication) (e.g., FIGS. 17K, 17L, and/or 17M). Persistently displaying the user profile indication as the user navigates the media library user interface enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

In some embodiments, the representation of the portion of the media library (e.g., 615) is part of a media library user interface (e.g., 610 and/or 622). While concurrently displaying the representation of the portion of the media library (e.g., 615) and the user profile indication (e.g., 1702a), the computer system receives, via the one or more input devices, a second navigation input (e.g., 1738d and/or 1738e) (e.g., one or more user inputs corresponding to a user request to display the second user interface) (e.g., one or more touch inputs, one or more touchscreen inputs, one or more gestures, one or more air gestures, one or more spoken inputs, and/or one or more mechanical inputs (e.g., via one or more physical buttons and/or physically rotatable input mechanisms)) corresponding to a user request to display a second user interface (e.g., 636a and/or 628) different from the media library user interface (e.g., 610 and/or 622) (e.g., in some embodiments, the navigation input comprises a selection input corresponding to selection of a representation of a first media item and/or selection of a representation of a first collection of media items). In response to receiving the second navigation input corresponding to a user request to display a second user interface (e.g., 636a and/or 628) different from the media library user interface (e.g., 610 and/or 622), the computer system ceases display of the user profile indication (e.g., 1702a) (e.g., FIG. 17N and/or FIG. 17O) and displays, via the one or more display generation components, the second user interface (e.g., 636a and/or 628). Ceasing display of the user profile indication when the user navigates to a different user interface enhances the operability of the system and makes the user-system interface more efficient (e.g., by preventing erroneous inputs and helping the user to provide proper inputs and reducing errors) which, additionally, reduces power usage and improves the battery life of the device by enabling the user to use the system more quickly and efficiently.

Note that details of the processes described above with respect to method 1800 (e.g., FIG. 18) are also applicable in an analogous manner to the methods described above. For example, method 700, method 800, method 1000, method 1100, method 1300, method 1400, and/or method 1600 optionally include one or more of the characteristics of the various methods described above with reference to method 1800. For example, the media library in method 700 is the media library in method 800, method 1300, method 1400, method 1600, and/or method 1800; and/or the queries recited in method 1000 and/or method 1100 are queries within the media library recited in method 700, method 800, method 1300, method 1400, method 1600, and/or method 1800. For brevity, these details are not repeated below.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

Although the disclosure and examples have been fully described with reference to the accompanying drawings, it is to be noted that various changes and modifications will become apparent to those skilled in the art. Such changes and modifications are to be understood as being included within the scope of the disclosure and examples as defined by the claims.

Some embodiments described herein can include use of artificial intelligence and/or machine learning systems (sometimes referred to herein as the AI/ML systems). The use can include collecting, processing, labeling, organizing, analyzing, recommending and/or generating data. Entities that collect, share, and/or otherwise utilize user data should provide transparency and/or obtain user consent when collecting such data. The present disclosure recognizes that the use of the data in the AI/ML systems can be used to benefit users. For example, the data can be used to train models that can be deployed to improve performance, accuracy, and/or functionality of applications and/or services. Accordingly, the use of the data enables the AI/ML systems to adapt and/or optimize operations to provide more personalized, efficient, and/or enhanced user experiences. Such adaptation and/or optimization can include tailoring content, recommendations, and/or interactions to individual users, as well as streamlining processes, and/or enabling more intuitive interfaces. Further beneficial uses of the data in the AI/ML systems are also contemplated by the present disclosure.

The present disclosure contemplates that, in some embodiments, data used by AI/ML systems includes publicly available data. To protect user privacy, data may be anonymized, aggregated, and/or otherwise processed to remove or to the degree possible limit any individual identification. As discussed herein, entities that collect, share, and/or otherwise utilize such data should obtain user consent prior to and/or provide transparency when collecting such data. Furthermore, the present disclosure contemplates that the entities responsible for the use of data, including, but not limited to data used in association with AI/ML systems, should attempt to comply with well-established privacy policies and/or privacy practices.

For example, such entities may implement and consistently follow policies and practices recognized as meeting or exceeding industry standards and regulatory requirements for developing and/or training AI/ML systems. In doing so, attempts should be made to ensure all intellectual property rights and privacy considerations are maintained. Training should include practices safeguarding training data, such as personal information, through sufficient protections against misuse or exploitation. Such policies and practices should cover all stages of the AI/ML systems development, training, and use, including data collection, data preparation, model training, model evaluation, model deployment, and ongoing monitoring and maintenance. Transparency and accountability should be maintained throughout. Such policies should be easily accessible by users and should be updated as the collection and/or use of data changes. User data should be collected for legitimate and reasonable uses of the entity and not shared or sold outside of those legitimate uses. Further, such collection and sharing should occur through transparency with users and/or after receiving the informed consent of the users. Additionally, such entities should consider taking any needed steps for safeguarding and securing access to such data and ensuring that others with access to the data adhere to their privacy policies and procedures. Further, such entities should subject themselves to evaluation by third parties to certify, as appropriate for transparency purposes, their adherence to widely accepted privacy policies and practices. In addition, policies and/or practices should be adapted to the particular type of data being collected and/or accessed and tailored to a specific use case and applicable laws and standards, including jurisdiction-specific considerations.

In some embodiments, AI/ML systems may utilize models that may be trained (e.g., supervised learning or unsupervised learning) using various training data, including data collected using a user device. Such use of user-collected data may be limited to operations on the user device. For example, the training of the model can be done locally on the user device so no part of the data is sent to another device. In other implementations, the training of the model can be performed using one or more other devices (e.g., server(s)) in addition to the user device but done in a privacy preserving manner, e.g., via multi-party computation as may be done cryptographically by secret sharing data or other means so that the user data is not leaked to the other devices.

In some embodiments, the trained model can be centrally stored on the user device or stored on multiple devices, e.g., as in federated learning. Such decentralized storage can similarly be done in a privacy preserving manner, e.g., via cryptographic operations where each piece of data is broken into shards such that no device alone (i.e., only collectively with another device(s)) or only the user device can reassemble or use the data. In this manner, a pattern of behavior of the user or the device may not be leaked, while taking advantage of increased computational resources of the other devices to train and execute the ML model. Accordingly, user-collected data can be protected. In some implementations, data from multiple devices can be combined in a privacy-preserving manner to train an ML model.

In some embodiments, the present disclosure contemplates that data used for AI/ML systems may be kept strictly separated from platforms where the AI/ML systems are deployed and/or used to interact with users and/or process data. In such embodiments, data used for offline training of the AI/ML systems may be maintained in secured datastores with restricted access and/or not be retained beyond the duration necessary for training purposes. In some embodiments, the AI/ML systems may utilize a local memory cache to store data temporarily during a user session. The local memory cache may be used to improve performance of the AI/ML systems. However, to protect user privacy, data stored in the local memory cache may be erased after the user session is completed. Any temporary caches of data used for online learning or inference may be promptly erased after processing. All data collection, transfer, and/or storage should use industry-standard encryption and/or secure communication.

In some embodiments, as noted above, techniques such as federated learning, differential privacy, secure hardware components, homomorphic encryption, and/or multi-party computation among other techniques may be utilized to further protect personal information data during training and/or use of the AI/ML systems. The AI/ML systems should be monitored for changes in underlying data distribution such as concept drift or data skew that can degrade performance of the AI/ML systems over time.

In some embodiments, the AI/ML systems are trained using a combination of offline and online training. Offline training can use curated datasets to establish baseline model performance, while online training can allow the AI/ML systems to continually adapt and/or improve. The present disclosure recognizes the importance of maintaining strict data governance practices throughout this process to ensure user privacy is protected.

In some embodiments, the AI/ML systems may be designed with safeguards to maintain adherence to originally intended purposes, even as the AI/ML systems adapt based on new data. Any significant changes in data collection and/or applications of an AI/ML system use may (and in some cases should) be transparently communicated to affected stakeholders and/or include obtaining user consent with respect to changes in how user data is collected and/or utilized.

Despite the foregoing, the present disclosure also contemplates embodiments in which users selectively restrict and/or block the use of and/or access to data. That is, the present disclosure contemplates that hardware and/or software elements can be provided to prevent or block access to data. For example, in the case of some services, the present technology should be configured to allow users to select to “opt in” or “opt out” of participation in the collection of data during registration for services or anytime thereafter. In another example, the present technology should be configured to allow users to select not to provide certain data for training the AI/ML systems and/or for use as input during the inference stage of such systems. In yet another example, the present technology should be configured to allow users to be able to select to limit the length of time data is maintained or entirely prohibit the use of their data for use by the AI/ML systems. In addition to providing “opt in” and “opt out” options, the present disclosure contemplates providing notifications relating to the access or use of personal information. For instance, a user can be notified when their data is being input into the AI/ML systems for training or inference purposes, and/or reminded when the AI/ML systems generate outputs or make decisions based on their data.

The present disclosure recognizes AI/ML systems should incorporate explicit restrictions and/or oversight to mitigate against risks that may be present even when such systems having been designed, developed, and/or operated according to industry best practices and standards. For example, outputs may be produced that could be considered erroneous, harmful, offensive, and/or biased; such outputs may not necessarily reflect the opinions or positions of the entities developing or deploying these systems. Furthermore, in some cases, references to third-party products and/or services in the outputs should not be construed as endorsements or affiliations by the entities providing the AI/ML systems. Generated content can be filtered for potentially inappropriate or dangerous material prior to being presented to users, while human oversight and/or ability to override or correct erroneous or undesirable outputs can be maintained as a failsafe.

The present disclosure further contemplates that users of the AI/ML systems should refrain from using the services in any manner that infringes upon, misappropriates, or violates the rights of any party. Furthermore, the AI/ML systems should not be used for any unlawful or illegal activity, nor to develop any application or use case that would commit or facilitate the commission of a crime, or other tortious, unlawful, or illegal act. The AI/ML systems should not violate, misappropriate, or infringe any copyrights, trademarks, rights of privacy and publicity, trade secrets, patents, or other proprietary or legal rights of any party, and appropriately attribute content as required. Further, the AI/ML systems should not interfere with any security, digital signing, digital rights management, content protection, verification, or authentication mechanisms. The AI/ML systems should not misrepresent machine-generated outputs as being human-generated.

As described above, one aspect of the present technology is the gathering and use of data available from various sources to improve the delivery to users of content, such as dynamically generated collections of content, or any other content that may be of interest to them. The present disclosure contemplates that in some instances, this gathered data may include personal information data that uniquely identifies or can be used to contact or locate a specific person. Such personal information data can include demographic data, location-based data, telephone numbers, email addresses, social network IDs, home addresses, data or records relating to a user's health or level of fitness (e.g., vital signs measurements, medication information, exercise information), date of birth, or any other identifying or personal information.

The present disclosure recognizes that the use of such personal information data, in the present technology, can be used to the benefit of users. For example, the personal information data can be used to deliver targeted content that is of greater interest to the user. Accordingly, use of such personal information data enables users to have calculated control of the delivered content. Further, other uses for personal information data that benefit the user are also contemplated by the present disclosure. For instance, health and fitness data may be used to provide insights into a user's general wellness, or may be used as positive feedback to individuals using technology to pursue wellness goals.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of content delivery, the present technology can be configured to allow users to select to “opt in” or “opt out” of participation in the collection of personal information data during registration for services or anytime thereafter. In another example, users can select not to provide personal information for targeted content delivery. In yet another example, users can select to limit the length of time personal information is maintained or entirely prohibit the collection of personal information. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users by inferring preferences based on non-personal information data or a bare minimum amount of personal information, such as the content being requested by the device associated with a user, other non-personal information available to the content delivery services, or publicly available information.

What is claimed is:

1. A computer system configured to communicate with one or more display generation components and one or more input devices, comprising:
one or more processors; and
memory storing one or more programs configured to be executed by the one or more processors, the one or more programs including instructions for:
displaying, via the one or more display generation components, a representation of a media library, wherein the media library includes a plurality of media items including a first media item and a second media item different from the first media item;
while displaying the representation of the media library, detecting, via the one or more input devices, a request to display the first media item; and
in response to detecting the request to display the first media item:
in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.

2. The computer system of claim 1, wherein displaying the representation of the media library comprises concurrently displaying a plurality of representations of media items in the representation of the media library, including a representation of a non-spatial media item, wherein the representation of the non-spatial media item is displayed without displaying the spatial conversion option.

3. The computer system of claim 1, the one or more programs further including instructions for:
in response to detecting the request to display the first media:
in accordance with a determination that second criteria different from the first criteria are satisfied, wherein the second criteria include a requirement that the first media item is a spatial media item that includes stereoscopic depth information in order for the second criteria to be met, displaying, via the one or more display generation components, the first media item with a first set of visual characteristics and with a spatial viewing option that, when selected, causes the computer system to display the first media item in a spatial viewing mode in which the first media item is displayed with a second set of visual characteristics different from the first set of visual characteristics.

4. The computer system of claim 3:
displaying the first media item with the spatial conversion option comprises displaying the spatial conversion option at a first display position; and
displaying the first media item with the spatial viewing option comprises displaying the spatial viewing option at the first display position.

5. The computer system of claim 1, the one or more programs further including instructions for:
while displaying the first media item with the spatial conversion option, receiving, via the one or more input devices, a selection input corresponding to selection of the spatial conversion option; and
in response to receiving the selection input corresponding to selection of the spatial conversion option, displaying, via the one or more display generation components, replacement of the spatial conversion option with a spatial viewing option that, when selected, causes the computer system to transition from displaying the first media item with a first set of visual characteristics to displaying the first media item in a spatial viewing mode in which the first media item is displayed with a second set of visual characteristics different from the first set of visual characteristics.

6. The computer system of claim 1, the one or more programs further including instructions for:
while displaying the first media item with the spatial conversion option, receiving, via the one or more input devices, a selection input corresponding to selection of the spatial conversion option; and
in response to receiving the selection input corresponding to selection of the spatial conversion option, displaying, via the one or more display generation components, the first media item with a three-dimensional effect in which one or more visual elements of the first media item are displayed at a first simulated depth and other visual elements of the first media item are displayed at a second simulated depth different from the first simulated depth.

7. The computer system of claim 1, the one or more programs further including instructions for:
while displaying the first media item with the spatial conversion option, receiving, via the one or more input devices, a selection input corresponding to selection of the spatial conversion option; and
in response to receiving the selection input corresponding to selection of the spatial conversion option, displaying, via the one or more display generation components, a first animation while converting the first media item from a non-spatial media item to a spatial media item that includes simulated depth.

8. The computer system of claim 7, wherein displaying the first animation includes displaying an indication of a determined three-dimensional shape of one or more visual elements of the first media item.

9. The computer system of claim 7, wherein displaying the first animation includes displaying animation of the spatial conversion option.

10. The computer system of claim 7, wherein displaying the first animation includes blurring at least a first portion of the first media item.

11. The computer system of claim 7, wherein displaying the first animation includes moving the boundary of a distortion layer across the first media item.

12. The computer system of claim 7, wherein displaying the first animation includes displaying movement of a color gradient across different simulated depths of the first media item.

13. The computer system of claim 7, wherein displaying the first animation includes displaying highlighting of different depths of the first media item at different times.

14. The computer system of claim 1, the one or more programs further including instructions for:
in response to detecting the request to display the first media item:
in accordance with a determination that the first media item is a non-spatial media item that cannot be converted to a spatial media item, displaying, via the one or more display generation components, the first media item without displaying the spatial conversion option.

15. The computer system of claim 1, wherein the spatial conversion option is displayed with a brightness that is above a threshold brightness.

16. The computer system of claim 1, wherein converting the first media item from a non-spatial media item to a spatial media item that includes stereoscopic depth includes using one or more machine learning models to estimate the depths of objects depicted in the first media item.

17. The computer system of claim 1, wherein converting the first media item from a non-spatial media item to a spatial media item that includes stereoscopic depth includes using one or more generative models to create infill to synthetically generate at least one of a left view of the first media item and a right view of the first media item that is different from the left view of the first media item.

18. The computer system of claim 1, wherein:
displaying the first media item with the spatial conversion option comprises displaying the first media item with a first set of visual characteristics indicative of the first media item being a non-spatial media item; and
the one or more programs further include instructions for:
while displaying the first media item with the first set of visual characteristics and with the spatial conversion option, receiving, via the one or more input devices, a selection input corresponding to selection of the spatial conversion option; and
in response to receiving the selection input corresponding to selection of the spatial conversion option:
displaying, via the one or more display generation components, the first media item with a second set of visual characteristics indicative of the first media item being a spatial media item; and
displaying, concurrently with the first media item with the second set of visual characteristics, a selectable object that, when selected, causes the computer system to transition from displaying the first media item with the second set of visual characteristics to displaying the first media item with the first set of visual characteristics.

19. The computer system of claim 18, the one or more programs further including instructions for:
in response to receiving the selection input corresponding to selection of the spatial conversion option, displaying, concurrently with the first media item with the second set of visual characteristics and the selectable object, a spatial viewing option that, when selected, causes the computer system to display the first media item in a spatial viewing mode in which the first media item is displayed with a third set of visual characteristics different from the first set of visual characteristics and the second set of visual characteristics;
while concurrently displaying the first media item with the second set of visual characteristics, the selectable object, and the spatial viewing option, receiving, via the one or more input devices, a selection input corresponding to selection of the selectable object; and
in response to receiving the selection input corresponding to selection of the selectable object, ceasing display of the spatial viewing option.

20. The computer system of claim 18, wherein:
in response to receiving the selection input corresponding to selection of the spatial conversion option, the first media item is converted from a non-spatial media item to a spatial media item that includes stereoscopic depth;
converting the first media item from a non-spatial media item to a spatial media item includes generating calculated spatial information corresponding to the first media item; and
the one or more programs further include instructions for:
in response to receiving the selection input corresponding to selection of the selectable object, transitioning a spatial treatment setting of the first media item from an enabled state to a disabled state; and
subsequent to transitioning the spatial treatment setting of the first media item from the enabled state to the disabled state:
in accordance with a determination that the spatial treatment setting of the first media item has been in the disabled state for greater than a threshold duration of time, discarding the calculated spatial information corresponding to the first media item.

21. The computer system of claim 20, the one or more programs further including instructions for:
in response to receiving the selection input corresponding to selection of the selectable object, concurrently displaying, via the one or more display generation components:
the first media item with the first set of visual characteristics; and
the selectable object; and
subsequent to discarding the calculated spatial information corresponding to the first media item, displaying, via the one or more display generation components, the first media item with the first set of visual characteristics without displaying the selectable object.

22. The computer system of claim 1, wherein:
in response to receiving the selection input corresponding to selection of the spatial conversion option, the first media item is converted from a non-spatial media item to a spatial media item that includes stereoscopic depth;
converting the first media item from a non-spatial media item to a spatial media item includes generating calculated spatial information corresponding to the first media item; and
the one or more programs further include instructions for:
subsequent to converting the first media item from the spatial media item to the spatial media, including generating the calculated spatial information corresponding to the first media item, receiving, via the one or more input devices, a user request to discard the calculated spatial information corresponding to the first media item; and
in response to receiving the user request to discard the calculated spatial information corresponding to the first media item, discarding the calculated spatial information corresponding to the first media item.

23. The computer system of claim 22, the one or more programs further including instructions for:
subsequent to converting the first media item from the spatial media item to the spatial media, displaying, via the one or more display generation components, the first media item with the first set of visual characteristics without displaying the spatial conversion option; and
in response to receiving the user request to discard the calculated spatial information corresponding to the first media item:
displaying the spatial conversion option concurrently with the first media item.

24. The computer system of claim 22, the one or more programs further including instructions for:
subsequent to converting the first media item from the spatial media item to the spatial media, concurrently displaying, via the one or more display generation components, the first media item with the first set of visual characteristics and a selectable object associated with changing a spatial viewing state of the media item which, when selected, causes the computer system to transition from displaying the first media item with the first set of visual characteristics to displaying the first media item with a second set of visual characteristics different from the first set of visual characteristics; and
in response to receiving the user request to discard the calculated spatial information corresponding to the first media item:
ceasing display of the selectable object; and
displaying the first media item with the first set of visual characteristics without displaying the selectable object.

25. The computer system of claim 1, the one or more programs further including instructions for:
while displaying the first media item with the spatial conversion option, receiving, via the one or more input devices, a selection input corresponding to selection of the spatial conversion option; and
in response to receiving the selection input corresponding to selection of the spatial conversion option, displaying, via the one or more display generation components, the first media item with stereoscopic depth;
while displaying the first media item with stereoscopic depth, receiving, via the one or more input devices, a first user input; and
in response to receiving the first user input, displaying, via the one or more display generation components, a media library user interface that includes representations of two or more media items in the media library, including a representation of the first media item, wherein the representation of the first media item is displayed without stereoscopic depth.

26. The computer system of claim 1, the one or more programs further including instructions for:
displaying, via the one or more display generation components, a first media item without stereoscopic depth, wherein:
the first media item comprises a plurality of frames;
the first media item is represented by a static representation and an animated representation different from the static representation when a viewing setting of the first media item is in an enabled state; and
the first media item is represented by the static representation and not the animated representation when the viewing setting of the first media item is in a disabled state;
while displaying the first media item without stereoscopic depth, receiving, via the one or more input devices, a user request to display the first media item with stereoscopic depth; and
in response to receiving the user request to display the first media item with stereoscopic depth:
displaying, via the one or more display generation components, the first media item with stereoscopic depth; and
transitioning the viewing setting of the first media item from the enabled state to the disabled state.

27. The computer system of claim 26, the one or more programs further including instructions for:
while displaying the first media item with stereoscopic depth, receiving, via the one or more input devices, a user request to transition the viewing setting of the first media item from the disabled state to the enabled state; and
in response to receiving the user request to transition the viewing setting of the first media item from the disabled state to the enabled state:
transitioning the viewing setting of the first media item from the disabled state to the enabled state; and
displaying, via the one or more display generation components, the first media item without stereoscopic depth.

28. The computer system of claim 1, the one or more programs further including instructions for:
displaying, via the one or more display generation components, a first media item without stereoscopic depth, wherein:
the first media item comprises a plurality of frames;
the first media item is represented by a static representation and an animated representation different from the static representation when a viewing setting of the first media item is in an enabled state; and
the first media item is represented by the static representation and not the animated representation when the viewing setting of the first media item is in a disabled state;
while displaying the first media item without stereoscopic depth, receiving, via the one or more input devices, a user request to display the first media item with stereoscopic depth; and
in response to receiving the user request to display the first media item with stereoscopic depth:
displaying, via the one or more display generation components, the first media item with stereoscopic depth; and
maintaining the viewing setting of the first media item in the enabled state.

29. The computer system of claim 1, the one or more programs further including instructions for:
displaying, via the one or more display generation components, a media library user interface that includes representations of two or more media items of the plurality of media items in the media library, including:
visually emphasizing representations of two or more media items that have been converted from being non-spatial media items to being spatial media items.

30. The computer system of claim 29, wherein the representations of two or more media items that have been converted from being non-spatial media items to being spatial media items includes a representation of a first converted media item that has been converted from being a non-spatial media item to being a spatial media item, wherein the first converted media item was converted from being a non-spatial media item to being a spatial media item automatically without user input.

31. The computer system of claim 1, the one or more programs further including instructions for:
displaying, via the one or more display generation components, a media library user interface that includes representations of two or more media items of the plurality of media items in the media library, including:
in accordance with a determination that the computer system is configured to display spatial media with stereoscopic depth, visually emphasizing representations of two or more media items that have been converted from being non-spatial media items to being spatial media items; and
in accordance with a determination that the computer system is not configured to display spatial media with stereoscopic depth, displaying the media library user interface without visually emphasizing representations of media items that have been converted from being non-spatial media items to being spatial media items.

32. The computer system of claim 1, the one or more programs further including instructions for:
displaying, via the one or more display generation components, a media library user interface that includes representations of two or more media items of the plurality of media items in the media library, wherein the media library user interface includes a converted media option that, when selected, causes the computer system to display representations of media items that have been converted from being non-spatial media items to being spatial media items without displaying representations of non-spatial media items.

33. The computer system of claim 1, the one or more programs further including instructions for:
receiving, via the one or more input devices, a user request to display a first respective media item; and
in response to receiving the user request to display the first respective media item:
in accordance with a determination that the first respective media item is a non-spatial media item, displaying, via the one or more display generation components, the first respective media item with a first set of visual characteristics indicative of the first respective media item being a non-spatial media item;
in accordance with a determination that the first respective media item is a native spatial media item that has stereoscopic depth and was captured with stereoscopic depth, displaying, via the one or more display generation components, the first respective media item with a second set of visual characteristics indicative of the first respective media item being a spatial media item with stereoscopic depth; and
in accordance with a determination that the first respective media item is a converted spatial media item that was converted from being a non-spatial media item to being a spatial media item with stereoscopic depth, displaying, via the one or more display generation components, the first respective media item with the second set of visual characteristics.

34. A non-transitory computer-readable storage medium storing one or more programs configured to be executed by one or more processors of a computer system that is in communication with one or more display generation components and one or more input devices, the one or more programs including instructions for:
displaying, via the one or more display generation components, a representation of a media library, wherein the media library includes a plurality of media items including a first media item and a second media item different from the first media item;
while displaying the representation of the media library, detecting, via the one or more input devices, a request to display the first media item; and
in response to detecting the request to display the first media item:
in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.

35. A method, comprising:
at a computer system that is in communication with one or more display generation components and one or more input devices:
displaying, via the one or more display generation components, a representation of a media library, wherein the media library includes a plurality of media items including a first media item and a second media item different from the first media item;
while displaying the representation of the media library, detecting, via the one or more input devices, a request to display the first media item; and
in response to detecting the request to display the first media item:
in accordance with a determination that first criteria are satisfied, wherein the first criteria include a requirement that the first media item is a non-spatial media item in order for the first criteria to be met, displaying, via the one or more display generation components, the first media item with a spatial conversion option that, when selected, causes the computer system to initiate a process for converting the first media item from a non-spatial media item to a spatial media item that includes stereoscopic depth.
